(19) United States
(12) Patent Application Publication
(10) Pub. No.: US 2025/0071040 A1
(43) Pub. Date: Feb. 27, 2025

(54) Internet of things system

(71) Applicant: CHINA ENTROPY CO., LTD., Zhangjiakou, Hebei (CN)

(72) Inventors: Tiejun Wang, Beijing (CN); Tiehong Wang, plano, TX (US); Chengshuang Yang, Shenzhen (CN); Guang Zhang, Beijing (CN); Wei Zhang, Beijing (CN); Nan Zhou, Beijing (CN); Hao Weng, Beijing (CN); Tonghui Sun, Beijing (CN); Tao Liu, Beijing (CN)

(21) Appl. No.: 18/688,784

(22) PCT Filed: Sep. 3, 2022
(86) PCT No.: PCT/CN2022/116928

§ 371 Date: Sep. 27, 2024

Related U.S. Application Data
(63) Continuation-in-part of application No. 16/132,079, filed on Sep. 14, 2018, now Pat. No. 10,469,898.
(63) Continuation-in-part of application No. 16/605,191, filed on Oct. 14, 2019, now abandoned.
(63) Continuation-in-part of application No. 17/902,825, filed on Sep. 3, 2022.
(63) Continuation-in-part of application No. 18/106,497, filed on Feb. 7, 2023.
(60) Provisional application No. 63/240,965, filed on Sep. 5, 2021.
(60) Provisional application No. 63/325,613, filed on Mar. 31, 2022.
(60) Provisional application No. 63/353,816, filed on Jun. 20, 2022.

(30) Foreign Application Priority Data
May 24, 2022 (CN) CN202210571576.8

(51) Int. Cl. H04L 43/0876; G01D 18/00; G01D 21/02; G16Y 40/10; G16Y 40/50; G16Y 40/60

(52) U.S. Cl. CPC H04L 43/0876; G01D 18/00; G01D 21/02; G16Y 40/10; G16Y 40/50; G16Y 40/60

(57) ABSTRACT

Flexible scheduling, self-healing, high-utilization strong stability for cellular network communications are discussed. Cellular network communication settings and strategies are developed with communication interval, transmit power data rate, channel delay, spectrum occupancy, source coding, receiving sensitivity, channel coding, signal-to-noise ratio, packet loss rate, channel occupancy rate, reception frequencies frequency band size of data package transmission frequencies, data package structure, modulation scheme, information coding scheme, antenna configuration.

### CROSS REFERENCES TO RELATED APPLICATIONS

This application claims priority to the following: the U.S. application 63/240,965 submitted on Sep. 5, 2021, with the title of “A wireless system”, and the application U.S. 63/325,613 submitted on Mar. 31, 2022, with the title of “IoT Networks”, the application U.S. 63/353,816 filed on Jun. 20, 2022, with the title of “An IoT System”: the application CN202210571576.8 filed on May 24, 2022, titled “Internet of Things Data Utilization and Deep Learning Method”, all of which are incorporated herein by reference in their entirety. This application is PCT/CN2022/116928 (WO2023030513A1) national phase entry in USA This application is a continuation-in-part of application Ser. No. 16/605,191, with a PCT (PCT/US2019/042729) filed on Jul. 22, 2019, which claims priority of 62/701,837 filed on Jul. 22, 2018, all of which are incorporated herein by reference in their entirety.

This application is a continuation-in-part of US Application Ser. No. US17/902.825 filed on Sep. 3, 2022, all of which are incorporated herein by reference in their entirety.

This application is a continuation-in-part of U.S. Pat. No. 10,469,898 issued on Nov. 5, 2019 with an application number of Ser. No. 16/132,079, all of which are incorporated herein by reference in their entirety.

### TECHNICAL FIELD

This disclosure involves the Internet of Things system and its multiple layers, including terminal layer, transmission layer, support layer, artificial intelligence business platform layer and city operation comprehensive IOC layer, also includes: security management platform, unified operation and maintenance management platform and IT resource service. It specifically involves technologies such as industry terminals, edge computing, intelligent data fusion, artificial intelligence, streaming media, blockchain security management, digital twins, integrated communications, intelligent inspection, unified operation and maintenance, and cloud management.

### BACKGROUND TECHNIQUE

At present, the Internet of Things technology has not yet achieved the interconnection of all things, there is no effective integration of data, and no data warehouse that can be used in the entire industry has been formed. In addition, the Internet of Things system in related technologies still has high latency, high power consumption, incomplete network coverage, and insecure data. Problems such as low load capacity, insecure data, and failure to effectively allocate communication resources on application terminals are obstacles to the development of the Internet of Things technology. The integration of the Internet of Things and vertical industries will be a comprehensive network and scene with multiple devices, multiple networks, multiple applications, interconnection, and mutual integration. The standardization of device interface standards, communication protocols, and management protocols is a systematic technological innovation. Only by solving the above problems can the Internet of Things technology be popularized and applied.

At present, the “data islands” and “industry chimneys” in this field, technically speaking, mainly have the following problems to be solved urgently. 1. In industrial applications, there are unreliable network connections (especially in remote areas). Due to problems such as high operation and maintenance costs, inconsistent access technologies, and insecure industry data, there is a lack of a ubiquitous, dynamic, and real-time network, and the problem of “Internet of Everything” needs to be solved; 2. Different communication protocols, access authentication methods. Different manufacturers and different types of terminals with network bandwidth requirements and application protocols lack a secure and unified access method to access the network, and the problem of “ubiquitous access and unified management” needs to be solved, 3 Lack of a unified security protection system, including various access security issues of various types of IoT edge devices, multi-mode transmission channel diversification security protection issues, and security risks brought about by multi-scenario business coupling, data sharing, and data interaction need to be resolved. Problem, 4. Lack of core functions such as data fusion platform, unified collection, aggregation, data specification, storage management, analysis and mining, fusion algorithm, and on-demand services of multi-source data, which need to solve the “information islands and application chimneys” among smart applications Problem; 5. The “device-cloud” technical solution based on cloud computing can effectively utilize the powerful computing resources and storage resources of the cloud, but it is difficult to meet the low-latency requirements of many real-time applications, and new technical solutions are urgently needed, 6 Intelligent AI technology needs to be able to quickly meet the comprehensive management of intelligent application classification, clustering, prediction, and association analysis artificial intelligence models.

Based on one or more technical problems including but not limited to the foregoing, the present disclosure proposes an Internet of Things system.

### Contents of the Invention.

The Internet of Things system or industrial Internet system provided by this disclosure is built for the smart twin/smart empowerment of various industries, covering multiple levels. The whole can be divided into five horizontal and three vertical, and the five horizontal from bottom to top are terminal layer, transmission layer, support layer, artificial intelligence business platform layer, and urban operation comprehensive IOC layer. The three verticals are security, operation and maintenance, and IT resource services, in which security and operation and maintenance vertically run through all horizontal levels, providing full-chain, end-to-end services: IT resource services are support layer, artificial intelligence business platform layer and urban operation integration. The IOC layer provides services (For example: FIG. 1B).

The first aspect is to introduce the structure and relationship of the “five horizontal layers” proposed in this disclosure.

### (1) Terminal Layer

The terminal layer includes thousands of terminals in different industries and types of sensing, linkage, mobile, video, etc.

Sensing terminals can detect the multi-dimensional state of the city ubiquitously, in real time, and dynamically, such as water, gas, electricity, soil, sound, fire, etc. and the sensing data is uploaded to center platform.

Linkage terminals can realize edge-side sensing linkage based on the communication network that dynamically adjusts any communication parameters according to industry requirements or/and physical location, such as linkage alarms, linkage calls, linkage control valves/doors, linkage SMS/email notifications, etc.

Converged communication terminals provide those sensors that do not have communication transmission capabilities to dynamically adjust transmission and interconnection according to industry requirements or/and physical locations. Support composite sensing technology, multi-sensor data fusion, and support unified access of sensing devices from different manufacturers. Perception/detection technology combined with edge computing technology realizes edge correction and self-correction of sensor data, and an optimized sampling strategy is derived from it, such as dynamically changing the sampling interval, sampling accuracy and sending frequency, etc. in connection with response time, power consumption of the whole machine, and network bandwidth occupation can be taken into account at the same time.

Mobile terminals include handhelds, walkie-talkies, vehicle-mounted devices, positioning terminals, wearable terminals, etc. which detects and applied in the mobile state, and realize wide, medium and narrow through a communication network that dynamically adjusts any communication parameters based on industry requirements or/and physical locations. Combined, voice/video/text fusion communication applications.

Video-type terminals include cameras, thermal imaging, hyperspectral and other diversified video-aware terminals, which are uploaded to the central platform through a communication network that dynamically adjusts any communication parameters according to industry requirements or/and physical location.

### (2) Communication Layer

The communication layer can be understood as the root and stem of the tree, which is the bridge connecting the tentacles and the trunk of the tree. The communication layer uploads the perception/detection, control, status and other information of the tentacles to the support layer (trunk of the big tree) through wireless/wired means.

The communication layer is an intelligent Internet of Things composed of base stations and gateways. It dynamically adjusts any communication parameters according to industry requirements or/and physical locations to establish a network. In addition to mainstream communication modes, it also includes advanced components such as Mesh, relay, and SDN. Network mode, providing network support for fixed-mobile convergence, combination of broadband, medium and narrowband, and voice/video/text communication for the terminal layer.

The base station covers various communication networks such as satellite, private network, WLAN, bridge, public network, etc. and dynamically adjusts any communication parameters according to industry requirements or/and physical location to establish a network. For example, it supports data splitting and aggregation for multi-path transmission. Different strategies are adopted according to needs during multipath transmission. For example, when the equipment in the blind area cannot be directly connected to the base station, a mesh network can be established with other equipment, and uplink communication can be realized with the help of equipment that can be connected to the base station. The device can be switched between the star network and the mesh network; when working in the mesh network mode, the terminal can be used as a routing node or a normal node. It supports point-to-point intercommunication between devices, reducing the bandwidth occupation of the base station.

The core network and the base station can collect the link information of the base station, routing node, and terminal, including: communication standard, communication path, signal-to-noise ratio, packet loss rate, delay, channel occupancy rate and other information, and it is better to do link prediction and deduction through deep learning solution, adaptive adjustment of device connection mode (direct connection to base station, mesh network, point-to-point), transmission path (single path, multi-path), radio frequency parameters on demand (bandwidth, response time, reliability, connection distance, etc.) (Modulation mode, rate, spectrum occupancy, receiving bandwidth). Gateways include different types of edge AI, security, positioning, video, mid-range communication, CPE, RFID, technical detection, etc. which can realize network interconnection with different high-level protocols, including wired and wireless networks, and dynamically adjust any communication parameters according to industry requirements or/and physical locations.

### (3) Support Layer

The support layer can be understood as the trunk of a big tree, and all the data and services required by the upper-level business are provided by the support layer. The sensing/detection, control and other data at the root of the big tree will enter the crown and each branch through the support layer. The supporting layer mainly includes IoT sensing platform, data intelligent fusion platform, digital twin middle platform, artificial intelligence industry algorithm middle platform, integrated communication middle platform and streaming media platform.

1. The sensing platform of the Internet of Things, which aggregates the data of the terminal layer and the communication layer, supports the device management of the terminal layer and the communication layer, and provides communication network services and edge computing services that dynamically adjust any communication parameters according to industry requirements or/and physical locations.

Communication network services not only provide separate access and management services for existing satellite links, cellular network links, RFID network management, LTE core network, WLAN network management, LoRa core network and other network communications; but also provide core network-based wireless access services, supporting integrated access and unified management of wireless networks. Communication network services provide network services that dynamically adjust any communication parameters according to industry requirements or/and physical locations, such as adjustable physical communication parameters such as source coding, channel coding, modulation model, signal time slot, and transmission power; flexible scheduling, flexible and expanded wireless link access and management technology Communication network services can perform functions such as remote control, upgrade, parameter reading/modification, and management of equipment, support link self-healing, and provide high-utilization, strong stability, and easy-to-restore professional wireless network hosting services.

Edge computing service, for the connected communication network, provides dynamic and adaptive network allocation with edge computing capabilities of the converged network, and provides different delays, different bandwidths. Networks with different time slots can dynamically, automatically and rationally allocate network resources. For example, the environmental protection industry requires thousands of sites to report data at the same time, which not only requires low latency, but also high concurrency at the same time, but the time interval between two reports may be as long as 1 hour or 4 hours, which requires our Edge computing services provide support and dynamically and reasonably allocate network resources.

2. The intelligent data fusion platform provides cross-departmental and cross-industry services including structured, semi-structured and unstructured multi-source heterogeneous data collection, data cleaning, data fusion, resource catalog and data sharing and exchange services.

Data aggregation can be connected to the sensor data uploaded by the IoT sensing platform, and the data shared by other third-party platforms or upper-lower-level platforms, and unified aggregation forms a data lake. At the same time, it gathers business data/control data/algorithm early warning data/required data of different industries/physical location data, etc. that are generated or need to interact with other sections (business section, other support sections).

Data cleaning, fusion, and resource catalogs mainly manage and classify the aggregated data to form various theme libraries and topic libraries, etc. to facilitate the extraction of different business data. Support platforms such as platforms and streaming media platforms and artificial intelligence business platforms provide the data they need.

Data sharing and exchange, providing data sharing and exchange with third-party platforms and upper and lower platforms.

### 3. Streaming Media Platform.

The streaming media platform provides services such as video recording, PTZ control, streaming media, SDK. ONVIF, and national standard protocols for video data uploaded from different industries and locations based on the communication network, and supports the artificial intelligence business platform.

The interaction with the intelligent data fusion platform includes receiving information such as video, pictures, and streaming media access from the intelligent data fusion platform, feeding back control information, screenshot information, etc. to the intelligent data fusion platform and storing them in the corresponding theme/special library. At the same time, it is sent to terminals corresponding to industries and corresponding physical locations through the communication network to realize control.

4. Converged communication center, based on the communication network that dynamically adjusts any communication parameters according to industry requirements or/and physical location, realizes the converged communication services of different types of data or files such as text, voice, picture, video, location, attachment, etc. Converged communication services include data uplink and downlink Uplink includes uploading of different types of data and files, and downlink includes downlinking of different types of data and files to terminals in corresponding industries and/or physical locations.

The communication center platform of the present disclosure can provide integrated communication services of different types of data or files such as text, voice, picture, video, location, attachment, etc. to support the artificial intelligence business platform. For example, WeChat chat supports sending and receiving different types of data and files; for example, event reporting supports filling in text when reporting, adding information such as voice, video, picture, location or attachment, etc. It can access the text, voice, picture, video, location, files, etc. provided by the intelligent data fusion platform. The data of the intelligent data fusion platform comes from the communication network of the terminal and the communication layer. It supports feeding back the data generated by the fusion communication to the intelligent data fusion platform and storing the data in the corresponding theme/theme library. For the converged communication of video, the streaming media platform provides camera control and streaming media services for the converged communication center. Some control information can be downlinked to terminals corresponding to industries and corresponding physical locations through the communication network.

5. The artificial intelligence industry algorithm center provides artificial intelligence algorithms with management services such as algorithm deployment, algorithm configuration, algorithm training, and algorithm viewing/importing/deleting/upgrading. The inputs or video sources of the platform in the artificial intelligence industry algorithm are aggregated and uploaded from communication networks that are dynamically deployed according to industry requirements or/and physical locations, including various sensor data, alarms, and video data. At the same time, data such as linkage control, linkage shouting, linkage alarm, linkage SMS/email notification generated in the algorithm of the artificial intelligence industry are dynamically downloaded to the corresponding terminal according to industry requirements or/and physical location through the multi-mode heterogeneous communication network.

The artificial intelligence industry algorithm platform can access the input parameters and video data required by different algorithms uploaded by the data intelligent fusion platform, and can output alarms/characteristic values to the artificial intelligence business platform to realize early warning based on artificial intelligence and algorithms check.

The alarms/characteristic values generated by the platform in the artificial intelligence industry algorithm will also be fed back to the data intelligent fusion platform and stored in the corresponding theme/special library.

For video algorithms, the artificial intelligence industry algorithm center can retrieve the required video/picture through the streaming media center.

For prediction algorithms, such as fire spread prediction, gas diffusion prediction, etc. it is necessary to display the predicted diffusion range after a period of time (such as one hour) in a three-dimensional form. In such cases, the artificial intelligence industry algorithm center will provide data such as eigenvalues and predictive simulations to the digital twin center.

6. The digital twin middle platform, based on the dynamic sensor data of different industries and locations uploaded by the communication network, provides urban 3D twin services for the artificial intelligence business platform. The CIM, AR, VR, BIM, GIS, etc. required by the artificial intelligence business platform all require the support of the digital twin platform.

At the same time, the data generated by the modification and definition of maps, layers, key points, etc. in the digital twin platform will also be fed back to the data intelligent fusion platform and stored in the corresponding theme/theme library.

### (4) AI Business Platform Layer.

Display, analyze, predict, forecast, rehearse, etc. the data uploaded by the communication network in different industries and different physical locations, provide artificial intelligence-based unified module component management and smart applications in different industries, receive data from various supporting platforms, and integrate business Terminal operation information is fed back to each support platform. At the same time, some operational data can be dynamically adjusted according to industry requirements or/and physical location, and sent to the terminal through the communication layer to realize linkage.

### (5) Comprehensive IOC Layer of Urban Operation.

Integrating the data of various industries can realize the overview of the overall situation of the city, monitoring and early warning, command and dispatch, event handling, operation decision-making, etc. The bridge/support of various convergence and downlink data of the city operation comprehensive IOC layer relies on the communication network established by dynamically adjusting any communication parameters according to industry requirements or/and physical location.

The second aspect is to introduce the structure and relationship of the “three vertical layers” proposed in this disclosure.

The three vertical verticals are security, operation and maintenance, and IT resource services, in which security and operation and maintenance vertically run through all horizontal levels, providing full-chain, end-to-end unified security and unified operation and maintenance services. IT resource service provides unified monitoring and dynamic allocation services including computing resources, storage resources and network resources for the support layer, artificial intelligence business platform layer and urban operation comprehensive IOC layer according to different needs such as business volume and time.

The security management platform starts with the terminal, runs through the transport layer and the multi-mode heterogeneous core network, reaches the support layer, and finally reaches the application layer, and dynamically controls security from the root, instead of ensuring security only at the platform layer.

The unified operation and maintenance management platform dynamically controls the status of all devices based on the dynamically adjusted communication network. At the same time, it can also be sent to each terminal according to the demand through the dynamic communication network to realize functions such as alarm, work order, and inspection.

The following describes a sensor terminal device in the general inventive concept. For the inventive concept of the Internet of Things or Industrial Internet system, a sensor calibration method and system thereof are provided.

In order to extend the service life of sensors, reduce maintenance costs, and improve sensor data accuracy and sensitivity analysis, this disclosure uses deep learning calibration algorithms to perform historical data reported by sensors and at least part of the corresponding historical data collected by standard sensors. The original model is obtained through training, and combined with the computing power characteristics of sensor terminal equipment, base stations, and cloud servers, deep learning pruning or knowledge distillation is performed on the trained original model to achieve a balance between accuracy and response speed.

The calibration algorithm based on deep learning in the present disclosure adopts a deformer model (Transformer model) based on a multi-head attention mechanism (Multi-Head Attention). The Transformer model is an Encoder-Decoder model based entirely on the attention mechanism. Further deep learning pruning or knowledge distillation is carried out on the obtained original model, so that it can achieve model compression and optimization on the basis of no obvious decrease in accuracy, so that it has the ability to be deployed separately in sensor terminal equipment, base stations and cloud servers.

The technical problem solved by the present disclosure is to provide a sensor calibration method and system thereof, which realize hierarchical, efficient, intelligent calibration and multi-level collaborative calibration of sensors.

In this context, the embodiments of the present disclosure expect to provide a method and system for calibrating sensors based on deep learning.

The Present Disclosure Provides a Method for Calibrating a Sensor Based on Deep Learning, and the Calibration Method Includes the Following Steps:

The sensor collects historical data in chronological order;

Accurate values of historical data collected at least in part by standard sensors, providing said historical data and said accurate values to a deformer model;

The deformer model trains the historical data and the accurate value to obtain an original model; performing multi-level compression optimization on the original model through deep learning pruning or knowledge distillation to obtain a multi-level compression optimized model:

The raw data collected by the sensor is then calibrated according to the original model or the multi-stage compression optimized model.

The present disclosure also provides a calibration system for sensors based on deep learning, the calibration system includes: sensors, which are used to collect historical data in chronological order; standard sensors, which are used to collect accurate values of at least part of the corresponding historical data. A training device, which is used to receive the historical data and the accurate value, and train the historical data and the accurate value to obtain the original model; a compression optimization device, which is used for pruning or knowledge distillation through deep learning performing multi-level compression optimization on the original model to obtain a multi-level compression optimized model; a calibration device for calibrating the original data collected by the sensors according to the original model or the multi-level compression optimized model. The present disclosure also provides a deep learning processing method, and the processing method includes the following steps: collecting historical data in chronological order; collecting accurate values of at least part of the corresponding historical data; providing the historical data and the accurate values to the deformer model; the deformer model trains the historical data and the accurate value to obtain the original model; performs multi-level compression optimization on the original model through deep learning pruning or knowledge distillation to obtain multi-level compression optimization. For the final model, the first-level compressed and optimized model obtained through knowledge distillation is deployed on the terminal device, the second-level compressed and optimized model obtained through deep learning pruning is deployed on the base station, and the original model is deployed on the cloud server, the processing accuracy of the model after the two-stage compression optimization is higher than that of the model after the one-stage compression optimization, and lower than the processing accuracy of the original model, and the response of the model after the two-stage compression optimization is lower than the response speed of the model after the first-level compression optimization, and higher than the response speed of the original model, and the data calculation amount of the model after the second-level compression optimization is higher than that of the model after the first-level compression optimization. The data calculation amount of the model is lower than the data calculation amount of the original model; according to the processing accuracy requirements, response speed and/or data calculation amount, determine the terminal device, base station or cloud server uses the deployed model for processing (raw) data collected.

The present disclosure also provides an application of a sensor calibration method based on deep learning, the application comprising the following steps; the sensor collects raw data in real time; the standard sensor collects an accurate value corresponding to the raw data in real time; Take a certain amount of the original data and the corresponding accurate value according to the sampling rate, and upload the original data and the accurate value to the base station; the base station compares the certain amount of the original data with the corresponding accurate value; If the difference between the two is greater than a certain accuracy threshold and the proportion is less than the ratio threshold, the sensor is marked as a sensor in a normal state, all raw data is accepted and uploaded to the cloud server.

According to the method and system for calibrating sensors based on deep learning provided in this disclosure, the following are achieved. First, the Transformer model based on the multi-head attention mechanism is adopted. This deep learning model can not only effectively learn and imitate the characteristics of time series data, but also it can use the multi-head attention mechanism to help the Transformer model capture more abundant sensor features and information, and further comprehensively process the captured sensor features and information. Inter-data correlation, alarm for abnormal values, and has a strong filtering ability, which realizes the application in multiple types of sensor equipment; second, hierarchical calibration, deep learning pruning or knowledge of the original model trained distillation enables it to achieve model compression and optimization on the basis of no significant decrease in accuracy, so that it has the ability to be deployed separately on sensor terminal equipment, base stations, and cloud servers. Combining the computing power characteristics of sensor terminal equipment, base stations, and cloud servers, intelligent match the calibration position to achieve a balance between the ratio of accuracy and response speed, perform quick calibration with low accuracy on sensor terminal devices with weak computing power, and perform high-precision calibration on cloud servers with strong computing power, realize the application in multiple scenarios; third, multi-level collaborative calibration, upload the low-level calibration results and original data to the high-level device or environment, and perform advanced calibration on at least part of the original data in the high-level device or environment, such as performing primary calibration on the raw data in the sensor terminal equipment, uploading the obtained primary calibrated data and original data to the base station, and performing secondary calibration on at least part of the original data at the base station, and obtaining at least part of the secondary calibration, comparing the at least part of the data after secondary calibration with the corresponding data after primary calibration, if the difference between the two is less than a certain error threshold, then accept all the data after primary calibration, otherwise, the received raw data is subjected to secondary calibration by using the model optimized by secondary compression to obtain all secondary calibrated data Multi-level collaborative calibration can use multi-level calibration models of different precision to calibrate part of the original data, (spot) check whether the calibration results reported by the low-level calibration models are qualified, and realize the simple and efficient inspection of the received calibration results.

### DESCRIPTION OF DRAWINGS

In order to more clearly illustrate the technical solutions in the embodiments of the present disclosure, the following will briefly introduce the drawings that need to be used in the embodiments or related technical descriptions. It should be noted that the drawings in the following description are only the present disclosure. For some embodiments of the invention, those skilled in the art can also obtain other drawings according to these drawings without paying creative efforts.

FIG. 1 is a general architecture diagram of the Internet of Things provided by the present disclosure;

FIG. 1A is a composition diagram of the Internet of Things provided by the present disclosure;

FIG. 1B is a global relationship diagram of the Internet of Things provided by the present disclosure;

FIG. 1C is a communication network flow and system relationship diagram provided by the present disclosure;

FIG. 1D is an example diagram of an Internet of Things service flow provided by the present disclosure;

FIG. 1E is a schematic design diagram of a communication network in the Internet of Things provided by the present disclosure;

FIG. 1F is a schematic diagram of a communication link in the Internet of Things provided by the present disclosure;

FIG. 1-1 is a flow chart of low-power wide-area wireless IoT edge computing and fog computing technology provided by the present disclosure;

FIG. 1-2 is a schematic diagram of an application scenario of smart fire fight edge computing provided by the present disclosure;

1-3 are data flow charts of the edge computing gateway platform provided by the present disclosure;

FIGS. 1-4 are flow charts of edge computing data provided by the present disclosure;

FIG. 2-1 is a schematic diagram of communication between terminals provided by the present disclosure;

FIG. 2-2 is a schematic diagram of timing communication between terminals using different channels provided by the present disclosure;

FIG. 2-3 is a schematic diagram of wake-up communication of the terminal listening to the long data packet header provided by the present disclosure;

2-4 are schematic diagrams of the control of transmit power and reception sensitivity between terminals provided by the present disclosure;

FIG. 3-1 and FIG. 3-2 are related schematic diagrams (1 to 2) of the invention points of the Internet of Things terminal power consumption control provided by the present disclosure;

FIG. 4-1 is a schematic diagram of a highly configurable edge computing framework provided by the present disclosure:

FIG. 4-2 is a schematic diagram of an edge computing decision-making loop provided by the present disclosure;

FIG. 5-1 is a flow chart of an embodiment of a method for calibrating a sensor based on deep learning according to the present disclosure provided by the present disclosure;

FIG. 5-2 is a schematic diagram of hierarchical deployment of the original model provided by the present disclosure after different processing:

FIG. 5-3 is a sensor network topology diagram provided by the present disclosure;

FIG. 5-4 is a flow chart of training the original model from the Transformer model provided by the present disclosure:

FIG. 5-5 is the flow chart of the multi-level cooperative calibration of the calibration method of the sensor based on deep learning according to the present disclosure provided by the present disclosure;

5-6 are Flow Charts of Retraining the Updated Original Model Provided by the Present Disclosure; 5-7 are Schematic Diagrams of the Relationship Between Temperature and Humidity Learned by the Transformer Model Provided by the Present Disclosure;

5-8 are structural block diagrams of a sensor calibration system based on deep learning according to the present disclosure provided by the present disclosure, 5-9 are structural block diagrams of a compression optimization device 940 provided by the present disclosure;

5-10 are structural block diagrams of a calibration device 950 provided by the present disclosure; 5-11 are flowcharts of an exemplary application of the deep learning-based calibration method provided by the present disclosure to the same type of sensor calibration;

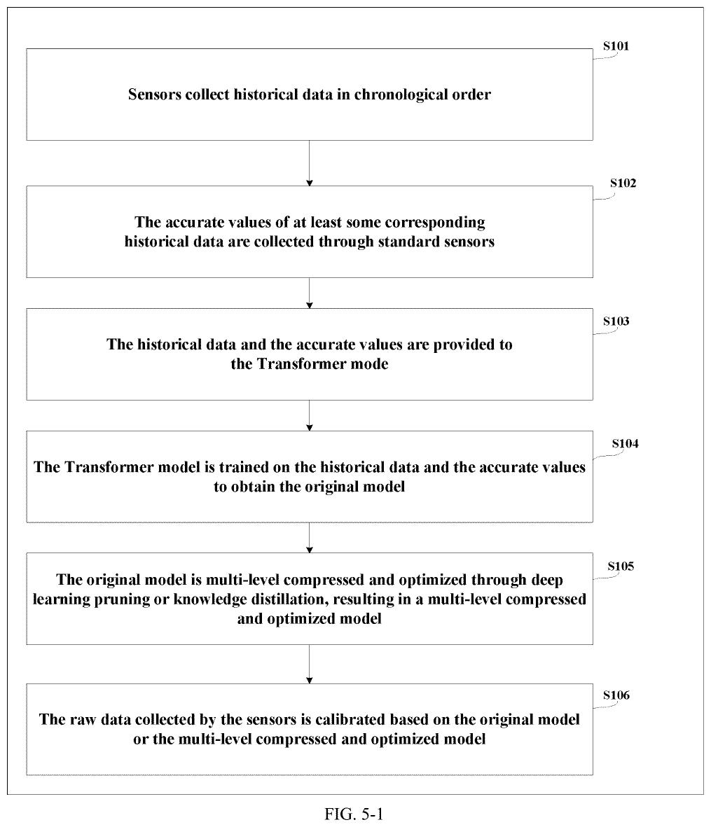

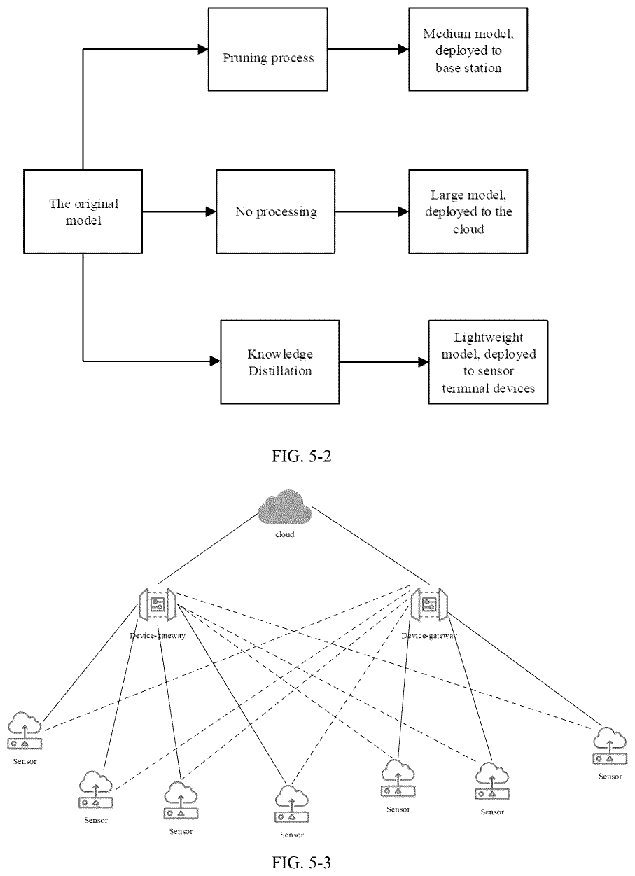

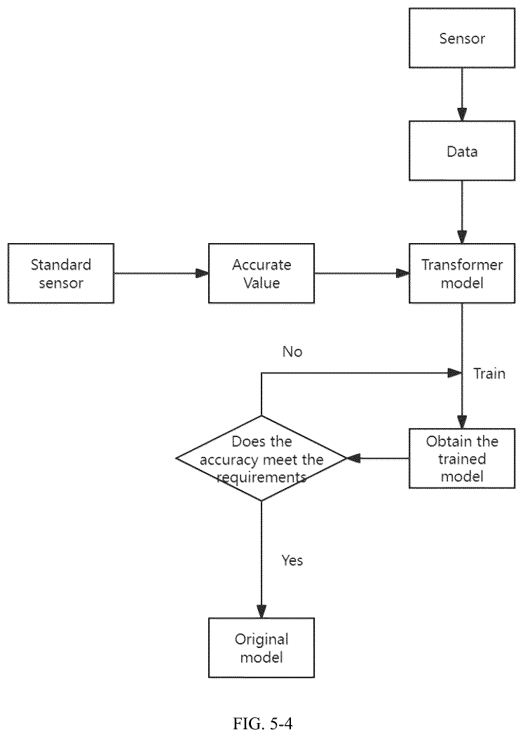

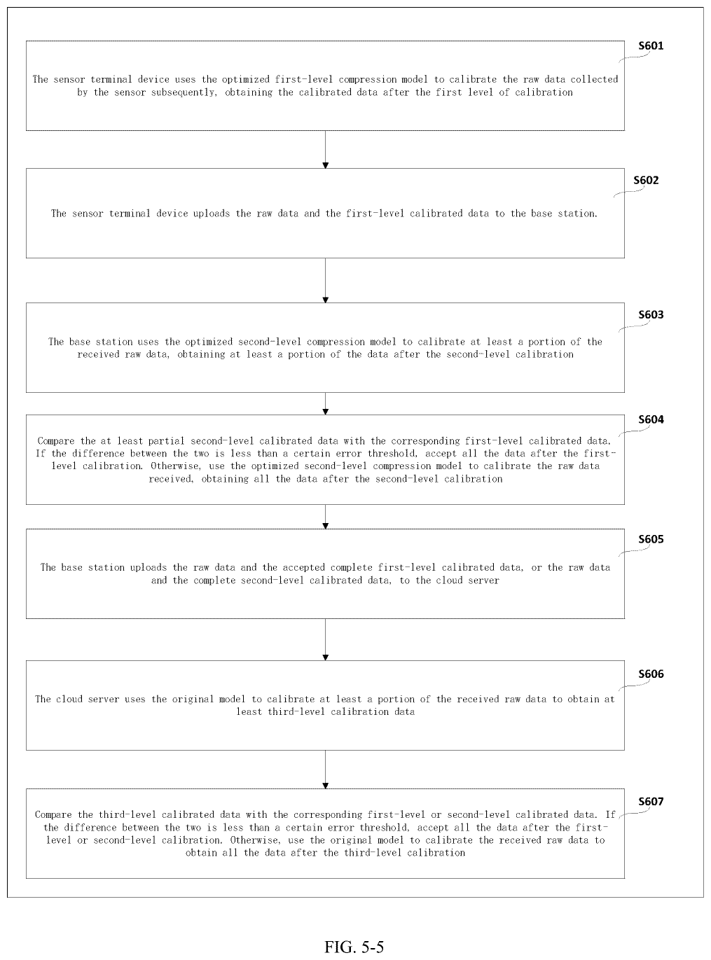

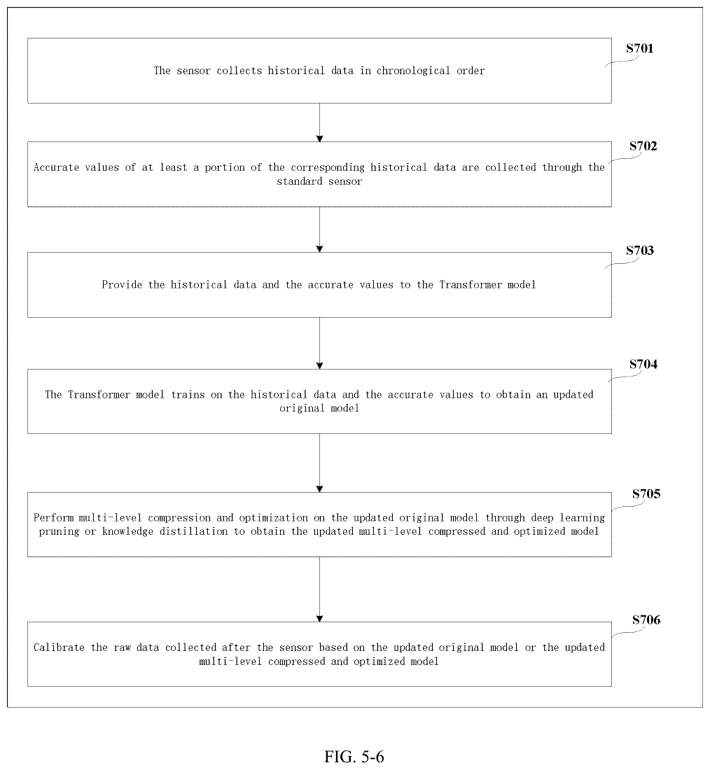

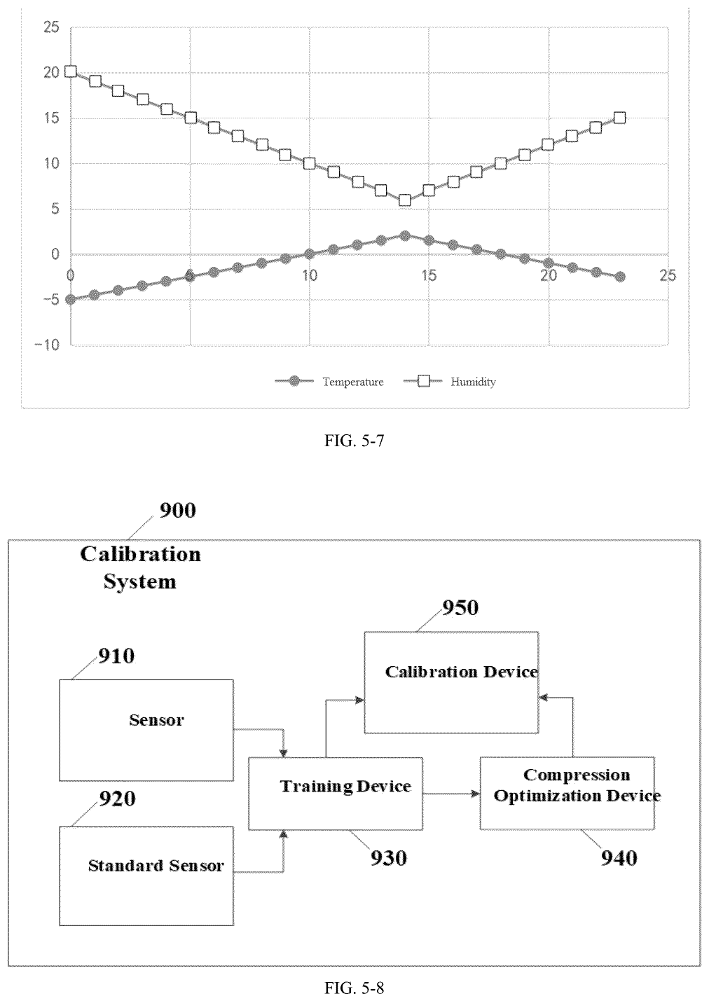

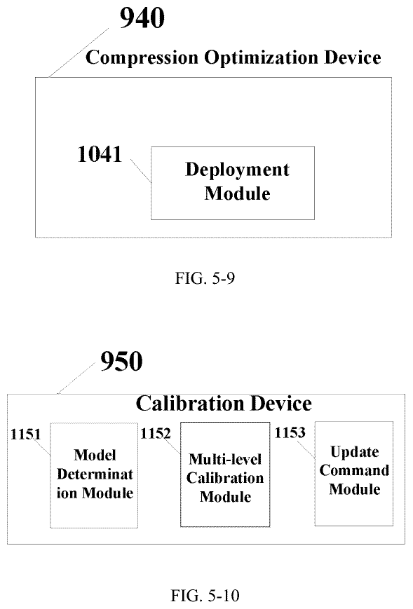

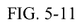

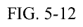

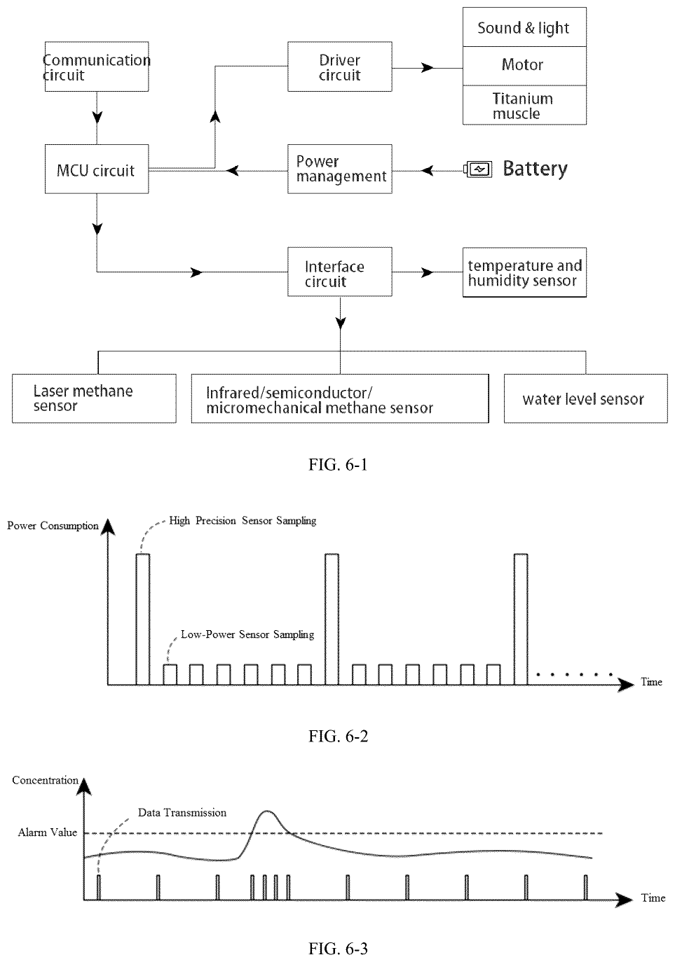

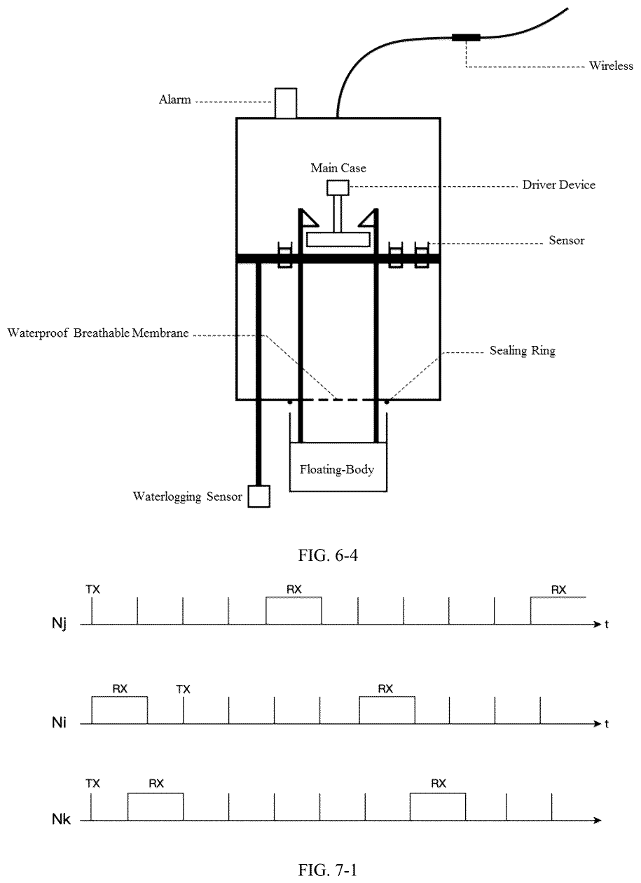

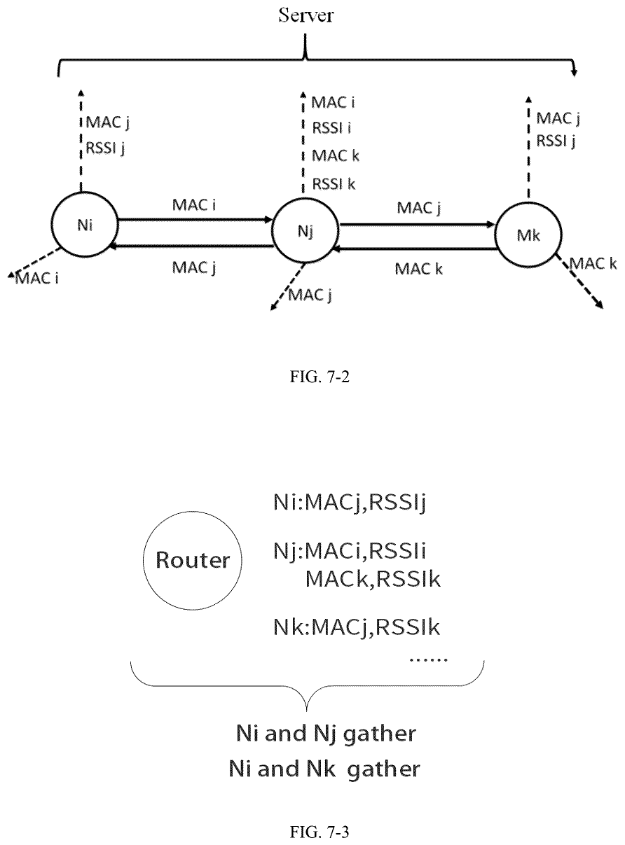

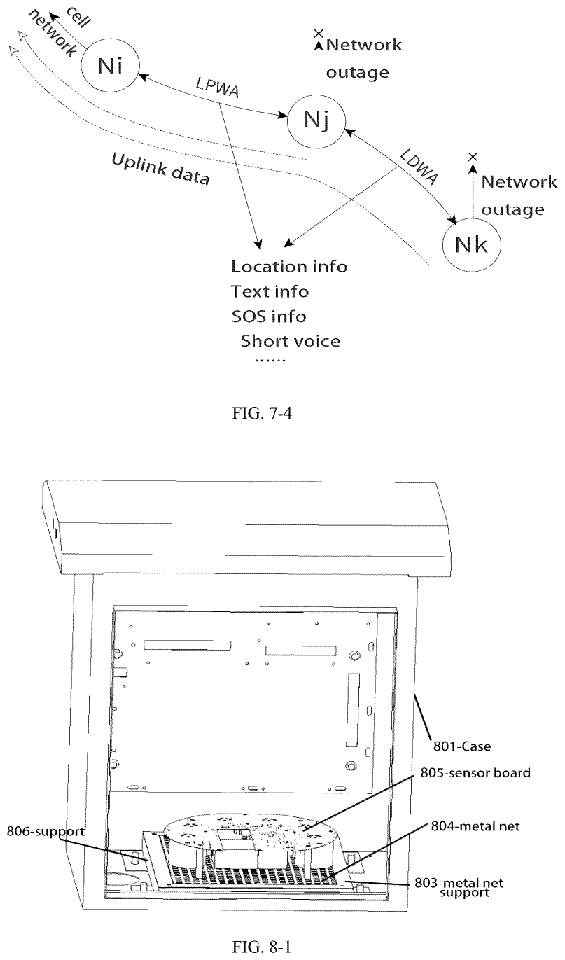

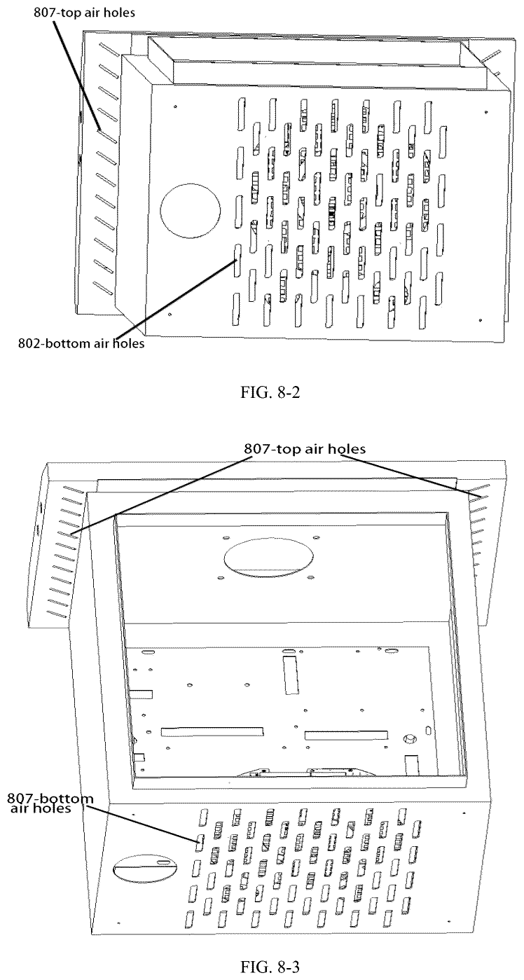

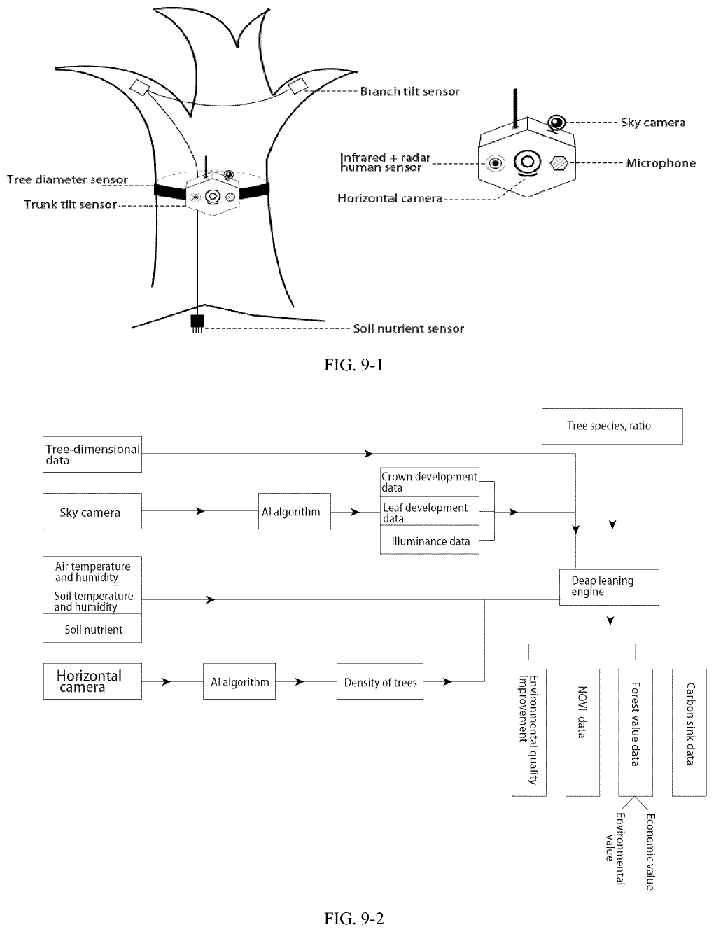

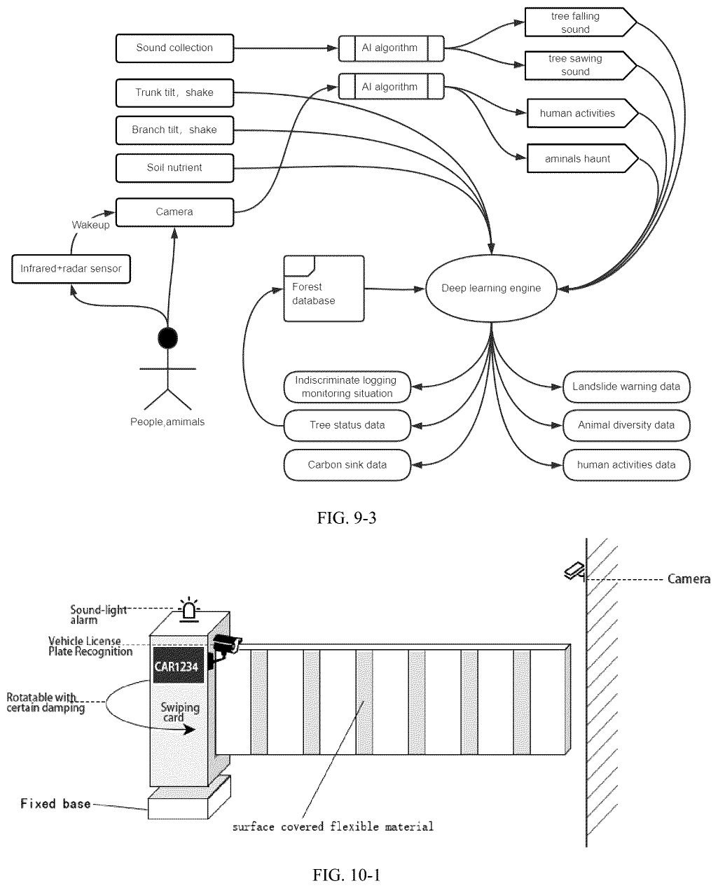

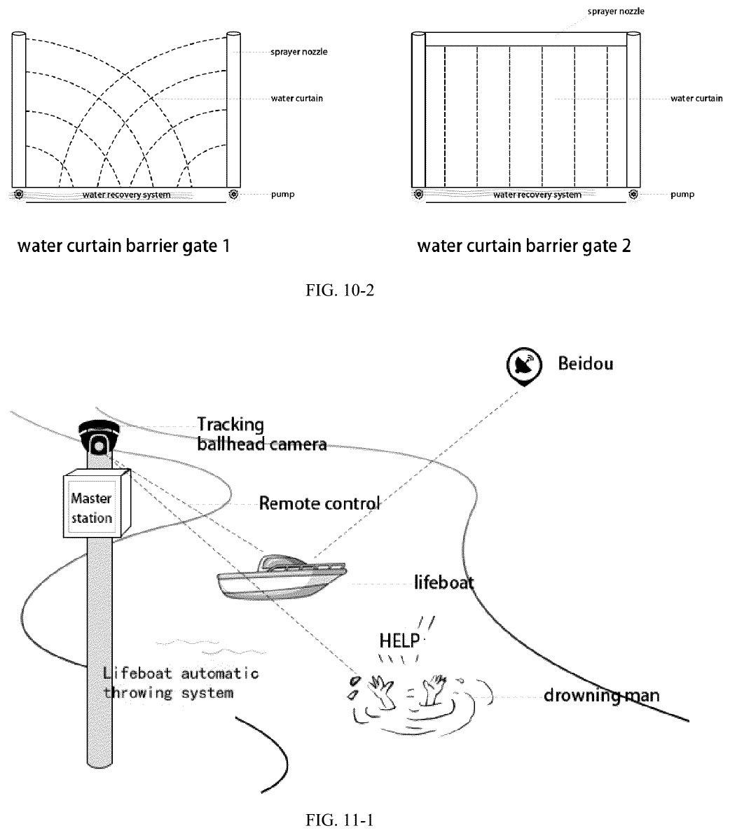

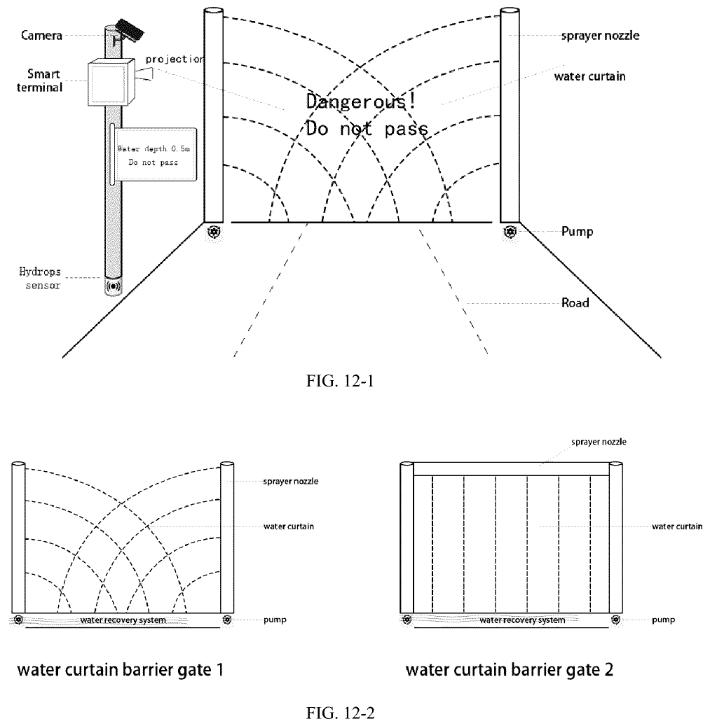

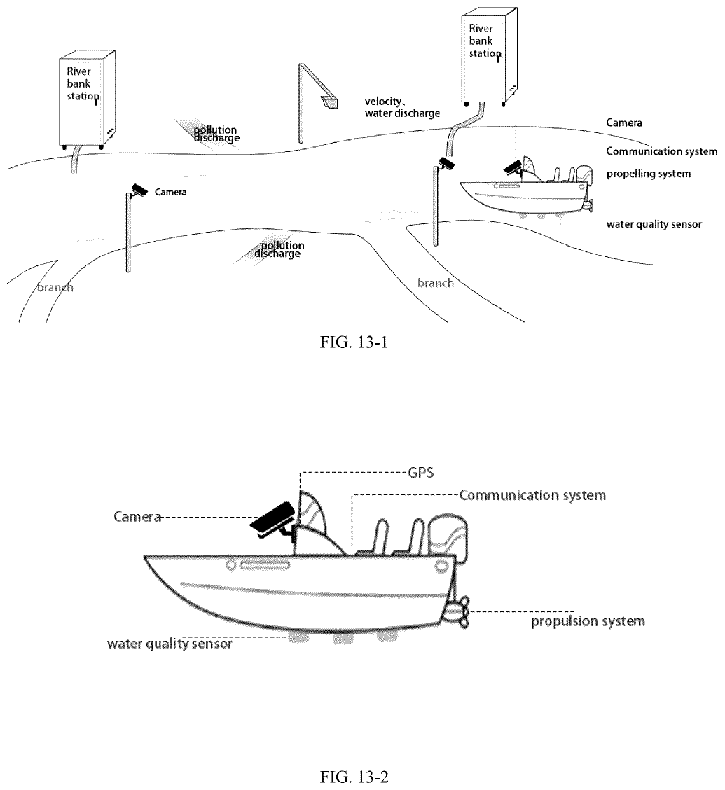

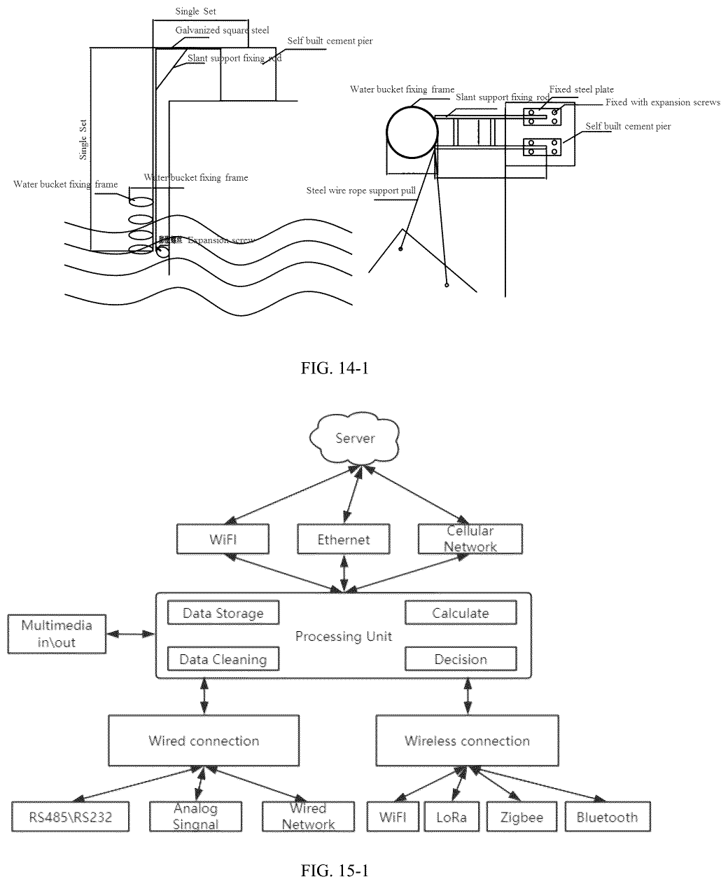

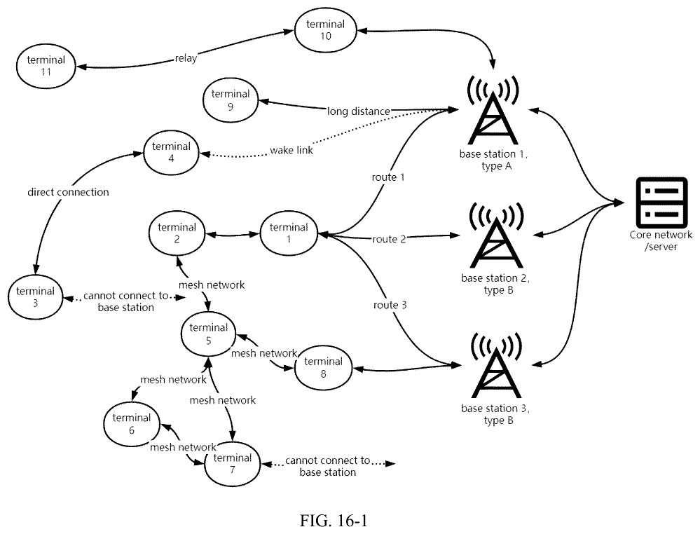

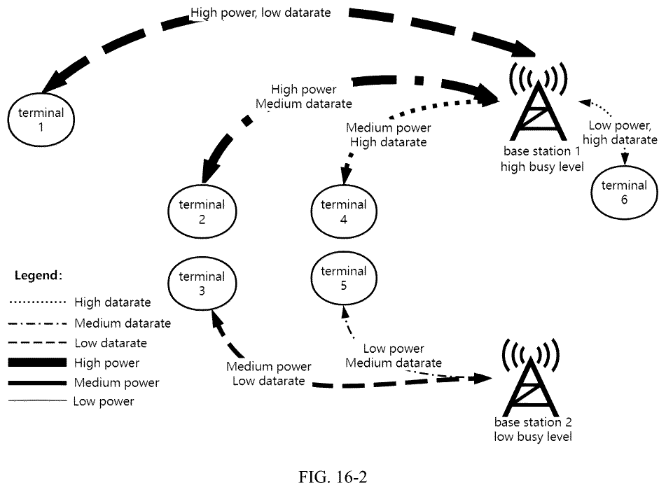

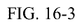

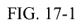

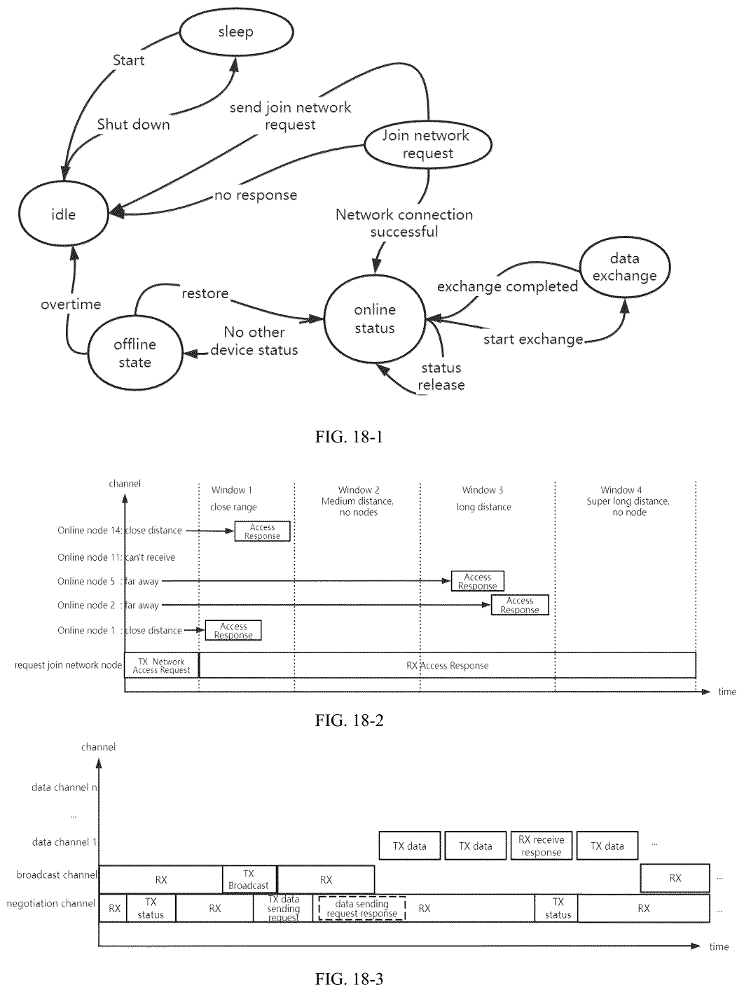

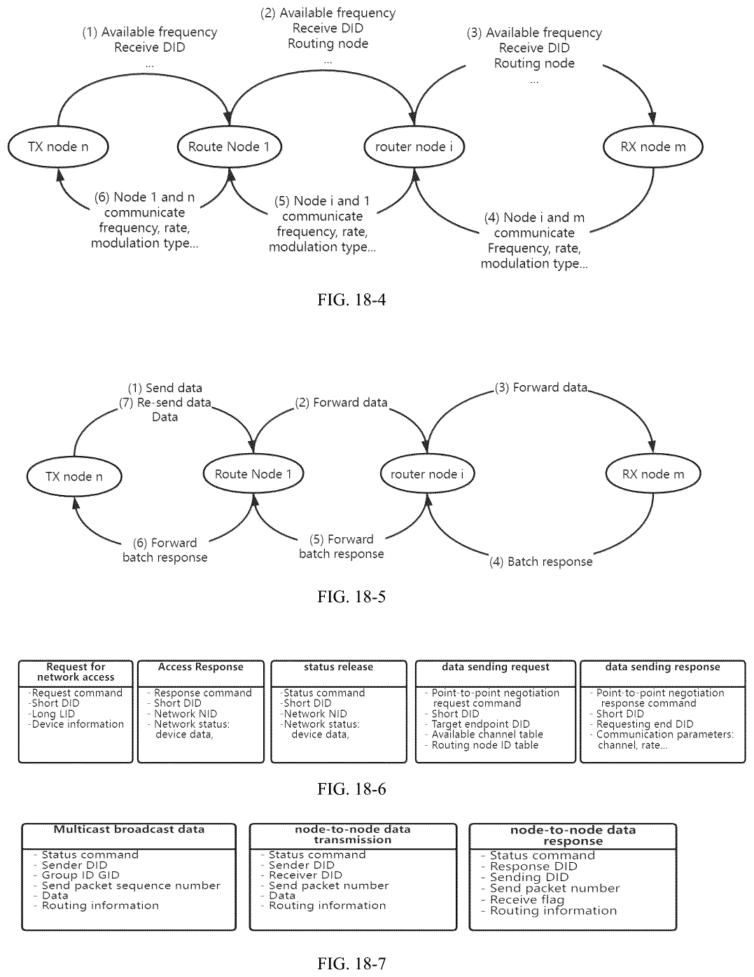

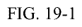

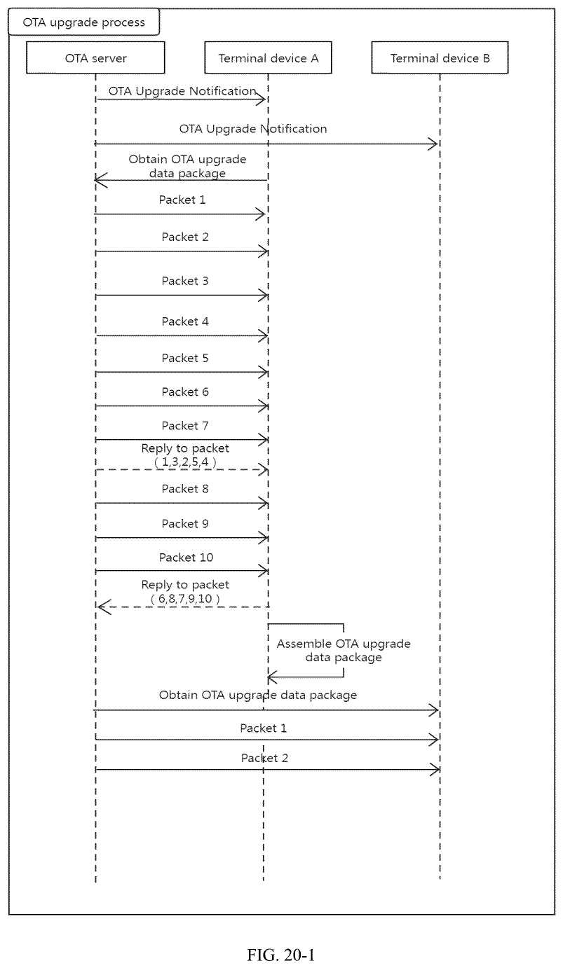

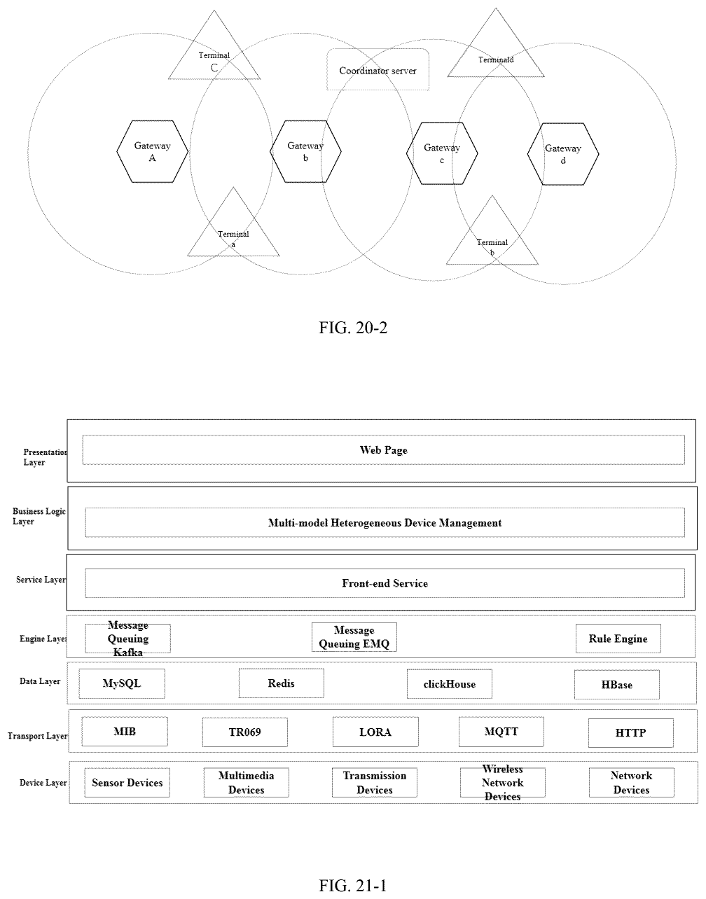

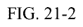

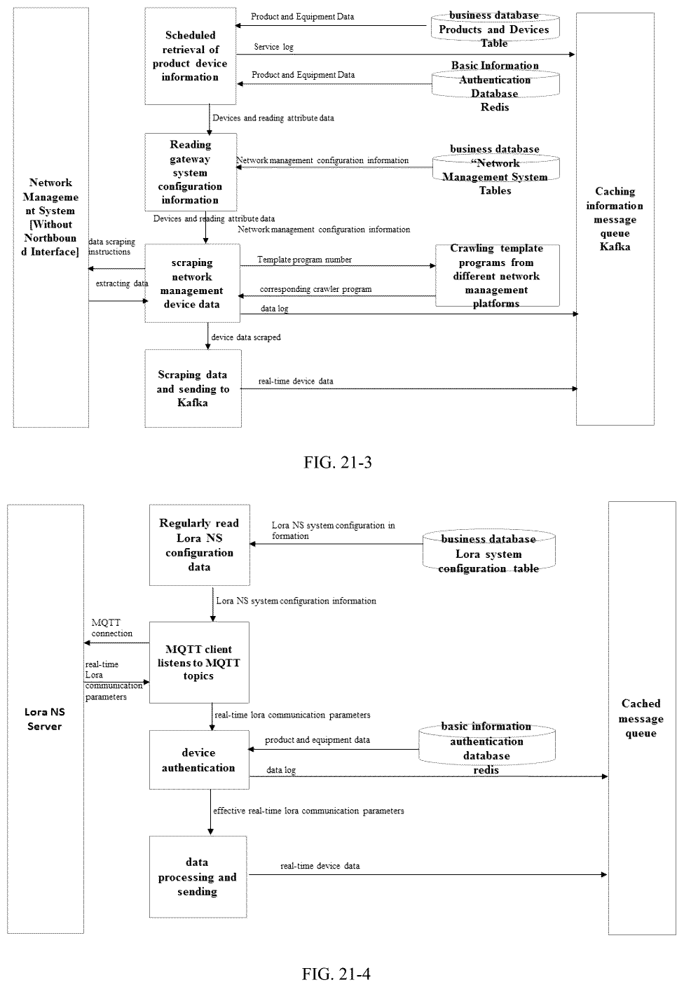

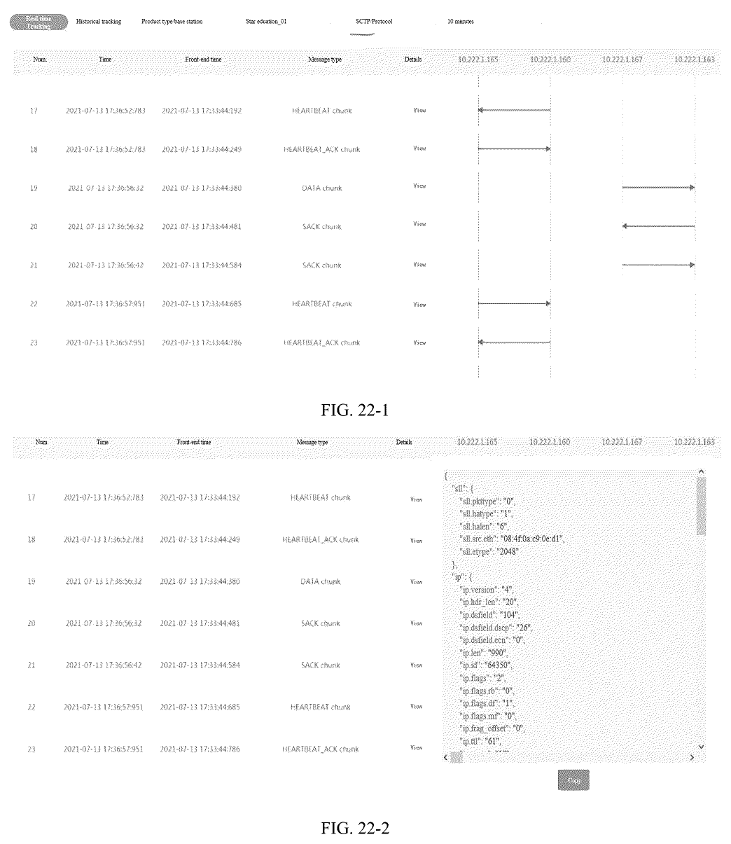

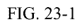

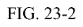

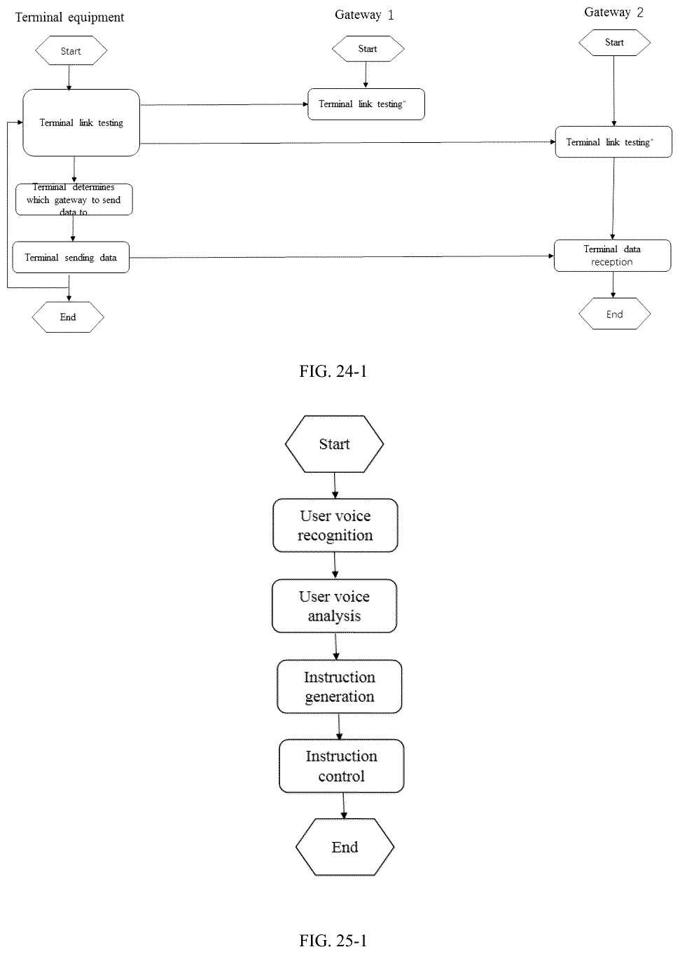

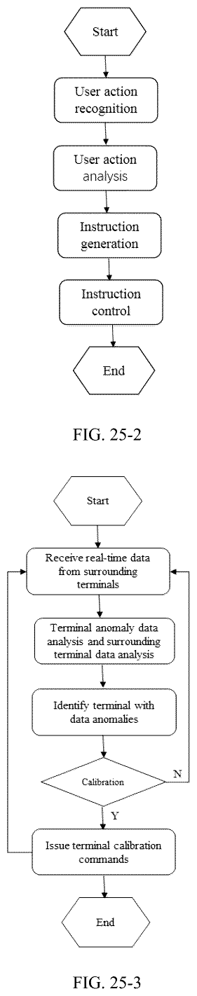

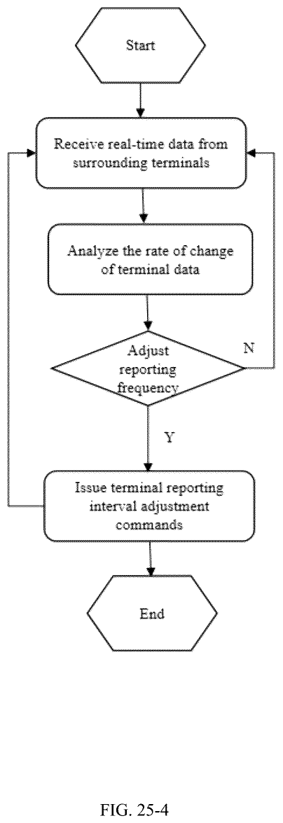

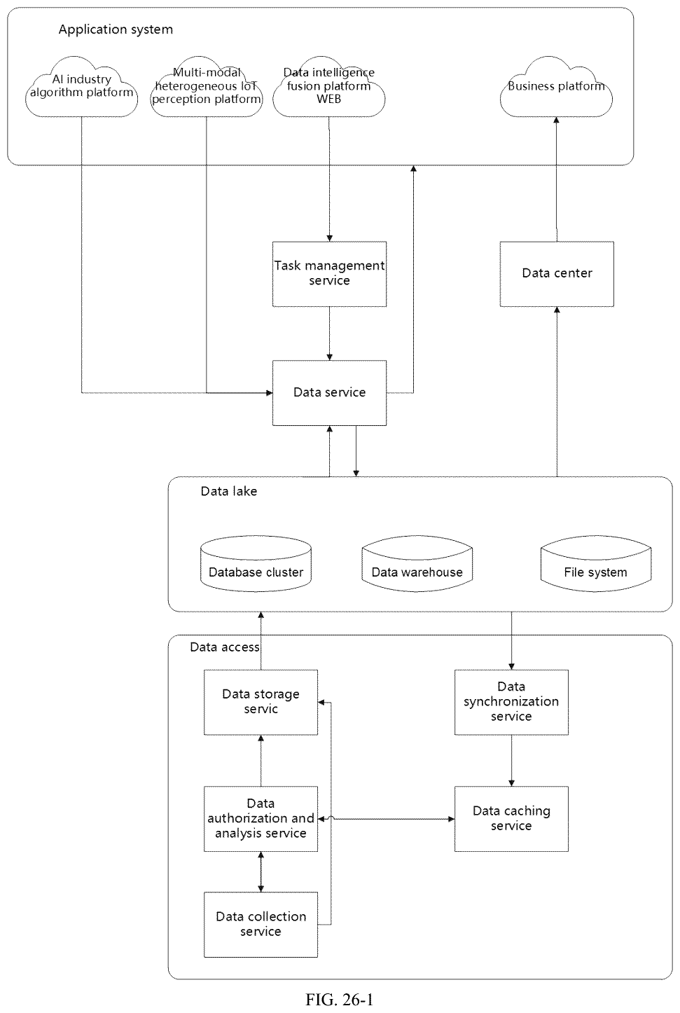

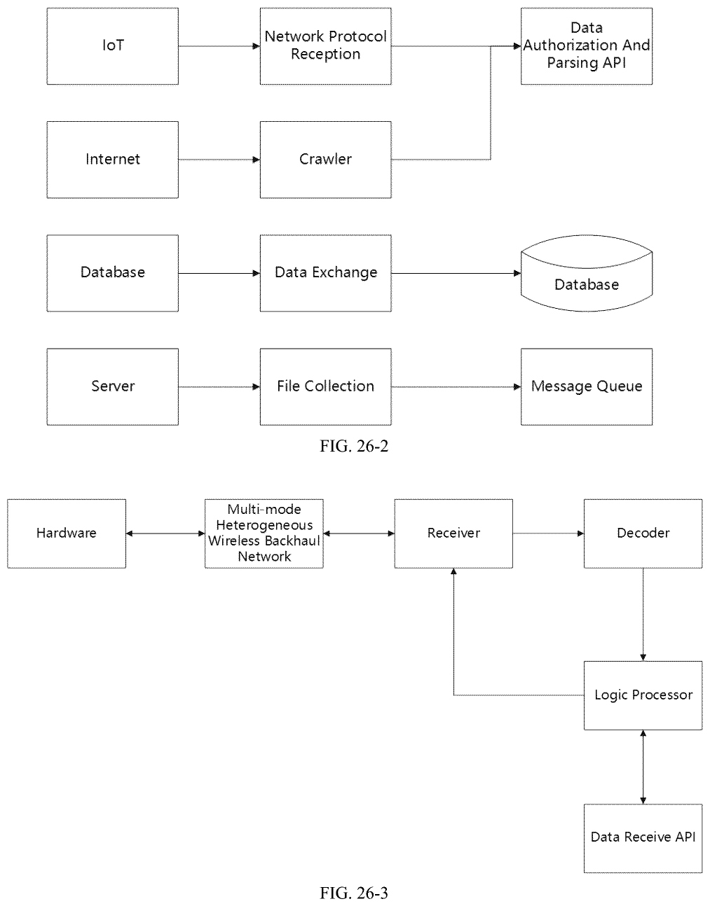

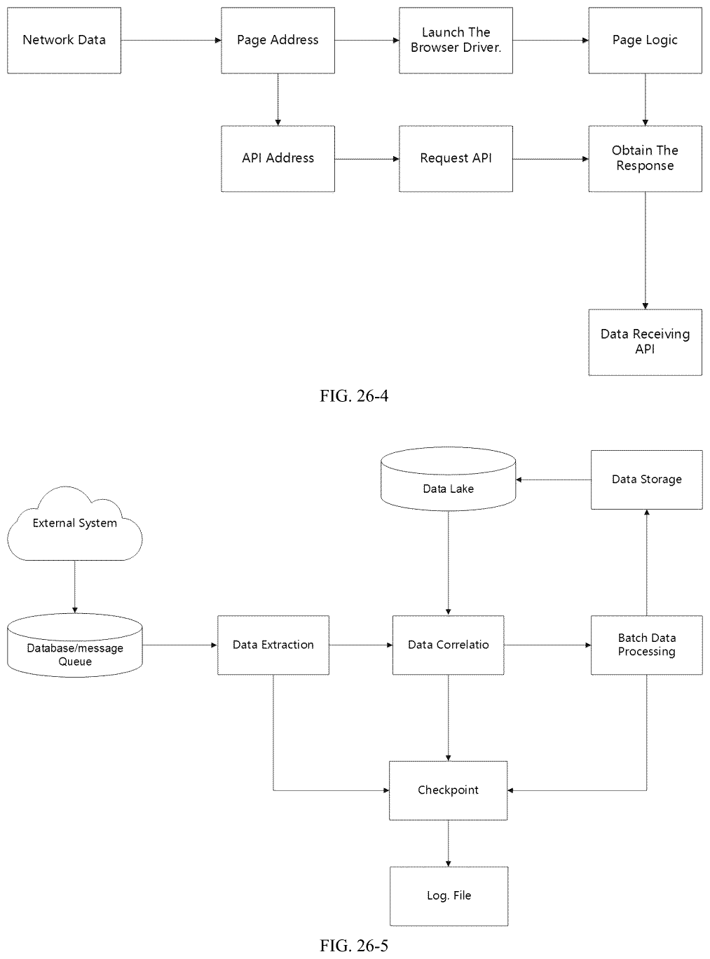

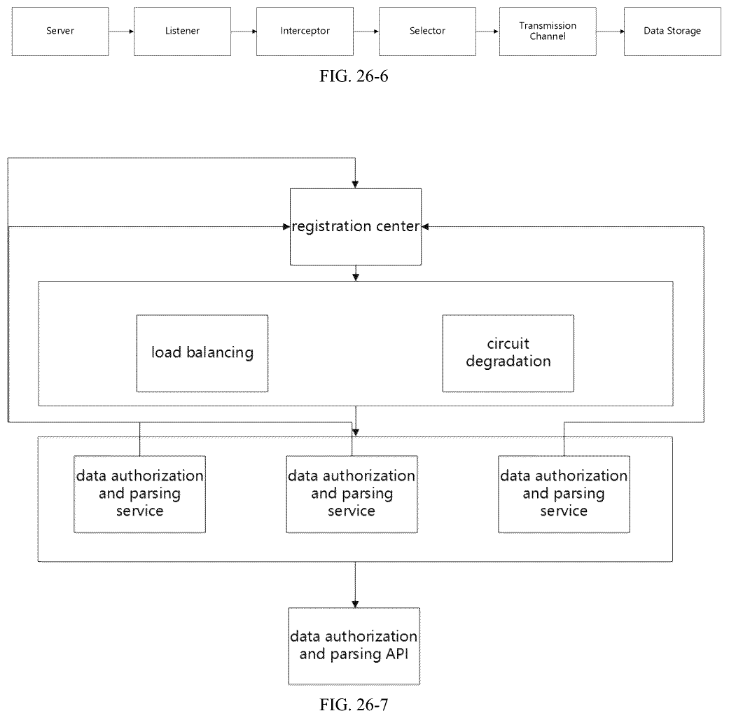

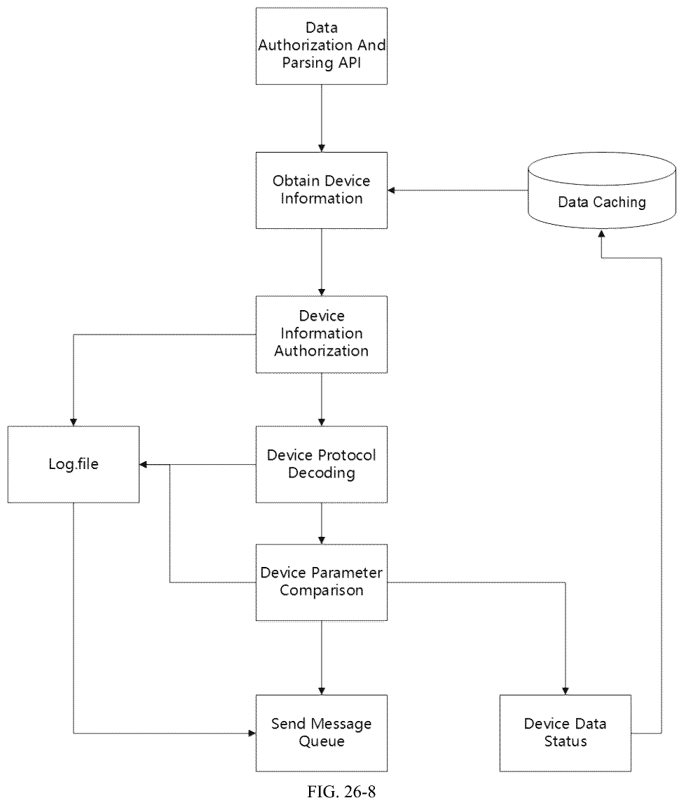

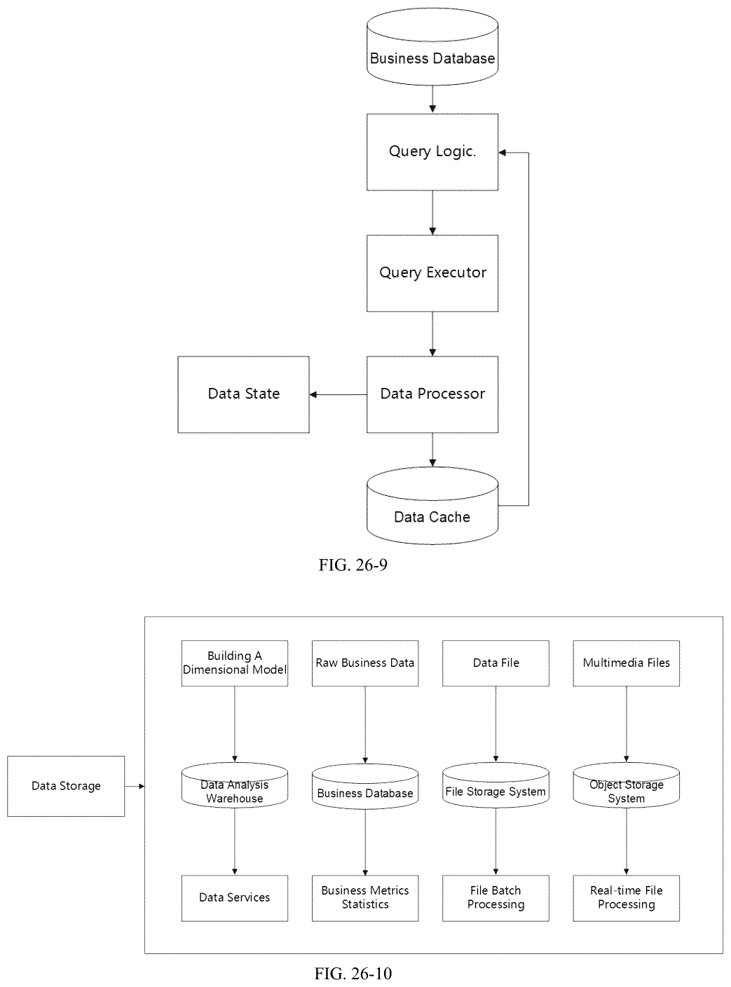

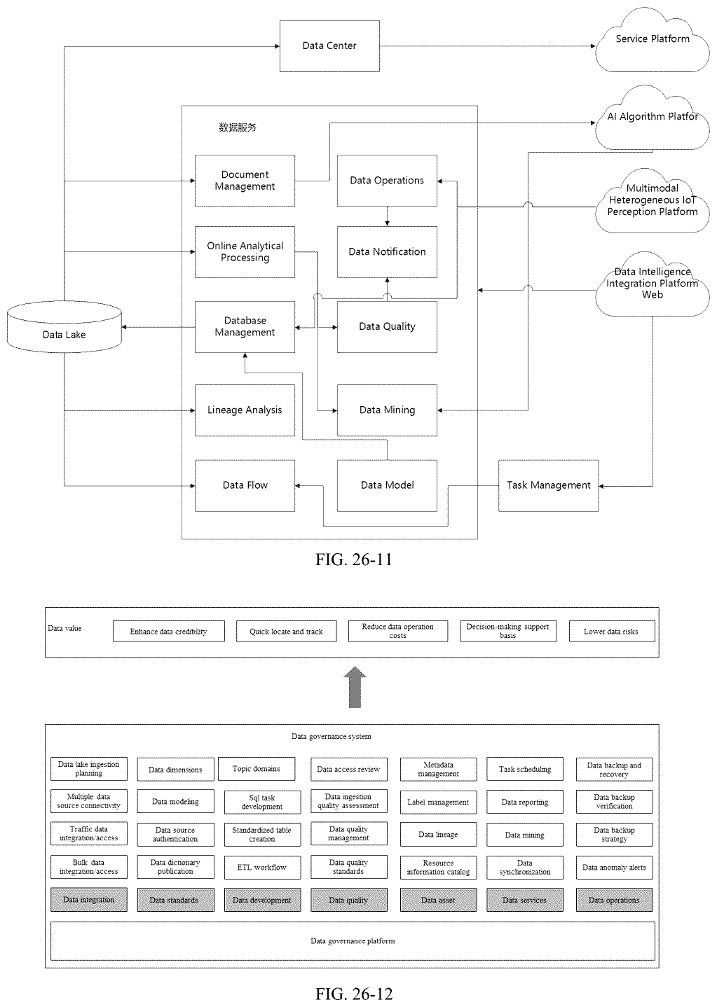

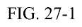

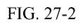

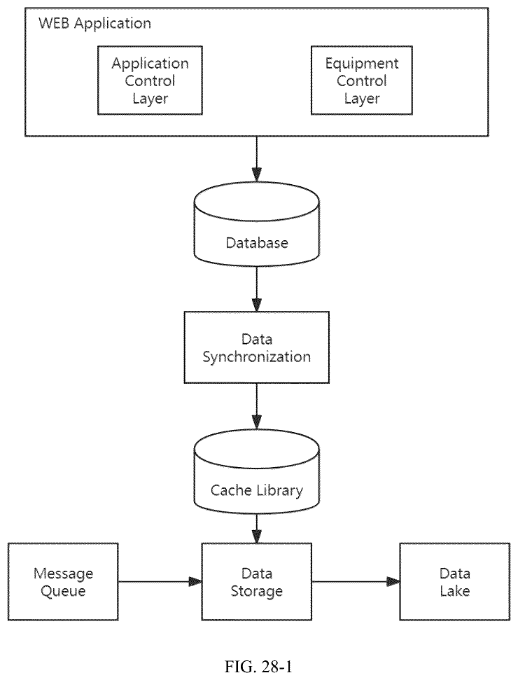

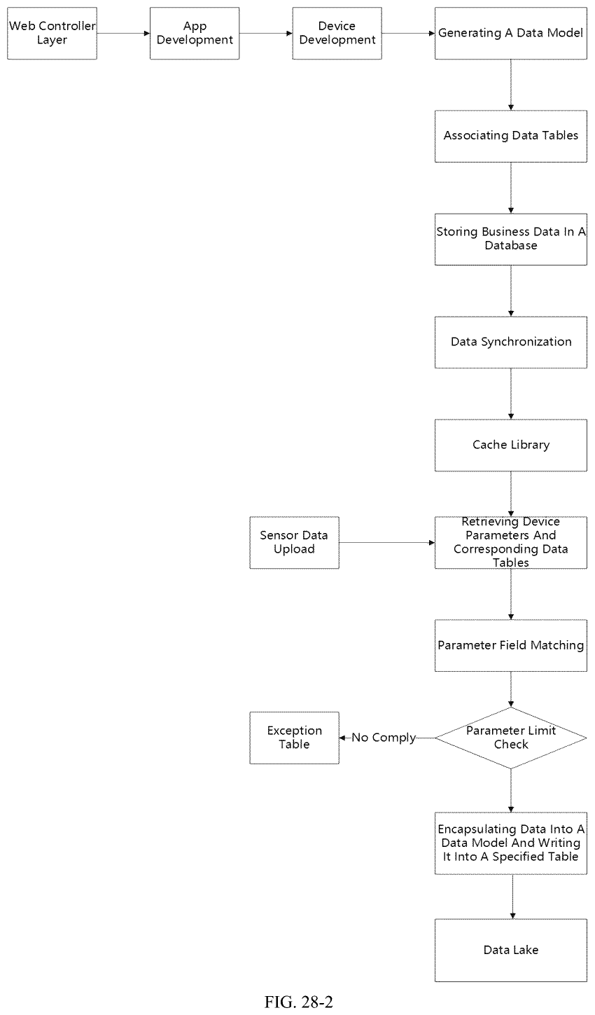

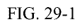

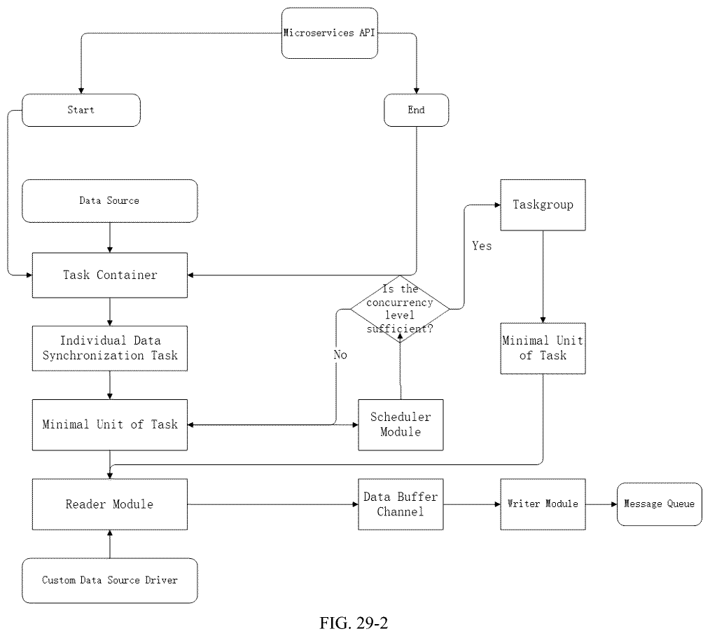

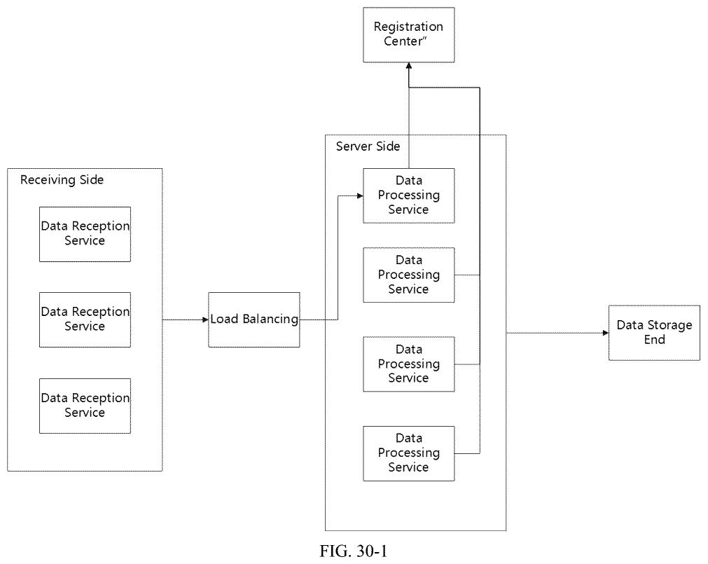

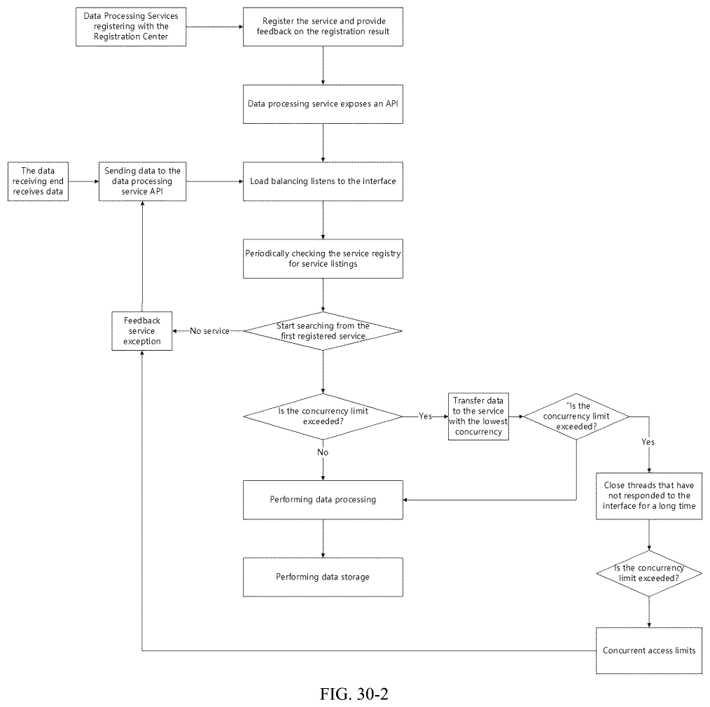

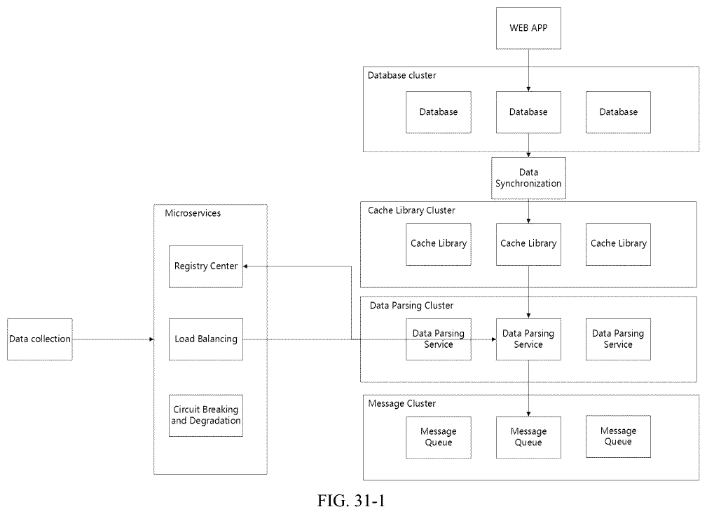

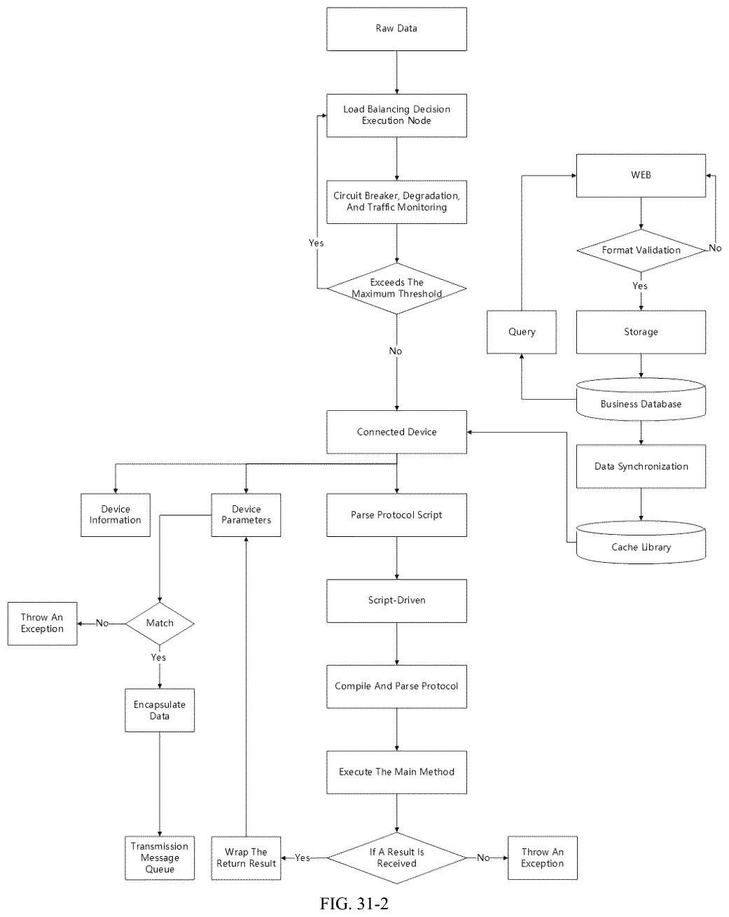

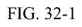

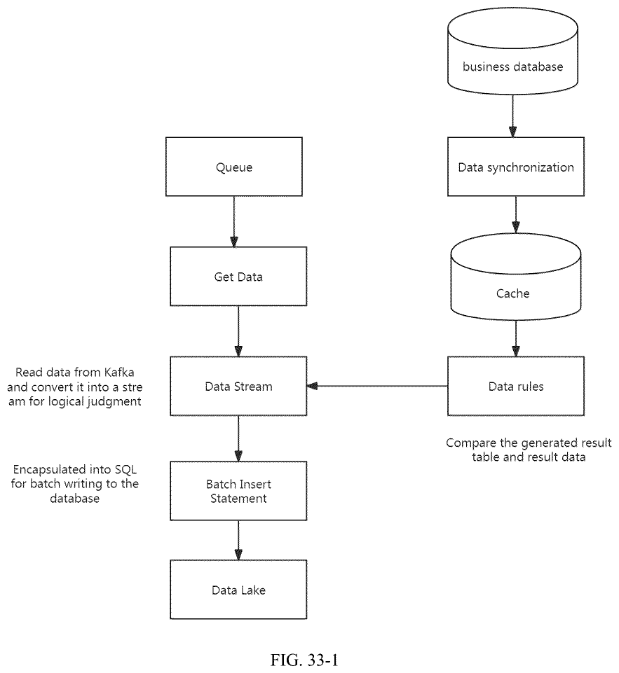

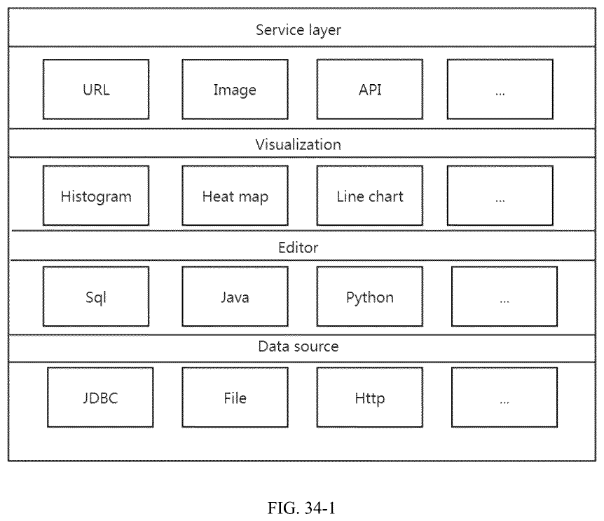

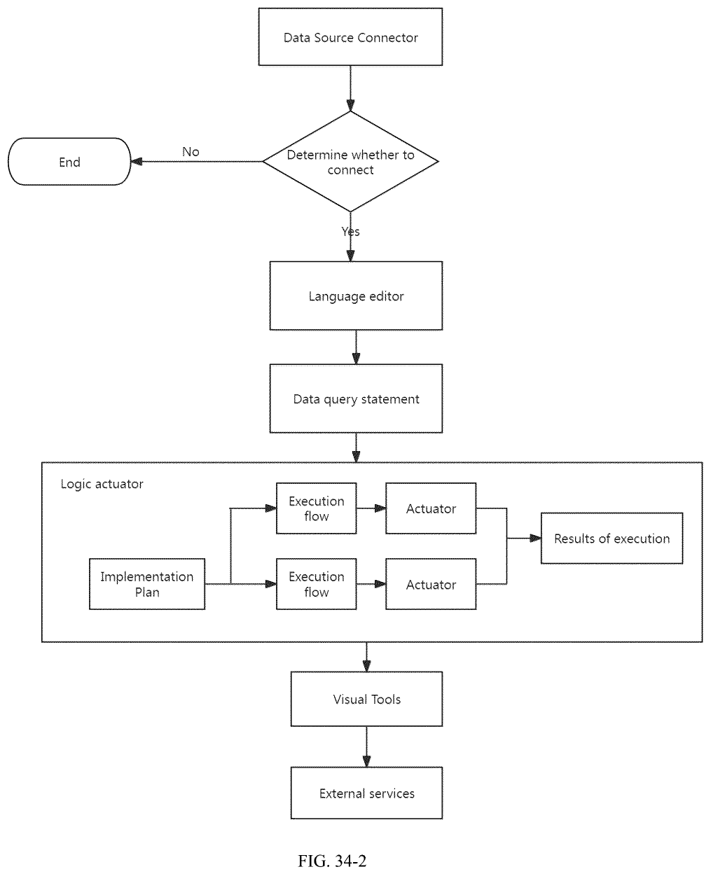

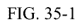

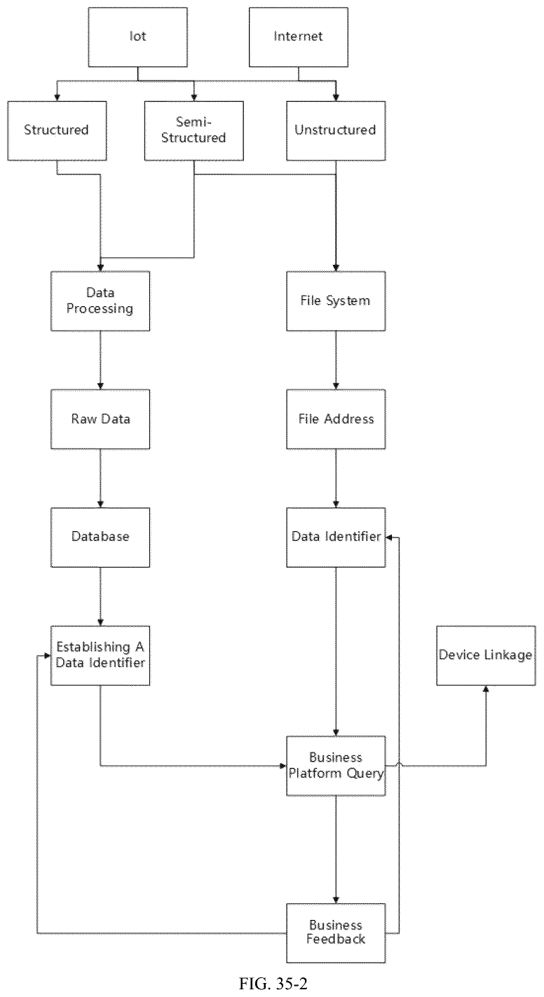

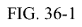

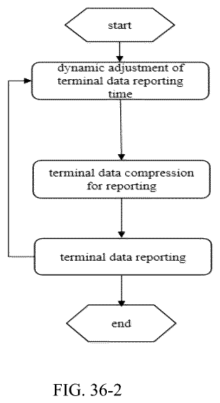

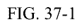

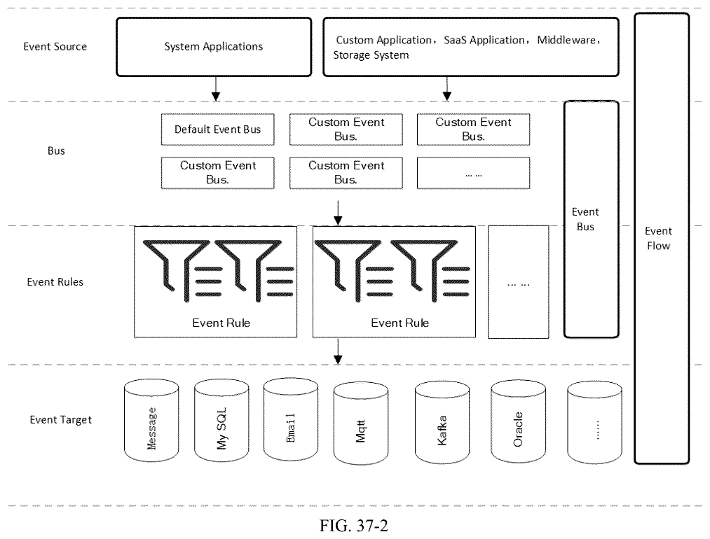

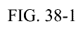

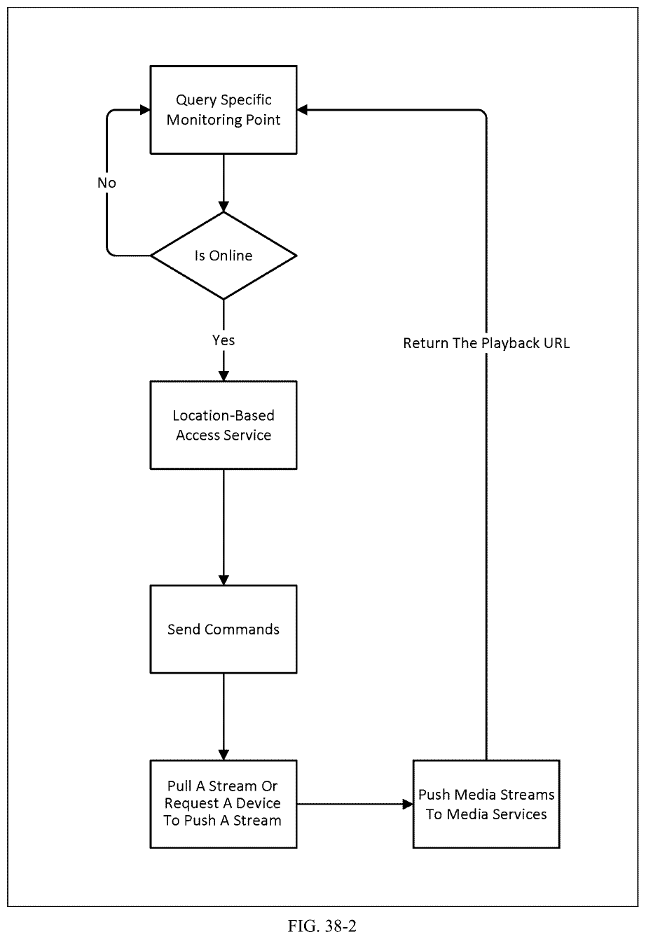

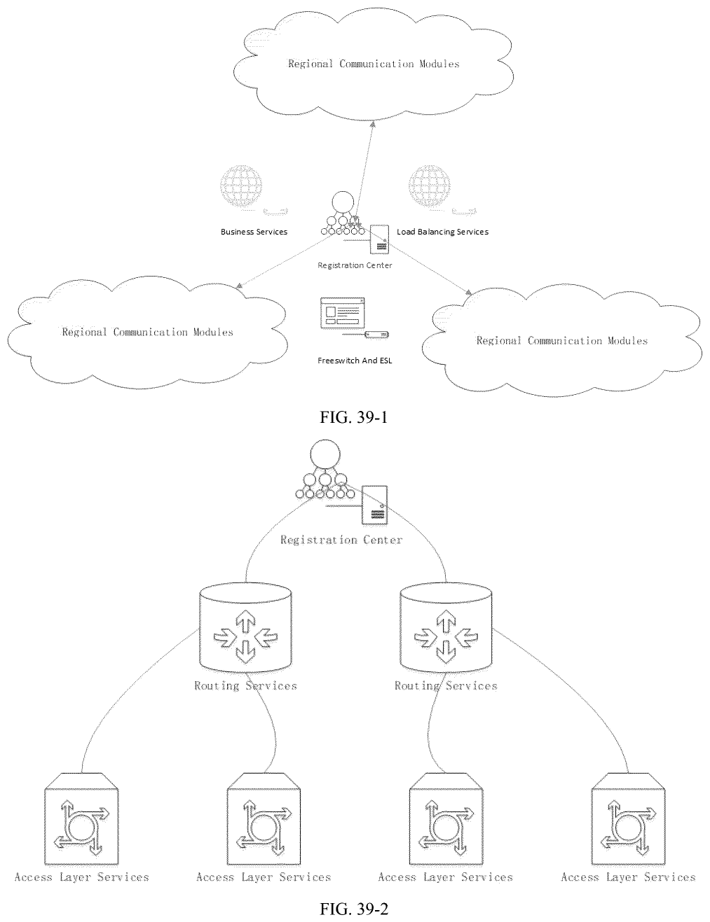

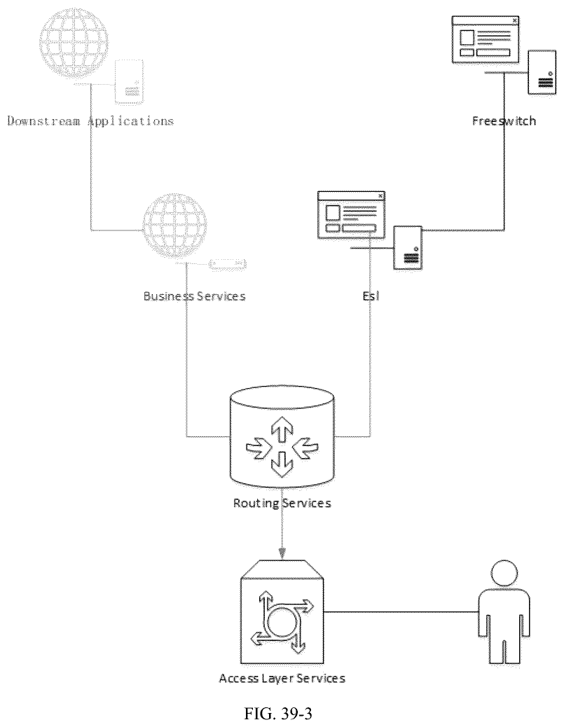

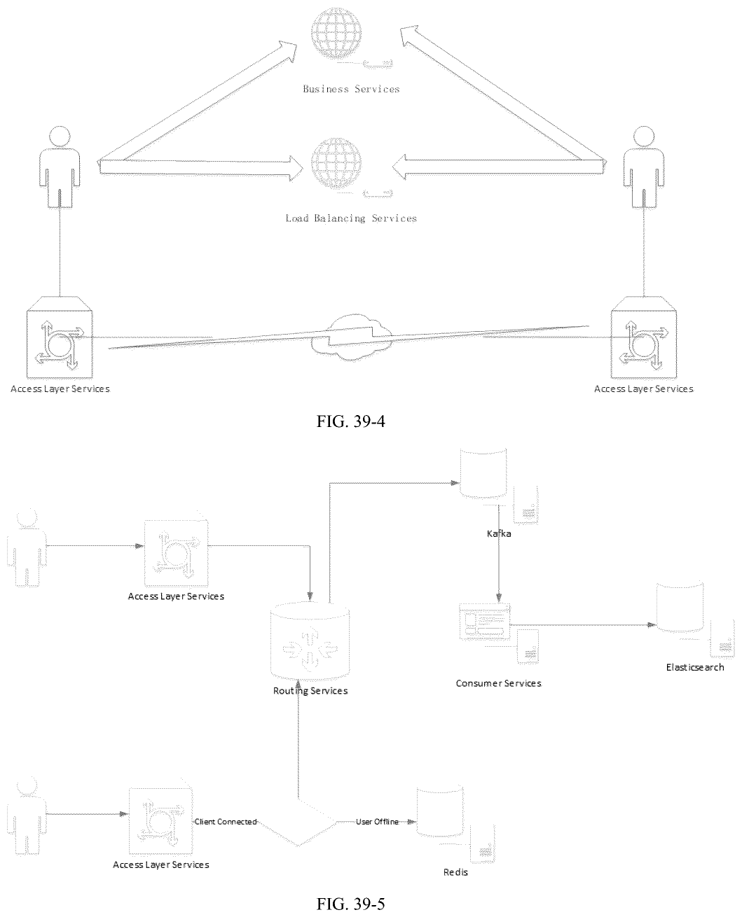

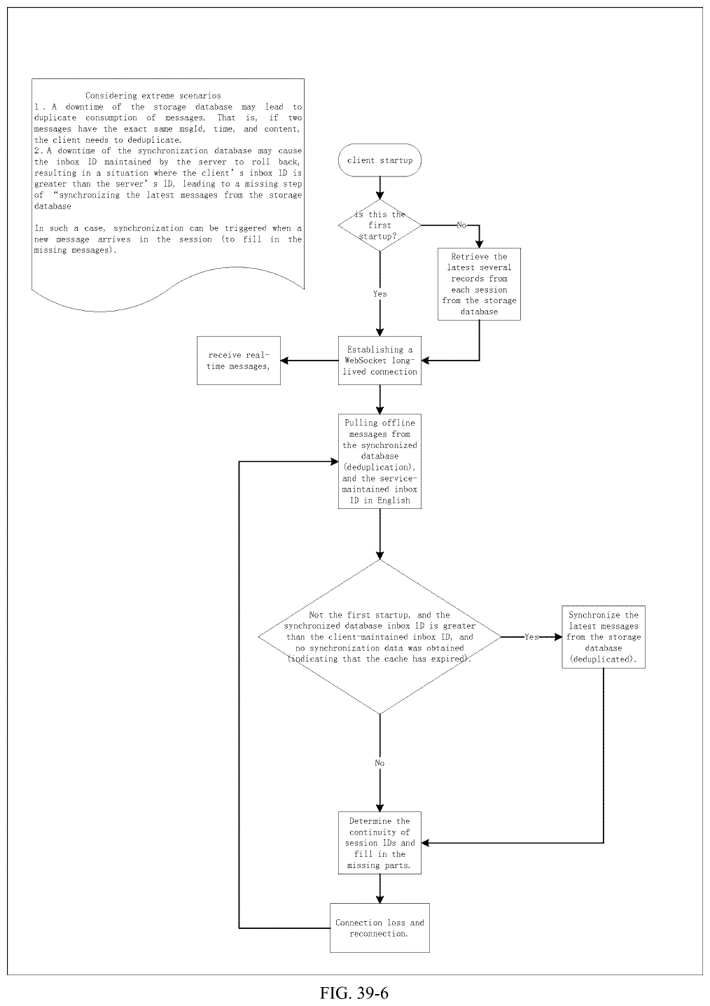

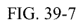

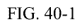

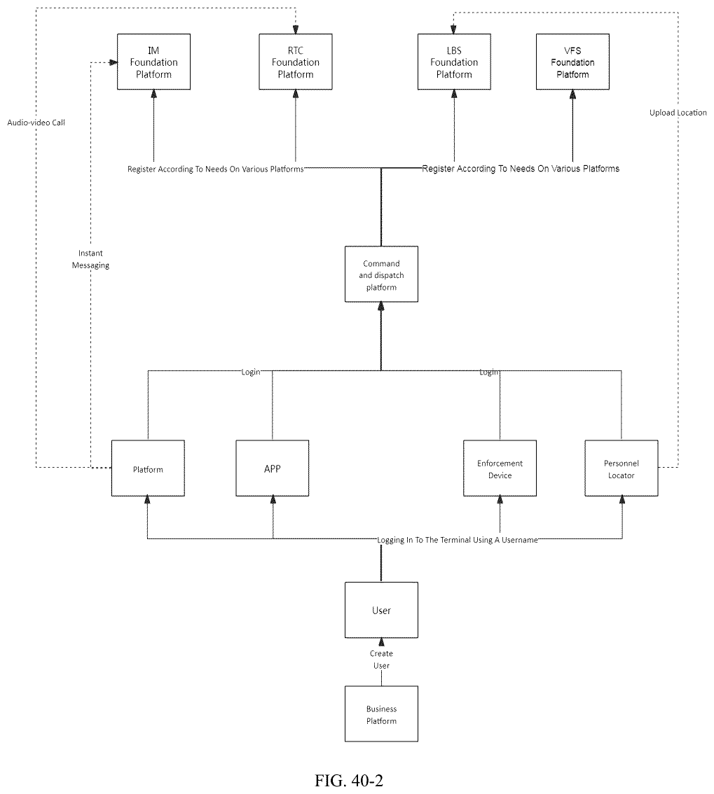

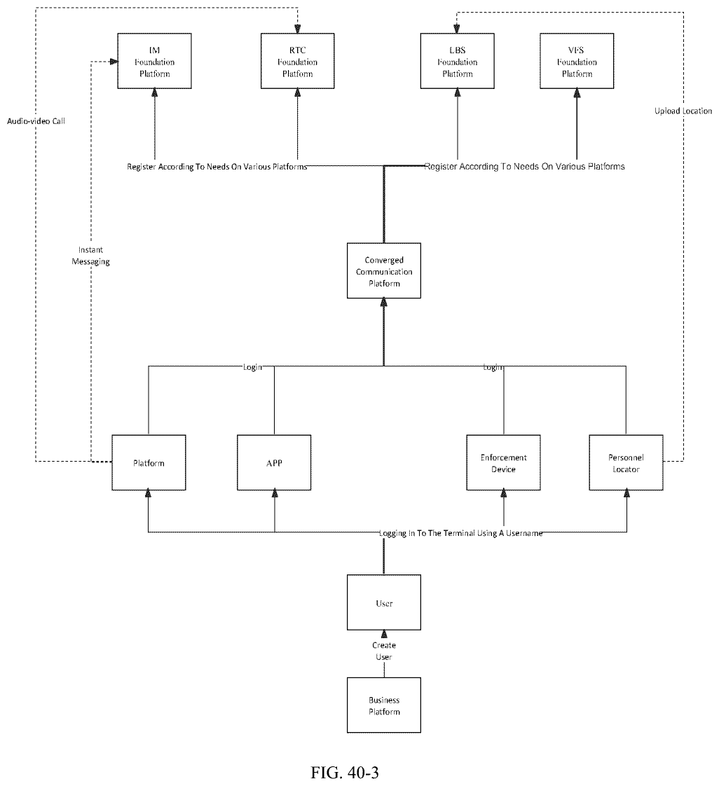

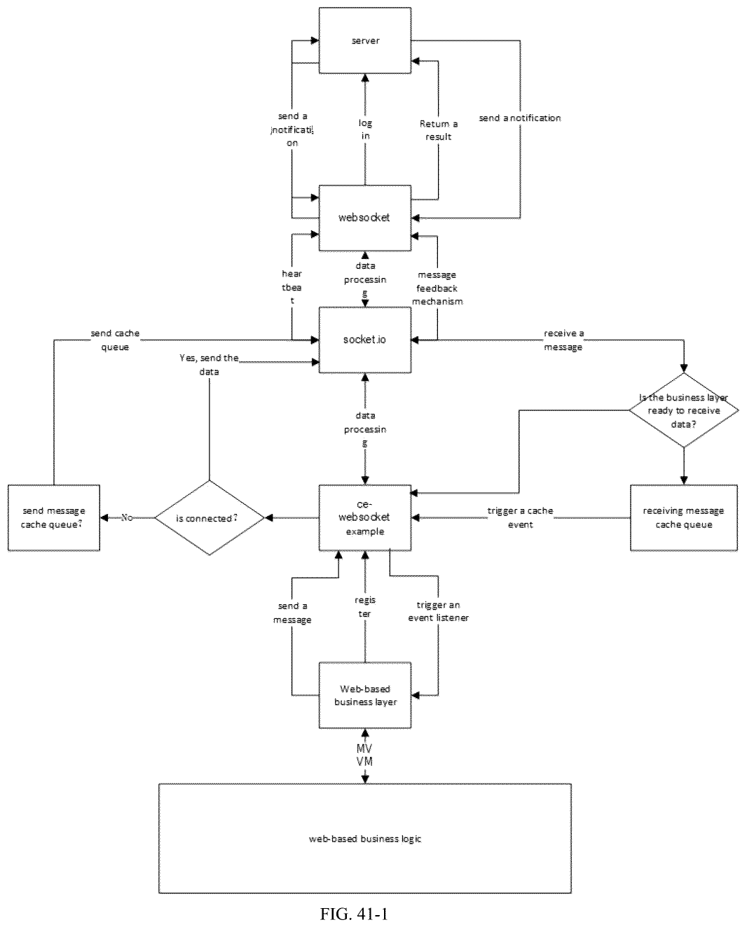

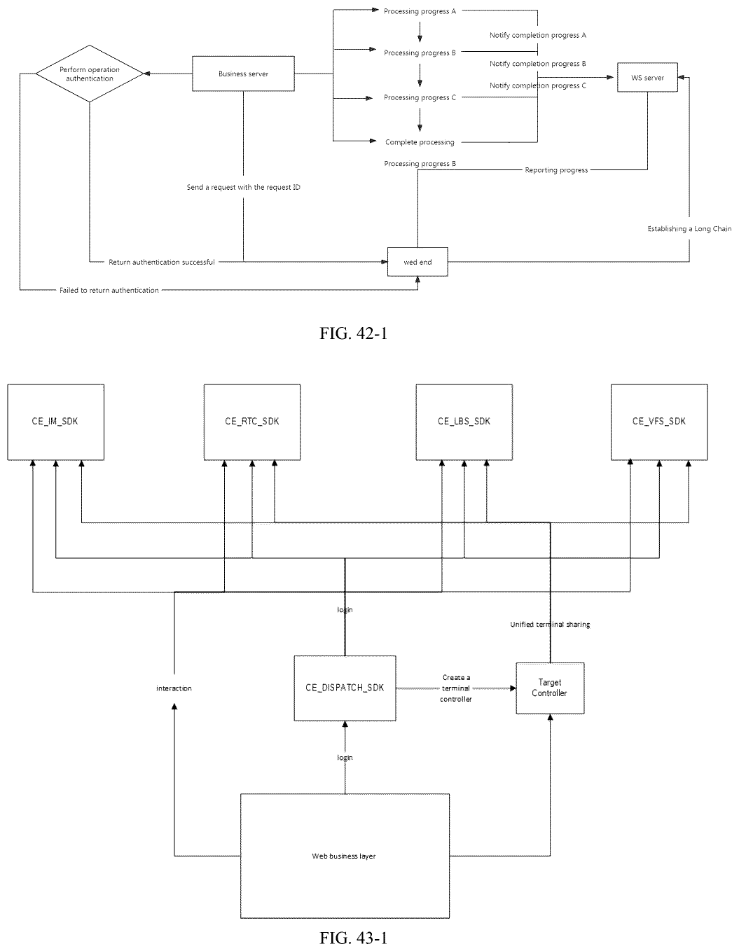

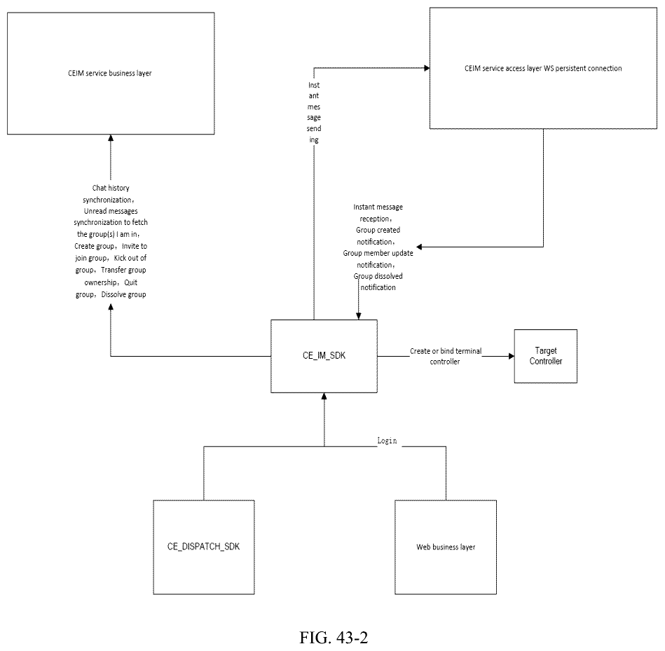

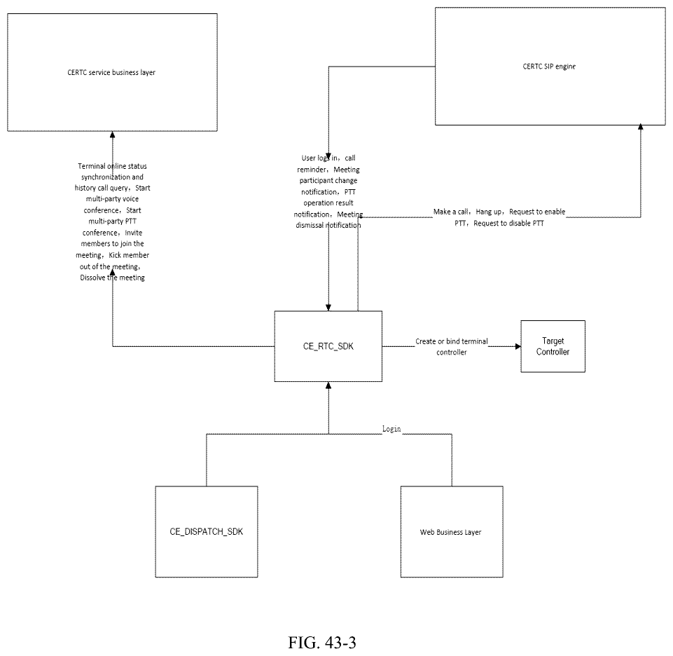

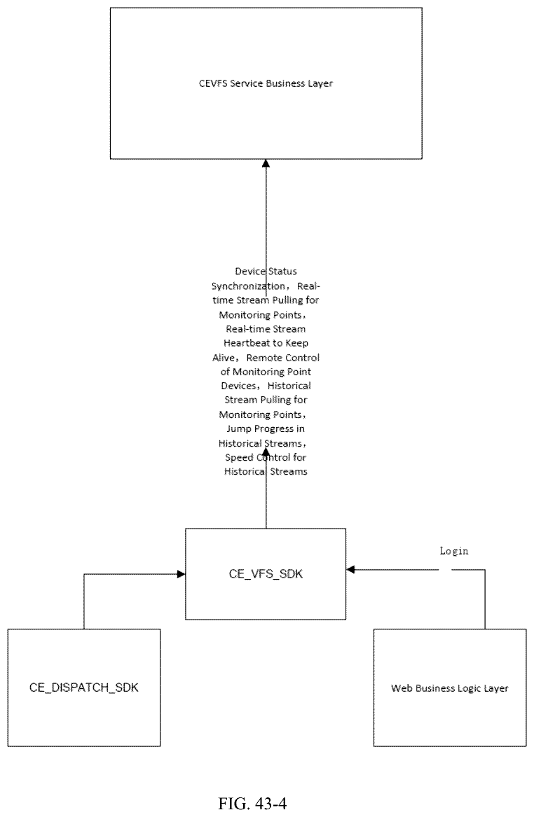

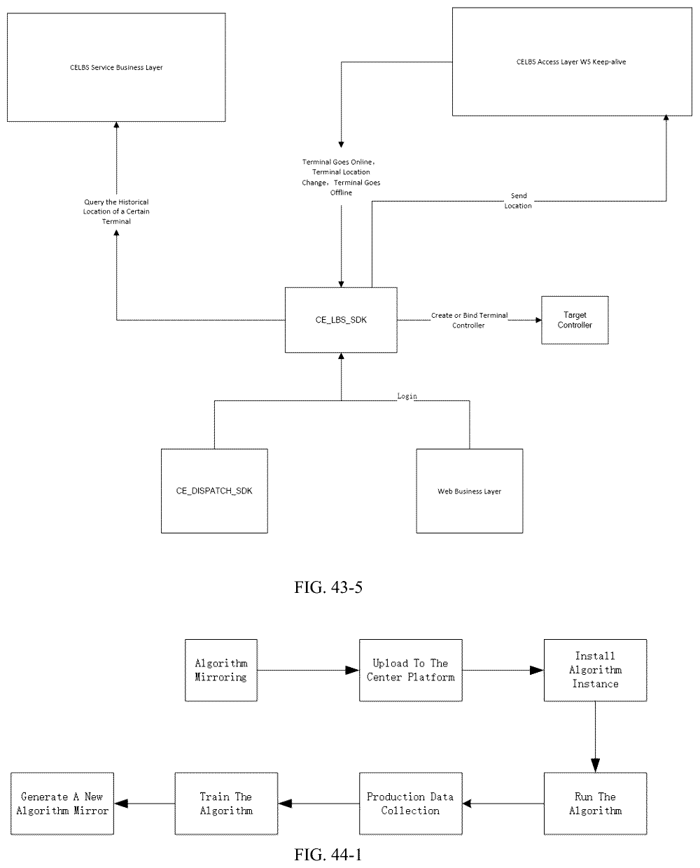

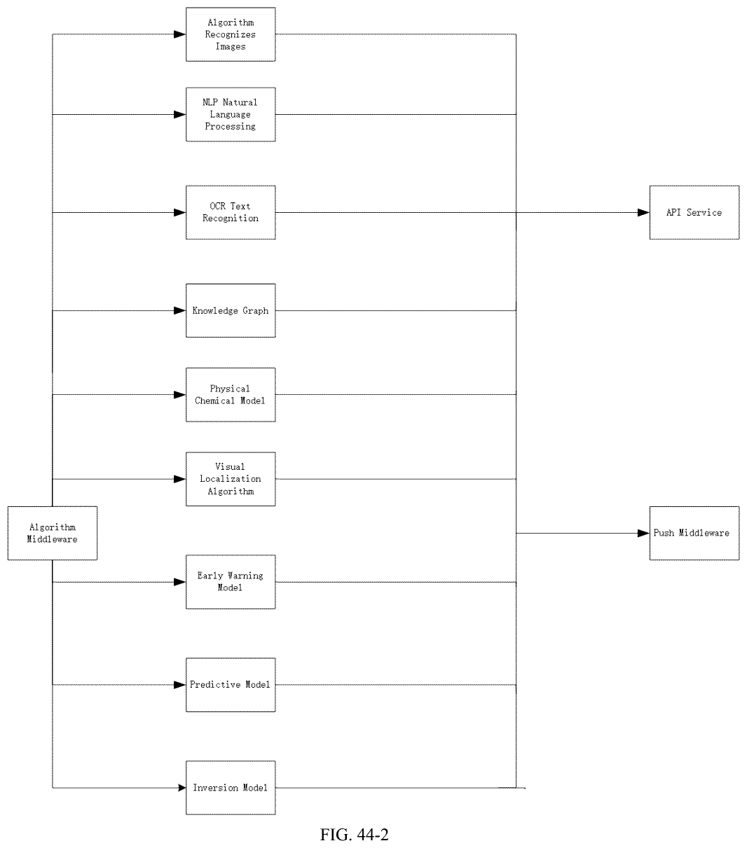

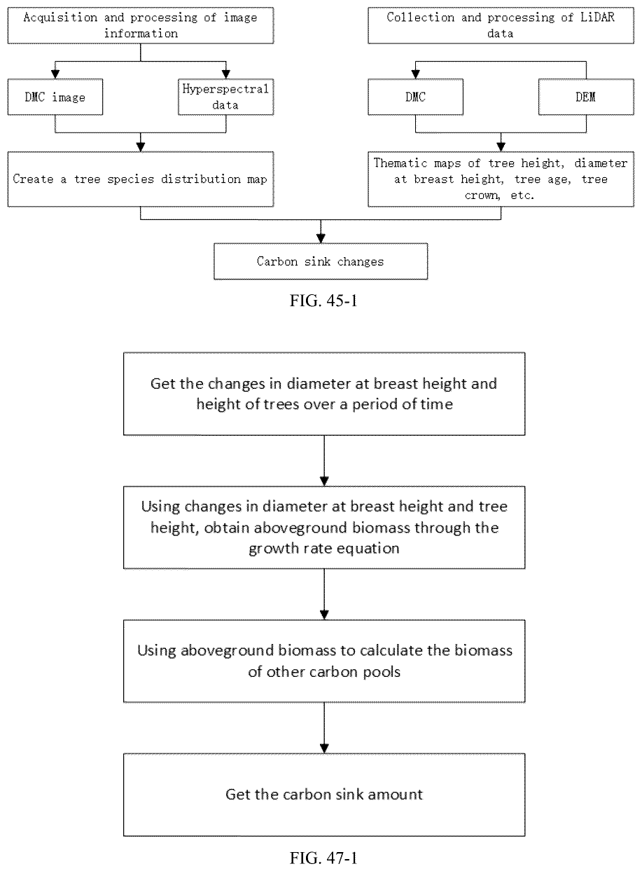

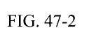

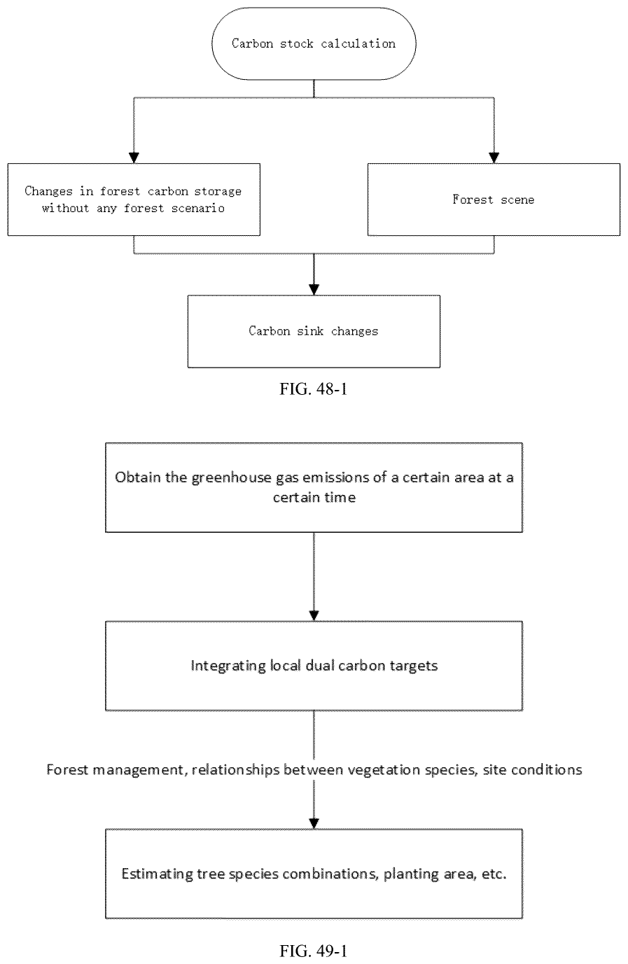

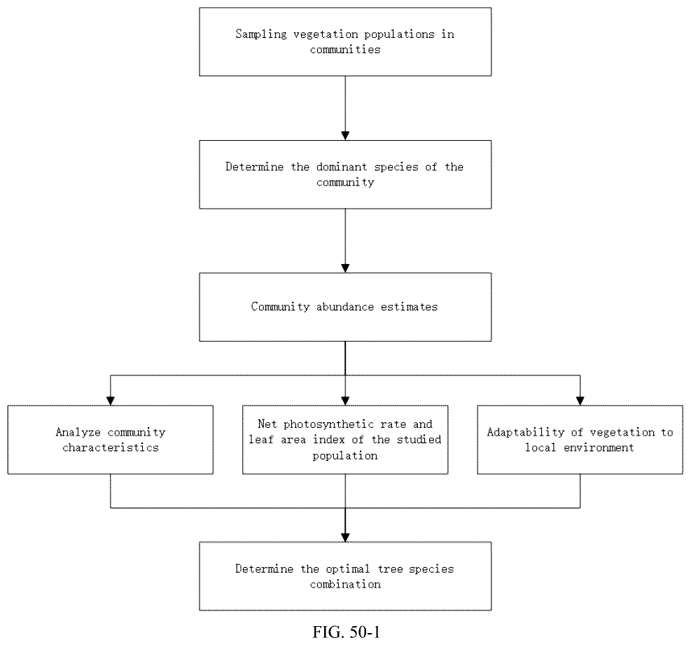

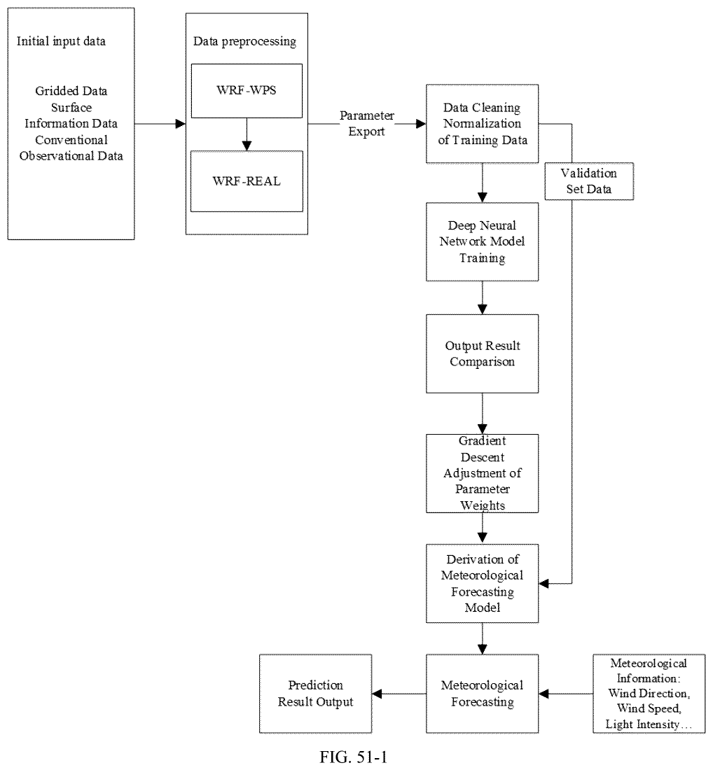

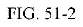

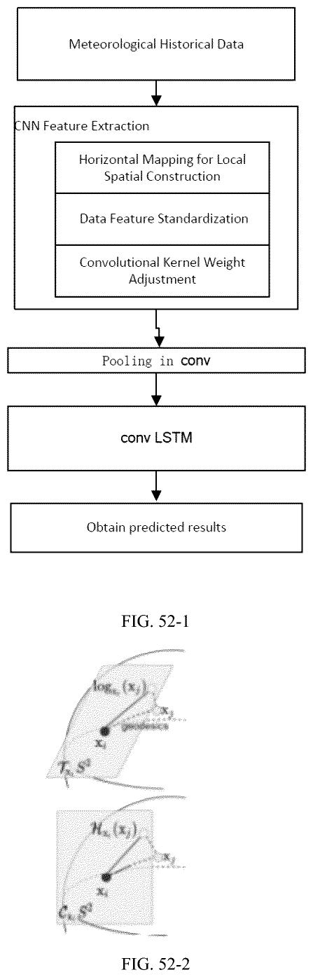

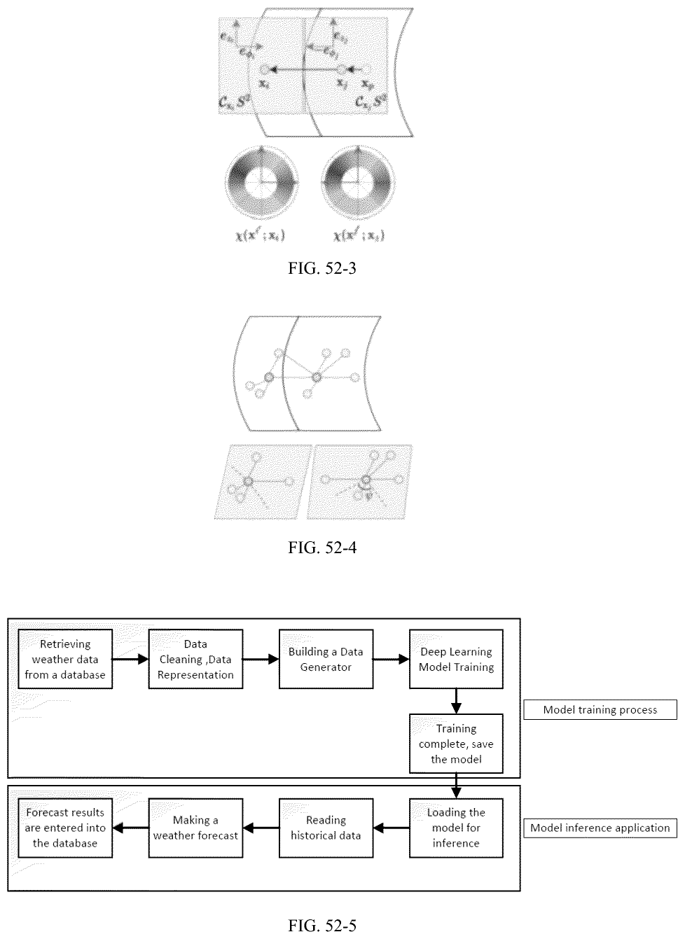

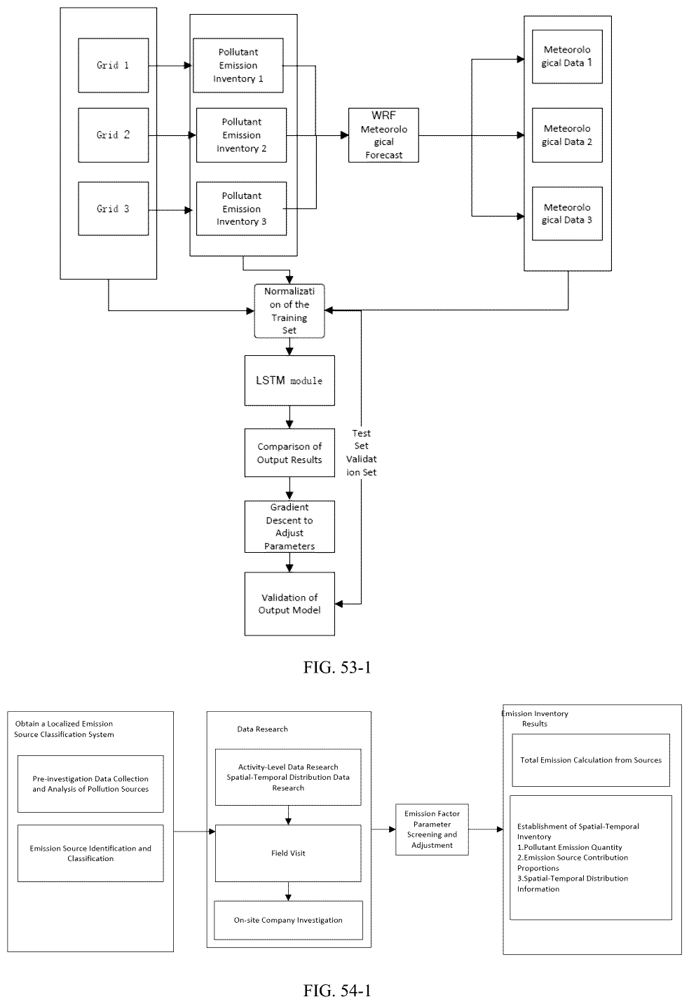

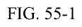

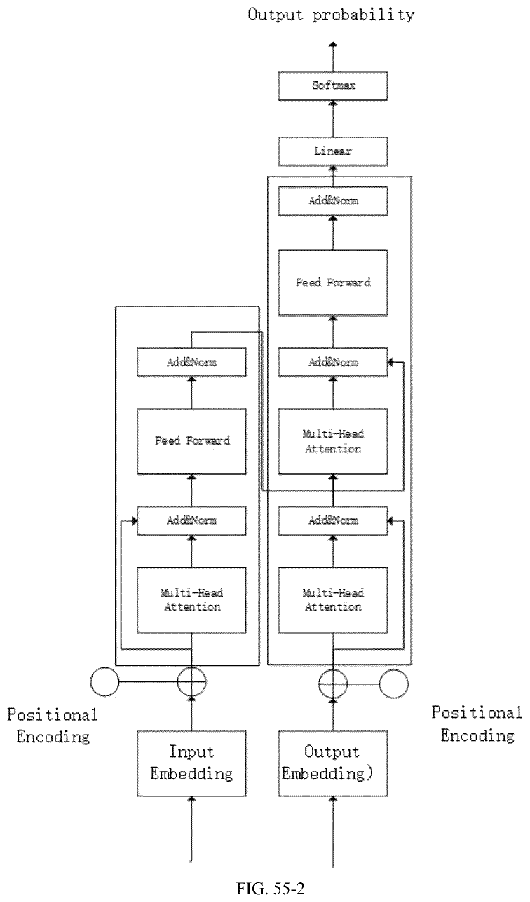

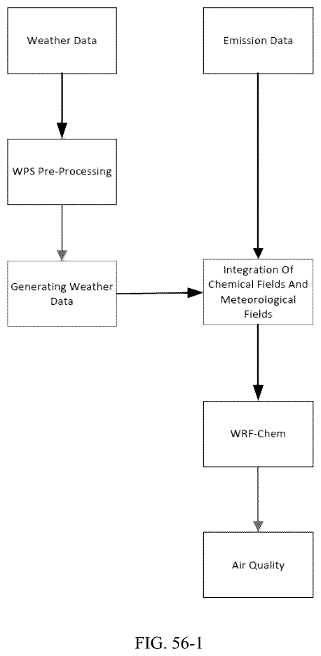

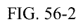

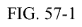

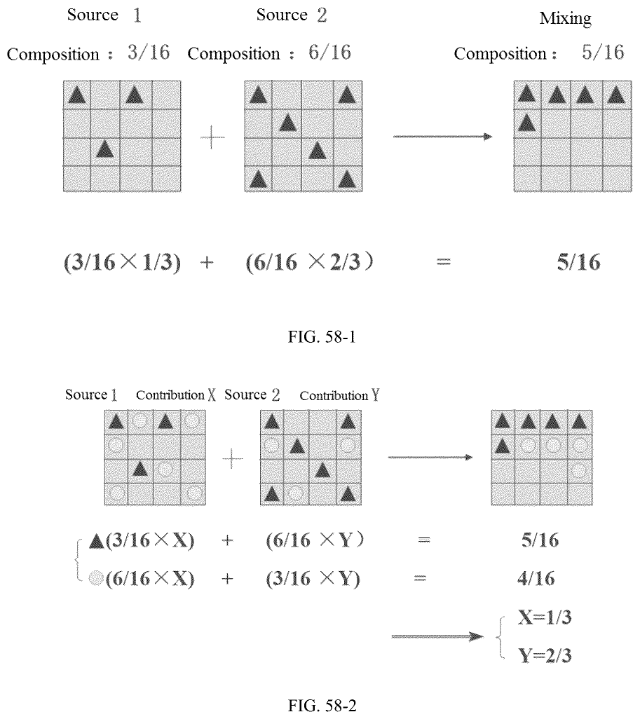

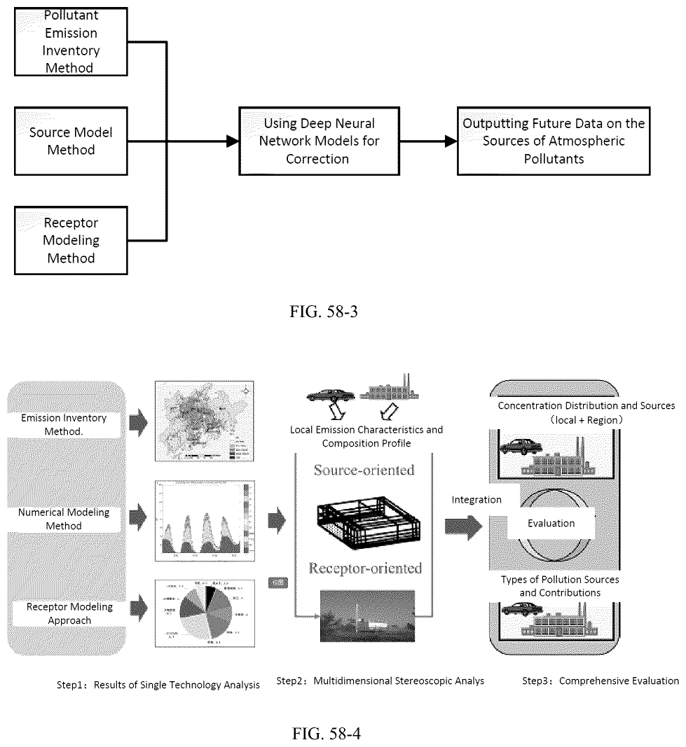

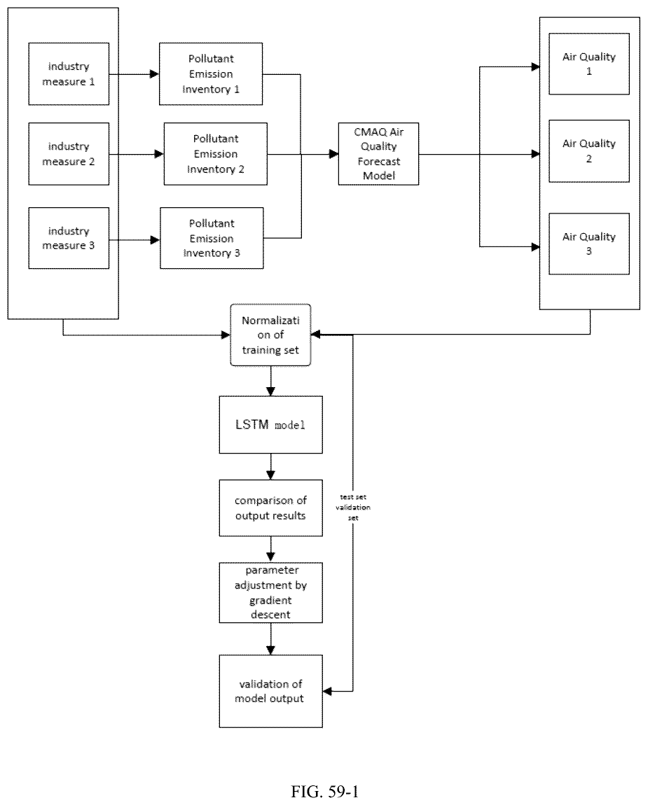

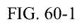

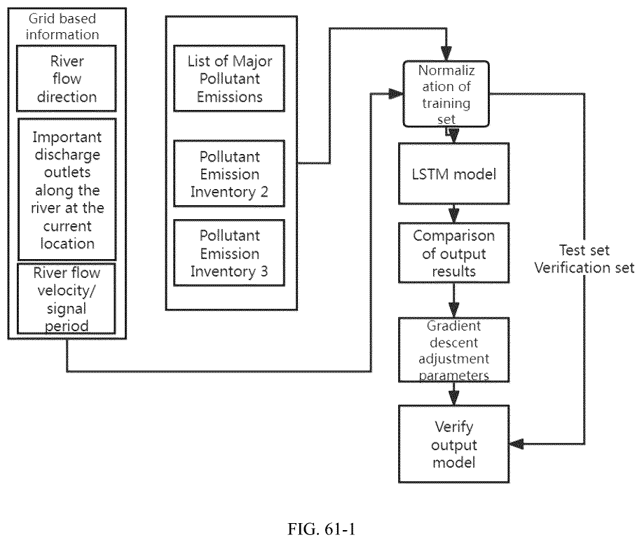

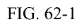

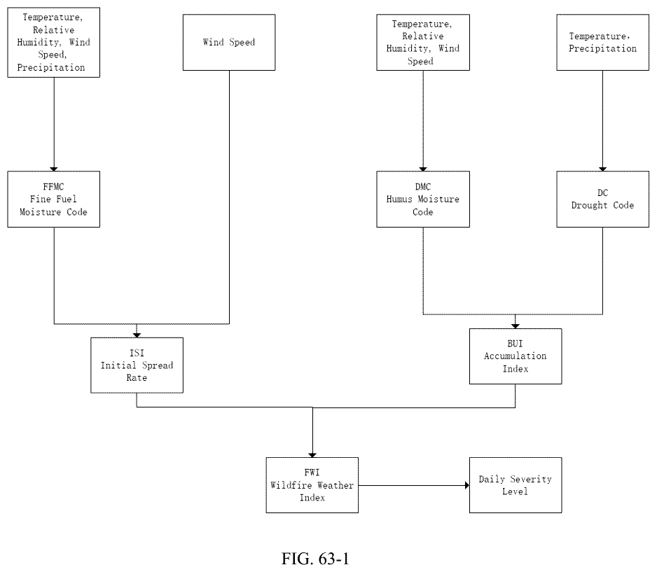

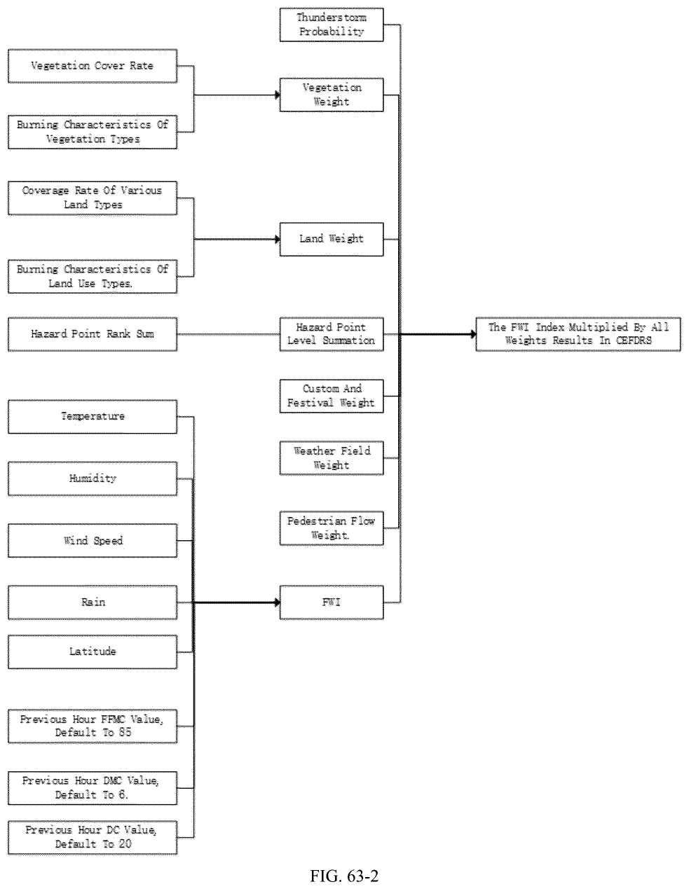

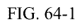

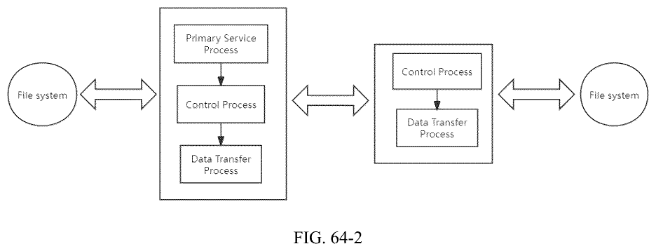

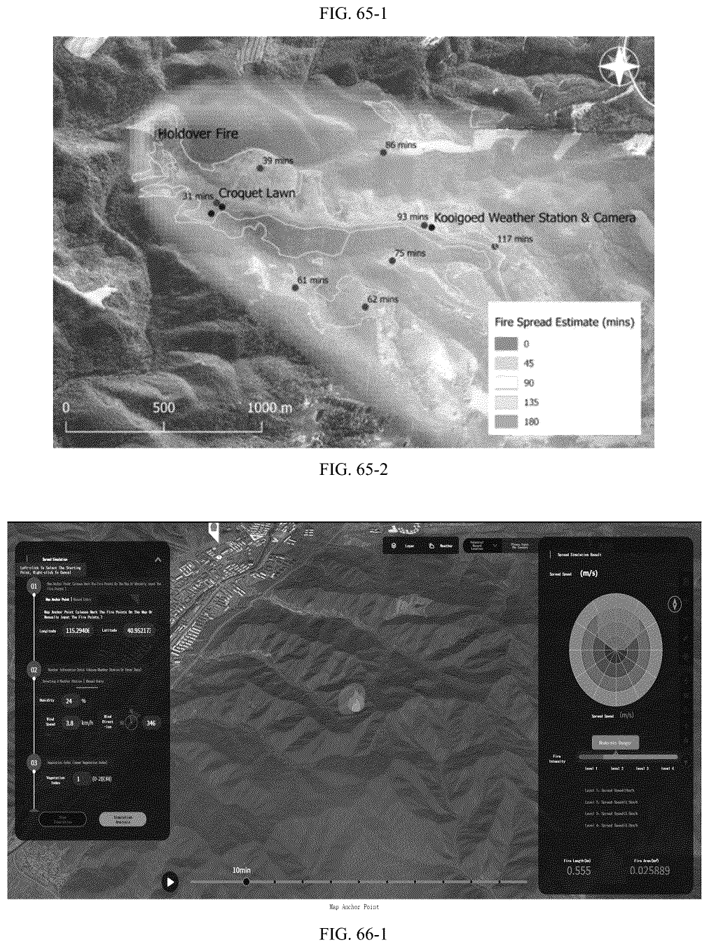

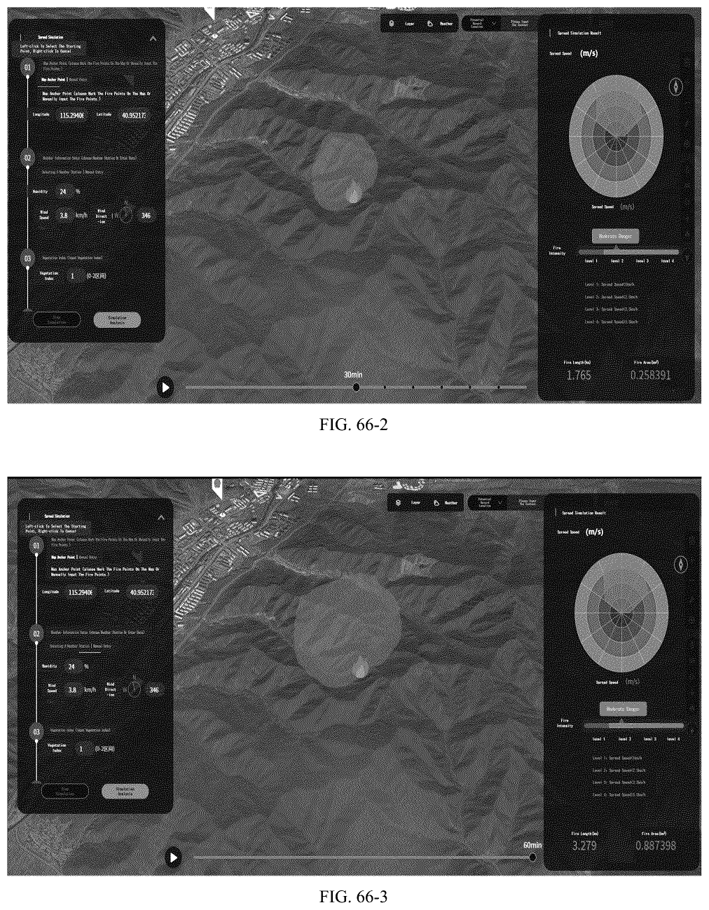

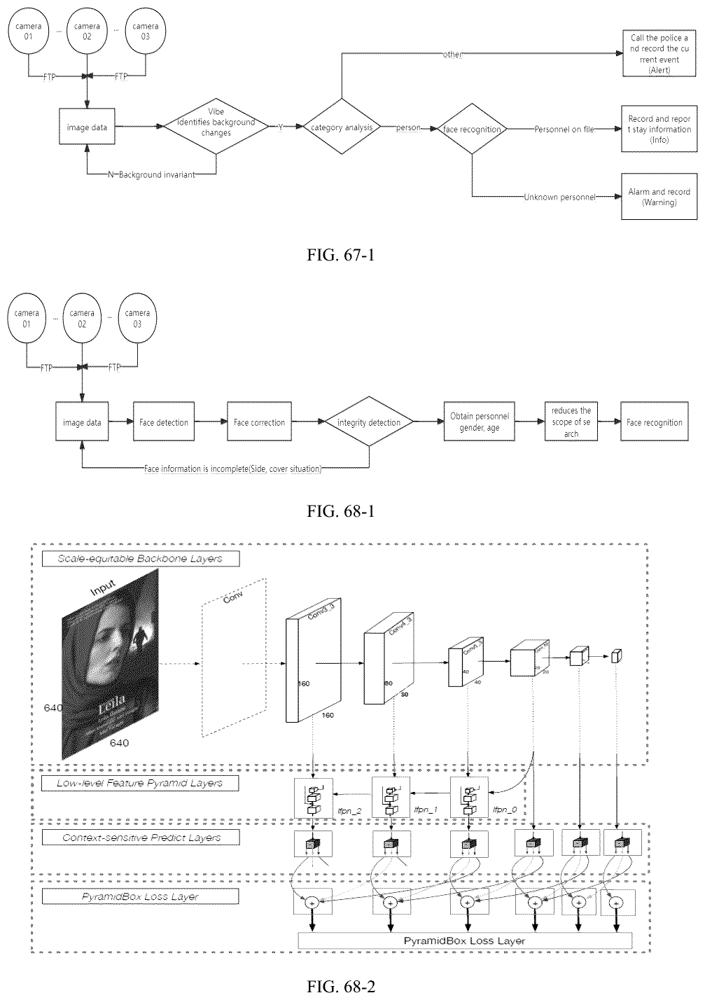

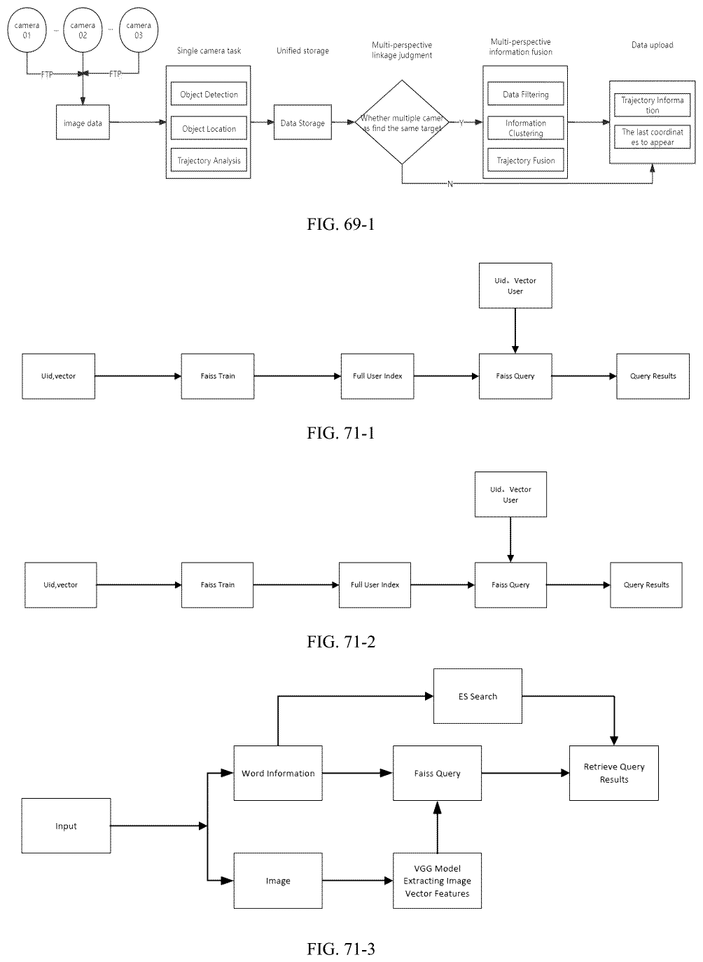

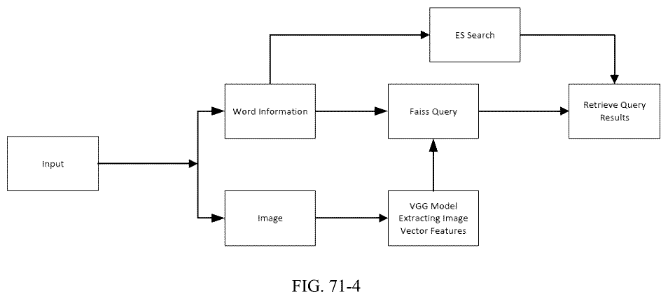

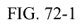

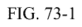

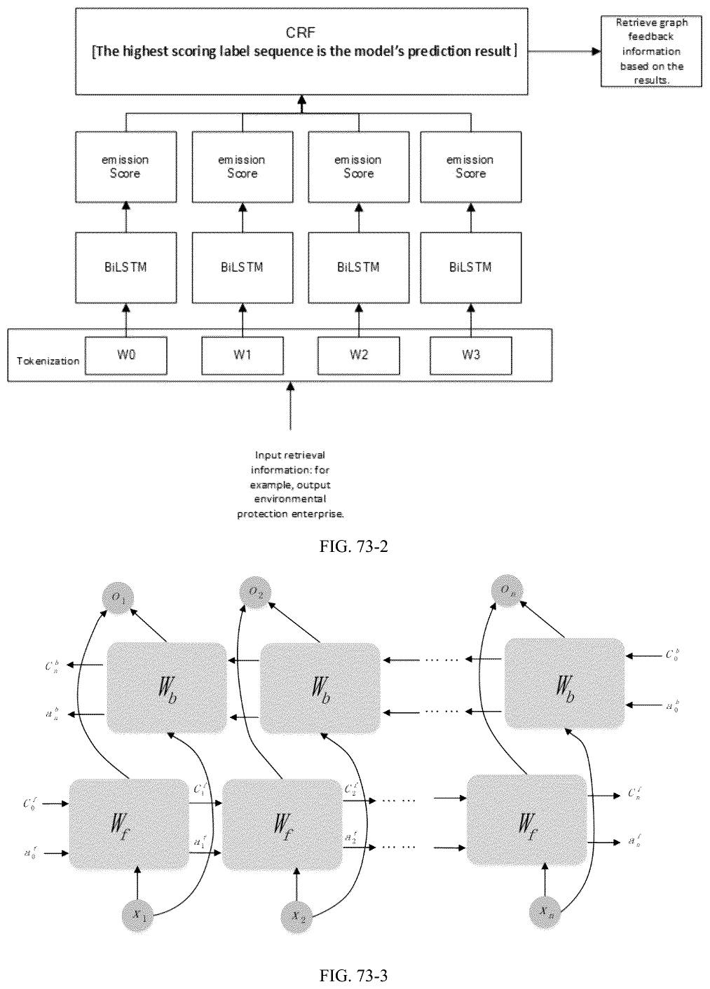

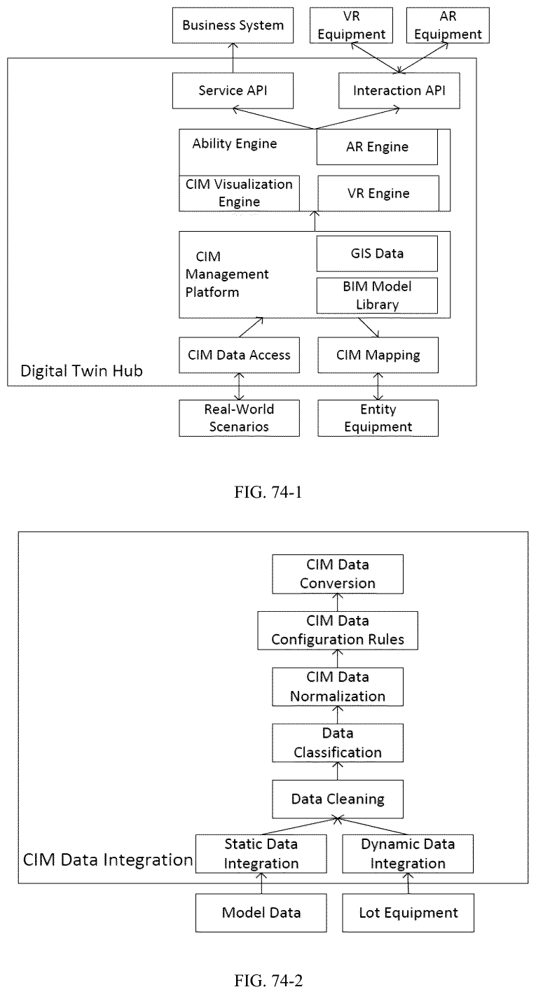

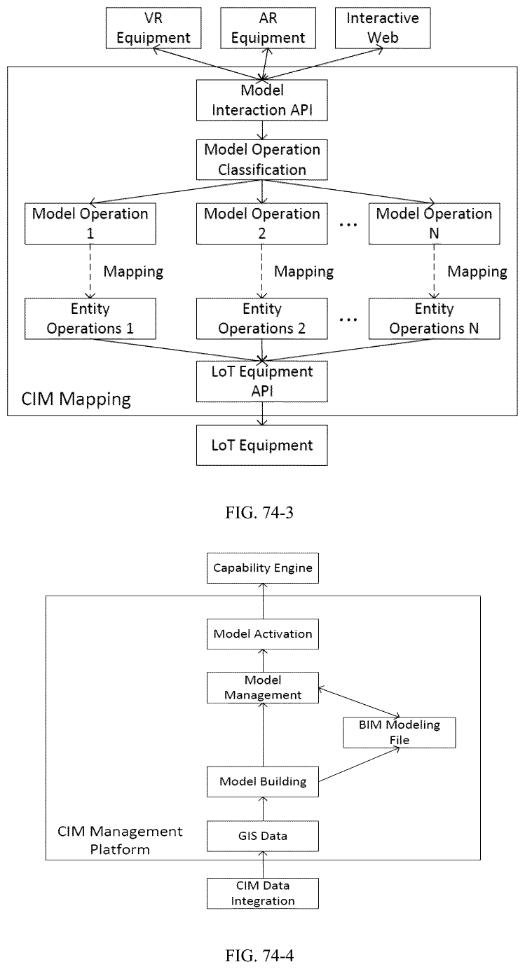

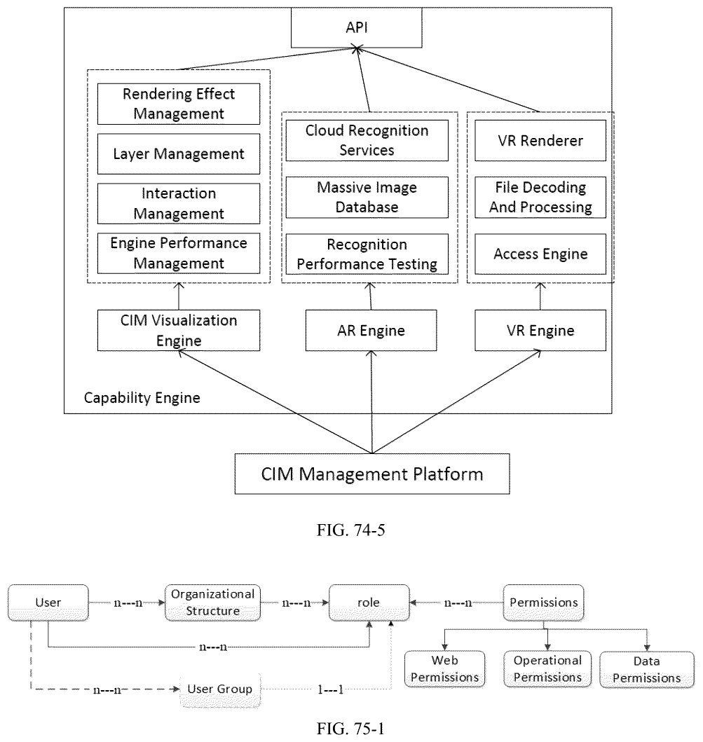

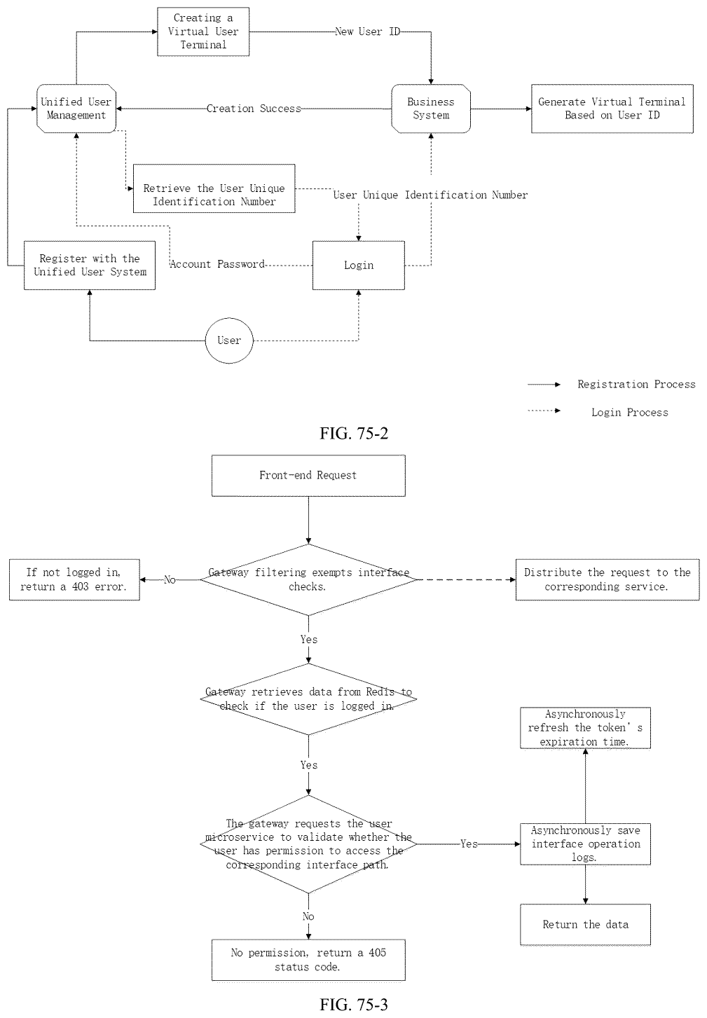

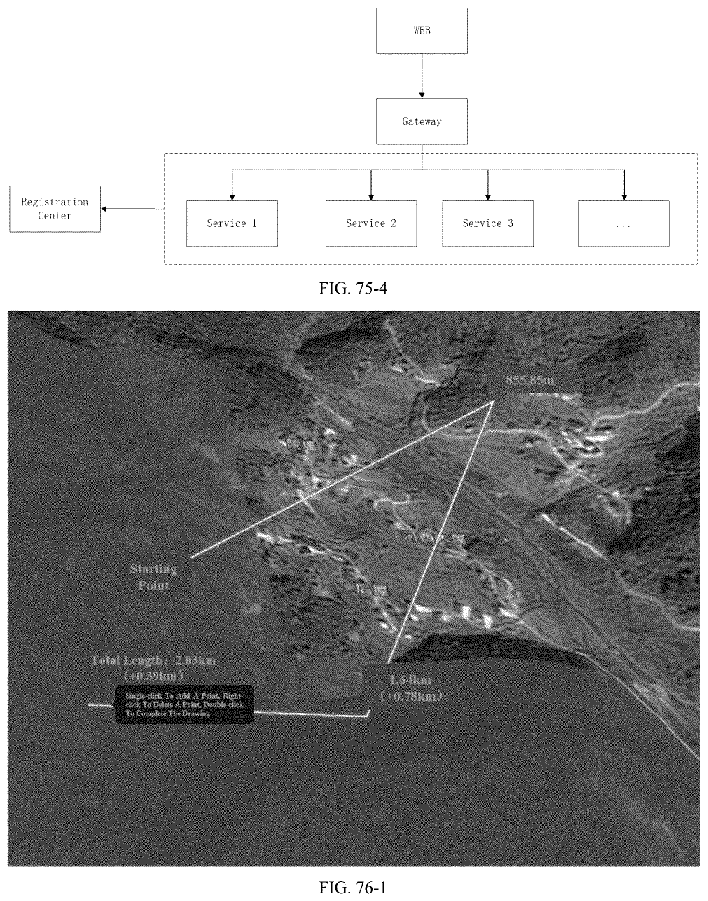

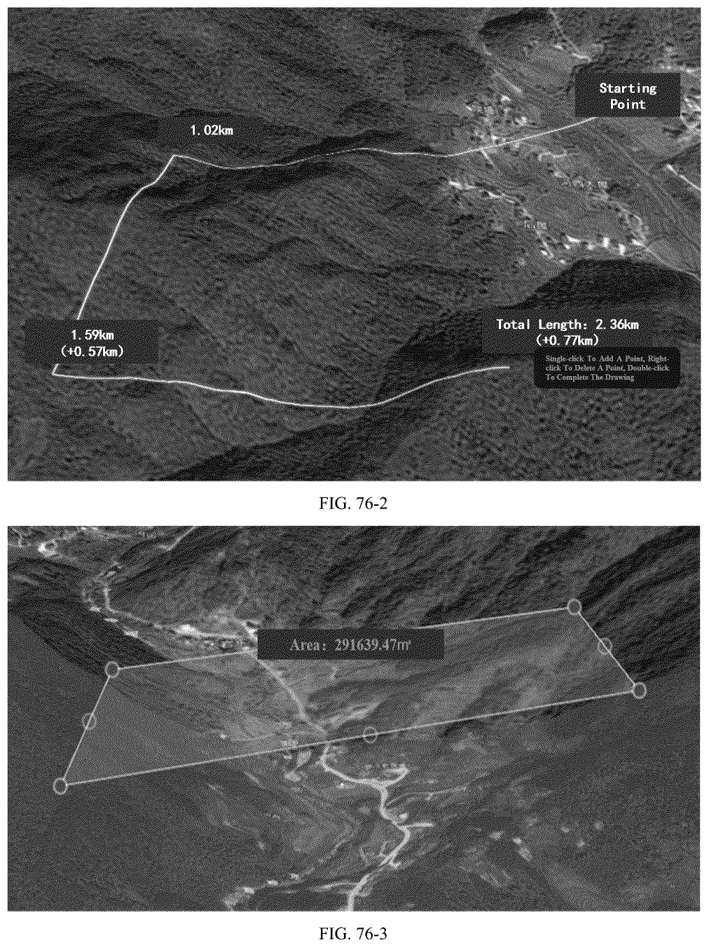

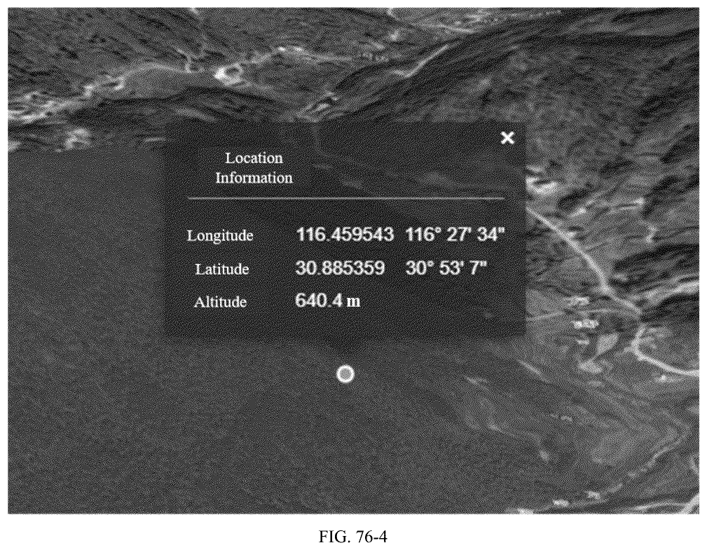

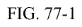

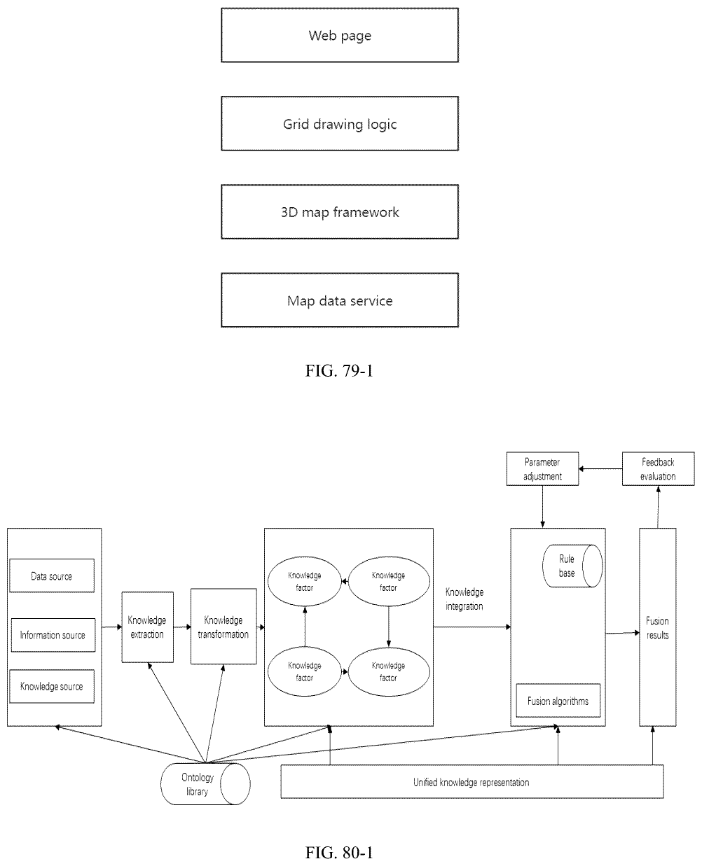

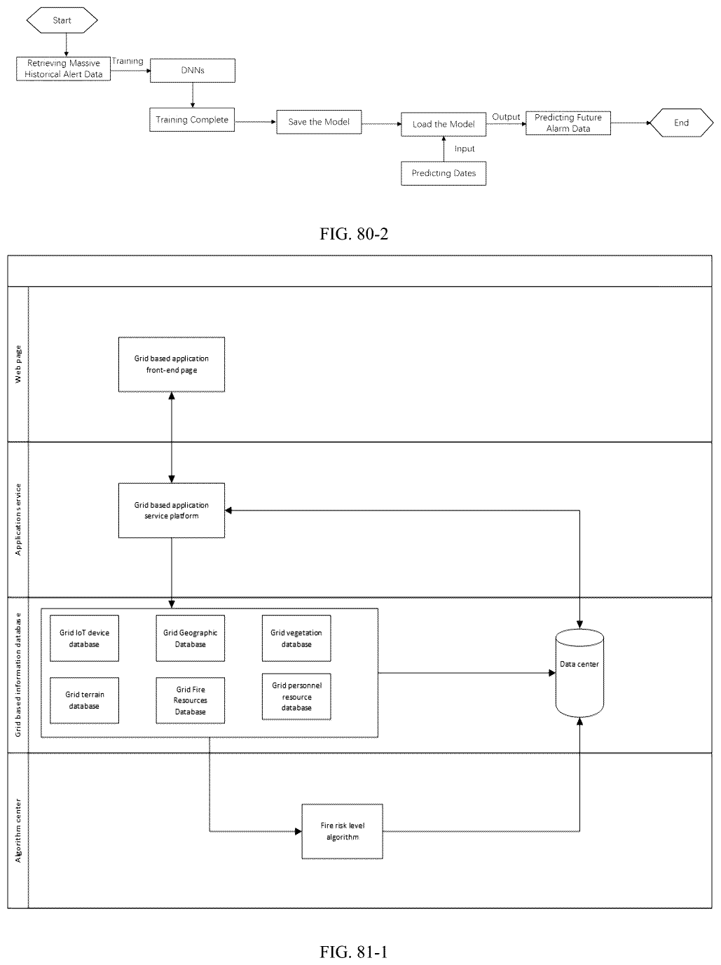

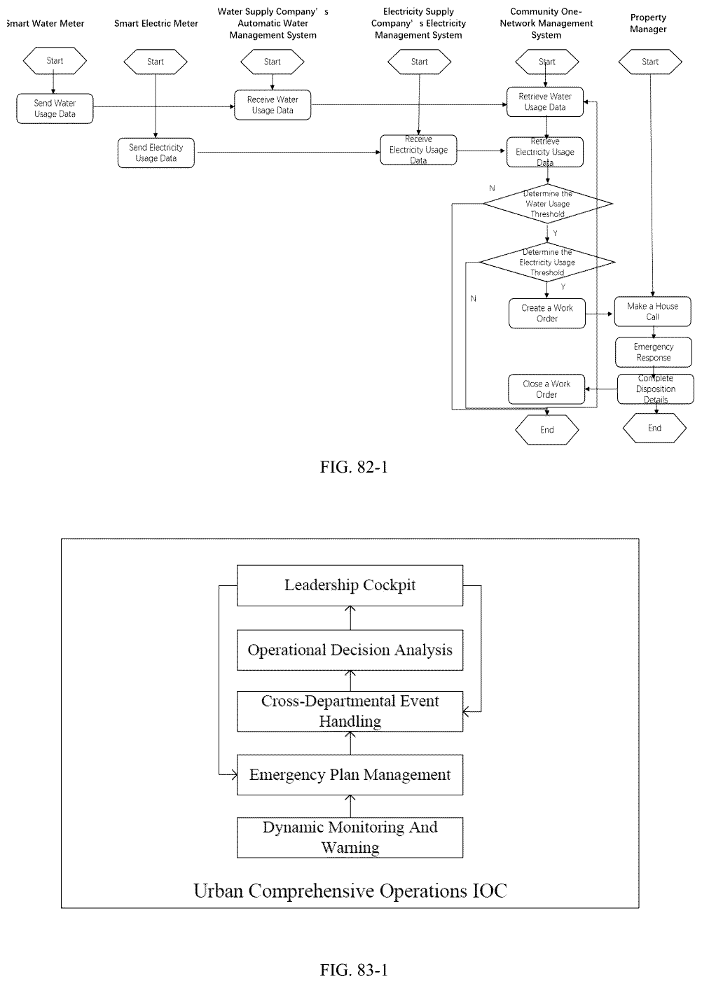

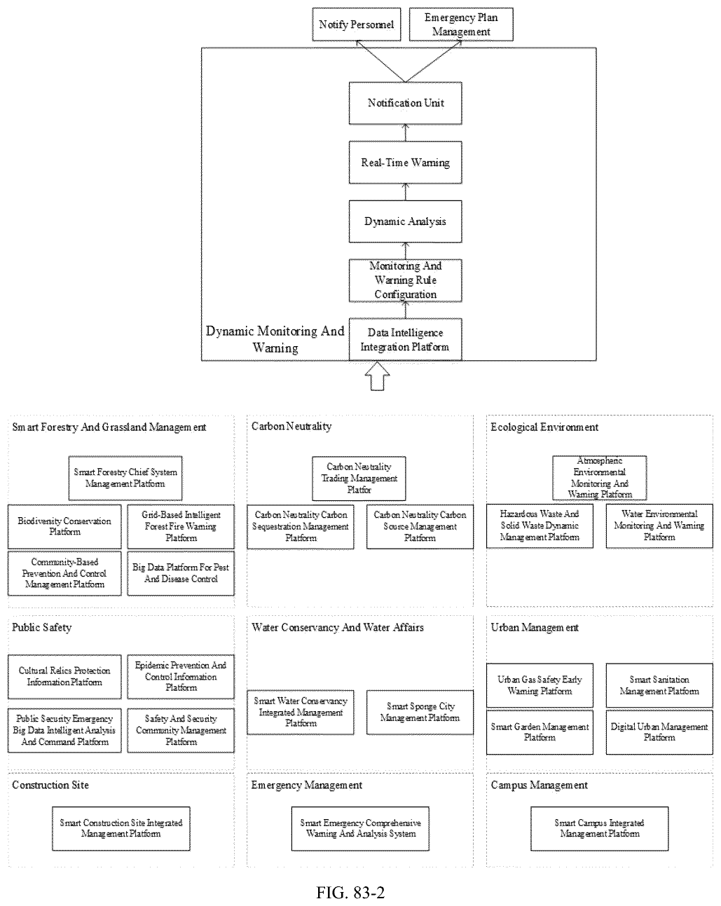

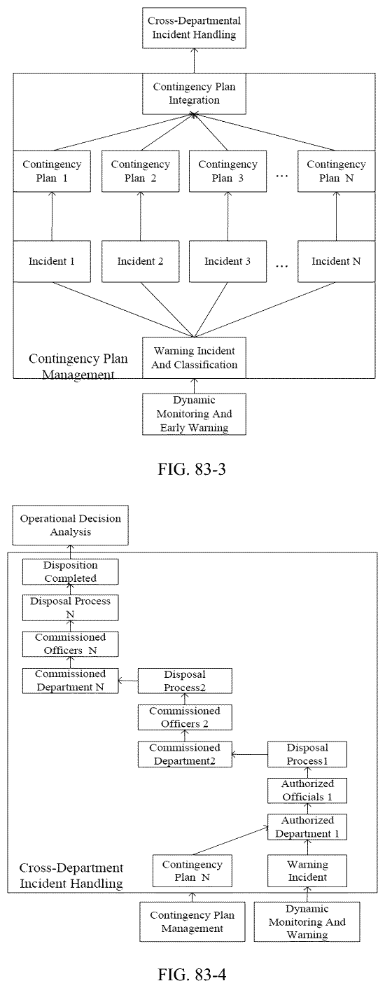

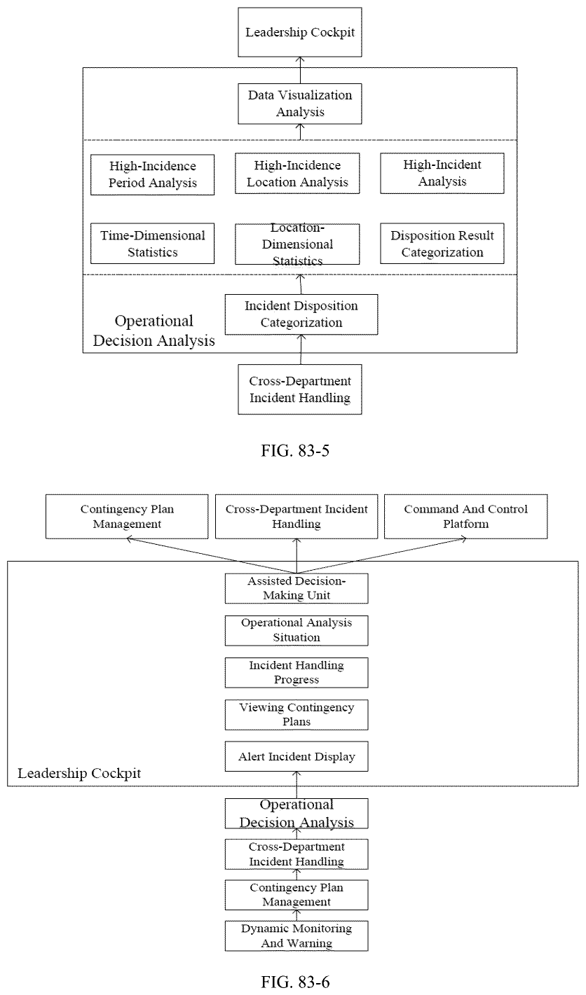

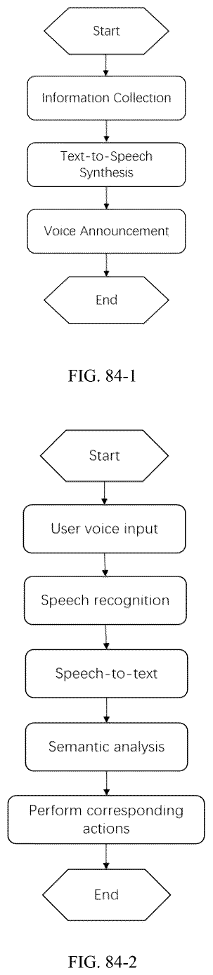

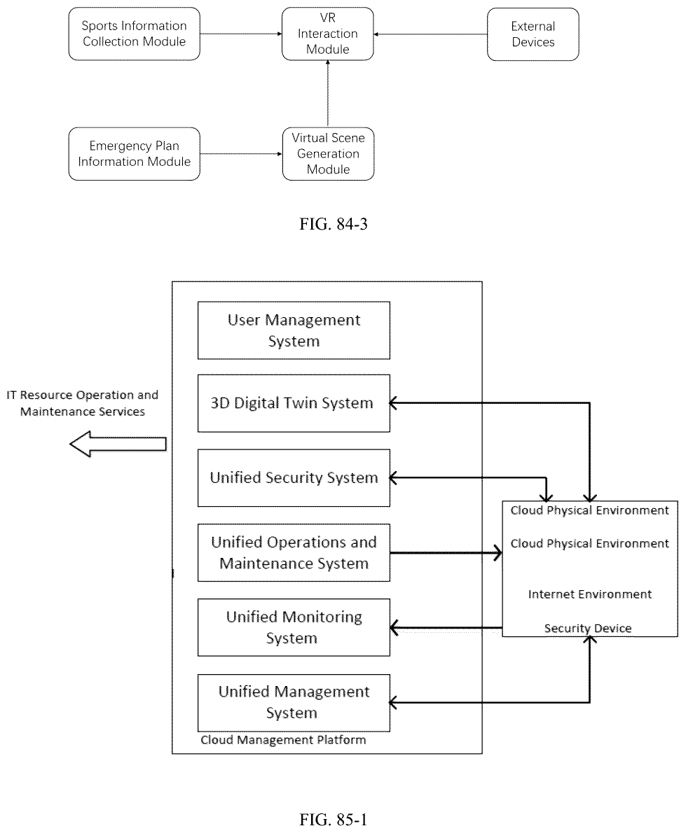

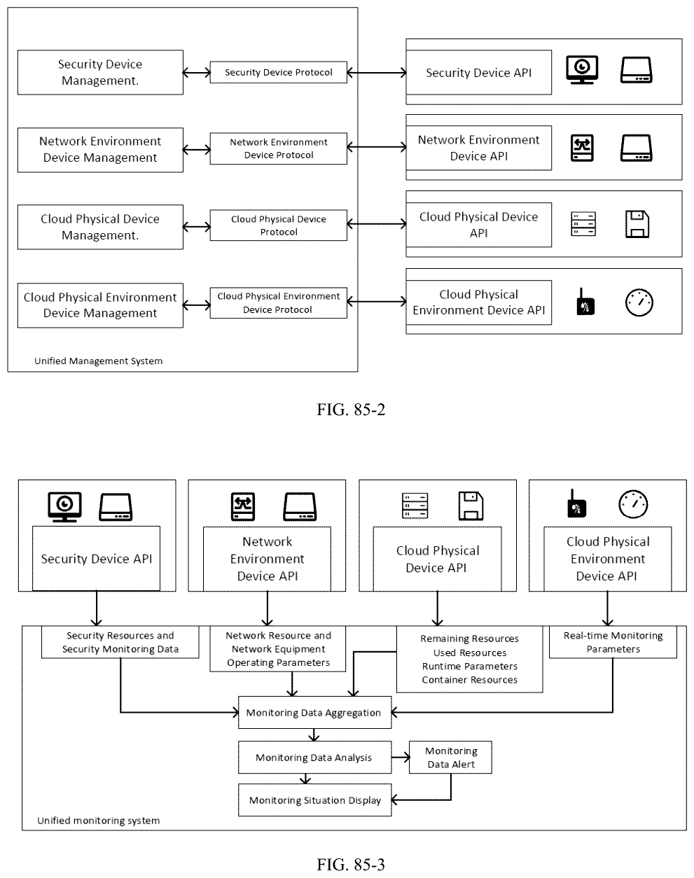

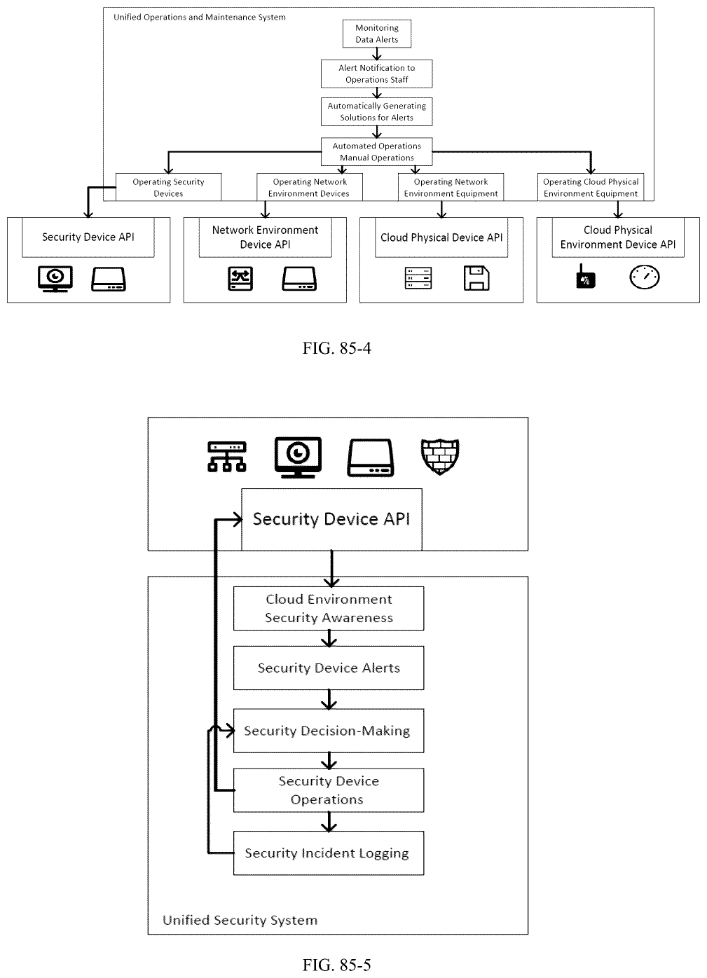

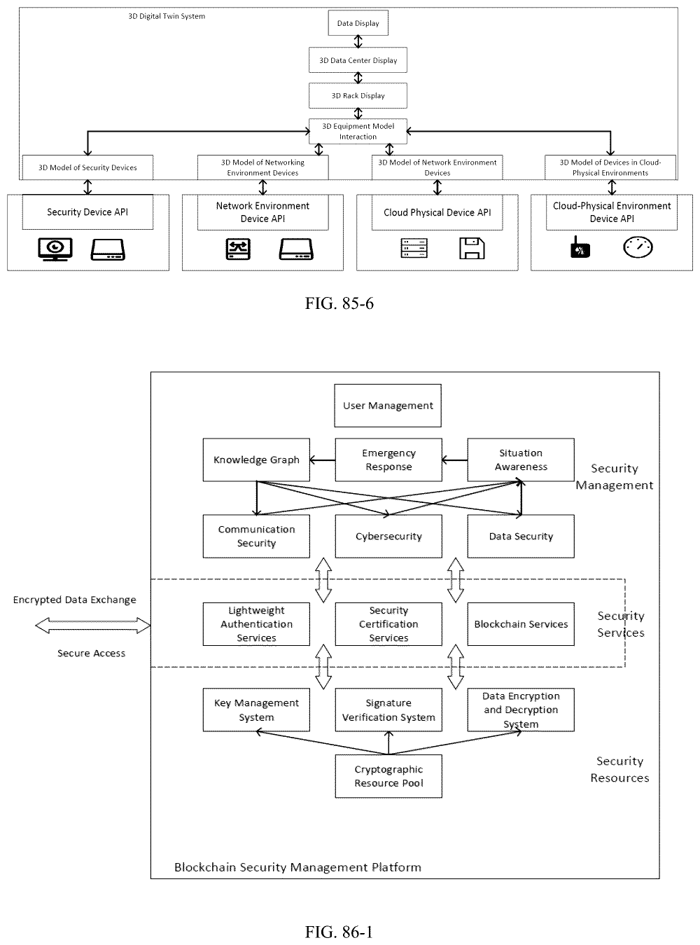

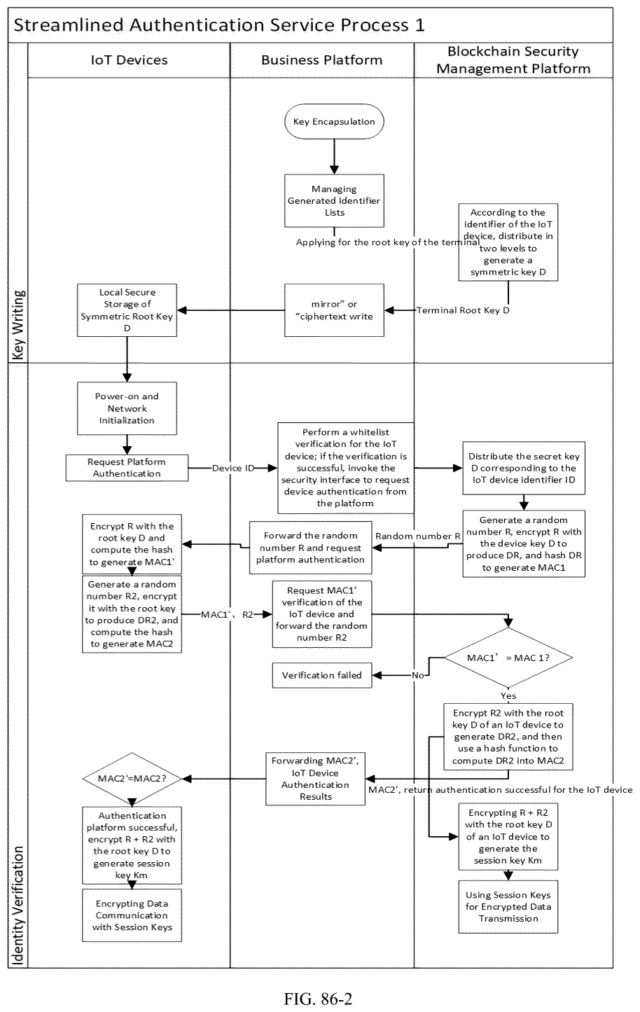

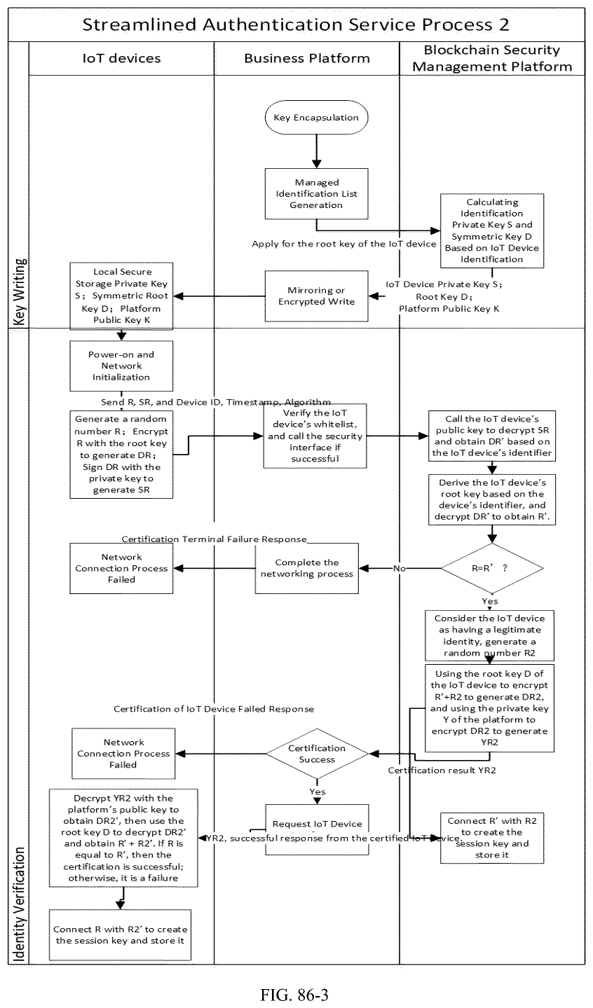

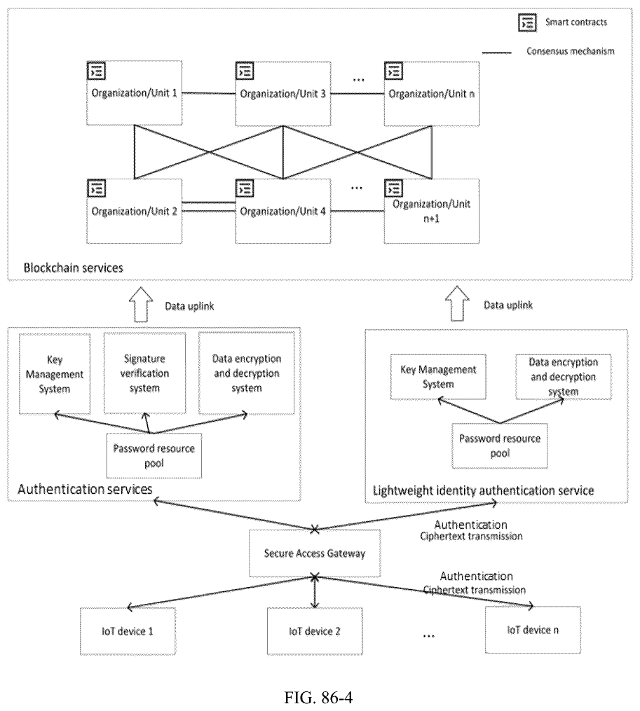

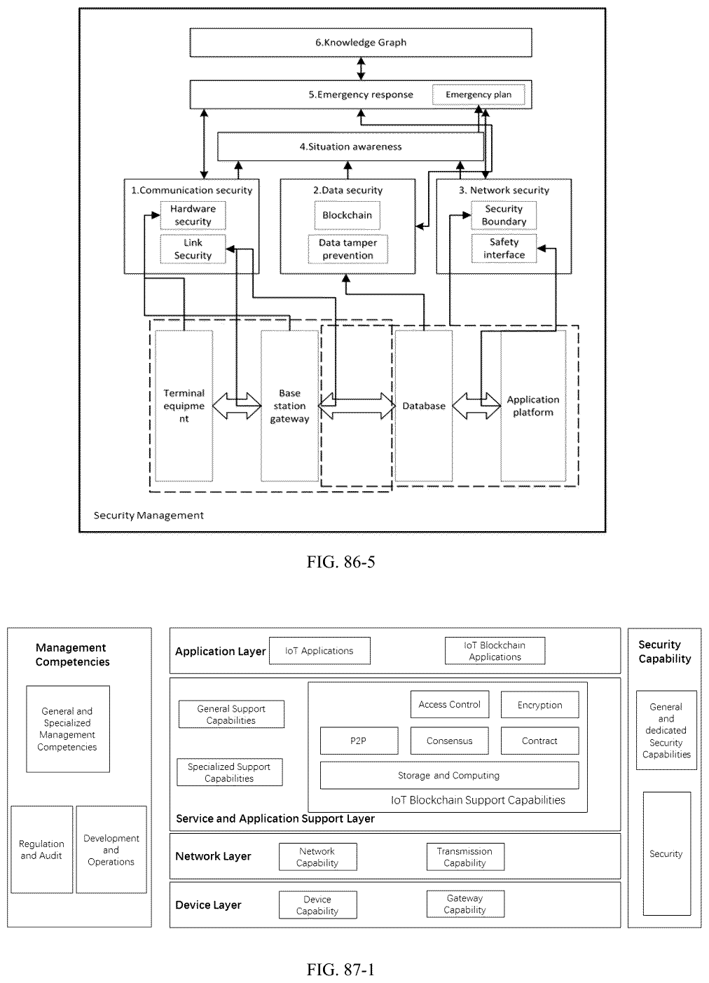

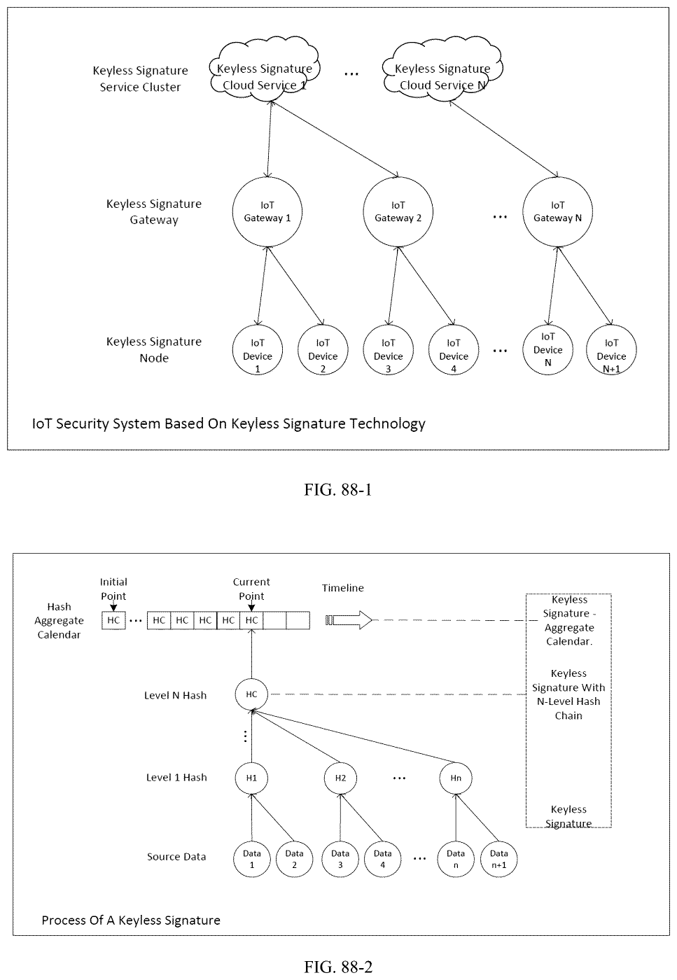

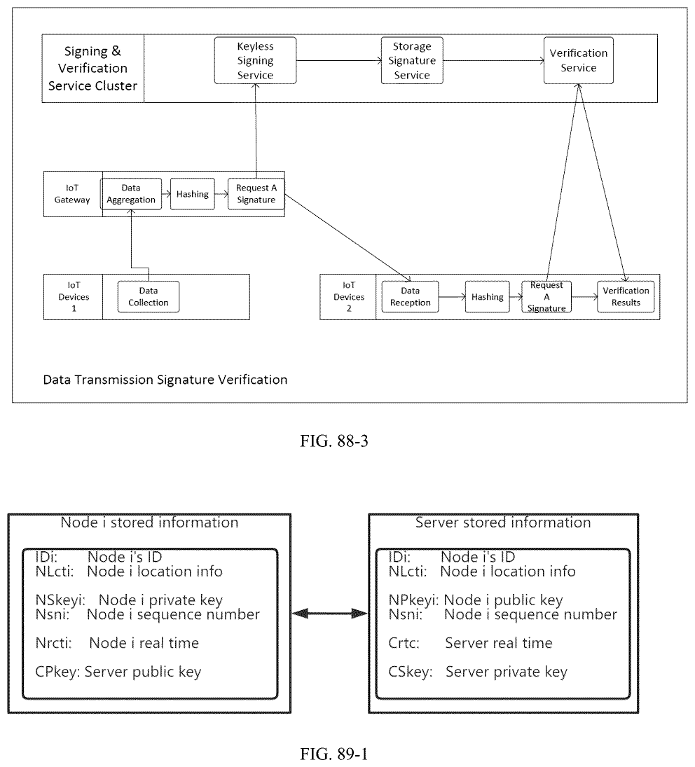

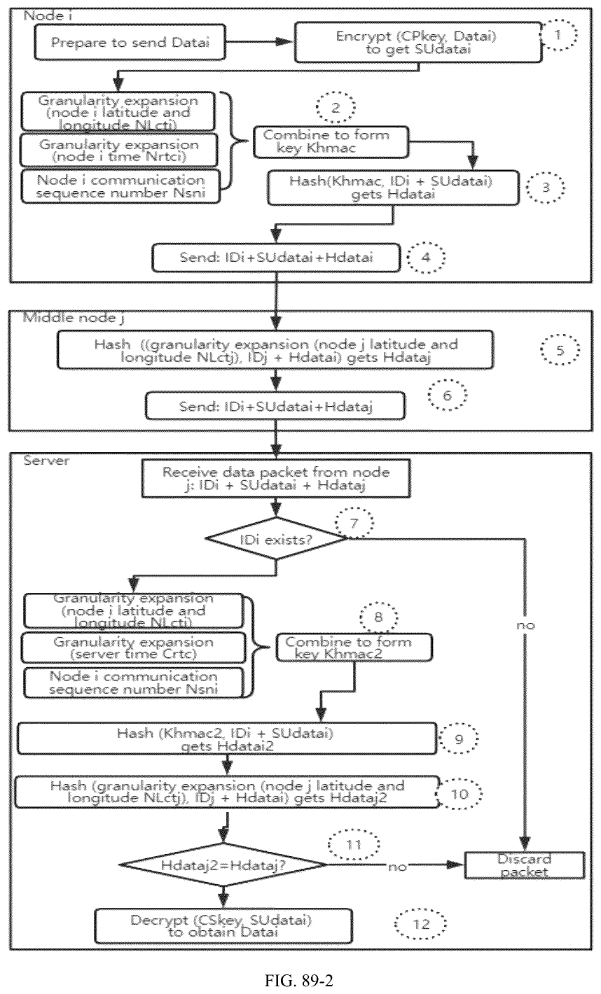

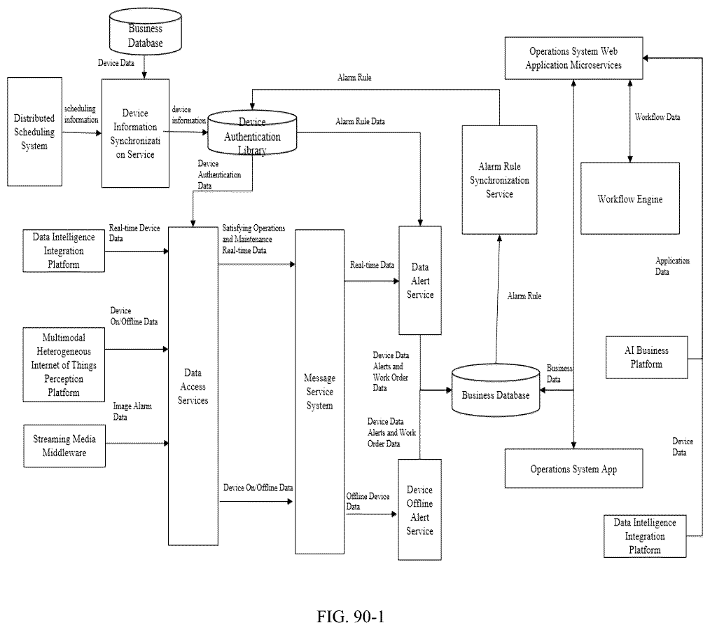

FIG. 5-12 is the flow chart of using the adaptive network topology numerical calibration of the LSTM neural network provided by the present disclosure;

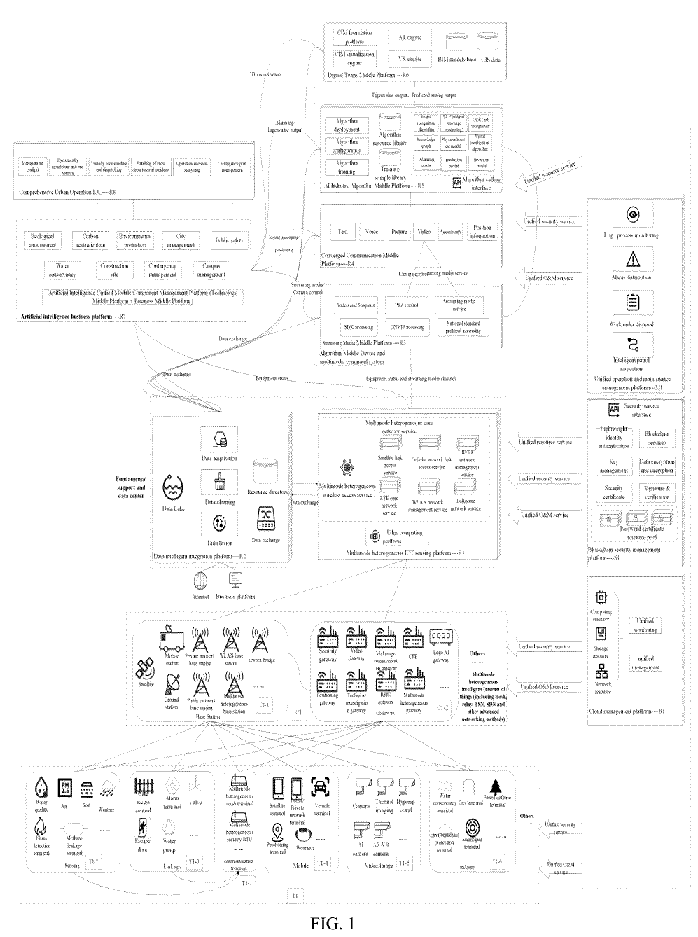

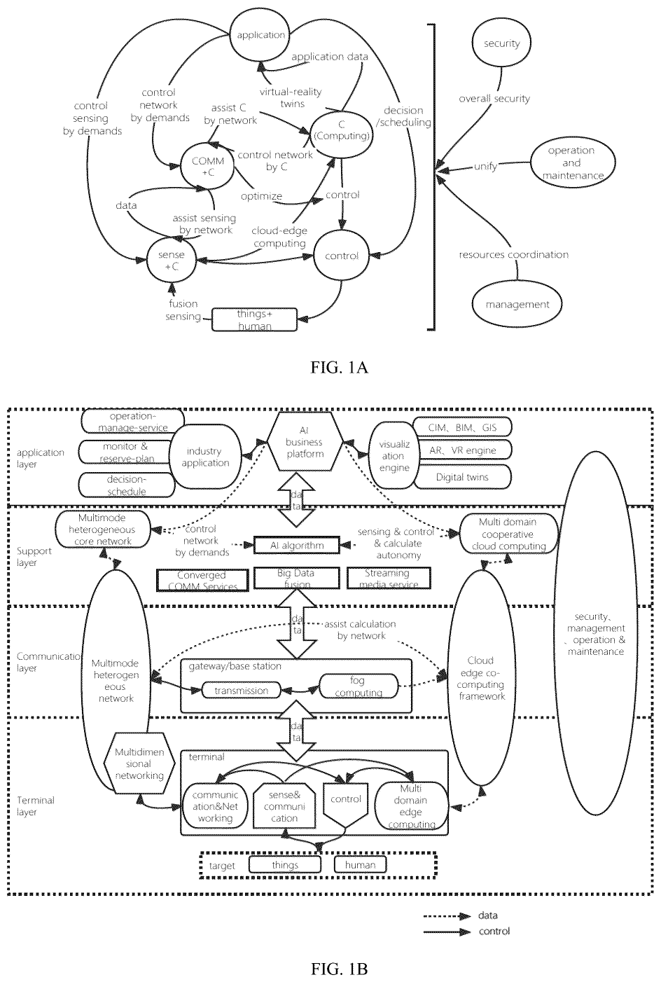

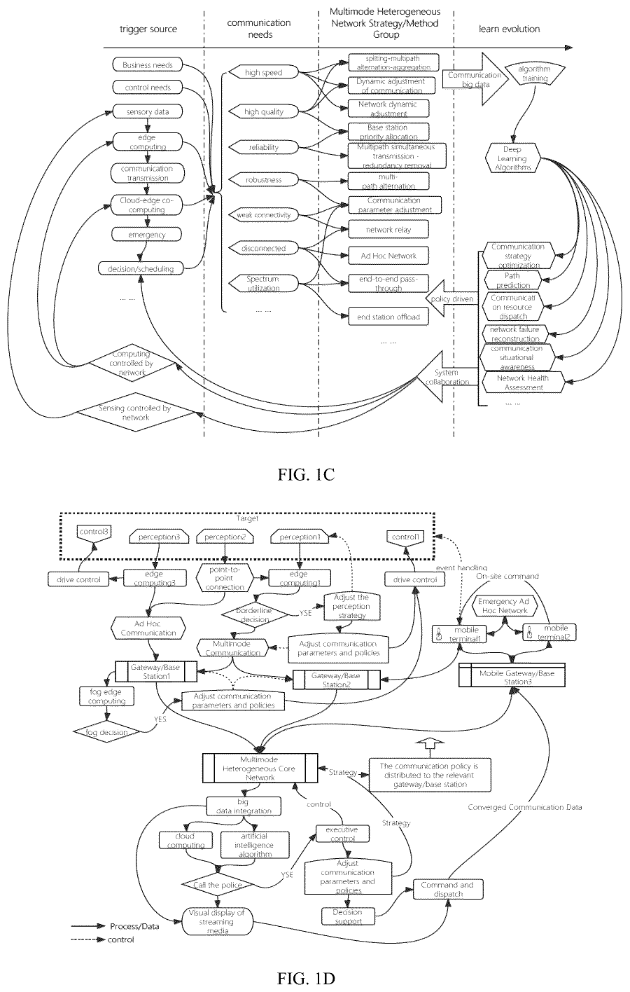

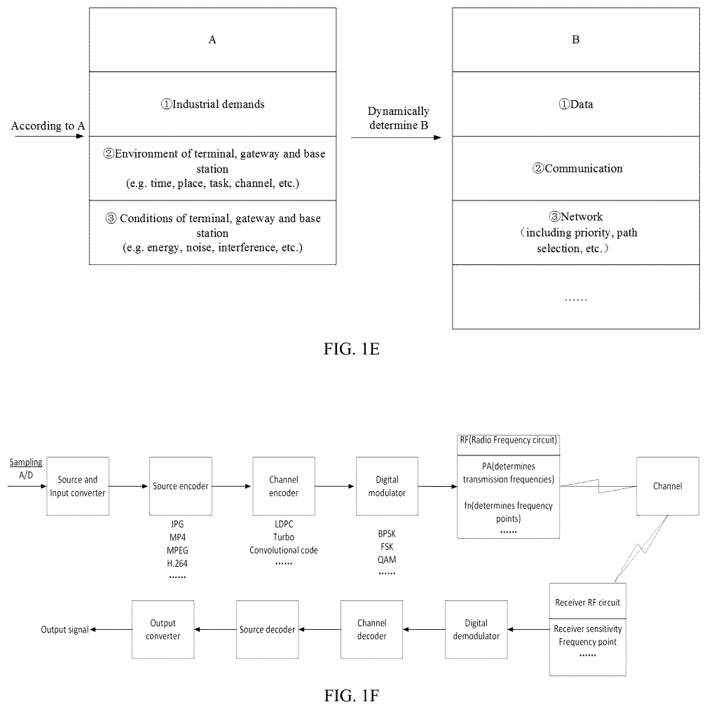

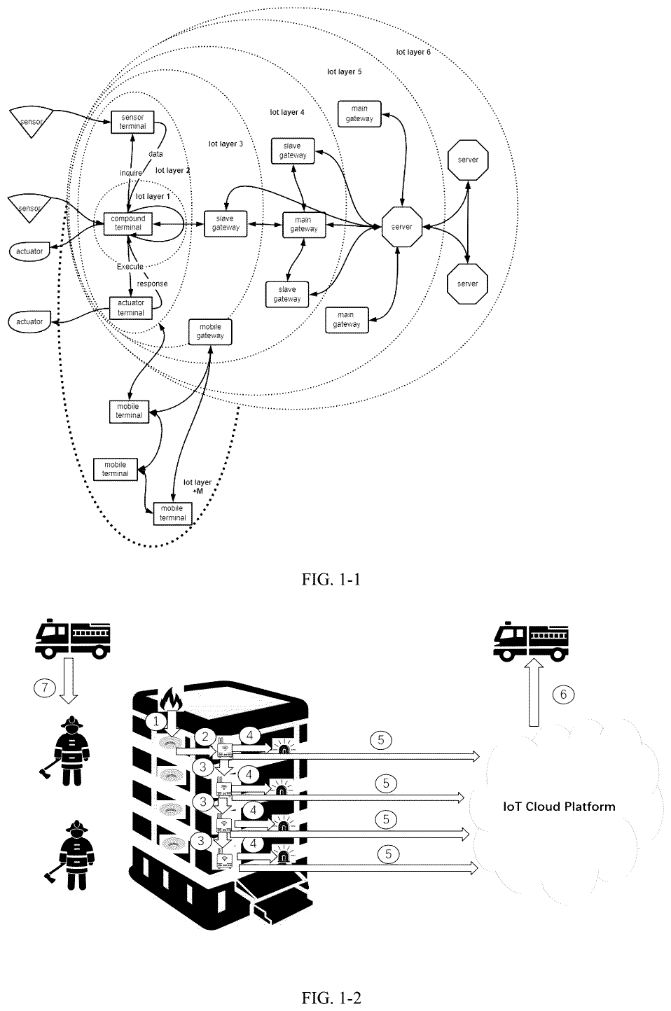

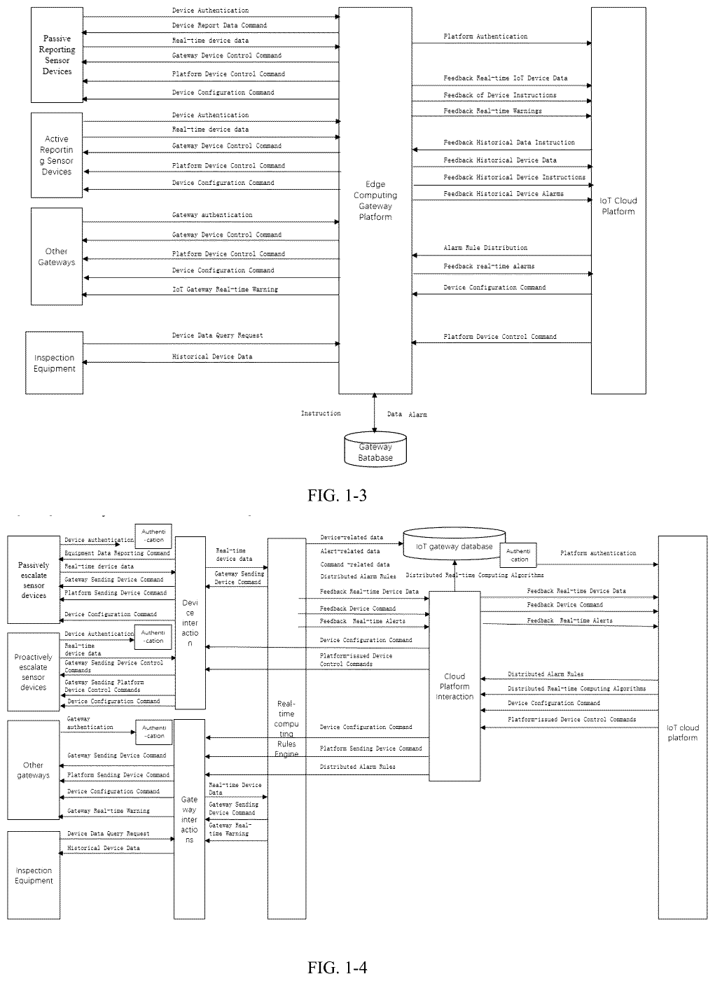

FIG. 6-1 to FIG. 6-4 are schematic diagrams (1 to 4) related to the invention points of the composite gas leakage sensor terminal provided by the present disclosure, FIG. 7-1 to FIG. 7-4 are related diagrams (1 to 4) of the multi-mode ad hoc network mutual identification intelligent positioning badge and system provided by the present disclosure;

FIG. 8-1 to FIG. 8-3 are chassis structure diagrams (1 to 3) provided by the present disclosure, FIG. 9-1 to FIG. 9-3 are schematic diagrams of tree multi-dimensional monitoring terminals provided by the present disclosure (1 to 3);

FIG. 10-1 and FIG. 10-2 are related schematic diagrams (1 to 2) of the emergency crashable and non-destructive barrier gate system provided by the present disclosure;

FIG. 11-1 is a schematic diagram of the AI-based drowning recognition and automatic rescue system provided by the present disclosure:

FIG. 12-1 and FIG. 12-2 are related schematic diagrams (1 to 2) of the weak blocking type road gate system for accumulated water provided by the present disclosure;

FIG. 13-1 and FIG. 13-2 are schematic diagrams of the global water quality detection system provided by the present disclosure (1 to 2);

FIG. 14-1 is a schematic diagram of the support technology of the water level bucket provided by the present disclosure;

FIG. 15-1 is a schematic diagram related to the intelligent multi-mode LPWA gateway provided by the present disclosure,

FIG. 16-1 is a schematic diagram of a communication network provided by the present disclosure:

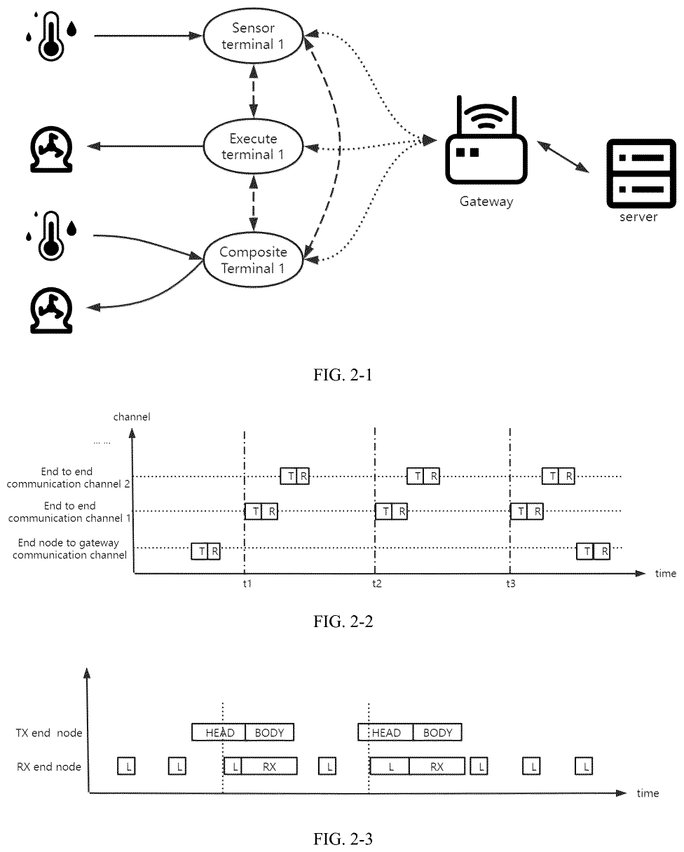

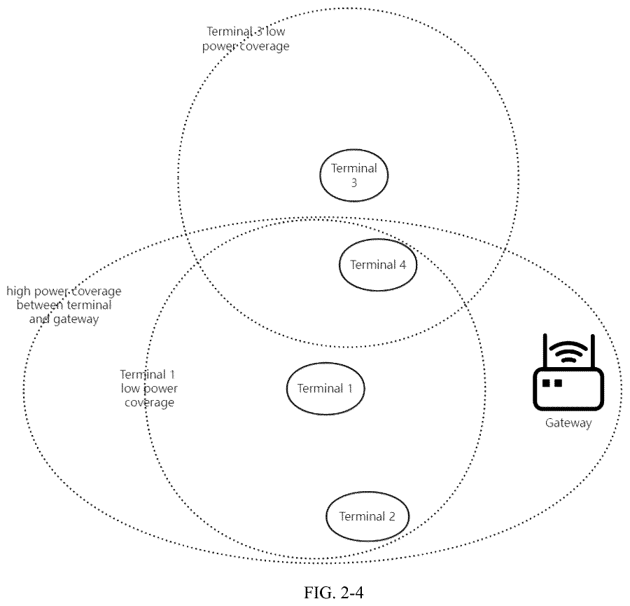

FIG. 16-2 is a schematic diagram of communication resource coordination provided by the present disclosure;

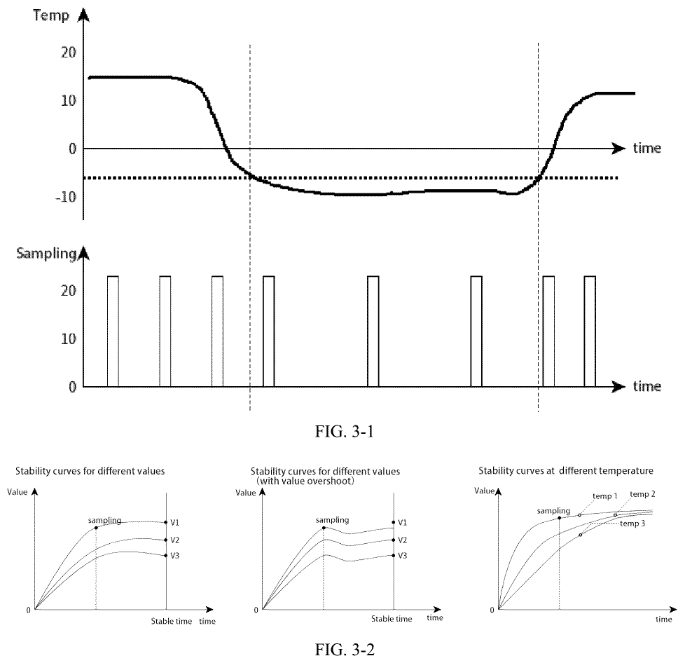

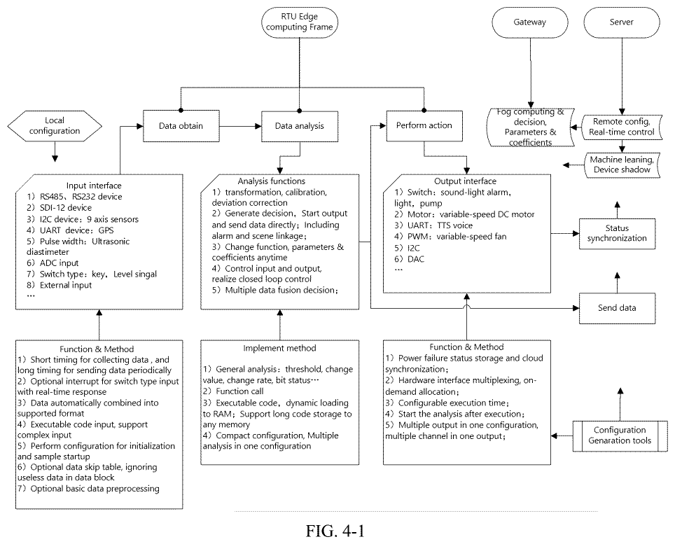

FIG. 16-3 is a schematic diagram of the Internet of Things provided by the present disclosure;

FIG. 17-1 is a schematic diagram of the overall architecture of the IoT sensing platform system provided by the present disclosure:

FIG. 18-1 is a schematic diagram of node state switching provided by the present disclosure;

FIG. 18-2 is a flow chart of node network access provided by this disclosure;

FIG. 18-3 is a flow chart of node sending and receiving after network access provided by the present disclosure,

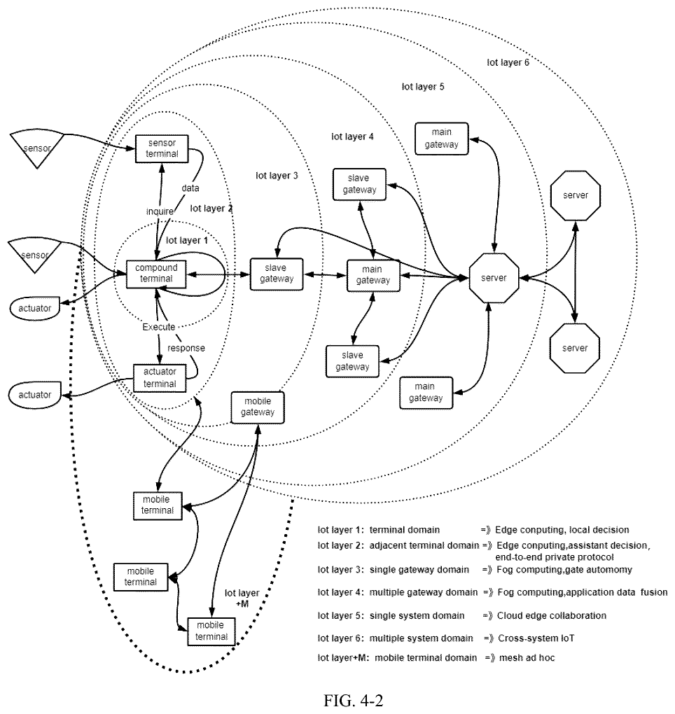

FIG. 18-4 is a flow chart of the data transmission request and response provided by the present disclosure;

FIG. 18-5 is a flow chart of data transmission provided by this disclosure;

FIG. 18-6 is a schematic diagram of summaries of different data packets sent for a negotiation channel based on an embodiment of the present disclosure;

FIG. 18-7 is a schematic diagram of summaries of different data packets sent by the data channel provided by the present disclosure;

FIG. 19-1 is a schematic diagram related to the communication technology of the hybrid connection network provided by the present disclosure;

FIG. 20-1 is a flow chart of OTA dedicated protocol firmware upgrade provided by the present disclosure;

FIG. 20-2 is a composition diagram of an adaptive coordinated multi-point system provided by the present disclosure under the condition that multiple gateways and multiple terminals coexist;

FIG. 21-1 is an overall architecture diagram of the device management system provided by the present disclosure;

FIG. 21-2 is a flow chart of equipment network and communication monitoring data access processing provided by the present disclosure;

FIG. 21-3 is a flowchart of crawler service processing provided by the present disclosure;

FIG. 21-4 is a flow chart of LoRa communication parameter access service processing provided by the present disclosure;

FIG. 22-1 is a schematic diagram of the signaling real-time tracking interface provided by the present disclosure;

FIG. 22-2 is a schematic diagram of the signaling real-time tracking details interface provided by the present disclosure;

FIG. 23-1 is a technical flow chart of the signaling tracking packet capture service provided by the present disclosure;

FIG. 23-2 is a flow chart of the signaling tracking signaling packet capture control service provided by the present disclosure,

FIG. 24-1 is a flow chart of network thermal analysis provided by the present disclosure;

FIG. 25-1 is a flow chart of the voice interaction technology of the human-computer interaction terminal and gateway provided by the present disclosure;

FIG. 25-2 is a flow chart of the video interaction technology of the human-computer interaction terminal and the gateway provided by the present disclosure;

FIG. 25-3 is a flow chart of the terminal data calibration technology based on the edge computing mode provided by the present disclosure;

FIG. 25-4 is a technical flow chart of dynamically adjusting sensor coefficients based on the edge computing mode provided by the present disclosure;

FIG. 26-1 is an overall architecture diagram of the intelligent data fusion platform provided by the present disclosure;

FIG. 26-2 is a flow chart of data collection provided by the present disclosure;

FIG. 26-3 is a flow chart of receiving the Internet of Things network protocol provided by the present disclosure,

FIG. 26-4 is the flow chart of the Internet crawler provided by the present disclosure;

FIG. 26-5 is a flow chart of data exchange provided by the present disclosure;

FIG. 26-6 is a flow chart of data storage provided by the present disclosure;

FIG. 26-7 is a data authentication analysis architecture diagram provided by this disclosure;

FIG. 26-8 is a flow chart of data authentication analysis provided by this disclosure,

FIG. 26-9 is a flow chart of data synchronization provided by the present disclosure;

FIG. 26-10 is a data lake structure diagram provided by this disclosure;

FIG. 26-11 is a structural diagram of the data intelligent fusion platform provided by the present disclosure:

FIG. 26-12 is a schematic diagram of the help of the present disclosure to the product;

FIG. 27-1 is a sensory data access architecture diagram provided by the present disclosure;

FIG. 27-2 is a flow chart of sensor data access provided by the present disclosure,

FIG. 28-1 is a fixed-point access architecture diagram of IoT sensor devices provided by the present disclosure;

FIG. 28-2 is a flow chart of fixed-point access of IoT sensor devices provided by the present disclosure;

FIG. 29-1 is a diagram of the data access architecture of multiple data sources based on the secondary development of DataX provided by this disclosure;

FIG. 29-2 is a flow chart of data access from multiple data sources based on the secondary development of DataX provided by this disclosure;

FIG. 30-1 is a data access load balancing architecture diagram provided by this disclosure;

FIG. 30-2 is a flow chart of data access load balancing provided by the present disclosure: FIG. 31-1 is a data analysis architecture diagram provided by this disclosure;

FIG. 31-2 is a flow chart of data analysis provided by the present disclosure;

FIG. 32-1 is a flowchart of online data processing based on real-time stream/batch provided by the present disclosure;

FIG. 33-1 is an overall flowchart of the dynamic configuration system for directional storage of IoT devices provided by the present disclosure;

FIG. 34-1 is a new data intelligent analysis architecture diagram provided by this disclosure;

FIG. 34-2 is a flow chart of the novel intelligent data analysis provided by the present disclosure;

FIG. 35-1 is a data fusion architecture diagram provided by the present disclosure;

FIG. 35-2 is a flow chart of data fusion provided by the present disclosure;

FIG. 36-1 is a flow chart of the cloud-based terminal device data reporting interval control technology provided by this disclosure:

FIG. 36-2 is a flow chart of terminal data reporting provided by this disclosure;

FIG. 37-1 to FIG. 37-2 are the flow charts (1 to 2) of the event bus service management of the industrial intelligent application platform provided by the present disclosure;

FIG. 38-1 is a general design diagram of the streaming media platform provided by the present disclosure;

FIG. 38-2 is a general flow chart for fetching streams provided by this disclosure;

FIG. 39-1 is an overall design diagram of multimedia backend message transmission provided by the present disclosure;

FIG. 39-2 is a diagram of regional deployment provided by this disclosure;

FIG. 39-3 is a schematic diagram of the server delivering events to users provided by this disclosure;

FIG. 39-4 is a schematic diagram of user-to-user communication provided by the present disclosure;

FIG. 39-5 is a schematic diagram of message storage provided by the present disclosure;

FIG. 39-6 is a flow chart of message synchronization provided by the present disclosure: FIG. 39-7 is an example diagram of the request flow provided by the present disclosure;

FIG. 40-1 is a diagram of the relationship between microservices and platforms provided by this disclosure:

FIG. 40-2 is a diagram of the relationship between the user terminal and the platform provided by the present disclosure;

FIG. 40-3 is a diagram of the relationship between an independent terminal and a platform provided by the present disclosure;

FIG. 41-1 is a schematic diagram of the message mechanism provided by the present disclosure;

FIG. 42-1 is a flowchart of the operation processing feedback mechanism provided by the present disclosure;

FIG. 43-1 is the interactive flow chart of the command and dispatch unified SDK provided by this disclosure:

FIG. 43-2 is the IMSDK interaction flowchart provided by this disclosure;

FIG. 43-3 is the RTCSDK interaction flowchart provided by this disclosure;

FIG. 43-4 is the VESSDK interaction flowchart provided by this disclosure;

FIG. 43-5 is the LBSSDK interaction flowchart provided by this disclosure;

FIG. 44-1 is a schematic diagram of the self-iteration of the mirroring algorithm implemented by the platform in the algorithm provided by the present disclosure;

FIG. 44-2 is a schematic diagram of the industry model that the platform can serve in the algorithm provided by this disclosure,

FIG. 45-1 is a schematic diagram related to the real-time carbon sink measurement method based on airborne lidar and hyperspectral provided by this disclosure;

FIG. 47-1 is a related schematic diagram of a method for measuring carbon sinks by monitoring stand growth provided by the present disclosure;

FIG. 47-2 is a schematic diagram of growth allometric equations of different tree species provided by the present disclosure;

FIG. 48-1 is a related schematic diagram of the method for simulating the impact of forestry scenarios on forestry carbon sinks provided by this disclosure;

FIG. 49-1 is a related schematic diagram of the method for retrieving forest management based on carbon sinks provided by this disclosure,

FIG. 50-1 is a related schematic diagram of the method for improving forest carbon sequestration capacity based on adjusting forest structure provided by this disclosure;

FIG. 51-1 is a flow chart of WRF-based deep neural network weather prediction provided by the present disclosure;

FIG. 51-2 is a diagram of the LSTM calculation process provided by this disclosure;

FIG. 52-1 is a flow chart of weather forecasting based on deep learning provided by the present disclosure;

FIG. 52-2 is a local space and level mapping diagram provided by the present disclosure;

FIG. 52-3 is a schematic diagram of an example of a unified standard provided by the present disclosure:

FIG. 52-4 is a schematic diagram of the adjustment angle ratio provided by the present disclosure, FIG. 52-5 is a schematic diagram of the model training+inference application process provided by this disclosure:

FIG. 53-1 is a schematic diagram of the weather model-based site dynamic correlation analysis technology provided by the present disclosure;

FIG. S4-1 is a flow chart of gridded emission source inventory processing provided by this disclosure;

FIG. 55-1 is an overall flowchart of the air quality forecasting system based on deep learning provided by the present disclosure;

FIG. 55-2 is a structural diagram of Transformer provided by this disclosure;

FIG. 56-1 is a WRF-Chem processing flow chart provided by the present disclosure;

FIG. 56-2 is a general flow chart of the air quality forecast model based on CMAQ and deep neural network time series model provided by this disclosure,

FIG. 57-1 is a related schematic diagram of the pollutant transport analysis algorithm based on the HYSPLIT model provided by the present disclosure;

FIG. 58-1 is a detailed diagram of the principle of the CMB model provided by this disclosure;

FIG. 58-2 is a detailed diagram of the principle of the CMB model provided by this disclosure;

FIG. 58-3 is the reasoning process of air pollutant source analysis based on the fusion method provided by the present disclosure;

FIG. 58-4 is a flow chart of the fusion and analysis of pollutant sources provided by the present disclosure;

FIG. 59-1 is a training diagram of the industry contribution quantitative analysis model based on deep learning provided by this disclosure;

FIG. 60-1 is a flow chart of the emergency rapid assessment of heavy atmospheric pollution provided by the present disclosure;

FIG. 61-1 is a schematic diagram of the training process of the river pollutant traceability and spread prediction algorithm provided by the present disclosure;

FIG. 62-1 is a flow chart of hyperspectral retrieval of vegetation water content provided by the present disclosure.

FIG. 63-1 is a calculation framework diagram of the Canadian FWI index provided by this disclosure;

FIG. 63-2 is a schematic diagram of the fire risk index calculated by CEFDRS provided by the present disclosure;

FIG. 64-1 is a flow chart of the smoke detection algorithm provided by the present disclosure,

FIG. 64-2 is an FTP file transfer diagram provided by the present disclosure;

FIG. 65-1 is a flow chart of the fire spread algorithm provided by the present disclosure;

FIG. 65-2 is an effect diagram of the forest fire spread model provided by the present disclosure;

FIG. 66-1 is an analysis diagram of fire behavior after 10 minutes of ignition provided by the present disclosure,

FIG. 66-2 is a fire behavior analysis diagram provided by the present disclosure after 30 minutes of ignition;

FIG. 66-3 is a fire behavior analysis diagram provided by the present disclosure one hour after the start of fire;

FIG. 67-1 is a flow chart of the personnel intrusion detection algorithm provided by the present disclosure;

FIG. 68-1 is a flow chart of the facial feature recognition algorithm provided by the present disclosure;

FIG. 68-2 is a network architecture diagram of the PyramidBox provided by this disclosure;

FIG. 69-1 is a flow chart of multi-camera multi-target detection, tracking and positioning provided by the present disclosure;

FIG. 71-1 is a Faiss flowchart provided by the present disclosure,

FIG. 71-2 is an IVF flowchart provided by the present disclosure,

FIG. 71-3 is a schematic diagram of product quantization provided by the present disclosure;

FIG. 71-4 is a flowchart provided by the present disclosure;

FIG. 72-1 is a flow chart of the face search system provided by the present disclosure;

FIG. 73-1 is a diagram of the knowledge map construction architecture provided by this disclosure;

FIG. 73-2 is a flowchart of knowledge map retrieval provided by the present disclosure;

FIG. 73-3 is an analysis diagram of the BILSTM operator provided by this disclosure;

FIG. 74-1 is the digital twin middle platform provided by this disclosure;

FIG. 74-2 is a schematic diagram of CIM data access provided by this disclosure;

FIG. 74-3 is a schematic diagram of CIM mapping provided by the present disclosure;

FIG. 74-4 is a schematic diagram of the CIM management platform provided by the present disclosure;

FIG. 74-5 is a schematic diagram of the capability engine provided by the present disclosure;

FIG. 75-1 is a related schematic diagram (1) of the artificial intelligence-based unified module component management platform provided by the present disclosure;

FIG. 75-2 is a related schematic diagram (2) of the artificial intelligence-based unified module component management platform provided by the present disclosure;

FIG. 75-3 is a related schematic diagram (3) of the artificial intelligence-based unified module component management platform provided by the present disclosure;

FIG. 75-4 is a related schematic diagram (4) of the artificial intelligence-based unified module component management platform provided by the present disclosure:

FIG. 76-1 is a spatial distance measurement diagram provided by the present disclosure,

FIG. 76-2 is a measurement map of the distance to the ground provided by the present disclosure;

FIG. 76-3 is a measurement diagram of the space area provided by the present disclosure;

FIG. 76-4 is a coordinate measurement diagram provided by the present disclosure;

FIG. 77-1 is a path planning diagram provided by the present disclosure;

FIG. 79-1 is a grid fine-grained management architecture diagram provided by this disclosure;

FIG. 80-1 is a schematic diagram of the knowledge fusion method for warnings, warning suggestions, and disposal solutions provided by the present disclosure;

FIG. 80-2 is a flow chart of fault/defect/malfunction prediction based on machine learning provided by the present disclosure;

FIG. 81-1 is an architecture diagram of the grid-based fine management system provided by the present disclosure;

FIG. 82-1 is a flow chart of integrated monitoring and alarm based on household water consumption and electricity consumption provided by the present disclosure;

FIG. 83-1 is a diagram of the overall architecture of the urban comprehensive operation and maintenance IOC provided by this disclosure;

FIG. 83-2 is a schematic diagram of the dynamic monitoring and early warning unit provided by the present disclosure;

FIG. 83-3 is a schematic diagram of the plan management provided by this disclosure;

FIG. 83-4 is a schematic diagram of the handling of cross-departmental incidents provided by this disclosure;

FIG. 83-5 is a schematic diagram of operational decision analysis provided by the present disclosure;

FIG. 83-6 is a schematic diagram of leadership cockpit management provided by the present disclosure;

FIG. 84-1 is a flow chart of the TTS voice broadcast technology provided by the present disclosure;

FIG. 84-2 is a flowchart of the STT-based multimedia input method provided by the present disclosure;

FIG. 84-3 is a flow chart of the VR technology-based plan demonstration and simulation technology provided by this disclosure;

FIG. 8S-1 to FIG. 85-6 are schematic diagrams (1 to 6) related to the cloud management platform provided by the present disclosure;

FIG. 86-1 is a schematic diagram of the blockchain security management platform provided by this disclosure;

FIG. 86-2 is a flowchart of the lightweight certification service provided by this disclosure;

FIG. 86-3 is a flowchart of another lightweight authentication service provided by this disclosure;

FIG. 86-4 is a flow chart of secure access & data uplink of IoT devices provided by this disclosure;

FIG. 86-5 is a block diagram of a security management component provided by the present disclosure;

FIG. 87-1 is a block chain system diagram of the Internet of Things provided by this disclosure;

FIG. 88-1 is a schematic diagram of the IoT security system based on the keyless signature technology provided by this disclosure;

FIG. 88-2 is a flowchart of the keyless signature provided by this disclosure,

FIG. 88-3 is a schematic diagram of data transmission signature verification provided by this disclosure;

FIG. 89-1 is a graph of pre-stored information of nodes and servers provided by this disclosure;

FIG. 89-2 is a flow chart of nodes sending data provided by this disclosure,

FIG. 90-1 is a diagram of the overall architecture of the unified operation and maintenance management platform system provided by the present disclosure.

### DETAILED DESCRIPTION OF THE INVENTION

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments. It is a part of embodiments of the present disclosure, but not all embodiments. Based on the embodiments in the present disclosure, all other embodiments obtained by persons of ordinary skill in the art without making creative efforts belong to the protection scope of the present disclosure.

In the description of the present disclosure, it should be noted that the terms “center”.

“longitudinal”, “transverse”, “upper”, “lower”, “front”, “rear”, “left”, “right”, “The orientations or positional relationships indicated by “vertical”, “horizontal”, “top”, “bottom”, “inner” and “outer” are based on the orientations or positional relationships shown in the drawings, and are only for the convenience of describing the present disclosure and the description is simplified, rather than indicating or implying that the device or element referred to must have a particular orientation, be constructed in a particular orientation, and operate in a particular orientation, and thus should not be construed as limiting the present disclosure. In addition, the terms “first”, “second”, “third”, etc. are used for descriptive purposes only and should not be construed as indicating or implying relative importance.

In the description of the present disclosure, it should be noted that unless otherwise specified and limited, the terms “installation”, “connection” and “connection” should be interpreted in a broad sense, for example, it can be a fixed connection or a detachable connection Connected, or integrally connected: it may be mechanically connected or electrically connected; it may be directly connected or indirectly connected through an intermediary, or it may be the internal communication of two components. Those of ordinary skill in the art can understand the specific meanings of the above terms in the present disclosure depending on the specific circumstances.

In addition, in the description of the present disclosure, unless otherwise specified, the meanings of “multiple”, “multiple roots” and “multiple groups” are two or more.

In the description of this specification, descriptions referring to the terms “one embodiment”, “some embodiments”, “example”, “specific examples”, or “some examples” mean that specific features described in connection with the embodiment or example, structure, material or characteristic is included in at least one embodiment or example of the embodiments of the present disclosure. In this specification, the schematic representations of the above terms are not necessarily directed to the same embodiment or example. Furthermore, the described specific features, structures, materials or characteristics may be combined in any suitable manner in any one or more embodiments or examples. In addition, those skilled in the art can combine and combine different embodiments or examples and features of different embodiments or examples described in this specification without conflicting with each other. Any embodiment and/or any example of the present disclosure can be freely combined under the condition of not contradicting each other, and the combination still belongs to the technical solution provided by the present disclosure.

The Internet of Things system, this disclosure provides the next-generation artificial intelligence Internet of Things system, which is based on a multi-mode heterogeneous network specially designed for smart twins/smart empowerment in various industries. Multi-mode heterogeneous networks are effectively innovated for existing wireless communications and networks. Improvement and innovation, through communication parameters, various networking methods and dynamic coordination and allocation of network resources, ubiquitous, dynamic and real-time effective communication has been realized, spectrum utilization and network resource utilization have been improved, and network capacity has been increased. Coverage capability and coverage performance are improved. Among them, ubiquitous mainly refers to widespread and ubiquitous networks. It is impossible for operator networks to achieve ubiquity based on their profitable nature. However, multi-mode heterogeneous IoT can be built according to location and needs, that is, it can be deployed at the required location. Corresponding multi-mode heterogeneous base stations. For example, in Daxing'an Mountains, there is almost no operator network coverage in the forest area, and it is impossible to achieve large-scale deployment of operator networks. However, multi-mode heterogeneous base stations can be deployed to cover target areas. According to business needs, communication needs and low cost requirements, a single base station requires a large coverage area (corresponding to a longer communication distance), and the base station group only provides limited overall bandwidth Secondly, dynamic means that the network is dynamically changeable. According to industry requirements or/and physical location, dynamically adjust any communication parameters to establish a network. In addition to mainstream communication modes, it also includes advanced networking methods such as Mesh, relay, and SDN Finally, real-time refers to the delay of communication. Real-time is relative. In different communication scenarios, real-time delays are not the same. In order to meet the above three conditions, the concept of multi-mode heterogeneity is proposed. As shown in FIG. 1E, B is dynamically determined according to A in FIG. 1E. Among them. A includes three situations: (1) industry requirements (2) environment of terminals, gateways, and base stations (such as: time, location, task, channel, etc.) (3) conditions of terminals, gateways, and base stations themselves (such as: energy, noise, interference, etc.). B in FIG. 1E further includes data, communication, network, etc. Exemplarily, in the first case, industry requirements refer to the different requirements for communication in different industries. For example, the environmental protection industry has the requirements of the environmental protection industry, the safety supervision industry has the requirements of the safety supervision industry, and the water conservancy industry has the needs of the water conservancy industry. Their needs are different, that is, due to the difference in the content to be delivered, the corresponding communication and network requirements are also different. In the second case, the environment where the terminal, gateway, and base station are located refers to the physical environment, that is, the physical environment where the terminal, gateway, and base station are located, which further includes time, location, task, and channel. In the last case, the conditions of the terminal, the gateway, and the base station include their own power, sensor values, and the change of the sensor value. A dynamically determines B, via adjusting parameters such as communication interval, transmission power, and modulation mode, for example. If the terminal's own power is low, the sensor value is lower than the set threshold, or the sensor value changes negligible, the frequency of transmission will be reduced. Further, as shown in FIG. 1E, the data in B indicates how to collect data, what data to collect, how to process data, how to use data, how to transmit data, etc.; and communication indicates what kind of communication settings, radio frequency parameters, transmission and reception mode, etc.; and the network indicates what kind of networking method and transmission path are used in the transmission process. Different communication requirements determine different communication strategies, such as high-quality communication requirements, strategies such as data splitting-multipath concurrency-convergence, real-time optimization of communication settings and radio frequency parameters, and construction of high-priority networks through core networks and base stations can be used, and can be dynamically allocated in actual situations.

The system covers multiple levels: from bottom to top, there are terminal layer, transmission layer, support layer, artificial intelligence business platform layer and city operation comprehensive IOC layer. In addition, the next-generation artificial intelligence Internet of Things system also includes: a security management platform, a unified operation and maintenance management platform, and IT resource services; wherein, the security management platform and the unified operation and maintenance management platform run through all levels vertically, providing a full chain, end-to-end Terminal services: IT resource services provide services for the support layer, artificial intelligence business platform layer and city operation comprehensive IOC layer. The present disclosure will be further described below in conjunction with the accompanying drawings and embodiments:

Please refer to FIG. 1A and FIG. 1B together. The terminal layer includes thousands of terminals of different industries, different types of sensor, linkage, multi-mode heterogeneous communication, mobile and/or video. Among them, the sensing terminal can detect the multi-dimensional state of the city ubiquitously, in real time, and dynamically, such as water, gas, electricity, soil, sound, fire, etc. and the sensing data can dynamically adjust the multi-mode heterogeneity of any communication parameters according to industry requirements or/and physical location. The network uploads to the central platform. Further, the sensing terminal may be various sensors with data collection functions or electronic devices with sensors, for example, temperature sensors, smoke sensors, atmospheric pressure sensors, sound wave sensors, image sensors, cameras, etc.

In this embodiment, the linkage terminal can realize the linkage that the edge side detects and executes based on the multi-mode heterogeneous network that dynamically adjusts any communication parameters according to industry requirements or/and physical location, such as linkage alarm, linkage call, linkage control valve/door, linkage SMS/email notification, etc Multi-mode heterogeneous communication terminals provide those sensors that do not have communication transmission capabilities to dynamically adjust transmission and interconnection according to industry requirements or/and physical locations. Support composite sensing technology, multi-sensor data fusion, and support unified access of sensing devices from different manufacturers. Sensor technology combined with edge computing technology realizes edge correction and self-correction of sensor data, and an optimized sampling strategy is derived from it, such as dynamically changing the sampling interval, sampling accuracy and sending frequency, etc. so the response time, power consumption of the whole machine, and network bandwidth occupation can be taken into consideration at the same time. Further, the edge computing method includes: collecting data by several sensing terminals; judging whether the data collected by the sensing terminals is abnormal; The information is sent to all second devices connected to the first device; the second device sends the second alarm information to all alarm devices connected to the second device. Wherein, both the first device and the second device may be edge devices or intermediate devices. In this embodiment, the edge device can be used for data packet transmission between the access device and the core/backbone network device, and can be a switch, router, routing switch, gateway, IAD and various devices installed on the edge network. MAN/WAN and other equipment. With the addition of edge computing, the data collected by the sensing terminal can let the local device know which function to perform without shuttling between the local and the central server. In this way, operating costs and storage equipment investment can be saved. In addition, edge computing or fog computing or algorithm platforms are used to judge the information that needs to be uploaded by communication terminals (such as sensory terminals or gateways or base stations) and the matching communications and networks. The data difference value, characteristic value and/or characteristic value of image and video of the data. As an example, the matching communication and network are output through dynamic deployment of multi-mode heterogeneous networks. For example, when the data difference of the data collected by the sensing terminal exceeds the threshold range, or conforms to a specific image or video characteristic value, or conforms to a specific sound wave characteristic, it can be determined that the collected data is abnormal, and then an alarm message and perform other further operations (at the same time, the multi-mode heterogeneous network dynamically allocates network and communication resources) When the collected data is not abnormal, the sensing terminal can reduce the frequency of collecting data and transmit it through the matching communication and network, which reduces the waste of communication resources and saves the energy of the communication terminal. Mobile terminals include handhelds, walkie-talkies, vehicle-mounted devices, positioning terminals, wearable terminals, etc. which detect, apply, and communicate in a mobile state, through multi-mode heterogeneous networks that dynamically adjust any communication parameters based on industry requirements or/and physical locations to realize the combination of broadband, medium and narrowband, and the application of voice/video/text/picture/data/file fusion communication. Video terminals include diverse video sensing terminals such as cameras, thermal imaging, and hyperspectral, and upload through a multi-mode heterogeneous network that dynamically adjusts any communication parameters according to industry requirements or/and physical locations.

Further, as shown in FIG. 2-1, all terminals in the terminal layer (including terminals for sensing, linkage, multi-mode heterogeneous communication, mobile and/or video, etc.) establish communication connections between each other. In the way of establishing direct communication between terminals, any terminal can obtain the sensing data of other multiple terminals, and can make decisions and generate execution commands based on the sensing data of multiple terminals, that is, it can comprehensively sense the data to generate decision results, so that the decision result is more reliable, and even in the case of a gateway network failure, the sensing terminal can still obtain the data of other terminals based on the direct communication between the terminals for edge computing and then generate execution commands under specified conditions, that is, the network failure will not affect generation of decision results. Further, the communication mode between terminals is different from the communication mode between the terminal and the gateway. For example: different communication channels, modulation methods, synchronization bytes, etc. are used between the terminal and the terminal and between the terminal and the gateway; the load content transmitted between the terminal and the terminal can use different protocols; the communication between the terminals can use different channels (It may also include different modulation methods, data rates, coding methods, etc.), as shown in FIG. 2-2, so as to reduce the conflict with the communication between the terminal and the gateway.

Please refer to FIG. 1 and FIG. 1B together. The communication layer/transport layer is a multi-mode heterogeneous intelligent IoT composed of base stations and gateways. It dynamically adjusts any communication parameters according to industry requirements or/and physical locations to establish a network. In addition to the mainstream communication mode, it also includes advanced networking methods such as Mesh, relay, and SDN, providing network support for fixed-mobile convergence, combination of broadband, medium-narrow, and voice/video/text/picture/data/file communication for the terminal layer. The communication layer/transport layer can be understood as the root of the tree, which is the bridge connecting the tentacles and the trunk of the tree. The transmission layer uploads the sensing, control, status and other information of the tentacles to the support layer (trunk of the big tree) through wireless/wired means.

Furthermore, the base station covers various communication networks such as satellite, private network, WLAN, bridge, public network, and multi-mode heterogeneous network, and dynamically adjusts any communication parameters according to industry requirements or/and physical location to establish a network. For example, it supports data splitting and aggregation for multi-path transmission. As shown in FIG. 16-1, the terminal splits the sends data packet into multiple data sub-packets, and different data sub-packets are transmitted through different communication methods and different paths, and then spliced into a complete data packet after being aggregated at the receiving end. In the figure, terminal 1 has a multi-mode communication mode, and can simultaneously connect to three base stations of different standards, base station 1, base station 2, and base station 3. When transmitting data, it transmits data simultaneously through three base stations, and performs data aggregation and splicing on the core network/server side. Different strategies are adopted according to needs during multipath transmission. For example, when the equipment in the blind area cannot be directly connected to the base station, a mesh network can be established with other equipment, and uplink communication can be realized with the help of equipment that can be connected to the base station: as shown in FIG. 16-1, terminal 6 and terminal 7 pass through terminal 5, terminal 2 and terminal 8 by establishing a mesh network among them, and connecting to the base station through terminal 5 and terminal 8. Terminal 5. Terminal 2 and Terminal 8 undertake routing functions. The device can be switched between the star network and the mesh network; when working in the mesh network mode, the terminal can be used as a routing node or a normal node. The communication network supports point-to-point intercommunication between devices, reducing the bandwidth occupation of the base station. The core network and the base station can collect the link information of the base station, routing node, and terminal, including: communication standard, communication path, signal-to-noise ratio, packet loss rate, delay, channel occupancy rate, etc. and use deep learning to make link prediction and then deduce better networking and communication solutions, adaptively adjust the connection mode of the device (directly connected to the base station, mesh network, point-to-point), transmission path (single-path, multipath), communication parameters (modulation mode, rate, spectrum occupancy, communication bandwidth). For example, as shown in FIG. 16-2, it provides a method to achieve network coordination only by adjusting power and rate. The higher the power, the farther the transmission distance, but the larger the signal coverage area during the transmission process, the more likely it will affect the communication of other nearby devices. The higher the rate, the shorter the communication time, and the less resources are occupied by frequency resources, but the closer the communication distance. In the figure, base station 1 is busy with many devices, while base station 2 is relatively idle. To reduce the busyness of base station 1, terminal 2 and terminal 4 use high-power and high-speed transmission. The transmission process may affect base station 2, because the base station 2 is relatively idle and can accept this effect. Terminal 3 and terminal 5 transmit through base station 2 with low power and low rate as much as possible, because the low power has little impact on base station 1. Terminal 1 can only transmit at high power and low rate due to the long distance, while terminal 6 can transmit at low power and high rate because it is close enough to base station 1.

In this embodiment, the gateway includes different types of edge AI, security, positioning, video, mid-range communication, CPE, RFID, technical detection, etc. and can realize network interconnection with different high-level protocols, including wired and wireless networks, according to industry Require or/and physical location to dynamically adjust any communication parameters. Please refer to FIG. 15-1. The gateway supports the connection of multiple terminals in multiple connection modes. The multi-connection modes include LPWA. Ethernet, Wifi and other wired connections and wireless connections (such as Bluetooth, Zigbee and private wireless communication, etc.). Local terminals in different connection modes have independent identification numbers, and manage and communicate like normal terminals. The gateway also has a communication network service function, which can maintain normal communication when the network is disconnected, and can automatically synchronize status and data with the server after networking. The gateway has an edge computing framework, and can configure edge computing functions arbitrarily. It can realize data cleaning, aggregation, calculation, and decision-making locally, and can directly issue decision-making instructions locally to designated terminals at the terminal layer. Further, the gateway supports a display screen, which can directly display system status and data reports generated by edge computing, and also provides user interaction functions such as camera and audio to realize edge multimedia applications. Further, in the embodiments of the present disclosure, the base station/gateway can have its own distributed edge core network (or communication server), and can automatically switch to the edge core network when the connection with the server core network is interrupted; in case of network disconnection. The base stations/gateways can be networked wirelessly or wiredly, and one of the base stations/gateways serves as the core network. The edge core network provides layered and regional communication in the case of disconnected and weak networks, and provides the necessary support for data exchange for domain-based edge computing.

The support layer is the core of the next-generation artificial intelligence Internet of Things system or industrial Internet system. It can be understood as the backbone of a big tree. All data and services required by the upper-level business are provided by the support layer. The detection, control and other data at the root of the big tree will enter the crown and each branch through the support layer. In this disclosure, the supporting layer mainly includes a multi-mode heterogeneous IoT sensing platform, a data intelligence fusion platform, a digital twin middle platform, an artificial intelligence industry algorithm middle platform, a converged communication middle platform, and a streaming media platform. The above-mentioned platforms will be described in detail below in conjunction with the accompanying drawings.

Further, as shown in FIG. 17-1, the multi-mode heterogeneous IoT sensing platform is used to aggregate data at the terminal layer and transport layer, support device management at the terminal layer and transport layer, and provide information based on industry requirements or/and multi-mode heterogeneous network services and edge computing services that dynamically adjust any communication parameters in physical locations. Among them, the multi-mode heterogeneous network service not only provides separate access and management services for different network communications such as existing satellite links, cellular network links, RFID network management, LTE core network, WLAN network management, and LoRa core network; The wireless access service of the multi-mode heterogeneous core network supports the integrated access and unified management of the multi-mode heterogeneous wireless network. Multi-mode heterogeneous network services provide network services that dynamically adjust any communication parameters according to industry requirements or/and physical locations, such as adjustable physical communication parameters such as source coding, channel coding, modulation modeling, signal unit time slot, and transmit power; The wireless link access and management technology that can be flexibly scheduled and expanded can perform functions such as remote control, upgrade, parameter reading/modification, and management of equipment, support link self-healing, and provide high-utilization, strong stability, and easy recovery of professional wireless network hosting services. For example, please also refer to FIG. 1F, which is a schematic diagram of multi-mode heterogeneous communication links in the next generation Internet of Things. As shown in the figure, the data is sampled first, and the sampling interval can be set according to requirements (for example, it can be sampled once every minute, or once every second). Then A/D conversion is performed on the sampled data to convert the analog data into digital data, and the accuracy of the A/D conversion can also be set according to needs: it can be 8 bits, 12 bits, 16 bits, 24 bits, etc. The digital data is then transmitted through the RF (radio frequency circuit) after the source coder performs source coding, the channel coder performs channel coding, and the digital modulator performs digital modulation. Wherein, information source encoding may be implemented based on one or more protocols, such as MPEG-1, MPEG-2, MPEG-4, H.263, H.264, H.265, etc. The types of channel coding mainly include: linear block codes, convolutional codes, concatenated codes. Turbo codes, and LDPC codes. Digital modulation methods include: FSK (Frequency Shift Keying), QAM (Quadrature Amplitude Modulation), BPSK (Binary Phase Shift Keying), etc. Multi-mode heterogeneous network services provide network services that dynamically adjust any communication parameters according to industry requirements or/and physical location, such as adjustable source coding, channel coding, modulation modeling, signal time slot, transmission power and other physical communication parameters. For example, transmitting RF signals can be adjusted through PA (determining the transmitting power) and fn (determining the transmitting frequency point). Exemplarily, the adjustment includes allocating different transmission bandwidths to different services, and when the data transmission requirements of some terminals change, the multi-mode heterogeneous network adjusts the allocation of network resources to adapt to the demand changes. Exemplarily, the adjustment includes priority adjustment of signal transmission. For example, signals from some terminals are transmitted preferentially. For example, the data of some base stations or gateways are transmitted preferentially. For example, some service signals of the terminal are transmitted preferentially. The multi-mode heterogeneous network adjusts network parameters in a timely manner based on site detection and business requirements, which can ensure the implementation of important upper-layer services and improve the availability of the multi-mode heterogeneous network. Further, the adjustment includes dividing different data into different data streams and transmitting them through different communication paths. For example, part of the data is transmitted to the upper-layer business through the 4G network, part of the data is transmitted to the edge computing module via LoRa protocol, and part of the data is transmitted via a custom multi-mode heterogeneous communication network protocol. On the premise of meeting the business transmission requirements, reduce the consumption of network resources as much as possible, and dynamically adjust communication and network in real time according to changing business needs. In addition, the edge computing service is aimed at accessing multi-mode heterogeneous networks, providing dynamic and adaptive network allocation with edge computing capabilities of the converged network, and providing different extensions to meet the needs of different industries and different physical environments. Dynamically, automatically, and rationally allocate communication and network resources for networks of different time delay, different bandwidth, and different time slot. For example, the environmental protection industry requires timely data sampling and low-latency reporting, but thousands of sites report data at the same time, and the concurrency of sending at the same time is very high, but the time interval between two adjacent reports may be very long, which requires our edge computing services to provide support to dynamically and reasonably allocate network resources, such as deploying other non-time-sensitive devices to avoid avoidance, such as temporarily deploying multiple communication channels, such as sampling on time but uploading at a wrong time.

Further, as shown in FIG. 26-1, the intelligent data fusion platform is used to provide cross-departmental and cross-industry multi-source heterogeneous data collection and aggregation, data cleaning, and data integration including structured, semi-structured, and unstructured Fusion, resource catalog and data sharing exchange services. Among them, data aggregation can be connected to the sensing data uploaded by the multi-mode heterogeneous IoT sensing platform, and the data shared by other third-party platforms or upper-lower platforms, and unified aggregation forms a data lake. The data lake also aggregates business data/control data/algorithm early warning data/required data of different industries/physical location data, etc. that are generated or need to be interacted with other sections (business section, other support sections). Data cleaning, fusion, and resource catalog mainly manage and classify the aggregated data to form various theme libraries and special libraries, etc. to facilitate the extraction of different business data. Support platforms such as streaming media platforms and artificial intelligence business platforms provide the data they need. Data sharing and exchange, providing data sharing and exchange with third-party platforms and upper and lower platforms. In this embodiment, the data lake warehouse is composed of a database cluster, a data warehouse, and a file system. The database cluster mainly stores business data to ensure daily business flow, and the data warehouse stores the collected raw data and data ETL (extraction, conversion, loading), data governance, and data mining result data, the file system mainly stores unstructured data files including database backup files; data services are based on a complete set of data systems implemented on the data lake warehouse, including application systems for any operation of the data lake warehouse, and provide service support to the business platform. In a nutshell, the intelligent data fusion platform can realize multi-industry access, including multi-industry data such as air, weather, soil, transportation, construction, water quality, fire insurance, etc. including environmental protection, fire protection, and municipal administration. Integration to break through industry barriers; at the same time, the intelligent data fusion platform also provides multi-source heterogeneous data access, including data sources such as databases, file systems, and message queues, as well as structured, semi-structured and unstructured data sources. Data sources can Unlimited expansion, data capabilities can be copied infinitely, providing huge data resources for various business scenarios; its data specifications are unified, providing a unified data dictionary and data specifications, reducing development costs and improving data quality. It should be understood that because of the network communication data transmission between the multi-mode heterogeneous IoT network and the intelligent data fusion platform, the continuous access and downlink of data in different formats in the intelligent data fusion platform is dynamically realized. Operation, so that the data sources in the data lake of the data intelligent fusion platform can be expanded infinitely, and the data capabilities can be copied infinitely, providing huge data resources for various business scenarios. In this embodiment, the data sources in the data lake of the intelligent data fusion platform include, data from sensing terminals, communication big data, external data, and data generated by the platform in the algorithm.

Further, the function of the streaming media platform mainly includes two parts: the first is to provide video recording, PTZ control, streaming media, SDK, ONVIF, etc. international standard agreement and other services to support the artificial intelligence business platform. In addition, the interaction between the streaming media platform and the intelligent data fusion platform includes that the streaming media platform receives information such as video, pictures, and streaming media access of the intelligent data fusion platform, and the streaming media platform feeds back control information, screenshot information, etc. to the intelligent data fusion platform and stored in the corresponding theme/theme library. The streaming media platform supports sending control commands to terminals in corresponding industries and corresponding physical locations through a multi-mode heterogeneous network to realize terminal control. In this embodiment, as shown in FIG. 38-1, the access layer of the streaming media platform is responsible for the interconnection of devices and lower-level domains, as well as the acquisition of original media data, and reports the information after abstracting it. The core layer is responsible for the unified management and control of equipment and services, shielding the differences of different access methods from the outside, and providing core APIs (such as streaming, video recording, PTZ control, and device control). The cascading layer service is connected to the upper-level domain. The application service layer handles business logic and authority control. The streaming media platform supports multi-protocol access (GB/T28181, ONVIF, various SDKs, network video streams, live streams); supports multi-protocol playback (RTSP, RTMP, FLV. HLS). It can adapt to various network environments (such as multi-mode heterogeneous networks), dynamically configures policies to control when the flow is disconnected and when it is pulled up, and supports screenshot plans and recording plans; it can be connected with algorithms to deeply mine data. At the same time, the streaming media platform supports national standard platform cascading and supports GA/T1400 view library.

Further, the converged communication center provides a multi-mode heterogeneous network based on dynamically adjusting any communication parameters according to industry requirements or/and physical location to realize the fusion of different types of data or files such as text, voice, picture, video, location, attachment, etc. Communication service. Converged communication services include data uplink and downlink. Uplink includes uploading of different types of data and files, and downlink includes downlinking of different types of data and files to terminals in corresponding industries and/or physical locations. Its main services include. (1) Provide integrated communication services for different types of data or files such as text, voice, pictures, videos, locations, attachments, etc. to support the artificial intelligence business platform. For example, voice chat not only supports voice, but also supports sending and receiving different types of data and files, and event reporting supports the use of text, adding information such as voice, video, pictures, positioning or attachments, etc. (2) Access to text, voice, picture, video, location, file and other data provided by the intelligent data fusion platform. The data of the intelligent data fusion platform comes from the multi-mode heterogeneous network of the terminal and communication layer. It supports feeding back the data generated by the fusion communication to the intelligent data fusion platform and storing it in the corresponding theme/theme library. (3) For converged video communication, the streaming media platform provides camera control and streaming media services for the converged communication center. Some control information can be downlinked to terminals in corresponding industries and corresponding physical locations through multi-mode heterogeneous networks. In a nutshell, the converged communication center can be understood as an interactive system (data types include video, voice, text, pictures, location, files, etc.), the data is bidirectional, and the data can flow between the platform and the terminal and/or Or, between terminals and between multiple terminals and platforms (similar to groups). The streaming media platform mainly focuses on the uplink data collection and downlink control of cameras. The integrated communication platform of the present disclosure realizes comprehensive sensing, information fusion, instant communication and intelligent control through the interconnection of “people and people”, “things and people” and “things and things” (based on multi-mode heterogeneous networks).

Further, the artificial intelligence industry algorithm center is used to provide artificial intelligence algorithms with management services such as algorithm deployment, algorithm configuration, algorithm training, and algorithm viewing/importing/deleting/upgrading. The inputs or video sources of the platform in the artificial intelligence industry algorithm are aggregated and uploaded from multi-mode heterogeneous networks that are dynamically deployed according to industry requirements or/and physical locations, including various sensor data, alarms, and video data. At the same time, data such as linkage control, linkage shouting, linkage alarm, linkage SMS/e-mail notification generated in the artificial intelligence industry algorithm platform are dynamically downloaded to corresponding terminals through multi-mode heterogeneous networks according to industry requirements or/and physical locations. In this embodiment, the artificial intelligence industry algorithm platform supports unified management and operation and maintenance of computing power and service resources, and can realize fog computing, edge computing and artificial intelligence according to industry applications, computing power, network and communication conditions. In the industry algorithm, with the platform's own computing power and dynamic allocation of algorithm tasks, the containerized cluster mode is adopted to support elastic scheduling of computing resources, and automatic expansion and contraction are realized according to actual configuration scenarios and dynamic allocation of multi-mode heterogeneous communication networks to improve the utilization rate of computing resources. Secondly, the platform in the artificial intelligence industry algorithm can access the input parameters and video data required by different algorithms uploaded by the data intelligent fusion platform, and can output alarms/characteristic values to the artificial intelligence business platform to realize the artificial intelligence-based and the early warning view of the algorithm. In addition, the alarms/characteristic values generated by the platform in the artificial intelligence industry algorithm will also be fed back to the data intelligent fusion platform and stored in the corresponding theme/special library. For example, for video algorithms, the artificial intelligence industry algorithm center can retrieve the required videos/pictures through the streaming media center. For example, for prediction algorithms such as fire spread prediction and gas diffusion prediction, it is necessary to display the predicted diffusion range after a period of time (such as one hour) in a three-dimensional form. In such cases, the artificial intelligence industry algorithm center will provide data such as eigenvalues and predictive simulations to the digital twin center described below.

The following describes in detail the method for implementing mirroring in the artificial intelligence industry algorithm of the present disclosure in combination with FIG. 44-1 and FIG. 44-2:

As shown in FIG. 44-1, the self-iterative steps of implementing the mirroring algorithm in the algorithm center include: first, upload the algorithm image to the algorithm center; then, based on the algorithm image, install the corresponding algorithm instance; run the algorithm mirror service based on the algorithm instance; collect negative samples of the production data of the running algorithm mirror service; then, retrain the algorithm mirror, improve the model accuracy and generalization ability, and produce a new algorithm mirror.

As shown in FIG. 44-2, the platform in the algorithm provides processing capabilities to the outside world through APIs or push messages.

In a nutshell, the artificial intelligence industry algorithm platform in the embodiment of the present disclosure takes computer vision algorithms as the core, and the algorithm model covers mainstream industries, and supports the rapid deployment, management, and demonstration of massive mature algorithms integrated in the platform, which is applicable to any algorithm model. For scenarios with automation requirements, through a unified entrance, integrated computing resources are provided, shared services, and development costs are reduced. It is suitable for scenarios that require centralized management and maintenance of algorithm models, provides standardized API interfaces and documents, and develops standardized AI capabilities. The artificial intelligence industry algorithm platform can carry out standardization and platform management, and the integration is simple, which also simplifies the development process; it provides an operation and monitoring mechanism for the algorithm model to ensure the stability of the service provided by the model; it provides access to the algorithm data set unified channels, standardization and unification of data format standards; provide a unified evaluation index system for algorithm models, and reflect the generalization ability of algorithm models on the platform; perform data aggregation and analysis on algorithm calculation results; The model can also provide a continuous improvement and iterative model quality system; it has the whole process management of the algorithm model generation and optimization process, it provides a system for the operation and maintenance management and performance evaluation of the algorithm model, and dynamically allocates and manages computing power resources. As an independent middle-end product, it can provide external service capabilities, and conduct statistical analysis on the resources, data and operation status of the provided services and instances.

Further, the digital twin platform is based on the dynamic sensor data of different industries and different locations uploaded by multi-mode heterogeneous networks, and provides urban 3D twin services for the artificial intelligence business platform. The CIM, AR, VR, BIM, GIS, etc. required by the artificial intelligence business platform all require the support of the digital twin platform. In this embodiment, the data generated by the modification and definition of maps, layers, key points, etc. in the digital twin platform will also be fed back to the intelligent data fusion platform and stored in the corresponding theme/theme library. The digital twin middle platform of the embodiment of the present disclosure provides synchronization and operation mapping capabilities between various types of physical equipment and twin models; provides the middle platform architecture and implementation method of digital twin general capabilities; provides the expansion technology of the capability engine and multiple dimensional performance-balancing technical architecture; provides the capabilities of AR engine, VR engine, and CIM visualization engine for unified management, integrated release and service provision. Exemplarily, as shown in FIGS. 74-1 to 74-5, the digital twin middle platform provided in an embodiment of the present disclosure is a middle platform that provides unified digital twin services and provides a CIM model engine for business systems Support and interaction layer docking.

Furthermore, the artificial intelligence business platform layer displays, analyzes, predicts, forecasts, rehearses, etc. data uploaded by multi-mode heterogeneous networks in different industries and different physical locations, and provides artificial intelligence-based unified module component management and smart applications in different industries, receive the data of each support platform, and feed back the operation information of the business end to each support platform. At the same time, some operational data can be dynamically adjusted according to industry requirements or/and physical location, and sent to the terminal through the communication layer to realize linkage. Exemplarily, referring to FIG. 75-1 to FIG. 75-4, the artificial intelligence business platform layer provided by an embodiment of the present disclosure includes: organization management module, user management module, role management module, authority management module, log management module, thematic project modules and common component library modules. The artificial intelligence business platform layer provided by an embodiment of the present disclosure can flexibly and quickly configure cross-application, cross-system, and cross-role projects through unified authentication, and establish a unified authentication center and authentication gateway from a business perspective Through the decentralized authentication method, it breaks the bottleneck of authority reuse and unification of various technical platforms and business platforms. In a nutshell, this disclosure can flexibly and quickly configure cross-application, cross-system, and cross-role projects through unified authentication; through decoupling and stripping business modules, each independent module supports asynchronous development, reducing the overall situation in the development process. Problems can improve development efficiency: through unified public technology modules, services can be separated and formed, and when the service is needed again, it can be completed through interface calls, avoiding prolonging the development cycle and saving development time and resource sampling business processes. The modules are encapsulated into public business process modules, which can be reused directly when encountering the same business process scenarios, reducing the cost of trial and error; solving the pain points of many project research and development links, inability to integrate uniformly, and lack of unified development standards and operation and maintenance mechanisms; implementation technology. The integrated application of, business and data can reduce R&D costs, realize rapid business response, data accumulation and efficiency improvement.

Furthermore, the city operation comprehensive IOC layer is used to integrate data from various industries to realize an overview of the city's overall situation, monitoring and early warning, command and dispatch, event handling, and operational decision-making. The bridge/support of various aggregation and downlink data of the city operation comprehensive IOC layer relies on the multi-mode heterogeneous network established by dynamically adjusting any communication parameters according to industry requirements or/and physical location. The integrated IOC layer of urban operation provided by this disclosure is applicable to comprehensive urban operation scenarios at the district and county levels, prefecture-level cities, provincial departments, and ministerial and commission levels. Contingency plan management, hierarchical event handling, big data operation decision analysis and leadership hierarchical management decision-making. In addition, the urban operation comprehensive IOC layer is suitable for accessing and converging the data and processes of various government commissioned units, enterprises and institutions, and performing unified data cleaning, data standardization, early warning rule definition, and monitoring and early warning. Applicable to various secure network environments, it provides secure data access management and comprehensive urban operation functions. It is suitable for departments and personnel of government commissioned units at all levels, enterprises and institutions. It is suitable for centralized deployment and distributed deployment environments, and is suitable for user groups of different sizes and various complex circulation processes. Exemplarily, as shown in FIG. 83-1 and FIG. 83-6, the city comprehensive operation IOC platform provided by an embodiment of the present disclosure is divided into five components, namely, dynamic monitoring and early warning, plan management, cross-department event handling. Run decision analysis and leadership cockpits. The city operation integrated IOC layer provided by an embodiment of the present disclosure solves the barrier problem of existing data islands in the existing city comprehensive operation system products, integrates information system data of various industries in smart cities, unifies data standards, and unifies data cleaning and unified data exchange, this disclosure solves the problem that the urban comprehensive operation system cannot open up the event handling process between various departments; establishes a closed loop of urban comprehensive operation functions, making urban comprehensive operation more efficient. Further, as shown in FIG. 1, the functions of the dynamic monitoring and early warning module and visual command and dispatch included in the comprehensive urban operation IOC are as follows: the dynamic monitoring and early warning module is used to use the data of the intelligent data fusion platform, and use the real-time Data, with the help of artificial intelligence industry algorithm middle platform, and the visualization function of digital twins, the visual command and dispatch module is used to use the integrated communication middle platform, and then associate with multi-mode heterogeneous core networks, use streaming media platforms to view camera terminals, use digital twins platform for displaying personnel, resources, terminals, etc. In this disclosure, the security management platform starting with multi-mode heterogeneous network security can provide security support for the steps of data collection, data transmission, and data processing of each terminal/device in the Internet of Things, and can solve illegal intrusion, data leakage, any issues related to data security such as external attacks; the security system starts with multi-mode heterogeneous network security, and dynamically controls security from the root, rather than only ensuring security at the platform layer. The security management platform provided by this disclosure is applied in the multi-mode heterogeneous system as shown in FIG. 1, the terminal layer (including various sensors, etc.), communication layer (including base stations, gateways, etc.) of the multi-mode heterogeneous system in this embodiment.), and the supporting layer (including the data center, core network, etc) interacting with each other, so as to perform dynamic and linkage control on the entire multi-mode heterogeneous system to ensure data security and communication security. The security management platform provided by an embodiment of the present disclosure is suitable for any scenario where IoT devices are safely connected to the cloud; it is suitable for securely connecting any type of third-party platform data, providing a secure channel and data tamper-proof function; applicable for use in combination with multiple communication types, that is, to meet the needs of multi-mode heterogeneous networks; it is suitable for scenarios where IoT device data, user-generated data, and third-party access data are safely accessed and uploaded to the blockchain for protection. Referring to FIG. 86-1 and FIG. 86-4, the blockchain security management platform of this embodiment is divided into three components, namely security resources, security services, and security management. Among them, the security resource component includes a password resource pool, a key management system, a signature verification system, and a data encryption and decryption system. The password resource pool is pre-configured, and then based on the password resources and encryption and decryption algorithm resources in the password resource pool, a key management system, a signature verification system, and a data encryption and decryption system are established. Security management components include communication security, network security, data security, situational awareness, emergency response, knowledge graph, user management and other systems. Among them, communication security, network security, and data security provide security situation awareness data for situational awareness; situational awareness analyzes the security situation; situational awareness provides the results to emergency response, and emergency response notifies relevant security personnel, then the entire security event stored in the knowledge map for storage and recording; the knowledge map provides basis support for the configuration of communication security, network security, and data security, forming a closed loop. Security service components include lightweight authentication services, security authentication services, and blockchain services. The security service component is based on the security resource component and under the call management of the security management component, it provides security services to the business system and the IoT terminal.

In this disclosure, in combination with FIG. 89-1 and FIG. 89-2, the difficult problem of device key distribution and storage is solved. The blockchain security management platform utilizes the chain formed by ready-made terminals, gateways and base stations, and utilizes their location (such as longitude, latitude, height and other coordinate data), communication parameter information, time information, data packet sequence information and other row data to calibrate authentication and encryption. The receiver uses the corresponding information for reverse verification and decryption. The path (the path is defined by the geographic location information of the gateway through which the data passes) is converted into a key for encryption, and the receiver checks the path information to determine whether the data is legal. The receiver needs to know or collect legal paths in advance, or location information of legal path points (such as gateways). It should be noted that the data transmission path is different, the decryption key is different, the next node knows the location information of the previous node, and the adjacent layer times use different keys to encrypt and decrypt. Or, instead of decrypting at the intermediate node, the data is encrypted layer by layer and then transmitted to the server or the cloud, and the server or the cloud performs multiple rounds of decryption on the data. Or, only the first node performs encryption, and the intermediate nodes passing through the transmission perform integrity verification and digest superposition on the data, and the server or cloud performs reverse integrity verification according to the transmission path After the verification is passed, the first node information is decrypted. The encryption process runs from the data source (sensing terminal layer), through the communication layer/network layer, to the multi-mode heterogeneous core network layer, and then to the full coverage of the support layer and application layer, instead of only ensuring security at the platform layer.

Referring to FIG. 89-2, the first sensing terminal at the terminal layer needs to transmit Data1 data to the first server, and the first sensing terminal has a unique device ID1, HMAC1 key and public-private key pair {NPkey 1, NSkey1}; the first server has a public-private key pair {CPkey, CSkeya} The first sensing terminal has a real-time clock and latitude and longitude location data, and sends data Data1 to the first server at time T1 and location L1. Among them, the encryption process includes: (1) use the server public key CPkey to encrypt T1 and Data1 to obtain the Ciphertext E1; (2) use the private key NSkey 1 to digitally sign ID1 and E1 to obtain the signature S1; (3) use the HMAC1 key to perform hash operations on E1 and S1 Obtain the hash value H1: (4) Send the data ID1, E1, S1 and H1 to the first server, and the first server will decrypt it. As an example, encryption can also be generated at the sensor terminal or gateway according to needs.

In some embodiments, each node in the transmission can perform a superposition hash algorithm on the data, and after receiving the data packet, the server performs a bash algorithm on the information of the sending node and the intermediate node one by one to ensure the integrity and authenticity of the data sex. Continuing from the above example, in step (4), it also includes: the first sensing terminal sends data ID1, E1, S1 and H1 to the first server and passes through several communication nodes in turn, wherein the communication nodes can be gateways, base stations, communication nodes, etc. devices involved in communication. Each node performs a superposition hash algorithm on the data sent by the previous node: after receiving the data IDn, En, Sn and Hn sent by node n, node m obtains the real-time time Tm and location Lm. Then the hash value Hm is obtained through the hash algorithm, and finally, the data IDm, IDn, En, Sn and Hm are sent to the next communication node, and so on, and finally the data is sent to the server. The encryption method provided by the embodiments of the present disclosure ensures the confidentiality, integrity and availability of data, and can resist common communication attack methods. For example: the saboteur obtains the data packet by monitoring the communication method. Since the data is encrypted at the source of the sensing terminal, the saboteur cannot easily obtain the original data, so the content of the data cannot be known to ensure the confidentiality of the data; When the packet passes through each node, the integrity check value will be recalculated, and the receiving end will recalculate the integrity check value in the same way. Only when the data sender and all intermediate nodes are correct can it pass. This operation not only ensures data integrity. The property also ensures the non-repudiation of the communication node; the destroyer intercepts the data packet and resends the same data packet to the intermediate node (that is, the replay attack) Since the data uses the timestamp and the serial number as the key fragment, the receiving end Integrity verification and decryption will fail and the data packet will be discarded; if the saboteur uses a man-in-the-middle attack to simulate himself as an intermediate node, since superimposed encryption and verification cannot be performed, any changes to the data cannot pass through the receiving end, verify.

Similarly, throughout all horizontal levels, a unified operation and maintenance management platform that provides full-chain, end-to-end operation and maintenance services can realize unified operation and maintenance of each terminal/device in the Internet of Things. Inspection, alarm distribution, work order distribution, work order disposal, log management and other tasks; it dynamically controls the status of all devices based on a dynamically adjusted multi-mode heterogeneous network. At the same time, it can also be sent to each terminal according to the demand through the dynamic multi-mode heterogeneous network to realize functions such as alarm, work order, and inspection Exemplarily, as shown in FIG. 90-1, an embodiment of the present disclosure provides a unified operation and maintenance management platform, and the unified operation and maintenance management platform may include: a data access module, used to access smart city-related information from other modules. The data information of the equipment of the project, and convert the data information into real-time data and offline data of the equipment that meet the requirements of operation and maintenance; the data alarm analysis module is used to analyze the real-time data of the equipment and the offline data of the equipment according to the preset alarm rules. The data is analyzed to generate equipment data alarm information and equipment offline alarm information; the operation and maintenance module is used to maintain equipment data according to the equipment data alarm information, and maintain equipment according to the equipment offline alarm information. The scheme of the embodiment of the present disclosure will be described in detail below with reference to FIG. 90-1: As shown in FIG. 90-1, the unified operation and maintenance management platform of the embodiment of the present disclosure adopts unified operation and maintenance technology and work order processing technology, through multi-mode heterogeneous. The connected sensing platform conducts unified operation and maintenance of the equipment reporting data and equipment offline data related to smart city projects, and automatically generates and distributes work orders according to the status of the equipment, and processes and statistically analyzes the work orders, so as to realize the monitoring of equipment in the whole city Operation and maintenance and equipment data operation and maintenance. The unified operation and maintenance management platform can be applied to the unified operation and maintenance management platform (R9) shown in FIG. Y2), multi-mode heterogeneous IoT sensing platform (R1), algorithm middle platform and multimedia command system (R4, R5, R6, R7), etc. provide unified operation and maintenance services. It should be emphasized that the unified operation and maintenance management platform can dynamically control the status of all devices based on the dynamically adjusted multi-mode heterogeneous network, and can also issue instructions to each terminal according to the demand through the dynamic multi-mode heterogeneous network. In order to realize functions such as alarming, dispatching work orders, and inspections. Further, the data information accessed by the data access module in the unified operation and maintenance management platform includes but is not limited to: data from the intelligent data fusion platform (R2) shown in FIG. 1, the multi-mode heterogeneous IoT sensing platform (R1) and the algorithm platform (R4) and other platforms access the device upload data, device online status data and camera image alarm data. Exemplarily, the WEB application microservice submodule of the operation and maintenance system is used to realize the basic business logic of the unified platform for operation and maintenance, including but not limited to: basic management microservices, system management microservices, resource management microservices, alarm management microservices and Operation and maintenance management microservices, etc. It can obtain equipment data from the data intelligent fusion platform (R2) shown in FIG. 1, obtain application-available data from the artificial intelligence business platform (R10), and obtain workflow data from the workflow engine, so as to integrate with the operation. The APP subsystem of the maintenance system realizes the operation and maintenance management together. The workflow engine here is used to provide basic workflow flow services for the unified operation and maintenance management platform. In summary, the unified operation and maintenance management platform of the disclosed embodiment has the following advantages: it provides unified operation and maintenance of smart city-related projects, and breaks the limitation of chimney construction of different systems of smart city operation and maintenance. The unified operation and maintenance management platform supports independent operation and maintenance of different projects. Supports the control of system access according to user rights. Data from various industries can be integrated to achieve an overview of the city's overall situation, monitoring and early warning, command and dispatch, event handling, and operational decision-making.

IT resource service can provide unified monitoring and dynamic allocation services including computing resources, storage resources and network resources for the support layer, artificial intelligence business platform layer and urban operation comprehensive IOC layer according to different needs such as business volume and time. IT resource service dynamically allocates communication resources to provide support, which can realize unified management of physical devices and physical environments in the Internet of Things, including unified resource management of computing resources, storage resources, network resources, security resources, and monitoring and sensing resources. The IT resource service provided by an embodiment of the present disclosure is applicable to the installation and deployment of computer rooms and the management of computer room equipment in any industry, suitable for the management of data center computer rooms and computer room equipment of any scale, and suitable for self-built cloud computer rooms and public Management of cloud computer room and computer room equipment. It is suitable for the management of the integrated intelligent cabinet. It is suitable for on-site and remote cloud platform computer room management. As shown in FIG. 85-1, the IT resource service components include a unified management system, a unified monitoring system, a unified operation and maintenance system, a unified secure system, a 3D twin system, and a user management system. In summary, the IT resource service provided by an embodiment of the present disclosure can achieve the following technical effects in combination with multi-mode and heterogeneous application scenarios: the cloud physical environment can be monitored comprehensively. Multi-path, multi-method technology to obtain cloud physical environment parameters. Flexible for any type of cloud physical device. Customized service configuration and keep alive according to different application scenarios. Remotely perform physical power-off restart and maintenance on cloud physical devices. The cloud physical equipment is abstracted into a 3D virtual model, and the 3D model operation is mapped to the actual cloud physical equipment and cloud physical environment monitoring equipment. Transmission of monitoring data through active +passive multi-mode. Perform service installation and management configuration on bare metal cloud physical machines. IT resources are managed in a unified manner, and unified IT resource operation and maintenance services are provided externally to improve the efficiency of operation, maintenance and management. The IT resource service (that is, the cloud management platform) can perform unified resource management on cloud resources such as memory, hard disk, input/output interface, CPU and/or GPU. It can also dynamically expand and manage the computing resources connected to any interface: it can directly connect to the computing resources of physical devices and virtualize them as computing resources, or it can connect to the virtualization platform to indirectly manage and connect the computing resources of physical devices. As an example, what the cloud management platform implements is the allocation and use of computing resources on the platform side. The “edge computing platform” in the multi-mode heterogeneous IoT sensing platform and the artificial intelligence industry algorithm middle platform are used to allocate computing tasks among platforms, gateways/base stations and terminals.

Embodiments of the present disclosure provide an application of the next generation Internet of Things in the field of forest fire fighting. Exemplarily, the upper-layer business is fire warning and flame detection in the forest fire prevention industry. The business needs are met through the following solutions the network coverage of operators in forest areas is poor, and the target area is covered by deploying multi-mode heterogeneous base stations. According to business needs, communication needs and low cost requirements, a single base station requires a large coverage area (corresponding to a longer communication distance), and the base station group only provides a limited overall bandwidth. The sensing devices at the terminal layer include soil sensors, temperature sensors, wind direction sensors, flame detection terminals, cameras with pan-tilts, etc. Security encryption that can use communication endpoint characteristics or communication information as a key (refer to the above embodiment about encryption). Soil sensors, temperature sensors, wind direction sensors, and flame detection terminals have low power consumption, fast response, and small communication data transmission volume, but many points and scattered deployment require long-distance communication; (video) cameras have high power consumption, slow response, and communication data transmission large. The infrared sensor can sense the specific infrared light signal generated by the flame combustion. Due to the background noise in the environment, it is necessary to fuse the data of infrared sensors with multiple wavelengths, and analyze the original signals of multiple sensors through edge computing to determine whether there is a fire. The soil sensor, temperature sensor, and wind direction sensor respectively collect surrounding environment information, including but not limited to: soil conditions, temperature and humidity conditions, and wind direction. The sensing device can be connected to the camera by wire. After judging the existence of a fire, the edge side automatically sends information to the camera, so that the camera can complete the capture action and generate pictures/videos. Finally, only the fire results/pictures/videos needs to be sent the platform, and the original information is not needed.

The flame detection terminal is connected to the base station through a low-speed long-distance configuration, and some terminals that cannot be directly connected to the base station are connected to the base station through a nearby terminal relay. When the terminal is turned on, try to connect directly to the gateway/base station. By evaluating the actual connection situation, the communication performance between the terminal and the gateway/base station can be evaluated. When there is no fire, choose the communication method that occupies the least resources. If the terminal cannot directly connect to the gateway/base station, then select a multi-dimensional networking mode. As an example, the terminal communicates with another relay that can be covered by the gateway/base station terminal, and the terminal responsible for the relay can turn on low-power monitoring mode, monitor the leading signal of the relayed terminal in real time. If there is no detected signal, it will enter the sleep mode immediately. If the signal is recognized, it will start receiving the entire data packet and resend the data packet to the gateway/base station.

During daily sampling, the soil sensor, temperature sensor, wind direction sensor, and flame detection terminal take samples at a regular speed, and the flame detection terminal executes an algorithm locally to identify whether there is a flame. The soil sensor, temperature sensor, and wind direction sensor detect the surrounding environment intermittently (For example, 2 hours) Sending status information includes battery power, ambient temperature and humidity, flame background noise level and other information, and periodically sending raw data of some sensors as needed, and these data will be transmitted to the data intelligence fusion platform through a multi-mode heterogeneous network for further processing Calculate and obtain the flame detection parameters under the current background noise level, and these flame detection parameters will be sent to the corresponding flame detection terminal. As an example, the above information is transmitted through matching communications and networks (dynamically allocated by multi-mode heterogeneous networks). For example, because the above information is short in length and is not sent frequently, non-compressed or lossless compressed source coding can be used Taking into account the energy consumption of the detection terminal, use more energy-efficient channel coding (such as LDPC) and use low date rate coding methods. The transmit power of the PA is reduced as much as possible to save power consumption, and the fn frequency point is randomly selected among multiple idle frequency points. Furthermore, the flame detection terminal samples at a regular speed, and analyzes whether there is a fire through terminal calculation. If there is no fire, it dynamically sends the prediction result, status information and other communication parameters to the server according to the detection prediction result, and the interval increases or shortened as needed. As the risk of a sensed fire increases, the frequency of detection increases and so does the sending of relevant information. The cloud computing engine requests part of the original data fragments from the device in different periods of time. These original data fragments will be used for background noise analysis, combined with historical big data and current meteorological big data to obtain the current detection parameter set through artificial intelligence algorithms, and send it to the base station, and the base station sends it to the terminal one by one in time division. The terminal uses the detection parameter set for flame detection. The PTZ camera scans the surrounding area according to the specified cruise track, and sends video data to the server at a certain period. The video data is displayed in rotation on the large screen of the monitoring center through the streaming media service and the visualization engine. Multiple PTZs share the base station bandwidth in a time-sharing manner. When a flame detection terminal detects a flame signal, it immediately sends an alarm signal to the background, and immediately sends data to the gateway/base station through the established communication network, and the gateway/base station sends the data to the artificial intelligence service through the multi-mode heterogeneous core network platform, the artificial intelligence service platform starts the emergency process according to the business needs of the industry, and the artificial intelligence service platform sends a control command to control the camera near the flame detection terminal through the multi-mode heterogeneous core network, and controls it to shoot video in the direction of the flame detection terminal. And through the multi-mode heterogeneous core network, the gateway/base station sends commands to the on-site base station. The base station dynamically adjusts the communication resources to the flame detection terminal and camera Other devices far away from the fire area temporarily lower the communication priority and give up communication resources. The terminal that discovers the fire starts the rapid detection process, detects the flame intensity, and immediately sends it to the server through the gateway/base station, and the camera also sends real-time continuous video/pictures to the server to show the spread of the fire, providing firefighters with data support for decision-making. For example, when the sensing terminal detects changes in environmental conditions such as low ambient air humidity and rising temperature, the edge algorithm is used to judge that the fire danger level has risen, and the infrared sensor then executes the algorithm to identify whether there is a flame. The time interval becomes shorter, and the status is sent to the server. The interval of information including battery power, ambient temperature and humidity, flame background noise level, etc. is shortened (such as 0.5 hours). Because the above-mentioned information has the characteristics of short length and relatively frequent transmission, a matching communication transmission method can be adopted: use lossless compression source coding, and use channel coding with higher energy efficiency in consideration of the energy consumption of the detection terminal (such as LDPC), using the modulation for medium data rate, the transmit power of the PA is reduced as much as possible to save power consumption, and the fn frequency point can be randomly selected from multiple idle frequency points.

When a fire occurs (the flame detection terminal recognizes the flame through an algorithm), the flame detection terminal immediately sends a fire alarm message to the server, then starts continuous flame signal sampling and executes the recognition algorithm, and sends flame intensity signals and ambient temperature and humidity signals (obtained by sensors) to the server, this information will be used to assess the fire spread. As an example, the above information is also transmitted through matching communications and networks (dynamically allocated by multi-mode heterogeneous networks). For example, in order to ensure transmission reliability, use the spread spectrum modulation, and choose to use a relatively idle communication channel, appropriately increase the transmit power of the PA to improve the signal-to-noise ratio; at the same time, the flame detection terminal turns on the camera, and first sends high-definition picture data (such as jpg encoded pictures), this picture will be used in the firework recognition algorithm (to confirm whether there is a fire), after confirming that there is a fire, the camera starts to send images and/or video information for real-time fire monitoring. According to actual network conditions, the image and/or video information may use different resolutions and different source codes (such as H.264,H265), and Turbo channel coding may be used at this time, and use modulation with higher bit rates (such as QAM64, QAM128), and use channels with less background noise and more idle. In terms of emergency command, the artificial intelligence management platform obtains geographical data, vegetation data, forest fire factor data, meteorological data, real-time data of sensing terminals, fire extinguishing resources and other data from the data lake of the data intelligent fusion platform, and through deep learning algorithms calculates the fire point, center, current fire area, fire spread trend, feasible rescue path, etc. combined with command and dispatch terminal location data, and deduce the optimal rescue path for on-site rescuers. The rescue path takes into account factors such as the safety of rescuers and fire fighting efficiency. Through the trajectory prediction of command and dispatch terminals, the artificial intelligence management platform can determine the dynamic networking requirements of command and dispatch terminals: which terminals are key terminals, the required communication rate, etc. and send the requirements to the multi-mode heterogeneous core network, the multi-mode heterogeneous core network retrieves historical communication big data from the data lake, combined with on-site communication environment data, deduces the optimal networking mode, communication resource scheduling strategy, etc. through deep learning algorithms, and issues the final control instructions through the gateway/base station to the command and dispatch terminal and/or the on-site mobile gateway/base station, the command and dispatch terminal forms a network according to the instructions and returns a variety of streaming media information in real time for further use by the platform. The mobile terminals and mobile base stations equipped by on-site personnel constitute an ad hoc network. According to the site conditions, some mobile terminals can be identified as key terminals (such as mobile terminals worn by commanding team members), and priority should be given to ensuring communication speed and server quality. According to the actual communication performance on site, the interaction between terminals and between the terminal and the command and dispatch platform uses video, audio, voice messages, and text messages in sequence according to the quality of the communication environment. When using video/audio communication, one can also choose to use different source encoding to achieve a balance between video/audio quality and network carrying capacity. If the network is better, use high-definition video and high bit rate H.264 coding, and low-definition video and low-bit-rate H.265+encoding are used for poor networks. Channel coding is selected according to the situation. For example, LDPC coding with higher energy efficiency is used for high rates, and Turbo coding with better performance is used for high noise. Switch modulation mode through the multi-mode heterogeneous network to adapt to the change of the communication distance. If the communication distance is very short, use QAM64, if the communication distance is slightly longer, use QAM8, and if the communication distance is far, use FSK. Devices that need to prioritize communication quality can use dedicated communication channels.

Furthermore, the integrated communication center provides three major service functions during the dispatching process: (1) instant messaging function, which is used to issue command and dispatch instructions and listen to on-site situation reports. The integrated communication center can establish communications between artificial intelligence business platforms and on-site terminals, terminals and terminals, platforms and multi-terminal groups. Depending on the network connection, different communication methods can be established, such as video calls, audio calls, and text communications. If the communication condition is good, use the video call, if the communication condition is normal, use the audio call, and if the communication condition is poor, use the text communication. When it is really necessary to use a high-speed communication mode but the current terminal network connection rate does not support it, the artificial intelligence service platform can initiate a network evaluation to the multi-mode heterogeneous core network, and the core network will be reorganized according to the current network status and environment through deep learning algorithm evaluation. Network, temporary allocation and other methods can meet the communication rate allocation of the specified terminal, and if the conditions are met, the allocation will be performed. When using text communication, it is supported to use the language processing unit of the platform in the algorithm to convert the voice of the platform into text and send it to the terminal; when using group calls, it supports some terminals to use video calls and some terminals to use voice calls. The artificial intelligence industry algorithm predicts and simulates the spread of fire based on current and historical data, and can directly output automatic dispatching instructions. These dispatching instructions can be directly sent to the terminal through the integrated communication platform without manual participation According to the networking of the terminal, automatic scheduling instructions can be issued in voice or text format. The original format of dispatch instructions can be voice or text (of course, video, pictures or other types of files can also be included). Through the algorithm platform TTS speech synthesis algorithm and NPL natural language recognition algorithm, dispatch instructions can be converted between speech and text (2) Location positioning, which provides the collection and circulation of terminal location information. The location information is used in the algorithm center to generate dispatching decisions for on-site personnel, the location information is used in the digital twin center for visual display, and the location information is used in the multi-mode heterogeneous core network for dynamic networking and communication resource allocation. (3) On-site monitoring. The artificial intelligence business platform can actively perform operations such as pulling terminal video streams, controlling terminal to take pictures, and controlling terminal recording. These operations do not require any operations on the terminal, thereby reducing unnecessary intervention for rescuers.

According to information such as fire control situation, rescue personnel situation, and real-time scheduling of the artificial intelligence business platform, the platform side calculates communication requirements in real time and dynamically adjusts communication strategies to ensure real-time, dynamic, and coherent communication connections between command and dispatch terminals and on-site sensing equipment. The platform of the digital twin can display to the command center the prediction and simulation data of the platform in the artificial intelligence industry algorithm (such as fire spread prediction), the location data of on-site rescuers, and the data of the communication network (base station/gateway coverage area, communication equipment interconnection, etc.), so as to help the command and dispatch of the command center. Of course, those of ordinary skill in the art can understand that all or part of the processes in the methods of the above embodiments can be realized by instructing related hardware (such as processors, controllers, etc.) through computer programs, and the computer programs can be stored in. In a non-volatile computer-readable storage medium, the computer program may include the processes of the above-mentioned method embodiments when executed. The storage medium mentioned herein may be a memory, a magnetic disk, a floppy disk, a flash memory, an optical memory, and the like.

Referring to FIG. 1A, the present disclosure provides a configuration example of the next generation Internet of Things.

The next-generation Internet of Things is characterized by weakening the boundaries of sensing (sensing), transmission (communication), calculation (computation), control (control) and use (application) of the traditional Internet of Things, and improving the interoperability between layers. It is guided by the dynamic, on-demand, and rational allocation of resources, so that the layers can promote each other, so that the system can achieve overall optimization.

From the perspective of the sensing layer, the sensing terminal can detect status and collect data from objects and people. For example, the sensing terminal can collect environmental data of the surrounding environment (such as temperature, carbon dioxide concentration, atmospheric pressure, etc.), as well as data such as images and sounds of human activities. By adding terminal computing functions at the sensing layer, for example, by adding a processor to the sensing terminal, the sensing terminal can be equipped with data processing capabilities, and the sensing terminal can directly analyze the collected data and generate a decision after collecting the data. As a result, even the sensing terminal can make local decisions at the edge. The combination of FIG. 1-1 and FIG. 1-4 is the architecture and process for the sensing terminal to make local decisions at the edge. It should be noted that the edge side is neither a single component nor a single layer, but an end-to-end open platform involving EC-IaaS, EC-PaaS and/or EC-SaaS. As an example, edge computing nodes generally involve networks, virtualized resources, RTOS, data planes, control planes, management planes, or industry applications, etc. where networks, virtualized resources, and RTOSs belong to EC-IaaS capabilities, and data planes, control planes, etc. management plane, etc. belong to EC-PaaS capabilities, and industry applications belong to the category of EC-SaaS.

In some embodiments, one sensory terminal can establish communication connections with other multiple sensory terminals, and multiple sensory terminals can transmit collected data to each other, so that any sensory terminal can combine multiple or multiple sensory terminals Hence, comprehensive decision-making with data can achieve more complex and higher-level decision-making by fusing data collected by multiple sensing devices, making decision-making results more accurate. The combination of FIG. 2-1, FIG. 2-2 and FIG. 2-3 is the process and principle of communication between terminals. For example, the sensing terminal can receive temperature data sent by the temperature sensor, carbon dioxide data sent by the carbon dioxide sensor, humidity data sent by the humidity sensor, etc. to comprehensively judge whether a fire is currently occurring. Compared with making decisions based on only one kind of sensory data, combined with multiple sensory data to make decisions, the basis can be changed from a small amount of “sample data” to massive “overall data”, and a more comprehensive, multi-dimensional fusion and visualization can be obtained. Decision-making results, so as to avoid false alarms and waste of rescue resources. In some embodiments, the sensing terminal can be directly connected to the execution terminal through the dynamic communication between objects in the multi-mode heterogeneous network, so that after the sensing terminal makes a decision based on the sensing data, if the specified condition is met, the execution terminal needs to execute corresponding actions, at this time, the sensing terminal can directly send a control instruction to the executing terminal, so as to instruct/link the executing terminal to execute the corresponding action. FIG. 2-1 is the flow of the sensing terminal sending control instructions to the executing terminal. For example, when the sensing terminal makes a decision that there is a fire, it can send an action command to the alarm and the sprinkler mechanism to instruct the alarm to issue an alarm prompt and instruct the sprinkler mechanism to start sprinkling water By directly making decisions by the sensing terminal and directly sending control instructions to the execution terminal, there is no need to wait for the upper-level devices such as gateways or servers to analyze the sensing data before making decisions, which can save decision-making time. In addition, when the communication is abnormal it can analyze the data by itself and then generate control instructions to start executing actions, so as to gain more rescue time when a dangerous situation occurs.

In a further preferred embodiment, after the sensing terminal makes a decision based on the sensing data, the sensing policy, communication parameters and/or network transmission rules for the sensing terminal may be adjusted according to the decision content. Exemplarily, when the decision content shows that the specified conditions are met, such as when a dangerous situation occurs, the sensing terminal can automatically adjust the sensing strategy, such as increasing the sampling frequency, increasing the sampling progress, etc. and can request the upper device to change the communication parameters and strategies. Therefore, higher speed, high reliability and more suitable transmission can be obtained in the way of multi-mode communication. Among them, the communication parameters that can be dynamically adjusted/controlled/modified/configured include carrier frequency point, carrier bandwidth, modulation mode, channel coding, transmission power, receiving sensitivity, etc.

From the perspective of the communication layer, multi-mode heterogeneous networks can provide diversified, configurable, and coordinated network connections for sensing terminals, and can dynamically and on-demand provide suitable network communication resources for terminals. For example, after a sensing terminal makes a decision, it can simultaneously send the collected data and decision results to a higher-level device (such as a gateway), so that the upper-level device can store and analyze the data collected by all sensing terminals. Exemplarily, the sensing terminal can establish a communication connection with the gateway, and the sensing terminal can send the collected data and decision results to the gateway. The gateway itself can have data processing capabilities, so the gateway can process all the received data, and according to the processing results generate decision results on the gateway side, that is, fog computing is realized on the gateway side. The fog computing refers to that the data from sensors and edge devices are not all stored in the cloud data center, but a layer of “fog” is added between the terminal device and the cloud data center, that is, the network edge layer, and the data, data processing and applications are concentrated in the device gateway at the edge of the network, and the cloud server can store data synchronously. For relatively large data fog devices (gateways), they can be processed locally, extract meaningful features, and then synchronize to the cloud. It can greatly reduce the computing and storage pressure on the cloud, with lower latency and higher transmission rate. Terminal devices and fog devices (gateways) are transmitted in a multi-mode heterogeneous network, which can greatly ensure smooth communication in various situations. Exemplarily, the gateway can process the data of all terminals under its coverage, and its decision-making effect tends to be more global, so the accuracy of the decision result made by the gateway can be greater than the accuracy of the decision result made by the sensing terminal. When the decision result made by the gateway side is inconsistent with the decision result made by the sensing terminal, the gateway can send an adjustment command to the sensing terminal to adjust the sampling behavior of the sensing terminal and can send a control command to the execution terminal to adjust the action of the execution terminal, thereby realize networking assisted sensing and realize the optimization of control FIG. 1-1 is the integrated architecture of fog computing, edge computing and cloud computing. For example, parameters such as the sampling interval of the sensing terminal and the size of the preset threshold can be adjusted, and the execution terminal can be adjusted to terminate the execution of the action. For example, in building fire protection applications, once a gateway receives the alarm information from the smoke sensor, it will send the alarm information to nearby gateways, and eventually the entire building gateway can receive the alarm information, and the entire building gateway is connected to it. The smoke alarms of the entire building will send an alarm command, and finally the smoke alarms of the entire building will alarm at the same time, warning all the personnel in the entire building to evacuate quickly. Through the gateway communication technology, it is ensured that the fire alarm information is broadcast to the entire building in the first time, and the broadcast of the alarm information will not be affected in the case of abnormal communication between the gateway and the cloud. FIG. 1-2 is an example of the application of gateway communication technology in building fire protection.

In a further preferred embodiment, the gateway can also directly send control instructions to the execution terminal according to the result of the decision made to instruct the execution terminal to perform corresponding actions, and can adjust itself and neighboring gateways, base stations and/or sensing devices communication parameters, so as to provide better communication services for high-priority devices. For example, according to the data characteristics of IoT terminals, services can be divided into delay-sensitive services (such as data uploaded by fire alarm sensors), services with large bandwidth requirements (such as live broadcast, monitoring data) and ordinary services (such as data uploaded by temperature and humidity sensors). The data). Different types of services have different requirements for channel delay and bandwidth. Multi-mode sites allocate appropriate channels for IoT terminals according to their service types to ensure efficient data transmission. In the embodiment of the present disclosure, the gateway holds the secret key of other gateways, the connection between the gateways connected through IP uses TLS, the subordinate gateway uses token authentication, the connection between gateways connected through IP uses TLS, and the connection between gateways connected through IP uses TLS, and X.509 authentication is used. Authorization, connecting gateways through IP interconnection, using digest algorithm for authentication and/or two-way authentication; terminals using LoRa connection, using private protocol, DH key exchange. Gateway and inter-gateway and cloud communication technology supports automatic networking, automatic scanning, and automatic connection of the intranet; the gateway supports LoRa, and the slave gateway can scan at the specified frequency point and automatically connect. FIG. 88-1 is the IoT security architecture based on keyless signature technology.

From the perspective of the computing layer, by introducing the cloud-edge collaborative computing framework, the tasks of coordinating terminal computing (sensing terminal), fog computing (gateway) and cloud computing (cloud server) are effectively allocated, and communication and network transmission are controlled to adapt to the resulting environment. On the contrary, when the network status changes, the cloud-edge collaborative computing framework can also dynamically adjust the computing strategy to provide better communication services. In this embodiment, edge-cloud collaboration (also called cloud-edge collaborative computing) involves comprehensive collaboration at all levels of IaaS, PaaS, and SaaS EC-IaaS and cloud IaaS should be able to achieve resource collaboration on network, virtualized resources, security, etc.; EC-PaaS and cloud PaaS should be able to realize data collaboration, intelligent collaboration, application management collaboration, and business management collaboration; EC-SaaS and cloud SaaS should enable service collaboration.

In some embodiments, the gateway can establish a communication connection with the server, and can send the data sent by the sensing terminal, the decision result made by itself, and the decision result of the sensing terminal to the server, so that the server can comprehensively process all the sensing data and/or deep learning, and make a decision result. Since the computing power of the server is often greater than that of the gateway and the terminal, and the server can process the data of all the gateways and terminals under its coverage, the accuracy of the decision made by the server is usually greater than that of the gateway and the terminal. Accuracy. In reality, due to network imbalance and instability, not all terminals can provide the accurate data required by the algorithm. The multi-mode heterogeneous network ensures the transmission of key data and the normal operation of the algorithm according to the algorithm requirements, so as to realize networking assisted calculation Exemplary, but when an abnormal situation occurs when the algorithm run by the algorithm center has special requirements for input data, such as when a certain device needs to send higher-definition pictures, and a certain area-aware terminal sends more densely sampled data, the algorithm center can send the multi-mode heterogeneous core network control requests, and the core network coordinates network resources through the base station/gateway to meet the requirements of the algorithm for terminal data transmission to realize the calculation controlled networking; when the actual communication capability of the terminal cannot fully meet the data requirements of the algorithm, part of the computing tasks are allocated to the base station/gateway, and the terminal side, and cloud-side collaborative computing is realized through reasonable computing power balance, task dispersion, algorithm complementation and communication conditions. Exemplarily, when adjusting the computing capability of the gateway, it may be to adjust the communication parameters of the gateway, adjust the number of access terminals of the gateway, adjust the computing cycle of the gateway, etc.; when adjusting computing capability of the sensing terminal, it may adjust communication parameters, adjusting the sampling interval of the sensing terminal, adjusting the coverage area of the sensing terminal, adjusting the calculation period of the sensing terminal, etc. Wherein, the communication parameters may include carrier frequency point, carrier bandwidth, modulation mode, channel coding, transmission power, receiving sensitivity and so on. FIG. 19-1 is a schematic diagram of how the server adjusts the sensor terminal communication parameters, and FIG. 36-1 is a technical flow of server-based terminal device data reporting interval control.

In some embodiments, after the server makes a decision, the server may directly instruct the execution terminal to perform a corresponding action, thereby realizing the server's direct control over the execution terminal. Since the server has a high-level decision-making ability, when the execution command sent by the sensing terminal received by the execution terminal is inconsistent with the execution command sent by the server, the execution terminal can only perform corresponding actions according to the execution command sent by the server. And because the server has a higher level of decision-making ability, it can also provide better communication services for high-priority devices by directly controlling the actions of actuators through the server.

From the perspective of the control layer, in the communication process of the sensing terminal, gateway, server, and execution terminal, the dynamically allocated communication and network can be used to realize and guarantee faster and more reliable delivery of control commands, command and dispatch, and related operations execution. For example, the sensing terminal itself can dynamically adjust its own sampling interval, sampling time, sleep time, etc. and can also request the allocation of more communication resources to the upper device when the set conditions are met, so as to provide better communication services; the gateway can adjust Its own communication parameters can also adjust the communication parameters of the sensing terminals connected to it; the server can adjust the communication parameters of all terminals covered by it, and can dynamically adjust the task ratio, time domain allocation, compensation rate, etc. of these terminals according to the actual needs of users. FIG. 3-1 is an example of a sensing terminal dynamically adjusting its own sampling interval.

From the perspective of the application layer, sensing terminals, gateways, computing frameworks, and multi-mode heterogeneous networks become explicit resources, and all resources can be dynamically allocated and coordinated on demand. FIG. 16-2 shows an example of communication resource coordination. For example, for different user needs, different tasks and/or different priorities can be assigned to sensing terminals, and more communication resources can be allocated to sensing terminals with heavier tasks or higher priorities to improve sensing terminal's data processing capabilities such as data collection, data calculation, and data transmission to achieve demand driven sensing, thereby providing users with better communication services. In the same way, different communication resources or different tasks can be assigned to the gateway according to user needs, so as to realize demand driven network control and improve the computing power and computing efficiency of the gateway. Similarly, the server can also be instructed to adjust the communication resources of the lower-level devices connected to the server according to user requirements, so as to achieve the purpose of rationally allocating communication resources. According to user requirements, the execution actions of the execution terminal can also be adjusted to implement decision-making/scheduling of the execution terminal according to user requirements. For example, it is possible to increase/decrease the execution actions of the execution terminal, increase/decrease the execution strength of the execution terminal, etc. according to user needs. In some embodiments, the application data collected and processed by the cloud server can also be fed back to the user layer, so that the user layer can monitor and make decisions on the data. In addition, the server can also establish a data model that matches the user's needs based on the collected and processed data and different user needs. According to these data models, the user layer can understand the operation of each terminal within the Internet of Things more easily and quickly And the situation of the data collected by each terminal, so as to realize the feedback to the user's needs. FIG. 34-2 is a flow chart of intelligent data analysis based on the establishment of data models based on different user needs and display of data through visualization tools. In some other embodiments, the next-generation Internet of Things may also include a security system, an operation and maintenance system, and a management system.

Among them, the security system can provide security support for the steps of data collection, data transmission, and data processing of each terminal/device in the Internet of Things, and can solve any data security-related issues such as illegal intrusion, data leakage, and external attacks; The system starts with multi-mode heterogeneous network security, and dynamically controls security from the root, instead of only ensuring security at the platform layer. FIG. 86-1 is a security system architecture diagram, FIG. 86-2 and FIG. 86-3 describe the lightweight authentication service process, and FIG. 86-4 describes the IoT device secure access & data uplink process. The security management platform provided by this disclosure interacts with the terminal layer (including various sensors, etc.), the communication layer (including base stations, gateways, etc.), and the support layer (including data centers, core networks, etc.) of the multi-mode heterogeneous system, thereby perform dynamic and linkage control on the entire multi-mode heterogeneous system to ensure data security and communication security. The security management platform provided by an embodiment of the present disclosure is suitable for any scenario where IoT devices are securely connected to the cloud, it is suitable for securely connecting any type of third-party platform data, providing a secure channel and data tamper-proof function; It is suitable for use in combination with multiple communication types, that is, to meet the needs of multi-mode heterogeneous networks; it is suitable for scenarios where IoT device data, user-generated data, and third-party access data are securely accessed and uploaded to the blockchain for protection. In this embodiment, the security management platform is divided into three components, which are security resources, security services, and security management. Among them, the security resource component includes a password resource pool, a key management system, a signature verification system, and a data encryption and decryption system. The password resource pool is pre-configured, and then based on the password resources and encryption and decryption algorithm resources in the password resource pool, a key management system, a signature verification system, and a data encryption and decryption system are established Security management components include communication security, network security, data security, situational awareness, emergency response, knowledge graph, user management and other systems Among them, communication security, network security, and data security provide security situation awareness data for situational awareness: situational awareness analyzes the security situation; situational awareness provides the results to emergency response, and emergency response notifies relevant security personnel; then the entire security incidents and practice stored in the knowledge map for storage and recording; the knowledge map provides basis support for the configuration of communication security, network security, and data security, forming a closed loop. Security service components include lightweight authentication services, security authentication services, and blockchain services. The security service component is based on the security resource component and under the call management of the security management component, it provides security services to the business system and the IoT terminal. In order to solve the problem of device key distribution and storage difficulties, the operation and maintenance system can realize the unified operation and maintenance of each terminal/device in the Internet of Things. For example, tasks such as intelligent inspection, alarm dispatching, work order dispatching, work order disposal, and log management can be arranged through the operation and maintenance system; the management system can provide dynamic allocation of communication resources provides support, which can realize unified management of physical devices and physical environments in the Internet of Things, including unified resource management of computing resources, storage resources, network resources, security resources, and monitoring and sensing resources. The cloud management platform can uniformly manage resources such as memory, hard disk, input/output interface, CPU and/or GPU in the cloud. It can also dynamically expand and manage the computing resources connected to any interface: it can directly connect to the computing resources of physical devices and virtualize them as computing resources, or it can connect to the virtualization platform to indirectly manage and connect the computing resources of physical devices. FIG. 90-1 is a diagram of the O&M system architecture. Referring to FIG. 1B, the present disclosure provides an example of next-generation IoT global relationships.

The present disclosure provides an Internet of Things platform, which includes a terminal layer, a communication layer, a support layer and an application layer arranged sequentially from bottom to top.

In the terminal layer, the terminal, as a node of the communication network, participates in the establishment of the network, obtains network status information, determines the sensing and execution strategy according to the network status information, and adjusts the sampling mode according to the business needs and the communication environment to obtain the sensing data. The sampling mode includes Sampling frequency, sampling precision, source coding and/or compression method. As an example, air quality monitoring stations used for dust monitoring on construction sites use wireless gateways to transmit data back, and particle sensors are used to assess dust conditions. High-frequency sampling data can result finer dust change curves, but if the system deploys multiple different types of terminals, and the gateway capacity is limited, then the frequency of sampling and return can be appropriately reduced to reduce the communication resource occupation. When there is a construction site during the day, a slightly higher sampling frequency should be used. If the wind speed is high and the dust spreads and changes quickly, a higher sampling frequency should be used to adapt to accurate change tracking. If there is no construction on the construction site at night, the sampling frequency, sampling accuracy and return frequency can be further reduced. If the change in the dust is small, the source coding can be changed to a difference method, that is, fewer data bits are used to represent the difference from the previous value. It is also possible to accumulate multiple sampling data and use a compression algorithm to compress it and send it uniformly FIG. 36-1 is a flow chart of terminal device data reporting interval control technology, FIG. 36-2 is a flow chart of compressed terminal data reporting, and FIG. 25-4 is a flow chart of terminal dynamic adjustment of sensor coefficients based on data reported by surrounding terminals.

In the communication layer, base stations and gateways introduce fog computing, perform fog computing based on the sensor data of all terminals under their coverage, and adjust terminal communication resources, as an example, in the monitoring system of smart greenhouses, a gateway is responsible for the data of multiple types of terminals. Transmission and computing services, where each type of terminal is installed at multiple points on demand. Among them, the light terminal is used to evaluate the light level in the greenhouse During the daytime, when the light is relatively strong, more attention should be paid to the change of humidity in the greenhouse, and the temperature change is relatively unimportant. At night, when the illumination is low, more attention should be paid to temperature changes in order to prevent plant frostbite, and the evaporation at night is small, so the humidity does not need to be paid special attention. The gateway continuously collects the sensor data of the terminal, and analyzes the illumination data through fog calculation. If a certain proportion of the illumination data exceeds the set threshold and lasts for a certain period of time, it can be determined that it is daytime, and the gateway sends a communication resource adjustment command to the terminal, which notifies the temperature sensor terminal to reduce the communication resource occupation, and the humidity sensor terminal to increase or decrease the communication resource occupation. FIG. 1-3 is a schematic diagram of the interaction process between the edge computing gateway platform deployed on the gateway and the terminal.

In the support layer, the artificial intelligence algorithm cloud computing platform sends commands to the multi-mode heterogeneous core network to change the communication and networking performance of different terminals, use different algorithm parameters and allocate different algorithm resources according to the sensing data; as an embodiment, an urban management project deployed multiple cameras, using multiple multi-mode heterogeneous base stations for coverage, and the support layer deployed deep learning algorithms for road occupancy business identification and fireworks identification. The project deploys Jurisdiction 1 and Area 2. Area 1 focuses on fire protection and road occupation operations. Road occupation operations require attention during the day but not at night, while fire protection requires attention throughout the day and at night. Area 2 only focuses on daytime fire protection. The artificial intelligence algorithm platform mobilizes resources according to this demand. At the beginning of the day, send commands to the multi-mode heterogeneous core network to increase the communication authority of the road-occupied cameras in area 1, and allocate more computing resources to them. The road-occupied cameras use to collect and send high-definition video data, and adjust algorithm parameters to adapt to the recognition of high-definition video data; the communication authority of the pyrotechnic recognition camera in area 1 is reduced, the camera only collects low-resolution images and transmits them at low frequency, the algorithm platform only provides part of the computing resources, and rough recognition can be done by adjusting the algorithm parameters; the algorithm platform Increase the communication authority of the fireworks recognition camera in area 2, allocate more computing resources to it, and adjust the computing parameters to improve the recognition speed and recognition rate. Before the night begins, the algorithm platform allocates the communication resources of the road-occupying operation cameras in Area 1 to the pyrotechnic recognition cameras, retaining only the basic connection communication, and allocates all the algorithm resources occupied by the road-occupying business Rate algorithm parameters; the pyrotechnics recognition camera in area 2 has sufficient bandwidth, and communication resources are still occupied, and the camera still sends high-definition images, but the algorithm resources are partially released, and the algorithm parameters used can guarantee the general recognition rate. The multi-mode heterogeneous network coverage domain extends from the communication layer down to the terminal layer, and up to the support layer and application layer; the cloud-edge collaborative computing framework coordinates the task allocation of cloud computing, fog computing, and edge computing.

In the application layer, the visual display is performed through the visualization engine. FIG. 34-1 shows the visualization engine in the intelligent data analysis architecture; the operation and maintenance management platform and the cloud management platform provide unified resource services and unified operation and maintenance services, and FIG. 90-1 is. The technical processing flow of the operation and maintenance management platform, FIG. 85-1 is the functional architecture of the cloud management platform; the blockchain security management platform provides unified security management services, and security management covers the sensing layer, communication layer, support layer and the top application layer, FIG. 86-1 is the functional architecture of the blockchain security management platform.

In some embodiments, at the terminal layer, the terminal can participate in the establishment of the network as a node of the communication network, and the terminal can obtain network status information, and then change the sensing or execution strategy. The terminal performs edge computing according to the business needs and the communication environment to adjust parameters such as sampling frequency, sampling accuracy, source coding, compression mode, etc. FIG. 20-2 shows the composition principle of adaptive multi-point cooperative selection of the best gateway communication for the terminal based on obtaining network status information, FIG. 25-3 shows the flow chart of terminal calibration based on surrounding terminal data, and FIG. 25-4 shows the flow chart of terminal dynamically adjusting data reporting frequency. The edge computing function is added to the terminal layer, and the sensing data can make local decisions on the edge side, so as to directly link the execution terminal; due to the existence of edge computing, it can realize the fusion of multiple sensing device data for more complex and high-level decision-making; the results of edge computing it can improve the importance and urgency of the corresponding sensor data, and through the dynamic adjustment of communication parameters and network transmission rules, the terminal can obtain faster, more reliable and more suitable communication and network resources. When there is a large change in the sensor data and needs continuous attention, it can apply for more network resources to the communication layer and the support layer through data transmission as needed while increasing the sampling frequency and accuracy. The multi-mode heterogeneous network can be dynamically adjusted through communication to achieve resource allocation. Dynamically adjustable factors include carrier frequency point, carrier bandwidth, modulation mode, channel coding, transmission power, receiving sensitivity, etc. As an example, in an urban fire application, multiple smoke sensor terminals are installed on each floor of a building, and the terminals are equipped with temperature identification capabilities and communicate with one or more wireless gateways. All terminals have been detected at a certain frequency during normal operation, but data is sent to the gateway once a few hours to report device status (such as battery power, temperature, etc.). In order to reduce the power consumption of the terminal, spread spectrum modulation is used for communication. Low transmit power and medium receive sensitivity. When a fire occurs on a certain floor, all terminals on this floor will send smoke concentration and temperature data at a faster frequency, and these data will be used by the algorithm to calculate the spread of the fire and calculate the best escape route, in order to cope with the temporary increase of communication resources. It is necessary to enable multi-carrier frequency points for communication between the gateway and the device, use the GFSK modulation that supports higher rates, and increase the transmission power and reception sensitivity to ensure the communication distance.

In some embodiments, in the communication layer, the multi-mode heterogeneous network provides diversified, configurable, and coordinated network connections, and can dynamically and on-demand provide suitable network communication resources for terminals; the gateway and base station sides introduce fog computing Fog computing can be based on the data of all terminals under its coverage, and its decision-making effectiveness tends to be more global. The multi-mode heterogeneous network coverage domain extends downward from the communication layer to the terminal layer, and extends upward to the support layer and application layer FIG. 1-1 shows the architecture diagram of fog computing with multi-mode heterogeneous network.

In some embodiments, in the support layer, various services and algorithms such as big data fusion, converged communication services, and streaming media services are provided. Computing provides algorithmic support. Artificial intelligence algorithms have different requirements for terminal sensor data at different times and locations, such as sampling rate, precision, data rate, etc. The artificial intelligence algorithm platform can send commands to the multi-mode heterogeneous core network to change the communication of different devices and networking performance, and then use different algorithm parameters and allocate different algorithm resources according to the actual sensing data. As an example, during the day, the camera that monitors random sales needs to capture images frequently, while the camera used for border detection in the middle of the night has a higher priority; the forest fire factor terminal used in forest fire prevention can reduce thefrequency of collecting combustible layer and weather sensing data under low temperature or rainy conditions, and increasing the sampling frequency to obtain faster response time when the weather is dry and high temperature.

In some embodiments, at the application layer, an artificial intelligence business platform is provided, and through various visualization engines such as CIM, BIM, GIS, AR, VR, etc. the data, sensing and control terminals, computing frameworks, multi-mode all resources can be dynamically allocated and coordinated on demand, and can realize various types and various tasks from operation to management to service, from monitoring to pre-planning, from decision-making to scheduling, etc. business operations of the industry. FIG. 74-1 shows the CIM, BIM, GIS, AR, VR and other visualization engines provided by the digital twin platform. In the event of an accident, some terminals (such as emergency terminals, terminals for rescue vehicles, accident scene-related terminals, etc.) need more network resources, and the application side can directly issue commands to the multi-mode heterogeneous core network.

In some embodiments, by introducing a cloud-edge collaborative computing framework, the tasks of coordinating edge computing, fog computing, and cloud computing are effectively assigned and coordinated, and communication and network transmission are controlled to adapt to changes in transmission requirements brought about by this; on the contrary, when the network status changes occur, the cloud-edge collaborative computing framework can also dynamically adjust the computing strategy. The cloud-edge collaborative computing framework coordinates the task allocation of cloud computing, fog computing, and edge computing, and realizes cloud-edge computing collaboration. The cloud-edge collaborative computing framework allocates tasks according to the requirements definition of the business platform, the communication big data of the multi-mode heterogeneous network, and the communication and computing capabilities of the gateways and the terminals. FIG. 4-1 shows the cloud-edge collaborative highly configurable edge computing framework. FIG. 4-2 shows the edge computing decision-making loop structure. As an example: a vision-based fire protection system, both on-site image sensing devices and the cloud have firework recognition capabilities based on deep learning, and the sensing devices use uncompressed image data, which is more friendly to the algorithm, because only the recognition results need to be transmitted instead of. The image is sent to the cloud, so the communication requirements are also low, but the limited computing power of the sensing terminal still limits the recognition ability of the algorithm; the corresponding cloud computing uses the compressed image returned by the sensing terminal through the network, which is very important for the recognition algorithm and the requirements for network transmission are higher, but the computing power in the cloud is relatively abundant. Reasonably combining the advantages of edge computing and cloud computing can effectively improve the recognition rate and reduce the false positive rate, so it is necessary to dynamically adjust the task ratio, time domain division, and mutual compensation rate of cloud edge computing to a reasonable range, while the dynamic adjustment feature of the multi-mode heterogeneous network provides the necessary support for the dynamic communication requirements brought about by the cloud-edge computing coordination adjustment. In order to take into account the needs of network disconnection and self-control in some scenarios, the gateway and terminal can have two different sets of task groups, one for use when the network is unblocked, and the other for use when the network is disconnected. Decision-making can also be made independently at any time, avoiding decision-making failure and decision-making delay caused by network disconnection and weak network. When the network is unblocked, we hand over the authority to the gateway or the upper server. As an example, as an example, there can be multiple sets of different task groups. We can even say that we can divide into more situations when the network is weak, disconnected and the network is unblocked. In each case, we should use different task groups and strategies, and then let the gateway and the terminal take corresponding responsibilities. In the embodiments of the present disclosure, the devices at the terminal layer are connected to the multi-mode heterogeneous IoT sensing platform, and the multi-mode heterogeneous IoT sensing platform manages the devices at the terminal layer and the communication layer, providing information based on industry requirements or/and physical locations Multi-mode heterogeneous network services and edge computing services that dynamically adjust any communication parameters. Ad hoc network communication uses negotiation channels and data channels. The negotiation channel is used for device network access, status announcement and communication negotiation; the data channel is divided into broadcast channel and directional channel, the broadcast channel is used to send multicast and broadcast data, and the directional channel is used for node-to-node communication; the broadcast channel and directional channel can use the same transceiver. The network access process uses the network access request and network access response methods. The network access response includes the interconnection status between devices (whether communication is possible, link status). Devices that have joined the network or are preparing to join the network can send network access responses in multiple windows according to the distance between them and the network-connected device (using the received signal strength). The number of windows and the distance range corresponding to each window are defined according to actual needs; devices in the same window using random delay and detecting channel occupancy before sending has fewer conflicts. When the nodes use the negotiation channel to communicate, determine the communication rate and transmission power according to the actual radio frequency situation; when the data needs to be routed by the intermediate node, the communication between the node and the route, and between the route and the route can use different channels and rates according to the actual radio frequency environment, function and other parameters. FIG. 18-1 shows the state diagram of the terminal node state switching, FIG. 18-2 shows the network access process of the terminal node, FIG. 18-3 shows the sending and receiving process of the terminal node after network access, and FIG. 18-4 shows the data sending request and response process, FIG. 18-5 shows the data sending process, and FIG. 18-6 shows the summary of the negotiated channel package.

In some embodiments, the operation and maintenance management platform and the cloud management platform provide unified resource services and unified operation and maintenance services, covering the sensing layer, communication layer, support layer to the top application layer, and serving all layers of the entire system. The operation and maintenance management platform and cloud management platform are for unified management of physical equipment and physical environment, including unified resource management of computing resources, storage resources, network resources, security resources, and monitoring and sensing resources in cloud computer rooms. FIG. 85-2 shows the processing flow of unified resource management. Exemplarily, when the requirements of the algorithm for computing resources and network resources change in different time periods, the cloud management platform dynamically adjusts the computing resources to the corresponding algorithm and adjusts the network resources to related devices Computing resources can also be adjusted according to the needs of corresponding algorithms such as data types, compression ratios, and code rates/data rates supported by applications and communication bandwidth. Data sources with a high compression ratio require less memory, but require more computing power to achieve appropriate calculation accuracy. For example, in terms of emergency command and dispatch for forest fire prevention, the command and dispatch terminal is wirelessly connected to the cloud management platform through a wireless communication module. The cloud management platform based on the multi-mode heterogeneous network will predict the forest fire spread area and spread time according to the artificial intelligence management platform, according to the distance from the command and dispatch terminal to the fire scene, and whether the command and dispatch terminal will be in the area where the fire is about to spread in the short term, etc. In emergencies, dynamically adjust the bandwidth and rate/speed, and give priority to ensuring information communication at key space points and/or key time points, for example: the communication quality of command and dispatch terminals that may be in a dangerous state. Among them, the communication connection between the command and dispatch terminal and the cloud management platform can adopt LoRa, NB-IoT or multi-mode heterogeneous communication methods. Therefore, when multi-mode heterogeneous communication is used in emergency command and dispatch for forest fire prevention based on the Internet of Things, it not only realizes wireless communication, but also effectively reduces costs.

In some embodiments, the blockchain security management platform provides unified security management services, and security management runs through all levels vertically and horizontally (sensing layer, communication layer, support layer to the top application layer), providing a full chain, end-to-end unified security services, FIG. 86-1 shows the architecture diagram of the blockchain security management platform. The blockchain security management platform uses the information in the transmission process to encrypt the transmitted data. The information in the transmission process can include: node location (such as latitude and longitude coordinate data), communication system, time point, communication serial number, communication path, frequency, bandwidth, and/or speed, etc. The information used for encryption may also be various indicators/characteristics of the communication endpoint or various combinations of the above transmission information and characteristics of the communication endpoint. In this disclosure, the blockchain security management platform uses the ready-made chain of gateways to encrypt data using the location of the gateway (such as latitude and longitude coordinate data, the latitude and longitude information of the gateway is attached to the data transmission), communication protocol information and time information. The receiver verifies the authenticity of the data by checking the location information, communication protocol information and time information. The path (the path is defined by the geographic location information of the gateway through which the data passes) is converted into a key for encryption, and the receiver checks the path information to determine whether the data is legal. The receiver needs to know or collect legal paths in advance, or location information of legal path points (such as gateways). As an example, the data transmission path is different, the decryption key is different, the next node knows the location information of the previous node, layer by layer encryption, layer by layer decryption the next node decrypts the previous node, and then transmits the decrypted data to the next node. Alternatively, decryption may not be performed during node transmission, but after layer-by-layer encryption, it is transmitted to the server or cloud for decryption by the server or cloud. The method of using the key solves the problem of difficulty in key distribution and storage for terminal equipment, intermediate nodes (such as terminals, relays, routers, etc. as network nodes), and gateways/base stations. At the same time, the encryption process ensures data security from the source of terminal data, runs through the network layer/communication layer, and the multi-mode heterogeneous core network of the support layer, and provides secure data transmission for other sections of the support layer and the application layer, rather than only on the platform layers for security.

For example, the first sensing terminal at the terminal layer needs to transmit Data1 data to the first server, and the first sensing terminal has a unique device ID1, HMAC1 key and public-private key pair {NPkey1, NSkey 1}; the first server has Public-private key pair {CPkey, CSkeya} The first sensing terminal has a real-time clock and latitude and longitude location data, and sends data Data1 to the first server at time T1 and location L1. Among them, the encryption process includes: [symbol] use the server public key CPkey to encrypt T1 and Data1 to obtain the Ciphertext E1; [symbol] use the private key NSkey 1 to digitally sign ID1 and E1 to obtain the signature S1; [symbol] use the HMAC1 key to perform hash operations on E1 and S1 Obtain the hash value H1; [symbol] Send the data ID1, E1, S1 and H1 to the first server, and the first server will decrypt it. As an example, encryption can also be generated at the sensor terminal or gateway according to needs. FIG. 89-2 shows the process of nodes sending data through encryption and decryption.

In some embodiments, each node in the transmission can perform a superposition summary algorithm/stacked digest algorithm on the data, and after receiving the data packet, the server performs a digest algorithm on the information of the sending node and the intermediate node one by one to ensure the integrity and authenticity of the data. Continuing from the above example, in step [symbol] , it also includes: the first sensing terminal sends data ID1, E1, S1 and H1 to the first server and passes through several communication nodes in turn, wherein the communication nodes can be gateways, base stations, communication nodes, etc. devices involved in communication. Each node performs a superposition summary algorithm/stacked digest algorithm on the data sent by the previous node: after receiving the data IDn, En, Sn and Hn sent by node n, node m obtains the real-time time Tm and location Lm. Then the hash value Hm is obtained through the digest algorithm, and finally, the data IDm, IDn, En, Sn and Hm are sent to the next communication node, and so on, and finally the data is sent to the server. The encryption method provided by the embodiments of the present disclosure ensures the confidentiality, integrity and availability of data, and can resist common communication attack methods. For example: the saboteur obtains the data packet by monitoring the communication method Since the data is encrypted at the source of the sensing terminal, the saboteur cannot easily obtain the original data, so the content of the data cannot be known to ensure the confidentiality of the data; When the packet passes through each node, the integrity check value will be recalculated, and the receiving end will recalculate the integrity check value in the same way. Only when the data sender and all intermediate nodes are correct can it pass. This operation not only ensures data integrity, the property also ensures the non-repudiation of the communication node; the destroyer intercepts the data packet and resends the same data packet to the intermediate node (that is, the replay attack) Since the data uses the timestamp and the serial number as the key fragment, the receiving end Integrity verification and decryption will fail and the data packet will be discarded; if the saboteur uses a man-in-the-middle attack to simulate himself as an intermediate node, since superimposed encryption and verification cannot be performed, any changes to the data cannot pass through the receiving end verification. The blockchain security management platform removes the trouble of key distribution and storage, and saves resources; at the same time, it expands the communication security dependence from node to node to the communication chain, which has high security and high reliability functions, and greatly improves the entire Internet of Things system security. The blockchain security management platform provided by this disclosure is suitable for any scenario where IoT devices are safely connected to the cloud; it is suitable for securely connecting any type of third-party platform data, providing a secure channel and data tamper-proof; suitable for and combination of multiple communication types, such as LoRa, NB-IoT, LTE. Bluetooth, Zigbee, Sub 1G, WLAN, 4G, 5G, etc.; suitable for IoT device data, user-generated data, and third-party access data scenarios for secure access and uploading data to the blockchain for protection.

Referring to FIG. 1C, the present disclosure provides an example of the relationship between multi-mode heterogeneous network processes and systems.

The present disclosure provides a dynamic adjustment method of a multi-mode heterogeneous network. The method includes: obtaining a communication trigger source of a terminal; determining a communication requirement according to the communication trigger source of the terminal; and providing a corresponding communication strategy according to the communication requirement. In the field of Internet of Things or Industrial Internet, the three elements of communication are: ubiquitous, dynamic and real-time. Among them, ubiquitous mainly refers to widespread and ubiquitous networks. It is impossible for operator networks to achieve ubiquity based on their profitable nature, while multi-mode heterogeneous IoT can be built according to location and needs, that is, setting up corresponding multi-mode heterogeneous base stations in the required location. For example, in Daxing'an Mountains, there is almost no operator network coverage in forest areas, and it is impossible to achieve large-scale deployment of operator networks. However, it is possible to cover the targets by deploying multi-mode heterogeneous base stations. According to business requirements, communication requirements, and low-cost requirements, a single base station requires a large coverage area (corresponding to a longer communication distance), and the base station group only provides limited overall bandwidth. Secondly, dynamic means that the network is dynamically changeable. Dynamically adjust any communication parameters according to industry requirements or/and physical location to establish a network. In addition to mainstream communication modes, it also includes advanced networking methods such as Mesh, relay, and SDN Finally, real-time is about delay of communication Real-time is relative. In different communication scenarios, real-time delays are not the same. In order to meet the above three conditions, the concept of multi-mode heterogeneity is proposed. As shown in FIG. 1E. Bis dynamically determined according to A. Among them. A includes three situations (1) industry requirements (2) environment of terminals, gateways, and base stations (such as: time, location, task, channel, etc.) (3) conditions of terminals, gateways, and base stations themselves (such as, energy, noise, interference, etc.). B further includes data, communication, network, etc. Exemplarily, in the first case, industrial requirements refer to the different requirements for communication in different industries. For example, the environmental protection industry has the requirements of the environmental protection industry, the safety supervision industry has the requirements of the safety supervision industry, and the water conservancy industry has the needs of the water conservancy industry. Their needs are different. In the second case, the environment where the terminal, gateway, and base station are located refers to the physical environment, that is, the physical environment where the terminal, gateway, and base station are located, which further includes time, location, task, and channel. In the last case, the conditions of the terminals, gateways, and base stations include their own power, sensor values, and sensor conversion rates, and dynamically adjust parameters such as communication intervals, transmission power, and modulation methods. A dynamically determines B, such as adjusting parameters such as communication interval, transmission power, and modulation mode. If the terminal's own power is low, the sensor value is lower than the set threshold, or the sensor value changes small, the frequency of transmission will be reduced. Further, as shown in FIG. 1E, the data in B indicates how to collect data, what data to collect, how to process data, how to use data, how to transmit data, etc. and communication indicates what kind of communication settings, radio frequency parameters, transmission and reception mode, etc. and the network indicates what kind of networking method and transmission path are used in the transmission process. Different communication requirements determine different communication strategies, such as high-quality communication requirements, strategies such as data information splitting-multipath concurrency-convergence, real-time optimization of communication settings and radio frequency parameters, and construction of high-priority networks through core networks and base stations can be used, and can be dynamically allocated in actual situations.

In the present disclosure, according to different industry requirements, different physical environment requirements and/or different terminal conditions, the corresponding data, communication, network, etc. are dynamically provided and determined. For example, the environmental protection industry requires thousands of sites to report data at the same time, which not only requires low latency, but also sends high concurrency at the same time, but the time interval between two reports may be as high as 1 hour or 4 hours, which requires us to establish a multi-mode heterogeneous network capable of dynamically adjusting any communication parameters. Multi-mode heterogeneous network services not only provide separate access and management services for different network communications such as existing satellite links, cellular network links, RFID network management, LTE core network, WLAN network management, and LoRa core network; The wireless access service of the heterogeneous core network supports the integrated access and unified management of multi-mode heterogeneous wireless networks. Multi-mode heterogeneous network services provide network services that dynamically adjust any communication parameters according to industry requirements or/and physical locations, such as adjustable physical communication parameters such as source coding, channel coding, modulation modeling, signal time slot, and transmit power; Flexible scheduling and flexible expansion of wireless link access and management technology can perform functions such as remote control, upgrade, parameter reading/modification, and management of equipment, support link self-healing, and provide high-utilization, strong stability, and easy-to-restore professional wireless network hosting service.

Please also refer to FIG. 1F. As shown in the figure, the data is firstly sampled, wherein the sampling interval can be set according to requirements (for example, it can be sampled once every minute, or once every second) Then perform A/D conversion on the sampled data to convert the analog data into digital data, and the precision of the A/D conversion can also be set according to the needs it can be 8 bits, 12 bits, 16 bits, 24 bits etc. The digital data is then transmitted through the RF (radio frequency circuit) after the source encoder performs source encoding, the channel encoder performs channel encoding, and the digital modulator performs digital modulation. Wherein, information source coding can be realized based on one or more protocols, such as MPEG-1, MPEG-2, MPEG-4, H.263, H.264, H.265 and so on. The types of channel coding mainly include: linear block codes, convolutional codes, concatenated codes. Turbo codes, and LDPC codes. Digital modulation methods include: FSK (Frequency Shift Keying), QAM (Quadrature Amplitude Modulation), BPSK (Binary Phase Shift Keying), etc.

In the embodiment of the present disclosure, the multi-mode heterogeneous network service provides a network service that dynamically adjusts any communication parameters according to industry requirements or/and physical location, such as adjustable source coding, channel coding, modulation model, signal time slot, and transmit power and other physical communication parameters. For example, transmitting RF signals can be adjusted through PA (determining the transmitting power) and fn (determining the transmitting frequency point). Exemplarily, the adjustment includes allocating different transmission bandwidths to different services, and when the data transmission requirements of some terminals change, the multi-mode heterogeneous network adjusts the allocation of network resources to adapt to the demand changes. Exemplarily, the adjustment includes priority adjustment of signal transmission. For example, signals from some terminals are transmitted preferentially. For example, the data of some base stations or gateways are transmitted preferentially. For example, some service signals of the terminal are transmitted preferentially. The multi-mode heterogeneous network adjusts network parameters in a timely manner based on site detection and business requirements, which can ensure the implementation of important upper-layer services and improve the availability of the multi-mode heterogeneous network. Further, the adjustment includes dividing different data into different data streams and transmitting them through different communication paths. For example, part of the data is transmitted to the upper-layer business application through the 4G network, part of the data is transmitted to the edge computing module through the LoRa protocol, and part of the data is transmitted through a multi-mode heterogeneous network. On the premise of meeting the business transmission requirements, the network resource consumption is reduced as much as possible. As an example, in an urban fire application, multiple smoke sensor terminals are installed on each floor of a building, and the terminals are equipped with temperature identification capabilities and communicate with one or more wireless gateways. All terminals detect at a certain frequency during normal operation, but only send data to the gateway once a few hours to report device status (such as battery power, temperature, etc.). In order to reduce the power consumption of the terminal, spread spectrum modulation is used for communication, low transmit power and medium receiving sensitivity. When a fire occurs on a certain floor, all terminals on this floor will send smoke concentration and temperature data at a faster frequency, and these data will be used by the algorithm to calculate the spread of the fire and calculate the best escape route, in order to cope with the temporary increase of communication resources, it is important to enable multi-carrier frequency points for communication between the gateway and the device, use the 16QAM modulation that supports higher rates, and increase the transmission power and reception sensitivity to ensure the communication distance.

Please continue to refer to FIG. 1F, the transmitting end calculates the best channel to connect with the receiving end through the communication parameters, and the transmitting end transmits data to the receiving end through the channel. The receiving end receives through the receiving RF circuit, and outputs the signal through the digital demodulator, channel decoder, source decoder, and output (via output switch) in sequence.

As another example, air quality monitoring stations used for dust monitoring on construction sites use wireless gateways to transmit data back, in which particle sensors are used to assess dust conditions, and high-frequency sampling data can obtain finer dust change curves, but if the system is deployed, there are many different types of terminals, and the capacity of the gateway is limited, so the frequency of sampling and return can be appropriately reduced to reduce the occupation of communication resources. When there is a construction site during the day, a slightly higher sampling frequency should be used. If the wind speed is high and the dust spreads and changes quickly, a higher sampling frequency should be used to adapt to accurate change tracking. If there is no construction at the construction site at night, the sampling frequency, sampling accuracy and return frequency can be further reduced. If the change in the dust is small, the source coding can be changed to a difference method, that is, fewer data bits are used to represent the difference from the previous value. It is also possible to accumulate multiple sampling data and use a compression algorithm to compress and send them uniformly.

In summary, the multi-mode heterogeneous network of the present disclosure provides network services that dynamically adjust any communication parameters according to industry requirements or/and physical location, including adjustable source coding, channel coding, modulation modeling, signal time slot, and transmit power, etc. It also supports flexible scheduling and flexible expansion of wireless link access and management technology, which can perform functions such as remote control, upgrade, parameter reading/modification, management, etc. supports link self-healing, and provides high utilization, strong, stable and easy-to-restore professional wireless network hosting service.

In some embodiments, communication trigger sources include different requirements such as business requirements and control requirements, and different requirements include static requirements and dynamic requirements. Static requirements are generally used to maintain the networking status of terminal devices and send basic information, and dynamic requirements are divided into various situations, such as frequent monitoring of accident trends in sensing terminal equipment data, network self-healing for gateway/base station failures, real-time networking of mobile terminal equipment, temporary regulation, etc. The communication requirements corresponding to different communication trigger sources are also different, and the communication requirements include high speed, high quality, reliability, robustness, weak network access, disconnected network access, and increased frequency utilization. The modular heterogeneous network has many different strategies or methods to deal with different communication requirements. Multi-mode heterogeneous network strategies or methods include: split-multi-path concurrency-aggregation, communication dynamic adjustment, network dynamic adjustment, base station priority allocation, multi-path simultaneous transmission-redundancy removal, multi-path round-robin transmission, communication parameter adjustment. Network relay, ad-hoc network, end-to-end direct connection, end-station offload, etc. FIG. 19-1 shows the principle of multi-mode heterogeneous network split-multi-path concurrency-convergence strategy.

In some embodiments, the sensor of each terminal collects data to obtain a communication trigger source, and after performing edge computing, communication transmission, and cloud-edge collaborative computing on multiple sensing data, it can not only make scheduling decisions for different terminals, but also determine communication requirements for each communication trigger source. Different communication requirements require different communication strategies, which can be properly deployed in actual situations. For high-quality communication requirements, strategies such as split-multipath concurrency-aggregation, dynamic adjustment of communication, and base station priority allocation can be adopted; for communication requirements of network disconnection and network access, network relay, ad hoc network, and end-to-end can be used end-to-end strategies. In this embodiment, the data splitting and aggregation of multi-path transmission is realized by link aggregation using multi-standard and multi-layer networks (by means of link quality detection, link response time detection and link load detection, etc. and selection Optimal link), which can improve edge throughput, so that terminals can enjoy high-speed and stable data access services no matter where they are in the network. At the same time, through the integration of communication methods of different standards, seamless access to heterogeneous networks can be realized, and an appropriate communication method can be adaptively selected according to the network environment deployed by the terminal to improve the transmission service quality of the terminal. Aggregation provides the necessary hardware support. As an embodiment, the sending end splits the sent data packet into multiple sub-data packets, which are assembled at the receiving end to form a complete data packet. The sending end and the receiving end are different terminals, and they can be the sending end and the receiving end in different data transmission processes. According to the needs, on the basis of the hybrid network, the sub-packets can be sent from the sending end to the receiving end through multi-path and multi-communication, and different strategies can be adopted for multi-path transmission according to needs. When terminals communicate with each other, a connection can be established through the base station or directly without bridging through the base station, which reduces the bandwidth occupation of the base station. Hybrid networking adds ad hoc networking and point-to-point communication on the basis of the star network. When the terminal in the blind area cannot directly connect to the base station, it can establish a mesh network with other terminals, and realize uplink communication with the help of equipment that can connect to the base station. The terminal can switch between star network and mesh network; when working in mesh network mode, the terminal can be used as a routing node or a common node. FIG. 19-1 shows the data splitting and aggregation of multi-path transmission in a multi-mode heterogeneous network principle.

In some embodiments, all data in the communication process will be stored in the database, and a variety of parameters and status information for decision-making can be obtained through deep learning algorithms, covering communication strategy optimization parameters, path prediction parameters, resource scheduling parameters, and network fault reconstruction parameters, communication situational awareness information, network health status assessment information, etc. These results will be used to implement different multi-mode heterogeneous network strategies or methods, and improve the capabilities and effects of multi-mode heterogeneous network strategies or methods through continuous learning and optimization. And these results also apply to the collaboration of multi-mode heterogeneous networks, which are used to regulate the terminal's data, control the terminal's edge computing and cloud-edge collaborative computing, and even directly make scheduling decisions for the terminal. As an example, because of the network communication data transmission between the multi-mode heterogeneous Internet of Things network and the intelligent data fusion platform, the continuous access and downlink operation of data in different formats in the intelligent data fusion platform is dynamically realized, so that the data sources in the data lake of the data intelligent fusion platform can be expanded infinitely, and the data capabilities can be copied infinitely, providing huge data resources for various business scenarios. In this embodiment, the data sources in the data lake of the intelligent data fusion platform include: data from sensing terminals, communication big data, external data, and data generated by the platform in the algorithm. In a nutshell, the data intelligent fusion platform can realize multi-industry access, including multi-industry data such as air, weather, soil, transportation, construction, water quality, fire insurance, etc. including environmental protection, fire fighting, municipal administration, etc. first access and then integrate. Break through industry barriers; at the same time, the data intelligent fusion platform also provides multi-source heterogeneous data access, including data sources such as databases, file systems, and message queues, as well as structured, semi-structured and unstructured data sources, and data sources can be infinitely expanded, data capabilities can be copied indefinitely, providing huge data resources for various business scenarios, its data specifications are unified, providing a unified data dictionary and data specifications, reducing development costs and improving data quality.

It is worth noting that the core network and base stations collect communication data of base stations, routing nodes, and terminals, communication standard, modulation, communication path, signal-to-noise ratio, packet loss rate, delay, channel occupancy rate, etc. and use deep learning algorithms to make link predictions. According to the network environment and transmission requirements (bandwidth, speed, response time, reliability, connection distance, etc.); connection mode (direct connection to the base station, mesh network, point-to-point), transmission path (single path, multi-path), source coding (such as Huffman coding, arithmetic coding, LZ coding, etc.), modulation modeling (such as FSK, GFSP, spread spectrum, BPSK, QPSK, 8PSK, 16QAM, 64QAM, etc.), channel coding (such as Turbo code, LDPC code. Polar code, LT code, etc.), signal bandwidth, transmit frequency point, radio frequency parameters (modulation mode, rate, spectrum occupancy, receiving bandwidth) and other factors are dynamically adjusted.

In some embodiments, splitting-multipath concurrency-gathering is the data splitting and gathering method of multi-path transmission, including splitting the data packet into multiple data packets, different data packets transmitted through different communication methods and different path and finally is spliced into complete data after being aggregated at the receiving end. When multi-path transmission adopts different strategies as required, as an embodiment: a) the data packet is split into multiple data packets, which are transmitted in turn through different paths to increase robustness, b) the data packet is split into multiple data packets, and passed different paths are transmitted in parallel to increase network bandwidth, c) the same communication packet is transmitted redundantly through different paths at the same time to increase reliability FIG. 19-1 shows the principle of data splitting and aggregation methods for multi-path transmission. In some embodiments, when the devices in the blind area cannot be directly connected to the base station, a mesh network can be established with other devices, and uplink communication can be realized by means of devices that can be connected to the base station. The device can switch between the star network and the mesh network; when working in the mesh network mode, the terminal can communicate as a routing node or a common node. FIG. 2-1 shows the communication principle between terminals.

In some embodiments, when adjacent devices communicate with each other, a connection may be established through the base station or directly without bridging through the base station, thereby reducing spectrum occupancy of the base station. Evaluate the communication bandwidth requirements between the two devices from the application requirements, and select the appropriate code rate/data rate, modulation, and control of transmission power according to the distance between the two devices and radio frequency noise conditions, so as to achieve the minimum occupancy of spectrum resources, as shown in FIG. 2-4 which illustrates the control principle of transmitting power and receiving sensitivity between terminals.

In some embodiments, the terminal node dynamically adjusts parameters such as communication interval, transmission power, and modulation mode according to its own power, sensor value, and sensor conversion rate. For example, if the terminal's own power is low, the sensor value is lower than the set threshold, or the sensor value changes negligible, the transmission frequency will be reduced. FIG. 25-4 shows the technical flow chart for dynamically adjusting the terminal reporting time interval.

Referring to FIG. 1D, the present disclosure provides an example of a next-generation Internet of Things traffic flow.

As shown in FIG. 1D, the sensing device 3 (represented by sensing 3 in the figure, similarly, the sensing device 2 is represented by sensing 2, and the sensing device 1 is represented by sensing 1) has end computing functions, and can directly generate edge decisions through sensing data (In the figure, it is represented by edge computing 3) so as to directly link control 3, and the sensing data is sent to the gateway/base station 1 through ad hoc network communication at the same time. In this embodiment, the sensing data collected by the sensing device may be water, air, electricity, earth, sound, fire, and the like. Sensing devices can be mobile terminals such as handhelds, walkie-talkies, vehicle-mounted devices, positioning terminals, and wearable terminals, sensing data can also be voice/video/text, etc. For example, the sensing device can be a variety of video sensing terminals such as cameras, thermal imaging, and hyperspectral.

Further, sensing device 1 obtains sensing data from sensing device 2 through point-to-point communication, fuses the sensing data of the two devices, and uses edge computing 1 to automatically adjust the sensing strategy (such as increasing sampling frequency, increasing sampling progress) if specified conditions are met etc. and control the sampling behavior of sensing device 1, and request to adjust communication parameters and strategies to obtain higher rate and highly reliable transmission through multi-mode communication, and in connection with control 1 performing corresponding actions. Among them, the data collected by the sensing device is uploaded to the edge computing module. The edge computing module can be a part of the terminal, or a different device connected to the terminal by short-distance communication, such as a device connected to the terminal through ZigBee, Wifi, Bluetooth, etc. The edge computing module forms edge decisions based on the processing of sensor data Among them, the formation of edge decision-making is based on the data processing of one or more sensing devices. For example, the edge computing module fuses the data of more than one terminal to form an edge decision. FIG. 25-3 shows the technical process of terminal data calibration based on the edge computing mode. In some embodiments, the edge computing module acquires processed data based on the processing of data, for example, implements edge correction and self-correction of sensor data, and the processed data is further used for uploading or forming edge decisions. The edge decision-making of the edge computing module includes adjusting the terminal's sensing strategy based on the processing of sensor data, such as dynamically changing the sampling interval, sampling accuracy, and sending frequency according to the rate of change of sensing data, preset thresholds, and network conditions, etc. so that the response can be considered at the same time, power consumption of the whole machine, and network bandwidth occupation, etc. In addition, the edge decision-making of the edge computing module can also include processing and executing preset behaviors based on collected data. The preset behaviors include, for example, triggering linkage alarms, linkage calls, linkage control valves/doors, linkage SMS/email notifications, etc. through linkage terminals. FIG. 2-1 shows the trigger linkage process of edge decision-making.

Furthermore, the gateway/base station 1 has edge computing capabilities, which can collect data from multiple sensing terminals, have higher-level decision-making capabilities, and can be configured to directly issue instructions to devices to execute drive/control when the front-end and center are disconnected, and can adjust the communication parameters of the adjacent gateway/base station 1 to provide better communication services for high-priority devices.

Please continue to refer to FIG. 4. All gateway/base station data finally enters the support platform through the multi-mode heterogeneous core network, and is used for calculation, display and storage after fusion of big data. Real-time monitoring and analysis of on-site conditions through cloud computing and artificial intelligence algorithms. If an alarm occurs, an execution control command will be issued to the designated device, and the adjustment of communication parameters and strategies will be sent to the core network to dispatch communication resources to related devices. Generate an operation plan through the auxiliary decision-making system to provide assistance to the leader, and then start the command and dispatch process, and send it to the gateway/base station 3 through the fusion of communication data, mobile terminal 2), the ad hoc network communication between the mobile terminals is used for on-site command, and the mobile terminal 1 keeps in touch with the support platform through the gateway/base station 2.

The communication layer includes a multi-mode heterogeneous intelligent IoT composed of base stations and gateways, dynamically adjusting any communication parameters according to industry requirements or/and physical location to establish a network Provide network support for the terminal layer, such as the integration of fixed network and mobile network, the combination of broadband, medium and narrowband networks, and integrated communication of voice/video/text/picture/data/file.

The base station covers a variety of communication networks such as satellite, private network, WLAN, bridge, public network, multi-mode heterogeneous network, etc. and dynamically adjusts any communication parameters according to industry requirements or/and physical location to establish a network. For example, it supports data splitting and aggregation for multi-path transmission, and adopts different strategies according to needs during multi-path transmission. Gateways include different types of edge AI, security, positioning, video, mid-range communication, CPE, RFID, technical detection, etc. which can realize network interconnection with different high-level protocols, including wired and wireless networks, and dynamically adjust according to industry requirements or/and physical locations any communication parameters. The gateway or base station at the communication layer transmits data with the terminal layer through any one or a combination of methods such as Wifi, LoRa, ZigBee, Bluetooth, and operator networks. Optionally, in an area where a communication connection cannot be directly established with a gateway or a base station at the communication layer, a connection between the communication layer and the terminal layer is established through an ad hoc network. The communication layer receives, for example, the edge decision of the edge computing module or the data of the terminal through the network connection with the terminal layer.

In some embodiments, the communication layer includes a fog edge computing module, and the communication layer configures the fog edge computing module in one or more gateways or base stations, and the fog edge computing module receives the sensor data, intermediate data, or edge decision-making according to the configured gateway or base station, or the edge computing module, and executes the preset fog edge computing content, forming a fog decision-making level higher than the edge decision-making.

Fog decision-making includes adjusting communication parameters and strategies. If the object of communication parameters and strategies includes the communication layer, the communication layer adjusts communication parameters and strategies accordingly to meet business data requirements. For example, base stations or gateways preferentially transmit some data to the core network, and/or base stations or gateways adjust the bandwidth allocation for different terminals or services, and/or the communication layer starts multi-mode transmission and negotiates with the terminals to suggest a multi-mode connection. If the object of communication parameters and strategies includes the terminal layer, the relevant terminal equipment implements the adjustment of communication parameters and strategies to optimize the data transmission of the terminal layer, for example, the terminal adjusts the frequency band, power, modulation mode, ete of signal transmission, such as the terminal negotiates with the network layer to establish a multi-mode connection, for example, the terminal preferentially transmits data with low bandwidth occupation, etc.

The core network of the communication layer aggregates the data of multiple base stations/gateways. The next-generation Internet of Things system or industrial Internet system performs big data fusion processing on the data converged to the core network, and analyzes and calculates the data based on cloud computing technology, artificial intelligence algorithm technology, etc. and finally forms business data to provide upper-level services, such as Form a business alarm. The artificial intelligence industry algorithm platform supports unified management and operation and maintenance of computing power and service resources, and can realize fog computing, edge computing, and artificial intelligence industry algorithm platform itself according to industry applications, computing power, network and communication conditions. Dynamic allocation of computing power and algorithm tasks. The containerized cluster method is adopted to support flexible scheduling of computing resources, and automatic expansion and contraction can be realized according to actual configuration scenarios to improve the utilization rate of computing resources.

In some embodiments, when the analysis and calculation results of the data meet the preset business rules, the upper-layer business dynamically adjusts the communication layer based on business requirements. For example, the upper-layer service control core network delivers communication policy updates to gateways and base stations. For example, the upper layer services update the parameters and strategies of the communication network, and the core network, gateway or base station perform dynamic adjustments based on the updated parameters and strategies.

The upper-level business can be business applications in various scenarios such as smart city traffic management, highway traffic management, cultural relics management, fire prevention, forest fire protection, and smart grid.

The upper-layer business provides some interactive functions for users.

Optionally, the interactive function provided by the upper-layer service is a visual display service, such as based on digital twin technology or 3D modeling technology, combined with sensor data and edge decision-making to display the on-site environment and real-time status of the terminal.

FIG. 84-3 is based on VR technology Scenario presentations and simulation visualization examples.

Optionally, the interactive function provided by the upper-layer service is a streaming media display service, such as pulling service-related streaming media data from the integrated data and playing it on the user's service terminal. FIG. 38-1 shows the technical principle of the streaming media platform, FIG. 38-2 is the process of pulling streaming media.

Optionally, the interaction function provided by the upper-layer service is command and dispatch service, so that the remote service terminal is linked with the mobile terminal at the service site FIG. 40-1 is the technical process of the converged communication center. Furthermore, the upper-level business provides auxiliary decision-making services, and provides decision-making basis or decision-making suggestions based on technologies such as artificial intelligence and big data analysis.

In some embodiments, the business site does not have the access conditions of a fixed gateway or a base station, and network access is realized through a mobile gateway or a mobile base station to meet the command and dispatch requirements of the business site. The mobile gateway or mobile base station and the mobile terminal on the business site form an ad hoc network. On the one hand, the ad hoc network communicates with the upper-layer business through access to the core network, and transmits business data, such as issuing business instructions, uploading business data, and instant messaging Data, etc. On the other hand, as a part of the multi-mode heterogeneous network, the self-organizing network is managed by the communication strategy of the core network, and realizes the dynamic adjustment of the multi-mode heterogeneous network according to the actual needs of the business.

In some embodiments, the mobile terminal performs related actions at the service site, such as controlling linkage terminals, collecting sensing signals, and so on.

In some embodiments, the upper-layer service directly sends instructions to the terminal layer to control some terminals at the terminal layer to perform related actions, such as controlling linkage-type terminals, such as controlling awareness-type terminals.

In some embodiments, a terminal can access a star network or a mesh network, and switch between the star network and the mesh network. When the terminal cannot directly connect to the base station, it can access the base station through cascading of other terminals. When the terminal works in the mesh network mode, the terminal can be used as a routing node or a common node. It supports point-to-point intercommunication between devices, reducing the bandwidth occupation of the base station.

In some embodiments, the multimodal heterogeneous network dynamically adjusts any communication parameters based on industry requirements or/and physical location. Exemplarily, the adjustment includes adjusting the signal transmission of some terminals from single-mode transmission to multi-mode transmission, or from multi-mode transmission to single-mode transmission, so as to meet different bandwidth and data types under different scenarios and service requirements and/or transport needs. For example, when the current bandwidth cannot meet the temporary high-concurrency data transmission, the transmission bandwidth is increased by adjusting single-mode transmission to multi-mode transmission. Exemplarily, the adjustment includes allocating different transmission bandwidths to different services, and when the data transmission requirements of some terminals change, the multi-mode heterogeneous network adjusts the allocation of network resources to adapt to the demand changes. Exemplarily, the adjustment includes priority adjustment of signal transmission. For example, signals from some terminals are transmitted preferentially. For example, the data of some base stations or gateways are transmitted preferentially. For example, some service signals of the terminal are transmitted preferentially. The multi-mode heterogeneous network adjusts network parameters in a timely manner based on site sensing and business requirements, which can ensure the implementation of important upper-layer services and improve the availability and practical value of the multi-mode heterogeneous network.

Further, the adjustment includes dividing data into different data streams and transmitting them through different communication paths. For example, part of the data is transmitted to the upper-layer business through the 4G network, and part of the data is transmitted to the edge computing module through the LoRa protocol. On the premise of meeting the business transmission requirements, the consumption of network resources is reduced as much as possible.

The embodiment of the present disclosure provides the operation process of the next generation Internet of Things in the field of forest fire fighting. It should be understood that it is only a preferred embodiment of the present disclosure, and does not limit the scope of protection of the present disclosure. Any equivalent structure or equivalent process transformation made by using the contents of this disclosure and the accompanying drawings, or directly or indirectly used in other relevant technical fields are equally included in the protection scope of the present disclosure. The disclosure can be used in forest fire prevention, security monitoring, farm management, traffic management, criminal investigation, battlefield and other scenarios. When the upper-layer business is flame detection in the forest fire prevention industry, the following solutions are used to meet the business needs the network coverage of operators in forest areas is poor, and multi-mode heterogeneous base stations are deployed to cover target areas. In order to control costs, a single base station requires a large coverage area (corresponding to longer communication distances), and base station clusters provide only limited overall bandwidth. Sensing devices include flame detection terminals and cameras. Security encryption that can use communication endpoint characteristics or communication information as a key (refer to the above embodiment about encryption). Flame detection terminals have low power consumption, fast response, and small amount of communication data, but many points and scattered deployment require long-distance communication; cameras have high power consumption, slow response, and large amount of communication data. Sensing equipment can detect specific infrared light signals generated by flame combustion. Due to the background noise in the environment, it is necessary to fuse the data of infrared sensors with multiple wavelengths, and analyze the original signals of multiple sensors through edge computing to determine whether there is a fire. The sensing device is connected to the camera through a wired method. After judging the existence of a fire, the edge side automatically sends information to the camera, and the camera completes the capture action and generates pictures/videos. Finally, only the fire result/picture/video is needed to send to the platform, and the original signal is not needed.

The flame detection terminal is connected to the base station through a low-speed long-distance configuration, and some terminals that cannot be directly connected to the base station are connected to the base station through a nearby terminal relay. When the terminal is turned on, try to connect directly to the gateway/base station. By evaluating the actual connection situation, the communication performance between the terminal and the gateway/base station can be evaluated. When there is no fire, choose the communication method that occupies the least resources. If the terminal cannot directly connect to the gateway/base station, then select the multi-dimensional networking mode. As an example, the terminal communicates with another relay that can be covered by the gateway/base station terminal, and the terminal responsible for the relay turns on the low-power monitoring mode. Monitor the leading signal of the relayed terminal, if there is no detected signal, it will enter the sleep mode immediately, if the signal is recognized, it will start to receive the entire data packet, and resend the data packet to the gateway/base station. The flame detection terminal samples at a regular speed, and analyzes whether there is a fire through terminal calculation. If there is no fire, it dynamically sends the prediction result, status information and other communication parameters to the server according to the detection prediction result, and the interval increases and shortens as needed. As the risk of a sensed fire increases, the frequency of detection increases and so does the sending of relevant information.

The cloud computing engine requests part of the original data fragments from the device in different periods of time. These original data fragments will be used for background noise analysis, combined with historical big data and current meteorological big data to obtain the current detection parameter set through artificial intelligence algorithms, and send it to the base station, and the base station sends it to the terminal one by one in time division. The terminal uses the new detection parameter set for flame detection.

The PTZ camera scans the surrounding area according to the designated cruise track, and sends video data to the server at a certain period, and the video data is displayed in rotation on the large screen of the monitoring center through the streaming media service and the visualization engine. Multiple PTZs time-share the base station bandwidth.

When a flame detection terminal detects a flame signal, it immediately sends an alarm signal to the background, and immediately sends data to the gateway/base station through the established communication network, and the gateway/base station sends the data to the artificial intelligence service through the multi-mode heterogeneous core network. The platform and the background platform start the emergency process according to the business needs of the industry. The artificial intelligence business platform sends a control command to control the camera near the flame detection terminal through the multi-mode heterogeneous core network, and controls it to shoot video in the direction of the flame detection terminal. The multi-mode heterogeneous core network sends commands to the on-site base station via the gateway/base station, and the base station dynamically adjusts communication resources to the flame detection terminal and camera, and other devices far away from the fire area temporarily lower the communication priority and give up communication resources. The terminal that discovers the fire starts the rapid detection process, detects the intensity of the flame, and immediately sends it to the server through the gateway/base station. At the same time, the camera also sends real-time continuous video to the server to show the spread of the fire, providing data support for firefighters to make decision-making.

When the upper-level business is forest fire emergency command and dispatch, the business needs are met through the following schemes:

In the case of no fire, there is no need for command and dispatch on site, and there is no need to configure base stations separately. When a fire is discovered, mobile multi-mode heterogeneous base stations are deployed on site, and rescuers are equipped with mobile command and dispatch terminals. Mobile terminals support multimedia communication: information, voice, image, positioning, etc. When the on-site communication resources are sufficient, video and voice can be turned on at the same time. When on-site communication resources are tight or the distance between the terminal and the base station is too far to support high-speed communication, the converged communication service at the support layer will control the corresponding device to switch to single-voice mode Heterogeneous core network negotiation, dynamic adjustment of communication and network to ensure the communication distance of the device, if the communication rate is still limited, the short message communication mode will be turned on. Furthermore, the multi-mode heterogeneous network management platform will predict the forest fire spread area and spread time according to the artificial intelligence management platform, according to the distance between the command and dispatch terminal and the fire scene, and whether the command and dispatch terminal will be in the area where the fire will soon spread in the short term, etc. In emergencies, dynamically adjust the bandwidth and rate, and give priority to ensuring the communication quality of command and dispatch terminals that may be in danger. The artificial intelligence management platform obtains geographical data, vegetation data, forest fire factor data, meteorological data, real-time data of sensing terminals, fire extinguishing resources and other data from the data lake of the data intelligence fusion platform, and calculates the center of the fire point and the current fire area through the deep learning algorithm, fire spread trend, feasible rescue path, etc. combined with command and dispatch terminal location data, the optimal rescue path for on-site rescuers is deduced. The rescue path takes into account factors such as the safety of rescuers and fire-fighting efficiency. Through the trajectory prediction of command and dispatch terminals, the artificial intelligence management platform can determine the dynamic networking requirements of command and dispatch terminals; which terminals are key terminals, the required communication rate, etc. and send the requirements to the multi-mode heterogeneous core network. The heterogeneous core network retrieves historical communication big data from the data lake, combined with on-site communication environment data, deduces the optimal networking mode, communication resource scheduling strategy, etc. through deep learning algorithms, and issues the final control instructions through the gateway/base station to the command and dispatch terminal and/or the on-site mobile gateway/base station, the command and dispatch terminal forms a network according to the instructions and returns a variety of streaming media information in real time for further use by the platform.

During the dispatching process, the integrated communication center provides three major service functions: (1) Instant messaging function, which is used to issue command and dispatch instructions and listen to on-site situation reports. The integrated communication center can establish communications between artificial intelligence business platforms and on-site terminals, terminals and terminals, platforms and multi-terminal groups. Depending on the network connection, different communication methods can be established, such as video calls, audio calls, and text communications. If the communication condition is good, use the video call, if the communication condition is normal, use the audio call, and if the communication condition is poor, use the text communication. When it is really necessary to use a high-speed communication mode but the current terminal network connection rate does not support it, the artificial intelligence service platform can initiate a network evaluation to the multi-mode heterogeneous core network, and the core network will be reorganized according to the current network status and environment through deep learning algorithm evaluation. Network, temporary allocation and other methods can meet the communication rate allocation of the specified terminal, and if the conditions are met, the allocation will be performed. When using text communication, it is supported to use the language processing unit of the platform in the algorithm to convert the voice of the platform into text and send it to the terminal; when using group calls, it supports some terminals to use video calls and some terminals to use voice calls. The artificial intelligence industry algorithm predicts and simulates the spread of fire based on current and historical data, and can directly output automatic dispatching instructions. These dispatching instructions can be directly sent to the terminal through the integrated communication platform without manual participation. According to the networking of the terminal, automatic scheduling instructions can be issued in voice or text format. The original format of dispatch instructions can be voice or text (of course, video, pictures or other types of files can also be included). Through the algorithm platform TTS speech synthesis algorithm and NPL natural language recognition algorithm, dispatch instructions can be converted between speech and text (2) Location positioning, which provides the collection and circulation of terminal location information. The location information is used in the algorithm center to generate dispatching decisions for on-site personnel, the location information is used in the digital twin center for visual display, and the location information is used in the multi-mode heterogeneous core network for dynamic networking and communication resource allocation. (3) On-site monitoring. The artificial intelligence business platform can actively perform operations such as pulling terminal video streams, controlling terminals to take pictures, and controlling terminal recordings. These operations do not require any operations on the terminal, thereby reducing unnecessary intervention for rescuers.

According to information such as fire control situation, rescue personnel situation, and real-time scheduling of the artificial intelligence business platform, the platform side calculates communication requirements in real time and dynamically adjusts communication strategies to ensure real-time, dynamic, and coherent communication connections between command and dispatch terminals and on-site sensing equipment. The platform in the digital twin can display to the command center the prediction and simulation data of the platform in the artificial intelligence industry algorithm (such as fire spread prediction), the location data of on-site rescuers, and the data of the communication network (base station/gateway coverage area, communication equipment interconnection, etc.), so as to help the command and dispatch of the command center. The next-generation artificial intelligence Internet of Things or industrial Internet systems and algorithms are based on multi-mode heterogeneous networks and are specially designed for smart twins/smart empowerment in various industries, covering multiple levels. The whole can be divided into five horizontal and three vertical, and the five horizontal from bottom to top are terminal layer, transmission layer, support layer, artificial intelligence business platform layer, and urban operation comprehensive IOC layer. The three verticals are security, operation and maintenance, and IT resource services, in which security and operation and maintenance vertically run through all horizontal levels, providing full-chain, end-to-end services; IT resource services provides services for support layer, artificial intelligence business platform layer and urban operation integration. The IOC layer.

### 1. The Correlation of the Five Horizontal Layers is as Follows.

### (1) Terminal Layer, Including all Technologies Numbered T1-1 to T1-14.

As shown in FIG. 1, the terminal layer T1 includes tens of thousands of different industries and different types of sensing, linkage, multi-mode heterogeneous communication, mobile, video and other terminals.

Sensing terminals can detect the multi-dimensional state of the city ubiquitously, in real time, and dynamically, such as water, gas, electricity, soil, sound, fire, etc. and the sensor data can be uploaded to the central platform via the network with dynamically adjusted communication parameters according to industry requirements or/and physical location.

Linkage terminals can realize edge-side sensing and execution linkage through a multi-mode heterogeneous network that dynamically adjusts any communication parameters according to industry requirements or/and physical location, such as linkage alarms, linkage calls, linkage control valves/doors, linkage text messages/mails notifications and more.

Multi-mode heterogeneous communication terminals provide those sensors that do not have communication transmission capabilities with dynamically adjusted transmission and interconnection according to industry requirements or/and physical locations. Multi-mode heterogeneous communication terminals support composite sensing technology, multi-sensor data fusion, and support unified access of sensing devices from different manufacturers. Sensing technology combined with edge computing technology realizes edge correction and self-correction of sensor data, and an optimized sampling strategy is derived from it, such as dynamically changing the sampling interval, sampling accuracy and sending frequency, etc. so response time, power consumption of the whole machine, and network bandwidth occupation can be taken into account at the same time.

Mobile terminals include handhelds, walkie-talkies, vehicle-mounted devices, positioning terminals, wearable terminals, etc. which detect and applied in a mobile state, and realized through a multi-mode heterogeneous network based on dynamic adjustment of any communication parameters according to industry requirements or/and physical location to realize combination of wide, medium and narrow, voice/video/text fusion communication applications.

Video terminals include diverse video sensing terminals such as cameras, thermal imaging, and hyperspectral, and are uploaded to the central platform through a multi-mode heterogeneous network that dynamically adjusts any communication parameters according to industry requirements or/and physical locations.

The implementation of the terminal layer in the present disclosure will be described in detail below in conjunction with the embodiments.

### T1-1-1—Edge Computing Technology.

A general-purpose gateway cannot obtain or process data by itself, and it will completely lose its autonomy if it is separated from the server. A brief network interruption can cause data loss. Even if some terminals have the function of data cache retransmission, the real-time performance of retransmitting data after the network is restored has been destroyed, making it impossible for other terminals to make processing and decision-making in the first place. For some scenarios with relatively high security requirements, such as natural disasters (fires, floods, earthquakes, etc), network interruption and delay will cause the system to miss the best decision-making and execution window period, which may cause damage to life and property and huge loss. In the traditional method, the downlink data must be sent by the Internet of Things service center after the terminal is connected to the network. The gateway cannot directly send data to the terminal. In special circumstances (fire, flood, earthquake, etc.), the terminal and the server may not be able to communicate. In prior art circumstances, important alarm information of the service center is not sent to the terminal in time, which may cause loss of life and property.

With the prior art terminal networking method, when the terminal data is abnormal, the system cannot respond quickly, and the control command from the IoT service center is often delayed. When the gateway and the IoT service center cannot be connected, the alarm and disposal of the abnormal data of the equipment will not happen. In addition, the original massive data transmission of equipment to the Internet of Things service center has caused pressure on communication bandwidth and data pressure.

Edge-cloud collaboration has already begun to be applied in the IoT field to improve the operational efficiency of the IoT. Among them, edge-cloud collaboration refers to the collaboration between edge computing and cloud computing. For example: edge computing is not a single component, nor a single layer, but an end-to-end open platform involving EC-IaaS, EC-PaaS, and BC-SaaS As an example, edge computing nodes generally involve networks, virtualized resources, RTOS, data planes, control planes, management planes, industry applications, etc. wherein networks, virtualized resources, RTOSs, etc. belong to EC-IaaS capabilities, and data planes, control planes, etc. management plane, etc. belong to EC-PaaS capabilities, and industry applications belong to the category of EC-SaaS. Edge-cloud collaboration involves comprehensive collaboration at all levels of IaaS, PaaS, and SaaS. EC-IaaS and cloud IaaS should be able to achieve resource collaboration on networks, virtualized resources, security, etc.; EC-PaaS and cloud PaaS should be able to realize data collaboration, intelligent collaboration, application management collaboration, and business management collaboration; EC-SaaS and cloud SaaS should enable service collaboration.

For example, for resource collaboration: edge nodes provide infrastructure resources such as computing, storage, network, and virtualization, and have local resource scheduling and management capabilities. At the same time, they can collaborate with the cloud to accept and execute cloud resource scheduling management strategies, including edge node equipment management, resource management, and network connection management.

For example, for data collaboration edge nodes are mainly responsible for the collection of on-site/terminal data, conduct preliminary processing and analysis of data according to rules or data models, and upload the processing results and related data to the cloud; the cloud provides storage, analysis and value mining. The data collaboration between the edge and the cloud supports the controllable and orderly flow of data between the edge and the cloud, forms a complete data flow path, and performs lifecycle management and value mining of data efficiently and at low cost. For example, for intelligent collaboration: edge nodes execute reasoning according to the AI model to realize distributed intelligence, the cloud performs centralized AI model training and distributes the model to edge nodes.

For example, for application management collaboration: the edge node provides the application deployment and operation environment, and manages and schedules the life cycle of multiple applications on the node, the cloud mainly provides application development, testing environment, and application life cycle management capabilities.

For example, for business management collaboration: edge nodes provide modular, micro-service applications, digital twins, and network application instances, the cloud mainly provides business orchestration capabilities for applications, digital twins, and networks based on customer needs. For example, for service collaboration: edge nodes implement part of ECSaaS services according to cloud policies, and realize customer-oriented on-demand SaaS services through the collaboration of ECSaaS and cloud SaaS, the cloud mainly provides SaaS services in the cloud and edge nodes SaaS service capabilities.

In practical applications, not all scenarios involve the aforementioned edge-cloud collaboration capabilities. Combined with different usage scenarios, the capabilities and connotations of edge-cloud collaboration will be different. At the same time, even the same collaboration capability will have different capabilities and connotations when combined with different scenarios. In related technologies, gateways lack mutual data communication mechanisms, which cannot meet the requirements of fast communication between gateways in special application scenarios to meet the requirements of fast dissemination of key information; system expansion is more complicated, although it can be added on the cloud. More storage and computing power can realize the expansion of cloud computing, but for edge computing, it is necessary to add or physically upgrade equipment for the organization to obtain more computing power or storage space; edge computing security faces a more complex situation, protecting distributed edge computing networking can be difficult and often requires physical access to each individually deployed device, adding multiple edge computing devices also increases the vulnerable surface area; edge computing requires additional storage, but the edge can have a lot of storage, reducing the burden on data centers to store all IoT and IoT data; edge computing requires more complex maintenance because edge computers are distributed and maintenance may require access to every location where devices are deployed. In order to solve at least one of the above defects existing in the current edge-cloud collaboration technology, embodiments of the present disclosure provide an edge computing method and system, which can be applied to a scenario of edge-cloud collaboration. Exemplarily, the edge computing method and system involves low-power wide-area wireless Internet of Things edge computing technology and fog computing technology. FIG. 1-1 is a flow chart of low-power wide-area wireless Internet of Things edge computing and fog computing technology.

Edge computing belongs to the basic level of architecture in intelligent manufacturing. “Near real-time” analysis on the production floor can improve operational efficiency and increase margins to improve profits. In the process of collecting data and manufacturing intelligent tools through the edge computing system, abnormal situations can be identified in time to avoid production line stoppage as much as possible.

With the addition of edge computing, the collected data can let the local device know which function to perform without shuttling between local and central servers. In this way, operating costs and storage equipment investment can be saved.

For those enterprises with large and complex security systems, edge computing is very practical, it can effectively filter out key information to prevent the waste of bandwidth. For example, a motion-capture camera could only upload valuable information if it had computing power.

The edge computing method provided by the embodiments of the present disclosure can be applied to the architecture shown in FIG. 1, for example, various terminals shown in FIG. 1 (such as flame detection terminals, gate access control, multi-mode heterogeneous MESH terminals, satellite terminals, cameras, water conservancy terminals, etc), various gateways (such as security gateways, video gateways, positioning gateways, technical detection gateways, etc.), various base stations (mobile stations, private network base stations, WLAN base stations, network bridges, etc.) Edge computing capability, and the edge computing method provided by the embodiments of the present disclosure can be used to realize edge computing.

In addition, the edge computing method provided by the embodiments of the present disclosure can also be applied to the architecture/flow shown in FIG. JA, FIG. 1B, FIG. 1C and FIG. 1D (ie, FIG. 1A-ID). For example, terminals, gateways, base stations, etc shown in FIGS. 1A-ID have edge computing capabilities themselves, and they can implement edge computing based on the edge computing method provided by the embodiments of the present disclosure.

Exemplarily, the edge computing method provided by the present disclosure involves low-power wide-area wireless Internet of Things edge computing technology and fog computing technology, and the technical process of the edge computing method includes the following components: sensing/detection, the sensor of the terminal device, the main function is to collect sensing parameters; execution: the actuator of the terminal device is responsible for performing corresponding actions; sensing terminal: a terminal including sensors, which can detect related parameters; executing terminal a terminal including actuators, which can perform corresponding actions. For example, actions such as sprinkling, spraying, and alarming can be performed; composite terminal: a terminal that includes both sensing sensors and actuators. It can sense relevant parameters and execute corresponding actions. The terminal issues execution instructions: mobile terminal, mobile terminal equipment, an intelligent mobile terminal with voice call function, which can establish a connection with the mobile gateway; mobile gateway responsible for accessing the voice call access of the mobile terminal; slave gateway: composite terminal and slave gateway establish a connection and send the collected sensor parameter data to the slave gateway. The slave gateway can directly issue instructions to the composite terminal, or receive the instructions issued by the master gateway and forward them to the composite terminal; the master gateway can connect with the slave gateway and receive, from the slave gateway, the reported sensing parameter data. It can also issue instructions to the slave gateway; and send the sensing parameter data to the server, receive the command issued by the server and forward it to the slave gateway; server: connect to the master gateway, and receive the sensing parameter data reported by the master gateway, can also issue instructions to the main gateway, and can exchange data with other servers at the same time.

The edge computing method includes: collecting data by several sensing terminals; judging whether the data collected by the sensing terminals is abnormal; when abnormal, the first device connected to the sensing terminal generates first alarm information, and sends the first alarm information to the all second devices connected to the first device; the second device sends second alarm information to all alarm devices connected to the second device. Wherein, both the first device and the second device may be edge devices or intermediate devices (such as core terminals in the following).

Wherein, the sensing terminal may be various sensors with data collection functions or electronic devices with sensors, for example, temperature sensors, smoke sensors, atmospheric pressure sensors, sound wave sensors, image sensors, cameras, etc. Any edge device can be used for data packet transmission between access devices and core/backbone network devices, and can be switches, routers, routing switches, gateways, IADs, and various MAN/WAN devices installed on the edge network.

When judging whether the data collected by the sensing terminal is abnormal, it may be judged by the sensing terminal or the first edge device, and the collected data may be compared with a reference threshold or a reference image feature, a reference sound wave feature, and the like. For example, when the collected data exceeds a threshold range, or when the collected data conforms to a specific image characteristic, or when the collected data conforms to a specific sound wave characteristic, it can be determined that the collected data is abnormal. And when the collected data is not abnormal, the data collection terminal can continue to collect data. In some embodiments, the sensing sensor of each terminal collects sensing data to obtain a communication trigger source, and after performing edge computing, communication transmission, and cloud-edge collaborative computing on multiple sensing data, it can not only make scheduling decisions for different terminals, but also determine communication requirements for each communication trigger source. Different communication requirements require different communication strategies. If high-quality communication is required, strategies such as split-multipath concurrency-aggregation (FIG. 19-1 shows the principle of data splitting and aggregation for multi-path transmission in a multi-mode heterogeneous network), communication dynamic adjustment, and base station priority allocation can be adopted; Another example is the communication requirements of the disconnected network and the network, and strategies such as network relay, self-organizing network, and end-to-end direct connection can be adopted. Different communication requirements require different communication strategies, which can be properly deployed in actual situations.

The gateway will be used as an example to illustrate the following. As shown in FIG. 1-1. IoT layer 1 terminal coverage domain: a single terminal has its own sensing and execution equipment, through configuration, it can obtain data from the sensor and upload it to the gateway. When the communication is abnormal, it can analyze the data by itself and generate a driving command to initiate execution actions; IoT layer 2 adjacent terminal coverage domain: means that adjacent terminals communicate with each other (not through edge devices) to share sensing data and convey execution commands, and one terminal is responsible for executing edge computing processes as a core terminal: IoT layer 3 edge devices coverage domain: Indicates the situation where there are gateways participating. The gateway is the main body of edge computing, sensing data and executing commands to cover the devices covered by the gateway, IoT layer 4 multi-gateway coverage domain: Indicates the situation of multiple gateways, one of which is the main gateway, and the slave. The gateway communicates with the main gateway to collect the data reported by the terminal, and the main gateway sends the terminal control command to the slave gateway, and the device data reported by the slave gateway comes from the device data covered by multiple networks; the IoT layer 5 single system coverage domain: represents the server Hierarchy, the server layer collects the terminal data reported by the gateway, and can generate terminal control commands and send them to the gateway; the multi-system coverage domain of the connection layer 6: represents the cross-project and cross-platform level; the IoT layer+M mobile terminal domain represents at the edge computing level of mobile ad hoc network devices, mobile devices may be connected to mobile gateways and fixed gateways, or to nearby terminals to obtain nearby sensing data. Of course, execution commands can also be directly issued to terminals.

In the edge computing method provided by this disclosure: the data from sensors and edge devices are not all stored in the cloud data center, but a layer of “fog” is added between the terminal device and the cloud data center, that is, the network edge layer, with which data, data processing, and applications are concentrated in the device gateway at the edge of the network, and the cloud server stores data synchronously, while relatively large data fog devices (gateways) can be processed locally, extract meaningful characteristics/incidents, and then synchronize to the cloud. This method can greatly reduce the computing and storage pressure on the cloud, with lower delay and higher transmission rate; communications between terminal devices and fog devices (gateways) can be transmitted by LoRa and other methods, which can greatly ensure smooth communication in various situations; Realize authentication between gateways, and carry out data communication and data exchange. Applications in special scenarios, such as in building fire protection applications, once a gateway receives the alarm information from the smoke sensor, it will send the alarm information to nearby gateways, and eventually the entire building gateway can receive the alarm information, and the entire building gateway send an alarm command to the smoke alarms connected to it, and finally the smoke alarms of the entire building will alarm at the same time, warning all the personnel in the entire building to evacuate quickly. Through the gateway communication technology, it is ensured that the fire alarm information is broadcast to the entire building in the first time, and the broadcast of the alarm information will not be affected in the case of abnormal communication between the gateway and the cloud. For example, a gateway can hold the secret key of other gateways, the connection between gateways connected through IP can use TLS, the subordinate gateway can use token authentication, the connection between gateways connected through IP can use TLS, use X.509 authentication. The connection between the gateways connected through IP can use the digest algorithm for authentication and two-way authentication; the terminal connected by LoRa uses a private protocol and DH key exchange Gateway and inter-gateway and cloud communication technology. Support intranet automatic networking, automatic scanning, automatic connection, the gateway supports LoRa, and the subordinate gateway can scan at the specified frequency point and automatically connect; support LoRaWAN standard protocol access and LoRa private protocol, support LoRa voice transmission, support channel scanning and Message monitoring: support X.509 authentication and authentication; key files can be prevented and monitored from being tampered with by controlling authority and verifying digital signatures, encrypted authentication technology between gateways; edge computing technology, data flow analysis, real-time processing of terminal data. The logarithm is collected, cleaned, processed, aggregated, data connected, anomaly detected, etc. Supports SQL-like syntax and basic semantic operations; rule engine technology, which can define trigger sources, execution conditions, and execution actions: function computing applications; cloud edge node control; message routing, dynamically planning the transmission path of messages through routing rules, and messages can be stored on the device, function computing, cloud platform number data flow analysis; emergency management of network outages, support for sending control commands to devices, alarm processing, configuration changes, etc.; all changes are automatically synchronized to the cloud after the network is restored; edge AI provides edge models Ability to fit and model acceleration. An embodiment of the present disclosure provides an application scenario of edge computing for smart fire protection. As shown in FIG. 1-2, the edge computing process of smart fire protection: [symbol] the smoke sensor detects smoke and/or temperature data: [symbol] the smoke sensor sends the smoke and/or temperature data to the nearest gateway, and after the gateway receives the smoke and/or temperature data, the smoke alarm information is generated through edge computing, [symbol] The gateway sends the smoke alarm information to other gateways, and finally all gateways will receive the smoke alarm information; [symbol] The gateway that receives the smoke alarm sends the smoke alarm information to the smoke alarm device connected to it, the smoke alarm sends out an audible and visual alarm; [symbol] the gateway that receives the smoke alarm sends smoke alarm information to the IoT cloud platform; [symbol] Firefighting commanders issue instructions to firefighting vehicles through the Internet of Things cloud platform and track the movement of firefighting vehicles; [symbol] Firefighting vehicles issue instructions to firefighters to obtain the spread of fire and adopt the most effective fire-extinguishing strategies. In the application of edge computing in smart fire fighting, when the smoke sensor detects smoke, it will immediately transmit the smoke alarm information to the nearest gateway that can communicate with it, and the gateway that receives the smoke alarm will immediately trigger the smoke alarm to send out the smoke alarm information. The sound and light alarm notifies the building personnel to evacuate, and through the edge computing capability, the gateway notifies each gateway of the smoke warning information, and each gateway triggers the sound and light alarm to notify the building personnel to evacuate. Notification of the smoke alarm can still be achieved when the communication between the building and the outside world is blocked. If the communication between the building and the outside world is smooth, the gateway will notify the IoT cloud platform of the smoke warning information, and notify the fire brigade to rush to the scene for rescue as soon as possible.

The smart fire edge computing application scenario diagram includes the following components: smoke sensor collects temperature and humidity information, and reports the information to the nearby IoT gateway; IoT gateway: receives temperature and humidity information collected by the smoke sensor, supports edge computing, generate alarm information, support sending audible and visual alarm information to the connected audible and visual alarm device, and support sending alarm information to nearby gateways, and can return the data collected by sensors and generated alarm information to the IoT cloud platform. Sound and light alarm: support receiving the sound and light alarm information issued by the IoT gateway, and issue an audible and visual alarm, IoT cloud platform: support receiving data and alarms reported by the IoT gateway, and can issue control to the IoT gateway Instructions; fire command vehicle: support issuing instructions and fire situation information to firefighters, and support the integration of fire fighting videos collected by firefighters; firefighters can collect on-site fire video and send it back to the fire command vehicle, and can receive the fire situation and instructions issued by the fire command vehicle. As shown in FIG. 1-2, the smart fire edge computing process includes, the smoke sensor detects the smoke data; the smoke sensor sends the smoke and/or temperature data to the nearest gateway, and the gateway generates the smoke and/or temperature data through edge computing after receiving the smoke and/or temperature data; the gateway sends smoke warning information to other gateways, and eventually all gateways will receive the smoke warning information; the gateway that receives the smoke warning sends a smoke warning signal to the smoke alarm device connected to it, and the smoke alarm device sends out an audible and visual alarm; After the gateway receiving the smoke alarm, the smoke alarm information is sent to the Internet of Things cloud platform; the fire commander issues instructions to the fire-fighting vehicles through the IoT cloud platform, and tracks the running track of the fire-fighting vehicles, and implement the most effective fire fighting strategy.

Through the edge computing method provided by the embodiments of the present disclosure, for the application scenario of smart fire edge computing, the data exchange mechanism based on gateway communication can respond to the fire situation in the smart fire field at the first time, and notify the personnel in the building as quickly as possible. The ability to respond to various situations at the fire scene has been improved. If the location of the gateway is just at the location of the fire, the mechanism of the gateway notifying other gateways of fire and smoke alarms can make the fire and smoke warnings still be transmitted to the sensor cloud when the gateway is burned down, effectively improving the system's disaster tolerance capability; in the case of network abnormalities, the system can still work and send a fire alarm to the people in the building, monitor the status of each executive device, and if there is an abnormality, it will actively issue a drive command.

The embodiment of the present disclosure provides a data flow of an edge computing gateway platform. As shown in FIG. 1-3, the data flow chart of the edge computing gateway platform includes the following components: passive reporting sensor device: supports device authentication with the edge computing gateway platform, after receiving the device reporting instruction from the edge computing platform, it will report data to the edge computing gateway platform; and can receive device control instructions and device configuration instructions issued by the edge computing gateway platform; actively report sensor devices: support device authentication with the edge computing gateway platform, and actively report data to the edge computing gateway platform; and can receive device control instructions and device configuration instructions issued by the edge computing gateway platform; other gateways: support gateway authentication with other edge computing gateway platforms, and receive gateway device control instructions sent by other edge computing gateway platforms, platform device control instructions, device configuration instructions, and gateway real-time alarms; inspection equipment: send device data query requests to the edge computing gateway platform, and receive device historical data issued by the edge computing gateway platform; edge computing gateway capable of sensor data interaction, control command interaction, configuration information interaction, and alarm data interaction between equipment, other gateways, inspection equipment, and the IoT cloud platform; gateway database: to store data information reported by devices, generated alarm information, instruction information issued by the cloud platform, and others gateway real-time alarm information generated by the edge computing gateway; IoT cloud platform: can receive data, instructions and alarms reported by the edge computing gateway platform, and can issue instructions, alarm rules and other information to the edge computing gateway platform.

The embodiment of the present disclosure provides an edge computing data flow. As shown in FIG. 1-4, the edge computing data flow chart includes the following components: passive reporting sensor device: supports device authentication with the authentication module, and will report data to device interaction module; can also receive device control instructions and device configuration instructions issued by the device interaction module; authentication: access authentication of sensor devices and gateway devices; actively report sensor devices: support device authentication with the authentication module authorization, actively report data to the device interaction module; and can receive device control instructions and device configuration instructions issued by the device interaction module; other gateways support gateway authentication with the authentication module, and receive gateway device control sent by the gateway interaction module Commands, platform device control commands, device configuration commands, and gateway real-time alarms; 5. Inspection equipment: send device data query requests to the gateway interaction module, and receive device historical data issued by the gateway interaction module, device interaction can interact with the sensor Interaction between devices and cloud platform for data interaction, control command interaction and configuration information interaction; gateway interaction: data interaction, control command interaction, configuration information interaction and alarm data interaction with other gateways and inspection devices, gateway database: storage device reporting Data information, generated alarm information, instruction information issued by the Internet of Things cloud platform, and gateway real-time alarm information generated by other edge computing gateways; real-time computing, rule engine: execute edge computing, and analyze the data reported by the device interaction module and gateway interaction module Real-time calculation, the rule engine triggers and generates alarm information according to the configured alarm rules, and sends device control instructions to the gateway interaction module or device interaction module: supports reporting data to the cloud platform interaction module; cloud platform interaction: can receive device interaction modules. The data, instructions and alarms reported by the gateway interaction module are sent back to the lot cloud platform, and device control instructions, alarm rules, and device configuration instructions are issued to the device interaction module and gateway interaction module; the IoT cloud platform receiving cloud platform. The data, instructions and alarms reported by the interaction module, and the alarm rules, calculation algorithms, equipment configuration instructions and equipment control instructions are issued to the cloud platform interaction module.

### T1-2-2—Wireless IoT Terminal Communication.

In traditional IoT application scenarios, there is a lack of direct interconnection methods between IoT terminals, which cannot realize the intercommunication of sensory data and the direct execution of control commands. For example, in some IoT application scenarios, sensing devices and execution devices are used to jointly generate and execute decisions, and are deployed in a short distance in space, but the data interaction between the two still needs to be transmitted through the gateway/base station to the server. This will easily lead to low communication rate and long response time, which will eventually lead to decision-making lag and high communication cost. For example, when the sensing terminal is connected to the server through the gateway, the server can generate an execution command through the decision-making system according to the sensing data sent by the sensing terminal, and then send the command to the execution terminal through the gateway, so that the execution terminal can perform corresponding actions. In order to reduce the response time and the amount of data transmission, edge computing can be deployed at the gateway and the sensing terminal, that is, the gateway or the sensing terminal can perform calculations based on the sensing data and generate corresponding execution commands. However, there may still be two problems in this way: 1 If the gateway fails or a terminal fails to connect to the network, and the sensing data cannot be sent to the gateway, the edge computing running on the gateway cannot perform edge computing due to lack of sensing data, and the execution terminal will also fail to perform edge computing. As a result, it may lose its ability: 2. The edge computing running on the terminal can only obtain its own data, and sometimes it cannot fully meet the decision-making requirements.

In order to solve at least one of the above technical problems, for example, to increase the communication rate between a sensing device and an executing device, the present disclosure provides a communication method between terminals of the wireless Internet of Things. The communication method includes: establishing communication connections between all base-level terminals in the same Internet of Things. The base-level terminals include sensing terminals, execution terminals and/or compound terminals; The communication methods are different. The communication method between terminals of the wireless Internet of Things provided by the embodiments of the present disclosure can be applied to the architecture shown in FIG. 1. Communication methods between gateways/base stations and gateways/base stations, and/or between gateways/base stations and servers. In addition, the wireless IoT terminal communication method of the IoT sensor device provided by the embodiment of the present disclosure can also be applied to the architecture/flow shown in FIG. 1A, FIG. 1B, FIG. 1C and FIG. 1D (ie, FIG. 1A-1D). In FIG. 1A-ID, for example, it can be used as between terminals and terminals, between terminals and gateways/base stations, between terminals and servers, between gateways/base stations and gateways/base stations, and/or between gateways/base stations and servers. The communication method among them to support the operation of the multi-mode heterogeneous Internet of Things in FIG. 1A-1D.

FIG. 2-1 shows an application scenario diagram of the communication method between wireless Internet of Things terminals. In FIG. 2-1, the sensing terminal 1 has the sensing function and can be used to collect data, the execution terminal 1 has the execution function and can be used to perform corresponding actions according to the execution command or sensing data sent by the sensing terminal 1; the composite terminal 1 has the function of sensing and execution at the same time, which can not only detect status but also perform corresponding actions. The sensing terminal 1, the execution terminal 1 and the composite terminal 1 can establish communication connections with each other, and the three can establish communication connections with the gateway/base station at the same time, and the gateway/base station can establish communication connections with the server. As shown in FIG. 2-1, by establishing direct communication between terminals, any terminal or gateway can obtain the sensor data of other multiple terminals, and can make decisions and generate execution commands based on the sensor data of multiple terminals, that is, it is possible to generate decision-making results based on comprehensive sensor data, making the decision-making results more reliable, and even in the case of a gateway network failure, the sensing terminal can still obtain data from other terminals based on direct communication between terminals and generate execution commands, that is, the network Faults do not affect the generation of decision results.

In an embodiment of the present disclosure, in order to avoid the communication between the terminal and the communication between the terminal and the gateway/base station conflicting, the communication between the terminal and the terminal may adopt one or more of the following methods: Different communication channels, radio frequency modulation methods, synchronization bytes, etc. are used between the terminal and the terminal and between the terminal and the gateway; and/or, the payload content transmitted between the terminal and the terminal can use a different protocol, after the data is received by the host Just discard. As shown in FIG. 2-2, communication between terminals can use different frequency channels (also including different modulation methods, data rates, coding methods, etc.) to reduce conflicts with communication between terminals and gateways.

In one embodiment of the present disclosure, in order to maintain timing and synchronous communication of devices, devices with unlimited power supply can always turn on receiving, and can receive data from other nearby terminals at any time, but devices with limited power supply cannot always turn on receiving. After the time can be synchronized between the two devices, send and receive exchange data on a regular basis. When multiple devices need to exchange data, time slots can be specified, and each device uses a different time slot.

In an embodiment of the present disclosure, as shown in FIGS. 2-3, a low power consumption wake-up mechanism may be used for a device with limited power supply. For example, the receiving device can start receiving periodically to detect whether there is a wireless signal, and if there is no wireless signal, it will immediately stop receiving and go to sleep. When the transmitting end transmits data, a long preamble data is added, and the sending time of the preamble data should be longer than the opening interval of the receiving device, so as to ensure that the receiving device can receive the preamble signal in two adjacent short receiving windows. In addition, in order to maintain the low power consumption characteristics of the terminals when sending and receiving data, the terminals can interact with each other at the agreed time and channel timing, and the terminals can determine which end to transmit and which end to receive according to actual needs, and if there is no data to be transmitted. It is allowed to not send data for several consecutive time periods.

As shown in FIG. 2-4, in order to further reduce the impact of communication between terminals on other terminals and gateways, one or more of the following methods can be used, transmit power control mechanism, reduce transmit power so that the signal only covers a certain Range, as long as it can cover the desired terminal (target terminal). For example, in FIG. 2-4, terminal 1 can cover terminal 2 and terminal 4, and terminal 3 can cover terminal 4; the receiving sensitivity control mechanism, in order to further reduce other Unnecessary wake-up caused by the device transmitting signals, during the period of receiving signals from adjacent devices, the interference of other devices can be reduced by turning on the attenuation of the receiving circuit, and the attenuation can be removed when the host signal needs to be received. As shown in FIG. 2-4, if terminal 1 and terminal 4 do not need to communicate, but terminal 3 and terminal 4 need to communicate, you can set terminal 4 to reduce the receiving sensitivity and only receive the signal from terminal 3 (because terminal 4 is closer to terminal 3).

Through the communication method between terminals of the wireless Internet of Things provided by the embodiments of the present disclosure, since terminal devices can communicate directly, the coverage area of edge computing can be increased, the sinking of edge computing can be made more thorough, and the dependence of terminal decision-making on the transmission network can be reduced; and, which can reduce the delay of data sharing between terminals and reduce power consumption. Further, as shown in FIG. 2-1, all terminals in the terminal layer (including terminals for sensing, linkage, multi-mode heterogeneous communication, mobile and/or video, etc.) establish communication connections between each other. In the way of establishing direct communication between terminals, any terminal can obtain the sensing data of other multiple terminals, and can make decisions and generate execution commands based on the sensing data of multiple terminals, that is, it can comprehensively sense the data to generate decision results, so that. The decision result is more reliable, and even in the case of a gateway network failure, the sensing terminal can still obtain the data of other terminals based on the direct communication between the terminals for edge computing and then generate execution commands under specified conditions, that is, the network failure will not affect Generation of decision results. Further, the communication mode between terminals is different from the communication mode between the terminal and the gateway. For example: different communication channels, modulation methods, synchronization bytes, etc. are used between the terminal and the terminal and between the terminal and the gateway; the load content transmitted between the terminal and the terminal can use different protocols; the communication between the terminals can use different channels (It may also include different modulation methods, data rates, coding methods, etc.), as shown in FIG. 2-2, so as to reduce the conflict with the communication between the terminal and the gateway.

T1-3-3—IoT terminal power consumption control.

When the terminal in the Internet of Things is installed in an environment without grid and electricity (such as forests, uninhabited areas, etc), it needs to use a small-capacity battery to work for at least one year, and sometimes it may need to work for more than three years in order to reduce maintenance costs. However, there is currently no effective power consumption control method that can enable IoT terminals to work for a long time under the condition of battery power. Moreover, the existing power consumption control method has slow data response and consumes a lot of power, and it is necessary to wait for the sensor to stabilize before powering on to sample data.

In order to solve at least one of the above problems, such as prolonging the working hours of IoT terminals, the present disclosure provides a method for controlling power consumption of IoT terminals, which can be applied to IoT terminals, such as sensing terminals, execution terminals, composite terminal and/or edge devices, etc. The method includes: setting a sampling time for the sensing terminal, and sampling when the sensing terminal reaches the sampling time, comparing the data obtained by two adjacent samplings, and when the difference between the two sampling data is greater than or equal to a reference threshold, the latter sampling. The obtained data is sent. The IoT terminal power consumption control method provided by the embodiments of the present disclosure can be applied to the architecture shown in FIG. 1, for example, it can be used as various terminals in FIG. Heterogeneous MESH terminals, satellite terminals, camera terminals, soil monitoring terminals, water conservancy and gas monitoring terminals, etc.), various gateways (such as security gateways, video gateways, positioning gateways, technical investigation gateways, etc.), various base stations (mobile stations. A power consumption control method for private network base stations, WLAN base stations, network bridges, etc). In addition, the IoT terminal power consumption control method provided by the embodiments of the present disclosure can also be applied to the architecture/flow shown in FIG. 1A, FIG. 1B, FIG. 1C and FIG. 1D (ie, FIG. The power consumption control methods of various terminals, various gateways, and various base stations in 1A-ID, so as to support the operation of the multi-mode heterogeneous Internet of Things in FIG. 1A-1D.

Exemplary: The sensor samples regularly, and after the sampling is completed, the sensor power is turned off by hardware. In order to avoid the jitter of the collected data just after power-on, turn on the power before each sampling, and start sampling after a certain period of time. Communication interface circuits such as RS485, RS232, etc. still consume power during sleep, the hardware circuit can control the power supply of the switch interface circuit, and the main control is controlled through the IO port. The peripheral IO port connected to the communication interface is switched to the normal mode before the power of the interface circuit is turned off to avoid the input of wrong signals. Record a certain amount of historical sampling data and set a threshold value. If the change value of the new sampling data is less than the set threshold value compared with the previous data, define such data as inactive data. Send it to the gateway and/or server, or reduce the sending frequency, such as sending once every 5 samples. If the data obtained from the sensor for a long time is inactive data, increase the sampling interval of the sensor Once active data appears, immediately restore the original sampling interval or reduce the sampling interval. The device has its own edge computing function. After each piece of data is sampled, one or more calculations and parameters can be configured. The intermediate results of the calculation can be used as the input of other calculations. Multiple calculation results can be configured to generate new calculation results. The edge computing results are used to generate local execution commands, which can be used to drive local output devices; the calculation results can also be used to generate complex data active judgment processes, such as detecting temperature changes only when the output control fan is turned on.

In an embodiment of the present disclosure, an intermittent sampling strategy may also be used. For example, the sampling interval may be set for the sensing terminal, or a specific sampling time may be directly set for the sensing terminal. During the non-sampling time, the sensing terminal can be in the power-off or dormant state, and when the sampling time interval is met, or when the specific sampling time is reached, the sensing terminal can quickly turn on and sample data, and enter the power-off or dormant state after the sampling is completed. Thereby saving power consumption. The value of the sampling interval or specific sampling time can be adjusted by the server or by the staff according to the demand, and can also be adjusted according to the specified policy according to the change of the on-site environment. For example, if the temperature is below minus ten degrees, the soil sensor sampling interval is extended from 30 minutes to 2 hours.

In an embodiment of the present disclosure, a radio transmission power consumption optimization strategy may also be adopted. For example, according to the connection between the terminal and the gateway, the transmission rate and transmission power can be adjusted in real time to achieve the minimum transmission power consumption. Among them, the transmission rate determines the time when the transmission circuit is turned on, and the transmission power determines the current during transmission Therefore, by controlling the transmission circuit to open Time and emission current can be optimized for power consumption.

In an embodiment of the present disclosure, a data sending policy may also be adopted. For example, when there is no change, small change value, or small change magnitude in the data obtained by the sensing terminal for two adjacent samples, compare the data changes between the two samples and/or between the last transmitted value and the current sample to adjust the data Sending strategy, such as extending the time or sending immediately.

In an embodiment of the present disclosure, a quick alarm strategy may also be adopted. For example, in order to ensure a faster response time, multiple sampling and one feedback strategy can be set, and the rate of change and threshold value can be set as the alarm threshold. When the set rate of change and/or threshold is reached, it can be determined that the alarm condition is met, and data transmission can be started immediately. When the alarm condition is reached multiple times in a row, if the alarm data has been sent, the data will not be sent repeatedly, which can avoid occupying too many communication resources, and can also reduce power consumption.

In an embodiment of the present disclosure, a data calculation strategy for a sensor stabilization time period may also be used. For example, after a sensor or sensing terminal is powered off or sleeps, it takes a stable time to obtain stable data after it is turned on again, and the sensor consumes power during this period. Although the sampled data before the stabilization time is different from the stable data, it has a certain correlation with the stable data. The stable value is calculated by the curve trend of the data collected by the sensor or the sensing terminal, so that there is no need to turn on the sensor or the sensing terminal until the stabilization time Approximate data can be obtained, thereby reducing power consumption. For example, after a sensor is powered off or dormant, it can calculate the stable data of the sensor based on the data collected within a period of time after the sensor is turned on again, instead of waiting for the sensor to stabilize before taking the data collected by the sensor as stable data, so that Reduce sensor power consumption. In an embodiment of the present disclosure, a sensor change rate identification method may also be used. For example, the identification of the rate of change can be realized by identifying the first derivative of the sensor value through analog circuits and/or software. When using an analog circuit to identify the rate of change, a differentiator circuit can be used to trigger an interrupt when the specified slope is reached, so that the master can start the sampling and processing process. The differential parameters can be controlled by controlling the RC elements through IO or more precisely through the DAC (digital-to-analog conversion) circuit, so as to realize how much slope can be controlled to generate an interrupt, for example, the interrupt can be controlled according to the set slope. When using the software to identify the change rate, basically use the numerical difference between two or a period of time that can be sampled multiple times, and can calculate multiple analysis results such as the numerical change value, change percentage, slope, etc. within the sampling period, and analyze the results Additional strategies can trigger actions such as data sending and local output.

FIG. 3-1 shows a schematic diagram of transmission interval and data change rate, and FIG. 3-2 shows a schematic diagram of calculating stable data of a sensor.

Combined with FIG. 3-1, the sensor intermittent sampling steps can include: if the value is an analog quantity, the magnitude of the value change is determined by the value of its first derivative, and the data change rate can be obtained through a differential circuit; if the value is a digital signal, it can directly use the change difference to get the data change rate; change with time, when the sensor data change rate is 0 or very small, the transmission interval is large or the sampling interval is large; when the sensor data change rate is large, the transmission interval is small or the sampling interval Small. In each sampling, the quantity of each sampling may be the same or different, for example, the same quantity of data may be collected each time, or the quantity of data collected each time may also be different.

As shown in FIG. 3-2, the data calculation steps of the sensor stabilization period may include: collecting and recording the data curves of the sensor from power-on to the availability of stable data in different situations; calculating the stable value through the curve change trend, for example. The stable value can be calculated from the data of the non-stable section according to the trend of the curve.

Exemplarily, as shown in FIG. 3-2, curves V1, V2, and V3 in the figure represent transition curves from when the sensor is powered on to being stable when the same sensor detects different sensed objects. When the power is first applied, the sensor is still unstable, and the output value gradually approaches the real detection value from 0 over time. The actual detection value is different, and the curve is also different. Collect and record the data curve of the sensor from power-on to stable data under different conditions, and extract the relationship between the value obtained by sampling in advance and the value obtained after stabilization, through which the relationship can be inferred by sampling in advance. To stabilize the value, the sensor can be turned off after sampling in advance to reduce the sensor turn-on time and reduce power consumption. The figure on the left shows that it takes a certain period of time for the sensor to stabilize after it is turned on, and the value after the sensor stabilizes can be calculated at the time point of “sampling”. Taking the V1 curve as an example, the value of V1 is higher than that of V2 and V3 after stabilization, and the value obtained at the “sampling” time point is also proportionally higher than that of V2 and V3. The picture in the middle shows the situation that the sensor has an overshoot during the stabilization process (the value rises and then falls during the stabilization process) By selecting an appropriate “sampling” time point, the relationship between the stable value and the pre-sampled value can still be found, thereby avoiding the overshoot. Overshoot or reduce the error caused by overshoot. The values at the early sampling time in the figure are almost consistent with the stabilized V1, V2 and V3. The figure on the right shows the rising curve of the same sensor at different temperatures, where temperature 1 is greater than temperature 2, and temperature 2 is greater than temperature 3. After stabilization, the value is slightly higher when the temperature is high, and the temperature at the sampling point is high. In some cases, the value is relatively high, so the temperature needs to be used as a parameter to obtain an accurate relationship between the stable value and the pre-sampled value.

In another new embodiment, in the fields of fire warning and flame detection in the forest fire prevention industry, soil sensors, temperature sensors, wind direction sensors and flame detection terminals are sampled at a regular speed during daily sampling, and the flame detection terminal executes the algorithm locally Identify whether there is a flame, soil sensor, temperature sensor and wind direction sensor intermittently detect the surrounding environment, send status information for a certain period of time (such as 2 hours), including battery power, ambient temperature and humidity, flame background noise level, etc. and send some sensor data periodically as needed. The original data will be transmitted to the data intelligent fusion platform through the multi-mode heterogeneous network for calculation, and the flame detection parameters under the current background noise level will be obtained, and these flame detection parameters will be sent to the corresponding flame detection terminal. As an example, the above information is transmitted through matching communications and networks (dynamically allocated by multi-mode heterogeneous networks). For example, because the above-mentioned information is short in length and sent infrequently, uncompressed or lossless compressed source coding can be used. Considering the energy consumption of the detection terminal, channel coding with higher energy efficiency (such as LDPC) and low code rate modulation can be used, the transmit power of the PA is reduced as much as possible to save power consumption, and the fn frequency point is randomly selected among multiple idle frequency points.

The power consumption control method of the Internet of Things terminal provided by the embodiment of the present disclosure: low cost, the main power consumption management of this method is realized by software algorithm, without additional hardware cost; low power consumption, and adopts multiple power consumption control strategies at the same time. It can achieve extremely low power consumption; the data response is fast, the data is sampled multiple times and the sending strategy is sent immediately when the alarm condition is met; there is also a strategy of small sending intervals based on large data changes. The IoT terminal power consumption control method provided by the embodiments of the present disclosure can be applied to data terminals powered by batteries or low-power solar energy, and has the advantages of low power consumption and fast data response, and this method can be implemented on the terminal side based on edge computing. Without the participation of the cloud server.

T1-4-4-A terminal edge computing and multi-domain coverage computing method Existing edge computing frameworks have diverse and complex functions, but have high requirements on resources, especially processing performance, memory, and power consumption, and are not suitable for running on small single-chip computers. Moreover, the existing edge computing framework has poor data analysis capabilities and can only analyze the data simply; In order to solve at least one of the above technical problems, such as improving the data analysis capability of the edge computing framework, an embodiment of the present disclosure provides an edge computing framework, which can be used for a general RTU (Remote Terminal Unit, RTU, remote terminal unit) For example, it can be applied to sensing terminals, which can quickly realize data collection and output execution projects, such as air station methane detection terminals, forest fire factor smart manhole covers, hydrological monitoring fire hydrant monitoring terminals, etc. The present disclosure is described in conjunction with FIG. 4-1 and FIG. 4-2, including the following steps or components: the edge computing function of the terminal is composed of three major modules, a data acquisition module, a data analysis module and an execution module. The data acquisition module can regularly read sensor data according to the configuration, and supports reading actions with different interfaces, communication rates, protocols, and data formats. For example, the data acquisition module can support a variety of interfaces, including RS485, SDI-12, UART, 12C, SPI, GPIO, ADC, pulse input, frequency input, etc. and can also easily expand other interfaces. The data read by the data acquisition module is delivered to the data analysis module. The data analysis module first preprocesses the data, and then performs comparison and logical judgment. The results can be used to start execution actions, control data transmission, and change other configuration behaviors (such as startup, stop), etc. The execution action module accepts the instruction of data analysis to execute the corresponding action, and the status and result of the execution action will be synchronized to the server. Gateways and servers can dynamically change all configurations, including software configuration, hardware configuration, communication resource configuration, etc. The gateway device has similar modules and can achieve similar functions or functions, except that the data acquisition module on the gateway side comes from the terminal covered by the gateway, and the execution module is handed over to the terminal for execution by sending instructions. Terminals, gateways, and servers can all be computing executors, and can be divided into different layers of edge computing according to different sensing and execution coverage circles. Both the server and the gateway can send down commands to modify configuration and execute commands; the execution status and results can be synchronized to the outer gateway and server. IoT layer 1 is a single terminal, which has its own sensing and execution equipment. Through configuration, it can acquire data from sensors, analyze data, and then generate driving commands to start execution actions. This process can be executed by itself when communication is abnormal. IoT layer 2 means that adjacent terminals communicate with each other (not through a gateway) to share sensor data and convey execution commands, and one of the terminals can be used as the core terminal to be responsible for executing the edge computing process. IoT layer 3 represents the situation where gateways are involved. The gateway is the main body of fog computing, sensor data and executing commands to cover the devices covered by the gateway; IoT layer 4 represents the situation of multiple gateways, one of which is the main gateway, and the devices come from multiple equipment covered by the network. The IoT layer 5 represents the server level, which is aimed at a project or a subsystem of a project; while the lot layer 6 represents the cross-project and cross-platform level IoT layer+M represents the edge computing level of mobile ad hoc network devices Mobile devices may be connected to mobile gateways and fixed gateways, or to nearby terminals to obtain nearby sensor data. Of course, execution commands can also be directly downloaded sent to the terminal.

The edge computing framework provided by the embodiments of the present disclosure can be applied to the architecture shown in FIG. 1, for example, it can be applied to various terminals with edge computing capabilities in FIG, multi-mode heterogeneous MESH terminals, satellite terminals, cameras, water conservancy terminals, etc), gateways (such as security gateways, video gateways, positioning gateways, technical detection gateways, etc.), base stations (mobile stations, private network base stations, WLAN base stations, network Bridge, etc.) to assist/enable these terminals to complete edge computing. In addition, the edge computing framework provided by the embodiments of the present disclosure can also be applied to the architecture/flow shown in FIG. 1A, FIG. 1B, FIG. 1C and FIG. 1D (ie, FIG. Various terminals, gateways, and base stations with edge computing capabilities in ID assist/realize these terminals to complete edge computing to support the operation of the multi-mode heterogeneous Internet of Things in FIGS. 1A-1D.

The edge computing framework provided by the embodiments of the present disclosure has rich functions of the execution module, supports execution devices such as driving switches, motors, serial ports, and PWMs, and supports power-down state storage and cloud synchronization; the data analysis module has complex data analysis functions, common analysis includes threshold, change value, change rate, bit state, etc. and can also realize complex executable code RAM dynamic loading, function call, etc.; the execution action module can also accept direct instructions issued by the upper layer (such as gateway, server) and perform corresponding actions. And it has the following advantages: low cost, the framework requires less memory and performance, and can run on a small single-chip computer: supports a variety of input and output interfaces, and can cope with various application scenarios; high stability, data acquisition, data analysis. The output execution is all realized through configuration, and only one set of code needs to be maintained to realize multiple functions.

### T1-5-5—Sensor Calibration.

The prior art sensor implementation methods based on the Internet of Things have problems such as single function, inability to learn from big data, inability to make decisions and rapid responses, and inability to perform concurrent processing of large amounts of data. In order to solve the above-mentioned problems existing in the implementation method of the sensor based on the Internet of Things, the present disclosure provides a sensor implementation method and device based on the Internet of Things.

With the wide application of sensor technology, the sensor maintenance problem caused by the sensor drift phenomenon during its use also needs to be solved urgently. At present, there are four main maintenance schemes for sensors: one is to carry out aging experiments before leaving the factory to simulate the exposure process of gas sensors in the atmosphere, and then generate compensation algorithms to correct the sensor response in advance to achieve a certain degree of anti-aging and anti-aging after installation. Self-calibration; the second is to regularly maintain the micro-air station, replace the new sensor, return the original gas sensor to the factory, and perform a secondary calibration in the laboratory; the third is the traditional on-site manual calibration method, that is, technicians come to the site Use tools to calibrate; the fourth is to use the deep learning model to calibrate the sensor. In the related art, the deep learning model is a residual neural network based on self-attention. This method uses the data augmentation method to expand the data samples. The proposed sensor drift calibration method includes two parts drift feature extraction and drift calibration, which correspond to drift Feature extraction module and calibration module. The drift feature extraction module extracts key features of time and frequency drift hidden in different scales in the data through multi-scale convolutional layers, laying the foundation for the calibration module; the calibration module uses a one-dimensional residual convolutional neural network based on self-attention to effectively utilize Data correlation between adjacent sensors performs drift compensation on drift data, which can simultaneously calibrate the drift of multiple sensors in a sensor group. Related technologies only support the deployment of calibration models on cloud servers. The system includes at least: an acquisition module, a standard sensor, and a cloud server. An electrical parameter acquisition module of parameters, the cloud server at least includes a modeling module and a calibration module, and the modeling module is based on the original concentration parameters, humidity parameters, temperature parameters, electrical parameters and standard sensors sent by the acquisition module. The data is used to establish a calibration model according to a deep learning algorithm. Exemplarily, a high-dimensional nonlinear model based on a least squares method fitting algorithm, or a BP neural network algorithm is used for deep learning to obtain a calibration model. The calibration module calibrates the original concentration parameters sent by the collection module based on the calibration model. By incorporating the electrical data collected by the gas sensor into the calibration model as a calibration influencing factor, the calibration rate of the calibration model is improved and more accurate gas concentration parameters are obtained.

In Option 1, the compensation algorithm produced by aging simulation before leaving the factory can prolong the service life of the sensor to a certain extent, but due to the unpredictability of changes in ambient temperature, humidity, and gas concentration, the compensation algorithm is difficult to use for a long time on the sensor After that, accurate compensation is still maintained. In the second option, the method of returning to the factory for recalibration or directly replacing it with a new sensor is costly, inefficient, and very time-consuming. Option 3 The on-site manual calibration method is time-consuming and laborious, and due to the existence of measurement methods, personnel operations and other factors, manual sensor calibration will introduce various errors. The residual neural network of the self-attention mechanism, the high-dimensional nonlinear model of the least squares fitting algorithm or the BP neural network algorithm in the fourth scheme need to be improved for the prediction effect of the time series; and because of the computational complexity or parameter redundancy of deep learning. Corresponding model deployment is limited on sensor terminal equipment and base stations. Solution 4 cannot match the calibration position for the calibration model according to the amount of calculation There is no hierarchical deployment capability, and only supports the deployment of the calibration model on the cloud server; and it cannot calibrate different types of sensors, and outlier checking are only valid for a single sensor of the same type.

In view of the problems existing in the above sensors, the present disclosure provides a method and system for calibrating sensors based on deep learning.

In this disclosure, the Transformer model based on the multi-head attention mechanism can not only consider time series factors, but also capture richer sensor features and information, learn the data features of the same type of sensors, and obtain the relationship among different types of sensors through learning. The data correlation and strong filtering ability realize the application in various types of sensor equipment. Hierarchical calibration realizes the intelligent matching of the calibration model to the calibration position, achieves the balance of the ratio of accuracy and response speed, and realizes the application in multiple scenarios. Multi-level collaborative calibration uses multi-level calibration models of different precision to calibrate part of the original data, and spot checks whether the calibration results reported by the low-level calibration models are qualified, and realizes the simple and efficient inspection of the received calibration results. FIG. 5-1 is a flow chart of an embodiment of a method for calibrating a sensor based on deep learning according to the present disclosure, including the following steps: S101: the sensor collects historical data in chronological order; S102, collects at least part of the corresponding data through the standard sensor value of the historical data; S103: provide the historical data and the value to the Transformer model; S104: the Transformer model trains the historical data and the value to obtain the original model; S105, pruning through deep learning Or knowledge distillation performs multi-stage compression optimization on the original model to obtain a multi-stage compression optimized model; S106. Calibrate the raw data collected by the sensor according to the original model or the multi-stage compression optimized model.

Among them, the sensor is included in the sensor terminal device, and the types of sensors may include but not limited to temperature sensors, humidity sensors, gas sensors, pressure sensors, vibration sensors, distance sensors, infrared sensors, optical sensors and displacement sensors, which are not limited here. As long as the measured information can be felt, and the sensed information can be transformed into electrical signals or other required forms of information output according to certain rules, so as to meet the transmission, processing, storage, display, and recording of information by sensor terminal equipment and control requirements.

The sensors may include a combination of the following different sensors at least one target sensor; at least one target sensor in the same environment, and at least one sensor of the same type but with different accuracy or different used time; at least one target sensor in the same environment. And at least one sensor of different types; or at least one target sensor in the same environment, at least one sensor of the same type but with different accuracy or different used time, and at least one sensor of different types.

The target sensor refers to a sensor that currently needs to perform deep learning and establish a calibration model for subsequent calibration. In the process of deep learning, the value of the historical data corresponding to the target sensor is collected through the standard sensor. The same environment refers to two or more points where the distance does not exceed the distance threshold or the difference of environmental attribute values such as temperature and humidity does not exceed the corresponding environmental difference threshold. For example, multiple sensors included in one detection box can be considered as in the same environment.

Sensors of the same type but with different accuracy or different elapsed time in the same environment, for example, the target sensor is a temperature sensor with C-level accuracy, then the system can be trained and calibrated on the measured value of the C-level temperature sensor In, add the data of the B-level temperature sensor and the A-level temperature sensor in the same environment. The accuracy of the temperature sensor is grade A higher than grade B, grade B higher than grade C.

The historical data refers to time series data composed of sensor data collected and recorded at regular intervals within a certain period of time. The temperature data of the room is measured and recorded once every 10 minutes, and these temperature data are composed of time series data according to the time sequence of the collected records, which is the historical data of this temperature sensor.

The sensor data includes, but is not limited to: the measured value of the sensor, the device ID of the sensor, the collection time of the measured value of the sensor, the geographic location information of the sensor, the current weather information of the sensor at the collection time point, and other environmental information of the sensor at the collection time point.

The standard sensor is a high-precision sensor in the same environment corresponding to the sensor, which is responsible for providing the value of the sensor during the deep learning process, and the value is sensor data whose accuracy is not lower than the standard threshold.

The Transformer model is a Transformer model based on a multi-head attention mechanism, which can be used for machine translation. Based on the overall architecture of the Transformer model, which includes an encoder Encoder and a decoder Decoder, the Transformer model is an Encoder-Decoder structure formed by stacking several encoders and decoders. The encoder, consisting of multi-head attention and a feed-forward neural network, is used to convert input data into feature vectors. The decoder, whose input is the output of the encoder and the predicted result, consists of masked multi-head attention, multi-head attention and a feed-forward neural network to output the conditional probability of the final result. Since there is no recursion and no convolution in the Transformer model, the information of the absolute (or relative) position of each marker in the sequence is represented by a positional code. The linear layer in the Transformer model is a simple fully connected neural network. The vector generated by the Decoder is projected into a larger vector and becomes a logarithmic vector. After the linear layer is a Softmax layer. The Softmax layer can convert the scores into probabilities through conversion, select the one with the highest probability as the index, and then find the data through the index as the output.

In the existing Encoder-Decoder framework, they are all implemented based on CNN or RNN. The Transformer model abandoned CNN and RNN, and only used attention to achieve it. It can be compared to the role of using multiple filters in CNN at the same time, so Transformer is an Encoder-Decoder model based entirely on the attention mechanism.

The multi-heads are multiple inputs, and the multiple inputs include the input of the target sensor in the same environment, the value of the target sensor, and the input of other sensors of the same or different types in the same environment. The input of the target sensor in the same environment is the historical data of the target sensor in the same environment. The input of other sensors of the same or different types in the same environment is the historical data of other sensors of the same or different types in the same environment Among them, the same type of sensors are sensors with different accuracy or different used time. For example, the target sensor is a temperature sensor with a B-level accuracy, and the same type of sensors in the same environment are two A-level and AA-level temperature sensors sensor. Intuitively, multi-bead attention helps the network capture richer features and information. The so-called multi-head attention mechanism is to send the input obtained by each head to the attention mechanism, and comprehensively utilize various characteristics and information. The multi-head attention mechanism can extract the internal relationship between the learned data. When there is sufficient data support, the Transformer model can not only learn the data characteristics of the same type of sensor, but also realize the calibration model of the same type of sensor. The establishment of the data correlation between different types of sensors can also be achieved through learning, and the establishment of calibration models for different types of sensors can be realized, that is, the original model can be obtained, and abnormal values can be alarmed.

The whole training process is carried out in the cloud server. The original model is a model obtained through training that meets accuracy requirements Therefore, the Transformer model can not only effectively learn and imitate the characteristics of time series data, but also use the multi-head attention mechanism to help the Transformer model capture more abundant sensor features and information, and further comprehensively process the captured sensor features and information. Not only can the data characteristics of the same type of sensors be learned, but also the data correlation between different types of sensors can be obtained through learning, and it has a strong filtering ability. The Transformer model realizes the application in many types of sensor devices. The Transformer model supports the establishment of various types of calibration models, including but not limited to: the establishment of a calibration model for a single sensor; the establishment of a calibration model for the same type of sensor; the establishment of a calibration model for different types of sensors.

Furthermore, due to its high computational complexity, the original model after deep learning has high requirements for hardware storage space and computing power. It can only be deployed on cloud servers with high computing power. In some scenarios and The corresponding model deployment is limited on the device, such as base stations and sensor terminal devices, which have relatively low computing power compared to cloud servers, and the original model cannot be deployed on devices. In order to achieve hierarchical calibration and enable the model after deep learning to have the ability to be deployed separately on sensor terminal equipment, base stations, and cloud servers, it is necessary to use compression optimization, that is, model compression, optimization acceleration, and other methods to break through the bottleneck. Compression optimization can effectively reduce the redundancy of model parameters, thereby reducing storage usage, communication bandwidth and computational complexity, which is conducive to the application deployment of deep learning.

The sensor terminal device refers to a device that collects data and sends data to the network layer. The base station is an information bridge between the sensor terminal and the cloud server, and is a multi-channel transceiver.

The multi-stage compression optimization method provided by the present disclosure includes but not limited to: knowledge distillation and deep learning pruning. Among them, knowledge distillation refers to the method of using the knowledge learned by the complex model to guide the training of the small model, so that the small model has the same performance as the complex model, but the number of parameters is greatly reduced, thereby achieving model compression and acceleration. A complex model is a single complex network or a collection of several networks with good performance and generalization ability. The core idea of knowledge distillation is to train a complex network model first, and then use the output of this complex network and the real label of the data to train a smaller network Therefore, the knowledge distillation framework usually includes a complex model (Teacher model) and a small model (Student model). The one-stage compressed optimized model obtained through knowledge distillation in the present disclosure is deployed on the sensor terminal device.

Among them, deep learning pruning means that due to the sparsity or overfitting tendency of the deep learning model, by changing the dense connection in the large network into a sparse connection, during the training process, gradually set the parameters with smaller weights to 0, and then remove those with a weight value of 0, that is, delete some computational costs that are too low in income, and cut the deep learning model into a network model with a simplified structure. In this disclosure, the two-level compressed optimized model obtained by deep learning pruning is deployed in the base station. The computing power of the base station is higher than that of the sensor terminal equipment and lower than that of the cloud server.

Through the deep learning pruning and knowledge distillation of the original model, it can achieve multi-level compression and optimization of the model on the basis of no obvious decrease in accuracy, so that it has the ability to be deployed separately on sensor terminal equipment, base stations and cloud servers, combined with sensors Based on the computing power characteristics of terminal equipment, base stations, and cloud servers, the disclosure can intelligently match the calibration position, achieve a balance between the ratio of accuracy and response speed, and realize the application in multiple scenarios. As shown in FIG. 5-2, the original model that has undergone knowledge distillation, the lightweight model, that is, the model after one-level compression optimization is deployed on the sensor terminal device with weak computing power, the original model that has not been compressed and optimized, the large model, deployed on a cloud server with strong computing power; the original model pruned by deep learning, the medium model, that is, the model after two-level compression optimization, is deployed on a base station with medium computing power.

Data calculation amount: the original model is greater than the model after the two-level compression optimization is greater than the model after the first-level compression optimization; calibration accuracy: the original model is greater than the model after the second-level compression optimization is greater than the model after the first-level compression optimization; response speed: level one Compression-optimized model is larger than two-stage compression-optimized model is larger than original model.

Further according to the calibration accuracy requirements, response speed and/or data calculation amount, it is determined to use the deployed model to perform hierarchical calibration on the sensor terminal equipment, base station or cloud server. For example, fast primary calibration with less data calculation and/or low precision is performed on the sensor terminal device, and third-level calibration with large data calculation and/or high precision is performed on the cloud server. If the model after the secondary compression optimization of the base station is required for secondary calibration, the sensor terminal device will select the nearest base station for calibration. If the nearest base station is unavailable, the sensor terminal device will enable a backup line and submit sensor data to other base stations. If all base stations are unavailable, sensor end-devices are calibrated using the optimized model with one-stage compression. The solid line shown in FIG. 5-3 is the line between the sensor and the nearest base station, and the dotted line shown is the line between the sensor and other base stations, that is, the backup line.

To sum up, exemplary, step S101 is that the sensor collects and records sensor data at regular time intervals within a certain period of time in chronological order to form time series data, that is, the historical data, wherein the sensor data includes But not limited to the measured value of the sensor, the device ID of the sensor, the collection time of the measured value of the sensor, the geographic location information of the sensor, the environmental meteorological information of the sensor, and other environmental information of the sensor. For example, it can also include (1) air quality parameters in the environmental protection industry: NO₂, SO₂, CO, O₃, PM2.5, PM10, PM1.0, TVOC and other parameters; (2) hydrological parameters in the environmental protection industry: Velocity, flow, water level, water volume; (3) Water quality parameters in the environmental protection industry: water temperature, dissolved oxygen, PH value, conductivity, turbidity, total phosphorus, total nitrogen, ammonia nitrogen, permanganate index, chemical oxygen demand (4) Soil parameters in the forest fire protection industry electrical conductivity, humidity, salinity rate, temperature: (5) Various equipment parameters in the urban management or security industry hydrogen sulfide, NH 3, smoke sensor, gas sensor. Pressure, geomagnetic parameters, intelligent trash can parameters, intelligent manhole cover parameters, intelligent sound and light alarm parameters. By maintaining the matrix information of the time series of the reported data, infer whether the data has drifted, and combined with the calculation amount, intelligently select the calibration location (sensor end, gateway end, and cloud) to perform inference calibration. Wherein, the types of sensors may include but not limited to temperature sensors, humidity sensors, gas sensors, pressure sensors, vibration sensors, distance sensors, infrared sensors, optical sensors and displacement sensors, which are not limited herein. The sensors include: target sensors; target sensors in the same environment and sensors of the same type but different accuracy or different used time; target sensors in the same environment and different types of sensors, or target sensors in the same environment, the same type of sensors But sensors with different accuracy or different hours of use and different types of sensors. The target sensor refers to a sensor that currently needs to perform deep learning and establish a calibration model for subsequent calibration. In the process of deep learning, the value of the historical data corresponding to the target sensor is collected through the standard sensor. The same environment refers to two or more points whose distance does not exceed the distance threshold or the difference of environmental attribute values such as temperature and humidity does not exceed the corresponding environmental difference threshold. FIG. 5-4 further shows an exemplary flow of steps S102-S104, in which the value of the historical data corresponding to the target sensor is collected by the standard sensor, and the historical data and the value are provided to the Transformer model. The standard sensor is a high-precision sensor in the same environment corresponding to the sensor, which is responsible for providing the value of the sensor during the deep learning process, and the value is sensor data whose accuracy is not lower than the standard threshold. The Transformer model trains the historical data and the numerical value, wherein the multi-head attention mechanism of the Transformer model will be multi-headed, that is, multiple inputs, including the historical data of the target sensor in the same environment, the value of the target sensor and the value of the target sensor in the same environment. The historical data of other sensors of the same or different types are sent to the attention mechanism, and the characteristics and information of various aspects in multiple inputs are comprehensively used to extract and learn the internal relationship between various data. The sensors of the same type are sensors of different precision or different used time. By learning the historical data and values of the same sensor, the establishment of a calibration model for a single sensor is realized, and the data characteristics of sensors of the same type but with different accuracy or different lengths of use in the same environment are realized, and a calibration model for the same type of sensor is realized. The establishment of, by learning and obtaining the data correlation between different types of sensors in the same environment, the establishment of calibration models for different types of sensors is realized, and it is further judged whether the accuracy of the trained model meets the requirements, and if so, it will be used as Original model output; if not, continue training until its accuracy meets the requirement.

Exemplarily, step S105 is performing one-level compression optimization on the original model through knowledge distillation to obtain a first-level compression optimized model; performing two-level compression optimization on the original model through deep learning pruning to obtain a two-level compression Optimized model. The model after the one-stage compression optimization has lower requirements on computing power, and is deployed in sensor terminal equipment. The model after the two-stage compression optimization has moderate requirements on computing power, and is deployed in the base station.

Among them, the original model that has not been compressed and optimized requires high computing power, and it is deployed on the cloud server. Therefore, the multi-level compression optimization of the original model realizes hierarchical calibration, so that the model after deep learning has the ability to be deployed separately in sensor terminal equipment, base stations, and cloud servers. The learned model, that is, the first-level compression optimized model, the second-level compression optimized model, and the original model can intelligently match the calibration position. It achieves the balance of the ratio of accuracy and response speed, and realizes the application in multiple scenarios.

Further, in step S106, according to the original model deployed on the cloud server, the model after the two-level compression and optimization deployed on the base station, or the model after the first-level compression and optimization deployed on the sensor terminal equipment, the data collected by the target sensor Raw data for calibration.

In addition, the obtained calibration models of different accuracy types, namely the original model, the model after the first-level compression optimization and the model after the second-level compression optimization, can not only be used for hierarchical calibration, and different calibration models can be selected according to different needs; they can also be used for Multi-level collaborative calibration, the high-level model calibrates at least part of the original data, and compares at least part of the obtained high-level calibrated data with the corresponding low-level calibrated data. Otherwise, advanced calibration is performed on all original data to obtain all advanced calibration data. Utilizing the different accuracies of the calibration models, the high-level model is used to perform random checks on the low-level calibrated data, so that the received calibration results can be checked more simply and efficiently.

FIG. 5-5 is a flow chart of the multi-level collaborative calibration of the sensor calibration method based on deep learning according to the present disclosure, including the following steps S601: The sensor terminal device uses the first-level compressed and optimized model to perform calibration on the sensor Afterwards, the collected raw data is subjected to primary calibration to obtain primary calibrated data: S602, the sensor terminal device uploads the original data and the primary calibrated data to the base station; S603: the base station Perform secondary calibration on at least part of the received raw data using the model after secondary compression optimization to obtain at least part of the data after secondary calibration; S604: combine the at least part of the data after secondary calibration with the corresponding all. If the difference between the two is less than a certain error threshold, all the data after the first-level calibration will be accepted, otherwise, the received original data will be calibrated at the second level using the optimized model after the second-level compression, to obtain all secondary calibrated data; S605: The base station uploads the original data and all received primary calibrated data, or the original data and all secondary calibrated data to the The cloud server; S606: The cloud server uses the original model to perform three-level calibration on at least part of the received original data to obtain at least part of the three-level calibrated data; S607: Combine the three-level calibrated data with Corresponding to the data after the primary calibration or the data after the secondary calibration, if the difference between the two is less than a certain error threshold, then accept all the data after the primary calibration or all the data after the secondary calibration. Otherwise, use the original model to perform tertiary calibration on the received raw data to obtain all tertiary-calibrated data.

The calibration accuracy of the original model obtained through deep learning will decrease to varying degrees after a certain period of time after the last model deployment. Therefore, when the calibration accuracy is lower than a certain accuracy threshold or a certain period of time has passed after the last model deployment, retraining is required. The later original model to replace the original model. For example, the target sensor is a temperature sensor. On the third day of each month, another high-precision temperature sensor is used to accurately measure the temperature of the environment where the target sensor is located. When the difference between the model calibration result and the accurate measurement result is higher than a certain accuracy threshold, then. It means that the calibration result of the original model has a large error, and the original model cannot continue to work. It needs to be retrained, and the previous original model should be replaced with the updated original model after retraining, or after the original model has been used for 3 months, use the retraining. An updated original model replaces the previous original model. FIG. 5-6 is a flow chart of retraining the updated original model, including the following steps: S701: The sensor collects historical data in chronological order, and the historical data required for the retraining is the same as the history used for the last training model. The data are different, and the historical data for a period of time immediately before this training should be used for this training, so that a more accurate model can be obtained; S702: Collect at least part of the corresponding values of the historical data through the standard sensor, S703: Provide the historical data and the numerical value to the Transformer model; S704: The Transformer model trains the historical data and the numerical value to obtain the updated original model; S705: Through deep learning Perform multi-level compression optimization on the updated original model by pruning or knowledge distillation to obtain an updated multi-level compression optimized model, S706:

According to the updated original model or the updated multi-level compression optimized. The model is calibrated to the raw data collected after the sensor.

As before, deploy the updated first-level compression-optimized model obtained through knowledge distillation on the sensor terminal device, deploy the updated second-level compression-optimized model obtained through deep learning pruning on the base station; The updated original model is deployed on the cloud server.

As an optional implementation, four temperature sensors with different accuracies within a radius of 10 meters (the accuracies are respectively C-level, B-level, A-level, and AA-level, and the accuracy is getting more and more from left to right) Large, C-level accuracy is the lowest, AA-level accuracy is the highest), 1 humidity sensor and 1 pressure sensor will collect and record sensor data every 10 minutes from 9:00 to 14:00 Beijing time on Apr. 11, 2022, forming time series data, that is, the historical data of each sensor. The sensor data includes, but is not limited to: the measured value of the sensor, the ID of the sensor device, the collection time of the measured value of the sensor, the geographic location information of the sensor, the environmental weather information of the sensor, and other environmental information of the sensor. The measurement value of the temperature sensor is the temperature value, the measurement value of the humidity sensor is the humidity value, and the measurement value of the pressure sensor is the pressure of the measurement medium, namely liquid or gas.

The accuracy is that the C-level temperature sensor is the target temperature sensor, and the value corresponding to the historical data of the C-level temperature sensor is collected by a standard sensor, and the historical data of the four temperature sensors, humidity sensors and pressure sensors and the C-level temperature sensor are collected. Numerical values are provided to the Transformer model. The Transformer model trains the above data, wherein the multi-head attention mechanism of the Transformer model combines the historical data of the C-level temperature sensor, the value of the C-level temperature sensor, the historical data of the B-level temperature sensor, the historical data of the A-level temperature sensor. The historical data of the AA-level temperature sensor, the historical data of the humidity sensor and the historical data of the pressure sensor are sent to the attention mechanism, and a combination of at least part of the data in the temperature, humidity, pressure value and temperature value in multiple inputs is comprehensively used Perform learning to obtain different calibration models.

By learning the historical data and values of the target sensor, such as the historical data and values of the C-level temperature sensor, the establishment of the first calibration model is realized; by learning the target sensor and its same type within a radius of 10 meters but with different accuracy or different. The data characteristics of the sensors that have been used for a long time, such as the historical data of the four temperature sensors and the value of the C-level temperature sensor, realize the establishment of the second calibration model; Data correlation between type sensors, for example, by learning the historical data and values of the C-level temperature sensor, the historical data of the humidity sensor and the historical data of the pressure sensor, the data between the three types of sensors can be obtained Correlation enables the establishment of a third calibration model. FIG. 5-7 shows the relationship between temperature and humidity learned by the Transformer model. It can be seen from the figure that the humidity decreases with the increase of temperature. When the temperature rises to the highest point, the humidity also drops to the lowest point. Then Humidity rises as temperature falls. Further abnormal value detection for different types of sensors includes: if there is only one humidity sensor and several temperature sensors in the same environment, the temperature continues to rise for a period of time, but the reported data of humidity suddenly rises after a continuous decline, that is. A trend mismatch in FIG. 5-7 triggers an alarm.

Refer to FIG. 5-8 to FIG. 5-12 by learning the target sensor, the same type of sensor within a radius of 10 meters but with different accuracy or different elapsed time, and the data correlation between different types of sensors, for example, by learning. The historical data of the four temperature sensors, the value of the C-level temperature sensor, the historical data of the humidity sensor and the historical data of the pressure sensor realize the establishment of the fourth calibration model. Further continue to judge whether the accuracy of the trained model meets the requirements, and if so, output it as the corresponding original model; if not, continue training until the accuracy meets the requirements.

Since different calibration models can be trained based on different historical data inputs, the complexity of each model is different, and the required input data is also different. The first to fourth original calibration models above can be deployed to sensor terminal equipment, base stations or cloud servers according to different situations.

When calibrating, if the input data is only from the C-level temperature sensor, you need to select the first model above for calibration; if the input data comes from the C-level temperature sensor, humidity sensor and pressure sensor, you need to select the above-mentioned third model for calibration calibration.

Due to the high computational complexity of the original model, it can only be deployed on a cloud server with high computing power, but the cloud server has a large amount of calculation and low responsiveness. In order to achieve fast calibration, the original model is further optimized for one-level compression through knowledge distillation to obtain a model after one-level compression optimization; the original model is optimized for two-level compression through deep learning pruning to obtain two-level compression optimization after the model. The model after the one-stage compression optimization has lower requirements on computing power, and is deployed in sensor terminal equipment. The model after the two-stage compression optimization has moderate requirements on computing power, and is deployed in the base station.

The calibration accuracy of the model after the two-level compression optimization is higher than that of the model after the first-level compression optimization, and lower than the calibration accuracy of the original model; the response speed of the model after the second-level compression optimization is lower than that of the first-level. The response speed of the model after compression optimization is higher than the response speed of the original model; the data calculation amount of the model after the two-level compression optimization is higher than the data calculation amount of the model after the first-level compression optimization, and lower than the original model amount of data calculations.

This embodiment requires that the calibration response speed should be as fast as possible, so it is determined that the first-level compression optimized model deployed on the sensor terminal device or the first calibration model in the above-mentioned original model is used for the 100 data collected after the C-level temperature sensor The original data is calibrated at the first level, and 100 temperature sensor data after the first level calibration are obtained; the sensor terminal device uploads the 100 original data and the 100 temperature sensor data after the first level calibration to the base station; Whether the 100 data calibrated by the sensor terminal equipment are accurate, the base station performs secondary calibration on any 10 of the original data using the model after secondary compression optimization, and obtains 10 temperature sensors after secondary calibration data; compare these 10 secondary calibrated temperature sensor data with their corresponding 10 primary calibrated temperature sensor data to obtain 10 differences, the average value of these 10 differences is greater than the set A certain error threshold, that is, if the spot check fails, continue to use the model after the second-level compression optimization to perform second-level calibration on the remaining 90 original data, and obtain all the temperature sensor data after the second-level calibration.

The base station uploads the 100 original data and the 100 secondary calibrated temperature sensor data to the cloud server; in order to spot check whether the 100 data after base station calibration are accurate, the cloud server utilizes. The original model performs three-level calibration on any 10 original data, and obtains 10 temperature sensor data after three-level calibration; the 10 temperature sensor data after three-level calibration and the corresponding 10 temperature sensor data after two-level calibration By comparison, 10 differences are obtained, and the average value of these 10 differences is less than the set error threshold, that is, the spot check is passed, and all the temperature sensor data after secondary calibration are accepted.

Three months after the last model deployment, the calibration accuracy of the original model, the first-level compression-optimized model, and the second-level compression-optimized model has been greatly reduced, and the updated original model needs to be retrained to replace Calibrate the original model whose accuracy cannot meet the requirements. The specific training method is the same as the method of training the original model for the first time. Similarly, perform multi-level compression optimization on the updated original model to obtain an updated multi-level compression optimized model, and deploy the updated one-level compression optimized model obtained through knowledge distillation on the sensor terminal device; The updated two-level compressed and optimized model obtained by deep learning pruning is deployed on the base station; and the updated original model is deployed on the cloud server.

The Transformer model based on the multi-head attention mechanism in this embodiment can not only capture the historical data and values of the target sensor, and realize the establishment of the first calibration model. The data characteristics of the temperature sensor can realize the establishment of the second calibration model; it can also realize the establishment of the third calibration model by learning the data correlation of the target sensor and the humidity sensor and pressure sensor in the same environment; it can also realize the establishment of the third calibration model by learning the target sensor, sensors of the same type but different precision or different used time in the same environment, and the data correlation of the humidity sensor and the pressure sensor in the same environment, realize the establishment of the fourth calibration model. In addition, the first-level compression optimization is performed on the original model through knowledge distillation to obtain a first-level compression-optimized model that can be deployed on the sensor terminal equipment, and the rapid calibration of the original data collected after the target temperature sensor is realized. The multi-stage compression optimization of the original model achieves a balance between the ratio of calibration accuracy and response speed. Breaking through the singleness of deep learning models that can only be deployed on cloud servers due to high computational complexity.

Multi-level collaborative calibration can use multi-level calibration models of different precision to calibrate part of the original data, spot check whether the calibration results reported by the low-level calibration models are qualified, and realize the simple and efficient inspection of the received calibration results.

The present disclosure also provides a more general deep learning processing method. The deep learning processing method uses the original model to generate a multi-level simplified version model, and deploys it in a multi-level distributed network device according to the processing capability of the network device, for Realize the application of corresponding identification, calibration and other big data processing by using the deployed models at all levels in multi-level network equipment. Described processing method comprises the steps: Collect historical data in chronological order;

Collecting at Least Some of the Values Corresponding to the Historical Data, Providing Said Historical Data and Said Values to a Deformer Model:

The deformer model trains the historical data and the values to obtain an original model; Perform multi-level compression optimization on the original model through deep learning pruning or knowledge distillation to obtain a model after multi-level compression optimization, and deploy the first-level compression and optimized model obtained through knowledge distillation on the terminal device. The model after the two-level compression optimization obtained by pruning is deployed in the base station, and the original model is deployed on the cloud server. The processing accuracy of the model after the two-level compression optimization is higher than that of the model after the first-level compression optimization. Accuracy, and lower than the processing accuracy of the original model, the response speed of the model after the two-level compression optimization is lower than the response speed of the model after the first-level compression optimization, and higher than the response speed of the original model, the data calculation amount of the model after the two-level compression optimization is higher than the data calculation amount of the first-level compression optimized model, and lower than the data calculation amount of the original model; according to the processing accuracy requirements, response speed and/or the amount of data calculation, it is determined that the terminal equipment, base station or cloud server uses the deployed model to process the raw data collected later.

The terminal device uses the first-level compressed and optimized model to perform a first-level processing on the subsequent collected raw data to obtain first-level processed data;

The terminal device uploads the original data and the primary-processed data to the base station; The base station performs secondary processing on at least part of the received raw data by using the model after the secondary compression optimization, to obtain at least part of the data after secondary processing;

Comparing the at least part of the data after the secondary processing with the corresponding data after the primary processing, if the difference between the two is less than a certain error threshold, accept all the data after the primary processing, otherwise, use the secondary. The compressed and optimized model performs secondary processing on the received raw data to obtain all secondary processed data;

The base station uploads the original data and all received first-level processed data, or the original data and all second-level processed data to the cloud server;

The cloud server uses the original model to perform tertiary processing on at least part of the received raw data to obtain at least part of the data after tertiary processing;

Comparing the data after the third-level processing with the corresponding data after the first-level processing or the data after the second-level processing, if the difference between the two is less than a certain error threshold, accept all the data after the first-level processing data or all data after secondary processing, otherwise, use the original model to perform tertiary processing on the received raw data to obtain all data after tertiary processing.

According to the processing accuracy is lower than a certain accuracy threshold or after a certain period of time after the last model deployment, retrain the updated original model, including the following steps.

Collect historical data in chronological order;

collecting at least partly corresponding values of the historical data;

providing the historical data and the values to the deformer model;

The deformer model trains the historical data and the values to obtain the updated original model; Perform multi-level compression optimization on the updated original model through deep learning pruning or knowledge distillation to obtain an updated multi-level compression optimized model, and use the updated one-level compression optimized model obtained through knowledge distillation Deploying on the terminal device, deploying the updated two-level compressed and optimized model obtained through deep learning pruning on the base station, and deploying the updated original model on the cloud server;

The raw data collected later are processed according to the updated original model or the updated multi-stage compression optimized model.

The present disclosure is not limited to the above-mentioned distributed network structure of three-level network equipment, and can also be applied to two-level, four-level or even higher-level network structures in the same way, so that each level of network equipment can be applied to all levels of versions obtained through training model to improve the efficiency and accuracy of data processing.

### Exemplary System

Embodiments of the present disclosure will be described in detail below in conjunction with the accompanying drawings.

5-8 are structural block diagrams of a sensor calibration system based on deep learning according to the present disclosure.

The calibration system 900 includes: a sensor 910, which is used to collect historical data in chronological order;

standard sensor 920, which is used to collect at least part of the value corresponding to the historical data;

A training device 930, configured to receive the historical data and the numerical value, and perform training on the historical data and the numerical value to obtain an original model. Compression optimization device 940, which is used to perform multi-level compression optimization on the original model through deep learning pruning or knowledge distillation to obtain a multi-level compression optimized model;

The calibration device 950 is configured to calibrate the raw data collected by the sensor according to the original model or the multi-stage compression optimized model.

The sensor 910 includes: a target sensor.

Target sensors in the same environment, and sensors of the same type but with different accuracy or different usage time;

target sensors in the same environment, and different types of sensors; or

Object sensors in the same environment, sensors of the same type but with different accuracy or age, and sensors of different types.

The training device 930 is a deformer model, and the deformer model uses a multi-head attention mechanism to learn the data characteristics of the same type of sensor and obtain the data correlation between different types of sensors, thereby obtaining the original model; wherein. The multi-head has multiple inputs, and the multiple inputs include the input of the target sensor in the same environment, the value of the target sensor, and the input of other sensors of the same or different types in the same environment.

As shown in FIGS. 5-9, the compression optimization device 940 also includes a deployment module 1041, which is used to deploy the first-level compressed and optimized model obtained through knowledge distillation on the sensor terminal device; the second-level model obtained through deep learning pruning. The compressed and optimized model is deployed on the base station; the original model is deployed on the cloud server.

The calibration accuracy of the model after the two-stage compression optimization is higher than the calibration accuracy of the model after the one-stage compression optimization, and lower than the calibration accuracy of the original model; the response speed of the model after the two-stage compression optimization Lower than the response speed of the model after the first-level compression optimization, and higher than the response speed of the original model; the data calculation amount of the model after the second-level compression optimization is higher than that of the model after the first-level compression optimization. The calculation amount of data is lower than that of the original model.

As shown in FIGS. 5-10, the calibration device 950 further includes a model determination module 1151, a multi-level calibration scheduling module 1152 and an update command module 1153.

The model determination module 1151 determines, according to the calibration accuracy requirements, response speed and/or data calculation amount, to use the deployed model in the sensor terminal device, base station or cloud server for calibration.

The multi-level calibration scheduling module 1152 performs the following control operations: The sensor terminal device uses the model after the first-level compression optimization to perform a first-level calibration on the original data collected by the sensor to obtain the data after the first-level calibration, and the sensor terminal device combines the original data and the Upload the data after the above-mentioned primary calibration to the base station;
making the base station perform secondary calibration on at least part of the received raw data by using the model after secondary compression optimization, obtain at least part of the data after secondary calibration, and convert the at least part of the data after secondary calibration to. The data is compared with the corresponding first-level calibrated data, and if the difference between the two is less than a certain error threshold, all the first-level calibrated data are accepted; otherwise, the received original. The data is subjected to secondary calibration, and all secondary calibrated data are obtained, and the original data and all accepted primary calibrated data, or the original data and all secondary calibrated data are uploaded to. The cloud server
making the cloud server use the original model to perform tertiary calibration on at least part of the received raw data, obtain at least part of the tertiary calibrated data, and combine the tertiary calibrated data with the corresponding. The data after primary calibration or the data after secondary calibration are compared, if the difference between the two is less than a certain error threshold, then all the data after primary calibration or all the data after secondary calibration are accepted, otherwise, use the original. The model performs three-level calibration on the received raw data to obtain all three-level calibrated data.

The update command module 1153 determines to retrain the updated original model according to that the calibration accuracy is lower than a certain accuracy threshold or after a certain period of time after the last model deployment, and performs the following control operations.

Make the sensor 910 collect historical data in chronological order; causing the standard sensor 920 to collect at least part of the corresponding values of the historical data;

making the training device 930 receive the historical data and the numerical value, and train the historical data and the numerical value to obtain an original model;

Make the compression optimization device 940 perform multi-level compression optimization on the updated original model through deep learning pruning or knowledge distillation to obtain an updated multi-level compression optimized model;

The calibration device 950 is configured to calibrate the raw data collected by the sensor according to the updated original model or the updated multi-stage compression optimized model.

Deployment module 1041 deploys the updated first-level compressed and optimized model obtained through knowledge distillation on the sensor terminal device; deploys the updated second-level compressed and optimized model obtained through deep learning pruning on the base station; The updated original model is deployed on the cloud server example application.

A kind of application to the calibration method of sensor based on deep learning, described application comprises the steps:

The sensor collects raw data in real time;

collecting values corresponding to the raw data in real time through standard sensors; Taking out a certain amount of the original data and corresponding values according to the sampling rate, and uploading the taken out original data and values to the base station;

The base station compares a certain amount of the original data with its corresponding value; If the difference between the two is greater than a certain accuracy threshold and the proportion is less than the ratio threshold, the sensor is marked as a sensor in a normal state, all raw data is accepted and uploaded to the cloud server.

If the difference between the two is greater than a certain accuracy threshold and the ratio is greater than or equal to the ratio threshold, the base station sends a level-1 calibration instruction to the sensor terminal device so that the sensor terminal device uses the model after level-1 compression optimization to perform calibration on the original data. First-level calibration, to obtain the first-level calibrated data, the sensor terminal device uploads the first-level calibrated data to the base station, and the base station takes a certain amount of the first-level calibrated data according to the sampling rate, and uploads the first-level calibrated data to the base station. It is compared with the corresponding value, if the difference between the two is greater than a certain accuracy threshold and the proportion is less than the ratio threshold, the sensor is marked as a sensor that needs local calibration, and all the first-level calibrated data are accepted and uploaded. The data after primary calibration is sent to the cloud server.

The base station takes out a certain amount of the first-level calibrated data according to the sampling rate, compares it with the corresponding value, and if the difference between the two is greater than a certain accuracy threshold and the proportion is greater than or equal to the ratio threshold, the sensor is marked as abnormal sensor;

The base station performs secondary calibration on the original data of the abnormal sensor by using the model after secondary compression optimization, obtains the data after secondary calibration, and uploads all the data after secondary calibration to the cloud server; Retraining the abnormal sensor to obtain its updated original model, before obtaining the updated original model, the base station needs to use the model after the secondary compression optimization to perform secondary calibration on the original data of the abnormal sensor. As an optional implementation manner, FIG. 5-11 is a flow chart of an exemplary application of a deep learning-based calibration method for calibrating the same type of sensors.

Three temperature sensors with different accuracies in the same geographical range (the accuracies are respectively C-level, B-level, and A-level, and the accuracy is getting bigger and bigger from left to right, the C-level accuracy is the lowest, and the A-level accuracy is the highest) Collect 100 original data, and deploy 3 standard sensors to collect 300 values corresponding to the original data in real time. Set the sampling rate to 10% according to the changes in the external environment, such as seasonal changes, the coming of the rainy season, and continuous fog. 10 are randomly selected from the 100 raw data of the A-level temperature sensor, the 100 raw data of the B-level temperature sensor, and the 100 raw data of the C-level temperature sensor Upload the 30 original data extracted above and their corresponding values to the base station. The base station further calculates the difference between the 30 original data and their corresponding values to obtain 30 difference values, of which only one difference value of the A-level temperature sensor is greater than the accuracy threshold (that is, the proportion of data that does not meet the accuracy threshold is 10%), there are 4 difference values greater than the accuracy threshold in the B-level temperature sensor (that is, the data that does not meet the accuracy threshold account for 40%), and 8 differences in the C-level temperature sensor are greater than the accuracy threshold (that is, the data that does not meet the accuracy threshold accounted for 80%).

In this embodiment, the proportion threshold is set to 20% according to the external environment change, then 10% of the Class A temperature sensors that do not meet the accuracy threshold are less than the proportion threshold of 20%, and the base station marks the Class A temperature sensor as a normal sensor The A-level sensor uploads 100 pieces of raw data to the base station, and the base station receives all the original data of the A-level sensor and uploads it to the cloud server.

If 40% of the class B temperature sensors do not meet the accuracy threshold, the ratio threshold is 20%, and the base station marks the class B temperature sensor as a sensor that needs to be calibrated. If the proportion of C-level temperature sensors that do not meet the accuracy threshold is 80% greater than the ratio threshold of 20%, the base station marks the C-level temperature sensors as sensors that need to be calibrated.

Further, the base station sends a first-level calibration instruction to the B-level temperature sensor and the C-level temperature sensor, so that the B-level temperature sensor terminal equipment uses the first-level compressed and optimized model to perform a first-level calibration on the 100 original data of the B-level temperature sensor, and obtains the B-level. The 100 first-level calibrated data of the first-level temperature sensors enable the C-level temperature sensor terminal equipment to use the first-level compressed and optimized model to perform first-level calibration on the 100 original data of the C-level temperature sensors, and obtain 100 first-level calibrations of the C-level temperature sensors. Calibrated data.

According to a sampling rate of 10%, 10 were randomly selected from the 100 first-level calibrated data of the B-level temperature sensor and the 100 first-level calibrated data of the C-level temperature sensor. Upload the above-mentioned 20 first-level calibration data and their corresponding values to the base station.

The base station further calculates the difference between the 20 first-level calibrated data and their corresponding values to obtain 20 difference values, of which only one difference value of the B-level temperature sensor is greater than the accuracy threshold (that is, the proportion of data that does not meet the accuracy threshold 10%), there are 5 differences in the C-level temperature sensor that are greater than the accuracy threshold (that is, the proportion of data that does not meet the accuracy threshold is 50%).

If 10% of the B-level temperature sensors do not meet the accuracy threshold, the proportion is less than 20%, and the base station marks the B-level temperature sensors as sensors requiring local calibration. The B-level sensor uploads 100 first-level calibrated data to the base station, and the base station accepts all the first-level calibrated data of the B-level sensor and uploads it to the cloud server.

If the proportion of C-level temperature sensors that do not meet the accuracy threshold is greater than 50% of the ratio threshold of 20%, the base station will mark the C-level temperature sensor as an abnormal sensor.

The base station performs secondary calibration on the raw data of the C-level temperature sensor by using the model after secondary compression optimization, obtains the data after secondary calibration, and uploads all the data after secondary calibration to the cloud server. Retrain the C-level temperature sensor to obtain its updated original model. Before obtaining the updated original model, the base station needs to use the two-level compression optimized model to perform two-level calibration on the real-time collected raw data of the C-level temperature sensor. As another optional implementation, different from the above-mentioned implementation that selects 100 raw data of the same sensor (such as 100 raw data of a grade A temperature sensor), this implementation selects 100 raw data of the same precision and 1 raw data of the same type of sensors (for example, 100 A-level temperature sensors collect 1 raw data respectively). 100 A-level temperature sensors, 100 B-level temperature sensors, and 100 C-level temperature sensors in the same geographical area collect one raw data each, and deploy 300 standard sensors to collect 300 values corresponding to the original data in real time. 10 are randomly selected from the raw data of 100 grade A temperature sensors, 100 raw data of B grade temperature sensors and 100 raw data of C grade temperature sensors. Upload the above 30 original data and their corresponding values to the base station. The base station further calculates the difference between the 30 original data and their corresponding values to obtain 30 difference values, of which only one difference value of the A-level temperature sensor is greater than the accuracy threshold (that is, the proportion of sensors that do not meet the accuracy threshold is 10%), 4 of the B-level temperature sensors have a difference greater than the accuracy threshold (that is, the proportion of sensors that do not meet the accuracy threshold is 40%), and 8 of the C-level temperature sensors have a difference greater than the accuracy threshold (that is, the sensors that do not meet the accuracy threshold accounted for 80%).

In this embodiment, the proportion that does not meet the accuracy threshold is the proportion of the number of such sensors. For example, among 10 A-level temperature sensors, there is one A-level temperature sensor that does not meet the accuracy threshold, and the proportion of sensors that do not meet the accuracy threshold is 10%; this is different from the proportion of the sensor data of the sensor that does not meet the accuracy threshold in the aforementioned embodiment, for example, 1 of the 10 sensor data of the sensor data of a Class A temperature sensor has 1 sensor data that does not meet the accuracy threshold. The accuracy threshold is met, and the proportion of data that does not meet the accuracy threshold is 10%.

In the above two embodiments, it is determined whether to calibrate the sensor according to the proportion of data with deviation in the data of the same sensor, and whether to calibrate this batch of sensors according to the proportion of sensors with deviation in the same batch of sensors. The different judgment criteria of all belong to the scope of the present disclosure, and those skilled in the art can flexibly determine the judgment criteria, precision threshold, ratio threshold, etc. according to specific needs.

### T1-6-6—Composite Gas Leak Detection Terminal.

The prior art gas leakage detection terminals have the following defects: battery power is used for easy installation and maintenance, and laser sensors are used. In order to reduce power consumption, intermittent sampling is used, which may miss short-term high-concentration leaks, resulting in poor real-time performance, use low power consumption when the infrared sensor is infrared, the methane sensor has low power consumption, but its selectivity is poor, and it is susceptible to environmental interference such as other gases, temperature and bumidity, resulting in obvious environmental interference; after the sensor has been dormant for a long time, it takes a stable time to turn on the power until accurate data can be read. This leads to high power consumption; there is no waterproof function, and the underground pipeline will be flooded, which will damage the sensor.

The sensor terminal used to monitor gas leakage cannot achieve continuous high-precision sampling due to the limited battery capacity and high power consumption of the sensor, and there is a risk of missing detection for sudden leakage. There is a need for a terminal that can detect both sudden large leaks quickly and slow leaks, and can control reasonable power consumption.

In order to solve at least one of the above technical problems, for example, in order to reduce the power consumption of the terminal, some embodiments of the present disclosure provide a composite gas leakage detection terminal, as shown in FIG. 6-1, equipped with two kinds of methane sensors: low power consumption Infrared sensors (such as infrared, semiconductor, micro-mechanical, etc.), low power consumption, short start-up time, but low precision, easily interfered by other gases and water vapor, suitable for detecting sudden high-concentration leakage; high-precision laser methane sensor, function High power consumption, requires a certain stabilization time, high precision, strong anti-interference ability, suitable for small slow leakage on the buccal side.

The composite gas leakage detection terminal provided by the embodiment of the present disclosure can be applied to the architecture shown in FIG. 1, for example, it can be used as the sensing terminal shown in FIG. 1, and the composite gas leakage detection terminal can send the collected data to other sensing Terminals, gateways/base stations, servers and other equipment, and the composite gas leak detection terminal itself has edge computing capabilities, which can realize local decision-making and better support the operation of multi-mode heterogeneous Internet of Things. In addition, the composite gas leakage detection terminal provided by the embodiments of the present disclosure can also be applied to FIG. 1A, FIG. 1B, FIG. 1C and FIG. 1D. For example, it can be used as the sensing terminal shown in FIG. 1A-ID. The terminal can also send the collected data to other sensing terminals, gateways/base stations, servers and other devices, and has edge computing capabilities, which can realize local decision-making and better support the operation of multi-mode heterogeneous Internet of Things.

The composite gas leakage detection terminal can be used for leakage monitoring of underground gas pipelines. It has the advantages of low power consumption, easy installation, and anti-environmental interference. It can effectively detect gas leakage in real time, reduce false alarms, improve accuracy, and ensure Gas transmission safety.

By adopting two kinds of methane sensors, a low-power methane sensor and a high-precision laser sensor, the low-power methane sensor is always on or frequently on to monitor high-concentration leaks. A laser methane sensor, timed on to detect micro-leaks.

In some embodiments, it can also include temperature and humidity sensors, air pressure sensors, water level sensors, etc. These sensors can be used to detect the surrounding environment of the equipment. It can be used to detect water immersion. When there is water immersion, the detection window can be closed to protect the sensor. The temperature and humidity sensor can compensate the low-power methane sensor, and the laser sensor can calibrate the low-power methane sensor. In some embodiments, the curves from power-on to stable data of the sensor under different temperature and humidity conditions can be collected and recorded, and the stable value can be calculated through the trend of the curve, so that the approximate concentration data can be obtained without turning on the stable time, thereby reducing power consumption consumption.

In some embodiments, the sensor can be protected from damage in case of water immersion by using a waterproof breathable membrane, a buoyancy mechanism, and an electric hatch.

In some embodiments, interface circuitry is used to interface with external sensors. In some embodiments, the driving circuit is used to drive the alarm (such as sound and light) and the sensor to detect the window closing device (such as motor, muscle titanium, electromagnet, etc.)

In some embodiments, the communication circuit is used for data exchange with the server. Exemplarily, the upper two shown in FIG. 6-2 represent the comparison of the turn-on frequency of the laser sensor and the low-power sensor; the laser sensor has high power consumption, a long single turn-on time, but a low turn-on frequency, and is used to monitor tiny slow leaks; The low-power sensor is turned on frequently, and the data can be obtained in a short turn-on time, which is used to detect sudden large-capacity leakage.

Exemplarily. FIG. 6-3 shows the relationship between data sending frequency and concentration. By setting a threshold, when the detected concentration is always lower than the threshold, the data will be sent at a relatively long fixed interval. If the detected concentration exceeds the threshold value, data is sent immediately.

Exemplarily, as shown in FIG. 3-2, the stabilization time of the sensor may be different at different concentrations, and waiting for the same stabilization time for all concentrations will result in increased power consumption. The figure on the left shows that the sampling is started before the numerical stabilization time, and the sensor is turned off immediately after sampling to achieve the purpose of energy saving. The data obtained by sampling in advance is calculated according to a certain stable trend algorithm to calculate the actual data after stabilization; the middle figure shows the overshoot of the value before the data is stable, and a different stable trend algorithm should be used to calculate the real data; the right figure is the external condition There are differences in the numerical stability curves when changing, and it is necessary to introduce parameters such as temperature into the stability trend algorithm to assist in the calculation to improve the calculation accuracy. Due to the individual differences of the sensors, the stability curves of each sensor are different. The stability trend curve can be obtained by sampling multiple data before the stabilization time and the environmental data value through the learning algorithm on site, and then this curve is used in 1, 2 and 3 calculation.

Exemplarily, as shown in FIG. 6-4· FIG. 6-4 shows the structure of the detection terminal, which can be divided into two large cavities. The upper cavity houses the battery and the motherboard. The cavity is completely sealed and waterproof. Of course, consider the battery is larger and it is also possible to provide a separate cavity for the battery. The lower cavity is the sensor cavity, which is used to place temperature, humidity and methane sensors. The cavity has a window covered with a waterproof and breathable membrane. The waterproof and breathable membrane allows gases such as methane to enter and exit freely, but prevents water from entering. The front and rear of the waterproof and breathable membrane are supported by grid sheets to improve the pressure difference resistance, at the same time, a separate pressure leakage device is set to leak the excessive pressure of the sensor cavity. The floating body part and the driving part are used in emergency situations (such as water immersion, excessive pressure difference) to close the ventilation window to more fully protect the ventilation membrane from being damaged. The former uses the buoyancy of the water to close, while the latter uses a device such as a motor to actively close.

The composite gas leakage detection terminal provided by the embodiments of the present disclosure has the following advantages: low power consumption: battery power supply, low power consumption methane sensor for real-time collection, high concentration measurement, laser sensor is turned on at regular intervals, and low concentration detection; self-calibration: laser sensor can Measure concentration data for data calibration of low-power sensors; anti-jamming: waterproof and breathable membrane is used to isolate water from entering without affecting gas detection. When the underwater pressure is too high, the terminal can start automatic protection function, and the sealed sensor is waterproof, thereby protecting the sensor.

T1-7-7—Multi-mode ad hoc network mutual recognition intelligent positioning badge and system.

The prior art positioning badges have a short standby time, the power consumption of satellite positioning is increased, and frequent charging is required, the positioning badges cannot distinguish between people getting together and one person wearing multiple badges; the prior art positioning badges use single-mode communication, and communication in places with poor signals will be interrupted.

In order to solve at least one of the above-mentioned technical problems, such as improving the standby time of badges, an embodiment of the present disclosure provides a multi-mode ad hoc network mutual recognition intelligent positioning badge, including: a main controller, a cellular communication module, an LPWA communication module, BLE communication module, acceleration sensor, GNSS positioning module, server.

The main controller is the control center of all modules. The cellular communication module connects to the server through the mobile network. The LPWA communication module can communicate with the IPWA gateway, and can also be used for ad hoc network communication between work cards. The BLE communication module is used for indoor RSSI and AOA positioning, clocking in and out, and can also be used for badges scan and identify each other.

Accelerometers are used for step counting and motion recognition, and can be used to identify whether the wearer is moving. The GNSS positioning module is used for outdoor positioning. The server is used to collect all badge information, and realize track record, group recognition, communication coordination, attendance and other applications.

The multi-mode ad hoc network mutual identification intelligent positioning badge provided by the embodiment of the present disclosure can be applied to the architecture shown in FIG. 1, for example, it can be used as the sensing terminal shown in FIG. 1. The positioning badge can send the collected data to other sensing terminals, gateways/base stations, servers and other devices, and the multi-mode ad hoc network mutual recognition intelligent positioning badge itself has edge computing capabilities, which can realize local decision-making and better support for the operation of multi-mode heterogeneous Internet of Things. In addition, the multi-mode ad hoc network mutual identification intelligent positioning badge provided by the embodiment of the present disclosure can also be applied to FIG. 1A, FIG. 1B, FIG. 1C and FIG. 1D (that is, FIG. 1A-ID), for example, can be used as FIG. 1A-The sensing terminal shown in ID can also send the collected data to other devices such as other sensing terminals, gateways/base stations, servers, etc. and has edge computing capabilities, can realize local decision-making, and can better support multi-mode heterogeneity operation of the Internet of Things.

The multi-mode ad hoc network mutual identification intelligent positioning badge provided by the embodiment of the present disclosure can be worn by sanitation workers, security personnel, construction site workers, rangers, firefighters and other personnel who need positioning, and is used to record personnel trajectory, attendance, monitoring Signs and monitoring personnel get together.

FIG. 7-1 to FIG. 7-4 are schematic diagrams of multi-mode ad hoc network mutual recognition intelligent positioning badges and systems. Among them, FIG. 7-1 is a schematic diagram of sending and receiving beacons, FIG. 7-2 is a schematic diagram of receiving and transmitting Bluetooth beacons to a server, FIG. 7-3 is a schematic diagram of judging service aggregation, and FIG. 7-4 is a schematic diagram of data transmission. The present disclosure is described in conjunction with FIG. 7-1 to FIG. 7-4, including the following steps or components: As shown in FIG. 7-1, when the terminal is working, it sends Bluetooth beacons at certain intervals. The beacon carries information such as the terminal's MAC address (or device identification ID number), device type, and transmit power. The sending interval can be adjusted as needed.

Exemplarily, the terminal starts to receive and scan beacon signals at intervals, and the beacon signal scanning time should be longer than the interval time between beacon transmissions. Scanned beacons may come from nearby terminals, positioning beacon devices and other non-system devices, and analyze the signal strength of all beacon load data records.

Exemplarily, as shown in FIG. 7-2, for the beacon data of the adjacent terminal, first identify whether there is duplicate data coming from the terminal. If there is, only one piece of data from the same terminal is left, and the signal strength is the average value of multiple duplicate data. Then according to the beacon data, sort the signals from strong to weak, and send one or more pieces of data with stronger signals to the server according to the configuration needs.

Exemplarily, as shown in FIG. 7-3, the server receives the data sent by the terminal, extracts the MAC address and signal strength in the beacon, stores it in the temporary cache, and queries the cache records of the past period of time, such as 10 minutes, if. The two terminals have scanned each other's beacons multiple times, indicating that the two terminals have been kept in close proximity for a long time, which can be judged as a cluster. If two devices are always detected to be close to each other, it can be determined that one person is wearing multiple devices.

Exemplarily, for the data sent by the positioning beacon, the coordinate data and signal strength are extracted, and the rough distance from the positioning terminal to the coordinate is calculated from these two data. This coordinate can be used as the device's positioning data when satellite positioning data is not available.

Exemplarily, if there are multiple pieces of data sent by the positioning beacons, after calculating them respectively, the accurate location information is calculated through the distance and coordinates.

Exemplarily, as shown in FIG. 7-4, there are dual communication networks, the cellular network is used for northbound communication, and the LPWA network can be used for both northbound communication and communication between badges.

Exemplarily, badges are self-organized networks with each other, badges at the edge of the network are connected to servers through other badge relays, communication data between badges is encrypted, and an encryption module can be selected.

Exemplarily, in the first way of reducing power consumption of the device, the positioning terminal can set the on-duty time of the wearer, and this time can also be sent through the server at any time. Turn off satellite positioning during off-duty hours, and turn off beacon scanning and scanning functions.

Exemplary, the second way to reduce device power consumption is to identify and locate terminal actions during on-duty hours. If the personnel action is not working, turn off satellite positioning, and the single-beacon emission and scanning functions are still enabled.

Exemplarily, the third way to reduce device power consumption is to switch the satellite to sleep mode if the satellite is still unable to locate within a period of time during the on-duty time, that is, to sleep for a certain period of time and then turn on for a period of time, and so on Increase the GNSS sleep time if the beacon is scanning for a positioning signal.

The technical effects that can be achieved by the technical solution of the present disclosure include: where the network coverage is not good, the use of multi-mode communication and ad hoc network can ensure device communication, increasing the applicable scenarios of the device; mutual identification between devices can realize clustering and indoor positioning, the supervision is more comprehensive; the low power consumption strategy increases the standby time of the equipment, and the equipment is more convenient to use. The multi-mode ad hoc network mutual recognition intelligent positioning badge provided by the embodiment of the present disclosure can realize indoor and outdoor positioning, attendance check, wearing supervision, action recognition and nearby device recognition while ensuring the standby time; Bluetooth beacon sending and scanning are used for Indoor positioning, identification of nearby equipment, and time attendance; low-power operation through switching between multi-purpose working modes and communication modes; multi-mode communication and ad hoc network interconnection.

### T1-8-8—a Miniature Air Station Terminal Equipment.

Prior art gridded micro-air stations, gas and particle sensors require high gas exchange rates to achieve fast response There are defects in the commonly used solutions, the dome-type housing gas can only circulate on the surface, while the structural gas circulation in the form of a chassis is not smooth, and sufficient air intake cannot be guaranteed. The replacement rate requirement can be achieved by using a pump-suction structure, but its structural load is high, and the overall power consumption is large.

In order to solve at least one of the above technical problems, an embodiment of the present disclosure provides a miniature air station terminal device, as shown in FIG. 8-1 to FIG. 8-3, including a chassis, a bottom opening, a metal mesh bracket, a metal mesh, and a sensor Board and bracket, top opening. The miniature air station terminal equipment can be applied to air pollution detection, gas detection in factories and parks.

The micro air station terminal device provided by the embodiment of the present disclosure can be applied to the architecture shown in FIG. 1, for example, it can be used as a sensing terminal shown in FIG. 1, and the micro air station terminal device can send the collected data to other sensing Terminals, gateways/base stations, servers and other equipment, and the terminal equipment of the micro air station itself has edge computing capabilities, which can realize local decision-making, and can better support the operation of multi-mode heterogeneous Internet of Things. In addition, the miniature air station terminal equipment provided by the embodiments of the present disclosure can also be applied to FIG. 1A, FIG. 1B, FIG. 1C and FIG. 1D (je, FIG. 1A-1D) The terminal can also send the collected data to other sensing terminals, gateways/base stations, servers and other devices, and has edge computing capabilities, which can realize local decision-making and better support the operation of multi-mode heterogeneous Internet of Things.

Exemplarily, a plurality of holes are opened at the bottom of the chassis; the shape of the small holes can be round, square, strip or other irregular shapes, and the size of the holes is moderate, which can block the entry of large foreign objects such as stones, large insects, branches, etc. The number of openings is sufficient to ensure that air can freely enter the chassis. The large holes at the bottom of the chassis block large objects, and cooperate with the multi-mesh filter bracket to filter fine particles. The metal mesh bracket plus the metal mesh and the bottom surface of the baseline enclose a cavity, and the metal mesh is used to block small foreign objects.

Exemplarily, a bracket is installed on the inner side of the bottom of the chassis near the small hole, the bracket is closed on all sides, the bottom is left empty, and the window above is used to fix the metal filter for filtering large particles of dust and flying catkins. At the same time, when rainwater enters and exits from below in bad weather, the off-grid also acts as a barrier; the support column is fixed on the bracket to fix the sensing plate.

Exemplarily, the sensor is installed upside down, and the air inlet of the control sensor module is close to the filter screen. The sensor is mounted upside down next to the multi-mesh filter for quick air exchange. The sensor board and bracket control sensor is installed close to the metal mesh to maximize exposure to the outside air.

Exemplarily, small boles are opened at the four corners of the case to drain accumulated water in the case due to tilting of the case and wind and rain.

Small holes are opened around the top cover of the case, and the airflow can enter through the bottom of the case and be exhausted from the top to realize the natural flow of air; optional small fans can be added through the top cover of the case to further enhance the air replacement rate. Windows at the top of the case increase air circulation. After the bottom air enters the chassis, it relies on the micro heat emitted by the internal components of the chassis to form an upward airflow and flows out through the top opening.

The mini air station terminal equipment provided by the embodiment of the present disclosure: Compared with the conventional chassis, the air replacement rate is significantly improved, the response time is shortened, and the detection accuracy is improved; the structure is simplified, the components of the equipment are not significantly increased or decreased, and the product is effectively controlled Cost; integrated design, easy to install, stable structure.

### T1-9-9—Tree Multi-Dimensional Monitoring Terminal.

Existing smart tree sign equipment only detects the trunk of trees, and can identify whether the tree is damaged or stolen through the change of inclination angle, and cannot detect the loss of the trunk; in addition, the existing tree circumference (tree diameter) detection cost is high, and the data obtained is single, so it cannot be detected Combine data with other factors to analyze tree health. In order to solve at least one of the above technical problems, for example, how to quickly identify whether a tree has been illegally felled, etc. an embodiment of the present disclosure provides a multi-dimensional tree monitoring terminal, which can be used to monitor illegal felling of trees, tree growth environment, and tree health, conditions, etc. can be used for the guardianship of ancient and famous trees.

As shown in FIG. 9-1, a multi-dimensional tree monitoring terminal includes: tilt sensor, tree circumference sensor, soil nutrition sensor, pyro-infrared sensor, sensor radar, microphone, horizontal camera, and sky camera. As shown in FIG. 9-2, the tilt sensor: used to monitor the tilt state of the trunk and branches; the tree circumference sensor: used to monitor the diameter of the tree to obtain the growth of the tree; the soil nutrition sensor to monitor the growth environment of the tree; Infrared release, sensor radar: used to detect whether someone is approaching; microphone: used to monitor illegal felling of trees, recognize the sound of sawing wood, and the sound of trees falling to the ground; horizontal camera: used to identify human activities, capture behaviors that destroy trees; sky camera; identify. The development of tree branches and leaves.

The tree multi-dimensional monitoring terminal provided by the embodiment of the present disclosure can be applied to the architecture shown in FIG. 1, for example, it can be used as the sensing terminal shown in FIG. 1. The tree multi-dimensional monitoring terminal can send the collected data to other sensing terminals. Gateways/base stations, servers and other devices, and the multi-dimensional tree monitoring terminal itself has edge computing capabilities, which can realize local decision-making, and can better support the operation of multi-mode heterogeneous Internet of Things. In addition, the tree multi-dimensional monitoring terminal provided by the embodiment of the present disclosure can also be applied to FIG. 1A, FIG. 1B, FIG. 1C and FIG. 1D (FIG. 1A-1D) For example, it can also send the collected data to other sensing terminals, gateways/base stations, servers and other devices, and has edge computing capabilities, which can realize local decision-making and better support the operation of multi-mode heterogeneous Internet of Things. As shown in FIG. 9-3, the method of using the tree multi-dimensional monitoring terminal includes pyro-infrared and/or sensory radar detects that someone is approaching, wakes up the horizontal camera to monitor human activities; at the same time, the microphone monitors whether there is a sound of sawing wood or a tilt sensor Detect the inclination of trees and send an alarm to the system; periodically collect tree circumference sensor data, soil nutrition sensor data, and sky camera data to analyze the growth of trees; 4 Input sensor data into the deep learning engine, and after a large amount of data training, get the environmental quality Enhancement value, NOVI data, tree value data, carbon sink data, etc.

The tree multi-dimensional monitoring terminal provided by this disclosure: in addition to detecting the inclination of the main trunk, it can also expand the monitoring of multiple branch inclinations, and the extended detection supports low power consumption and short-term alarm functions; in addition to supporting conventional tree circumference detection, a sky camera is added, through. The AI algorithm identifies the development of tree branches and leaves, and can analyze the lighting conditions of trees; the soil nutrition sensor and meteorological sensor can be expanded, so that the growth conditions of trees can be analyzed based on multi-dimensional data; pyro-infrared and radar sensors are used to identify human activities, captured by horizontal cameras Tree destruction behaviors, such as deforestation, can also be used to identify wild animals; low-power microphones are used to monitor tree illegal logging, such as recognizing the sound of sawing trees and the sound of trees falling to the ground; through sensor data, tree type data, forest grid Do AI analysis of data and image information, and then use the deep learning engine to mine more data, such as carbon sink data, forest value data, tree growth data, etc.; Excavation and deduction to obtain information on tree status, illegal felling, etc.; tree metabolism will generate and maintain a weak potential difference between the trunk and the soil, and power the equipment by collecting this voltage signal.

The tree multi-dimensional monitoring terminal provided by this disclosure has the following advantages: rich in data, can obtain data such as inclination angle, tree circumference, image, sound, human body activity, etc.; Deduce whether there is illegal logging, early warning; low power consumption, low maintenance cost.

### T1-10-10—Emergency Crashable Non-Destructive Barrier Gate System.

When the conventional gate is not authorized and opened, the accidental collision or forced passage of the vehicle will damage the brake lever and the vehicle, resulting in losses. Some barrier gates are unattended and cannot be opened in time when they need to be opened urgently. For example, firefighters and ambulances cannot pass through smoothly, which affects rescue. There are frequent accidents of people being injured when passing through the barrier gate, such as when the barrier gate is opened when crossing over or from the side, and when the barrier gate is opened, people are smashed from below.

In order to solve at least one of the above technical problems, such as avoiding personal injury when the barrier gate is opened, an embodiment of the present disclosure provides an emergency crashable and non-damaging barrier gate system, which can be applied to the entrances of residential quarters, shopping malls, parks, parking lots, etc. brake.

As shown in FIG. 10-1, the barrier system includes gate fixed base, gate main body (including sound and light alarm, display screen, angle detection sensor, rotation and damping parts, control board, brake lever control parts, etc.), brake lever, camera, etc. The gate fixed base is the integral fixed part of the gate and is fixed on the ground. The main body of the gate includes sound and light alarms, display screens, angle detection sensors, rotation and damping components, control panels, brake lever control components and other components. The main body of the gate and the fixed base can rotate relative to each other, and there is a certain damping. It can be automatically positioned when it is rotated at a small angle, and it can be self-locked after a large angle of rotation. The surface of the brake lever is covered with a flexible material, which will not cause damage to itself and the collision object when it is subjected to a general collision. The two cameras are used for license plate recognition and abnormal capture respectively.

The barrier gate system provided by the embodiment of the present disclosure can be applied to the architecture shown in FIG. 1, for example, it can be used as the sensing terminal shown in FIG. 1, and the barrier gate system can send the collected data to other sensing terminals, gateways/Base stations, servers and other equipment, and the barrier gate system itself has edge computing capabilities, which can realize local decision-making, and can better support the operation of multi-mode heterogeneous Internet of Things. In addition, the barrier gate system provided by the embodiment of the present disclosure can also be applied to FIG. 1A, FIG. 1B, FIG. 1C and FIG. 1D (that is, FIG. 1A-ID), for example, it can be used as the sensing terminal shown in FIG. 1A-ID. The collected data can also be sent to other sensing terminals, gateways/base stations, servers and other devices, and has edge computing capabilities, which can realize local decision-making and better support the operation of multi-mode heterogeneous Internet of Things.

The barrier gate system provided by the embodiment of the present disclosure is the same as the common barrier gate system. During normal operation, the barrier gate can recognize the license plate and open automatically. The barrier gate at the exit can be associated with the toll system, and can also receive remote commands to open for emergency passage. When the brake lever is not opened, if a car, tricycle, bicycle or pedestrian collides with the brake lever, the flexible surface of the brake lever will avoid collision damage Rotation angle, exceeding a specific angle generates an alarm signal. The alarm signal is used to turn on the sound and light alarm, send out voice prompts, turn on the camera to capture video, report to the management system, etc. When the rotation angle of the gate body is small, it will automatically recover, and when it exceeds a certain angle, it can lock the position, which is used to ensure the efficient passage of multiple vehicles in emergency situations. The gate is equipped with a recovery device that can be unlocked. As shown in FIG. 10-2, when the water curtain is used instead of the brake lever, the water pump is turned on to send water pressure to the sprinkler irrigation, and multiple nozzles are sprayed to form a barrier water curtain. There is a nozzle light at the nozzle, which emits a red light to indicate that the water curtain is opening. When it is necessary to release, stop the water pump, and the nozzle light will light up green to indicate the passage. When the water curtain needs to be turned on, the nozzle flashes red, and the water pump is turned on slowly. The falling water of the water curtain is recycled by the recycling device for reuse. The falling water point is equipped with a falling water detection sensor to detect that the falling water is blocked. When it is necessary to pass in an emergency, vehicles and pedestrians can directly rush through the water curtain, and the sensor at the falling point will generate an alarm signal when it detects unauthorized entry and exit. The barrier gate system provided by the embodiments of the present disclosure can withstand a certain level of impact, and the gate machine and the gate lever can rotate relative to the base as a whole. The rotation has a suitable damping coefficient, so that the rotation process will not damage any parts. When emergency passage is required, the brake lever can be pushed horizontally by hand or by the front of the car. It can be self-locked when it is pushed to a larger opening angle, and it can automatically return to its position when the impact angle is relatively small when the brake lever is accidentally hit. Equipped with a collision angle recognition sensor, an alarm angle threshold can be set. When a small-angle collision is detected, no alarm will be triggered. An alarm will be triggered if the alarm angle threshold is exceeded. Sound and light alarms and voice prompts will be turned on, and alarm information will be sent to the system. When a collision is detected, the capture camera can be triggered to capture on-site pictures as records and evidence. Optionally, the remote control switch is rotated at a large angle, which is suitable for passing general vehicles. The small angle of rotation cannot be turned off to accommodate accidental bumps. As a low-cost solution, for small-angle collisions, only the brake lever has a certain buffer tolerance, which can identify the collision and generate an alarm signal. As an example, the material of the brake rod has toughness, and the surface has a flexible material, so as to reduce or avoid damage to the brake rod itself and the impacting objects. As an alternative, use water curtain barriers. The water curtain barrier has only weak blocking characteristics, and it can pass freely when it is necessary to pass in an emergency. The water curtain is not destructive, and there is no damage problem in general collisions, and the blocking effect of the water curtain barrier on people is better than that of ordinary barriers.

The barrier gate system provided by the embodiments of the present disclosure can effectively reduce the probability of the barrier gate being damaged compared with conventional barrier gates. Compared with conventional barrier gates, it can avoid time delays when unattended or emergency passage is required. Effectively reduces the probability of brake lever injury.

### T1-11-11—AI-Based Drowning Recognition and Automatic Rescue System.

Falling into the water mainly depends on the direct rescue of personnel, which is very dangerous, the way of throwing the life buoy cannot be thrown in place for those far from the shore, and the purpose of rescue cannot be achieved Remote control lifeboats in water areas need to be thrown into the water manually and controlled by remote control, but non-trained personnel are not familiar with the method of use and may miss the best rescue time. There is a solution to identify falling into the water through the camera, but the identification and rescue systems are independent, resulting in slow response time and requiring the participation of on-site personnel.

In order to solve at least one of the above problems, for example, in order to prevent missing the best rescue time, an embodiment of the present disclosure provides an AI-based drowning recognition and automatic rescue system, which can be applied to river banks, dams, seaside, ditches, etc. The scene of falling into the water and rescue in time.

The AI-based falling-in-water recognition and automatic rescue system provided by the embodiments of the present disclosure can be applied to the architecture shown in FIG. 1, for example, it can be used as a sensing terminal shown in FIG. 1, sending the collected data to other sensing terminals, gateways/base stations, servers and other devices, and the AI-based drowning recognition and automatic rescue system itself has edge computing capabilities, can realize local decision-making, and can better support multi-mode heterogeneity operation of the Internet of Things. In addition, the AI-based drowning identification and automatic rescue system provided by the embodiments of the present disclosure can be applied to FIG. 1A, FIG. 1B, FIG. 1C and FIG. 1D (ie, FIG. 1A-ID). The sensing terminal produced by the system can also send the collected data to other sensing terminals, gateways/base stations, servers and other devices, and has edge computing capabilities, which can realize local decision-making and better support the multi-mode heterogeneous Internet of Things.

As shown in FIG. 11-1, the AI-based falling-in-water recognition and automatic rescue system is a system that uses video images plus AI algorithms to recognize falling-in-water and unmanned automatic rescue, including: a main control unit, a dome camera or a panoramic camera. Remote control lifeboat, lifeboat dock, server. The main control unit includes an AI processor, a wireless communication unit communicating with the lifeboat, a wired or wireless unit communicating with the server, and a control unit. The dome camera or panoramic camera provides panoramic images for the main control unit. The lifeboat dock can charge the lifeboat, release and recover the lifeboat, receive the control of the main control unit, and send the status to the main control unit. The lifeboat has a controller, a rechargeable battery, a power system, a satellite positioning unit, a voice recognition unit, a load detection unit, and a wireless communication unit.

The embodiment of the present disclosure provides an application method for the AI-based drowning recognition and automatic rescue system: the camera dome camera or the panoramic camera continuously patrols the water surface, and uses the AI image recognition algorithm to identify whether someone has fallen into the water. The lifeboat docks at the lifeboat wharf and is fully charged automatically. The lifeboat and the main control box are connected wirelessly and are in a standby state. When a person falling into the water is detected, the main control box sends out an audible and visual alarm to remind nearby personnel to assist in the rescue, and at the same time sends an alarm message and on-site images to the server. The video AI algorithm calculates the rough position of the person who fell into the water based on the pitch angle of the current camera and the position of the person who fell into the water in the picture. Release the lifeboat. The lifeboat has satellite positioning function and can report its own position to the main control unit. The main control unit calculates the best driving route to control the lifeboat to the landing point. It is also possible to send the position of the falling point to the lifeboat, and the lifeboat will calculate the path to the falling point by itself. The camera continuously tracks the position of the person who fell into the water and sends it to the lifeboat. Since the AI algorithm may deviate from the satellite positioning position, when the lifeboat and the lifesaving target are relatively close, the camera uses the AI algorithm to identify the distance and relative direction between the two, and control the lifeboat as close to the target as possible. The lifeboat has a load detection function. When it is detected that the person who fell into the water has grasped the back of the boat, the lifeboat will drag the person who fell into the water to move to a safe area. The lifeboat is equipped with a speaker and a microphone, and the person who falls into the water is prompted to issue control commands through voice, for example: “The lifeboat supports voice control, you can issue the following commands: forward, stop, turn left, turn right, if you do not issue control, the lifeboat will sail to the default Landing point”, the person who fell into the water said “forward”, the lifeboat moved forward, and other commands were similar.

The AI-based falling-in-water recognition and automatic rescue system provided by the embodiments of the present disclosure: patrols the water area through a camera dome camera or a panoramic camera, and uses an AI algorithm to identify whether someone has fallen into the water. Calculate the rough position of the landing point through the cruise pitch angle of the camera dome camera or panoramic camera and its own latitude and longitude. The automatic lifeboat and the main control unit are connected wirelessly, and through the satellite positioning data and AI image recognition of the lifeboat, the main control unit controls the lifeboat to approach the drowning person infinitely. The lifeboat dock can charge the lifeboat, and can automatically throw and recover the lifeboat. The lifeboat is equipped with a load detection sensor, which can identify whether the person in the water has caught the lifeboat. The main control unit controls the lifeboat to sail to the landing point; the lifeboat is equipped with a horn and a microphone, and the person in the water is prompted to issue control commands through voice.

Due to the support of automatic rescue, the dependence on personnel is reduced, and the safety of those who fall into the water and the rescuers is improved. Automatic drowning recognition and rescue are effectively connected and coordinated, which shortens the rescue time and greatly improves the success rate of rescue.

### T1-12-12—Weak Blocking Type Gate System for Water Accumulation.

When the road is flooded, driving through forcibly will cause the engine to stall and be trapped, which will seriously cause casualties. The existing system detects the water depth and reminds passing drivers through LED display screens and sound and light alarms. However, in heavy rain, drivers may not pay attention to the danger warning, and some drivers know the danger but are lucky enough to pass by. The purpose of interception can be achieved by using ordinary barriers, but there may be a possibility that the vehicle will not stop and crash into the barriers in time, and once a crisis occurs, the barriers will affect rescue. Another problem is that ordinary barrier gates are relatively large and are not suitable for installation on both sides of the road.

In order to solve at least one of the above problems, for example, in order to increase the interception capacity of the road gate, the embodiment of the present disclosure provides a weak blocking water curtain type road gate system, which can prevent vehicles or people from forcibly Passing causes danger. As shown in FIG. 12-1, the weak blocking water curtain gate system includes submersible pump, water filtration device, dyeing agent adding device, water curtain projector, nozzle, nozzle, display screen, broadcast speaker, water accumulation sensor, smart terminal, smart camera.

The weak blocking water curtain road gate system provided by the embodiment of the present disclosure can be applied to the architecture shown in FIG. 1, for example, it can be used as the sensing terminal shown in FIG. 1. The data sent to other sensing terminals, gateways/base stations, servers and other devices, and the weak blocking water curtain barrier system itself has edge computing capabilities, can realize local decision-making, and can better support the multi-mode heterogeneous Internet of Things run. In addition, the weak blocking water curtain road gate system provided by the embodiments of the present disclosure can also be applied to FIG. 1A, FIG. 1B, FIG. 1C and FIG. 1D (ie FIG. 1A-ID), for example, as shown in FIG. 1A-ID The sensing terminal can also send the collected data to other sensing terminals, gateways/base stations, servers and other devices, and has edge computing capabilities, which can realize local decision-making and better support the operation of multi-mode heterogeneous Internet of Things.

The submersible pump pumps the accumulated water on the road to the sprinkler irrigation. Before the accumulated water enters the pump, it passes through the water filter device to remove large impurities. During the process, the dye adding device will automatically add dye. Sprinkler irrigation delivers water to each nozzle, and the nozzles at different positions have different internal diameters and angles to form a complete water curtain. The water curtain projector is used to project warning signs and text to the water curtain. In order to reduce the cost, it is preferable to use fixed content and increase the warning effect through flashing. Display screens and broadcast speakers are used to provide alerts. Waterlogging sensors can detect the depth of waterlogging on the current road surface, smart cameras are used to collect on-site images, smart terminals collect and process water depth data and image data, and can push data to the server and receive server control. Referring to FIGS. 12-1 and 12-2, the embodiment of the present disclosure provides a method of using a weak blocking water curtain type road gate system, the water depth sensor and the camera detect the water accumulation on the road in real time, when the water accumulation is shallow and safe, the LED display and radio speakers display the current depth of water accumulation and prompt to pass slowly, when the water accumulation is deep and passage is dangerous, the LED display and broadcast speakers prompt information such as dangerous water depth, please do not pass; start the submersible pump to form a. The water curtain prevents the passage of vehicles and pedestrians. The water curtain projector can project warning icons or words such as prohibition of passage to the water curtain to increase the warning effect. The intelligent terminal sends on-site data and images to the service and receives control commands issued by the service, on-site. The camera continuously monitors the real road conditions, and uses AI algorithms to identify vehicle traffic conditions and whether vehicles and pedestrians are trapped Once a crisis situation occurs, high-priority alarm information is sent to the server, and the depth of road water and the direction of water flow can also be monitored through video AI algorithms, etc.; because the water curtain does not have strong blocking characteristics, it will not cause damage to the vehicle when the vehicle is too late to stop, and special vehicles such as emergency rescue can pass through the water curtain directly when they need to pass. When the depth of accumulated water drops to a safe level, stop the water pump and change the warning content such as the LED screen. As shown in the right picture of FIG. 12-2, another form of water curtain is shown here. A horizontal beam acts as a spray pipe, and water falls from the upper beam.

The embodiment of the present disclosure provides a weak blocking water curtain road gate system to prevent vehicles from passing through, even if the vehicle accidentally collides and does not cause damage to vehicles and personnel, and does not affect normal rescue; use projection lamps to project warning text Or patterns on the water curtain; add lights to the spout, add environmentally friendly dyes during the water spraying process, and increase the barrier feeling of the water curtain; use a water depth sensor to detect the water depth in real time.

A weak blocking water curtain road gate system provided by the embodiment of the present disclosure; it solves the problem of only monitoring but not controlling the waterlogged road. The conventional solution only monitors the water depth, provides simple display and broadcast prompts, and does not have the ability to prevent pedestrians and vehicles from passing through. The water curtain projection enhances the warning ability, and the water curtain increases the interception ability; the water curtain device is small in size, easy to install, and uses local materials to directly use the accumulated water on the road to form a water curtain. Rescue vehicles, ambulances and other vehicles can still pass through forcibly in emergency situations without causing any damage.

### T1-13-13—Global Water Quality Detection System.

The existing water quality system monitoring methods are single and have a low degree of integration, the degree of automation monitoring is low, and manual operations are still required, the calculation and analysis data is not timely, and the reliability is low, so it cannot be verified in time; most of the system is installed at fixed points, such as shore Side fixed stations and floating stations cannot do refined and customized sampling, and the cost is high; it is impossible to conduct refined sampling of the water quality in the whole basin, and the pollution source cannot be accurately located only through the data of concentration and flow.

In order to solve at least one of the above problems, for example, in order to improve the accuracy of water quality system monitoring, an embodiment of the present disclosure provides a global water quality detection system, which can be applied to river sewage outlets, tributary inflows, and entire river basins, etc. for River sewage traceability, evidence collection, etc. assisting in the investigation of illegal and disorderly discharges. As shown in FIGS. 13-1 and 13-2, the water quality detection system includes: shore station, floating station, water quality unmanned ship, hydrological camera, river velocity and flow meter, etc. Among them, the shore station: used to monitor and analyze water quality and detect the concentration of pollutants; floating station: powered by solar energy, equipped with electrodes and hyperspectral for water quality detection; hydrological camera: can detect abnormal river sewage discharge in real time; flow velocity meter: monitor river flow velocity and flow Abnormal, unmanned ship: automatic cruise, fixed-point detection and sampling.

The global water quality detection system provided by the embodiment of the present disclosure can be applied to the architecture shown in FIG. 1, for example, it can be used as the sensing terminal shown in FIG. 1, and the global water quality detection system can send the collected data to other sensing terminals. Gateway/base station, server and other equipment, and the global water quality detection system itself has edge computing capabilities, which can realize local decision-making, and can better support the operation of multi-mode heterogeneous Internet of Things. In addition, the global water quality detection system provided by the embodiments of the present disclosure can also be applied to FIG. 1A, FIG. 1B, FIG. 1C and FIG. 1D (that is, FIG. 1A-ID), for example, it can be used as the sensing terminal shown in FIG. 1A-ID, can also send the collected data to other sensing terminals, gateways/base stations, servers and other devices, and has edge computing capabilities, which can realize local decision-making and better support the operation of multi-mode heterogeneous Internet of Things.

Exemplarily, a working scenario of the water quality detection system is as follows: the shore station and the floating station monitor the pollution in the area, and send an early warning to the system; at the same time, the hydrological camera performs real-time identification and evidence collection; the unmanned ship automatically cruises the polluted area Carry out water quality sampling and analysis; the flow rate meter judges the early warning of sneak discharge and pollution arrival through the measured flow rate.

The global water quality monitoring system provided by the embodiments of the present disclosure, in terms of detection methods and means, integrates multiple monitoring means into one system to improve the accuracy and reliability of system monitoring; the system has conventional water quality stations, floating stations, hyperspectral, remote sensing UAV and water quality unmanned ship, also equipped with hydrographic camera identification; mobile sampling ship has power system, satellite positioning system, water depth sensor, can sail to the designated place according to needs; sampling ship can automatically return when the power is low, and The special dock is equipped with automatic charging and solar charging function; the sampling ship has the function of automatic driving, with the help of radar, camera and other sensors plus deep learning algorithm, it can realize functions such as automatic avoidance and obstacle detour; the sampling ship has its own conventional water quality detection sensor to monitor the water quality. On-line detection; equipped with an acquisition system that can store multiple water samples for more parameter testing in the laboratory, the water sample acquisition system has the function of deep water sampling, and can sample water at different depths through the retractable water sampling head; the system has artificial Intelligent algorithm, according to the data of sensing equipment (water quality station, floating station, hyperspectral, remote sensing UAV, hydrology, camera, etc.), calculates the possible occurrence point of pollution source, and automatically controls the sampling ship to sail to the designated place for accurate sampling and positioning of pollution source.

Based on the global water quality monitoring system provided by the embodiments of the present disclosure, the technical effects that can be achieved include, fast traceability, a variety of methods are integrated to trace the source of pollution, which is convenient for quickly locating pollution sources, and sampling and evidence collection; low cost: using unmanned ships and shore. The combination of side stations and floating stations reduces the construction of fixed stations and lowers the cost; automation, when pollution occurs, the system automatically calculates the pollution location and automatically controls surrounding sensing devices, such as unmanned ships and drones, for on-site monitoring and sampling, it can automatically return to home when it is finished. Energy saving and environmental protection: the acquisition and measurement equipment can be powered by solar energy, reducing external power supply and achieving energy saving effects.

### T1-14-14—Water Level Bucket Support Technology.

The current water quality sensor (water collection system) cannot collect water normally when the water volume increases sharply.

In order to solve at least one of the above problems, for example, to ensure that water can still be harvested normally when the water volume increases sharply, as shown in FIG. 14-1, an embodiment of the present disclosure provides a water level water harvesting bucket, including, a bucket fixing frame, a diagonal brace fixing Rod, expansion screw. Among them, the fixed frame of the bucket is used to fix the fixed frame of the bucket; the diagonal brace fixing rod is used for supporting and fixing with steel fixing steel, the expansion screw is used for fixing the expansion screw.

The water level water collection bucket provided by the embodiment of the present disclosure can be applied to the architecture shown in FIG. 1, for example, it can be used as the sensing terminal shown in FIG. 1, and the water level water collection bucket can send the collected data to other sensing terminals, gateways/Base stations, servers and other equipment, and the water level bucket itself has edge computing capabilities, which can realize local decision-making, and can better support the operation of multi-mode heterogeneous Internet of Things. In addition, the water level water collection bucket provided by the embodiment of the present disclosure can also be applied to FIG. 1A, FIG. 1B, FIG. 1C and FIG. The collected data can also be sent to other sensing terminals, gateways/base stations, servers and other devices, and has edge computing capabilities, which can realize local decision-making and better support the operation of multi-mode heterogeneous Internet of Things.

In related technologies, whenever it rains heavily, the water volume at the point increases sharply, and the water flow is too large, causing the water quality sensor (water collection system) to collapse, the submersible pump to be damaged, and the water collection bucket to be knocked apart. At present, steel structure fixing and stainless steel wires are not used in the deployment process of water quality sensors. However, the water level water collection bucket provided by the embodiment of the present disclosure can be kept in a fixed area according to the site conditions and the water flow is very fast, and it is also convenient for maintenance and can be manually lifted. In addition, by inserting the stainless steel structure into the ground and using steel bars to form a fence, it can ensure that the water harvesting bucket can move in this area. And use steel wire ropes at both ends for support, stick to the second line of defense.

The water level water collection bucket provided by the embodiment of the present disclosure can ensure that the water quality sensor (water collection system) can take water samples normally when the water volume increases sharply.

### (2) Communication Layer, Including Technologies Numbered C1 to C2.

The communication layer can be understood as the root of the tree, which is the bridge connecting the tentacles and the trunk of the tree. The communication layer uploads the sensing, control, status and other information of the tentacles to the support layer (trunk of the big tree) through wireless/wired means.

As shown in FIG. 1, the communication layer C1 is a multi-mode heterogeneous intelligent Internet of Things composed of base stations and gateways. It dynamically adjusts any communication parameters according to industry requirements or/and physical locations to establish a network. Besides mainstream communication modes, it also includes advanced networking methods such as Mesh, relay, and SDN, providing network support for fixed-mobile convergence, broadband, medium and narrowband integration, and voice/video/text converged communication for the terminal layer.

The base station covers a variety of communication networks such as satellite, private network, WLAN, bridge, public network, multi-mode heterogeneous network, etc. and dynamically adjusts any communication parameters according to industry requirements or/and physical location to establish a network. For example, it supports data splitting and aggregation for multi-path transmission. Different strategies are adopted according to needs during multipath transmission. For example, when the equipment in the blind area cannot be directly connected to the base station, a mesh network can be established with other equipment, and uplink communication can be realized with the help of equipment that can be connected to the base station. The device can be switched between the star network and the mesh network; when working in the mesh network mode, the terminal can be used as a routing node or a normal node. It supports point-to-point intercommunication between devices, reducing the bandwidth occupation of the base station. The core network and the base station can collect the link information of the base station, routing node, and terminal, including communication standard, communication path, signal-to-noise ratio, packet loss rate, delay, channel occupancy rate and other information, and it is better to do link prediction and deduction through deep learning Solution, adaptive adjustment of device connection mode (direct connection to base station, mesh network, point-to-point), transmission path (single path, multi-path), radio frequency parameters on demand (bandwidth, response time, reliability, connection distance, etc.) (Modulation mode, rate, spectrum occupancy, receiving bandwidth). Gateways include different types of edge AI, security, positioning, video, mid-range communication, CPE, RFID, technical detection, etc. which can realize network interconnection with different high-level protocols, including wired and wireless networks, and dynamically adjust according to industry requirements or/and physical locations any communication parameters.

The implementation manner of the communication layer in the embodiments of the present disclosure will be described in detail below in conjunction with exemplary embodiments.

### C1-1-15—Smart Multimode LPWA Gateway.

In related technologies, the networking mode is single, such as wireless connection mode: Lora, Wifi, Bluetooth, Zigbee, etc. or, for example, wired connection mode: Ethernet, RS485, RS232, etc. generally only includes one or two ways of one mode, the limitations are relatively large, and the scalability is poor. It does not have server functions, mainly based on data transparent transmission, cannot store data and decision-making offline, and cannot synchronize data with the server. Without edge computing capabilities, data cleaning and computing decisions cannot be made, and normal use will not be possible if the network connection is lost. It does not have multimedia expansion functions, such as human-computer interaction, audio and video input and output, and the user experience and expansion functions are poor.

In order to solve at least one of the above problems, for example, to improve the diversity and flexibility of networking modes, an embodiment of the present disclosure provides a multi-mode gateway, as shown in FIG. 15-1, the multi-mode gateway: supports multiple terminals in local connections in multiple connection modes, local terminals in different connection modes have independent identification numbers, manage and communicate like normal terminals; uplink connections support multiple channels such as cellular network, Ethernet, wifi, etc. Configure different priorities, and single-channel failures can be freely switched to other channels, with edge computing framework functions, edge computing functions can be configured arbitrarily, and data cleaning, aggregation, calculation, and decision-making can be realized locally, and decisions can be directly delivered locally for command to the specified terminal.

The multi-mode gateway provided by the embodiment of the present disclosure can be used as a gateway and/or a base station in the architecture diagram shown in FIG. 1. Technical investigation gateway, RFID gateway, and/or multi-mode heterogeneous gateway, etc. or mobile station, private network base station, WLAN base station, bridge, ground station, public network base station, and/or multi-mode heterogeneous base station, etc. The multi-mode gateway provided by the embodiment of the present disclosure can also be used as the gateway/base station shown in FIG. 1A, FIG. 1B, FIG. 1C and FIG. 1D (ie, FIG. 1A-1D), and the gateway/base station has edge computing/fog computing capabilities, can realize local decision-making, and the gateway/base station also supports multi-mode heterogeneous networking.

In the embodiment of the present disclosure, the multi-connection mode includes LPWA mode, Ethernet, Wifi, and other wired connections such as RS485, RS232, analog, etc extended through the gateway motherboard and wireless connections such as Bluetooth, Zigbee and private wireless communication.

In the embodiments of the present disclosure, the multi-mode gateway provided by the embodiments of the present disclosure can be applied to wide-area data collection, such as forestry fire monitoring, smart agriculture, electric power and other outdoor wide-area networking, which can realize long-distance data transmission. Power supply, to solve the problems of wide-area wiring difficulties, signal transmission obstacles, and power supply difficulties; at the same time, it can also be applied to local area data collection: such as residential environment, energy consumption data monitoring, industrial area networking, indoor networking, etc. can provide local area network, Bluetooth, WiFi, zigbee and other short-distance wireless networking, and can also provide reliable networking methods such as wired RS485 to ensure the diversity and flexibility of networking methods.

The multi-mode gateway provided by the embodiments of the present disclosure has the function of an LPWA network server, can maintain normal communication when the network is disconnected, and can automatically synchronize status and data with the server after being connected to the network.

In the embodiment of the present disclosure, the multi-mode gateway can be configured with a display screen, which can directly display system status and data reports, etc. provide user interaction functions, and also provide camera and audio input functions to realize multimedia applications.

In the embodiment of the present disclosure, as shown in FIG. 15-1, in the multi-mode gateway provided by the embodiment of the present disclosure: the wired connection networking is mainly based on RS485, RS232, analog signal, cable network, etc. mainly for short-distance Reliable communication, anti-jamming; WiFi, zigbee. Bluetooth and other short-distance wireless communication are the main wireless connection networking, and Lora is the main wireless wide-area networking, with long communication distance and low power consumption, integrated edge computing to realize data cleaning, calculation, storage, decision-making and other services; multimedia to realize human-computer interaction, touch, audio, video; uplink communication can choose cellular. Ethernet, WiFi, etc.

The multi-mode gateway provided in the embodiment of the present disclosure has simple networking and improved flexibility, which reduces the cost of development, deployment, and operation and maintenance; it not only provides low-power wide-area technology networking, but also provides local area technology networking, which can High selectivity, strong compatibility, and more complete functions; can provide edge computing services, realize data cleaning, calculation, storage, and decision-making, and can also run offline; can realize touch-screen human-computer interaction, audio and video input and output, entertainment and experience are enhanced.

C1-2-16—Multi-mode heterogeneous IoT network and sensing system.

In related technologies, the sensing layer and transmission layer of the Internet of Things are independent, and information sharing and collaborative work between sensing terminals, sensing devices and network devices cannot be achieved, and the transmission network and resource allocation cannot be optimized according to data transmission needs. In addition, in related technologies, terminals have certain edge computing functions, but the data used by edge computing is generally limited to a single terminal, and data cannot be shared between multiple terminals and gateways, resulting in limited data coverage of edge computing.

In order to solve at least one of the above-mentioned problems, for example, in order to improve the utilization rate of network resources, an embodiment of the present disclosure provides a multi-mode heterogeneous Internet of Things network and a sensing system, which is a sensing and multiple sensing system suitable for the Industrial Internet of Things. The modular heterogeneous transmission system can be used in related industries such as smart cities, environmental protection, forest fire prevention, and emergency smart dispatching.

The multi-mode heterogeneous Internet of Things network provided by the embodiments of the present disclosure can be used as a connection network between a terminal and a gateway/base station in the architecture diagram shown in FIG. 1 or FIG. 16-3. For example, as shown in FIG. 1, sensing terminals (such as gate access control, multi-mode heterogeneous MESH terminals, satellite terminals, cameras, water conservancy terminals, etc.) Network base stations, etc.) can be connected through the multi-mode heterogeneous Internet of Things network provided by the embodiments of the present disclosure, so as to realize data transmission. At the same time, the multi-mode heterogeneous Internet of Things network provided by the embodiments of the present disclosure can also be used as the architecture diagram shown in FIG. 1, between terminals and terminals, between gateways/base stations and gateways/base stations, between terminals and servers, gateways/The connection network between the base station and the server. In addition, the multi-mode heterogeneous Internet of Things network provided by the embodiments of the present disclosure can also be used as a connection between the terminal and the gateway/base station, between the terminal and the terminal as shown in FIG. 1A, FIG. 1B, FIG. 1C and FIG. 1D (ie, FIG. 1A-ID), between gateways/base stations and gateways/base stations, between terminals and servers, and between gateways/base stations and servers.

FIG. 16-1 shows a diagram of a multi-mode heterogeneous communication network provided by an embodiment of the present disclosure, and FIG. 16-3 shows a multi-mode heterogeneous communication network provided by an embodiment of the present disclosure in a multi-mode heterogeneous Internet of Things an application scenario. The multi-mode heterogeneous Internet of Things network and sensing system provided by the embodiments of the present disclosure support data splitting and aggregation of multi-path transmission. For example, the terminal splits the data packet to be sent into multiple data packets, and the multiple data packets sent to the receiving end through different communication methods and different paths, and spliced into complete data after gathering at the receiving end. In FIG. 16-1. Terminal 1 has a multi-mode communication mode, and can simultaneously connect to three base stations of different standards, namely Base Station 1. Base Station 2, and Base Station 3. When transmitting data, the three base stations transmit data at the same time, and perform data aggregation on the server side.

In an embodiment of the present disclosure, different strategies may be adopted during multipath transmission according to needs. For example, take terminal 1 as an example: a) multiple consecutive data packets are transmitted sequentially through different paths to increase robustness, data packet 1 is transmitted through path 1, data packet 2 is transmitted through path 2, and data packet 3 is transmitted through path 3, b) The data packet is split into multiple data packets, which are transmitted in parallel through different paths to increase network bandwidth. For example, subpacket 1 is transmitted via path 1, subpacket 2 is transmitted via path 2, subpacket 3 is transmitted simultaneously via path 3, then subpacket 4 is transmitted via path 1, subpacket 5 is transmitted via path 2, and subpacket 6 is transmitted via path 3.

Simultaneous transfers, and so on, c) The same communication packet is transmitted redundantly through different paths to increase reliability. For example, if the same data packet is transmitted simultaneously through path 1, path 2, and path 3, only one packet needs to be received by the server.

In an embodiment of the present disclosure, when devices communicate with each other, a connection may be established through a base station or directly without bridging through a base station, thereby reducing the bandwidth occupation of the base station. In FIG. 16-1, the connection between terminal 3 and terminal 4 and the base station is not smooth, and the two can directly establish a point-to-point connection.

In an embodiment of the present disclosure, when a device in a blind area cannot be directly connected to a base station, a mesh network can be established with other devices, and uplink communication can be realized by means of a device that can be connected to a base station. The device can be switched between the star network and the mesh network; when working in the mesh network mode, the terminal can be used as a routing node or a normal node. In FIG. 16-1 terminal 6 and terminal 7 establish a mesh network between terminal 5, terminal 2 and terminal 8, and connect to the base station through terminal 5 and terminal 8. Terminal 5. Terminal 2 and Terminal 8 undertake routing functions.

In an embodiment of the present disclosure, the core network and the base station can collect the link information of the base station, routing node, and terminal, including: communication standard, communication path, signal-to-noise ratio, packet loss rate, delay, channel occupancy rate, etc. through depth Learn to do link prediction and deduce better solutions, and adaptively adjust the connection mode (directly connected to the base station, mesh network, point-to-point) and transmission path (single path, multipath), radio frequency parameters (modulation mode, rate, spectrum occupation, receiving bandwidth). FIG. 16-2. Communication resource coordination diagram shows a method to achieve network coordination only by adjusting power and rate. The higher the power, the farther the transmission distance, but the larger the signal coverage area during the transmission process, the more likely it will affect other nearby terminals. The higher the rate, the shorter the communication time, which occupies less frequency resources, but the communication distance is closer. In FIG. 16-2, base station 1 is busy with many devices connected to it, while base station 2 is relatively idle with few devices connected to it. In order to reduce the busyness of base station 2, terminal 2 and terminal 4 adopt high-power and high-speed transmission, and the transmission process may affect the base station 2 has an impact, because the base station 2 is relatively idle and can accept this impact. Terminal 3 and terminal 5 transmit through base station 2 with low power and low rate as far as possible, without affecting the work of base station 1. Terminal 1 can only transmit at high power and low rate due to its long distance, while terminal 6 is close enough to the base station to transmit at low power and high rate. In one embodiment of the present disclosure, as shown in FIG. 4-2, multi-layer domain-divided edge computing, terminals, gateways, and servers can all be used as computing executors. According to different sensing and execution coverage circles, they can be divided into different types of edge computing layer. Both the server and the gateway can send down commands to modify configuration and execute commands; the execution status and results can be synchronized to the outer gateway and server.

In one embodiment of the present disclosure, as shown in FIG. 4-2, the IoT layer 1 is a single terminal, which has its own sensing and execution equipment, acquires data from sensors by itself, analyzes the data, and then generates driving commands to start execution actions and communicate. This process can be executed by itself when there is an exception; IoT layer 2 means that adjacent terminals communicate with each other (not through a gateway) to share sensor data and convey execution commands. One of the terminals is responsible for executing the edge computing process as the core terminal; the Internet of Things layer 3 represents the case where gateways participate, and the gateway is the main body of edge computing, sensor data and executing commands to cover the devices covered by the gateway, the Internet of Things layer 4 represents the situation of multiple gateways, one of which is the main gateway, and the devices come from devices covered by multiple gateways; the IoT layer 5 represents the server level, which is aimed at a project or a subsystem of a project; the IoT layer M represents the edge computing level of mobile ad hoc network devices. Mobile devices may be connected to mobile gateways and fixed gateways, and may also be connected to nearby terminals to obtain nearby sensor data. Of course, execution commands can also be issued directly to terminals.

The multi-mode heterogeneous Internet of Things network provided by the embodiments of the present disclosure, on the basis of star network, supplements relay, mesh network and point-to-point communication, improves the coverage of network blind areas; supports path prediction, and realizes multi-path Data splitting and aggregation functions; adopt communication resource and communication standard coordination mechanism, can dynamically change wireless modulation mode, transmission power, rate and other parameters according to the current network status to achieve the optimal utilization of coverage distance and channel resources; use sensing and communication coordination. The mechanism coordinates communication based on the sensing result data, and coordinates the sensing sampling strategy based on the communication state; builds a layered data sharing and domain-based edge computing system, and data can be transmitted/shared between devices and gateways as needed.

The multi-mode heterogeneous network provided by the embodiments of the present disclosure realizes ubiquitous, dynamic, and real-time effective communication, improves spectrum utilization rate and network resource utilization rate, and increases network coverage capability and coverage performance. Among them, ubiquitous mainly refers to widespread and ubiquitous networks. It is impossible for operator networks to achieve ubiquity based on their profitable nature. However, multi-mode heterogeneous IoT can be built according to location and needs, that is, it can be deployed at the required location. Corresponding multi-mode heterogeneous base stations. For example, in Daxing'an Mountains, there is almost no operator network coverage in the forest area, and it is impossible to achieve large-scale deployment of operator networks. However, multi-mode heterogeneous base stations can be deployed to cover target areas. According to business needs, communication needs and Low cost requirements, a single base station requires a large coverage area (corresponding to a longer communication distance), and the base station group only provides limited overall bandwidth. Secondly, dynamic means that the network is dynamically changeable. According to industry requirements or/and physical location, dynamically adjust any communication parameters to establish a network. In addition to mainstream communication modes, it also includes advanced networking methods such as Mesh, relay, and SDN. Finally, real-time refers to the delay of communication. Real-time is relative. In different communication scenarios, real-time delays are not the same. In order to meet the above three conditions, the concept of multi-mode heterogeneity is proposed. As shown in FIG. 1E. B is dynamically determined according to A. Among them. A includes three situations: (1) industry requirements (2) environment of terminals, gateways, and base stations (such as: time, location, task, channel, etc.) (3) conditions of terminals, gateways, and base stations themselves (such as: energy, noise, interference, etc.) B further includes data, communication, network, etc Exemplarily, in the first case, industrial industry requirements refer to the different requirements for communication in different industries. For example, the environmental protection industry has the requirements of the environmental protection industry, the safety supervision industry has the requirements of the safety supervision industry, and the water conservancy industry has the needs of the water conservancy industry. Their needs are different, that is, what they want is different. In the second case, the environment where the terminal, gateway, and base station are located refers to the physical environment, that is, the physical environment where the terminal, gateway, and base station are located, which further includes time, location, task, and channel. In the last case, the self-conditions of the terminal, gateway, and base station include the terminal, gateway, and base station's own power, sensor values, and sensor value conversion rates, and dynamically adjust parameters such as communication intervals, transmission power, and modulation methods. For example, if the battery of the terminal itself is low, the sensor value is lower than the set threshold, or the sensor value changes little, the frequency of transmission is reduced. For example, the self-conditions of the flame detection terminal installed in the Daxing'an Mountains include: low power consumption, fast response, and small amount of communication data. Further, as shown in FIG. 1E, the data, communication, network, etc. included in B are data information, communication information, and network information in the communication process. Different communication requirements require different communication strategies. For high-quality communication requirements, strategies such as data information splitting-multipath concurrency-aggregation, dynamic adjustment of communication information, and network information allocation through base station priorities can be adopted, and appropriate allocation can be performed in actual situations.

The multi-mode heterogeneous network provided by the embodiments of the present disclosure is an effective improvement and upgrade to the existing network. Through various networking methods and coordinated allocation of network resources, the utilization rate of network resources is improved, and the network capacity is increased. Coverage capability; and realize the coordination and unification of the network layer and the sensing layer, providing the sensing layer with specific requirements such as high bandwidth, low delay, and high reliability Occupation of resources; multi-domain edge computing technology allows terminals at the sensing layer to realize data intercommunication through the network, thus providing better capabilities than edge computing in related technologies.

### (3) Supporting Layer, Including Technologies Numbered R1-1 to R1-9.

The support layer provided by the embodiments of the present disclosure can be understood as the trunk of a big tree, and all data and services required by upper-layer business are provided by the support layer. The sensing, control and other data at the root of the big tree will enter the crown and each branch through the support layer. The supporting layer includes a multi-mode heterogeneous IoT sensing platform, a data intelligence fusion platform, a digital twin middle platform, an artificial intelligence industry algorithm middle platform, a converged communication middle platform and a streaming media platform.

As shown in FIG. 1, the multi-mode heterogeneous IoT sensing platform R1 is used to aggregate data at the terminal layer and communication layer to support device management at the terminal layer and communication layer, and provide dynamic adjustment of any Multi-mode heterogeneous network services and edge computing services for communication parameters.

Multi-mode heterogeneous network services not only provide separate access and management services for different network communications such as existing satellite links, cellular network links, RFID network management, LTE core network, WLAN network management, and LoRa core network; The wireless access service of the heterogeneous core network supports the integrated access and unified management of multi-mode heterogeneous wireless networks. Multi-mode heterogeneous network services provide network services that dynamically adjust any communication parameters according to industry requirements or/and physical locations, such as adjustable physical communication parameters such as source coding, channel coding, modulation model, signal time slot, and transmit power; another example, flexible scheduling, flexible expansion of wireless link access and management technology, can perform functions such as remote control, upgrade, parameter reading/modification, management, etc. support link self-healing, provide high utilization, strong stability, and easy recovery professional wireless network hosting services.

Edge computing services are used to provide dynamic and adaptive network allocation with edge computing capabilities for converged networks for accessing multi-mode heterogeneous networks. Time, different bandwidth, and different time slot networks, so that network resources can be allocated dynamically, automatically and reasonably. For example, the environmental protection industry requires thousands of sites to report data at the same time, which not only requires low latency, but also sends a high amount of concurrency at the same time, but the time interval between two reports may be as high as 1 hour or 4 hours, which requires this disclosure. The edge computing service provided by the embodiment provides support to dynamically and reasonably allocate network resources.

The implementation of the multi-mode heterogeneous IoT sensing platform of the support layer of the present disclosure will be described in detail below in conjunction with exemplary embodiments.

### R1-1-17—Multi-Mode Heterogeneous IoT Sensing Platform.

In related technologies, there is a lack of unified management of multi-mode heterogeneous devices in the Internet of Things, and integrated configuration, comprehensive management and monitoring techniques. Moreover, there is still a lack of an integrated platform for device information access, analysis, and device control in related technologies. In order to solve the problems in related technologies, embodiments of the present disclosure provide a multi-mode heterogeneous IoT sensing platform.

As shown in FIG. 1 and FIG. 17-1, R3 represents the streaming media platform, R7 represents the artificial intelligence business platform, R8 represents the comprehensive IOC of urban operations, S1 represents the blockchain security management platform, and B1 represents the cloud management platform. The multi-mode heterogeneous IoT sensing platform provided by the embodiments of the present disclosure includes: a sensing device configured to collect data, and send the collected data to the device security access service and the cellular connection. The inbound service receives and executes control commands; the camera is configured to collect real-time video equipment and upload it to the multimedia command system; the satellite is configured to collect satellite data and send the satellite data to the satellite gateway; the network element device is configured to Configured as a multi-mode heterogeneous network-related communication device, it supports the collection of communication-related parameters and uploads them to the Zabbix system; the satellite gateway is configured to support receiving satellite data, that is, based on the satellite link service to obtain satellite data from the satellite gateway; the Zabbix system is configured Configured to support access to network element devices and collect relevant parameters of network element devices; Lora NS Server is configured to access gateway devices and publish LoRa communication data and device online status data; gateway devices are configured to communicate with sensor Device communication, and can perform edge computing function, can connect with edge computing platform to obtain edge computing algorithm, and report device data and alarm data to edge computing platform; cellular network link connection service: support access to sensor device data, and send. The sensor device issues control commands and forwards them to the cached message queue Kafka; the satellite link service is configured to obtain satellite data in real time from the satellite gateway and forwards them to the cached message queue Kafka; the device security access service is configured. In order to support calling the blockchain security management platform to perform authentication operations on device access, receive sensor device upload data, network element device communication data, gateway device communication parameter data, and device online data, and support issuing control commands to devices. And forward the received sensor device upload data, network element device communication data, gateway device communication parameter data, and device online data to the cached message queue Kafka; the edge computing platform is configured to support edge computing related configurations, and the edge. The configuration information such as calculation algorithm is sent to the gateway device, the device data and alarm data reported by the gateway device are received, and forwarded to the cached message queue Kafka; the cached message queue Kafka is configured to provide data aggregation, data exchange and distribution services. Real-time data services are configured to provide verification services for the validity of real-time data and support statistical analysis services for real-time data; rule engine services are configured to provide data discrimination according to configured data alarm rules and generate alarms Information, stored in the data warehouse; LTE core services: provide LTE core network configuration, optimization, monitoring and other related services; WAN network management services are configured to provide network management services for WAN devices, including configuration, monitoring and reporting and other related services; multi-mode Heterogeneous core network service is configured to provide multi-mode heterogeneous core network monitoring, core network link optimization, intelligent scheduling and other related services; IoRa core network service is configured to provide LoRa core network configuration, monitoring and reporting Function: Flume, configured to provide log collection service; log query service. It is configured to provide services related to log query; the message queue EMQ is configured as message aggregation and message forwarding of device real-time data and alarm data, and the city comprehensive operation IOC, unified operation and maintenance management platform and artificial intelligence business platform obtain real-time information from the message queue. Data and alarm data; the data center is configured to obtain data from the data warehouse and provide query functions for device configuration, device history data, and device alarm data; the platform backend service is configured to provide functions such as device management and link management.

In some embodiments, the technical solutions provided by the embodiments of the present disclosure can be applied to the multi-mode heterogeneous IoT sensing platform shown in FIG. 1. Referring to the process shown in FIG. 1A-FIG. 1D, the multi-mode heterogeneous IoT sensing platform aggregates data at the terminal layer and communication layer, supports device management at the terminal layer and communication layer, and provides dynamic adjustments based on industry requirements or/and physical locations. Multi-mode heterogeneous network services and edge computing services with any communication parameters. Multi-mode heterogeneous network services provide separate access and management services for existing satellite links, cellular network links, RFID network management, LTE core network, WLAN network management, LoRa core network and other network communications; multi-mode heterogeneous network. The service also provides wireless access services based on multi-mode heterogeneous core networks, and supports integrated access and unified management of multi-mode heterogeneous wireless networks. Multi-mode heterogeneous network services provide network services that dynamically adjust any communication parameters according to industry requirements or/and physical locations, such as adjustable physical communication parameters such as source coding, channel coding, modulation model, signal time slot, and transmit power; another example. The wireless link access and management technology that can be flexibly scheduled and expanded can perform functions such as remote control, upgrade, parameter reading/modification, and management of equipment, support link self-healing, and provide high-utilization, strong stability, and easy recovery. Professional wireless network hosting services. Edge computing service, for accessing multi-mode heterogeneous networks, provides dynamic and adaptive network allocation with edge computing capabilities of converged networks, and provides different delays. Networks with different bandwidths and different time slots can dynamically, automatically and reasonably allocate network resources. For example, the environmental protection industry requires thousands of sites to report data at the same time, which not only requires low latency, but also sends a high amount of concurrency at the same time, but the time interval between two reports may be as high as 1 hour or 4 hours, which requires this disclosure. The edge computing service provided by the embodiment provides support to dynamically and reasonably allocate network resources. After the equipment operation and maintenance personnel configure the data rules, the sensor data is collected, transmitted and stored through the appropriate sensing strategy, communication transmission strategy and data rules.

In some embodiments, the multi-mode heterogeneous network provides diversified, configurable, and coordinated network connections, and can dynamically and on-demand provide suitable network communication resources for terminals; the gateway and base station side introduce fog computing functions, and fog computing can Based on the data of all terminals under its coverage, its decision-making effectiveness tends to be more global. The multi-mode heterogeneous network coverage domain extends downward from the communication layer to the terminal layer, and extends upward to the support layer and application layer. FIG. 1-1 shows the architecture diagram of fog computing with multi-mode heterogeneous network.

In some embodiments, the artificial intelligence algorithm can control the multi-mode heterogeneous core network as required, and provide algorithm support for multi-domain collaborative cloud computing. Artificial intelligence algorithms have different requirements for terminal sensor data at different times and locations, such as sampling rate, precision, code stream, etc. The artificial intelligence algorithm platform can send commands to the multi-mode heterogeneous core network to change the communication of different devices and networking performance, and then use different algorithm parameters and deploy different algorithm resources according to the actual sensor data. As an example: during the day, the camera that monitors hawking needs to capture images frequently, while the camera used for border detection in the middle of the night has a higher priority; the forest fire factor terminal used in forest fire prevention can be reduced under low temperature or rainy conditions. The frequency of collecting combustible layer and weather sensor data, and increasing the sampling frequency to obtain faster response time when the weather is dry and high temperature.

The multi-mode heterogeneous device management technology provided by this disclosure realizes the unified management of all devices in the Internet of Things and the collection and unified monitoring of device operation status and communication parameters; it enables the Internet of Things platform to know the operation status of devices in a timely manner, and is an Internet of Things device. Unified operation and maintenance provides strong technical support; as a technology middle platform for smart city application systems or industrial Internet of Things application systems, it provides general device management and device data access for smart city application systems or industrial Internet of Things application systems.

### R1-2-18—Multi-Mode Ad Hoc Network Wireless Communication System.

In order to solve the problem that the ad hoc network system in the related art establishes a connection and communicates with each other on a single or limited frequency, the channel occupancy rate is high, and the data rate is limited. The existing ad hoc network system uses fixed rates and fixed frequency points, which cannot be compatible with simultaneous. For issues such as transmission rate and communication distance, inability to effectively utilize spectrum resources, and existing mobile ad hoc network systems, slow network access speed and route update speed, this disclosure provides a multi-mode ad hoc network wireless communication system. In one embodiment provided by the present disclosure, the multi-mode ad hoc network wireless communication system includes a node with at least two wireless transceivers, the transmit power of the node can be adjusted, and the node can be configured to work on different frequency channels, speed, modulation, encoding mode and other working modes. Different wireless transceivers in the nodes may have different communication modes. The ad hoc network communication uses a negotiation channel, a data channel, and the like. The negotiation channel is configured for device network access, state release, communication negotiation, etc.; the data channel is divided into broadcast channel and directional channel, etc. the broadcast channel is configured to send multicast and broadcast data, etc. and the directional channel is configured. The configuration is node-to-node communication; the broadcast channel and the directional channel may be the same transceiver.

In an embodiment of the present disclosure, the network access process in the multi-mode ad hoc network wireless communication system uses a network access request and a network access response manner. The network access response includes the interconnection status between devices, and the interconnection status includes whether communication is possible and link status, etc. Devices that have joined the network or are preparing to join the network can send network access responses in multiple windows according to the distance between them and the network-connected device (using the received signal strength). The number of windows and the distance range corresponding to each window are defined according to actual needs; devices in the same window Using random delay and detecting channel occupancy before sending has fewer conflicts. In one embodiment of the present disclosure, the communication rate and transmission power are determined according to the actual radio frequency conditions when the nodes use the negotiation channel for communication; Use parameters such as different channels, rates, and functions according to the actual radio frequency environment.

The following describes the multi-mode ad hoc network wireless communication system provided by the present disclosure and the working method of the system under the practical application of mobile ad hoc network emergency communication and Internet of Things terminal data return in conjunction with the accompanying drawings.

As shown in FIG. 18-1, the node working state switching process. The node does not join any network in the idle state. It actively sends network access requests regularly to join the existing network or network with other idle nodes, and then enters the network access request state to receive network access responses from other nodes. If the response information is received, it will enter the network state, otherwise return to the idle state. When a node is in the network state, it will always listen to the status packets released by other nodes. The status packets can be used to calculate the coverage of the nodes and plan the routing path. If it does not receive any data packets beyond the set time interval, it will enter the disconnected state. If it receives data packets within the set time interval, it will return to the online state, otherwise it will return to the idle state. In the networked state, a data launch request can be sent to the designated node, that is, when the node can be directly connected or connected through a route, it can directly start the data channel to send data.

As shown in FIG. 18-2, the node network access process After a node sends a request to enter the network, it can receive network access responses returned by multiple surrounding nodes. The network access responses can include the status of the responding node and its surrounding nodes. These responses allow the requesting network access node to quickly obtain the connection status between devices. The network access response is divided into multiple time windows according to the distance of the device. The number of windows and the distance range corresponding to each window are defined according to actual needs; devices in the same window use random delays and detect channel occupancy before sending to reduce conflicts.

As shown in FIG. 18-3, the sending and receiving process of the node after joining the network. After joining the network, the node has been listening to the status packets sent by other nodes in the negotiation channel. By receiving the status packets, the node can evaluate the connection status of nearby communicable nodes. Nodes periodically send status packets to other nodes. In the broadcast channel and data channel, nodes can receive broadcast data sent by other nodes. When a node needs to send data to other nodes, it can initiate a request on the negotiation channel and communicate on the data channel. The data channel and the broadcast channel can share a transceiver.

As shown in FIG. 18-4, the data sending request and response process. When a node sends data to a designated node, it first initiates a request on the negotiation channel, and initiates actual communication after receiving a response from the target node. Before sending the request, the node calculates the approximate routing path according to the received status packet, so as to determine whether routing is needed, and if necessary, determine the routing node that should pass through, etc. and then send the request. The request packet can specify a complete routing path or intermediate path nodes. After the routing node receives the request, the node will determine the channel and rate to use to send and receive data with the previous node according to the connection situation. Different channels and rates can be used between different nodes. If there is a complete path, it will be sent directly to the next route according to the path Otherwise, calculate the best route based on the state information collected by itself and send it to the next route, and attach the new routing node to the request packet. After the request reaches the target node, the target node sends a response packet, and the response packet is transmitted in reverse according to the routing path of the request packet. All intermediate nodes can obtain complete routing information, communication time width, time point and other information in order to turn on the receiver at an appropriate time and determine the timeout period.

As shown in FIG. 18-5, the data sending process. The sending node sends the data in packets according to the result of the data sending response. Multiple data packets can be sent in batches, the receiving node responds in batches, and the initiating node retransmits the undelivered data packets. The intermediate routing node will buffer the sent data. If the data is lost at a certain node, the node will be responsible for retransmitting it instead of completely retransmitting it from the sending node.

A summary of the different packets sent for the negotiation channel is shown in FIG. 18-6. For example, the packet digest of the network access request includes request command, short DID, long LID, and device information, and the packet digest of the network access response includes the response command, short DID, network NID, and network status. FIG. 18-6 also includes the status announcement, data transmission request, and data packet summary of data transmission response. The summary of different data packets sent by the negotiation channel shown in FIG. 18-6 is an exemplary implementation manner, which can be flexibly adjusted in different embodiments. A summary of the different packets sent for the data channel is shown in FIG. 18-7. For example, the data packet digest of the multicast broadcast data includes a status command, a sender DID, a group number GID, a send packet sequence number, data, routing information, and the like. FIG. 18-7 also includes the node-to-node data transmission and node-to-node data packet summary and so on. The summary of different data packets sent by the data channel shown in FIG. 18-7 is an exemplary implementation manner, which can be flexibly adjusted in different embodiments. In some embodiments, the multi-mode ad hoc network wireless communication system provided by the embodiments of the present disclosure may be applied to FIG. 1. Referring to the process shown in Figure LA-FIG. 1D, the device at the terminal layer is connected to the multi-mode heterogeneous IoT sensing platform, and the multi-mode heterogeneous IoT sensing platform manages the device at the terminal layer and the communication layer, providing or/and Multi-mode heterogeneous network services and edge computing services that dynamically adjust any communication parameters in physical locations. Ad hoc network communication uses negotiation channels and data channels. The negotiation channel is used for device network access, status announcement and communication negotiation; the data channel is divided into broadcast channel and directional channel, the broadcast channel is used to send multicast and broadcast data, and the directional channel is used for node-to-node communication; the broadcast channel and directional channel can for the same transceiver. The network access process uses the network access request and network access response methods. The network access response includes the interconnection status between devices (whether communication is possible, link status). Devices that have joined the network or are preparing to join the network can send network access responses in multiple windows according to the distance between them and the network-connected device (using the received signal strength). The number of windows and the distance range corresponding to each window are defined according to actual needs, devices in the same window Using random delay and detecting channel occupancy before sending has fewer conflicts. When the nodes use the negotiation channel to communicate, determine the communication rate and transmission power according to the actual radio frequency situation; when the data needs to be routed by the intermediate node, the communication between the node and the route, and between the route and the route can use different channels and rates according to the actual radio frequency environment, function and other parameters.

In some embodiments, the artificial intelligence management platform obtains data such as geographic data, vegetation data, forest fire factor data, meteorological data, real-time data of sensing terminals, fire extinguishing resources and other data from the data lake of the data intelligent fusion platform, and calculates the fire extinguishing resources through deep learning algorithms. Point center, current fire area, fire spread trend, feasible rescue path, etc. combined with command and dispatch terminal location data, deduces the optimal rescue path for on-site rescuers. The rescue path takes into account factors such as the safety of rescuers and fire fighting efficiency Through the trajectory prediction of command and dispatch terminals, the artificial intelligence management platform can determine the dynamic networking requirements of command and dispatch terminals: which terminals are key terminals, the required communication rate, etc. and send the requirements to the multi-mode heterogeneous core network, multi-mode. The heterogeneous core network retrieves historical communication big data from the data lake, combined with on-site communication environment data, deduces the optimal networking mode, communication resource scheduling strategy, etc. through deep learning algorithms, and issues the final control instructions through the gateway/base station. To the command and dispatch terminal and/or the on-site mobile gateway/base station, the command and dispatch terminal forms a network according to the instructions and returns a variety of streaming media information in real time for further use by the platform.

The multi-mode ad hoc network wireless communication system provided by this disclosure can be used to build a multi-mode emergency communication system, which has fast networking characteristics, adapts to dynamic networking of mobile devices and multi-transmission mode, multi-channel, multi-communication mode communication Significantly improve the communication rate and reliability of the system.

R1-3-19-A communication technology for multi-mode heterogeneous hybrid connection network. In order to solve the problem of equal allocation of terminal communication resources in the related technology, dynamic deployment on demand is not possible, data splitting transmission and aggregation of multi-mode communication is not supported, and the quality of service cannot be guaranteed; the connection mode of the star network is single, and mixed self-organization is not allowed in the blind area of the network network and point-to-point modes; radio frequency transmission and reception parameters are fixed, and parameters cannot be adjusted according to connection quality to achieve a balance between performance and distance. The disclosure provides a communication method for a multi-mode heterogeneous hybrid connection network.

In one embodiment of the present disclosure, the communication method of the multi-mode heterogeneous hybrid connection network includes the sending end splits the sent data packet into multiple sub-data packets, link prediction and adaptive scheduling algorithm based on deep learning. All the sub-packets are sent to the receiving end through hybrid networking, and the receiving end assembles all the sub-packets and splices them into a complete data packet.

The following describes the communication method of the multi-mode heterogeneous hybrid connection network provided by the present disclosure under the specific application of the emergency communication system and the Internet of Things terminal communication in conjunction with the accompanying drawings.

As shown in FIG. 19-1, in an embodiment of the present disclosure, the sending end splits the sent data packet into multiple sub-data packets, which are assembled at the receiving end to form a complete data packet. The sending end and the receiving end are different terminals, and they can be the sending end and the receiving end in different data transmission processes. On the basis of mixed networking as required, the sub-packet can be sent from the sending end to the receiving end by means of multi-path and multi-communication, and different strategies can be adopted as required during multi-path transmission, as an embodiment: a) the data packet is split into Multiple sub-packets are sequentially transmitted through different paths to increase robustness, b) the data packet is split into multiple sub-packets, and transmitted in parallel through different paths to increase network bandwidth, c) the same sub-packet is redundant through different paths transmission for increased reliability. When terminals communicate with each other, a connection can be established through the base station or directly without bridging through the base station, which reduces the bandwidth occupation of the base station Hybrid networking adds ad hoc networking and point-to-point communication on the basis of the star network. When the terminal in the blind area cannot directly connect to the base station, it can establish a mesh network with other terminals, and realize uplink communication with the help of equipment that can connect to the base station. The terminal can switch between the star network and the mesh network; when working in the mesh network mode, the terminal can be used as a routing node or a normal node. In an embodiment of the present disclosure, the core network and the base station can collect link information of the base station, routing node, and terminal, including information such as communication standard, communication path, signal-to-noise ratio, packet loss rate, delay, and channel occupancy rate, and use deep learning to do link prediction and deduce a better solution. During the process of sending sub-packets from the sending end to the receiving end, the connection mode of the terminal can be adaptively adjusted as needed (bandwidth, response time, reliability, connection distance, etc.) (Directly connected to the base station, mesh network, point-to-point), transmission path (single path, multi-path) and radio frequency parameters (modulation mode, rate, spectrum occupancy, receiving bandwidth).

In the embodiment of the present disclosure, the communication method of the multi-mode heterogeneous hybrid connection network provided by the embodiment of the present disclosure is applied to FIG. 1. Referring to the process shown in FIG. 1A-FIG. 1D, the connection and communication between the terminal equipment and the core network or base station can be in the form of hybrid networking, adding ad hoc network and point-to-point communication on the basis of the shape network, and using ad hoc network in the blind area of the base station Through point-to-point communication, the efficient utilization of channel resources is realized; through resource allocation, the data transmission quality of high-priority devices is guaranteed; through multi-mode and multi-path data packetization and aggregation, the purpose of expanding bandwidth and increasing reliability is achieved.

In an embodiment of the present disclosure, please also refer to FIG. 1F, which is a schematic diagram of multi-mode heterogeneous communication links in the next generation Internet of Things. As shown in the figure, the data is sampled first, and the sampling interval can be set according to requirements (for example, it can be sampled once every minute, or once every second). Then A/D conversion is performed on the sampled data to convert the analog data into digital data, and the accuracy of the A/D conversion can also be set according to needs: it can be 8 bits, 12 bits, 16 bits, 24 bits, etc. The digital data is then transmitted through the RF (radio frequency circuit) after the source coder performs source coding, the channel coder performs channel coding, and the digital modulator performs digital modulation. Wherein, source coding such as MPEG-1, MPEG-2, MPEG-4, H.263, H.264, H.265, etc. can be realized based on one or more protocols. The types of channel coding mainly include linear block codes, convolutional codes, concatenated codes. Turbo codes, and LDPC codes Digital modulation methods include: FSK (Frequency Shift Keying), QAM (Quadrature Amplitude Modulation), BPSK (Binary Phase Shift Keying), etc. Multi-mode heterogeneous network services provide network services that dynamically adjust any communication parameters according to industry requirements or/and physical location, such as adjustable source coding, channel coding, modulation model, signal time slot, transmission power and other physical communication parameters. For example, the transmission power RF can be adjusted through PA (determines the transmission frequency) and fn (determines the transmission frequency point). Exemplarily, the adjustment includes allocating different transmission bandwidths to different services, and when the data transmission requirements of some terminals change, the multi-mode heterogeneous network adjusts the allocation of network resources to adapt to the demand changes. Exemplarily, the adjustment includes priority adjustment of signal transmission. For example, signals from some terminals are transmitted preferentially. For example, the data of some base stations or gateways are transmitted preferentially. For example, some service signals of the terminal are transmitted preferentially. The multi-mode heterogeneous network adjusts network parameters in a timely manner based on site sensing and business requirements, which can ensure the implementation of important upper-layer services and improve the availability of the multi-mode heterogeneous network. Further, the adjustment includes dividing different data into different data streams and transmitting them through different communication paths. For example, part of the data is transmitted to the upper-layer business through the 4G network, part of the data is transmitted to the edge computing module through the LoRa protocol, and part of the data is transmitted through a custom multi-mode heterogeneous communication network protocol. On the premise of meeting the business transmission requirements, reduce the consumption of network resources as much as possible, and dynamically adjust communication and network in real time according to changing business requirements. In addition, the edge computing service is aimed at accessing multi-mode heterogeneous networks, providing dynamic and adaptive network allocation with edge computing capabilities of the converged network, and providing different extensions to meet the needs of different industries and different physical environments. Time, different bandwidth, and different time slot networks, dynamically, automatically, and rationally allocate communication and network resources. For example, the environmental protection industry requires timely data sampling and low-latency reporting, but thousands of sites report data at the same time, and the concurrency of sending at the same time is very high, but the time interval between two adjacent reports may be very long, which requires our edge computing services provide support to dynamically and reasonably allocate network resources, such as deploying other non-time-sensitive devices to give way, such as temporarily deploying multiple communication channels, such as sampling on time but uploading at staggered time.

The communication method of the multi-mode heterogeneous hybrid connection network provided by the present disclosure uses ad-hoc network and point-to-point communication for the blind area of the base station, which realizes efficient utilization of channel resources; ensures the data transmission quality of high-priority equipment through resource allocation; through multi-mode, multi-path data packetization and aggregation, to achieve the purpose of expanding bandwidth and increasing reliability.

### R1-4-20—a New Low-Power Wide-Area Wireless IoT Protocol and Mechanism.

The LoRa-WAN protocol in the related technology. LoRaWAN is a low-power wide area network based on LoRa, it provides a: low power consumption, scalability, high service quality, safe long-distance wireless network, it divides network entities into 4 categories: EndNodes (terminal node). Gateway (gateway), LoraWAN Server (LoRaWAN server) and Application Server (user server). In the star network of LoRaWAN. End Nodes communicate with one or more Gateways using single-hop wireless; Gateway communicates with LoRaWAN Server through standard IP links (Ethernet, 3G/4G and WiFi); Gateway is responsible for End Nodes and LoRaWAN Server information of the relay. The existing LoRaWAN communication protocol, when there are multiple communication links between the terminal and the gateway, lacks a mechanism to elect an optimal frequency point, channel and gateway, so that the terminal can communicate with the gateway in an optimal way; the current low-power wide-area wireless networking protocol includes the communication protocol between the terminal and the gateway, the communication protocol between the gateway and the server, and lacks the communication protocol between the terminals and the communication protocol between the gateways; in the case of the coexistence of multiple gateways and multiple terminals, it lacks adaptive multi-point coordination interference mitigation algorithm; lack of dedicated over-the-air technology (Over-the-Air Technology, OTA) protocol, does not support parallel upgrades, batch response; the protocol itself lacks support for edge computing and fog computing; lack of self-discovery. For issues such as self-organization, self-recovery, and network self-healing support for various networking modes, the present disclosure provides a low-power wide-area wireless Internet of Things system or an industrial Internet system.

In one embodiment of the present disclosure, a combination of cloud computing, edge computing, and fog computing is adopted. The low-power wide-area wireless Internet of Things system or industrial Internet system includes terminals, gateways, and servers. The terminals, gateways, and servers can all be used as Computing executor; a terminal as the core terminal is configured as the main body of edge computing, and different terminals can communicate with each other to share sensor data and convey execution commands without using a gateway; the gateway is configured as the main body of fog computing, and all terminals covered by the gateway are covered Sensor data and executing commands; according to the different coverage areas of sensor data and executing commands, fog computing can be divided into different areas; the server is configured as the main body of cloud computing, and both the server and the gateway can send executing commands to the terminal; the terminal can execute the The execution status and execution result of the command are synchronized to the gateway and the server.

As shown in FIG. 1-1 or FIG. 4-2, in one embodiment of the present disclosure, the low-power wide-area wireless Internet of Things system or industrial Internet system includes: a sensing terminal with a sensing sensor configured to collect sensor data, an executive terminal with an actuator configured to execute actions; a composite terminal with sensors and actuators configured to collect sensor data, execute command actions, inquire about the sensor data collected by the sensing terminal, and report to the execution. The terminal issues an execution command, the mobile terminal with a voice call function is configured to establish a connection with the mobile gateway; the mobile gateway is configured to access the voice call of the mobile terminal, the slave gateway is configured to establish a connection with the composite terminal Connecting, receiving the sensor data sent by the composite terminal, directly issuing an execution command to the composite terminal, and receiving the execution command issued by the master gateway and forwarding it to the composite terminal; the master gateway is configured to connect with the slave gateway, receive. The sensor data reported by the gateway sends execution commands to the slave gateway, and sends sensor data to the server, receives the execution command issued by the server and forwards it to the slave gateway; the server is configured to connect to the master gateway, and receives the report from the master gateway sensor data, issue execution commands to the main gateway, and connect with other servers for data exchange.

In this embodiment, edge computing and fog computing are divided into different scopes, that is, different circles, according to the different coverage areas of sensor data and execution commands. As shown in FIG. 1-1 or FIG. 4-2, IoT layer 1 terminal coverage area, a single terminal has the ability to collect sensor data and execute commands, and obtain data from sensing sensors and upload them to the gateway through configuration. When the communication is abnormal. It can analyze the data by itself and then generate execution commands to start execution actions; IoT layer 2 adjacent terminal coverage area: adjacent terminals communicate with each other (not through the gateway) to share sensor data and convey execution commands One of the terminals, as the core terminal, is responsible for executing the edge computing process; IoT layer 3 single gateway coverage domain: when there is a gateway participating, the gateway is the main body of fog computing, sensor data and executing commands to cover the devices covered by the gateway; IoT layer 4 and more Gateway coverage domain: when multiple gateways participate, one of them acts as the master gateway, and the slave gateway communicates with the master gateway to collect the data reported by the terminal, and the master gateway sends the terminal execution command to the slave gateway; IoT layer 5 single system coverage domain: Indicates the server level. The server layer collects the terminal data reported by the gateway, and can generate terminal execution commands and send them to the gateway; IoT layer 6 multi-system coverage domain indicates cross-project and cross-platform levels; IoT layer+M mobile Terminal domain: Indicates the edge computing level of mobile ad hoc network devices Mobile devices can be connected to mobile gateways and fixed gateways, and can also be connected to nearby terminals to obtain nearby sensor data. Of course, execution commands can also be directly issued to terminal.

In one embodiment of the present disclosure, an OTA-specific protocol firmware upgrade system is provided, including: an OTA server, which is responsible for device firmware upgrade services, and controls the entire process of upgrading terminal firmware; a terminal device interacts with the OTA server to update the terminal firmware to upgrade.

In the embodiment of the present disclosure, the OTA dedicated protocol adopts the sliding window protocol to support the parallel upgrade of terminal device firmware. After receiving the data packet, the terminal device adopts a batch response mechanism to improve the efficiency of parallel firmware upgrade. The method identifies the serial number of the received packet, effectively reduces the packet length of the response packet, and improves the efficiency of device firmware upgrade.

As shown in FIG. 20-1, the OTA dedicated protocol firmware upgrade process is as follows: 1. The OTA server issues an OTA upgrade notification to each corresponding terminal; 2. After receiving the OTA upgrade notification, each terminal sends a request to the OTA upgrade packet; 3. OTA The server divides the OTA data packet according to the data packet size, divides it into small data packets, and sends them to the terminal device separately: 4. After receiving a certain number of data packets sent by the OTA server, the terminal device responds to the received data packets in a unified manner: 5 The OTA server finds that the terminal device has not received the data packet and resends it until the terminal device OTA upgrade data packet is normally received: 6. The terminal device assembles the data packet and upgrades the device firmware.

An embodiment of the present disclosure provides an adaptive multi-point coordination system under the condition that multiple gateways and multiple terminals coexist, including: a terminal configured to sense data and/or execute commands to communicate with the gateway and report the collection sensor data and receive execution commands issued by the gateway; the gateway is configured to perform fog computing functions and communicate with the terminal to receive the sensor data reported by the terminal, issue execution commands to the terminal, and regularly report the gateway to the coordination server Communication rate, communication quality, and frequency point occupancy: the coordination server is configured to receive the gateway communication rate, communication quality, and frequency point occupancy reported regularly by the gateway, and perform calculations in real time. When the terminal initiates a request, the terminal sends the optimal Gateway and frequency point information.

As shown in FIG. 20-2, the embodiment of the present disclosure provides an adaptive multi-point coordinated multi-point method under the condition that multiple gateways and multiple terminals coexist, including the gateway regularly sends the gateway communication rate, communication quality and frequency point occupancy to the coordinator Server, the coordination server's interference mitigation algorithm performs real-time calculations, and calculates the available frequency points, communication quality and communication speed of each gateway; each time the terminal needs to obtain the optimal gateway and frequency point from the coordination server before establishing a connection with the gateway; the terminal obtains the optimal gateway and frequency point by obtaining. The optimal gateway and frequency point to establish a connection with the gateway and transmit data.

In the embodiments of the present disclosure, when multiple terminal devices can be connected to multiple gateways, each time the terminal device transmits data to the gateway, it faces the problem of selecting which gateway to connect to and which frequency point to communicate with. Adaptive multi-point cooperative interference mitigation algorithm under the condition of multi-gateway and multi-terminal coexistence. By introducing the coordination server, the gateway regularly sends the gateway communication rate, communication quality and frequency point occupancy to the coordination server, and the interference mitigation algorithm of the coordination server performs real-time calculation, each time the terminal device needs to establish a connection with the gateway to obtain the optimal gateway and frequency point from the coordination server, the terminal device then establishes a connection with the gateway through this frequency point and transmits data, which can effectively improve the terminal data transmission rate and transmission quality. And can maximize the use of different frequency points.

In an embodiment of the present disclosure, the gateway broadcasts on a fixed channel, the terminal and the gateway scan frequency points at the same time, and the gateway adaptively selects a better idle frequency point for communication.

In one embodiment of the present disclosure, an AD-HOC-based network self-organization is provided, which supports multiple networking methods, supports mesh networks and AD-HOC, and supports self-discovery, self-organization, self-recovery and network self-healing.

In one embodiment of the present disclosure, a network transmission method based on different business priorities is provided, including: sensor intermittent sampling strategy, usually in power-off or dormant to save power consumption, quickly sample data after turning on, and then enter power-off or hibernate. The sampling interval is adjusted by the server according to the demand, and can also be adjusted according to the specified strategy according to the change of the site environment. For example, when the temperature is lower than minus ten degrees, the sampling interval of the soil sensor is extended from 30 minutes to 2 hours; the wireless transmission power consumption optimization strategy is based on the terminal and gateway. The transmission rate and transmission power are adjusted in real time to achieve the minimum transmission power consumption. The transmission rate determines the start time of the transmission circuit and the transmission power determines the current during transmission, that is, the optimal power consumption is achieved by controlling the time and current; the data transmission strategy. When the sensor data has no change, small change value or small change range, different strategies can be set to adjust the data transmission strategy by comparing the data changes between two samplings and/or between the last emission value and the current sampling, such as extending the time Or send it now.

In an embodiment of the present disclosure, a low-power wide-area wireless Internet of Things system or an industrial Internet system is provided, which can be applied to edge computing, fog computing, cloud computing, and edge-cloud collaboration shown in FIG. 1. Referring to the process shown in FIG. 1A-FIG. 1D, based on the integrated computing system of edge computing, fog computing and cloud computing of the low-power wide-area wireless Internet of Things, the terminal realizes the data collected by the sensor device through the application service deployment Real-time analysis, real-time analysis and real-time calculation and processing, using artificial intelligence algorithms to realize real-time recognition and image classification based on real-time images, the combination of rule engine algorithms and artificial intelligence algorithms can generate intelligent alarm information, and control actuators in real time based on alarm information Execute corresponding actions, and support data exchange and mutual control between adjacent terminals; in the fog computing layer, the main gateway can obtain the data reported by the terminal from the gateway, and can perform complex calculations and data analysis that require more computing resources. It also supports data analysis of the data reported by the terminal in the area, supports identification of terminal devices with abnormal data reported based on the data reported by peripheral devices, and sends terminal calibration instructions to the terminal for terminal calibration. Instructions indirectly issue control instructions to the execution terminal; the cloud service layer supports functions related to machine learning, data analysis, model data training, data prediction and decision analysis of massive data.

The low-power wide-area wireless Internet of Things system or industrial Internet system in this disclosure can effectively improve the rapid response capability of the entire Internet of Things to sensor data collection, and can meet the application scenarios that require high system response time; at the same time, the network conditions are abnormal. The system can also respond quickly under certain circumstances; the OTA dedicated protocol can effectively improve the efficiency of terminal firmware upgrades; the interference mitigation algorithm of adaptive multi-point coordination can effectively improve the terminal data transmission rate and transmission quality, and can maximize the use of different frequency points: based on AD-HOC's network self-organization technology can continue to complete normal network transmission when some network equipment fails; network transmission modes based on different business priorities can effectively reduce terminal power consumption, and can extend terminal work for battery-powered terminals Duration; Terminal device configuration that does not require prior pre-configuration can simplify the process of device network access.

### R1-S-21—Multi-Mode Heterogeneous Device Management Technology.

In order to solve the lack of unified management of multi-mode heterogeneous devices in the Internet of Things in related technologies, as well as the lack of integrated configuration and comprehensive. To solve the problem of management and monitoring, the present disclosure provides a multi-mode heterogeneous device management system.

As shown in FIG. 21-1, the embodiment of the present disclosure provides a multi-mode heterogeneous device management system, including: a device layer, including all devices in the system; a transport layer, configured to provide data transmission for the system, including transferring devices Layer data is transmitted to the data layer; the data layer is configured to provide data storage for the system; the engine layer is configured to provide the required engine for the system; the service layer is configured to provide data access and data analysis basic services for the system; business logic. The layer is configured to provide business logic services for the system to manage multi-mode heterogeneous devices.

In the embodiments of the present disclosure, the device layer includes various types of devices, that is, various types of sensing devices, camera devices, multimedia devices, transmission devices, and various network devices, etc.; the transmission layer is configured for data transmission, supporting MIB, TR069, LoRa, MQTT and HTTP protocols, etc. the data layer is responsible for data storage, including relational database MySQL, data warehouse clickHouse, non-relational database. Hbase and memory database Redis, etc.; engine layer provides message queue engine, rule engine, etc.; service layer provides data Basic services such as access and data analysis; the business logic layer provides business logic services for multi-mode heterogeneous device management.

As shown in FIG. 21-2, in an embodiment of the present disclosure, a data access system is provided for a multi-mode heterogeneous device management system, including: MIB network element devices, which are terminals supporting the MIB protocol, communication devices and Network equipment; TR069 network element equipment, which are terminals, communication equipment and network equipment supporting TR069 protocol; network management system with northbound interface, which is a network management system with northbound interface supporting MIB protocol, which can manage terminals, communication equipment and network Equipment; network management system without northbound interface, the network management system can manage terminals, communication equipment and network equipment; LORA terminal equipment communication server, configured to support Lora communication; MIB database network element information server, configured to support MIB protocol Obtain real-time network and communication-related real-time data of terminals, communication devices, and network devices from MIB network element devices, analyze the real-time data, publish the parsed real-time data and log data to the cache-type message queue Kafka, and support receiving cache-type. The configuration commands of terminals, communication devices, and network devices sent by message queue Kafka are encapsulated into MIB commands and sent to MIB terminals, communication devices, and network devices; Obtain alarm information with TR069 terminals, communication equipment, network equipment, and network element equipment with northbound interfaces, and encapsulate the alarm information according to standard protocols, and then publish network element alarm information and log information to the cached message queue Kafka; TR069 network element information. The server is configured to support obtaining network and communication-related real-time data from TR069 terminals, communication devices, and network devices according to the TR069 protocol, and analyzing the real-time data, and publishing the analyzed real-time data and log data to the cached message queue Kafka. The network management information server of the MIB library is configured to support the acquisition of real-time data related to the network and communication of terminals, communication devices and network devices from the network management system with northbound interfaces through the MIB protocol, and analyze the real-time data, and analyze the real-time data and logs. The data is published to the cached message queue Kafka, and supports receiving network element configuration commands sent by the cached message queue Kafka, encapsulated into MIB commands and delivered to the network management system with northbound interface; the crawler server is configured to read Relevant configuration information of the interface network management system, from the network management system without northbound interface crawls the network, communication-related real-time data and alarm data of terminals, communication equipment and network equipment, and analyzes the real-time data, and analyzes the completed real-time data and log data Published to the cached message queue Kafka; the Lora communication parameters are connected to the server, which is configured to support obtaining the real-time Lora communication parameters of the Lora terminal and the LoRa gateway from the Lora NS Server through the MQTT protocol, and analyze the real-time data. Data and log data are published to the cached message queue Kafka, the cached message queue Kafka is configured as a negative Responsible for data aggregation and data exchange; real-time data server is configured to be responsible for real-time data calculation and real-time data alarm services; Flume is configured to be responsible for log data collection services.

As shown in FIG. 21-3, in an embodiment of the present disclosure, the crawler server includes: a product device information device configured to regularly read information about devices and corresponding products from a network management system without a northbound interface: a network management system configuration information device, is configured to read the relevant configuration information of the network management system without northbound interface; crawls the network management device data device, and is configured to crawl terminals and communication devices from the network management system without northbound interface according to the product device information device and the network management system configuration information device Real-time data and alarm data related to the network and communication of network devices; the crawled data is sent to the Kafka device, which is configured to encapsulate the crawled data according to the protocol and send it to Kafka. As shown in FIG. 21-4, in one embodiment of the present disclosure, the Lora terminal device communication server includes a regularly read Lora NS information device, which is configured to regularly read Lora network service software related configuration information; the MQTT client listens to the MQTT The theme device is configured to monitor the Lora communication parameter information of the device specified by the Lora network service software, and the device authenticator is configured to perform device authentication on the Lora communication parameter information of the device read from the Lora network service software; data processing and sending. The Kafka device is configured to encapsulate the Lora communication parameter information data according to the protocol and send it to Kafka.

An embodiment of the present disclosure provides a multi-mode heterogeneous device management system that can be applied to the multi-mode heterogeneous IoT sensing platform shown in FIG. 1. Referring to the process shown in FIG. 1A-FIG. 1D, the unified management of multi-mode heterogeneous devices is realized through micro-service technology, and the integration of various sensor devices, multimedia devices, network communication devices and computer room devices for narrowband, medium-band and broadband. It supports the configuration and management of different monitoring parameters for different devices, obtains the monitoring parameters of multi-mode heterogeneous devices through multiple protocols, and supports the unified collection of online status of multi-mode heterogeneous devices; real-time monitoring parameters Analyze according to the alarm rules, alarm and deal with abnormal monitoring parameters; track communication signaling in real time and query historical signaling; link connections such as 5G, LTE, LoRa, NB_IoT, WLAN, WBridge, and satellite in real-time visual display technology: Display multi-mode heterogeneous wireless hosting network structure, and display communication traffic in real time; display MESH link self-optimization in real time; display MESH link self-recovery in real time; display MESH link optimization in real time. The multi-mode heterogeneous device management technology provided by this disclosure realizes the unified management of all devices in the Internet of Things and the collection and unified monitoring of device operation status and communication parameters; it enables the Internet of Things platform to know the operation status of devices in a timely manner, and is an Internet of Things device. Unified operation and maintenance provides strong technical support; provides a technical foundation for the Internet of Things platform to collect sensor device business information and camera video information; as a technology middle platform for smart city application systems or industrial Internet of Things Or the industrial Internet of Things application system provides general equipment management.

### R1-6-22—Signaling Tracking Packet Capture Program.

In order to solve the problem that the packet capture program in the related art is implemented using the CS architecture and does not use the signaling tracking visualization software of the BS architecture. When a network abnormality or a network failure occurs, it is impossible to visually locate the cause of the fault and the problem of the faulty device. This disclosure provides a visualization system for signaling real-time tracking.

An embodiment of the present disclosure provides a visualization system for real-time tracking of signaling, including: a serial number item module configured to obtain the signaling sequence number; a time module configured to obtain the time when the signaling is sent, a front-end time module configured to. It is used to obtain the time when the front-end page receives the signaling; the message type module is configured to obtain the message type of the signaling; the detail module is configured to obtain the details of the signaling; the node module is configured to obtain the IP and indicate the signaling From source device to target device.

As shown in FIG. 22-1, in this embodiment, the visualization interface of the signaling real-time tracking visualization system includes: serial number item, which displays the signaling sequence number, time, which displays the time when the signaling is sent, front-end time, which displays the received Signaling time; message type, displaying the message type of signaling; details, displaying signaling details: node, displaying node IP address, and a red arrow indicates that the signaling is from the source device to the target device.

In an embodiment of the present disclosure, the detail module in the signaling real-time tracking visualization system includes: a format unit configured to obtain signaling details and perform format conversion; a selection unit configured to select signaling real-time tracking detailed information.

As shown in FIG. 22-2, in this embodiment, the visual interface of the details module includes: displaying real-time signaling detail information in Json format; selecting signaling real-time tracking detail information and clicking the “Copy” button to copy signaling real-time Track details. The disclosure has equipment network communication data monitoring technology, monitors equipment network card communication data, and analyzes network data packets according to different protocols; has distributed signaling data processing technology, gathers and processes asynchronous signaling by introducing message queues; has signaling Visual display technology, through visualization technology, displays signaling originating device, receiving device, signaling direction, message type, signaling time and other information in the order of signaling. It can be applied to multiple scenarios. When a communication fault occurs in a multi-mode heterogeneous wireless hosting network, it is necessary to locate the faulty device, and capture the device signaling through the signaling tracking packet capture program to locate the faulty communication device; When understanding the status of communication transmission in a multi-mode heterogeneous network, use the signaling tracking packet capture program to capture the equipment signaling to understand the entire process of signaling transmission and the transmission delay of each link of signaling transmission.

In some embodiments, the visualization system for signaling real-time tracking provided by the embodiments of the present disclosure may be applied to the multi-mode heterogeneous IoT sensing platform shown in FIG. 1. Referring to the process shown in FIG. 1A-FIG. 1D, when a communication fault occurs in the multi-mode heterogeneous wireless hosting network, it is necessary to locate the faulty device, and use the signaling tracking packet capture program to capture the signaling of the device to locate the faulty communication Equipment; when it is necessary to understand the communication transmission status in a multi-mode heterogeneous network, the signaling tracking packet capture program is used to capture the signaling of the equipment to understand the entire process of signaling transmission and the transmission delay of each link of signaling transmission.

This disclosure provides a web-based signaling tracking tool for multi-mode heterogeneous networks, which is easy to operate and intuitive to display results; the signaling packet capture program supports distributed signaling packet capture, and supports terminal. The concurrent signaling packet capture of communication equipment supports massive terminals and communication equipment.

### R1-7-23—a Web-Based Signaling Tracking Method.

In related technologies. Wireshark is a general-purpose network packet analysis software that supports interception of network packets and can display detailed data packet details. Wireshark uses WinPCAP as an interface to directly exchange data packets with the network card. The workflow of Wireshark is as follows
1. Determine the location of Wireshark. If there is no correct location, it will take a long time to capture some irrelevant data after starting Wireshark;
2. Select the capture interface Generally, the interface connected to the Internet network is selected, so that the data related to the network can be captured. Otherwise, other captured data will not help you;
3. Use capture filters. By setting the capture filter, you can avoid generating too large capture files. In this way, users will not be disturbed by other data when analyzing data;
4. Use display filters. Often the data filtered using capture filters is often still complex. In order to make the filtered data packets more detailed, use the display filter to filter at this time;
5. Use coloring rules. Usually, the data filtered by the display filter is a useful data packet. If you want to display a session more prominently, you can use coloring rules to highlight it;
6. Build the chart. If users want to see the changes of data in a network more clearly, it is convenient to display the data distribution in the form of charts;
7. Reorganize the data. It can reassemble the information of different data packets in a session, or reassemble a complete picture or file. Since transferred files tend to be large, the information is spread across multiple packets. In order to be able to view the entire picture or file, it is necessary to use the method of reorganizing the data at this time.

However, the use of Wireshark for signaling tracking of IoT devices is complicated, and the tracking operation of the same signaling between different devices is complicated and inconvenient to use. A signaling trace tool specific to IoT devices is required. In order to solve the problems in related technologies, the embodiments of the present disclosure provide a signaling tracking packet capture system and method.

As shown in FIG. 23-1 and FIG. 23-2, the embodiment of the present disclosure provides a signaling tracking packet capture system, including: a front-end web page, responsible for obtaining signaling tracking equipment, protocols and other related information, and displaying signaling tracking Return the result information; the device data packet capture control service module is responsible for receiving the start packet capture request and stop packet capture request sent by the front-end web page, and forward the request to the message queue EMQ, obtain the captured analysis data packet from EMQ, and process it. After that, it is sent to the message queue EMQ; the message queue EMQ is responsible for message collection and message forwarding services; the device data packet capture service module is responsible for capturing data packets from the response network element equipment, terminal equipment and/or communication equipment according to the capture protocol.

As shown in FIG. 23-1 and FIG. 23-2, the embodiment of the present disclosure provides a signaling tracking packet capture method, the method includes: the front-end web page sends a request to start packet capture; the device data packet capture control service module forwards. The start packet capture request is sent to the message queue EMQ; the device data packet capture service module obtains the start packet capture request from the message queue; the device data packet capture service module captures the communication data packet of the network element device from the network element device, and The analysis data packet of the obtained network element device communication data packet is published to the message queue EMQ; the device data packet capture control service module obtains the analysis data packet of the network element device from the message queue; the device data packet capture control service module. The analysis data packet is processed and the processed analysis data packet is sent to the message queue EMQ, the device data packet capture control service module saves the processed analysis data packet to the packet capture file; the front-end web page is obtained from the message queue EMQ The parsed packet after processing.

In this embodiment, when it is necessary to stop packet capture, the signaling tracking packet capture method also includes: the front-end web page sends a stop packet capture request to the device packet capture control service module; the device packet capture control service module Post the packet capture stop request to the message queue EMQ; the device packet capture service module monitors and obtains the packet capture stop request from the message queue; the device packet capture service module closes the packet capture file.

In this embodiment, when it is necessary to save the packet capture data packet, the signaling tracking packet capture method also includes: the front-end web page initiates preservation of the packet capture data packet to the device data packet capture control service module; The control service module dumps the file to a new directory and stores the data package file into the library. It is worth noting that the device packet capture control service module will regularly clean up the captured file.

As shown in FIG. 23-1 and FIG. 23-2, an embodiment of the present disclosure provides a device data capture control service module applied to a signaling tracking packet capture system, including: a receiving start packet capture request unit configured to Receive the start packet capture request and request parameters sent by the front-end web page; clear the earliest packet capture file unit, which is configured to clean up the earliest packet capture file; forward the packet capture request unit, which is configured to publish the received start packet capture request to the message queue EMQ; the receiving analysis data packet unit is configured to receive the analysis data packet from the message queue, and send the analysis data packet to the storage data packet unit and the data packet processing unit; the storage data packet unit is configured to receive the received. The parsed data packet is stored in the packet capture file; the data packet processing unit is configured to perform data parsing processing on the parsed data packet; the post-processed parsed data packet unit is configured to send the processed parsed data packet to the message queue EMQ

As shown in FIG. 23-2, in an embodiment of the present disclosure, the device data capture control service module further includes: a receiving stop packet capture request unit configured to receive stop packet capture information sent by the front-end page, stop packet capture information Including stop packet capture request and/or stop packet capture instruction; send stop packet capture request unit, configured to send stop packet capture request information to message queue EMQ; stop receiving and analyzing data packet unit, configured to stop receiving from message queue EQM Parse the packet.

As shown in FIG. 23-2, in an embodiment of the present disclosure, the device data capture control service module further includes: a unit for receiving and saving a data packet request, configured to receive a request for saving a data packet from a front-end web page: The new directory unit is configured to dump files to a new directory; the save packet capture information to the database unit is configured to save packet capture related information to the database. In some embodiments, the technical solutions provided by the embodiments of the present disclosure may be applied to the multi-mode heterogeneous core network service shown in FIG. 1. Referring to the process shown in FIG. 1A-FIG. 1D, when the terminal device is connected to the multi-mode heterogeneous network, when a network abnormality or network failure occurs, and when the terminal device cannot connect to the multi-mode heterogeneous network, the Web-based signaling tracking. The method can provide a visual tool to analyze the transmission of the signaling, locate the cause of the fault and the faulty device, which is conducive to quickly locating the fault point and quickly repairing the network fault; and is conducive to ensuring the normal operation of the Internet of Things device.

The technical solution provided by the embodiments of the present disclosure adopts the distributed packet capture and control technology: the packet capture service deploys the packet capture in a distributed manner according to the needs; the message queue technology realizes that the control commands of the packet capture start and the packet capture end are released to the corresponding packet capture service, and realize the collection and distribution of the signaling packets captured by the packet capture service; the packet capture control service receives the start packet capture request and stop packet capture request from the front-end page, and sends the start packet capture request and stop packet capture request to the message queue, the packet capture control service receives the information data collected by the message queue, and executes the signaling data analysis service, and then publishes it to the message service after the analysis is completed. The packet capture control service also provides the storage function of the signaling data; using the packet capture protocol technology through. An application protocol formulated for information tracking to control the packet capture process and the transmission of packet capture signaling data throughout the system, including starting packet capture instructions and signaling data packet protocols; using signaling analysis technology: to achieve capture of packet capture services Data analysis of the signaling data, extracting the source IP address of the signaling, the destination IP address of the signaling, time, protocol (tcp, udp, arp, icmp, sctp, sip, etc) and packet data from the signaling data packet; Centralized signaling display technology is adopted: the packet capture control service parses the signaling data packets distributed in different machines and publishes them to the message service, and the front end connects to the message service through Websocket, and displays the signaling data according to the order of the signaling data packets, and displays the data Including: signaling source IP address, signaling destination IP address, time, protocol (tcp, udp, arp, icmp, sctp, sip, etc.) and packet data, and analyze the signaling data displayed visually. Compared with Wireshark, the disclosure provides a signaling tracking tool that is more suitable for intelligent terminal equipment and communication equipment, and is more professional.

### R1-8-24—Network Thermal Analysis, Link Adaptation.

At present, in the Internet of Things, once a terminal is connected to a gateway, the terminal will always transmit data through the gateway. If the terminal can be connected to multiple gateways, the terminal will transmit data to multiple gateways at the same time. The LoRaWAN gateway is an “intermediary” between the device and the network server. Its first job is to receive data packets by selecting the appropriate frequency plan, which of course matches the needs of the equipment in the region in which it is deployed. The second job is to properly forward the data to the web server, during which the LoRaWAN gateway is registered with the packet forwarder. Terminals do not have the ability to select gateways with strong transmission signals to transmit data, and data links do not have adaptive matching capabilities and data disaster recovery capabilities. In order to solve the problems in related technologies, an embodiment of the present disclosure provides a network thermal analysis method.

As shown in FIG. 24-1, in an embodiment of the present disclosure, the network thermal analysis method includes: the terminal sends gateway terminal link test data packets to each gateway, and obtains the communication quality with each gateway; The connected target gateway; the terminal sends data to the target gateway.

In some embodiments, the technical solutions provided by the embodiments of the present disclosure may be applied to the multi-mode heterogeneous core network service shown in FIG. 1. Referring to the process shown in FIG. 1A-FIG. 1D, when a terminal device is connected to a multi-mode heterogeneous network, if the terminal can be connected to multiple gateways, each time the terminal needs to send data, the terminal obtains the information of all gateways that can be connected through the link test. Communication parameters (signal-to-noise ratio and transmission rate), calculate the best channel in the gateway connected to the terminal, and the terminal transmits data to the gateway through this channel. When the terminal detects that it cannot establish a connection with the gateway, the terminal broadcasts this information to the gateway that can establish a connection with it, and the gateway broadcasts and updates and records the connection information. For an invalid gateway, automatically find a gateway node that can transmit, and realize link self-adaptation.

### R1-9-25—an Edge Computing System Based on Low-Power Wide-Area Wireless Internet of Things.

The connotations of the three-tier and six-category edge-cloud collaboration are as follows: Edge computing is neither a single component nor a single layer, but an end-to-end open platform involving EC-IaaS, EC-PaaS, and EC-SaaS. According to the overall structure of edge-cloud collaboration, edge computing nodes generally involve networks, virtualized resources, RTOS, data planes, control planes, management planes, and industry applications, among which networks, virtualized resources, and RTOSs are EC-IaaS capabilities, control plane, management plane, etc. belong to EC-PaaS capabilities, and industrial applications belong to the category of EC-SaaS.

Edge-cloud collaboration involves comprehensive collaboration at all levels of IaaS, PaaS, and SaaS. EC-IaaS and cloud IaaS should be able to achieve resource collaboration on networks, virtualized resources, security, etc.; EC-PaaS and cloud PaaS should be able to realize data collaboration, intelligent collaboration, application management collaboration, and business management collaboration; EC-SaaS and cloud SaaS should enable service collaboration. Resource collaboration. Edge nodes provide infrastructure resources such as computing, storage, network, and virtualization, and have local resource scheduling and management capabilities. At the same time, they can collaborate with the cloud to accept and execute cloud resource scheduling management strategies, including edge node device management and resource management, and network connection management.

Data collaboration: The edge nodes are mainly responsible for the collection of on-site/terminal data, conduct preliminary processing and analysis of the data according to rules or data models, and upload the processing results and related data to the cloud, the cloud provides storage, analysis and value mining of massive data. The data collaboration between the edge and the cloud supports the controllable and orderly flow of data between the edge and the cloud, forms a complete data flow path, and performs lifecycle management and value mining of data efficiently and at low cost. Intelligent collaboration: edge nodes execute reasoning according to the AI model to realize distributed intelligence; the cloud conducts AI centralized model training and distributes the model to edge nodes.

Application management collaboration: Edge nodes provide application deployment and operating environments, and manage and schedule the life cycles of multiple applications on this node; the cloud mainly provides application development, testing environments, and application life cycle management capabilities.

Business management collaboration edge nodes provide modular, micro-service applications, digital twins, and network application instances; the cloud mainly provides business orchestration capabilities for applications, digital twins, and networks based on customer needs.

Service collaboration: edge nodes implement part of ECSaaS services according to cloud policies, and realize customer-oriented on-demand SaaS services through the collaboration of ECSaaS and cloud SaaS, the cloud mainly provides SaaS service distribution strategies in the cloud and edge nodes, as well as SaaS services undertaken by the cloud ability.

Not all scenarios involve the aforementioned edge-cloud collaboration capabilities. Combined with specific usage scenarios, the capabilities and connotations of edge-cloud collaboration will be different. At the same time, even the same collaboration capability will have different capabilities and connotations when combined with different scenarios.

However, the existing edge-cloud collaboration lacks terminals or gateways with intelligent voice and video interaction; lacks integrated edge computing and fog computing systems, and lacks secure computing for edge computing and fog computing systems; In case of deviation, there is no sensor calibration mechanism; edge terminals and gateways lack edge intelligence, and cannot quickly respond to various problems such as abnormal situations in the collection of environmental data. In order to solve the problems in related technologies, the embodiments of the present disclosure provide a low-power wide-area wireless Internet of Things system or an industrial Internet system.

In one embodiment of the present disclosure, a combination of cloud computing, edge computing, and fog computing is adopted. The low-power wide-area wireless Internet of Things system or industrial Internet system includes terminals, gateways, and servers. The terminals, gateways, and servers can all be used as Computing executor; a terminal as the core terminal is configured as the main body of edge computing, and different terminals can communicate with each other to share sensor data and convey execution commands without using a gateway; the gateway is configured as the main body of fog computing, and all terminals covered by the gateway are covered Sensor data and executing commands; according to the different coverage areas of sensor data and executing commands, fog computing can be divided into different areas; the server is configured as the main body of cloud computing, and both the server and the gateway can send executing commands to the terminal; the terminal can execute the The execution status and execution result of the command are synchronized to the gateway and the server.

As shown in FIG. 1-1 and FIG. 4-2, in one embodiment of the present disclosure, the low-power wide-area wireless Internet of Things system or industrial Internet system includes: a sensing terminal with sensing sensors configured to collect sensor data; an executive terminal with an actuator configured to execute actions; a composite terminal with sensors and actuators configured to collect sensor data, execute command actions, inquire about the sensor data collected by the sensing terminal, and report to the execution. The terminal issues an execution command; the mobile terminal with a voice call function is configured to establish a connection with the mobile gateway; the mobile gateway is configured to access the voice call of the mobile terminal; the slave gateway is configured to establish a connection with the composite terminal Connecting, receiving the sensor data sent by the composite terminal, directly issuing an execution command to the composite terminal, and receiving the execution command issued by the master gateway and forwarding it to the composite terminal; the master gateway is configured to connect with the slave gateway, receive. The sensor data reported by the gateway sends execution commands to the slave gateway, and sends sensor data to the server, receives the execution command issued by the server and forwards it to the slave gateway, the server is configured to connect to the master gateway, and receives the report from the master gateway sensor data, issue execution commands to the main gateway, and connect with other servers for data exchange.

In this embodiment, edge computing and fog computing are divided into different scopes, that is, different circles, according to the different coverage areas of sensor data and execution commands. As shown in FIG. 1-1 and FIG. 4-2. IoT layer 1 terminal coverage area: a single terminal has the ability to collect sensor data and execute commands, and obtain data from sensors and upload them to the gateway through configuration. When the communication is abnormal. It can analyze the data by itself and then generate execution commands to start execution actions; IoT layer 2 adjacent terminal coverage area adjacent terminals communicate with each other (not through the gateway) to share sensor data and convey execution commands. One of the terminals, as the core terminal, is responsible for executing the edge computing process; IoT layer 3 single gateway coverage domain: when there is a gateway participating, the gateway is the main body of fog computing for sensor data and executing commands covering the devices covered by the gateway; IoT layer 4 and more Gateway coverage domain: when multiple gateways participate, one of them acts as the master gateway, and the slave gateway communicates with the master gateway to collect the data reported by the terminal, and the master gateway sends the terminal execution command to the slave gateway; IoT layer 5 single system coverage domain: Indicates the server level. The server layer collects the terminal data reported by the gateway, and can generate terminal execution commands and send them to the gateway; IoT layer 6 multi-system coverage domain: indicates cross-project and cross-platform levels; IoT layer+M mobile Terminal domain: Indicates the edge computing level of mobile ad hoc network devices. Mobile devices can be connected to mobile gateways and fixed gateways, and can also be connected to nearby terminals to obtain nearby sensor data. Of course, execution commands can also be directly issued to terminal.

An embodiment of the present disclosure provides a voice interaction device applied to a human-computer interaction terminal and a gateway of a low-power wide-area wireless Internet of Things system or an industrial Internet system, including: a user voice recognition unit configured to recognize user input Speech, and convert the speech into text; the user semantic analysis unit is configured to convert the text into semantics through lexical analysis and grammatical analysis of the text; the instruction generation unit is configured to generate corresponding execution according to the converted semantics. The control instruction of the unit; the instruction control unit is configured to issue a control instruction to the specified execution unit, and the execution unit executes the corresponding action.

As shown in FIG. 25-1, an embodiment of the present disclosure provides a voice interaction method applied to a human-computer interaction terminal and a gateway of a low-power wide-area wireless Internet of Things system or an industrial Internet system, including: identifying the user input Voice, and convert voice into text; through lexical analysis and grammatical analysis of text, convert text into semantics; according to the converted semantics, correspondingly generate control instructions corresponding to the execution unit: issue control instructions to the specified execution unit. The execution unit executes the corresponding action.

An embodiment of the present disclosure provides a video interaction device applied to a human-computer interaction terminal and a gateway of a low-power wide-area wireless Internet of Things system or an industrial Internet system, including, a user action recognition unit configured to use a neural network algorithm Recognize the action of the user; the user action analysis unit is configured to analyze the action of the identified user and obtain the meaning of the action; the instruction generation unit is configured to correspondingly generate a control instruction corresponding to the execution unit according to the analyzed action meaning; the instruction control. The unit is configured to issue a control command to a designated execution unit, and the execution unit executes corresponding actions.

As shown in FIG. 25-2, an embodiment of the present disclosure provides a video interaction method applied to a human-computer interaction terminal and a gateway of a low-power wide-area wireless Internet of Things system or an industrial Internet system, including: using a neural network algorithm Identify the user's action; analyze the identified user's action and obtain the action meaning; according to the analyzed action meaning, correspondingly generate the control instruction corresponding to the execution unit; issue the control instruction to the designated execution unit, and the execution unit executes the corresponding action.

An embodiment of the present disclosure provides a terminal data calibration device based on edge computing mode applied to a low-power wide-area wireless Internet of Things system or an industrial Internet system, including; a unit for receiving real-time data from peripheral terminals, configured to directly Receive the real-time data of peripheral terminals, or receive data from the peripheral forwarded by the gateway; the terminal abnormal data and peripheral terminal data analysis unit is configured to compare and analyze the terminal data with the peripheral terminal data; the identification data abnormal terminal unit is configured to identify the data. An abnormal terminal; a calibration unit configured to determine whether a terminal with abnormal data needs to be calibrated; a terminal calibration instruction issuing unit configured to issue a terminal calibration instruction to a terminal requiring calibration.

As shown in FIG. 25-3, an embodiment of the present disclosure provides a method for calibrating terminal data based on edge computing mode applied to a low-power wide-area wireless Internet of Things system or an industrial Internet system, including: receiving peripheral data directly from the terminal real-time data, or receive data from the peripheral forwarded by the gateway; compare and analyze terminal data with peripheral terminal data; identify abnormal data terminals; determine whether data abnormal terminals need to be calibrated; issue terminal calibration instructions to terminals that need calibration.

An embodiment of the present disclosure provides a device for dynamically adjusting sensor coefficients based on an edge computing mode applied to a low-power wide-area wireless Internet of Things system or an industrial Internet system, including: a unit for receiving real-time data from peripheral terminals, configured to. The terminal directly receives the real-time data of surrounding terminals, or receives data from the surroundings forwarded by the gateway; the analysis terminal data change rate unit is configured to analyze the recent data change rate of each terminal, and compare it with the adjusted terminal data reporting frequency threshold; adjust the reporting frequency. The unit is configured to determine whether the reporting frequency needs to be adjusted according to the comparison result; the unit for sending the terminal reporting time interval instruction unit is configured to send the sensor parameter adjustment to the terminal if the gateway algorithm analyzes that the data reported by the terminal is in a fast-changing interval Instructions to reduce the terminal data reporting time interval, and if the gateway algorithm analyzes that the terminal data reporting changes slowly, the gateway sends sensor parameter adjustment instructions to the terminal to increase the terminal data reporting time interval.

As shown in FIG. 25-4, an embodiment of the present disclosure provides a method for dynamically adjusting sensor coefficients based on an edge computing mode applied to a low-power wide-area wireless Internet of Things system or an industrial Internet system, including: directly from the terminal Receive real-time data from peripheral terminals, or receive data from peripherals forwarded by the gateway, analyze the recent data change rate of each terminal, and compare it with the adjusted terminal data reporting frequency threshold; judge whether the reporting frequency needs to be adjusted according to the comparison results; if the gateway algorithm analyzes. If the data reported by the terminal is in the fast-changing range, the gateway will issue a sensor parameter adjustment command to the terminal to reduce the time interval for terminal data reporting, if the gateway algorithm analyzes that the data reported by the terminal changes slowly, the gateway will issue sensor parameter adjustment to the terminal Command to increase the time interval for terminal data reporting.

In some embodiments, the technical solutions provided by the embodiments of the present disclosure may be applied to edge computing, fog computing, cloud computing, and edge-cloud collaboration shown in FIG. 1. Referring to the process shown in FIG. 1A-FIG. 1D, based on the integrated computing system of edge computing, fog computing and cloud computing of the low-power wide-area wireless Internet of Things, at the edge computing layer, the terminal realizes the Real-time analysis, real-time analysis and real-time calculation and processing of data collected by sensing equipment, using artificial intelligence algorithms to realize real-time recognition and image classification based on real-time images, the combination of rule engine algorithms and artificial intelligence algorithms can generate intelligent alarm information, based on. The alarm information controls the actuator to perform corresponding actions in real time, and supports data exchange and mutual control between adjacent terminals; in the fog computing layer, the main gateway can obtain the data reported by the terminal with the slave gateway, and can execute tasks requiring more computing resources. Complicated calculation and data analysis, and supports data analysis of the data reported by the terminal in the area, supports identification of abnormal terminal devices with reported data based on the data reported by peripheral devices, and sends terminal calibration instructions to the terminal for terminal calibration. The main gateway also supports Indirectly issue control instructions to the execution terminal by issuing instructions from the gateway; the cloud service layer supports functions related to machine learning, data analysis, model data training, data prediction and decision analysis for massive data.

In the embodiments of the present disclosure, by introducing the cloud-edge cooperative computing framework, the tasks of coordinating edge computing, fog computing, and cloud computing are effectively assigned and coordinated, and the communication and network transmission are controlled to adapt to the changes in transmission requirements; otherwise, when the network status changes, the cloud-edge collaborative computing framework can also dynamically adjust the computing strategy. The cloud-edge collaborative computing framework coordinates the task allocation of cloud computing, fog computing, and edge computing, and realizes cloud-edge computing collaboration. The cloud-edge collaborative computing framework allocates tasks according to the requirements definition of the business platform, the communication big data of the multi-mode heterogeneous network, and the communication and computing capabilities of the gateway and the terminal. FIG. 4-1 shows the cloud-edge collaborative highly configurable edge computing framework. FIG. 4-2 shows the edge computing decision-making loop structure. As an example: a vision-based fire protection system, both on-site image sensing devices and the cloud have firework recognition capabilities based on deep learning, and the sensing devices use uncompressed image data, which is more friendly to the algorithm, because only the recognition results need to be transmitted instead of the image being sent to the cloud, so the communication requirements are also low. When the limited computing power of the sensing terminal still limits the recognition ability of the algorithm, the corresponding cloud computing uses the compressed image returned by the sensing terminal through the network, and the multi-identification algorithm and the requirements for network transmission are higher, but the computing power in the cloud is relatively abundant. Reasonably combining the advantages of edge computing and cloud computing can effectively improve the recognition rate and reduce the false positive rate, so it is necessary to dynamically adjust the task ratio, time domain allocation, and mutual compensation rate of cloud edge computing to a reasonable range, while the multi-mode heterogeneous network. The communication dynamic adjustment feature provides the necessary support for the dynamic communication requirements brought about by the cloud-edge computing coordination adjustment. In order to take into account the needs of network disconnection and self-control in some scenarios, the gateway and terminal can have two different sets of task groups, one for use when the network is unblocked, and the other for use when the network is disconnected. Decision-making can also be made independently at any time, avoiding decision-making failure and decision-making delay caused by network disconnection and weak network. When the network is unblocked, we hand over the authority to the gateway or the upper server. As an example, there can be multiple sets of different task groups. We can even say that we can divide the weak network, disconnected network and smooth network. We can divide more situations. In each case, we should use different task group strategies, and then Let the gateway and the terminal take their respective responsibilities. In the embodiments of the present disclosure, the devices at the terminal layer are connected to the multi-mode heterogeneous IoT sensing platform, and the multi-mode heterogeneous IoT sensing platform manages the devices at the terminal layer and the communication layer, providing information based on industry requirements or/and physical locations. Multi-mode heterogeneous network services and edge computing services that dynamically adjust any communication parameters. Ad hoc network communication uses negotiation channels and data channels. The negotiation channel is used for device network access, status announcement and communication negotiation; the data channel is divided into broadcast channel and directional channel, the broadcast channel is used to send multicast and broadcast data, and the directional channel is used for node-to-node communication; the broadcast channel and directional channel can for the same transceiver. The network access process uses the network access request and network access response methods. The network access response includes the interconnection status between devices (whether communication is possible, link status). Devices that have joined the network or are preparing to join the network can send network access responses in multiple windows according to the distance between them and the network-connected device (using the received signal strength) The number of windows and the distance range corresponding to each window are defined according to actual needs; devices in the same window Using random delay and detecting channel occupancy before sending has fewer conflicts. When the nodes use the negotiation channel to communicate, determine the communication rate and transmission power according to the actual radio frequency situation; when the data needs to be routed by the intermediate node, the communication between the node and the route, and between the route and the route can use different channels and rates according to the actual radio frequency environment, function and other parameters. FIG. 18-1 shows the state diagram of the terminal node state switching, FIG. 18-2 shows the network access process of the terminal node, FIG. 18-3 shows the sending and receiving process of the terminal node after network access, and FIG. 18-4 shows the data sending request and response process, FIG. 18-5 shows the data sending process, and FIG. 18-6 shows the summary of the negotiated channel package.

The technical solution provided by the embodiments of the present disclosure adopts the gateway or terminal technology capable of man-machine interaction with touch display screen, voice interaction, and video interaction. Converted into text, through the semantic analysis of the text, identify the meaning of the text, and finally form instructions to execute corresponding actions or control related actuators. The video interaction terminal recognizes the response actions of people in the video through the neural network model, and interprets the corresponding meaning of the actions, and finally forms instructions to execute corresponding actions or control related actuators; adopts secure computing technology, uses terminal authentication mechanism, blockchain technology and data encryption technology to realize the secure computing of the edge computing system, realize the security computing of the border side such as access control, transmission direction control, industrial protocol analysis, situation awareness, etc; data encryption and decryption, local storage of UID and related characteristics as key factors; data transmission Encryption and decryption; data end-to-end verification; terminal data calibration technology based on cloud and edge mode is adopted, and terminal data calibration technology based on gateway and cloud is supported. The master gateway can obtain the data reported by the terminal with the slave gateway, analyze the data reported by the terminal in the area, identify the abnormal terminal equipment with reported data based on the data reported by the surrounding equipment, and send a terminal calibration command to the terminal for terminal calibration; cloud support Machine learning and artificial intelligence algorithms are used to analyze the terminal data and surrounding data with abnormal data, and identify whether the terminal reports abnormal data. If it is a terminal with abnormal data, send a data calibration command to the terminal to perform data calibration on the terminal; use dynamic adjustment sensor coefficient, the gateway automatically judges whether to adjust the terminal data reporting frequency to the optimal data reporting frequency according to the terminal data reporting situation. If the gateway algorithm analyzes that the data reported by the terminal is in the fast-changing range, the gateway sends sensor parameter adjustment instructions to the terminal to reduce the time interval for terminal data reporting; if the gateway algorithm analyzes that the data reported by the terminal changes slowly, the gateway sends the Issue sensor parameter adjustment instructions to increase the time interval for terminal data reporting. The technical solutions provided by the embodiments of the present disclosure, the low-power wide-area wireless Internet of Things edge computing, and the fog computing mechanism can effectively improve the rapid response capability of the entire Internet of Things to sensor data collection, and are suitable for application scenarios that require high system response time. It can be satisfied; at the same time, the system can respond quickly under abnormal network conditions; the gateway or terminal technology capable of man-machine interaction with touch screen, voice interaction, and video interaction can interact with people in a more natural way, providing Very good human-computer interaction method; secure computing technology can ensure the security of data transmission in the entire data transmission link, prevent tampering, ensure data integrity and consistency, and effectively prevent illegal devices from invading the IoT network; terminals based on cloud and edge models. The data calibration technology can effectively ensure the validity of the data reported by the terminal; dynamically adjusting the sensor coefficient can allow the terminal to upload data as much as possible at critical moments, which is conducive to more accurate analysis of the data; reducing the frequency of data reporting at non-critical moments is beneficial to battery-powered terminal equipment. Extend terminal use time.

Data intelligent fusion platform, including technologies numbered R2-1 to R2-12 and R3-1 to R3-2. As shown in FIG. 1, the intelligent data fusion platform R2 provides cross-departmental and cross-industry services including structured, semi-structured, and unstructured multi-source heterogeneous data collection, data cleaning, data fusion, resource catalog, and data sharing and exchange Serve. Data aggregation can be connected to the sensor data uploaded by the multi-mode heterogeneous IoT sensing platform, and the data shared by other third-party platforms or upper-lower-level platforms, and unified aggregation forms a data lake. At the same time, it gathers business data/control data/algorithm early warning data/required data of different industries/physical location data, etc that are generated or need to be interacted with other sectors (business sectors, other support sectors). Data cleaning, fusion, and resource catalogs mainly manage and classify the aggregated data to form various theme libraries and topic libraries, etc. to facilitate the extraction of different business data. Support platforms such as platforms and streaming media platforms and artificial intelligence business platforms provide the data they need. Data sharing and exchange, providing data sharing and exchange with third-party platforms and upper and lower platforms.

The implementation of the intelligent data fusion platform of the support layer of the present disclosure will be described in detail below in conjunction with exemplary embodiments.

### R2-1-26—Data Intelligent Fusion Platform.

In related technologies, the business model is single, and there is a single line from design to implementation. Adding or modifying business requires redesign and development, and the processing logic and development costs are high; the data model is single, and the data source and data format are fixed from the design stage, The data firmly restricts the business, there is no horizontal expansion capability and data carrying capacity; the data caliber is inconsistent, and the data caliber of each business department or industry is inconsistent, which leads to the reduction of data credibility and makes cross-industry and cross-department cooperation difficult. In order to solve at least one of the above problems, for example, to improve the shareability of multi-source data, an embodiment of the present disclosure provides an intelligent data fusion platform. For the smart city management platform, it can provide industrial IoT hardware data collection, multi-platform data collection and exchange, uniformly provide raw data to the data review platform, lower-level site hourly day-month annual report, site data intelligent algorithm data set, similarly for existing Some smart management platforms do not need to re-connect to hardware for repeated function development.

Exemplarily, an application scenario of the data intelligent fusion platform provided by the embodiments of the present disclosure is the flame picture captured by the camera is transmitted to the algorithm center to trigger an alarm, and at the same time, all device data around the camera, all weather data, and all website-related data are obtained. The data is correlated in the same time range and the same space range, and the results are transmitted to the algorithm platform for fire spread simulation.

The embodiment of the present disclosure provides a solution for realizing an intelligent data fusion platform. For example, a data platform can be built step by step from bottom to top by underlying technology, and data can be carried by technology, and services can be supported by data, which can include: building a data circulation system, collecting data from multiple sources. Synchronization and fast data storage are the goals, and multi-source heterogeneous data is collected and stored in the data lake; the data lake is stored in a unified manner, and data services can be multi-dimensionally integrated according to industries and applications. On this basis, all data can be integrated into Perform upward query output in a multi-dimensional way; build a set of data centers on top of the data lake, and the data center provides data query services to business application platforms according to industry and application divisions, build a data service system, and analyze all data in the data lake according to requirements Carry out flexible fusion governance, the ultimate goal is to meet the data output quality of the data center; build task management services, monitor and maintain management for all data processes; build data intelligent fusion platform application systems, based on the combination of data service system and task management services, to carry out visual user management to enhance the value of data use. The data intelligent fusion platform provided by the embodiments of the present disclosure can be used as the data intelligent fusion platform shown in FIG. 1, which can support data collection, data cleaning and data fusion, and the collected/processed data can be stored in the data lake for subsequent use Applications. In addition, the data intelligent fusion platform provided by the embodiments of the present disclosure can also be applied to the steps of data fusion, data collection, and data storage shown in FIG. 1A, FIG. 1B, FIG. 1C and FIG. 1D (ie, FIG. 1A-ID). It can be used to support the operation of the multi-mode heterogeneous Internet of Things in FIG. 1A-ID.

Exemplarily, as shown in FIG. 26-1, data access is responsible for collecting and storing data from different data sources in the data lake, the data collection service reads the data and sends it to the data authentication analysis service, and the data synchronization service acquires business. The data information of the platform is stored in the data cache service. The data cache service stores the business data and its corresponding real-time data status. The data authentication analysis service compares the data with the information configured by the business system for authentication, and obtains the business after passing the verification. The analysis protocol configured by the system performs data analysis and converts data in different formats into the same data format. After the conversion is completed, the data is stored in the data lake through the data storage service; the data lake is composed of a database cluster, a data warehouse and a file system, and the database cluster mainly stores Business data, to ensure daily business flow, the data warehouse stores the collected raw data and the results of data ETL, data governance, and data mining based on the data, and the file system mainly stores unstructured data files including database backup files. The data center reads all the data in the data warehouse to provide query services, the data service is based on a complete set of data systems implemented on the data lake, including any operation of the application system on the data lake, and provides service support for the business platform; the task management system provides support for the entire. The ecological process management system manages and monitors the data process to realize the controllable, traceable and traceable data process; the application system is a comprehensive management platform for user visualization and interactive configuration, which is divided into a big data platform for integrated management of data and a big data platform for A business platform for industry application business management. Exemplarily, as shown in FIG. 26-2 and FIG. 26-3, the hardware end accesses the multi-mode heterogeneous wireless hosting network for networking; the receiver receives the registration information and data information from the hardware; receives the data and performs data decoding processing, send the decoded data to the logic processor; determine whether to send the response data, and whether to send the data receiving interface. Components may include: receivers, decoders, logic processors. Among them, the receiver is configured to receive the original message reported by the device; the decoder is configured to convert the original message bytes into readable characters; the logic processor triggers the corresponding logic according to the relationship between the characters, such as the registration packet returns the registration. As a result, the heartbeat packet returns successfully, and the data packet is pushed to the data receiving interface. Exemplarily, as shown in FIG. 26-4, the webpage receives network transmission data; obtains the corresponding webpage address for access; judges whether the data is obtained in the exposed interface address or through page rendering; page rendering needs to start a browser driver. Accessing the webpage automatically executes the webpage logic on the webpage to obtain the return result of the element; the interface starts an interface requester to simulate the request to obtain the return result; and sends the return result to the data receiving interface. Components may include: browser drivers, crawler scripts. Among them, the browser driver is responsible for starting and accessing webpages in the background to implement page logic; the crawler script is responsible for receiving the data returned by the browser driver for data processing and sending the data to the data receiving interface.

Exemplarily, as shown in FIG. 26-5, the external system stores data in the database or message queue, starts the data exchange process to extract data, obtains data from the storage location corresponding to the data lake and compares the extracted data to meet the requirements Perform data batch processing on the data to obtain data with a consistent structure with the data lake; send the data to the data storage service; perform checkpoint status storage at each step, record the data execution status of each step, checkpoint for log records. Components can include, data extraction, data reading, data association, data batch processing, data storage, and checkpoints. Among them, the data extraction component is responsible for establishing a connection with the external database and reading the corresponding data; the data reading component is responsible for reading the data corresponding to the storage location of the data lake; the data association is responsible for logically associating the two parts of data obtained by data extraction and data reading. In order to decide whether the extracted data is needed, the associated result data will be sent to the batch processing data: the data batch processing will perform unified data conversion on all the extracted data to obtain the data conforming to the data lake structure; the data storage is responsible for writing the corresponding data set into the corresponding data. The location of the lake; the checkpoint is responsible for recording the execution status of each step, and writing the data before and after execution to the log.

Exemplarily, as shown in FIG. 26-6: the server specifies a directory to generate data files; the listener listens to the directory to obtain data; the interceptor receives the data sent by the listener and performs business logic processing on the data: the selector receives data according to the data storage destination Send to different transmission channels; the data storage service obtains data from different transmission channels for data storage; the components can include: listeners, interceptors, and selectors. Among them, the listener listens to files in multiple directories, and when the file has content added, it will convert the data into an event and send it downstream, including the event header and data content; the interceptor intercepts the data from the listener, and sends the event header according to the requirements Add content; Selector A data can have multiple data transmission channels, and the selector sends the event to the specified transmission channel.

Exemplarily, as shown in FIG. 26-7, the data authentication analysis service initiates registration with the registration center; the registration center feeds back to the service after completing the registration; the data authentication analysis service starts load balancing and fuse downgrade services among the registration centers; The data authentication analysis service exposes the data receiving interface to the outside world Components can include: data authentication analysis service, load balancing, fuse downgrade, registration center. Among them, the data authentication and analysis service is responsible for receiving data from the data receiving interface and executing logic codes; the registration center load manages the service status of the entire system cluster, and conducts online inspection of distribution management for the data authentication and analysis service; load balancing is responsible for receiving data at the data receiving interface Unified data distribution to balance the amount of data received by each data authentication and analysis service; fuse downgrade is responsible for monitoring the load of data receiving interface data to each data authentication and analysis service, and if the load exceeds the threshold, the service will be closed or no data transmission will be performed.

Exemplarily, as shown in FIG. 26-8, the data receiving interface receives a piece of data; obtains device information from the data cache, including basic network information of the device, device protocol script, detailed information of device parameters, and device application information; combines the device information with. The device data is sent together to the device information authentication for association comparison; the comparison is successfully sent to the device protocol decoder for decryption and decoding of the data packet to form structured data; the data decoding is completed for parameter matching, and the data is organized in a fixed and unified format; Log records are executed during each step, which is convenient for traceability and data replenishment; data and process logs are sent to the message queue, and data is sent to the data cache to store the latest data status. The components may include: data authentication, data decoding, data parameter assignment, and data transmission. Among them, data authentication is responsible for associating the device information with the device information contained in the data of the data receiving interface; data decoding is responsible for decrypting and decoding the data packets that pass the authentication, and converting them into structured data; data parameter assignment is responsible for The structured data parameter names are re-changed so that they are unified as the parameter names of the database configuration; the data sending component is responsible for refreshing the real-time data in the data cache to facilitate real-time query of the data status.

Exemplarily, as shown in FIG. 26-9 generate query logic from the business database, the data cache library generates query logic from existing data; the query device obtains the query logic to execute and obtain data; the data processor processes the data so that it can be written into the cache. The data in the database, and after writing, the original data will be overwritten, the original redundant data will be deleted, and the data status will be updated. Components may include: business database, queryer, data processor, and cache database. Among them, the business database is responsible for storing the business data that needs to be synchronized; the queryer is responsible for the associated query of the data in the business database, the cached data is queried from the cache database, and it has been decided which data is updated, which data is inserted, and which data is deleted; the data processor Process the data obtained by the queryer and write it into the cache database; the cache database is responsible for storing the data of the business database in memory, and periodically persisting it to achieve efficient reading and writing.

Exemplarily, as shown in FIG. 26-10, the components may include: data storage services, data analysis warehouses, business databases, file storage systems, and object storage systems. Among them, the data storage service stores data from different data sources and different data structures according to different storage locations; the data analysis warehouse inputs the dimensional model, and the data service performs data acquisition on this basis; the business database is connected to the multi-mode heterogeneous IoT sensing platform. The data intelligent fusion platform obtains original business data, and performs statistical analysis of business indicators on this basis; file storage is mainly for unstructured and semi-structured data files, which can be processed uniformly through file batch processing; object storage is mainly for fast storage Fast reading of multimedia files for processing.

Exemplarily, as shown in FIG. 26-11, the establishment of the data model is input to the database management service for database construction; the database management service performs query management for the metadata and data definitions in the data lake, online analysis query reads data from the data lake for execution Data analysis; data mining uses artificial intelligence industry algorithm middle-end algorithms to obtain the results of online analysis and query for algorithm model calculation; lineage analysis queries the data log in the data lake for retrospective retrieval of data; data quality reads data from online analysis and query for data Quality inspection to confirm whether the data meets business expectations, and the problem data is sent to the data notification service; data operation and maintenance monitors the data and services in real time, judges offline and abnormal values, and sends the alarm data to the data notification service and multi-mode heterogeneous IoT sensing platform: data notification service is responsible for sending data messages, including various Internet messages. Internet of Things upstream and downstream messages; document management obtains all data files from the data lake, and multimedia files are provided to the artificial intelligence industry algorithm platform; data intelligent fusion platform WEB The client creates a task plan and submits it to the task management service, and the task management generates a data process to specifically execute all the above data processing logic; the data center queries all data from the data lake and provides it to the business platform. Based on the data intelligent fusion platform provided by the embodiments of the present disclosure, as shown in FIG. 26-12, it can support multi-industry data access, for example, it can include air, meteorology, soil, transportation, construction, water quality, fire insurance, etc. including environmental protection, fire protection. Multi-industry data, including municipal administration, is first connected and then integrated to break through industry barriers; it supports multi-source heterogeneous access, including multiple data sources such as databases, file systems, and message queues, as well as structured, semi-structured, and unstructured data Structure, data sources can be expanded indefinitely, data capabilities can be copied indefinitely, providing huge data resources for various business scenarios; unified data specifications, providing a unified data dictionary and data specifications, reducing development costs and improving data quality; creating city-level data Intelligence provides multi-dimensional perspectives for cities. For business scenarios, it can recognize images from cameras, sensor data, platform release data, and algorithm prediction data to understand problems from different angles and create an all-round digital city.

### R2-2-27—Multi-Mode Heterogeneous Sensor Data Access.

In related technologies, there are some problems as follows. With the increase of sensor data and the continuous expansion of various third-party data sources, resource utilization is unbalanced on the basis of the existing Internet of Things architecture; code reuse, the same logic But there are two pieces of the same code; the key function is missing, and the function cannot be realized when it is executed to a certain process node and found that the previous process is not supported; single point of failure, if an error occurs in a certain node, the entire data process cannot be carried out; data query low efficiency.

In order to solve at least one of the above problems, an embodiment of the present disclosure provides a multimode-based heterogeneous sensor data access framework. Based on the multi-mode heterogeneous sensor data access framework provided by the embodiments of the present disclosure, whenever a device is connected, it is only necessary to configure the basic information of the device, configure the address of the server on the device, and configure the monitoring of the corresponding protocol on the server module, establish a network connection, and then complete the device access.

The multi-mode heterogeneous sensor data access framework provided by the embodiments of the present disclosure can be applied to the architecture shown in FIG. A data access framework between a gateway/base station and a gateway/base station, between a terminal and a server, and/or between a gateway/base station and a server. In addition, the multi-mode heterogeneous sensor data access framework provided by the embodiments of the present disclosure can also be applied to the architecture shown in FIG. 1A, FIG. 1B, FIG. 1C and FIG. 1D (ie, FIG. Data access between terminals, terminals and gateways/base stations, gateways/base stations and gateways/base stations, terminals and servers, and/or gateways/base stations and servers in FIG. 1A-ID A framework to support the operation of the multi-mode heterogeneous Internet of Things in FIG. 1A-1D. As shown in FIG. 27-1 and FIG. 27-2, the multi-mode heterogeneous sensor data access framework provided by the embodiment of the present disclosure includes device-side sending program, multi-mode heterogeneous network, multi-module receiving end, data Parsing end, message queue. Among them, the device sending program is for the hardware to convert the collected data into network transport layer data, and send data packets through the multi-mode heterogeneous network; the multi-mode heterogeneous network realizes the network communication data transmission between the hardware and the platform; the multi-module receiving end is responsible for receiving. The data of different protocols is sent to the service analysis end; the service analysis end distributes the data in a balanced manner and concurrently processes and sends them to the message queue; the message queue is responsible for caching data for consumption by subsequent services.

As shown in FIG. 27-1 and FIG. 27-2, the method of using the multi-mode heterogeneous sensor data access framework provided by the embodiment of the present disclosure, or a method based on multi-mode heterogeneous sensor data access, including: the device starts the network transmission program, and transmits data to the data receiving module of the specified port; the data receiving module receives the data for format verification, log storage, and sends the verification to the data analysis service; the data analysis service registers with the registration center and sends it to the data. The data of the parsing service obtains the registered data parsing service through the load balancing service and sends it to one of the data parsing services through the load balancing algorithm, and monitors the data flow if the fuse is downgraded; the device issues instructions and the control layer sends control commands to the data parsing service; the data. The parsing service receives the data and starts the thread; according to the device, obtain the device information corresponding to the device and the device parsing script; if the sensor device needs to be transmitted by the transmission device, it will be associated, and the data needs to be sent to the transmission device; execute the data parsing script. And return the parsing result parsing log; judge whether the data is uplink data or downlink data, uplink data needs to be converted to device parameters, and downlink data is sent to the corresponding device receiving module, which sends the data to the device end; the analysis result Perform device parameter association conversion and send the result to the message queue.

The multi-mode heterogeneous sensor data access framework provided by the embodiments of the present disclosure the overall selection of micro-service architecture and the same registration center. Data receiving module; use various communication protocol technologies to receive data, responsible for sending data to the data analysis module, including: TCP service receiving uses high-performance NIO framework to receive TCP/IP communication protocol data, MQTT service receiving uses real-time message queue to receive MQTT communication protocol Data, the Lora service receives the Lora communication protocol; the http service receives the interface request sent by the device, the UDP service receives the UDP communication protocol data. Data analysis module: The data processing module is deployed in a distributed manner, using load balancing to call the interface between the data receiving module and the data analysis module, to realize the fuse degradation between service calls, to prevent the avalanche effect, to realize the online documentation and debugging function of the interface, and to use. The cache database is responsible for storing authentication information, parsing scripts, and data information, using script-driven classes to call parsing scripts to implement data parsing, and the message queue is responsible for receiving all data as a cache queue before data storage.

Based on the multi-mode heterogeneous sensor data access framework and its usage method provided by the embodiments of the present disclosure, it solves code reuse, avoids multiple exits for one piece of data, and eliminates coupling between services; solves resource utilization imbalance, distribution. The deployment of real-time load balancing is easy to expand, and it also solves the problem of single point of failure; solves the problem of low query efficiency and improves query efficiency.

### R2-3-28—Fixed-Point Access of IoT Sensor Devices.

In the industrial Internet system of the related technology, after the sensor device is connected to the system, if all the sensor data are stored together, there will be problems in query efficiency and field structure; if the sensor device data is classified and stored, how to classify How to manage, how to synchronize the stored location when the user queries; it is inconvenient for the user to understand the data content of the sensor and the corresponding meaning of the parameter name.

In order to solve at least one of the above problems, for example, to improve data query efficiency, as shown in FIG. 28-1 and FIG. 28-2, an embodiment of the present disclosure provides a fixed-point access method for IoT sensor devices, including: WEB terminal Create an application, create a logo under the application and create a data table under the application; create device information for a new access device, add device parameters, and select the application corresponding to the device; the association of application-device-device parameters will generate the data. The data model corresponding to the table is written into the database for storage; the data synchronization component synchronizes the data model to the cache library, when the data uploaded by the sensor device is sent to the data storage service, the data storage service obtains the device parameters in the cache library, and the device needs. The name of the library table to be written, and the configured parameter limit are associated with each piece of data. If the value is not within the parameter limit, the data will be written into the exception table; normal data is encapsulated into the data structure of the corresponding data table through data processing written to the database table.

The fixed-point access method for IoT sensor devices provided by the embodiments of the present disclosure can be applied to the architecture shown in FIG. The data access method between the terminal and the server, between the gateway/base station and the gateway/base station, and/or between the gateway/base station and the server, and based on the fixed-point access method of the IoT sensor device provided by the embodiment of the present disclosure. The collected data can be stored in the data lake shown in FIG. 1 for application in the Internet of Things that supports multi-mode heterogeneity. In addition, the fixed-point access method for IoT sensor devices provided by the embodiments of the present disclosure can also be applied to the architecture shown in FIG. 1A, FIG. 1B, FIG. 1C and FIG. 1D (ie, FIG. Data access between terminals, terminals and gateways/base stations, terminals and servers, gateways/base stations and gateways/base stations, and/or gateways/base stations and servers in Figures LA-ID method to support the operation of the multi-mode heterogeneous Internet of Things in FIG. 1A-ID.

Exemplarily, as shown in FIG. 28-1 and FIG. 28-2, based on the fixed-point access method for IoT sensor devices provided by the embodiments of the present disclosure, whenever a device is connected, it is only necessary to configure the corresponding Application, and then configure the corresponding identifier and corresponding table name of the application. When you want to query sensor data, you can obtain the table corresponding to the application configuration and the parameter attributes corresponding to the device. The page configuration device access point does not need to move the background.

Exemplarily, the fixed-point access method of the IoT sensor device provided by the embodiments of the present disclosure can be implemented through the following components/components: WEB terminal, business database, data synchronization, cache library, data storage, and data lake. Among them, the WEB side is responsible for configuring the relationship between applications, devices, and device parameters, and the data model can be generated by using the relationship; the business database is responsible for storing the relevant information of the device data model; data synchronization is responsible for synchronizing the data model in the business library to the cache library Medium; the cache library is responsible for storing the data model in the memory for fast reading and writing, the data storage load reads the data model of the cache library, performs association logic with the data reported by each sensor, and writes the result into the data table; the data lake is responsible for Manages storage of all write data tables.

The fixed-point access method of the IoT sensor device provided by the embodiment of the present disclosure uses the WEB terminal+business database+cache+fixed data flow to realize dynamic configuration, and does not need to go to the code layer to modify the storage logic, which can avoid dead code, high coupling. Reduce code development; realize dynamic management of equipment data storage, reduce development costs; real-time changes take effect, with higher modification efficiency.

### R2-4-29—Based on the Secondary Development of Data X to Realize Data Access of Multiple Data Sources.

In related technologies, a single data synchronization tool DataX cannot meet the data synchronization requirements of multiple data sources. DataX can only support a single data source for data source synchronization during data synchronization, and cannot selectively perform data synchronization of data sources, DataX open source. The version only supports stand-alone mode, does not support distributed mode, and needs to rely on the scheduling system; DataX's native data migration tool does not have automatic functions, and requires manual configuration of a large number of synchronization tasks; lack of flexibility, manual allocation of separate synchronization tasks. Time-consuming and labor-intensive, it is impossible to flexibly perform data synchronization tasks and reduce manual intervention; without task management functions. Data X can only record tasks through user's own scripts or forms, and can only be used as a temporary data synchronization tool.

In order to solve at least one of the above problems, for example, in order to simplify the data operation process, etc. as shown in FIGS. 29-1 and 29-2, the embodiment of the present disclosure provides a data access method for multiple data sources based on secondary development of DataX. Including: microservice startup interface, synchronization configuration parameters to start tasks, configuration of related data synchronization parameters according to the type of data source; the service will open a job job team to check the data source connection, determine whether the connection is successful, and start the job container; a single. The data synchronization job will be divided into small task tasks according to the degree of parallelism, and the task will be executed as the smallest unit of the job; the job container will open the scheduled for scheduling, and the scheduling will open a taskgroup group, and a taskgroup is composed of multiple tasks; according to multiple custom data. The source driver divides the data source to execute each task. The Readerjob reading module will perform the operation, and at the same time, the result will enter the channel data buffer channel; the Reader reading module and the Write writing module plug-in will store the data in the message queue synchronously.

The data access method for multiple data sources based on the secondary development of DataX provided by the embodiment of the present disclosure can be applied to the architecture shown in FIG. between the terminal and the server, between the gateway/base station and the gateway/base station, and/or between the gateway/base station and the server, and realize multiple. The data collected by the data source data access method can be stored in the data lake shown in FIG. 1 for application in the Internet of Things that supports multi-mode heterogeneity. In addition, the data access method for multiple data sources based on the secondary development of DataX provided by the embodiment of the present disclosure can also be applied to the architecture shown in FIG. 1A, FIG. 1B, FIG. 1C and FIG. 1D (ie, FIG. 1A-ID). For example, it can be used as a connection between each terminal and terminal, between a terminal and a gateway/base station, between a gateway/base station and a gateway/base station, between a terminal and a server, and/or between a gateway/base station and a server in FIGS. 1A-1D Data access methods to support the operation of the multi-mode heterogeneous Internet of Things in FIG. 1A-ID.

In one embodiment of the present disclosure, the data access method based on DataX secondary development provided by the embodiment of the present disclosure to realize multiple data source data access can be implemented based on the following components/components: service caller, parameter parser, rule processing engine, data execution device Among them, microservice interface: configured as an interface exposed synchronously by multiple data sources, users can directly operate and configure parameters; jobContainer (job container): initialization message; Reader (read plug-in): data acquisition module, which is Configured to collect data from the data source; Writer (write plug-in): data writing module, configured to write to the data source of the target, here is the write message queue: channel (buffer channel): used to connect the Reader data acquisition module and Writer data writing module, as the data transmission channel of the two, and handles core technical issues such as buffering, flow control, concurrency, and data conversion; TaskGroupContainer (task group container): contains multiple task tasks, and the taskgroupRunner can start task tasks. The execution method is to register the task task according to the configuration file, so as to cooperate with the taskExecutor to execute the task; Scheduler (scheduler): divide multiple task tasks and assign them to different taskgroups, jdbc driver class: set multiple data sources jdbc driver mode, so as to connect multiple data sources; message queue: the data source for data writing, which is convenient for subsequent use of other data sources.

The data access method of multiple data sources based on the secondary development of DataX provided by the embodiments of the present disclosure can be applied in various business scenarios, and data synchronization services of data sources such as hbase, oracle, and mysql can be simultaneously performed. Exemplarily, the customer will perform data synchronization and migration of multiple data sources, and the microservice interface is exposed to the user. The user only needs to call the interface of multiple data sources and configure parameters to realize data synchronization and migration of multiple data sources. The time to deploy DataX and configure DataX tasks does not need to synchronize and migrate data on the server, but only needs to synchronize and migrate data in a normal environment.

Based on the data access method of multiple data sources based on the secondary development of DataX provided by the embodiments of the present disclosure, data synchronization task management of multiple data sources can be realized, and multiple tasks can be processed simultaneously. Exemplarily, the user can directly call the microservice interface to concurrently perform data synchronization and migration of multiple data sources, and call this interface multiple times at the same time to perform concurrent tasks, and will not manually perform data synchronization and migration as frequently as DataX Migration saves manpower and time. At the same time, the microservice interface can be configured and monitored to manage and monitor tasks to ensure the completion of data synchronization and migration tasks.

The embodiment of the present disclosure provides a data access method based on DataX secondary development to realize multi-data sources, modify the scheduling entry, and change it to a micro-service interface; modify the data integration logic to unify the data format; add log entity classes, and implement log in factory mode Real-time printing, data source multi-source access, add custom data source access class, data output end is unified as message queue; add task entity class, realize task scheduling function.

The embodiment of the present disclosure provides a data access method based on DataX secondary development to realize multiple data sources. The deployment of microservices is simple, the process is simple, and the process of operation can be directly simplified. Only the parameters of related data synchronization data sources need to be configured to perform data synchronization. Synchronization and migration; flexible operation, no need for a large amount of manual intervention, only simple and flexible operations can be used to synchronize and migrate data; with task management functions, it can meet the needs of standardized operation and maintenance, perform task management, progress tracking, calibration A series of functions such as verification;

data synchronization and migration speed is fast, and the amount of data is large, which can meet the needs of multi-data source synchronization.

### R2-5-30—Data Access Load Balancing.

The data access process involves receiving, processing, and storing. If there is a problem in any link, it will cause the data access to fail. Therefore, each link must consider fault tolerance, and the existing big data technology rarely involves receiving, processing. The traditional network layer lacks some distribution strategies and status monitoring management; how to maximize load performance and achieve fast interaction of data transmission between services is one of the main problems in related technologies.

In order to solve at least one of the above problems, for example, to improve the system fault tolerance level, an embodiment of the present disclosure provides a data access load balancing method, as shown in FIG. 30-1 and FIG. 30-2, including: data processing service start. The program registers with the registration center; the registration center notifies the load balancer which services and interfaces need to be monitored; the data receiving end receives the data and sends the data to the data processing service interface; the load balancer goes to the registration center to query which data processing services are available. If there is no feedback service exception. Polling access to the interface of the data processing service, and check the concurrency, if the concurrency exceeds the limit value, go to the registration center to query the service interface to find the service with the smallest concurrency, if the service with the smallest concurrency also exceeds the limit, close the interface for a long time. The unresponsive thread is judging. If it still exceeds the limit, it will limit concurrent access and return an exception to the data receiving end; the data processing service receives the data and performs data processing; the data storage service performs data storage and storage.

The data access load balancing method provided by the embodiments of the present disclosure can be applied to the architecture shown in FIG. 1, for example, it can be applied between terminals in FIG. Data access between the gateway/base station, between the terminal and the server, and/or between the gateway/base station and the server, and the data collected based on the data access load balancing method provided by the embodiment of the present disclosure can be stored in the. The data lake shown in 1 is used for application in the Internet of Things that supports multi-mode heterogeneity. In addition, the data access load balancing method provided by the embodiments of the present disclosure can also be applied to the architecture shown in FIG. 1A, FIG. 1B, FIG. 1C and FIG. 1D (ie, FIG. Data access between terminals, between terminals and gateways/base stations, between gateways/base stations and gateways/base stations, between terminals and servers, and/or between gateways/base stations and servers in ID to support Operation of multimodal heterogeneous IoT in FIG. 1A-1D.

Exemplarily, the data access load balancing method provided by the embodiments of the present disclosure may be implemented by the following components/components: data receiving end, load balancing, registration center, data processing server end, and storage end. Among them, the data receiving end is responsible for receiving data and sending the data to data processing; load balancing is responsible for monitoring and intercepting the data sent to data processing, to determine the data to be sent to a specific service node, the registration center is responsible for the same management data processing services: service. The processing server is responsible for uniformly processing the received data in order to store the data; the storage end is responsible for persistent storage of the data.

Exemplarily, an application scenario of the data access load balancing method provided by the embodiments of the present disclosure is as follows: whenever a device is connected, it is only necessary to configure the application corresponding to the device, and then configure the corresponding identifier and corresponding table name of the application, when you want to query sensor data, just get the table corresponding to the application configuration, and get the parameter attributes corresponding to the device. The page configuration device access point does not need to move the background.

Based on the data access load balancing method provided by the embodiments of the present disclosure, the receiving end uses multiple entries for data transmission to ensure that there will be no single-point problems. The data processing and receiving data entry adopts load balancing, and the strategy is to use multiple services to register with the registration center, when a piece of data comes, it will poll and use the service interface to process the data. When the concurrency of the polled service interface exceeds the limit, it will find the service with the smallest concurrency among all registered services. If the service with the smallest concurrency still exceeds the limit. Then the thread that has not responded to the interface for a long time will judge whether the concurrency is over limit. If it is still over limit, a service exception will be fed back to the data receiving end.

Based on the data access load balancing method provided by the embodiments of the present disclosure, it can balance the resource utilization of the system and prevent data avalanche; support dynamic horizontal expansion to meet the high availability requirements of big data, improve system fault tolerance, and coordinate various services with health monitoring data transfer between them.

### R2-6-31—Data Analysis Service.

Most of the data analysis in related technologies is implemented on the code side, which does not support a variety of data analysis and cannot be expanded; data analysis is implemented in various ways and cannot be unified, and there is no centralized management system, data analysis in related technologies. The method has only a single function, lacks fault tolerance, lacks high-load tuning, and lacks high-availability performance.

In order to solve at least one of the above technical problems, for example, to improve product compatibility, an embodiment of the present disclosure provides a data parsing method, as shown in FIG. 31-1 and FIG. 31-2, including: The service selects a specific data analysis service node to input data; the circuit breaker will monitor the flow of the data, if it exceeds the threshold, it will not be executed on the node, and will be fed back to the load balancing to select other nodes: WEB will check the format of the analysis protocol script, if Successfully written to the database, otherwise page feedback; data synchronization synchronizes the analysis script data from the database to the cache library; the data analysis service reads device information, device parameters, and analysis protocol scripts from the cache library; the data analysis service reads the device from the original data Association, start the analysis protocol script driver of the device to compile, and input the original data into the main method as an input parameter, judge whether the execution result of the main method is not empty, and if it is not empty, encapsulate the result and pass it to the data parameter comparison method. The parameter comparison load associates the parameters configured by the user with the parsed data; the association result is the data that can be finally written into the message queue, and the data is unified and encapsulated and written into the message queue to complete the entire process.

The data parsing method provided by the embodiments of the present disclosure can be applied to the architecture shown in FIG. 1, for example, it can be applied between terminals in FIG. Data transmission between base stations, between terminals and servers, and/or between gateways/base stations and servers, and data collected based on the data analysis method provided by the embodiments of the present disclosure can be stored in the data lake shown in FIG. 1, for application in the Internet of Things that supports multi-mode heterogeneity. In addition, the data parsing method provided by the embodiments of the present disclosure can also be applied to the framework shown in FIG. 1A, FIG. 1B, FIG. 1C and FIG. 1D (ie, FIG. Data transmission between terminals, between terminals and gateways/base stations, between gateways/base stations and gateways/base stations, between terminals and servers, and/or between gateways/base stations and servers, to support Figures LA-ID The operation of multi-mode heterogeneous Internet of Things.

Exemplarily, the data parsing method provided by the embodiments of the present disclosure can be implemented based on the following components/components: WEB application, database, data synchronization, cache library, data parsing, registration center, load balancing, fuse downgrade, message queue, and data collection Among them, the WEB application is responsible for inputting the analysis protocol script data; the database stores the analysis script data of the WEB application persistently; the data synchronization is responsible for writing the analysis script data into the cache library; Responsible for reading the original data pushed by load balancing and the analysis protocol script and device parameter information of the cache library, starting the script driver to compile and analyze the protocol script data, inputting the original data to obtain the execution result, and then comparing the execution result with the device parameter information to obtain the final Results; the data collection service is responsible for receiving the original data; the registration center is responsible for receiving the information of each node of the data parsing service; the load balancing is responsible for receiving the raw data pushed by the data collection and distributing the data to a registered data parsing service through the load balancing algorithm Above; the circuit breaker is responsible for monitoring the data flow status of each data analysis service, and performing shutdown or current limiting operations; the message queue is responsible for gathering the final results of all data analysis services into the same queue, which is convenient for other services to read.

Exemplarily, an application scenario of the data parsing method provided by the embodiments of the present disclosure includes: when obtaining a device hardware product and a corresponding parsing protocol document, it is only necessary to convert the parsing protocol document into a script language and input it to the platform WEB end, and then connect the device to the Internet to complete data access and report in real time, without changing the background.

The data analysis method provided by the embodiment of the present disclosure uses the method that the page can modify the configuration online, and sinks the script data to the service layer in real time; the data analysis uses distributed deployment and multi-service load balancing, has resource allocation balance, and automatically monitors fuse degradation high performance to ensure data stability; convert the parsing protocol into a scripting language, which can be compiled and executed in the service in real time, leaving diversity at the input end without moving the service, saving development and deployment resources; using a cache library instead of Traditional databases implement millisecond-level queries to ensure that page modifications can be quickly responded to and sent to the service.

Based on the data analysis method provided by the embodiments of the present disclosure, the compatibility of products can be greatly improved. Most IoT products provide sdk or fix a protocol, resulting in huge compatibility and development and communication costs, the horizontal expansion of products can be extended infinitely. Using this set of architecture system, all problems are in the input data analysis script, and this can be developed infinitely, and the components of organization management can also be continuously upgraded and increased in the micro-service layer; the practicability is greatly improved, no need to participate in the background, access One device is all done in the foreground.

### R2-7-32—Real-Time Stream/Batch Based Online Data Processing.

In related technologies, different business projects will overlap in the big data development process, resulting in repeated development of tasks; the data source is simplified, and the rule processing model is too simple to meet complex rule matching, and the processing method is single; the current processing rule model Not general enough, for complex businesses, each rule requires programmers to write corresponding code; currently, it is not possible to truly match streaming data rules, only micro-batch processing of batch data, not streaming in the true sense, affecting real-time performance. In risk control scenarios, such as sensor monitoring of forest fires and other dangerous scenarios, we need to respond quickly. An hour or a few minutes will have a great risk cost, so we must ensure higher real-time performance.

In order to solve at least one of the above problems, for example, to implement rule matching in complex services, an embodiment of the present disclosure provides an online data processing method based on real-time stream/batch, as shown in FIG. 32-1, including: The service caller formulates parameters: customized rules, data access methods, and rule matching processing methods; the parameters are passed into the parameter parser, and the parameter parser will parse the parameters independently, and pass the data access methods and rules into the rule processing engine: The rule processing engine will receive the data access method sent by the parameter parser, and send the data access method to the data source access device for processing. The data source access device will automatically access the data source according to the data access method, and. The data flow is imported; the rule processing engine receives the rules sent by the parameter parser, and sends the rules to the rule template engine, and the rule template engine parses the incoming custom rules, splits the structure, and generates a rule matching template, and fill the parameters in the rules into the rule matching template, when the rule processing engine parses the rules and loads the streaming data source, the streaming data source and the rule matching template will be handed over to the trigger for rule matching. If the data does not match, no processing will be done. If the data is matched, data processing will be performed; data processing will select the specified processing method according to the rule matching processing method transmitted from the parameter parser.

The real-time stream/batch-based online data processing method provided by the embodiments of the present disclosure can be applied to the architecture shown in FIG. 1, for example, it can be used between terminals and between terminals and gateways/base stations in FIG. 1, between gateways/base stations and gateways/base stations, between terminals and servers, and/or between gateways/base stations and servers, and collect data based on real-time stream/batch based online data processing methods provided by embodiments of the present disclosure. The obtained data can be stored in the data lake shown in FIG. 1 for application in the Internet of Things that supports multi-mode heterogeneity. In addition, the real-time stream/batch-based online data processing method provided by the embodiments of the present disclosure can also be applied to the architecture shown in FIG. 1A, FIG. 1B, FIG. 1C and FIG. 1D (ie, FIG. 1A-1D). Data transmission between each terminal and terminal, between terminal and gateway/base station, between gateway/base station and gateway/base station, between terminal and server, and/or between gateway/base station and server in FIGS. 1A-ID, to support the operation of the multi-mode heterogeneous Internet of Things in FIG. 1A-ID.

Exemplarily, the real-time stream/batch-based online data processing method provided by the embodiments of the present disclosure may be implemented based on the following components/components: service caller, parameter parser, rule processing engine, and data executor. Service caller: It is the client, the entrance of the system. Parameter parser: parse the parameters from the service caller, such as rules, data access methods, and rule matching processing methods, and send the rules and data access methods to the downstream rule processing engine. Data rule processing engine: including data source accessor, rule template engine, and trigger Data source accessor: According to the data access method, access the data source, generate a data stream, and send it to the trigger. Rule template engine According to the rules, parse and disassemble the rules, generate a rule matching template, fill in the parameters, and send it to the trigger. Trigger: Introduce data flow and rule template to make the data flow match the rule template Data Executor: Match the data of the rule template to perform specific execution logic. Exemplary, an application scenario of the real-time streaming/batch-based online data processing method provided by the embodiment of the present disclosure includes: in an exemplary Internet of Things scenario, the sensor device sends streaming data in real time, and after protocol analysis Sent to the data acquisition system, the amount of data is 10,000 pieces/half an hour, but sometimes data loss occurs due to network problems, abnormal sensor equipment, etc. If there are too many lost data, it will not be possible to better monitor and analyze the data. Therefore, we can set a set of rules to capture data loss. For example, a device whose data loss condition is more than 2 times within 30 minutes is an abnormal device, and an alarm needs to be triggered. That is, within half an hour, streaming data is continuously sent to the stream/batch data processing engine. If only 9997 pieces of data are received, that is, 3 pieces of data are lost and more than 2 pieces are exceeded, which exceeds the threshold, an alarm will be triggered.

The real-time stream/batch-based online data processing method provided by the embodiments of the present disclosure uses a real-time rule matching method for data stream or batch processing, and first specifies a processing template for real-time analysis to obtain data processing rules, and then executes according to the data. The data processing method in the rules is similar to the real-time data analysis in the Internet of Things, and the data execution operation is added here. Based on the online data processing method based on real-time stream/batch provided by the embodiments of the present disclosure, user-defined rules are more flexible, and any complex rules can be parsed and split by a powerful rule template engine to generate a general template for rule matching; any. The business system can be used as a service caller to call the system's services and do rule matching; stream processing is truly realized, which increases the accuracy and real-time performance of rule matching; data processing is diversified and supports multiple data processing methods.

### R2-8-33—Dynamic Configuration of Oriented Storage for IoT Devices.

In the related technology, in the process of sensor data access, the data needs to be stored persistently, but the storage logic needs to be written in advance. If there is a newly added device, the newly added or modified device needs to be saved. Only after the logo is re-added to the service and restarted, the device data storage address can be changed, and then the newly added device data can be stored. The realization of this process requires: java front-end and back-end to dynamically configure sensor device information. Mysql to persistently store sensor device information, java back-end service to read sensor device information in Mysql, and logically add the newly added device corresponding table structure field to. In the code, package and redeploy.

The above process needs to increase the amount of code development, and it will also affect the data access and storage of existing devices, because the existing device storage is suspended when packaging and deploying, and it also increases personnel costs Not only does it require the participation of hardware developers. Software developers also need to be involved.

Based on the technical solutions provided by the embodiments of the present disclosure, each time a user adds a new device, instead of modifying the deployed service code, the device information is transferred to the service, and the corresponding storage logic is dynamically generated in the service. This technology. The solution can be applied to. Internet of Things basic configuration system (multi-mode heterogeneous wireless hosting network), data intelligent fusion platform. The data storage service provided by the embodiments of the present disclosure includes the steps of: acquiring the sensor data of the terminal; acquiring data rules; processing the sensor data of the terminal based on the data rules to obtain processing results; generating database insertion statements according to the processing results; and persisting according to the database insertion statements storage processing results. Among them, the data rules can be configured arbitrarily, so as to meet the data storage requirements of different devices and different services. The technical solution provided by the embodiments of the present disclosure includes the following contents: java front-end dynamically configures sensor device storage table information, and writes data into Mysql; Mysql performs persistent storage of sensor device information, including device parameters, device storage addresses, etc. Kafka. For sensor data caching, the data of the device corresponding to the device transmission protocol is normalized and cached, and the structure is consistent and can be read uniformly; Redis performs sensor storage information caching, and the database data is stored in the memory. Compared with the existing traditional database (disk), can perform high-speed reading and writing; SparkStream reads the sensor data in Kafka in real time and converts the data into a data stream, which can perform stream processing on each piece of data, and read each piece of data and Redis to the sensor device for storage. The rules are associated, the sensor data and the corresponding equipment information rules are matched by map, and the inserted sql statement is automatically generated according to the application matching and written into the corresponding industry application table of the ClickHouse database, and the upper and lower limits of the reading equipment range are automatically judged and written into the exception table; The persistent storage corresponds to the sensor data, and the fields are consistent with the configured device parameters.

As shown in FIG. 33-1, the embodiment of the present disclosure provides a data storage method, including steps: reading data from the message queue; synchronizing the business database to the data cache through data; obtaining data rules from the data cache, including writing to the table. Data comparison rules; convert the read data into real-time streams, and compare them one by one; compare and generate result data and result tables, and then convert the result data and result tables into database insert statements; execute batch insert statements to write data in the lake.

In some embodiments, the technical solutions provided by the embodiments of the present disclosure can be applied to the data lake of the intelligent data fusion platform shown in FIG. 1, and the data lake receives the sensor data uploaded by the terminal layer through a multi-mode heterogeneous network. Referring to the process shown in FIG. 1A-FIG. 1D, after the equipment operation and maintenance personnel configure the data rules, the sensor data is collected, transmitted and stored through the appropriate sensing strategy, communication transmission strategy and data rules.

The advantages of the technical solution provided by the embodiments of the present disclosure, reduce personnel costs, do not require software developers to participate, and only need equipment operation and maintenance personnel to perform simple configuration on the page; to ensure data stability, it is necessary to repackage and deploy code to reduce code deployment. The problems of data timeliness and lack of data are brought about; data storage is transparent, and data reading can also be closely integrated with other systems.

### R2-9-34—the Combination of Data Center and Data Intelligent Analysis.

Defects or problems existing in existing data center products or technologies:

The existing data center provides data processing capabilities, and there is no complete and detailed business scenario as support, which often requires users to operate a large number of pages or customize requirements;

Data association query is not convenient and fast enough, and often needs to be implemented across systems;

Traditional BI analysis tools mostly write SQL or read table queries, and the data structure is not flexible enough.

An embodiment of the present disclosure provides a query method, including: connecting to one or more data sources; generating corresponding data query statements according to the data sources and requirements; generating an execution plan based on the data query statement; The source gets the target data for the query. Wherein, the data source to be queried may include structured data, or semi-structured data or unstructured data.

The embodiment of the present disclosure realizes the following scene effect: user A wants to query the air quality data at a certain moment, and at the same time wants to see the local weather data, as well as the air quality of surrounding counties and cities, and finds that there may be problems with the data and wants to see the site camera. For the pictures taken, the data needed at this time include, site air data, district/county meteorological data, urban air data, urban meteorological data and picture data. At this time, user A can query according to one data through the technical solution provided by the embodiment of the present disclosure. The statement queries all the required structured data, and obtains the image data through unstructured query and returns it in the same result After simple editing and processing, data reports and image records can be produced, and finally an accessible address is generated, which is more convenient for multiple parties to use. Embodiments of the present disclosure are described below in conjunction with FIG. 34-1 and FIG. 34-2.

The embodiment of the present disclosure includes the steps of: opening the data source connector to obtain the data source connection; judging whether the data source is connected, if the connection is not passed, the process is stopped, and if the connection is passed, the language editor is called; the language editor converts the logic of the page. It is a data query statement, the data query statement is submitted to the logical executor and converted into an execution plan. The execution plan will be divided into different execution processes, and the corresponding execution results will be obtained through the corresponding code executors, and finally the obtained execution will be executed. The results are logically encapsulated to obtain complete data; the visualization tool generates corresponding chart pictures according to the page configuration; the external service is responsible for exposing the chart pictures in the form of services.

The components of the embodiment of the present disclosure include: a data source connector, a language editor, a logic executor, a visualization tool, and an external service.

The functions of each component are as follows: data source connector, connecting corresponding multi-source heterogeneous data, is the basic component for obtaining query data: language editor, responsible for generating corresponding data query statements according to data source and page logic, including structured and unstructured; logic executors are responsible for converting data query statements into data execution plans using multiple language tools, dividing them into processes to open code executors to obtain data, and associating data with calculation logic or algorithms; visualization tools. Responsible for converting input data and pictures into charts; for external services, responsible for exposing charts in the form of url or API address or files to facilitate external access.

In some embodiments, the technical solutions provided by the embodiments of the present disclosure can be applied to the data lake of the intelligent data fusion platform shown in FIG. 1, the artificial intelligence business platform, the digital twin middle platform, the artificial intelligence industry algorithm middle platform, and the converged communication center Platforms and streaming media platforms, from which data can be queried according to business requirements.

When the data query requirements include query logic, the intelligent data fusion platform converts the query logic into query statements suitable for different storage environments, and completes the query statements through data execution plans. The query process follows the associated part of the process shown in FIG. 1A-FIG. 1D, and the multi-mode heterogeneous network performs unified and fine-grained network scheduling on the communication transmission process. The advantages of the technical solution of the embodiment of the present disclosure: reduce the work of querying back and forth in a library or different systems, reduce query costs and improve query efficiency; it is more inclined to business scenarios, and can realize the reuse of the same scenario; reduce the participation of technical personnel, business personnel Specialized in business scenarios, can produce efficiently.

### R2-10-35—Data Fusion.

Defects or problems existing in existing data management products or technologies: All data platforms have the ability to access multiple data, but lack data governance capabilities and data mining capabilities; the main reason is that the current business scenarios are single, such as E-commerce order system, mall advertising system; the rise of Internet of Things technology makes future data usage scenarios infinitely possible; a single business model will also make new business scenarios Jack planning thinking.

In order to solve the above technical problems, the embodiment of the present disclosure realizes multi-source heterogeneous data collection as the core, data lake as the support, the Internet of Everything as the idea, and data empowerment as the springboard By combining structured and unstructured data across Unified integration across departments, across regions, across levels, and across technologies to support multiple business scenarios.

In some embodiments, sensor data, image and video data, and Internet web page data are collected, and then these data are stored in a data lake and marked with a data identifier. At this time, when the business platform uses the image algorithm to identify the alarm, it immediately obtains the provided sensor data and Internet data in the same geographical area, and performs correlation analysis at the same time, and sends instructions to other control devices to trigger the linkage of equipment and personnel in Internet business scenarios.

Embodiments of the present disclosure are described in conjunction with FIG. 35-1 and FIG. 35-2. Embodiments of the present disclosure include steps:

The Internet and the Internet of Things collect structured, semi-structured, and unstructured data and write them into data processing programs and file systems;

The data processing program writes the raw data to the database in the data lake.

The file system writes the file and returns the accessible address of the file;

On the database and file system of the data lake, the data is classified and managed, and the data is labeled with a data identifier. One data can correspond to multiple identifiers, so that all data of this type can be found through the identifier;

Trigger business scenarios. The business platform performs all relevant data queries according to the identification, and performs linkage processing of equipment;

After the business processing is completed, the business feedback of data identification is carried out, and the data identification in the data lake is continuously updated and iterated.

The components of the embodiments of the present disclosure include: a data collection layer, a data governance layer, and a service layer.

The role of each component is as follows:

The data acquisition layer is responsible for collecting raw data of different structures from multiple data sources into the data lake;

The data governance layer is responsible for the storage of the original data, and marks the data processing;

The service layer provides multi-dimensional query for business scenarios, multi-layer display of data, and data-based linkage processing of IT devices.

The technical solution provided by the embodiments of the present disclosure can be applied to the data lake and artificial intelligence business platform, the digital twin middle platform, the artificial intelligence industry algorithm middle platform, the converged communication middle platform, and the streaming media platform shown in FIG. 1. Linkage with any of the business platforms such as Taiwan. Due to the existence of data identification, the data intelligent fusion platform returns the required associated data based on the query request of the business platform, and optimizes the data identification based on the feedback of the business platform to improve the ability of data association. Wherein, for the linkage process, refer to the operation process of the multi-mode heterogeneous network shown in FIG. 1A-FIG. 1D.

The advantages of the technical solution provided by the embodiments of the present disclosure: Provides convenient data access and data exploration capabilities, provides multi-industry data service interfaces, breaks data islands under the condition of fully protecting user data security and non-shared data, and effectively supports government services, decision analysis and other application scenarios. Pain points need to be shared to achieve cross-data and cross-industry cooperation.

Based on the data lake, it provides massive low-cost storage capacity, and relies on the big data file system and data processing technology to reduce the storage cost of massive structured data, semi-structured data and unstructured data. It should be understood that, as shown in FIG. 1, because of the network communication data transmission between the multi-mode heterogeneous IoT network and the intelligent data fusion platform, the data sources in different formats in the intelligent data fusion platform are dynamically realized Continuous access and downlink operations enable the data sources in the data lake of the intelligent data fusion platform to expand infinitely, and data capabilities can be replicated infinitely, providing huge data resources for various business scenarios. In this embodiment, the data sources in the data lake of the intelligent data fusion platform include: data from sensing terminals, communication big data, external data, and data generated by the platform in the algorithm.

Make cross-domain, cross-platform, cross-media data storage and data analysis easy to realize, flexibly and efficiently support the formulation of various decisions of enterprises, truly help enterprises achieve cost reduction and efficiency increase, and realize digital intelligence transformation and development.

### R2-11-36 Data Reporting Control, Priority Transmission Technology, Data Compression Technology.

In related technologies, the transmission of sensor device data has the following problems: For IoT application scenarios, due to the increase of IoT devices, there will be data concurrency problems of tens of millions of IoT devices. The data of IoT devices is diverse, real-time, and concurrency. Currently, sensor devices. The data reporting time interval is fixed, and the data is reported at a fixed time interval. For the case of small data changes, the time interval for IoT devices to report data can be reduced;

When the data collected by the sensor device has a relatively high data change rate within a period of time, the current transmission route is fixed, which does not increase the priority of the data transmission of the device, which is not conducive to the rapid transmission of high-priority data to the cloud;

The data collected by the sensor equipment is transmitted in a non-compressed way, and the network data transmission volume is large, and the data compression technology can be used to compress the collected data before transmission.

At present, after the device leaves the factory, the device is centrally distributed and configured across regions in the IoT platform console to realize global access to the nearest device. This scheme has the following disadvantages:

The device reporting time interval is fixed, and it does not support changing the data reporting frequency according to the changes in the collected data reporting;

For the case where the rate of change of the data collected by the device is high, it is not supported to increase the priority of the data transmission of the device, so as to use the transmission route with higher transmission speed for transmission;

The transmission of the data collected by the sensor equipment is transmitted in a non-compressed manner, and the network data transmission volume is large.

The solutions provided by the embodiments of the present disclosure include.

Cloud-based terminal device data reporting interval control technology: the cloud analyzes the rate of change of data reported by the terminal device in real time. When the rate of change of data reported by the terminal device is less than the set threshold, the cloud generates an extended terminal device data reporting time interval instruction, and Send to the terminal device to lengthen the terminal device data reporting time interval; when the terminal device reported data change rate is greater than the set threshold, the cloud generates a shortened terminal device data reporting time interval command, and sends it to the terminal device to shorten the terminal Device data reporting time interval:

The terminal device randomly adjusts the starting time of data sending, before sending device data each time, the terminal will add a random time to the sending time, and then start sending data at the calculated time, using this mechanism to effectively prevent a large number of terminals from. The problem of sending data at the same time.

For terminals with a high data change rate, the technology to increase the priority of data transmission: For data with a relatively high terminal data change rate, adjust the transmission path and other technical means to increase the priority of data transmission, observe the status of all links (SNR) and. In contrast, select the optimal link for transmission, so that the terminal device data with a high rate of change can be transmitted quickly; when the rate of change of terminal device data drops, restore the data transmission to the normal priority by adjusting the transmission path and other technical means;

A new terminal data transmission method: in the process of terminal data transmission, the terminal will obtain the data of surrounding terminals, and transmit the terminal data in the form of the difference with the surrounding terminal data;

Terminal transmission data compression technology: Compress the data uploaded by the terminal through the data compression algorithm, and finally transmit the compressed data to the IoT cloud platform.

Please refer to FIG. 36-1, which provides a cloud-based terminal device data reporting interval control technical process, including:

Real-time data sending: the terminal device sends the collected data to the IoT cloud platform in real time;

Receive real-time data from terminal equipment: the IoT cloud platform receives real-time data sent by terminal equipment in real time;

Analysis of real-time data change rate of terminal equipment: The Internet of Things cloud platform analyzes the real-time data change rate received by terminal equipment;

Judging whether the data change rate is less than the lower limit threshold of the data change rate: the IoT cloud platform judges whether the data change rate is less than the lower limit threshold of the data change rate:

Issue the terminal reporting time interval adjustment and lengthening command: if the data change rate is less than the lower limit threshold of the data change rate, the IoT cloud platform will issue the terminal reporting time interval adjustment and lengthening command to the terminal device; Receive the time interval adjustment command reported by the terminal: the terminal device receives the time interval adjustment command issued by the IoT cloud platform;

Adjust the terminal reporting time interval: the terminal device adjusts the terminal reporting time interval;

Judging whether the data change rate is greater than the upper limit threshold of the data change rate: If the data change rate is greater than the upper limit threshold of the data change rate, the IoT cloud platform issues an instruction to adjust and shorten the terminal reporting time interval to the terminal device.

Referring to FIG. 36-2, the solution provided by the embodiment of the present disclosure includes the following components.

Dynamic adjustment of terminal data reporting time: dynamically adjust the terminal data reporting time of this time, and add a random time value to the planned time;

Data compression reported by the terminal: compress the data reported by the terminal; Terminal data reporting: Terminal data is reported to the IoT cloud platform.

Referring to FIG. 1, the technical solution provided by the embodiment of the present disclosure can be applied to the communication between the terminal layer and the support layer or the application layer shown in FIG. 1; the embodiment of the present disclosure optimizes the sensor data transmission of the terminal layer based on the data content, and improves. The data transmission capability of the multi-mode heterogeneous network is improved. Among them, the reporting of the terminal data and the feedback adjustment of the cloud are in accordance with the associated part of the process shown in FIG. 1A-FIG. 1D.

The advantages of the technical solution provided by the embodiments of the present disclosure. Adjust the terminal data reporting frequency based on the terminal data change rate. For rapid changes in terminal data, more key data can be collected. For terminal data that does not change significantly or when terminal data does not change, reduce uploaded data and reduce cloud data storage.

The terminal device randomly adjusts the starting time of data transmission, which can effectively disperse the terminal data reporting time and reduce the concurrent data volume of the terminal; For terminals with a high data change rate, the technology of increasing the priority of data transmission can ensure the rapid transmission of key data to the cloud;

A new terminal data transmission method can reduce the amount of data transmission; Terminal transmission data compression technology can reduce the amount of data transmission.

### R2-12-37—Industrial Intelligent Application Platform Event Bus Service Management System.

The communication between the traditional systems of enterprises requires the development of developers, and it is time-consuming and labor-intensive to connect various systems. Since the technologies used by different data sources are inconsistent, developers need to master additional technologies. The event bus service management system of the industrial intelligent application platform provided by the embodiments of the present disclosure can realize the interaction between different services, and only need to follow the industry-recognized CloudEvents 1 0 specification to conveniently process events.

The advantages of the event bus service management system of the industrial intelligent application platform are as follows:

Realize asynchronous message communication between different systems, thereby decoupling interdependent services;

You can directly filter and publish events without knowing the event source;

Horizontal expansion, fault tolerance;

Retry on error.

In some embodiments, the event processing method provided by the event bus service management system of the industrial intelligent application platform includes: receiving an event from an event source; processing the event through the event bus; and sending the processed event to the event target.

In some embodiments, there are multiple event buses, corresponding to different event sources, or processing events based on different event processing rules.

Among them, the event source is the source of event production, which is responsible for publishing the produced events to the event bus Data access to the following data sources: custom applications, business databases, big data middleware, and message middleware.

When the system in the embodiment of the present disclosure is set to access the event source, the custom application is configured to access the event bus EventBridge using the sdk. By creating an event bus EventBridge api, configuring custom event modes, event rules, and event targets, events in custom applications are published to the event bus EventBridge, and events are routed to event targets after filtering by event rules and event modes.

When the system of the embodiment of the present disclosure is set as event access, the event provider is configured to actively push the event to the event bus EventBridge. If the event source is a message queue such as kafka, mqtt, etc. the event bus EventBridge will actively push the event to the target without integrating SDK, and route the event to the event target after being filtered by the custom event mode.

Among them, the event bus EventBridge is responsible for receiving events from event sources. In some embodiments, the event bus types included in the event bus EventBridge have the following two types:

Cloud system dedicated bus a built-in event bus that does not need to be created and cannot be modified, and is set to receive events within the disclosed system. The events of the internal event source of the cloud system in the embodiment of the present disclosure can only be released to the interior of the cloud system in the embodiment of the present disclosure. Custom bus. An event bus that is actively created and managed, and is set to receive events of custom applications or stock message data. Events of custom application or stock message data can only be published to the custom event bus where event rules are set to filter and transform events. The filtering function of the event rule is provided by the event mode; the conversion function of the event rule is converted into a format acceptable to the event target by the event content conversion rule. Among them, the event target is the event processing terminal, which is responsible for consuming CloudEvents events. As shown in FIGS. 37-1 and 37-2, the components provided by the embodiments of the present disclosure include: event sources, providing event sources for the event bus service management system of the industrial intelligent application platform of the present disclosure, and supporting multiple data sources.

The bus is divided into a default event bus and a custom event bus. The default event bus is one, and multiple custom event buses can be defined. Event rules, to achieve event filtering and conversion, can define multiple.

The event target is the terminal where the event is published. It is set to consume the event sent by the event source. Multiple definitions can be made. Among them, when accessing as an event source, you need to configure a custom application to use the SDK to access the event bus EventBridge. By creating an event bus EventBridgeapi, configuring custom event modes, event rules, and event targets, events in custom applications are published to the event bus EventBridge, and events are routed to event targets after filtering by event rules and event modes. Among them, when accessing as an event, you need to configure the event provider to actively push the event to the event bus EventBridge. If your event source is a message queue such as kafka, mgtt, etc. the event bus EventBridge will actively push the event to the target without integrating SDK, and route the event to the event target after being filtered by the custom event mode.

The industrial intelligent application platform provided by the embodiments of the present disclosure uniformly manages the events of the business layer, and can be applied to event processing of any business layer shown in FIG. 1. Preferably, the event transmission process conforms to the relevant part of the flow shown in FIG. 1A-FIG. 1D.

The characteristics of the method provided by the embodiments of the present disclosure: realize decoupling of event processing, realize unified processing of events; do not need to write additional codes, and save development costs.

The streaming media platform provided by the embodiment of the present disclosure includes technologies numbered R3-1 to R3-2.

The streaming media platform provides services such as video recording. PTZ control, streaming media, SDK, ONVIF, and national standard protocols for video data uploaded in different industries and locations based on multi-mode heterogeneous networks, and supports the artificial intelligence business platform. The interaction with the intelligent data fusion platform includes receiving information such as video, pictures, and streaming media access from the intelligent data fusion platform, feeding back control information, screenshot information, etc. to the intelligent data fusion platform and storing them in the corresponding theme/special library. At the same time, the streaming media platform delivers to terminals corresponding to industries and corresponding physical locations through a multi-mode heterogeneous network to realize control.

### R3-1-38—Streaming Media Platform.

Streaming media technology is widely used in the monitoring and live broadcasting industry, but existing products are often limited in scope of application, and it is difficult to meet the ever-increasing business needs, such as adding different protocol access devices, adding different protocol streaming playback, and adapting to new Network scenarios, capability expansion based on streaming media, etc.

With the gradual increase of application systems, more and more services need to use streaming media-related functions. According to the method provided by the embodiments of the present disclosure, the streaming media platform queries the online streaming media signal source, accesses the signal source device, issues instructions to the signal source to obtain the media stream, and pushes the media stream to the streaming media service.

The embodiment of the present disclosure extracts the streaming media capability as a part of the public support platform. On the one hand, it can avoid repeated development and waste of manpower, on the other hand, it can focus on scene expansion and adapt to various business needs By setting up the streaming media platform in the system, various protocol access devices, streaming playback of different protocols, adapting to various network scenarios, platform cascading, and capability expansion based on streaming media can be realized, and with an appropriate architecture Support for subsequent new features.

The network requirements for data transmission by the streaming media platform are met by the communication layer through real-time scheduling. For example, the communication layer provides higher priority and higher bandwidth for the data transmission of the streaming media platform by adjusting communication parameters and strategies.

In some embodiments, the streaming media platform is configured to provide access services. Access service is a module responsible for device access, which can easily expand different types. Its main functions include protocol implementation, command delivery, data reporting, and stream forwarding. When access services and devices are deployed in a local area network, it can act as a P2P proxy. When conditions permit, the access service should be deployed as close to the device as possible to reduce the impact of packet loss and network fluctuations caused by public network transmission.

The access protocols supported by the streaming media platform include, for example, ONVIF, GB/T28181, SDKs of multiple streaming media service providers, etc. which can be expanded as needed.

In some embodiments, the streaming media platform is configured to provide media services. The media service is configured to transcapsulate the media stream. For example, the media service parses at least one of RTSP, RTMP, and RTP streams, and provides data in playback formats such as RTSP, RTMP, FLV, and HLS.

In some embodiments, the streaming media platform is designed to be cascaded through source stations and edge stations, deployed in multiple regions, and provide CDN-style services. In some embodiments, the streaming media platform is configured to provide transcoding services. A transcoding service is set up to transcode media streams and is usually located between the origin station and the edge station. The encoding format of the original stream is sometimes not supported by the terminal, or the bandwidth is not enough to support high-definition video. The transcoding service adjusts the data stream and modifies the encoding format or resolution and bit rate to meet actual needs.

In some embodiments, the streaming media platform is configured to provide network streaming proxy services. For scenarios with specific security requirements, sometimes it is impossible to directly control the management device, but media streams can be obtained through whitelists, security accounts, etc. and the streaming media platform acts as a proxy by actively pulling network streams, and handing over authority control to the upper application system.

In some embodiments, the streaming media platform is configured to provide lower-level platform cascading services.

The lower-level platform cascading service is responsible for platform-level docking, realizing the lower-level platform docking such as the GB/T28181 protocol, and the supported protocols can be expanded according to requirements.

In some embodiments, the streaming media platform is configured to provide a view library storage service. The view library storage service stores structured data and provides interactive interfaces according to view library specifications such as GA/T1400.

In some embodiments, the streaming media platform is configured to provide management center services. The management center service coordinates the information of all services and devices. For example, the management center service includes connecting to the access layer service, maintaining the state through registration and heartbeat, and performing resource synchronization and instruction delivery. For example, the management center service provides a unified API for the application system and shields the underlying details.

In some embodiments, the management center publishes all change events to the message queue for consumption by the upper layer service.

In some embodiments, the streaming media platform is configured to provide streaming services. The flow control service controls the media flow through the configuration strategy, which can be divided into two types: pull flow strategy and flow stop strategy, and the two types of strategies are mutually exclusive.

For example, you can configure the policy of closing the stream when no one is watching to reduce unnecessary bandwidth consumption; or pull it up again when the stream is detected to be disconnected to reduce the loss of video.

In some embodiments, the streaming media platform is configured to provide data collection services.

The data collection service can extract resources such as pictures and videos from online media streams, and can also extract resources from offline data (such as FTP and mobile hard disk). Provide a variety of collection plans, such as regular video recording and high-frequency screenshots. The collected files are uniformly submitted to the distributed file system for storage, and the file metadata is submitted to the management center.

In some embodiments, the streaming media platform is configured to provide object storage services. An object storage service based on a distributed file system. Responsible for file-related storage, such as pictures and videos.

It can be expanded horizontally by adding hardware or servers, and data security can be guaranteed. In some embodiments, the streaming media platform is configured to provide a message queuing service.

The message queue service mainly decouples and synchronizes the change events of various services, devices, and resources.

In some embodiments, the streaming media platform is configured to provide data parsing services. The data analysis service pulls the data collected by the collection service, analyzes it through algorithmic means, and generates structured data and alarms.

Structured data is synchronized to the view library, and alarms are synchronized to the application system.

In some embodiments, the streaming platform is configured to provide live streaming services. For live broadcast scenarios, it can also be supported through media services. On this basis, add live user management and assign stream IDs and secret keys to them.

In some embodiments, the streaming media platform is configured to provide upper-level platform cascading services.

The streaming media platform is responsible for platform-level docking, and currently implements the GB/T28181 protocol, which can be expanded according to requirements.

In some embodiments, the streaming media platform is configured to provide application services.

PAAS service, platform visualization, large screen, operation and maintenance status, real-time video, historical playback, media service, access service, cascade service, device management, directory resources, video wall, external domain management, video configuration, screenshot configuration, streaming Capabilities such as control strategy, proxy flow management, and system management can be displayed and configured on the web side, and unified authentication authority docking can be realized.

In some embodiments, the streaming media platform is configured to provide business system adaptation services.

SAAS service is functionally similar to application service, but it is no longer user-oriented, but upstream system-oriented, and authority control and isolation are performed on a system-by-system basis.

As shown in FIG. 38-1, the access layer is responsible for the interconnection between devices and lower-level domains, as well as the acquisition of original media data, and reports the information after abstracting it; the core layer is responsible for the unified management and control of devices and services. Shield the differences of different access methods, and provide core APIs (such as streaming, video recording, PTZ control, and device control); cascade layer services are connected to upper-level domains, application layer handles business logic and authority control. As shown in FIG. 38-2, it describes the basic process for the front-end user to obtain media streams.

The characteristics of the streaming media platform provided by the embodiments of the present disclosure include: multi-protocol access (GB/T28181, ONVIF, various SDKs, network video streams, live streaming); multi-protocol playback (RTSP, RTMP, FLV, HLS); Equipped with various network environments; configurable strategy to control when the flow is disconnected and when to pull it up, support screenshot plan, video plan; can connect algorithm to dig data deeply; support national standard platform cascading; support GA/T1400 view library.

The streaming media platform provided by the embodiments of the present disclosure may be the streaming media middle station shown in FIG. 1, and the network transmission of relevant data conforms to the relevant part of the process shown in FIGS. 1A-ID. In a nutshell, the functions of the streaming media platform provided by the embodiments of the present disclosure mainly include two parts: the first is to provide video recording, PTZ control. Services such as media, SDK, ONVIF, and national standard agreements provide support for the artificial intelligence business platform. In addition, the interaction between the streaming media platform and the intelligent data fusion platform includes that the streaming media platform receives information such as video, pictures, and streaming media access of the intelligent data fusion platform, and the streaming media platform feeds back control information, screenshot information, etc. to the intelligent data fusion platform And stored in the corresponding theme/theme library. The streaming media platform supports sending control commands to terminals in corresponding industries and corresponding physical locations through a multi-mode heterogeneous network to realize terminal control. In this embodiment, as shown in FIG. 38-1, the access layer of the streaming media platform is responsible for the interconnection of devices and lower-level domains, as well as the acquisition of original media data, and reports the information after abstracting it. The core layer is responsible for the unified management and control of equipment and services, shielding the differences of different access methods from the outside, and providing core APIs (such as streaming, video recording, PTZ control, and device control). The cascading layer service is connected to the upper-level domain. The application service layer handles business logic and authority control. The streaming media platform supports multi-protocol access (GB/T28181, ONVIF, various SDKs, network video streaming, live streaming); supports multi-protocol playback (RTSP, RTMP, FLV, HLS). It can adapt to various network environments (such as multi-mode heterogeneous networks), dynamically configure policies to control when the flow is disconnected and when it is pulled up, and supports screenshot plans and recording plans; it can be connected with algorithms to dig deep into data. At the same time, the The streaming media platform supports national standard platform cascading and supports GA/T1400 view library.

The advantages of the streaming media platform provided by the embodiments of the present disclosure include: realizing decoupling of event processing; realizing unified processing of events; no need to write additional codes, saving development costs.

### R3-2-39—Multimedia Backend Message Transmission.

When the number of business systems gradually increases, quite a few of them need to use functions related to converged communication command and dispatch, such as distributed IM and real-time alarm notification.

In the related art, a distributed-based message push method, device and system, the method includes: in the case of obtaining multiple messages to be pushed, distributing and storing the multiple messages to be pushed in multiple message lists, one. The message list corresponds to a notification target, and is set to store the messages to be pushed of a notification target in chronological order; generate multiple task messages based on multiple messages to be pushed, and a task message corresponds to a notification target; push multiple task messages. For multiple message pushers, when multiple task messages corresponding to the same notification target are pushed to multiple target message pushers, one target message pusher is allowed to push messages at the same time: based on pushing to the target message pusher. The notification target corresponding to the task message of, and push the messages in the corresponding message list to the notification target. In this way, a distributed, asynchronous, sequential, and high-concurrency communication method based on message notification can be realized.

The related technology discloses a multi-level message broadcasting method and system in an IM cluster. The user connects to the IM node and reports the room number; the message middleware MQ sends the message that the room number is the above-mentioned room number to the IM node; after the IM node receives the message, search for a list of all users under the room number, and then send messages to the users through the socket socket in turn. No need to look up the global user table, only need to look up the user list on a single IM node, so the problem of distribution delay is completely solved; there is no connection between nodes, so the cluster expansion is very simple; using the secondary distribution method, it can easily reach tens of millions level cluster size.

Disadvantages of the related message transmission method: some use the polling pull method, which has low real-time performance and slow efficiency; there is no ACK mechanism, so it is difficult to determine whether the message is delivered successfully; it is difficult to track, and it is impossible to locate when a problem occurs; it is difficult to implement.

In order to avoid wasting manpower through repeated development, distributed IM and real-time alarm notification capabilities are extracted as part of the public support platform to provide services for downstream business systems.

According to the method provided by the embodiments of the present disclosure, the public support platform accesses the first client through the access service, establishes a persistent connection with the first client, receives a message delivered by the first client, and sends the message to the, or to the inbox of an offline second client.

Wherein, the message of the first client and the message of the second client are delivered through the routing service, and the routing service queries the transmission path and then routes or delivers it to the public support platform.

In some embodiments, the public support platform includes multiple distributed access services, and the first client and the second client select corresponding access services to access the public support platform through a load balancing strategy.

In some embodiments, when the public support platform accesses the first client or the second client that is not started for the first time, it pulls the latest record of the session from the storage database, and the ID of the inbox maintained at the server is greater than. If the ID maintained by the first client or the second client is large and the message cache has not been obtained, the latest record is synchronized from the storage database. When the ID of the inbox maintained by the server is smaller than the ID maintained by the first client or the second client, or the message cache is obtained, the missing message is filled by the continuity of the ID. In the scenario of disconnection and reconnection, the integrity of the message can be maintained.

In some embodiments, the public support platform judges whether the second client is online according to the user registration information or the ACK message, and if not, delivers the message of the first client to the inbox of the second client. After the second client establishes a persistent connection, the data is synchronized through the inbox to maintain data integrity. Inboxes can cache messages or store them persistently.

In some embodiments, the public support platform performs global management through registry services, so as to maintain data consistency of distributed services.

In some embodiments, the routing service of the public support platform tracks the routing of the message, and when the message cannot be delivered to the target by the first routing service, it is forwarded to the second routing service that can be delivered to the target.

In some embodiments, the client's persistent connection messages are transmitted through queues. Furthermore, the public support platform regulates the length, sequence, and processing rate of the queue according to business requirements.

In some embodiments, the common support platform is configured to provide downstream application management services.

Downstream application management includes: unified management of applications accessing command and dispatch IM services; providing functions such as creation, modification, and deactivation of applications, creating corresponding containers for application data, such as message storage indexes, message queues, etc.; Resources need to be isolated, including data and logs, such as users, groups, meetings, events, access records, etc.

In some embodiments, the common support platform is configured to provide user management services. For example, provide services for adding new users, querying users, updating user status, deleting users, and removing groups for downstream services.

In some embodiments, the common support platform is configured to provide group management services. For example, it provides downstream applications with functions such as adding groups, querying groups, posting group announcements, querying group announcements, updating group members, and deleting groups.

In some embodiments, the public support platform is configured to provide real-time message forwarding services.

Chat messages are divided into one-to-one private chat messages and group chat messages. For one-to-one private chat messages, they are forwarded in real time when the other party is online. For group chat, real-time forwarding to online users in the group.

In some embodiments, the public support platform is configured to provide historical message query services.

All successfully sent messages can be queried Wherein, the query conditions include sender, receiver, group, time, and message content.

In some embodiments, the public support platform is configured to provide an offline message pull service.

For users who are disconnected for a short period of time, after reconnecting, they should be able to quickly obtain the messages that were not obtained in real time during the disconnection. In some embodiments, the public support platform is configured to provide log-off notifications. Users should be able to notify relevant personnel in a timely manner when they go online or offline. In some embodiments, the common support platform is configured to provide disconnection reconnection. After the user is disconnected due to network problems, reconnect and synchronize messages in time after recovery. Network isolation is generated between services, and when the network is restored, the data is resynchronized.

In some embodiments, the common support platform is configured to provide message read receipts. After the user sends a message, get the information whether the message has been read. If it is a group message, get the information of the object that has read the message.

In some embodiments, the public support platform is configured as a high-performance and high-availability service Among them, the access layer, routing, and business services can all be expanded horizontally, using message queues to cut peaks and fill valleys, and to avoid coupling. Users obtain the nearest access layer address through load balancing Considering the actual business situation, users of the same downstream application can be connected to the access layer of the same region as much as possible. Routing transfers the global state data to the registration center for processing to avoid data consistency problems, and non-state data is cached to speed up the query.

Use traced to trace the message delivery path to quickly locate problems. The whole process of message flow is asynchronous and non-blocking, which can maximize the use of server resources.

The specific implementation of the public support platform provided by the embodiments of the present disclosure is introduced below.

As shown in FIG. 39-1, when expansion is required, the system supports regional deployment to reduce network transmission loss and communication delay. The user queries the nearest access point through the load balancing service and establishes a long connection, the registration center maintains the user status of the access layer, and the business service provides stateless services (such as login, message query).

As shown in FIG. 39-2, a region (such as Shenzhen and Beijing) can deploy multiple access layer services according to the number of access users. The access layer services are registered with the routing service and maintain metadata through the registration center.

As shown in FIG. 39-3, when there is a message or event to be sent, it can be delivered to the nearest routing service. The routing service is responsible for querying the transmission path and forwarding it to the corresponding routing or access service.

As shown in FIG. 39-4, query the business service to obtain other user information, query the load balancing service to obtain access point information and connect. Then specify the UID to send the message, and it will be delivered to the corresponding target user.

As shown in FIG. 39-5, after a message is sent to the routing service, in addition to real-time forwarding, the routing service will also push the message to the message queue, which will be processed by an independent consumer service and written to ES to provide historical message query.

FIG. 39-6 and FIG. 39-7 show the message synchronization process and request process respectively.

The public support platform provided by the embodiment of the present disclosure can be used as a support for communication between any service layer platform or terminal shown in FIG. 1 and the streaming media middle station. Among them, the public support platform transmits messages based on the multi-mode heterogeneous network, and the operation process of the multi-mode heterogeneous network can be referred to in FIG. 1A-FIG. 1D.

The public support platform provided by the embodiments of the present disclosure has the following advantages: distributed message transmission; real-time event notification, message route tracking; message delivery confirmation.

Converged communication middle station, including technologies numbered R4-1 to R4-4.

Based on the multi-mode heterogeneous network that dynamically adjusts any communication parameters according to industry requirements or/and physical location, it realizes the integrated communication services of different types of data or files such as text, voice, picture, video, location, and attachment. Converged communication services include data uplink and downlink. Uplink includes uploading of different types of data and files, and downlink includes downlinking of different types of data and files to terminals in corresponding industries and/or physical locations. The middle platform provides integrated communication services for different types of data or files such as text, voice, pictures, videos, locations, attachments, etc. to support the artificial intelligence business platform. For example. WeChat chat supports sending and receiving different types of data and files; for example, event reporting supports filling in text when reporting, adding information such as voice, video, picture, location or attachment, etc.

It can access the text, voice, picture, video, location, files, ete provided by the intelligent data fusion platform. The data of the intelligent data fusion platform comes from the multi-mode heterogeneous network of the terminal and communication layer. It supports feeding back the data generated by the fusion communication to the intelligent data fusion platform and storing it in the corresponding theme/theme library.

For the converged communication of video, the streaming media platform provides camera control and streaming media services for the converged communication center. Some control information can be downlinked to terminals in corresponding industries and corresponding physical locations through multi-mode heterogeneous networks.

The implementation of the converged communication middle station of the support layer of the present disclosure will be described in detail below in conjunction with exemplary embodiments.

### R4-1-40 Converged Communication Center.

At present, each business system is independently developing command and dispatch services, adjusting the command and dispatch mechanism at the logical level according to the different needs of each business system, and implementing an independent and customized integrated communication center for a certain business scenario. This type of command and dispatch service has poor versatility Each system must cooperate with a separate communication center, and the operation of users and terminals to access command and dispatch is cumbersome. Many terminals need secondary development of the terminal to be properly matched, in a customized system. Moreover, the functions supported by the terminal also limit the overall functions of the users in the middle platform, customization increases the cost and the development cycle is lengthened. In addition, there are still the following problems in the integrated communication platform: The integration is too high, and now the integrated communication platform is generally developed separately according to the needs of the application scenario. The internal integration of the integrated communication platform is very high, and the development cost has increased exponentially;

In an emergency, the response of all staff is not sensitive enough. The emergency handling of the platform in the converged communication now requires the administrator to manually arrange the front-line tasks. When an emergency occurs, the front-line personnel cannot directly respond to the alarm information, which may cause a dangerous situation where the alarm event processing stagnates;

The coupling is too high, and the coupling between the platform and the business system in the converged communication is also very high. When a certain service fails, the entire user is offline, and the rest of the converged communication operations cannot be performed.

In order to solve the above problems, in some embodiments of the present disclosure, a distributed converged communication platform is provided, which collectively uses each basic service as a microservice, distributes, transfers and stores data in the middleware, and then a A comprehensive business processing center deploys and manages all basic microservices in a unified manner, and meets the customized needs of business systems and terminals by combining various services Embodiments of the present disclosure are described below with reference to FIGS. 40-1 to 40-3. In the embodiment of the present disclosure, the platform in the converged communication performs the following steps:

Register the independent terminal in each sub-service and synchronize it to the converged communication center;

The service platform establishes a user account, and synchronizes the user account to the converged communication center;

Unimpeded communication and remote control can be established between independent terminals, between user terminals, and between user terminals and independent terminals;

The middle station can automatically operate the terminal according to the pre-configured plan information according to different situations, and automatically notify the user.

The components of the integrated communication center include at least one of the following components: CD command and dispatch service layer, IM basic service, RTC audio and video communication basic service, LBS basic location service, and VFS video surveillance fusion service.

The functions of each component are as follows: IM basic service: provide instant multimedia message communication capabilities for terminals: RTC basic services: provide audio and video call capabilities for terminals; LBS basic services: provide location sharing and track storage capabilities for terminals; VFS basic services. Provide camera control and real-time historical video viewing capabilities for terminals; command and dispatch business services: provide alarm plan management services for business systems based on the above four basic services. In some embodiments, the converged communication method provided by the present disclosure includes: registering a user account with the IM basic service; receiving the user's multimedia message communication request, calling the IM basic service to respond to the user's multimedia message communication request; or, registering with the RTC basic service User; receive the user's video or audio call request, call the RTC basic service to respond to the user's call request; or, register the user in the LBS basic service: receive the user's LBS service request, call the LBS basic service to respond to the user's LBS service request; or, registered users in the VFS basic service, according to the user's STREAM service request, provide the user with camera control and real-time historical video viewing capabilities. Command and dispatch service provides contingency plan management service for IM basic service, or LBS basic service, or RTC basic service. Among them, before registering a user with the IM basic service, or LBS basic service, or RTC basic service, or VFS basic service, the user needs to log in or register in the converged communication center, and the converged communication center will be in the corresponding terminal according to the needs of the terminal. Basic service to register. Users are, for example, end users of service platforms such as APPs, law enforcement terminals, and personnel locators. In some embodiments, the converged communication center is also configured to bind the stand-alone device, and register the user of the stand-alone device in one or more basic services. In some embodiments, terminals communicate or share data through IM basic service, RTC basic service, or LBS basic service.

In some embodiments, the terminal communicates or shares data with the converged communication middle platform through IM basic service, or RTC basic service, or LBS basic service. In some embodiments, the terminal and the independent device communicate or share data through IM basic service, RTC basic service or LBS basic service.

In some embodiments, the IM basic service, LBS basic service, RTC basic service or command and dispatch business service will synchronize the service content provided by the terminal to the intelligent data fusion platform.

In some embodiments, the VFS basic service provides the terminal with camera control and real-time historical video viewing capabilities by interacting with the streaming media platform of the embodiment of the present disclosure.

The method and system provided by the embodiments of the present disclosure can be applied to the interaction with service layer platforms such as the converged communication center platform and the city operation integrated IOC shown in FIG. 1. In some embodiments, when the station in the converged communication is using various services, the transmission and processing of related data follow the associated part of the process shown in FIG. 1A-FIG. 1D.

The converged communication middle station (command and dispatch system) provided by the embodiments of the present disclosure provides a multi-mode heterogeneous network based on dynamically adjusting any communication parameters according to industry requirements or/and physical location to realize text, voice, picture, video, location, attachment, etc. Converged communication service of kind data or file. Converged communication services include data uplink and downlink. Uplink includes uploading of different types of data and files, and downlink includes downlinking of different types of data and files to terminals in corresponding industries and/or physical locations Its main services include: (1) Provide integrated communication services for different types of data or files such as text, voice, pictures, videos, locations, attachments, etc. to support the artificial intelligence business platform. For example, voice chat not only supports voice, but also supports sending and receiving different types of data and files, and event reporting supports the use of text, adding information such as voice, video, pictures, positioning or attachments, etc. (2) Access to text, voice, picture, video, location, files and other data provided by the intelligent data fusion platform. The data of the intelligent data fusion platform comes from the multi-mode heterogeneous network of the terminal and communication layer. It supports feeding back the data generated by the fusion communication to the intelligent data fusion platform and storing it in the corresponding theme/theme library. (3) For converged video communication, the streaming media platform provides camera control and streaming media services for the converged communication center. Some control information can be downlinked to terminals in corresponding industries and corresponding physical locations through multi-mode heterogeneous networks. In a nutshell, the converged communication center can be understood as an interactive system (data types include video, voice, text, pictures, location, files, etc.), the data is bidirectional, and the data can flow between the platform and the terminal and/or Or, between terminals and between multiple terminals and platforms (similar to groups) The streaming media platform mainly focuses on the uplink data collection and downlink control of cameras. The integrated communication platform of the present disclosure realizes comprehensive sensing, information fusion, instant messaging and intelligent control through the interconnection of “people and people”, “things and people” and “things and things” (based on multi-mode heterogeneous networks).

The converged communication platform provided by the embodiments of the present disclosure has the following advantages: Distribute service capabilities on demand: it will not cause too much difficulty in service development or secondary development due to high integration, rapid response to alarm events: alarm linkage plan management can be configured in advance Personnel who need to be notified can assign tasks to the nearest frontline personnel as soon as an emergency occurs, and send an alarm notification to the command center; each service is independently connected, each service is split and connected independently by the terminal, when a certain. When a service is not successfully connected, it will not affect the normal use of other service capabilities, which improves the stability of terminal connections.

### R4-2-41—Web Socket Message Processing Mechanism Based on Socket.Io.

The websocket (ws) communication mechanism is a real-time two-way communication mechanism established for the long-term connection between the web end and the server, and solves the problem of the server dynamically sending notifications to the web end in real time. However, websocket has the problem of timeout and disconnection. The native websocket will automatically disconnect if there is no data interaction for a certain period of time under the default configuration. It needs to verify the reconnection. It is easy to miss the missed server during the reconnection process. Notification that the latest data needs to be resynced. Moreover, websocket does not have a native return mechanism. The native websocket does not have a return mechanism when receiving a message from a remote location, so the sender does not know whether the message he sent was successfully transmitted or processed successfully. In addition, websocket lacks a web-side message caching mechanism. When the web side is not ready to accept data after disconnection or connection, websocket messages do not have a message caching mechanism on the web side, which makes it easy to miss remote messages, or it is too late to process remote messages. . . . In order to solve one or more problems existing in websocket, an embodiment of the present disclosure provides a message processing method, including: configuring an interceptor for the websocket connection, and the interceptor maintains a preset time length; when the connection does not meet the preset condition, the interceptor intercepts the websocket message and puts it into the cache queue; when the connection meets the preset conditions, the message in the cache queue is processed. The preset conditions include ws message receiver is ready to receive data or the sender confirms that the connection has been established. Wherein, when the message in the buffer queue is a message to be sent, the processing method is to send the message in the buffer queue; when the message in the buffer queue is a message to be received, the processing method is to receive the message in the buffer queue. In some embodiments, a new ws message is sent or received directly if a preset condition has been met.

The embodiment of the present disclosure also provides a socket.io-based web socket message processing mechanism at the web end. Socket.io is a long-term connection processing mechanism based on the native websocket. This mechanism encapsulates the heartbeat packet and the message processing feedback mechanism on the native websocket. When the two ends are connected, the two ends will exchange heartbeat packets to keep the current long connection alive. When a segment sends a message to the other end, the message sent by the sender carries a sender ID, and the receiver can return the processing result of the message according to this ID.

Based on socket io, this websocket processing mechanism encapsulates the message processing when the message is disconnected or unprepared. The front-end memory cache is established. When this instance is initialized, it receives a needReady input parameter. If there is such an input parameter, it is regarded as an interceptor for sending and receiving messages on this websocket connection. After the connection establishment command is triggered this mechanism will automatically bind the preset time for this websocket. When the business layer is not notified that it is ready to send and receive data, it will cache the messages that need to be sent or received in the queue, and then cache them when they are ready. The messages stored in the queue are thrown to the server and the local business layer for processing.

Embodiments of the present disclosure are described below with reference to FIG. 41-1. The embodiment of the disclosure includes steps the business layer at the web end creates the ws instance of the disclosure; the business layer prepares for receiving data; starts to establish a connection, the ws instance of the embodiment of the disclosure receives the message and puts it into the cache queue; the business layer sends the message to the remote. The message will be intercepted by the ws instance and stored in the cache queue; the business layer sends the command “I am ready to send and receive messages” to the disclosed ws; the disclosed ws processes all the messages in the cache queue, after that, the message sending and receiving enters the normal state, the ws instance no longer intervenes.

The components in the embodiment of the present disclosure include: a ws processing center of the present disclosure, a sending message queue, and a receiving message queue.

The functions of each component are as follows: ws processing center: perform business processing and forwarding of sent and received messages: send message queue: cache messages to be sent, receive message queue: cache messages to be received.

The steps and components provided by the embodiments of the present disclosure can be applied to the requirements related to websocket message processing of any support layer or application layer device shown in FIG. 1. Wherein, the websocket message conforms to the associated part of the process shown in FIG. 1A-FIG. 1D during transmission.

The technical solution provided by this technology embodiment has the advantages: websocket stability is enhanced: with bidirectional state maintenance, the web-side business layer does not need to take into account the current long-term connection state of the websocket, and can first perform the operations it needs to perform to avoid data occurrence Asynchronous, or the error that the long-term connection fails to jump out of the execution; websocket security enhancement: Various verification mechanisms can be added in the middle of the long-term connection message. Centralize the processing of this column of messages.

R4-3-42—Operation Processing Feedback Mechanism that can be Authenticated by the Downstream Service End.

The current ws message mechanism has at least the following defects:

Unable to receive the returned data: the ws long-term connection message is one-way, and the result returned by the other party is unknown, and there is no message binding mechanism;

The long-term connection request of ws cannot be verified by other business services: the long-term connection message of ws cannot be handed over to other business ends for judgment, and if each service needs to go to the business service for authentication first, it will waste interaction time, and there are more Multiple unstable factors;

Third-party encapsulation can only return one result: the ws server encapsulated by the third party receives the message, passes it to the logic layer for processing, and then returns the result once. If you want to return multiple results, it cannot be realized.

In order to solve the above problems, an embodiment of the present disclosure provides a ws message processing method, including: the web terminal sends a ws long-connected message; the ws server receives the message; the ws server sends the business service to make an authentication judgment; The returned result; the ws server returns the result to the web side.

In the solution provided by the embodiments of the present disclosure, the web terminal directly initiates a request to the business server, and the business server performs authentication after receiving the request. After the authentication is successful, the business terminal returns success and executes logic related to the request Among them, during the execution period, the business service will send the processing progress to the ws server multiple times, and the ws will forward the progress to the web end until the logic operation is completed.

The following describes the embodiment of the present disclosure in conjunction with FIG. 42-1, including the following steps: the web terminal directly initiates a request to the business server; the business server performs authentication after receiving the request; Request related logic; during the period, the business service will send multiple processing processes to the ws server; the ws server forwards the progress to the web side; the logical operation is completed; the web side business layer directly calls the CE-VFS instance to obtain the video surveillance service capability. The components of the embodiment of the present disclosure include: a web terminal, a business server, and a ws server.

The functions of each component are as follows: web end: send request, receive progress and result; business server: authenticate request, process operation logic, and notify ws server of operation progress and result; ws server: forward server processing progress and result.

The steps and components provided by the embodiments of the present disclosure can be applied to the requirements related to websocket message processing of any support layer or application layer device shown in FIG. 1, and the websocket messages are uniformly processed by the ws server. Wherein, the websocket message conforms to the associated part of the process shown in FIG. 1A-FIG. 1D during transmission.

The solution provided by the embodiments of the present disclosure has the following advantages: one-way data flow, no waste of resources: from request to processing progress notification and result notification, a one-way closed-loop operation is formed, which reduces the server burden to the lightest; can return Processing progress A request can return multiple processing progress and a final processing result, the progress of complex requests can be clearly received and displayed to the user, and the operation experience process is better.

### R4-4-43—CEIM Instant Messaging Service SDK Based on Middle-End Communication Capabilities.

In the previous CEIM, all services were combined and managed with one SDK ws was connected to remote IM service and RTC signaling service, and LBS service, and JSSIP was used to connect to SIP communication. In order to achieve all the services and functions required by the SDK. There are two problems as follows:

The online status cannot be truly reflected: because the previous CEIM binds multiple services through a long ws chain, it is easy to cause a service short-term and all services cannot be used normally. It caused the problem that users could not use all the same functions, and it could not reflect that the online status of the service was blocked, and the interaction was not friendly; the relationship between the terminal and the service was chaotic and the function was limited: the coupling between the IM service and the RTC service was too strong before, resulting in Group calls must be established on top of existing IM groups, and since the terminals are not synchronized, session members cannot be added at will, resulting in limited functions and inflexibility. In order to solve the above problems, the embodiment of the present disclosure implements an SDK, which is actually an SDK cluster, which is divided into a total SDK and 4 self-service SDKs, and then connects all the information required by the service through a Target-Controller. The total SDK (CE-DISPTCH) is responsible for docking with users for some comprehensive information settings and operations. Such as logging in to each sub-service.

IM SDK (CE-IM) is responsible for sending and receiving instant multimedia messages (text messages, voice messages, picture messages, video messages, file messages, custom messages), and also includes IM group configuration and dynamic monitoring (creating a new group. Modify group information, invite to join, remove members, transfer group, transfer group owner, exit group, disband group).

RTC SDK (CE-RTC) is responsible for the signaling and streaming media interaction of audio and video calls (single-line voice call, single-line video call, multi-person voice call, multi-person intercom call), and also includes the operation of the session room (establish session room, invite members to the session, kick members out of the session, and dissolve the session).

LBS SDK (CE-LBS) is responsible for the transmission and reception of real-time location. You can use this long link to actively send your own location information and receive other users' location information. It also includes an interface for querying the historical location track of a certain terminal.

VFS SDK (CE-VFS) is responsible for the docking of video surveillance media services, including real-time stream pull, real-time stream state keep alive, camera control, historical stream pull, historical stream double-speed switching, historical stream point switching operations.

In some embodiments, the method for CE_IM SDK to provide instant messaging services includes: completing service login; completing sending or receiving multimedia instant messages through a long connection with the CE IM service access layer CE_IM services include multimedia instant messaging services.

In some embodiments, the CE_IM_SDK method for providing an instant messaging service further includes, receiving group-related notifications through a long connection with the CE_IM service access layer.

In some embodiments, the CE_IM_SDK method for providing an instant messaging service further includes: synchronizing message records or performing group management through interaction with the CE IM service service layer.

In some embodiments, the method for CE_RTC_SDK to provide instant messaging services includes: completing service login; calling CE_RTC_SIP engine to dial or close audio and video calls, and obtaining real-time status information related to RTC services. CE_RTC_SIP engine includes audio and video call engine.

In some embodiments, the CE_RTC_SDK method for providing instant messaging services further includes synchronizing historical data or performing conference management through interaction with the CE RTC service business layer, and the CE RTC services include audio and video call services.

In some embodiments, the method for CE_VFS_SDK to provide instant messaging services includes, completing service login, through interaction with CE_VFS service service layer, obtaining data related to monitoring services or controlling monitoring equipment and playing streams. CE VFS services include video surveillance related services.

In some embodiments, the method for CE_LBS_SDK to provide instant messaging services includes: completing service login; sending location information or obtaining relevant status information of the terminal through a persistent connection with the CE_LBS service access layer CE LBS service includes location service.

In an embodiment, the method for CE_LBS_SDK to provide instant messaging service further includes: querying historical location information through interaction with CE_LBS service layer. Please refer to FIG. 43-1 to FIG. 43-5 to describe the embodiments of the present disclosure. The instant messaging service process provided by the embodiment of the present disclosure includes: the web-side business layer creates a CE-dispatch instance of the present disclosure; CE-dispatch logs in to pull terminal middle platform information, and creates a terminal manager; CE-dispatch connects to create each sub-service instance; The web-side business layer directly calls the CE-IM instance to obtain the instant message capability; the web-side business layer directly calls the CE-RTC instance to obtain the audio and video call capability; the web-side service layer directly calls the CE-LBS instance to obtain the location service capability. The end business layer directly invokes the CE-VFS instance to obtain the video surveillance service capability. The components of the embodiment of the present disclosure include: CE-DISPATCH, CE-IM, CE-RTC, CE-LBS, CE-VFS; the function of each component is as follows (each can be described in sequence according to the data flow direction or sequence connection relationship. The functions of the components and the cooperation between them); CE-DISPATCH: unified terminal management and connection of various sub-services: CE-IM: enabling the web service layer to obtain instant messaging capabilities; CE-RTC, enabling the web service layer to obtain audio and video Call capability; CE-LBS enables the web service layer to obtain location service capabilities; CE-VFS: enables the web service layer to obtain video surveillance service capabilities.

The method and SDK provided by the embodiments of the present disclosure can be applied to the converged communication middle station shown in FIG. 1, and can be applied to the communication between the terminal layer and any service layer device or platform. Among them, the transmission of the instant messaging message conforms to the operating characteristics of the multi-mode heterogeneous network shown in FIG. 1A-FIG. 1D.

The advantages of the technical solutions of the embodiments of the present disclosure after the decoupling of each service, the functions are clear: the status of each service is maintained separately, and the disconnection of one service will not cause the entire command and dispatch service to be unavailable, which is convenient for maintenance; flexibility is enhanced: each sub-service can be Calling separately does not necessarily accept the CE-dispatch service capability limit, which ensures the versatility and flexibility of each SDK

Artificial intelligence industry algorithm center, including technologies numbered R5-1 to R5-30. The artificial intelligence industry algorithm center provides artificial intelligence algorithms with management services such as algorithm deployment, algorithm configuration, algorithm training, and algorithm viewing/importing/deleting/upgrading. The inputs or video sources of the platform in the artificial intelligence industry algorithm are aggregated and uploaded from multi-mode heterogeneous networks that are dynamically deployed according to industry requirements or/and physical locations, including various sensings, alarms, and video data. At the same time, data such as linkage control, linkage shouting, linkage alarm, linkage SMS/email notification generated in the artificial intelligence industry algorithm platform are dynamically downloaded to the corresponding terminal according to industry requirements or/and physical location through a multi-mode heterogeneous network.

The artificial intelligence industry algorithm platform can access the input parameters and video data required by different algorithms uploaded by the data intelligent fusion platform, and can output alarms/characteristic values to the artificial intelligence business platform to realize early warning based on artificial intelligence and algorithms Check.

The alarms/characteristic values generated by the platform in the artificial intelligence industry algorithm will also be fed back to the data intelligent fusion platform and stored in the corresponding theme/special library.

For video algorithms, the artificial intelligence industry algorithm center can retrieve the required video/picture through the streaming media center.

For prediction algorithms, such as fire spread prediction, gas diffusion prediction, etc. it is necessary to display the predicted spread or diffusion range after a period of time (such as one hour) in a three-dimensional form. In such cases, the artificial intelligence industry algorithm center will provide data such as eigenvalues and predictive simulations to the digital twin center. The implementation of the artificial intelligence industry algorithm platform of the support layer of the present disclosure will be described in detail below in conjunction with exemplary embodiments.

### R5-1-44—Artificial Intelligence Industry Algorithm Center.

At present, there are many defects in the existing products of the algorithm platform in the artificial intelligence industry, including no standardization of the algorithm model, platform management, integration difficulties, and repeated development processes; lack of operation and monitoring mechanisms for the algorithm model, unable to guarantee the model Stability in providing services; lack of a unified channel for accessing algorithmic datasets, difficulty in obtaining data, lack of standardization and unification of data format standards; lack of a unified evaluation index system for algorithmic models, unable to reflect the generalization capabilities of algorithmic models on the platform; Lack of data aggregation and analysis of algorithm calculation results; lack of continuous improvement and iterative model quality system for algorithm models that are not effective after going online; no full-process management of algorithm model generation and optimization; lack of algorithm model Operation and maintenance management and performance evaluation system, scattered and isolated resources, unable to dynamically allocate and manage computing power resources; unable to provide external service capabilities as an independent middle-end product, lacking statistics on resources, data and operating conditions of the provided services and instances Analysis; lack of standard guidance in model development, many roles involved, lack of clear role definition, and difficult collaboration between roles.

Based on the above technical problems, the embodiments of the present disclosure provide an artificial intelligence industry algorithm center.

As shown in FIG. 44-1, the embodiment of the present disclosure provides a method for implementing mirroring in the artificial intelligence industry algorithm, including the following steps:

In the artificial intelligence industry algorithm, the platform produces data samples based on algorithm mirroring;

Based on the data sample training algorithm, a new algorithm image is generated.

Wherein, the steps of generating data samples based on algorithm mirroring in the artificial intelligence industry algorithm include:

Upload the initial algorithm image to the artificial intelligence industry algorithm center; Based on the initial algorithm image, install a corresponding algorithm instance in the artificial intelligence industry algorithm;

Running the algorithm mirroring service based on the algorithm instance.

Collect negative samples of running algorithm mirroring service production data.

Among them, in this embodiment, the artificial intelligence industry algorithm platform provides multi-category algorithm models and services including image technology, video technology, voice technology, text recognition, knowledge graph, physical and chemical models, natural language processing, etc.:

Compared with related technologies, the artificial intelligence industry algorithm platform in the embodiment of the present disclosure supports a unified service interface specification and supports dynamic arrangement and combination of algorithm services.

The platform of the artificial intelligence industry algorithm in the embodiment of the disclosure supports various mainstream open source framework algorithms in the market, and can quickly create a model operating environment and deploy model services according to actual business scenarios, and realize various customized development and integration;

The artificial intelligence industry algorithm platform in the embodiment of the present disclosure supports unified management and operation and maintenance of computing power and service resources, adopts containerized cluster mode, supports flexible scheduling of computing power resources, realizes automatic expansion and contraction according to actual configuration scenarios, and improves computing resources utilization rate.

The artificial intelligence industry algorithm center platform provided by the embodiments of the present disclosure has formed a complete algorithm evaluation system, and supports the whole process management of model iteration and refinement.

The artificial intelligence industry algorithm platform in the embodiment of the present disclosure provides a standardized model delivery deployment and update mechanism;

The artificial intelligence industry algorithm center platform of the embodiment of the present disclosure provides a standardized service management system, and realizes the supervision and maintenance of the whole life process for the authorization, release, installation, deactivation, and monitoring of the model;

The artificial intelligence industry algorithm middle platform of the embodiment of the present disclosure is based on intelligent algorithms and video technology components, and realizes the functions of automatic image recognition, alarm push, and auxiliary decision-making in multiple business scenarios;

The entire process of platform coverage model training in the artificial intelligence industry algorithm of the embodiment of the present disclosure includes real-time evaluation of the algorithm model, data set maintenance, data verification, and algorithm iteration management; The artificial intelligence industry algorithm center platform in the embodiment of the present disclosure provides standard and clear process guidance for the development process for the standardization and platform management of the algorithm model, improves reusability, and realizes flexible and fast delivery;

The artificial intelligence industry algorithm middle platform of the embodiment of the present disclosure provides multiple delivery methods, supports centralized deployment or hierarchical deployment, and realizes flexible connection of upper-level business applications;

The solutions of the embodiments of the present disclosure can be applied to various scenarios, including but not limited to:

The embodiments of the present disclosure are applicable to any scenario that requires automation of the algorithm model, and provide integrated computing power resources and shared services through a unified entrance, reducing development costs;

The embodiments of the present disclosure are applicable to scenarios that require centralized management and maintenance of algorithm models provide standardized API interfaces and documents, and develop standardized AI capabilities;

The embodiment of the present disclosure takes the computer vision algorithm as the core, and the algorithm model covers mainstream industries, and supports the rapid deployment, management, and demonstration of a large number of mature algorithms integrated in the platform; The method for implementing mirroring in the artificial intelligence industry algorithm in the embodiment of the present disclosure will be described in detail below in conjunction with FIG. 44-1 and FIG. 44-2:

As shown in FIG. 44-1, the self-iterative steps of implementing the mirroring algorithm in the algorithm include:

First, upload the algorithm image to the algorithm center;

Then, based on the algorithm image, a corresponding algorithm instance is installed in the artificial intelligence industry algorithm.

Running the algorithm mirroring service based on the algorithm instance. Collect negative samples of the production data of the running algorithm mirroring service: Then, retrain the algorithm image, improve the model accuracy and generalization ability, and produce a new algorithm image.

As shown in FIG. 44-2, the platform in the algorithm provides external processing capabilities through APIs or push messages.

The artificial intelligence industry algorithm center platform provided by the embodiments of the present disclosure is used to provide artificial intelligence algorithms with management services such as algorithm deployment, algorithm configuration, algorithm training, and algorithm viewing/importing/deleting/upgrading. The inputs or video sources of the platform in the artificial intelligence industry algorithm are aggregated and uploaded from multi-mode heterogeneous networks that are dynamically deployed according to industry requirements or/and physical locations, including various sensings, alarms, and video data. At the same time, data such as linkage control, linkage shouting, linkage alarm, linkage SMS/email notification generated in the artificial intelligence industry algorithm platform are dynamically downloaded to the corresponding terminal according to industry requirements or/and physical location through a multi-mode heterogeneous network. In this embodiment, the artificial intelligence industry algorithm platform supports unified management and operation and maintenance of computing power and service resources, and can realize fog computing, edge computing and artificial intelligence according to industry applications, computing power, network and communication conditions. In the industry algorithm, the platform's own computing power and dynamic allocation of algorithm tasks. The containerized cluster mode is adopted to support elastic scheduling of computing resources, and automatic expansion and contraction are realized according to actual configuration scenarios and dynamic allocation of multi-mode heterogeneous communication networks to improve the utilization rate of computing resources. Secondly, the platform in the artificial intelligence industry algorithm can access the input parameters and video data required by different algorithms uploaded by the data intelligent fusion platform, and can output alarms/characteristic values to the artificial intelligence business platform to realize the artificial intelligence-based And the early warning view of the algorithm. In addition, the alarms/characteristic values generated by the platform in the artificial intelligence industry algorithm will also be fed back to the data intelligent fusion platform and stored in the corresponding theme/special library. For example, for video algorithms, the artificial intelligence industry algorithm center can retrieve the required videos/pictures through the streaming media center. For example, for prediction algorithms such as fire spread prediction and gas diffusion prediction, it is necessary to display the predicted diffusion range after a period of time (such as one hour) in a three-dimensional form. In such cases, the artificial intelligence industry algorithm center will provide data such as eigenvalues and predictive simulations to the digital twin center described below.

Compared with related technologies, the artificial intelligence industry algorithm platform in the embodiment of the present disclosure can carry out standardized and platform-based management, simple integration, and simplified development process; it can provide an operation and monitoring mechanism for the algorithm model, and ensure the stability of the service provided by the model; It can provide a unified channel for accessing algorithmic data sets, and standardize and unify data format standards; it can provide a unified evaluation index system for algorithmic models, and reflect the generalization ability of algorithmic models on the platform; it can perform data aggregation and Analysis; for the algorithm model with poor effect after going online, it can also provide a continuous improvement and iterative model quality system; it has the whole process management of the algorithm model generation and optimization process; provides the operation and maintenance management and performance evaluation system for the algorithm model. It can dynamically allocate and manage computing power resources; as an independent middle-end product, it can provide external service capabilities, and conduct statistical analysis on the resources, data and operation status of the provided services and instances.

### R5-2-45—a Real-Time Carbon Sink Measurement Method Based on Airborne Lidar and Hyperspectral.

However, the current carbon sink measurement method often adopts the sample plot inventory method. This carbon sink measurement method is mainly based on the change of the forest area, and the sample plot inventory is carried out manually. Factors are measured as a whole, and it is impossible to show the impact of forest scenarios on forest management; and the existing carbon sink measurement methods divide terrestrial ecosystems into aboveground biomass, underground biomass, soil layer, litter, dead There are 5 carbon pools in the forest, and the total carbon storage of the forest land is the sum of the carbon storage of each carbon pool, that is, Cₜₒₜₐₗ=C_{above ground}+C_{underground}+Cₗᵢₜₜₑᵣ+C_{dead wood}+Cₛₒᵢₜ, by calculating forest carbon within a period of time Changes in reserves are used to measure carbon sinks. This measurement method has the problems of high survey difficulty and difficult data acquisition, and the method of manually checking sample plots takes a long time and has large errors.

Based on the above technical problems, the present disclosure provides a real-time carbon sink measurement method based on airborne lidar and hyperspectral.

This disclosure adopts airborne lidar and hyperspectral technology, uses airborne lidar measurements, airborne hyperspectral bands and derived vegetation indices to simulate biomass, reduces the investigation workload to a certain extent, and improves the impact of related technologies on biomass estimate.

Exemplarily, the present disclosure considers that forest biomass is an important factor affecting climate change and forest productivity, and forest contribution to carbon storage and carbon cycle can be assessed.

Therefore, this disclosure adopts the method of remote sensing, using accurate lidar data, hyperspectral images to quantify forest information to estimate accurate carbon uptake. Compared with other estimation methods, the remote sensing method is comprehensive, dynamic, and fast, and can accurately and non-destructively monitor the forest ecosystem macroscopically, and can realize the transformation from dynamic monitoring of sample plots to convenient dynamic monitoring of the entire project.

Exemplarily, as shown in FIG. 45-1, an embodiment of the present disclosure provides a method for real-time measurement of carbon sinks based on airborne lidar and hyperspectral, and the method includes the following steps:

Obtain forest image information and lidar data;

Generate a forest resources theme map according to the image information of the forest and the laser radar data;

Calculate forest carbon sink changes based on the forest resource thematic map.

Among them, after obtaining the image information of the forest and the lidar data, it also includes: The forest image information and lidar data are processed, the forest image information is processed into DMC image and hyperspectral data, and the lidar data is processed into DMC and DEM data. Wherein, the step of obtaining the image information of the forest and the laser radar data includes: Digital aerial photogrammetry is used to obtain forest image information, and aerial lidar measurement is used to obtain forest signal strength data.

Wherein, the step of generating the forest resource theme map according to the image information of the forest and the laser radar data includes:

Use the image information of the forest to generate accurate large-scale tree species thematic maps (or tree species distribution maps) through RGB color images and NIR images, and use lidar signal strength data to generate tree resource thematic maps of tree height, diameter at breast height and crown.

Among them, the real-time carbon sink measurement method based on airborne lidar and hyperspectral in the present disclosure can be applied to the measurement of 5 carbon pools in the forest ecosystem, and the 5 carbon pools include aboveground biomass, underground biomass, soil layer, dry S carbon pools of litter and dead wood.

The following describes the embodiment scheme of the present disclosure in detail in conjunction with FIG. 45-1.

As shown in FIG. 45-1, the scheme of the embodiment of the present disclosure is based on airborne lidar and hyperspectral to realize real-time measurement of carbon sinks Considering that forest biomass is an important factor affecting climate change and forest productivity, forest biomass is used to evaluate forest impact Carbon storage and carbon contribution cycle, thus using remote sensing methods, using accurate lidar data, hyperspectral images to quantify forest information to estimate accurate carbon uptake.

Exemplarily, firstly, image information of the forest is acquired and processed, and lidar data of the forest is collected and processed.

Wherein, the way of acquiring the image information of the forest includes but not limited to: acquiring the image information of the forest by digital aerial photogrammetry.

Wherein, the manner of processing the image information of the forest includes but not limited to: processing the image information of the forest into DMC image and hyperspectral data. Among them, the DMC image can be processed by the DMC digital aerial camera Based on the area array CCD technology, the DMC digital aerial camera integrates the latest sensor technology with the latest photogrammetry and remote sensing image processing technology. It is assembled from multiple optical and mechanical parts. High-precision, high-performance measuring digital aerial photography instrument.

As an implementation, the DMC digital image is exposed synchronously through the 8 lenses of the DMC digital aerial camera during the aerial photography flight, and the 4 panchromatic lenses respectively obtain a 7k*4k digital image, through the geometric calibration of the lens, the image Matching and camera self-inspection, etc. the 4 center projection images obtained by 4 panchromatic lenses are combined into a virtual center projection synthetic image with a virtual projection center and a fixed virtual focal length.

For hyperspectral images, the spectral resolution is in 10^{-2λ}.

Spectral images within the order of magnitude range are called hyperspectral images (Hyperspectral Image). After the development of remote sensing technology in the second half of the 20th century, major changes have taken place in theory, technology and application. Among them, the emergence and rapid development of hyperspectral image technology is undoubtedly a very prominent aspect of this change. Through hyperspectral sensors mounted on different space platforms, that is, imaging spectrometers, in the ultraviolet, visible, near-infrared and mid-infrared regions of the electromagnetic spectrum, the target area is simultaneously imaged in tens to hundreds of continuous and subdivided spectral bands. While obtaining surface image information, it also obtains its spectral information, which is the first time that the spectrum and image are truly combined. Compared with multispectral remote sensing images, hyperspectral images have not only greatly improved in terms of information richness, but also provide the possibility of more reasonable and effective analysis and processing of this type of spectral data in terms of processing technology. Therefore, the influence and development potential of hyperspectral image technology are incomparable in all stages of development of previous technologies, especially in the field of remote sensing.

Among them, the way of collecting the lidar data of the forest includes but is not limited to: using airborne lidar measurement to obtain the signal strength data of the forest.

The way of processing the lidar data of the forest includes but not limited to: processing the lidar data into DMC and DEM data.

Among them, the Digital Elevation Model (Digital Elevation Model), referred to as DEM, is to realize the digital simulation of the ground terrain through limited terrain elevation data (that is, the digital expression of the terrain surface shape). A solid ground model of elevation is a branch of the Digital Terrain Model (DTM), from which various other terrain characteristic values can be derived. It is generally believed that DTM describes the spatial distribution of various geomorphic factors including elevation, such as slope, slope aspect, slope change rate and other factors including linear and nonlinear combinations, and DEM is a zero-order simple single-item digital geomorphic model, other landform characteristics such as slope, aspect and slope change rate can be derived on the basis of DEM.

Secondly, after acquiring and processing the image information of the forest, and collecting and processing the lidar data of the forest, a thematic map of forest resources is generated according to the image information of the forest and the lidar data.

Exemplarily, after obtaining accurate lidar data and hyperspectral images of the forest by means of remote sensing, a tree species distribution map is made through DMC images and hyperspectral data, and tree height, diameter at breast height, diameter at breast height, and Tree Resource Theme Map of Tree Age and Canopy.

Among them, using the DMC image and hyperspectral data in the image information of the forest, an accurate large-scale tree species theme map (or tree species distribution map) is generated through RGB color images and NIR images, and the DMC and DEM data in the lidar signal intensity data are used Generate tree resource thematic maps of tree height, diameter at breast height, tree age, and tree crown.

Finally, the changes in forest carbon sinks are calculated based on the forest resource thematic map. Compared with related technologies, when the present disclosure uses laser radar and image information to estimate carbon absorption, digital aerial photogrammetry is used to obtain image information, and then aerial laser radar measurement is used to obtain signal strength data. Using image information to generate accurate large-scale tree species thematic maps through RGB color images and NIR images, and using lidar signal strength data to generate tree resource thematic maps of tree height, tree age and tree crown. By quantifying the tree species and age information of forest resources, the carbon sinks of tree species, years, and regions are calculated with the help of lidar and digital image information.

This disclosure adopts the method of remote sensing, and uses accurate fine-light radar data and hyperspectral images to quantify forest information to estimate accurate carbon absorption. Compared with other estimation methods, the remote sensing method is comprehensive, dynamic, and fast. It can accurately and non-destructively monitor the forest ecosystem macroscopically, and can realize the transformation from dynamic monitoring of sample plots to convenient dynamic monitoring of the entire project.

This disclosure adopts airborne lidar and hyperspectral technology, uses airborne lidar measurements, airborne hyperspectral bands and derived vegetation indices to simulate biomass, reduces the investigation workload to a certain extent, and improves the impact of related technologies on biomass estimate.

The disclosure not only realizes the measurement of the five carbon pools in the forest ecosystem, but also introduces changes in forest scenarios. It mainly has the following functions: 1. Quantify the impact of forest scenarios on forest carbon sinks, and provide guidance for forest management; 2. Through changes in forest carbon sinks, reflect the effects of forest fire prevention, pest control and other activities.

### R5-3-46—a Method for Measuring Forest Carbon Sinks Based on Changes in Forest Carbon Dioxide.

At present, there are various methods for measuring carbon sinks, and most of the relevant research focuses on the estimation of carbon storage and carbon sink volume, but lacks the analysis of the change process on the time scale and the spatial difference of the change characteristics. At present, the measurement method is more inclined to use the year as the unit, and it is impossible to understand the temporal and spatial changes of forest carbon sinks.

In addition, the existing carbon sink measurement method is based on the change of forest area, and uses the method of manual inspection of sample plots. When measuring forest carbon sinks, the factors of normal forest growth and forest activities are considered as a whole and cannot be displayed. Impacts of forest scenarios on forest management. Moreover, the existing carbon sink measurement method divides the terrestrial ecosystem into five carbon pools, aboveground biomass, underground biomass, soil layer, litter, and dead wood. The total carbon storage of forest land is the sum of the carbon storage of each carbon pool . . . expressed by the following formula:

$${C}_{total} = {C}_{above ground} + {C}_{underground} + {C}_{litter} + {C}_{dead wood} + {C}_{soil} ;$$

Using the above formula, carbon sink measurement is realized by calculating the change of forest carbon storage over a period of time.

However, the related technology has the following disadvantages:

Related technologies are based on the change of forest area, which is usually measured by detecting the change of carbon storage in terrestrial ecosystems, or expressed by the product of carbon storage change and carbon emission. These methods realize the measurement of carbon sink within a certain period of time. However, the measurement period is long, and the year is often used as the unit of time, so it is impossible to realize the change of time and space. Moreover, the method of manually checking sample plots takes a long time and has large errors.

Based on the above technical problems, the present disclosure provides a method for measuring forest carbon sinks based on changes in forest carbon dioxide.

This embodiment considers that related technologies are based on changes in forest area, and are usually measured by detecting changes in terrestrial ecosystem carbon storage, or expressed by the product of carbon storage changes and carbon emissions. These measurement methods have relatively short measurement periods. Long, more inclined to measure in units of years. The disclosure monitors the changes of greenhouse gases (mainly carbon dioxide) in the forest, analyzes the change process on the time scale, and analyzes the spatial differences of the change characteristics, so as to understand the temporal and spatial changes of forest carbon sinks. The complete technical implementation scheme provided by this disclosure is as follows: This disclosure builds an atmospheric-greenhouse gas monitoring station in the forest to monitor the changes in the concentration of greenhouse gases in the forest in real time, and adopts a “top-down” method to invert according to the concentration of atmospheric CO₂ Carbon sinks in terrestrial ecosystems.

Exemplarily, an embodiment of the present disclosure provides a method for measuring forest carbon sinks based on changes in forest carbon dioxide. The method includes the following steps: monitoring a pre-selected standard forest land per unit area in the forest monitoring area. Changes in the concentration of carbon dioxide within a given time; based on the monitored changes in the concentration of carbon dioxide, the forest carbon sink is measured.

Wherein, before the step of monitoring the standard forest land per unit area pre-selected in the forest monitoring area, the concentration change of carbon dioxide within the preset time may also include:

In the forest monitoring area, the standard forest stand per unit area is selected as the measurement space.

Wherein, the selection rules of the standard woodland per unit area can be set according to the actual situation, such as 10 square meters, 100 square meters, one mu, one hectare, etc. which are not specifically limited in this embodiment.

Wherein, the step of monitoring the standard woodland per unit area in the monitoring forest monitoring area, the concentration change of carbon dioxide within the preset time includes: Build atmospheric-greenhouse gas monitoring stations in forests.

The atmospheric-greenhouse gas monitoring station monitors in real time the change of the concentration of carbon dioxide within a preset time in a pre-selected standard forest land per unit area in the forest.

Wherein, the preset time may be selected according to actual conditions, such as one day, one week, one month, or one quarter, which is not specifically limited in this embodiment.

As a result, forest carbon sinks can be measured based on changes in forest carbon dioxide. Furthermore, it is also possible to display the temporal and spatial changes of forest carbon sinks and understand the ecological value of forests in real time.

In this example, through the above scheme, by building an atmospheric-greenhouse gas monitoring station in the forest, real-time monitoring of changes in the concentration of greenhouse gases in the forest, and using a “top-down” approach to invert the carbon sink of the terrestrial ecosystem based on the concentration of atmospheric coz.

The following is a detailed description of the flow of the present disclosure based on forest carbon dioxide changes to achieve the measurement method of forest carbon sinks;

First, select the standard forest stand per unit area in the forest monitoring area as the measurement space. Wherein, the selection rules of the standard woodland per unit area can be set according to the actual situation, such as 10 square meters, 100 square meters, one mu, one hectare, etc. which are not specifically limited in this embodiment.

Then, build an atmosphere-greenhouse gas monitoring station in the forest; among them, you can build an atmosphere-greenhouse gas monitoring station in the forest monitoring area, or you can build an atmosphere-greenhouse gas monitoring station in a selected unit area of the standard forest stand, and you can also Build atmospheric-greenhouse gas monitoring stations in other suitable areas of the forest.

Among them, the atmosphere-greenhouse gas monitoring station can use corresponding algorithms to monitor and analyze common greenhouse gases in the atmospheric environment. In this embodiment, carbon dioxide, a common greenhouse gas, is selected as the monitoring object. Then, through the atmosphere-greenhouse gas monitoring station, the concentration change of carbon dioxide within a preset time is monitored in real time in a pre-selected standard forest land per unit area in the forest.

Wherein, the preset time may be selected according to actual conditions, such as one day, one week, one month, or one quarter, which is not specifically limited in this embodiment.

Based on the monitored changes in the concentration of carbon dioxide per unit area of standard forest land within a certain period of time, the time-series data and average time-series data of carbon dioxide concentration measurement are respectively obtained;

Determine whether the change in carbon dioxide concentration is negative:

When the change of carbon dioxide concentration is a negative value, it is determined that the growth of forest plants absorbs carbon dioxide, and the forest is a carbon sink;

According to the change of carbon dioxide concentration per unit area, air volume and carbon dioxide density, the total mass of carbon dioxide change is obtained as the carbon sink of standard forest land per unit area;

Calculate the carbon sequestration of the entire forest monitoring area through the carbon sequestration of standard forest land per unit area;

As a result, forest carbon sinks can be measured based on changes in forest carbon dioxide. Furthermore, it is also possible to display the temporal and spatial changes of forest carbon sinks and understand the ecological value of forests in real time.

In this example, through the above scheme, by building an atmospheric-greenhouse gas monitoring station in the forest, real-time monitoring of changes in the concentration of greenhouse gases in the forest, and using a “top-down” approach to invert the carbon sink of the terrestrial ecosystem based on the concentration of atmospheric CO₂.

Compared with related technologies, this disclosure builds an atmospheric-greenhouse gas monitoring station in the forest to monitor the changes in the concentration of greenhouse gases in the forest in real time, and adopts a “top-down” method to invert the carbon sink of the terrestrial ecosystem according to the concentration of atmospheric CO₂. Therefore, by monitoring the changes of greenhouse gases (mainly carbon dioxide) in the forest, analyzing the change process on the time scale, and analyzing the spatial differences of the change characteristics, we can understand the temporal and spatial changes of forest carbon sinks.

In addition, the measurement method of forest carbon sink based on forest carbon dioxide changes proposed in this disclosure can realize the display of forest carbon sink temporal and spatial changes, and understand the ecological value of forests in real time: as a supplement to CCER methodology, it can be mutually verified with methodology Authenticity of data.

In addition, carbon sequestration can also be realized by monitoring the growth of forest stands, or the calculation of tree carbon sequestration can be realized based on point cloud data and image recognition technology: or, the measurement of forest carbon sequestration can be realized by using carbon flux inversion technology.

### R5-4-47—a Method for Carbon Sequestration by Monitoring Stand Growth.

Due to the needs of social and economic development, fossil fuel energy will continue to be used until new alternative energy sources are found, and the resulting carbon emissions will continue to increase the concentration of CO₂ in the atmosphere, and the most important thing to alleviate the concentration of CO₂ in the atmosphere One of the effective ways is to strengthen the carbon sink function of the forest ecosystem. During the growth of the forest, carbon dioxide is absorbed through photosynthesis, and inorganic carbon is converted into organic carbon. By detecting the growth of standing trees, the effect of forest carbon sinks can be measured in real time, which is of great significance to the realization of the double carbon goal.

The existing carbon sink measurement method divides the terrestrial ecosystem into five carbon pools: aboveground biomass, underground biomass, soil layer, litter, and dead wood. The total carbon storage of forest land is the sum of the carbon storage of each carbon pool Calculated by the following formula:

$${C}_{total} = {C}_{above ground} + {C}_{underground} + {C}_{litter} + {C}_{dead wood} + {C}_{soil} ;$$

Based on the above formula, carbon sink measurement is realized by calculating the change of forest carbon storage over a period of time.

However, related technologies need to conduct field surveys on the sample plots during the calculation process. In the current measurement methods, the carbon sink of the entire aboveground biomass is measured by the change of the standing tree area in the sample plots, especially most of the aboveground biomass is considered, and the aboveground biomass is used Calculating the carbon storage of the entire ecosystem by using biomass has large errors, and it is difficult to accurately reflect the real and accurate carbon sink. In addition, changes in the standing area often require long-term accumulation, and the current measurement methods are difficult to achieve sequential measurement on a monthly and quarterly basis, and cannot provide guidance for actual work.

Based on the above technical problems, the present disclosure provides a method for measuring carbon sinks by monitoring stand growth.

This embodiment considers: in the measurement method of the related technology, the carbon sink of the whole aboveground biomass is measured by the change of the standing tree area in the sample plot, especially most of the aboveground biomass is considered, and the aboveground biomass is used to measure the carbon sink of the whole ecosystem. The calculation of carbon storage has large errors, and it is difficult to accurately reflect the real and accurate carbon sink. In addition, changes in the standing area often require long-term accumulation, and the current measurement methods are difficult to achieve sequential measurement on a monthly and quarterly basis, and cannot provide guidance for actual work.

The present disclosure can realize accurate measurement of carbon sinks in a relatively short period of time, especially in the current carbon neutral and carbon peaking plan, and can realize measurement of carbon sinks on a more refined time scale.

Based on the above description, as shown in FIG. 47-1 and FIG. 47-2, the present disclosure uses a tree growth monitor to provide a real-time carbon sink measurement method based on the growth of standing trees. Dimensional change: Calculate the biomass of each carbon pool corresponding to the tree according to the size change of the tree, calculate the carbon sink according to the biomass of each carbon pool corresponding to the tree.

Wherein, the step of obtaining the dimensional change of the tree within the preset time includes: obtaining the diameter at breast height and the change of the tree height of the tree within a certain period of time through a tree growth monitor; wherein, according to the dimensional change of the tree. The step of calculating the biomass of each carbon pool corresponding to the tree includes: using the diameter at breast height of the tree and the change in height of the tree, combined with the growth allometric equation of the tree to obtain the corresponding aboveground biomass;

according to the aboveground biomass and The relationship between the underground biomass, soil layer, litter, and dead wood is used to obtain the biomass at different positions of the trees; the carbon sink is obtained by using the relationship between the biomass and the carbon content rate. The following describes in detail the exemplary process of the method for measuring carbon sinks by monitoring stand growth in the present disclosure in conjunction with FIG. 47-1 and FIG. 47-2:

As shown in FIG. 47-1, firstly, the size change of the tree within a certain period of time is obtained, where the size change of the tree includes but not limited to the change of the DBH and tree height of the tree.

In the process of tree generation, the diameter at breast height and the height of the tree will change continuously with the passage of time, the diameter at breast height of the tree will increase, and the height of the tree will become longer.

As an implementation, the tree growth monitor can be used to measure the changes in diameter at breast height and tree height of trees within a certain period of time. In addition, the diameter at breast height and tree height of trees can also be measured by other measurement methods or measurement equipment.

Among them, the tree diameter is used to express the thickness of the trunk. Diameter at breast height, also known as dry diameter, refers to the diameter of the trunk of the arbor at the chest height from the ground surface. When the section is deformed, the average value of the maximum and minimum values is measured. Generally speaking, the part of the arbor below the breast height does not need to be measured. If the tree grows on a slope, it should be measured from the top of the slope to the breast height.

As shown in FIG. 47-2, several tree species of different families are listed, the measured DBH range, and the calculation model adopted.

Firstly, the diameter at breast height and the tree height of the trees within a certain period of time are measured by the tree growth monitor.

Then, the biomass of each carbon pool corresponding to the tree is calculated according to the change amount of the diameter at breast height and the tree height of the tree.

Among them, the carbon pools corresponding to trees include: aboveground biomass, underground biomass, soil layer, litter, and dead wood corresponding to trees.

Among them, biomass (biomass) is an ecological term, or specifically called plant mass (phytomass), which refers to the organic matter (dry weight) that exists in a unit area at a certain time (including the weight of food stored in the organism) The total amount is usually expressed in kg/m² ort/hm² The amount of plants in various groups of flora is difficult to measure, especially the excavation and separation of underground organs is very difficult. For the purposes of economic utilization and scientific research, it is often necessary to investigate and count the aboveground biomass of trees and pastures, and based on this, the proportion of the biomass of various groups in the total biomass in the sample plot can be judged.

In this embodiment, when calculating the biomass of each carbon pool corresponding to the tree, firstly, the diameter at breast height and the tree height variation of the tree are used to obtain the corresponding aboveground biomass in combination with the growth allometric equation of the tree; Then, according to the relationship between aboveground biomass and underground biomass, soil layer, litter, and dead wood, obtain the biomass at different positions of the tree; finally, use the relationship between biomass and carbon content to obtain carbon sequestration.

Compared with related technologies, this disclosure can realize accurate measurement of carbon sinks in a short period of time, especially in the current carbon neutral and carbon peaking plan, and can realize the measurement of carbon sinks on a more refined time scale. In addition, airborne lidar can be used to measure tree height and DBH, or, based on point cloud data and image recognition technology, the calculation of tree carbon sequestration can be realized; or, carbon flux inversion technology can be used to realize forest carbon sequestration measurement. R5-5-48-A method for simulating the impact of forest scenarios on forestry carbon sinks Climate change is a common challenge for all mankind. In order to ensure that climate change does not threaten the sustainable development of the ecosystem, food production, and economy and society within a certain period of time, the concentration of greenhouse gases in the atmosphere should be stabilized to prevent the climate system from being subject to dangerous human interference. At a high level, it needs to be achieved by controlling or reducing greenhouse gas emissions.

The existing carbon sink measurement methods are usually based on changes in forest area. When measuring forest carbon sinks, the factors of normal forest growth and forest activities are considered as a whole for measurement, and it is impossible to show the impact of forest scenarios on forest management.

In addition, the existing carbon sink measurement method divides the terrestrial ecosystem into five carbon pools: aboveground biomass, underground biomass, soil layer, litter, and dead wood and, calculated by the following formula:

$${C}_{total} = {C}_{above ground} + {C}_{underground} + {C}_{litter} + {C}_{dead wood} + {C}_{soil} ;$$

Based on the above formula, carbon sink measurement is realized by calculating the change of forest carbon storage over a period of time.

In addition, forests have dual attributes of carbon sinks and carbon sources. During the growth process, forests absorb CO₂ in the atmosphere to synthesize organic matter through photosynthesis, and store organic carbon in the form of forest biomass. In this sense, forests are atmospheric CO_{2. 2} sinks. However, when the forest suffers from fire, pests and diseases, and deforestation activities, it will also release fixed carbon in the atmosphere and become a source of CO₂ in the atmosphere. In related technologies, the conversion between aboveground biomass, soil layer, and dead wood due to factors such as forest fires, pests and diseases is not considered, but the overall calculation is performed in the form of a unified tree area, which cannot clearly reflect the impact of forest scenarios forest impact.

Based on the above technical problems, the present disclosure provides a method for simulating the impact of forest scenarios on forestry carbon sinks.

This example considers that the forest absorbs carbon dioxide through photosynthesis and converts inorganic carbon into organic carbon. Therefore, understanding forest scenarios can enhance the ability of forest carbon sinks.

In this disclosure, various forest scenarios are introduced and compared with the normal growth state of the forest, the impact of the forest scenario on the forest can be more clearly and straightforwardly seen.

Based on the above description, this disclosure provides a method for simulating the impact of forest scenarios on forestry carbon sinks.

As shown in FIG. 48-1, this disclosure uses the sample plot method to measure the changes of the five carbon pools defined by the IPCC for terrestrial ecosystems over a period of time, and introduces various forest scenarios to achieve precise measurement of carbon pools.

Exemplarily, the method for simulating the impact of forest scenarios on forestry carbon sinks includes the following steps obtaining the amount of carbon stock change in the forest land in the monitoring area within a preset time; obtaining the forest activity factors of each forest scenario on the forest land in the monitoring area; The amount of change in the carbon storage of the forest land in the monitoring area within the preset time, and the forest activity factors of the forest land in the monitoring area in each forest scenario, to obtain the net carbon sink of the forest land in the monitoring area within the preset time; according to the Monitor the net carbon sequestration of regional forest land within a preset period of time to determine the impact of forest scenarios on forestry carbon sequestration.

Among them, the calculation formula of net carbon sink is as follows:

$${C}_{sink} = Δ C - BI ;$$

Cₛᵢₙₖ—the net carbon sink in time t;

ΔC—the amount of change in the carbon storage of the five carbon pools in the terrestrial ecosystem during time t;

BI—Forest activity factor of various forest scenarios introduced.

Among them, if Cₛᵢₙₖ >0, it means that the forest management activities bring positive effects to the forest, otherwise, it is a negative effect.

Further, the method for simulating the impact of forest scenarios on forestry carbon sinks may also include the following steps:

Build a graph of changes in forest activity factors over time for various forest scenarios; Show the change graph of the curve.

In order of time, the establishment of BI curve changes can more intuitively show the impact of each scenario on the forest. Wherein, the step of obtaining the change amount of the carbon storage of the forest land in the monitoring area within the preset time includes: obtaining the aboveground biomass, underground biomass, soil layer, litter, and dead wood within the preset time of the monitoring area. Changes in carbon stocks in pools. Among them, the total carbon storage of forest land is the sum of the carbon storage of all carbon pools in the monitoring area. Over a period of time, the carbon storage of forest land is the change of carbon storage, including the five carbon pools of the forest ecosystem in the monitoring area within a period of time. Changes in carbon stocks. Wherein, the step of obtaining the forest activity factors of each forest scenario to the forest land in the monitoring area includes: counting each forest scenario, and counting the forest activity factors of each forest scenario to the monitoring area woodland.

Among them, the forest scenario may include: 1 Afforestation activities: including determination of provenance, seedling raising, forest land clearing and land preparation methods, planting, survey of survival rate and preservation rate, replanting, weeding, fertilization and other measures; 2. Forest management activities: tending. Thinning, fertilization, cutting, renewal, pest control and fire prevention measures, etc.; 3. Forest disasters: forest fires, pests, etc.; 4. Human activities: greenhouse gases emitted by machinery, etc.

The method for simulating the impact of forestry scenarios on forestry carbon sinks in this disclosure will be described in detail below in conjunction with FIG. 48-1.

This disclosure uses the sample plot method to measure the changes of the five carbon pools defined by the IPCC for terrestrial ecosystems over a period of time, and introduces various forest scenarios to achieve precise measurement of carbon pools.

Exemplarily, first, the carbon storage calculation is performed on the forest land in the monitoring area. On the one hand, the forest carbon stock change when the forest land in the monitoring area is not used in any forest scenario is obtained. Calculate the change of carbon sink based on the above two, that is, the net carbon sink.

More exemplary, firstly, to obtain the forest carbon stock change when the forest land in the monitoring area does not have any forest scenario, the following scheme can be used specifically: Obtain the change of carbon storage in the five carbon pools of aboveground biomass, underground biomass, soil layer, litter, and dead wood in the monitoring area over a period of time. The total carbon storage of forest land is the sum of the carbon storage of each carbon pool in the monitoring area. Over a period of time, the carbon storage of forest land is the change of carbon storage, including the carbon storage of five carbon pools in the forest ecosystem of the monitoring area within a period of time amount of change.

Then, obtain the forest activity factors corresponding to each forest scenario in the forest land of the monitoring area. Specifically, the following scheme can be adopted:

Statistics of each forest scenario; statistics of the forest activity factors of each forest scenario on the forest land in the monitoring area.

Among them, the forest scenario may include: afforestation activities, forest management activities, forest disasters, human activities, etc. among which: afforestation activities: including determination of provenance, seedling raising, forest land clearing and site preparation methods, planting, survey of survival rate and preservation rate, replanting, weeding, fertilization and other measures; forest management activities tending, thinning, fertilization, cutting, regeneration, pest control and fire prevention measures, etc.; forest disasters: forest fires, pests, etc.; human activities: greenhouse gases emitted by machinery, etc.

After obtaining forest carbon stock changes and forest activity factors corresponding to each forest scenario, carbon sink changes, that is, net carbon sinks, are calculated based on the above two. Among them, the calculation formula of net carbon sink is as follows:

$${C}_{sink} = Δ C - BI ;$$

Cₛᵢₙₖ— the net carbon sink in time t;

ΔC—the amount of change in the carbon storage of the five carbon pools in the terrestrial ecosystem during time t.

BI—Forest activity factor of various forest scenarios introduced.

After obtaining the carbon sink change of the forest land in the monitoring area, the impact of the forest scenario on the forest carbon sink can be judged based on this indicator.

Among them, if Cₛᵢₙₖ >0, it means that the forest management activities bring positive effects to the forest, otherwise, it is a negative effect.

Furthermore, it is also possible to establish the curve changes of BI in time order, which can more intuitively show the impact of each scenario on the forest.

Compared with related technologies, this disclosure not only realizes the measurement of five carbon pools in the forest ecosystem, but also introduces changes in forest scenarios, thereby quantifying the impact of forest scenarios on forest carbon sinks and providing guidance for forest management; Moreover, through changes in forest carbon sinks, the effects of forest fire prevention, pest control and other activities can be reflected sideways.

### R5-6-49—a Method for Reversing Forest Management Based on Carbon Sequestration.

Existing technical implementation schemes often adopt a positive approach, starting with increasing the forest area and improving the quality of forest land Although this approach can steadily increase forest carbon sinks and have an effect on improving forestry carbon sinks, the purpose is weak. Especially under the 3060 dual carbon targets, it is necessary to plan forestry carbon sinks in a more planned and orderly manner.

Based on the above technical problems, the present disclosure provides a method for retrieving forest management based on carbon sinks.

This disclosure is committed to further providing technical support for forest afforestation, logging, and forest tending through quantified carbon sinks and various forest management indicators that affect carbon sinks.

The embodiment of the present disclosure proposes a solution by calculating the greenhouse gas (mainly carbon dioxide) emissions in a certain area within a certain period of time, find out the carbon emission base, and calculate the local carbon emissions according to the local double carbon target required carbon sinks. On the basis of carbon sinks, the combination of tree species is deduced through factors such as forest management, the relationship between vegetation, and site conditions.

Exemplarily, as shown in FIG. 49-1, the present disclosure provides a method for reversing forest management based on carbon sinks, including the following steps obtaining carbon sinks in forest preset areas: Inversion of carbon sinks for forest management strategies.

Wherein, the step of obtaining the carbon sequestration of the preset forest area may include: obtaining the greenhouse gas emissions of the preset forest area within a certain period of time; according to the greenhouse gas emissions of the preset forest area within a certain period of time, combined with the local Double carbon target, calculate the carbon sink required by the local area. Wherein, the step of estimating the required local carbon sink according to the greenhouse gas emissions in the forest preset area within a certain period of time, combined with the local double carbon target, includes: calculating the greenhouse gas emissions in the forest preset area within a certain period of time Emissions are calculated to obtain the base number of carbon emissions; based on the base number of carbon emissions, according to the local dual carbon goals, the local required carbon sinks are calculated. For example, by calculating the greenhouse gas (mainly carbon dioxide) emissions in a certain area within a certain period of time, find out the carbon emission base, and calculate the local required carbon sinks according to the local dual carbon goals.

Wherein, the step of inverting the forest management strategy according to the carbon sink in the preset forest area includes: inverting the forest management strategy based on the carbon sink in the preset forest area and in combination with preset management influencing factors.

Among them, management impact factors include but not limited to: forest management, relationship between vegetation species, site conditions, etc. Among them, forest management strategies include but are not limited to: forest tree species combinations, regional allocation strategies, etc.

On the basis of carbon sinks, the combination of tree species is deduced through factors such as forest management, the relationship between vegetation species, and site conditions, so as to achieve the purpose of inverting forest management based on carbon sinks.

As shown in FIG. 49-1, the method for inversion of forest management based on carbon sequestration in this disclosure is described in detail below: first, obtain the greenhouse gas emissions in the forest preset area within a certain period of time; then, according to the forest preset within a certain period of time. Regional greenhouse gas emissions, combined with local dual carbon targets, are used to calculate the required carbon sinks for the local area.

Among them, according to the greenhouse gas emissions in the forest preset area within a certain period of time, combined with the local double carbon target, the following scheme can be used to calculate the carbon sink required by the local area: the greenhouse gas emissions in the forest preset area within a certain period of time Calculate the amount of gas emissions to obtain the base number of carbon emissions; based on the base number of carbon emissions, and according to the local dual carbon goals, calculate the amount of carbon sinks required by the local area Among them, the greenhouse gas can be CO₂ and the like.

Then, the forest management strategy is reversed according to the carbon sinks in the forest preset area. Exemplarily, the implementation is as follows: inverting the forest management strategy according to the carbon sink in the preset forest area and in combination with the preset management influencing factors.

Among them, management impact factors include but not limited to: forest management, relationship between vegetation species, site conditions, etc.

Among them, forest management strategies include but are not limited to: forest tree species combinations, regional allocation strategies, etc.

On the basis of carbon sinks, the combination of tree species is deduced through factors such as forest management, the relationship between vegetation species, and site conditions, so as to achieve the purpose of inverting forest management based on carbon sinks.

Compared with related technologies, the disclosed scheme can combine the government's dual-carbon goals to obtain the carbon sinks of forest preset areas, and invert forest management strategies based on carbon sinks combined with preset management influencing factors. On the one hand, it can clarify the government's dual-carbon goals. The feasibility of implementing the dual-carbon plan can improve forest quality on the other hand.

### R5-6-50—a Method to Improve Forest Carbon Sequestration Capacity Based on Adjusting Forest Structure.

Research and practice have shown that the rate of forest carbon sequestration is closely related to its forest age structure Like people, forests also have infancy, youth, middle age and old age. Forests can be divided into young forests, middle-aged forests, nearly mature forests, mature forests and over-mature forests according to age. The carbon sequestration rate of young and middle-aged forests is relatively fast, while the growth and wood quality of mature forests and over-mature forests have decreased significantly, and their carbon sequestration capacity has also begun to gradually decline. At the end of the life cycle, trees will gradually die and become carbon sources, resulting in the release of carbon.

From the perspective of the forest cultivation process, the stand density at the young stage is relatively high. As the age of the stand increases, due to the competition of light and hot water, it will naturally become thinner gradually, but this process is very long. On the one hand, forest trees grow slowly and their carbon sequestration capacity decreases; on the other hand, a large number of carbon sources are formed due to the increase of dead wood in forest stands. Therefore, before the forest is naturally sparse, if scientific and reasonable artificial measures are taken to optimize the structure and promote the growth of trees, the purpose of improving stand quality and maintaining a high carbon sequestration rate can be achieved.

At present, an effective way to improve the carbon sequestration capacity of forests is to increase forest area and increase forest productivity. Among them, effective ways to increase forest area include:

1. Improve the utilization rate of existing forest land and increase the area of forest land.

2. Make full use of barren hills and wasteland suitable for forests, logging sites where natural regeneration is difficult, and forest open spaces, etc. to build artificial mixed forests or adopt methods to promote natural regeneration to cultivate mixed forests, effectively increasing the forest area.

3. Develop idle and waste land resources for afforestation and increase forest area.

Idle and waste land is part of land resources and belongs to the category of natural resources. In today's world, the population continues to increase, but the arable land on which human beings rely is decreasing year by year. There are idle and waste lands in a region that are not fully utilized, mostly saline-alkali land, dry waste pits, abandoned channels, abandoned traffic land, and river beach wasteland, Abandoned kiln pits, post-mining slag beaches in mining areas and other places. Afforestation on idle land can increase the area of forest land, protect the fields from wind, purify the atmosphere, and beautify the land.

4. The restarted project of returning farmland to forest is the main way to increase the forest area in the future.

Among them, effective ways to improve forest productivity and increase forest carbon sequestration include:

1. Strengthen the construction of carbon sink forests.

Carbon sink afforestation aims at forest carbon sink. Compared with ordinary afforestation, it highlights the carbon sink function of afforestation. Therefore, it is possible to maintain the long-term carbon sequestration capacity of the ecosystem by building forests and strengthening forest management. Building carbon sequestration forests is the most convenient and effective way to sequester carbon, and at the same time, it can also obtain multiple benefits of ecology, economy and society.

2. Strengthen the management of tending, and pay attention to the tending method that combines the effect of carbon sink with other effects.

The forestation of a region is all about considering its ecological function Strengthening tending management is the basis for improving the ecological efficacy of forests with different ecological efficacy. However, forest stands with different ecological functions have different emphases in tending management, and the forest carbon sink function focuses on the biomass per unit area. Therefore, in terms of tending management, it should be combined with other ecological functions to complement each other.

3. Promote stand improvement.

The forest stand that pays attention to carbon sink function is basically the same as other ecological function forest stands in terms of promoting stand improvement, which is a process of improving forest land productivity. It is necessary to renovate and transform the defective forest stands that have lost their ecological functions due to repeated human destruction or natural disasters, select suitable tree species for timely afforestation, and restore the forest as soon as possible; Carry out improvement; for sparse forests that have lost or have reduced ecological functions, replant according to the functions and specific conditions, comprehensively improve the quality of forest stands, and thereby increase forest productivity.

4. Combination of forest resources protection with compensation and social service functions.

The conventional protection of forest resources is to effectively protect forest resources in various places through publicity and education, banning and management, and crackdown and punishment. At the same time, it can be seen that the interruption of the source of livelihood of “relying on the mountains to eat the mountains” has exacerbated poverty and created social conflicts. Therefore, combining the management and protection of forest resources with free provision of solar cookers and building biogas pools, guaranteeing ecological compensation, providing subsidies for wild animals harming farmland, and increasing the enthusiasm of the people in forest areas to protect forest resources can more comprehensively and effectively benefit forest resources. Protect.

5. Adopt scientific and reasonable forest construction methods.

To have a reasonable structure, a reasonable structure must first be reasonably densely planted, increase the leaf area index per unit area, and strengthen the use of light energy; to build a mixed forest, the general multi-layer vertical canopy structure, due to the large leaf area index and large light-receiving surface, can be used. Making full use of solar energy not only improves forest productivity, but also maintains the stability of forest stands.

6. Select native tree species and cultivate and introduce improved species for afforestation.

Each tree species has its own ecological requirements. The selection of afforestation tree species should be suitable for the site, mainly native tree species. At the same time, it is necessary to introduce scientifically, actively cultivate, and strengthen the use of improved species. This is an inevitable choice for forestry development and also to improve forest productivity, increase the basis for forest carbon sequestration and forestry science development.

7. Strengthen scientific and technological innovation and improve forest productivity.

8. Strengthen independent scientific and technological innovation capabilities, carry out research and development of technologies for breeding seedlings of improved forest species, afforestation technologies for inferior site conditions, allocation of tree species with different ecological functions and tending management, and at the same time strengthen exchanges and cooperation, promote the transformation of scientific and technological achievements, and summarize advanced and practical technologies. The experience is applied to forestry production to improve the productivity of forest land.

9. Establish an ecological compensation system, mobilize the whole society, and improve forest productivity.

Implementing the ecological assessment and compensation system, carrying out assessment and evaluation, classifying grades, and adopting graded compensation methods can mobilize the enthusiasm of forest farmers to build forests; in some areas with good ecology, the losses suffered due to ecological protection have not been compensated for a long time, and eventually bruised. This has weakened the enthusiasm of the masses for ecological protection, made it difficult to coordinate the relationship between the protection department and the masses, and intensified the protection pressure. The implementation of the ecological compensation system allows the relatively poor and backward areas caused by ecological protection to fully enjoy the dividends brought about by development, which is conducive to mobilizing the enthusiasm of forest farmers to protect the ecology.

However, most of the related technologies are to increase the forest area and improve the productivity of the forest, ignoring the influence of the interaction between different vegetation and tree species in the community on the growth state of the forest.

Based on the above technical problems, the present disclosure provides a method for improving forest carbon sequestration capacity based on adjusting forest structure.

In this embodiment, it is considered that the related technologies mostly focus on increasing the area of forest land and improving the productivity of forest land, ignoring the influence of the interaction between different vegetation and tree species in the community on the growth state of the forest.

The present disclosure considers the influence of the interaction between different vegetation and tree species in the community on the growth state of the forest.

The distribution of vegetation populations depends on interspecific competition and seed dispersal ability at the micro scale, and is mainly affected by habitat differences at the macro scale. The main vegetation populations represent not only the results of ecological environment domestication over the years, but also the growth of future vegetation trends and the adaptation of vegetation to the overall environment.

Exemplarily, as shown in FIG. 50-1, the method proposed by the present disclosure to improve forest carbon sequestration capacity based on adjusting forest structure includes the following steps: determining the abundance and dominant population of communities in the ecosystem; degree and dominant populations to construct a multi-layer composite configuration of the forest. Wherein, as an implementation manner, the step of determining the abundance and dominant populations of communities in the ecosystem includes.

Using the sampling survey method, the abundance and dominant populations of the community can be determined through the ratio of the number, coverage, diameter at breast height or ground diameter of different vegetation in the ecosystem to the entire vegetation community. Wherein, as an implementation manner, the step of determining the abundance and dominant populations of the communities in the ecosystem may include: determining the vegetation populations of the communities in the ecosystem by sampling survey methods; The dominant population; estimate the abundance of the community to get the abundance of the community Wherein, as an implementation manner, the step of constructing a multi-layer composite configuration of forests according to the abundance and dominant populations of the communities includes:

Obtain the distribution pattern of the plant population on a spatial scale according to the abundance and dominant population of the community;

According to the distribution pattern of the plant population on the spatial scale, the characteristics of the community, the net photosynthetic rate and leaf area index of the studied population, and the degree of adaptation of the vegetation to the local environment are analyzed;

According to the community characteristics obtained from the analysis, the net photosynthetic rate and leaf area index of the population obtained from the research, and the adaptability of the vegetation to the local environment, determine the optimal species combination and construct a multi-layer composite configuration of the forest.

Among them, the distribution patterns of plant populations on the spatial scale include: random distribution, uniform distribution and cluster distribution.

Through the above scheme, the present disclosure considers the influence of the interaction between different vegetation and tree species in the community on the growth state of the forest. On the basis of increasing the forest area and improving the productivity of the forest land, taking into account the interaction between different populations in the community, through Optimizing the positive correlation of growth between populations and screening the vegetation species with the highest utilization rate of photosynthesis among populations to improve the carbon sequestration capacity of forests.

Below in conjunction with FIG. 50-1, the method of the present disclosure based on adjusting the forest structure to improve the carbon sequestration capacity of the forest is elaborated: as shown in FIG. 50-1, first, the vegetation population in the community is sampled and investigated; then, based on the vegetation in the community Population, to determine the dominant population of the community; then, estimate the abundance of the community; then, analyze the characteristics of the community, study the net photosynthetic rate and leaf area index of the population, and the adaptability of the vegetation to the local environment; finally, determine the optimal species combination.

Exemplarily, the present disclosure adopts a quadrat survey method to determine the abundance and dominant species of the community through the coverage quantity, coverage, diameter at breast height or the ratio of ground diameter to the entire vegetation community of different vegetation in the ecosystem.

The spatial distribution pattern of a plant population is mainly a study of the distribution of a certain plant population on a spatial scale, and it is also a discussion and study of the distribution of all individuals within a population within a certain spatial level. There are three patterns in the spatial distribution of individuals included in the population, namely random distribution, uniform distribution and cluster distribution.

By calculating the important value of species in each type of area, richness index (R). Shannon-Winer index (H′). Simpson dominance index (D), species evenness index (Jsw), diffusion coefficient (C), negative Binomial parameter (K), average crowding degree (m*), clustering index (I), agglomeration index (P1). Green index (GI). Cassie index (CA), diffusivity index (Iõ), determine advantage After the population distribution pattern, if the dominant species is determined to be an aggregation type, the degree of aggregation is basically proportional to the diversity indicators such as vegetation quantity and abundance, indicating that the same vegetation is more likely to form an aggregation effect, that is to say, most vegetation is characterized by species Inner aggregation is more conducive to mutual occlusion among individuals, and jointly resists external disturbances (competition between different species and the influence of environmental factors), thereby improving the survival rate.

In addition, the inter-species correlation plays an important role in forest carbon sequestration. The growth indicators of different vegetation, such as tree height, leaf area and canopy coverage area, can also reflect the adaptability of different vegetation to the surrounding environment, because There may be synergistic and adaptive systems formed by plants in response to environmental changes and species competition, enabling their respective intraspecific groups to form mutually beneficial habitats in response to external influences. In addition, due to the difference in net photosynthetic rate and leaf area index of different plants, photosynthetic carbon sequestration capacity is also different.

Taking into account the climate, rainfall, and vegetation requirements for the growth environment in different regions, it is also considered as a parameter.

Based on the above explanations, reasonably match trees, shrubs and herbaceous plants to construct a multi-layer composite configuration of the forest.

Compared with related technologies, the disclosure considers the interaction between different populations of the community on the basis of increasing the area of forest land and improving the productivity of forest land, by optimizing the positive correlation of growth between populations, and screening the vegetation with the maximum utilization rate of photosynthesis between populations species to increase the carbon sequestration capacity of forests. Therefore, taking scientific and reasonable artificial measures, optimizing structure, and promoting tree growth can achieve the purpose of improving stand quality and maintaining a high carbon sequestration rate.

### R5-7-51—Weather Prediction Model Based on WRF and Deep Neural Network.

Many features of weather and climate are coupled, and these relationships can be approximated using a parametric approach, in which relationships are often modeled at scales larger than the actual phenomena. In the related technology, although the parameterized operation simplifies many physical operation processes, the calculation cost is still expensive, and it is difficult to obtain the early data and required parameters, and the efficiency is low.

Based on the above technical problems, the embodiments of the present disclosure provide a weather prediction model based on WRF and deep neural network.

In this embodiment, it is considered that related technologies approximate the relationship between weather and climate by using a parameterized model, which is expensive and inefficient to calculate, and it is difficult to obtain early data and demand parameters.

Therefore, the embodiment of the present disclosure proposes a scheme of combining a neural network with a WRF model, which can reduce processing time and reduce calculation pressure. First introduce the WRF model and neural network.

WRF (Weather Research and Forecasting Model, weather forecasting model or weather research and forecasting model) is a unified meteorological model jointly developed by American scientific research institutions such as the Center for Environmental Prediction (NCEP) and the National Center for Atmospheric Research (NCAR) model. The WRF model is divided into two types. ARW (the Advanced Research WRF) and NMM (the Nonhydrostatic Mesoscale Model), namely research and business use, which are managed and maintained by NCEP and NCAR respectively. WRF mode is fully compressible and non-static mode, written in F90 language. Arakawa C (Arakawa C) grid points are used in the horizontal direction, and terrain following quality coordinates are used in the vertical direction. The WRF mode adopts the third-order or fourth-order Runge-Kutta algorithm in terms of time integration.

The WRF model can not only be used for real weather forecasting, but also can be used as a theoretical basis for the discussion of basic physical processes, such as in the field of atmospheric numerical simulation research, including data assimilation research, physical process parameterization research, regional Climate simulation, air quality simulation, air-sea coupling and ideal experiment simulation, etc. Therefore, the WRF model has many uses, such as: weather forecasting, small and medium-scale system simulation, data assimilation research, etc. It can also rely on WRF's chemical module, hydrological module, climate model and other professional modules to carry out aerosol, debris flow and other related research.

The WRF model consists of four parts, namely the preprocessing system (WPS, used to interpolate the data and initialize the model standard, define the model area and select the map projection method), the data assimilation system (WRFDA, including 3D variational assimilation), and the power core That is, the main module (ARW/NMM) and the post-processing system (graphics software package).

LSTM (Long Short-Term Memory) is a long-term short-term memory network, a time recurrent neural network (RNN), mainly to solve the problem of gradient disappearance and gradient explosion during long sequence training. Simply put, LSTM can perform better in longer sequences than ordinary RNNs. LSTMs already have a variety of applications in technology. LSTM-based systems can learn tasks such as translating languages, controlling robots, image analysis, document summarization, speech recognition image recognition, handwriting recognition, controlling chatbots, predicting diseases, click-through rates and stocks, synthesizing music, and many more. The scheme of the embodiment of the present disclosure includes the model training part and the inference prediction part of the model application, mainly combining WRF and deep neural network for regional climate prediction, and combining the data information initially processed by WRF-WPS with the collected real scene information as a deep neural network. Network training dataset. Exemplarily, as shown in Figures $1-1 to 51-2, a method for weather forecasting based on a WRF and deep neural network weather forecast model provided by an embodiment of the present disclosure includes the following steps.

Input the collected weather information into the pre-built weather forecast model; The weather conditions in the future are predicted by the weather prediction model.

Among them, the collected meteorological information includes but is not limited to: wind direction, light, wind speed, temperature, humidity, terrain, etc. and these collected meteorological information is input into the weather forecasting model as a reasoning basis to predict future weather conditions.

Among them, the weather prediction model is constructed based on WRF and deep neural network training.

Among them, FIG. 51-1 is a flow chart of weather forecasting based on deep learning, and FIG. 51-2 is a diagram of the LSTM calculation process. After the wind direction, light, wind speed, temperature, humidity, terrain and other data are input into the LSTM model, the calculation is performed through the LSTM unit, including the forgetting gate, input gate, and output gate for summary calculation, and finally output to the fully connected layer for dimension conversion to obtain the weather forecast result.

Therefore, combined with WRF and deep neural network for regional climate prediction, in the face of irregular meteorological features, available features can be more accurately selected and used, and LSTM can be used for long-term feature analysis and judgment, thereby significantly improving the accuracy of the forecast model.

As shown in FIG. 51-1 to FIG. 51-2, a method for building a weather forecast model based on WRF and a deep neural network provided by an embodiment of the present disclosure includes the following steps.

Obtain the collected basic data information;

Importing the basic data information into the WRF model for preliminary data processing to obtain preliminary processing data information;

Neural network model training is performed based on the preliminary processed data information to obtain a weather prediction model.

Wherein, the step of performing neural network model training based on the preliminary processing data information to obtain a weather prediction model includes:

Obtaining initial training set data based on the preliminary processed data information;

The initial training set data is divided into test set data and verification set data;

Carry out LSTM model training based on the test set data, obtain the trained meteorological prediction model;

The trained weather prediction model is verified based on the verification set data to obtain a final weather prediction model.

Among them, the collected basic data information includes but not limited to, gridded data, surface information data, conventional observation data, and the collected gridded data, surface information, conventional observation data, etc. are used as basic data information.

Wherein, the step of importing the basic data information into the WRF model for preliminary data processing, and obtaining the preliminary processing data information includes:

The WPS module that described basic data information imports in the WRF model carries out preprocessing, obtains preliminary preprocessing data;

Import the preprocessed data into the REAL module in the WRF model for preprocessing to obtain preliminary processed data information.

Wherein, the step of obtaining initial training set data based on the preliminary processing data information includes:

Collect real scene information;

Cleaning the collected real-scene scene information and preliminary processing data information; The cleaned preliminary processing data information is combined with the collected real-scene scene information for normalization processing as the initial training set data of the neural network. Wherein, the real-scene scene information includes but is not limited to: space-time coordinates, topography, topography, disturbing objects, and the like.

Wherein, the described step of carrying out LSTM model training based on the test set data to obtain the trained meteorological prediction model comprises:

Input the LSTM model based on the test set data for training, learn to judge the causal relationship between each parameter, and obtain the output result.

According to the output result and the gradient descent situation, the parameter weights of model training are adjusted to make the model converge, and a trained meteorological prediction model is obtained.

Subsequently, the collected weather information can be input into the weather forecast model constructed above, and the weather forecast model can be used to predict the future weather conditions.

Among them, the collected meteorological information includes but is not limited to: wind direction, light, wind speed, temperature, humidity, terrain, etc. and these collected meteorological information is input into the weather forecasting model as a reasoning basis to predict future weather conditions.

Among them, FIG. 52-1 is a flow chart of weather forecasting based on deep learning, and FIG. 51-2 is a diagram of the LSTM calculation process. After inputting wind direction, light, wind speed, temperature, humidity, terrain and other data into the LSTM model, the calculation is performed through the LSTM unit, including forgetting gate, input gate, and output gate for summary calculation, and finally output to the fully connected layer for dimension conversion. Obtain weather forecast results.

Therefore, combined with WRF and deep neural network for regional climate prediction, in the face of irregular meteorological features, available features can be more accurately selected and used, and LSTM can be used for long-term feature analysis and judgment, thereby significantly improving the accuracy of the forecast model.

The following is a systematic description of the embodiment of the present disclosure based on WRF and deep neural network to construct a weather prediction model and the scheme of weather prediction based on the constructed weather prediction model in combination with FIG. 51-1 to FIG. 51-2:

FIG. 51-1 is a flow chart of WRF-based deep neural network weather forecasting; FIG. 51-2 is a diagram of the LSTM calculation process.

For the Training Part:

First, collect historical data (grid data, surface information, conventional observation data) as basic data information.

Then, the data information is imported into the WPS module and the REAL module in the WRF model for preliminary data processing respectively.

Then, the initial processing data information of WRF-WPS, combined with the collected real scene information (space-time coordinates, terrain, landform, disturbance), etc. are used as the initial training set data of the neural network.

After that, the data is normalized and split into a validation set and a test set.

Import the test set into the LSTM network for training, and learn to judge the causal relationship between each parameter;

Among them, according to the output results and the gradient descent, the parameter weights are adjusted to ensure the convergence effect of the model.

Finally, the meteorological prediction model is obtained through validation set validation.

For the Applied Reasoning section.

First, the collected meteorological information: illumination, wind speed, terrain, etc. are input into the weather forecasting model as the reasoning basis; then, the weather forecasting model is used to predict the future weather conditions.

Compared with related technologies, the embodiments of the present disclosure combine WRF and deep neural network for regional climate prediction. When faced with irregular meteorological features, available features can be selected and used more accurately, and LSTM can be used for long-term feature analysis and judgment, thus significantly Improve predictive model accuracy.

### R5-8-52—Weather Forecasting Based on Deep Learning.

Among related technologies, weather forecasting technology mainly collects statistical data through satellite observation, meteorological observation stations, radar, etc Weather forecasting is done by calculating values that reflect atmospheric variables.

Traditional dynamic model prediction is severely limited by the amount of calculation when faced with a large amount of data. It can only be inferred and analyzed through short-term and timely meteorological information, and cannot infer future long-term meteorological trends through the hidden relationship of historical data. Meteorological forecasting has high requirements for timeliness, and the dynamic forecasting model is limited by the amount of calculation, so it is not very competent for long-term meteorological trend observation.

Moreover, the methods and devices in the related art are only aimed at the weather (such as icing, cold air, etc.) in a small range of targets, and have many restricted conditions and narrow application directions.

Based on the above technical problems, the embodiments of the present disclosure provide a weather forecast based on deep learning.

This embodiment considers that: the power prediction model in the related art is limited by the amount of calculation, and cannot be well qualified for long-term meteorological trend observation. Compared with the traditional dynamic model prediction, the deep learning method has unique advantages in processing big data Through the analysis of data characteristics, the hidden nonlinear relationship between a large amount of historical data can be obtained, and the weather forecast can be made more efficiently. For China Long-term meteorological trends can also be inferred. The main schemes of the embodiments of the present disclosure include:
1. Use the convolutional neural network (CNN) to extract the features in the data, and obtain the characteristics and invisible conditions of the historical meteorological information. Because of the irregularity of meteorological features, the traditional CNN model cannot perform good feature extraction on features. This part uses the concept of graph convolution kernel.
2. Use cylindrical tangent space and horizontal mapping to construct local space. (See FIG. 52-2)
3. Add conditional local convolution kernels to meet the conditions of convolution based on local conditions, similar features of adjacent parts, and sharing of adjacent convolutions when geographical features are different. (See FIG. 52-3)
4. Recalculate the weight of the convolution kernel in combination with the spatial angle and distance. (See FIG. 52-4)
5. Carry out causal judgment on data features through recurrent neural network (RNN), look for feature connections and the influence between each other to predict future features. Through LSTM, the features of the long-term memory are retained, and some unrepresented new features of unexpected situations are discarded, so as to improve the prediction model.
6. Save the model data after the training is completed, then load the model to input the historical weather data, and infer the weather forecast result (see FIG. 52-5) Among them, LSTM (Long Short-Term Memory) is a long-term short-term memory network, which is a time recurrent neural network (RNN), mainly to solve the problem of gradient disappearance and gradient explosion during long sequence training Simply put, LSTM can perform better in longer sequences than ordinary RNNs.

Exemplarily, referring to FIG. 52-1 to FIG. 52-5, a deep learning-based weather forecasting method provided by an embodiment of the present disclosure includes the following steps;

Get the current historical weather information in the most recent period;

Input the historical weather information in the most recent period into the pre-built LSTM model to predict the weather conditions in the preset time in the future.

Among them, FIG. 52-1 is a flow chart of meteorological prediction based on deep learning according to an embodiment of the present disclosure: FIG. 52-2 is a map of local space and level: FIG. 52-3 is a schematic diagram of a unified standard example, FIG. 52-4 is an adjustment angle ratio Schematic diagram; FIG. 51-2 is a schematic diagram of the LSTM calculation process. Wherein, the historical weather information includes but not limited to: wind direction, temperature, rain, humidity, sunny and so on.

After inputting the current historical weather information in the latest period into the LSTM model, the calculation is performed through the LSTM unit, including forgetting gate, input gate, and output gate for summary calculation, and finally output to the fully connected layer for dimension conversion to obtain future weather conditions.

The embodiment of the present disclosure is based on the weather prediction method based on deep learning. In the face of irregular weather features, available features can be more accurately selected and utilized. LSTM can perform long-term feature analysis and judgment, thereby significantly improving the accuracy of the forecast model.

Referring to FIG. 51-2, FIG. 52-1 to FIG. 52-4, a method for constructing a weather prediction model based on deep learning provided by an embodiment of the present disclosure includes the following steps:

Access to collected weather history data;

Constructing a training data set based on the collected meteorological historical data; performing feature extraction on the training data set to obtain feature data;

LSTM model learning and training is performed based on the feature data to obtain a trained LSTM model.

Wherein, the step of constructing a training data set based on the collected meteorological historical data includes, performing horizontal mapping construction on the collected meteorological historical data; performing standard instantiation processing on the data after horizontal mapping construction; standard instantiation. The processing is cleaned, and the cleaned instantiated data is used as the training data set.

Wherein, the step of performing feature extraction on the training data set to obtain feature data includes putting the training data set into a CNN model for feature extraction, adjusting the angle of the extracted features and calculating the weight of the convolution kernel to obtain the feature data.

Wherein, the step of performing LSTM model learning and training based on the feature data to obtain the trained LSTM model includes: inputting the features obtained by the CNN model into the LSTM model for learning, judging the causal relationship between the parameters, and obtaining Outputting the result: adjusting the parameter weight of the model training according to the output result and the gradient descent situation, so that the model converges, and obtains the trained LSTM model.

Subsequently, the current and recent historical weather information can be input into the LSTM model constructed above, and the weather conditions in the next week can be predicted through the LSTM model.

The embodiment of the present disclosure is based on the weather prediction method based on deep learning. In the face of irregular meteorological features, available features can be selected and used more accurately. LSTM can perform long-term feature analysis and judgment, thereby significantly improving the accuracy of the forecast model.

The detailed steps of the embodiment of the present disclosure are described below in conjunction with FIG. 51-2, FIG. 52-1 to FIG. 52-5 first, collect historical meteorological data, and perform horizontal mapping construction; then, perform standard instantiation processing on the collected data; The cleaned instantiated data is used as the training data set; then, the training data set is put into the CNN model for feature extraction; then, the features obtained by the CNN model are input into the LSTM model for learning, and the cause and effect between parameters are judged relationship to get the LSTM model; finally, input the current and recent historical weather information into the LSTM model to predict the weather conditions in the next week.

It should be noted that the embodiment of the present disclosure utilizes a convolutional neural network (CNN) to extract features from data, and obtain features and invisible conditions of historical weather information. Because of the irregularity of meteorological features, the traditional CNN model cannot perform good feature extraction on features. This part uses the concept of graph convolution kernel.

In addition, the embodiment of the present disclosure also uses cylindrical tangent space and horizontal mapping to construct a local space (see FIG. 52-2); at the same time, a conditional local convolution kernel is added to meet local conditions of convolution, similar features of adjacent parts, and different geographical features Conditions for sharing adjacent convolutions (see FIG. 52-3).

In addition, the embodiment of the present disclosure recalculates the weight of the convolution kernel in combination with the spatial angle and the distance (see FIG. 52-4).

At the same time, the recurrent neural network (RNN) is used to make causal judgments on data features, and to find out the relationship between features and the influence between them to predict future features. Through LSTM, the features of the long-term memory are retained, and some unrepresented new features of unexpected situations are discarded, so as to improve the prediction model.

Compared with related technologies, the embodiments of the present disclosure can more accurately select and utilize available features in the face of irregular meteorological features, and perform long-term feature analysis and judgment through LSTM, thereby significantly improving the accuracy of the prediction model; and can hide historical data. The relationship infers the long-term meteorological trend in the future, which is very competent for long-term meteorological trend observation, and meets the high timeliness requirements of meteorological prediction.

R5-9-53—Station dynamic association analysis technology based on meteorological model.

At the same time as air pollution detection, apart from pollution source information and corporate emission inventories, an important part of the reason is the interaction between weather and the environment. The current air pollution detection methods do not take into account factors such as weather.

Based on the above technical problems, an embodiment of the present disclosure provides a dynamic correlation analysis technology for a site based on a meteorological model.

The embodiment of the present disclosure proposes the scheme of combining the neural network with the WRF model, divides the administrative area into different stations according to the grid, performs grid information management, collects pollutant discharge information and grid information and inputs them into the WRF model for weather forecasting, and the output. The weather-related results serve as the training set for the neural network. Input the relevant meteorological information into the neural network model, and combine the air quality and grid information to judge the future air quality and the contribution of meteorology to the air quality. LSTM (Long Short-Term Memory) is a long-term short-term memory network, a time recurrent neural network (RNN), mainly to solve the problem of gradient disappearance and gradient explosion during long sequence training. Simply put, LSTM can perform better in longer sequences than ordinary RNNs. LSTMs already have a variety of applications in science and technology. LSTM-based systems can learn tasks such as translating languages, controlling robots, image analysis, document summarization, speech recognition image recognition, handwriting recognition, controlling chatbots, predicting diseases, click-through rates and stocks, synthesizing music, and many more.

The solution of the embodiment of the present disclosure includes a model training part and a reasoning prediction part of model application.

Exemplarily, as shown in FIG. 51-2 and FIG. 53-1, a meteorological model-based station dynamic correlation analysis method provided by an embodiment of the present disclosure includes the following steps input the collected meteorological and geographical environment-related factor data into. To the pre-built LSTM prediction model; through the prediction of the LSTM prediction model, the air quality situation and air quality impact contribution indicators are obtained. Among them, the collected meteorological and geographical environment-related factor data include but not limited to: meteorological data, grid topography, air emission information, etc. and these collected meteorological data, grid topography, air emission information, etc. are used as inference. The basic input is to the pre-built LSTM prediction model, and the future air quality and the contribution rate affected by the grid landform environment are predicted.

Among them, the LSTM prediction model is constructed based on WRF and deep neural network training. FIG. 53-1 is a schematic diagram of the site dynamic correlation analysis technology based on the meteorological model, FIG. 51-2 is a diagram of the LSTM calculation process; after inputting the meteorological data, grid topography, and air emission information into the LSTM prediction model, the LSTM unit is used to carry out Calculation, including forgetting gate, input gate, and output gate for summary calculation, and finally output to the fully connected layer for dimension conversion, inferring fully connected to predict the final air quality and the contribution rate affected by the weather and grid landform environment.

Therefore, combined with WRF and deep neural network, combined with meteorological and geographical environmental factors to accurately determine pollution sources, and provide a reliable basis for environmental governance decisions.

Further, before the step of inputting the collected meteorological and geographical environment-related factor data into the pre-built LSTM forecasting model, it also includes: constructing the LSTM forecasting model.

Exemplarily, as shown in FIG. 51-2 and FIG. 53-1, an LSTM prediction model construction method based on meteorological model-based station dynamic correlation analysis provided by an embodiment of the present disclosure includes the following steps:

Input the collected historical data into the WRF model for weather forecasting, and the output weather-related results are used as the training set of the neural network. The historical data includes: pollutant discharge information and grid information;

Neural network model training is performed based on the training set to obtain an LSTM prediction model.

Wherein, before the described step of inputting the collected historical data into the WRF model to carry out meteorological prediction, the meteorological related results of the output as the training set of the neural network also includes: collecting historical data, the historical data including: pollutant discharge list and area network formatted information.

Wherein, the step of collecting historical data includes:

Divide the administrative area into different stations according to the grid, and carry out grid information management;

Pollutant discharge information and grid information are collected as the historical data.

Wherein, the described historical data input WRF model of collecting is carried out meteorological prediction, and the step of the meteorological correlation result of output as the training set of neural network comprises:

The collected historical data is input into the WRF model for meteorological prediction, and the output weather-related results are used as the training set of the neural network. The weather conditions of the polluted emissions and the grid environment information obtained are summarized to form a corresponding relationship, which is used as the training set of the neural network. Wherein, the step of performing neural network model training based on the training set to obtain the LSTM prediction model includes dividing the training set into test set data and verification set data;

Perform LSTM model training based on the test set data to obtain a trained LSTM prediction model; verify the trained LSTM prediction model based on the verification set data to obtain a final LSTM prediction model.

Wherein, the step of performing LSTM model training based on the test set data to obtain the trained LSTM prediction model includes: inputting the LSTM model based on the test set data for training, learning and judging the causal relationship between each parameter, and obtaining the output result; According to the output result and the gradient descent situation, adjust the parameter weight of model training, so that the model converges, and obtain the trained LSTM prediction model.

Subsequently, the collected relevant meteorological information can be input into the LSTM prediction model constructed above, and the air quality and grid information can be combined to judge the future air quality and the contribution of meteorology to air quality.

FIG. 53-1 is a schematic diagram of the site dynamic correlation analysis technology based on the meteorological model; FIG. 51-2 is a diagram of the LSTM calculation process; after inputting the meteorological data, grid topography, and air emission information into the LSTM prediction model, the LSTM unit is used to carry out Calculation, including forgetting gate, input gate, and output gate for summary calculation, and finally output to the fully connected layer for dimension conversion, inferring fully connected to predict the final air quality and the contribution rate affected by the weather and grid landform environment.

The following describes the embodiment scheme of the present disclosure in detail in conjunction with FIG. 5-12 and FIG. 53-1:

First, the administrative area is divided into different stations according to the grid, and the grid information management is carried out;

Then, the collected pollutant emission information and grid information are input into the WRF model for meteorological prediction, and the output meteorological related results are used as the training set of the neural network, and the LSTM prediction model is obtained through training. After that, relevant meteorological information can be input into the LSTM prediction model, and the air quality and grid information can be combined to judge the future air quality and the contribution of meteorology to air quality.

Exemplarily, the solutions of the embodiments of the present disclosure include a model training part and an inference prediction part of model application.

Training part First, collect historical data, including; pollutant discharge inventory and regional grid information; divide the administrative area into different stations according to the grid, and conduct grid information management.

Then, input the emission inventory and grid information into the WRF weather prediction model, and obtain the corresponding meteorological data.

Then, the meteorological conditions of the obtained polluted emissions and the grid environment information are summarized to form a corresponding relationship, which is input into the LSTM model as a training set, and the meteorological data output by the above WRF weather forecasting model are summarized into the training set and input into the LSTM model for training. When training the LSTM model, the model parameter weights are adjusted according to information such as gradient and output, and the final LSTM prediction model is obtained through model verification.

Inference part. First, input meteorological data, grid topography, air emission information, etc. into the LSTM prediction model; then, reasoning is fully connected to predict the final air quality situation and the contribution rate affected by the grid topography environment. Compared with related technologies, the embodiments of the present disclosure combine WRF and deep neural network, and combine meteorological and geographical environment factors to accurately determine pollution sources, and provide reliable basis for environmental governance decision-making. With the neural network combined with the WRF model, the administrative area is divided into different stations according to the grid, and the grid information management is carried out. The pollutant discharge information and grid information are input into the WRF model for weather forecasting, and the output weather-related results are used as neural networks. The training set for the network. Input the relevant meteorological information into the neural network model, and combine the air quality and grid information to judge the future air quality and the contribution of meteorology to the air quality.

### R5-11-54—Networked Emission Source Inventory Processing Technology.

With the rapid development of the economy, the judgment of air pollution sources and the detection of air quality have emerged as the times require. In this context, model air quality forecasts and analytical models of sources of air pollutants require the data of emission source inventories as a support. Therefore, it is very important to have the networked emission source inventory processing technology. Without the grid emission source inventory processing technology, it is impossible to carry out model air quality forecasting and air pollution source analysis model work.

Based on the above technical problems, embodiments of the present disclosure provide a networked emission source inventory processing technology.

The embodiment of the present disclosure collects and analyzes pollution source data in the early stage, performs parameter correction and screening according to emission factors, removes unimportant information and information with low impression factors, calculates and statistics the initial situation of total emissions in the current area, and constructs a time-space distribution information map providing technical support for the development of model air quality forecasting and air pollutant source analysis models.

Exemplarily, as shown in FIG. 54-1, an embodiment of the present disclosure provides a networked emission source inventory processing technology, the steps of which include:
Step 1: Collect original information on local emission sources;
Step 2: Visit and collect real-time data;
Step 3: Carry out parameter correction and screening based on emission factors, and remove unimportant information and information with low impression factors;
Step 4: Calculate the initial situation of total emissions in the current area,
Step 5: Construct a spatio-temporal distribution information map according to the initial situation;
Step 6. The step of constructing the spatio-temporal distribution information map according to the initial situation includes:

According to the air pollution situation obtained by the air quality model (CMAQ), the feedback is rendered into the corresponding time-space distribution information map.

Wherein, the original information includes: pollution source information and category information of emission sources.

Wherein, the real-time data include: time-space distribution and enterprise on-site survey data. Wherein, the spatiotemporal distribution includes geographic information coordinates, surrounding terrain information, and the like.

Among them, the enterprise on-site investigation includes: preliminary understanding and collection of enterprise emissions, main emission sources, emission volume, etc.

The embodiment scheme of the present disclosure will be described in detail below in conjunction with FIG. 54-1.

The embodiment of the present disclosure collects and analyzes pollution source data in the early stage, performs parameter correction and screening according to emission factors, removes unimportant information and information with low impression factors, calculates and statistics the initial situation of total emissions in the current area, and constructs a time-space distribution information map provide data reference for pollutant emissions in various regions, and provide technical support for the country's “causes of heavy air pollution and prevention and control of public relations”.

Exemplarily. Step 1: first collect original information of local emission sources, the original information includes pollution source information and emission source category information.

Step 2: visit and collect real-time data, wherein the real-time data includes time-space distribution and enterprise site survey data. Exemplarily, the time-space distribution includes geographical information coordinates and surrounding terrain information, etc. and the enterprise site survey includes Understand the preliminary enterprise emission situation and collect the main emission sources and emission amounts.

Step 3: Carry out parameter correction and screening based on emission factors, and remove unimportant information and information with low impression factors.

Step 4: Calculate and count the initial situation of the total emissions in the current area.

Step 5· Construct a spatio-temporal distribution information map according to the initial situation.

Step 6: The step of constructing the spatio-temporal distribution information map according to the initial situation includes:

According to the air pollution situation obtained by the air quality model (CMAQ), the feedback is rendered into the corresponding time-space distribution information map.

In the embodiment, the pollution source data are collected and analyzed in the early stage, and then the emission source identification and source classification are carried out. Through the on-site collection of pollution data, the list of emission source pollutants is calculated according to the emission factors and calculation parameters. Total amount, build a high-temporal-spatial resolution inventory, output the pollutant characteristic results according to the spatio-temporal resolution inventory, use the original emission inventory compilation program to obtain the temporal and spatial distribution information of national pollutant emissions, and add a gridded emission inventory plug-in tool, interpolate from the low-resolution networked emission inventory to generate high-resolution gridded emission files as needed, cooperate with weather forecasting model (WRF), air quality model (CMAQ, CMB, WRF-Chem) and other data docking to identify pollutants Time contribution source categories; combined with spatio-temporal distribution information to locate and project into the grid information.

Among them, the network emission source inventory processing technology of the embodiment of the present disclosure can be applied to the forest fire protection industry, and can collect relevant pollution source data as much as possible, and play a role in predicting the overall situation in the forest.

Compared with related technologies, the embodiments of the present disclosure collect and analyze pollution source data in the early stage, perform parameter correction and screening according to emission factors, remove unimportant information and information with low impression factors, and calculate and count the initial situation of total emissions in the current area. Construct spatio-temporal distribution infographics. The emission source data provide technical support for the development of model air quality forecasting and atmospheric pollutant source analysis models; provide data reference for pollutant emissions in various regions.

### R5-12-55—Air Quality Forecast Model Based on Deep Learning.

Currently the most widely used are the third-generation comprehensive air quality models, such as: NAQPMS, CAMx, WRF-CHEM and CMAQ. The shortcomings of the third-generation comprehensive air quality models (such as: NAQPMS, CAMx, WRF-CHEM, and CMAQ, etc.) are. (1) The requirements for basic data such as meteorology and pollution sources are too harsh. In particular, the requirements for pollutant discharge in the emission inventory are specific to each chemical species, each grid and hourly. Due to the complexity of the emission inventory, the compilation of the emission inventory has become a new research field; (2) The functions are flexible and diverse, but the operability is reduced. In order to increase the flexibility of model development and application, the third-generation model has no visual operation interface, and adopts a modular integrated design method. Users must be familiar with the model structure, basic physical and chemical principles, and model program codes, (3) Professional computer knowledge. The requirements have been greatly increased. The third-generation air quality model has a huge amount of calculation, and mostly runs on a high-performance cluster computer platform based on the LINUX operating system, which requires high hardware resources and specialized personnel to be responsible for the daily management and maintenance of the platform; (4) massive input and output data need to be analyzed and visualization. The input and output data of the third-generation air quality model range from hundreds of gigabytes to thousands of gigabytes. The management, analysis and visualization of massive data greatly increases the cost of work.

Compared with the previous two generations of methods, although great progress has been made, the model is becoming more and more complex, and due to inconsistent standards, the generalization ability is poor. The contradiction between the “scientificity” and “ease of use” of the third-generation air quality model is very prominent, which has seriously affected its promotion and application. This has also become a difficulty in establishing a new generation of regulatory air quality models. The diversity of emissions inventories makes the simulation results incomparable. Based on the deep learning method to study the data set of the air quality forecast model research is mostly limited to the point data of a single or multiple cities, the amount of data is small, and the advantages of big data that the deep learning method relies on are not fully utilized. Deep learning based on massive data training Air quality prediction models are rather scarce.

Based on the above technical problems, the embodiments of the present disclosure provide an air quality forecasting model based on deep learning.

The embodiments of the present disclosure give full play to the feature extraction capability of the deep learning network, and can be used for emergency calculations through model optimization calculations that take seconds to ensure real-time calculation. After the training is completed, the model deployed to the server does not have high requirements for the input data, requires a small amount of data, and can intelligently handle the lack of input data and abnormal input data; supports online learning, and the model can continuously learn new data experience.

Exemplarily, as shown in FIG. 55-1-FIG. 55-2, an air quality forecasting model based on deep learning provided by Embodiment I of the present disclosure, the overall process steps of the system include:

Step 1. Obtain national historical air quality data;

Step 2, cleaning the data through a certain algorithm;

Step 3: After the data is cleaned, the preprocessing of the data is completed, and then the data is put into the transformer model, and the training starts. After reaching a certain number of rounds and meeting the precision, the model is obtained.

Wherein, the step of cleaning the data through a certain algorithm includes: Site data missing value processing and calibration of outliers.

Wherein, the step of described station data missing value processing comprises:

Deletion is performed by judging the missing rate or generated by CMAQ.

Wherein, the step of described calibration outlier comprises:

Use 3sigma (three sigma criterion) to calibrate outliers.

The following describes the embodiment of the present disclosure in detail in conjunction with FIG. 55-1-FIG. 55-2:

The embodiment of the present disclosure trains the model based on deep learning based on the transformer network structure. After the training is completed, the model deployed to the server does not have high requirements for the input data, requires a small amount of data, and can handle missing and abnormal input data. Perform intelligent processing; support online learning, and the model can continuously learn new data experience.

Exemplarily, as shown in FIG. 55-1, the air quality forecast model based on deep learning provided by the embodiment of the present disclosure, the steps of the overall system process include:

Step 1: Obtain historical air quality data.

Exemplarily, the historical air quality data can be obtained through any public channels or historical records.

Step 2: cleaning the data through a certain algorithm;

Step 3: After the data is cleaned, the preprocessing of the data is completed, and then the data is put into the transformer model, and the training starts. After reaching a certain number of rounds and meeting the precision, the model is obtained.

Wherein, the step of cleaning the data through a certain algorithm includes:

Site data missing value processing and calibration of outliers. The step of processing the missing value of the station data includes: deleting by judging the missing value or generating by using CMAQ.

Wherein, the step of marking outliers includes: using 36 criterion to mark outliers.

Among them, the 30 criterion is also known as the Raida criterion. It first assumes that a set of test data contains only random errors, calculates and processes it to obtain the standard deviation, and determines an interval according to a certain probability. It is believed that any error exceeding this interval is equal to. It is not a random error but a gross error, and the data containing this error should be eliminated. And 30 is applicable when there are many sets of data.

In an embodiment, construct the network structure of the transformer model, train the model to obtain a neural network model that meets the requirements, then perform data preprocessing, construct the network structure of the transformer, train the model to obtain a neural network model that meets the requirements, and finally generate the stage using: input Based on recent historical air quality monitoring data, the model can infer future air quality forecast data.

Among them, as shown in FIG. 55-2, the transformer model, generally speaking, the encoder part of the transformer, is composed of a multi-head attention mechanism and a feedforward neural network. Self-attention mechanism: Let the input represent the input. The self-attention mechanism linearly transforms the input through three matrices, and then obtains a weight matrix. After normalizing the weight matrix, the value is weighted and averaged and output.

$$Q = {HW}_{Q} ,$$

$$K = {HW}_{K} ,$$

$$V = {HW}_{V}$$

$$A = \frac{{QK}^{T}}{\sqrt{{d}_{K}}} ,$$

$$Attn ( H ) = soft max ( A ) V$$

Feedforward neural network, in simple terms, is a linear layer, usually with layer normalization (LN) and shortcut operations:

$$FFN ( H ) = LN ( H ) {W}_{F} + b + H$$

Compared with related technologies, the air quality prediction model based on deep learning provided by the embodiments of the present disclosure can obtain a well-trained air quality prediction model, which is simple and convenient to deploy and saves computing resources. Compared with the traditional CMAQ model, it can be applied to emergency response calculate. Realize the hourly weather forecast for the future time, including SO₂, NO₂, CO, O₃ 1H, O₃ 8H, PM2.5, PM10 and other parameters. Moreover, the multi-head attention (multi-head attention mechanism) can learn the correlation between parameters, abandoning the traditional CNN and RNN. The entire structure is completely composed of the Attention mechanism.

### R5-13-56—Air Quality Forecasting Method Based on CMAQ and Deep Neural Network Time Series Model.

At present, the air quality forecast is mainly evaluated by the traditional Community Multiscale Air Quality (CMAQ) model system. The accuracy of the air quality forecast is low, the air quality forecast time span is short, and the air quality forecast is overly dependent on the emission inventory technology, which is overly dependent on the emission inventory technology. Manpower and air quality forecasting cannot provide intelligent feedback to the emission inventory technology, so related technologies still need to be improved and improved.

Based on the above technical problems, an embodiment of the present disclosure provides an air quality forecasting method based on CMAQ and a deep neural network time series model. The embodiments of the present disclosure rely on the CMAQ air quality forecast model to realize air quality forecast; rely on the sensitivity analysis of forecast data and site detection data, and connect the automatic adjustment strategy of the emission inventory technology to improve the accuracy of air quality forecast; rely on the deep neural network time series model to achieve Long-term air quality forecasts.

Exemplarily, as shown in FIG. 56-2, the embodiment of the present disclosure provides an air quality forecast method based on CMAQ and deep neural network time series model, the method includes the following steps:

Obtain emissions data and weather data;

Input the WFR-chem model to obtain the first air quality data;

Input the emission inventory into the CMAQ model to obtain the second air quality data; The first air quality data and the second air quality data are summed and input into the time series model of the neural network to obtain preliminary prediction data.

Wherein, after the step of inputting the first air quality data and the second air quality data into the time-series model of the neural network to obtain the preliminary forecast data, it also includes: According to the data obtained from the monitoring points, the model is corrected, and finally the air quality data is obtained.

Wherein, after the step of inputting the emission inventory into the CMAQ model to obtain the second air quality data, it also includes:

The emissions inventory is corrected based on the second air quality data.

The embodiment of the present disclosure will be described in detail below in conjunction with FIG. 56-1:

As shown in FIG. 56-1, the embodiment scheme of the present disclosure illustrates the WFR-chem processing flow.

Exemplarily, in the step of obtaining emission data and meteorological data.

Meteorological data, pre-processed by WPS. WPS (WRF Preprocessing System) is a preprocessing process that provides input for real data simulation and obtains meteorological data; The step of obtaining the first air quality data by inputting the WFR-chem model exemplary includes:

The meteorological data obtained by the emission are combined with the chemical field and the meteorological field, and this data is used as the input data of WRF-chem to output the model; Obtain the first air quality data.

As shown in FIG. 56-2, the overall flow processing:

Obtain emissions data and weather data;

Meteorological data, pre-processed by WPS. WPS (WRF Preprocessing System) is a preprocessing process that provides input for real data simulation and obtains meteorological data; The meteorological data obtained by the emission are combined with the chemical field and the meteorological field, and this data is used as the input data of WRF-chem to output the model; Obtain the first air quality data;

Input the emission inventory into the CMAQ model to obtain the second air quality data;

The first air quality data and the second air quality data are summed and input into the time series model of the neural network to obtain preliminary prediction data.

According to the data obtained by the monitoring points, the model is corrected, and finally the air quality data is obtained;

Based on the second air quality data, the emission inventory is corrected;

Compared with related technologies, the embodiments of the present disclosure rely on the CMAQ air quality forecast model to realize air quality forecast; rely on the sensitivity analysis of forecast data and site detection data, and connect the automatic adjustment strategy of emission inventory technology to improve the accuracy of air quality forecast.

Embodiments of the present disclosure rely on deep neural network time series models to realize long-term air quality forecasts.

The embodiment of the present disclosure realizes the air quality forecast of a longer time period based on the deep neural network time series model, which can realize the air quality forecast of the next month, and prolongs the forecast time of the standard model.

The embodiment of the present disclosure introduces localized historical data to correct the model prediction results and improves the accuracy of model prediction. The local air pollution emission inventory self-adaptive adjustment algorithm is introduced, which can be integrated and optimized with the CMAQ air quality forecast model data and air quality site monitoring data, autonomously. Optimize the emission inventory data and improve the accuracy of air quality prediction.

### R5-14-57—a Pollutant Transport Analysis Algorithm Based on HYSPLIT Model.

The transport trajectory of pollutants can visually show the transport path of pollutants. Simulating the transmission trajectory of pollutants and clustering the simulated pollutant transmission trajectories are of great significance to the analysis of the causes of air pollution and pollution prevention and control.

At present, in the related technology, the pollutant data and meteorological data of the target area are usually obtained by the user, and according to the obtained pollutant data and meteorological data, through HYSPLIT (Hybrid Single Particle Lagrangian Integrated Trajectory Model, Lagrangian mixed single particle trajectory model) The transmission trajectory of pollutants is simulated, and then the user operates specific weather mapping software to cluster the simulated pollutant transmission trajectories. However, this related technology requires manual operation and processing by the user, which is very inefficient and prone to errors.

Based on the above technical problems, an embodiment of the present disclosure provides a pollutant transmission analysis algorithm based on the HYSPLIT model. Based on the HYSPLIT model, the trajectory is observed and analyzed from a long time span (year or month), combined with satellite images and air quality station monitoring data and spatial trajectory three-dimensional surface density analysis technology to analyze the transmission characteristics of pollutants Exemplarily, as shown in FIG. 57-1, a pollutant transmission analysis algorithm based on the HYSPLIT model, the method includes the following steps: Obtain GDAS data and GFS data;

Calculate the atmospheric transport trajectory of space-time points through the HYSPLIT model; Through the air quality site monitoring data and the CMAQ air quality forecast model, the spatial and temporal distribution of regional pollutants is obtained;

Through the DBSCAN density clustering algorithm and the spatial trajectory three-dimensional area density analysis technology, the trajectory analysis and composition analysis of pollutant transmission are proposed.

GDAS: The Global Data Assimilation Forecast System (GDAS) is the system used by the National Center for Environmental Prediction (NCEP) Global Forecast System (GFS) model to place observations into gridded model space in order to start or initialize weather with observations forecast. GDAS adds the following types of observational data to a gridded 3D model space:

surface observations, balloon data, wind profiler data, aircraft reports, buoy observations, radar observations, and satellite observations.

GDAS is meteorological archiving data, its naming rule is gdas1.mmmyy,w#, where mmm is the month (for example jul), yy is the year (05), #Reference: #=1—the 1st-7th day #=2-Days 8-14 #=3-Days 15-21 #=4-Days 22-28 #=5-Day 29—the rest of the month. Post every 6 hours (0:00, 6:00, 12:00, 18:00 every day). Inside are multiple lines of meteorological data containing latitude and longitude information and time information, including pressure, wind speed, temperature, relative humidity, and whether there is snow, ice, or freezing rain.

GFS data, the GFS (Global Forecast System) of the National Environmental Forecasting Center, which releases meteorological data on a global scale 4 times a day. The data for each release is saved in a folder named gfs. YYYYMMDDHH. The accuracy of the data required this time is 0.25° (Op25), so the file name of the data is: gfs.t {HH}z.pgrb2.0p25.f {XXX} where HH indicates the release time, and XXX indicates the forecast for the next few hours data. For example, gfs.100z.pgrb2.0p25.f001 indicates the weather data information released at 0 o'clock in the next hour. The data are similar to the GDAS data.

CMAQ: type is the third-generation air quality model system, mainly used for the formulation and compilation of relevant policies such as environmental planning, environmental protection standards, environmental impact assessment, environmental monitoring and forecasting and early warning, environmental quality change trends, total volume control, and pollutant discharge permits, and then get the forecast results for a specific time point or time period.

Exemplarily, firstly, based on the GDAS data and GFS data, the HYSPLIT model can calculate the atmospheric transmission trajectory of the space-time point. Then, using the air quality site monitoring data and the CMAQ air quality forecast model, the temporal and spatial distribution of pollutants in the region can be obtained Finally, using the DBSCAN density clustering algorithm and the three-dimensional surface density analysis technology of the spatial trajectory, the trajectory analysis and composition analysis of the pollutant transmission can be proposed.

According to the GDAS data and GFS data, the HYSPLIT model can calculate the atmospheric transmission trajectory of the time-space point in the embodiments of the present disclosure. Using the air quality site monitoring data and the CMAQ air quality forecast model, the spatial and temporal distribution of regional pollutants can be obtained. Finally, using the DBSCAN density clustering algorithm and the three-dimensional surface density analysis technology of the spatial trajectory, the trajectory analysis and composition of the pollutant transmission can be proposed. The embodiments of the present disclosure guide the composition of local pollutant sources and guide the emergency management of pollutant discharge by giving the transmission trajectory and characteristics of pollutants.

Compared with the related technologies, the embodiments of the present disclosure are based on the HYSPLIT model, observe and analyze the trajectory from a long time span (year or month), combine the satellite image and air quality site monitoring data and the three-dimensional surface density analysis technology of the space trajectory, and analyze the pollutants. Transmission characteristics: Based on the HYSPLIT model, combined with the three-dimensional area density analysis technology of the spatial trajectory, the DBSCAN density clustering algorithm and the CMAQ air quality forecasting model, the future transmission trajectory and transmission of various pollutants can be predicted. The embodiments of the present disclosure can effectively analyze the transmission trajectory and characteristics of pollutants; explain and guide the source composition of local pollutants; analyze the transmission of pollutants and guide emergency measures for pollutants.

### R5-15-58—a Fusion-Based Approach to Atmospheric Pollutant Source Analysis.

In human production and life, some substances are caused to enter the atmosphere, and when there is a sufficient concentration, air pollution is formed. It is harmful to human health, and also has great damage to the ecological environment. In recent years, controlling air pollution and protecting the ecological environment has become an important research direction.

In the process of air pollution control, the source analysis of pollutants is an important part of air pollution control. The detection methods in the related art all have the following problems; Acquisition and analysis of atmospheric monitoring parameters at target points, the data set is single, the model application scenarios are focused, and the versatility is poor.

The process of data acquisition and analysis is simple, there is no data correction process, and the final training of the adjusted model has low reliability.

Based on the above technical problems, the embodiment of the present disclosure provides a fusion method-based air pollutant source analysis method, which can realize hourly pollutant source analysis for future time, including SO₂, NO₂, CO, O₃, PM2. 5. The source analysis of parameters such as PM10, and compared with the direct application of CMB and other linear regression models for source analysis, on this basis, the secondary judgment of the neural network is added, combined with the detection to obtain a more accurate source analysis of air pollutants. Exemplarily, as shown in FIGS. 58-1 to 58-2, an embodiment of the present disclosure provides a method for analyzing the source of air pollutants based on a fusion method, and the method includes the following steps:

Obtain the emission inventory of point sources and non-point sources of pollutants and the final total emission statistics;

Use the CMB linear regression model to analyze the composition of various particulate matter emissions;

Use the information categories and parameters of CMB and list acquisition and classification as the training set, and put them into the neural network for training;

get the analytical model:

Analyze the source of the corresponding air pollutants through the analytical model. Exemplarily, the embodiments of the present disclosure use the fusion method to analyze air pollution sources, as shown in FIG. 58-3 to FIG. 58-4, use the pollutant discharge inventory method to obtain the preliminary point source and non-point source emission inventory, and the final emission. The total amount statistics are used: CMB linear regression model is used to analyze the composition of various particulate matter emissions. Judging the type of information marked for each type of object; using the information type and parameters of CMB and list acquisition and classification as the training set, and putting it into the neural network for training. The final neural network model is used as the criterion for judging the source analysis of air pollutants.

### The CMB Model is Based on:

There are significant differences in the chemical composition of particulate matter emitted from various sources;

The chemical composition of particulate matter emitted by various sources is relatively stable. There is no interaction dependence between various types of emissions; All pollutant component spectra are linearly independent;

The type of pollution source is lower than or equal to the classification of chemical composition; The measurement uncertainty is random and follows a normal distribution. Then the total substance concentration C measured on the receptor is the linear sum of each type of contribution concentration value (the formula is as follows):

$$C = {\sum }_{j = 1}^{J} {S}_{j}$$

where C: the total mass concentration of the recipient atmospheric particulate matter.

Sⱼ: Contribution mass concentration of each source class.

J: the number of source classes, j=1,2,3, . . . j.

If the concentration of chemical component i on the acceptor particle is C₁, then the formula is:

$$\text{?} = \text{?} \cdot {S}_{j}$$

$$\text{?} \text{indicates text missing or illegible when filed}$$

Note: When I>=j, the equation system has a solution, where C: the measured concentration of chemical component i in the recipient atmospheric particulate matter;

Fᵢⱼ: the measured value of the chemical component i in the particulate matter of the j type source; Sⱼ: the jth; the calculated value of the concentration contributed by the like source;

I: the number of chemical components, i=1,2,3 . . . i;

In the neural network model, each neuron is an over-regression model. After receiving the input from the upper layer, it classifies and processes the data, and then forwards the result to the output layer, finally completing the classification orientation.

Compared with related technologies, it can realize hourly pollutant source analysis for future time, including source analysis of parameters such as SO₂, NO₂, CO, O₃ PM2.5, PM10, and compared with direct application of CMB, etc. The linear regression model is used for source analysis, and on this basis, the secondary judgment of the neural network is added, combined with the detection to obtain a more accurate source analysis of air pollutants.

### R5-16-59—a Quantitative Analysis Method of Industry Contribution Based on Deep Learning.

Air pollution, also known as air pollution, according to the definition of the International.

Organization for Standardization (ISO), air pollution usually refers to certain substances entering the atmosphere due to human activities or natural processes, presenting sufficient concentrations, reaching sufficient time, and Phenomena that are thus jeopardizing the comfort, health and welfare of humans or the environment.

In the process of air pollution prevention and control, the relevant departments need to know the contribution rate of each unit to the air quality pollution in the current control area, and simulate the situation that when a certain unit or industry is rectified or eliminated, the Improvement effect of air quality.

Relevant technologies do not have an emission inventory corresponding to the unit grid information statistics target, and can only analyze the pollution source information in the air, and there is no relevant means to simulate and analyze the effects of various control measures.

Based on the above technical problems, the embodiments of the present disclosure provide a method for quantitatively analyzing industry contributions based on deep learning. The emission inventory with the corresponding unit grid information statistics target can not only analyze the pollution source information in the air, but also analyze the causal relationship with the emission point, and also use related means to simulate and analyze the effects of various control measures. Exemplarily, as shown in FIG. 51-2 and FIG. 59-1, the embodiment of the present disclosure provides a method for quantitative analysis of industry contribution based on deep learning, the method includes the following steps.

Obtain the pollutant discharge inventory and corresponding industry emission reduction measures; Input the pollutant discharge inventory and corresponding industry emission reduction measures into the CMAQ air quality prediction model to obtain the corresponding air quality conditions; Summarize the air quality situation and the industry's emission reduction measures to form a corresponding relationship, and input it into the LSTM model as a training set;

derive a predictive model;

Input the industrial emission reduction measures and local grid coordinate information into the prediction model to obtain the impact weight of the measure on the environment.

Wherein, after the step of summarizing the air quality situation and the industry emission reduction measures to form a corresponding relationship, and inputting the LSTM model as a training set, before the step of obtaining the prediction model, it also includes:

Adjust model parameter weights based on gradient and output information.

Further, the step of deriving the prediction model exemplarily includes: Validation leads to the final predictive model.

This embodiment includes a model training part and a model reasoning part, wherein the training part includes collecting historical data: pollutant discharge inventory and corresponding industry emission reduction measures; input emission inventory and emission reduction measures into the CMAQ air quality prediction model, and obtain the corresponding. The air quality situation; the obtained air quality situation and emission reduction measures are summarized to form a corresponding relationship, which is input into the LSTM model as a training set; the model parameter weights are adjusted according to information such as gradient and output; the final prediction model is obtained through verification. The reasoning part includes: inputting industry measures and local grid coordinate information into the deep learning model; according to the grid information and emission reduction measures, the impact weight of the measure on the environment is obtained.

Compared with related technologies, the embodiment of the present disclosure collects the pollutant discharge lists of each unit and the environmental factors of related places to establish preliminary grid information; obtains air quality-related information through the pollutant discharge lists through CMAQ air quality forecast; Measures and air quality information are imported into the deep neural network (LSTM) for training, and combined with deep learning methods for air quality assessment. The embodiment of the present disclosure has an emission list corresponding to the unit grid information statistical target, which can not only analyze the pollution source information in the air, but also analyze the causal relationship with the emission point, and also simulate and analyze the effects of various control measures by related means. The embodiments of the present disclosure can accurately simulate the effect in the early stage of the implementation of industry measures, and select the optimal plan, which is conducive to locking key pollution contribution units and clarifying the source of pollution.

### R5-17-60—a Rapid Assessment Method for Heavy Air Pollution Emergency Based on Deep Learning.

At present, air pollution is very serious, mainly characterized by soot pollution. The concentration of total suspended particulate matter in the urban atmospheric environment generally exceeded the standard; sulfur dioxide pollution remained at a relatively high level; total vehicle exhaust pollutant emissions increased rapidly; nitrogen oxide pollution showed an aggravating trend. Heavy air pollution will seriously threaten the normal ecological environment. In response to heavy air pollution, decision-making departments not only need to obtain information on pollution sources in a short period of time, but also need to formulate relevant control measures to improve air quality. There is an urgent need for a technology that can discover air pollution conditions and pollution sources, and can evaluate the effects of corresponding emission reduction measures and pollution conditions.

Based on the above technical problems, the embodiments of the present disclosure provide a method for rapid assessment of heavy air pollution emergency based on deep learning.

The embodiments of the present disclosure can not only discover air pollution conditions and pollution sources, but also perform effect evaluations based on corresponding emission reduction measures and pollution conditions.

Exemplarily, as shown in FIG. 60-1, the embodiment of the present disclosure provides a deep learning-based rapid assessment method for heavy air pollution emergency, the method includes the following steps.

Import emission reduction measures and pollutant discharge inventory based on WRF model; Obtain the corresponding air quality information through the CMAQ air quality forecast model;

Establish a data set in correspondence with the emission measures and pollutant discharge inventory and the air quality information obtained through CMAQ, as a deep learning model training set; Normalize the training set data:

Adjust the training parameters according to the output and gradient descent during training until the model converges to obtain a usable model;

Collect air quality output and pollutant discharge inventory as training data for the neural network model;

output model;

Input parameters to the model, and the model exports evaluation results.

Further, before the step of normalizing the training set data, the corresponding relationship between the emission measures and pollutant discharge inventory and the air quality information obtained by CMAQ is established as a data set as a deep learning model training set After the steps, also include:

Part of the training set is divided into a test set and a validation set.

Further, before the step of adjusting the training parameters according to the output during training and gradient descent until the model converges to obtain an available model, after the step of normalizing the training set data, it also includes.

Invest in the neural network model for parameter correction;

Wherein, the step of the output model exemplary includes:

Through the verification set and test set evaluation, the model accuracy information is obtained, and the model is output.

Exemplarily, information such as model accuracy is obtained through verification set and test set evaluation, and the model is output.

After obtaining the corresponding model, the input parameters are to the model, and the model derives the evaluation results, exemplary: input pollution reduction measures, pollution sources, etc. to the deep learning model; the model performs inference according to the corresponding parameters, and elicits its corresponding causal relationship; Export the evaluation results and predict the improvement of the current air pollution after the implementation of the measure. In the embodiment of the present disclosure, the original data provides the prediction data set for the CMAQ model to obtain preliminary air quality information; the original data and the air quality information obtained by CMAQ are correspondingly established as the training set of the deep learning model; the emission reduction measures are input into the training A good deep learning model for effect evaluation.

Compared with related technologies, the embodiments of the present disclosure can quickly evaluate the air quality improvement effect of implementing the emission reduction plan with few computing resources, and can provide technical support for emergency decision-making. Not only can the air pollution situation and pollution source be found, but also the effect evaluation can be carried out according to the corresponding emission reduction measures and pollution situation.

### R5-18-61—an Algorithm for Traceability and Spread Prediction of Pollutants in Environmentally Friendly Rivers.

River water pollution will cause serious harm to the natural environment.

Nowadays, river water pollution incidents often occur, and the response speed of the traceability technology in related technologies is slow, which can easily cause secondary diffusion due to untimely treatment; and the traceability results are low in accuracy. It is impossible to provide reliable theoretical support for pollutant prevention and control.

Based on the above technical problems, the embodiment of the present disclosure provides an environmental protection river pollutant traceability and spread prediction algorithm, which makes full use of the monitoring data of the river section, and integrates the big data according to the river flow direction, sewage outlets along the river, important pollution source information, hydrological flow rate, etc. Consider using deep learning algorithms to continuously optimize coefficients and predict spreading paths.

Exemplarily, as shown in FIG. 51-2 and FIG. 61-1, the embodiment of the present disclosure provides an algorithm for traceability and spread prediction of pollutants in environmentally friendly rivers, including the following steps:

A pollutant traceability and spread prediction algorithm, comprising the following steps:

Obtaining historical data including information within pollutant discharge inventories and regional gridding;

Correspond the emission inventory with the grid information, mark its historical pollution situation, and use it as a deep learning model training set;

After cleaning and normalizing the marked training set data, put it into the LSTM model for training:

Adjust model parameter weights according to information such as gradient and output, to derive the final predictive model.

Wherein, after the labeled training set data is cleaned and normalized, put into the LSTM model, and before the step of training, the emission inventory and the grid information are correspondingly marked, and the historical pollution situation is marked as a deep learning model training After the set of steps, including:

Split the dataset into test and validation sets.

Wherein, after the labeled training set data is cleaned and normalized, it is put into the LSTM model, and the steps of training include:

Obtain the direction of the river in the grid information, whether it is a flood season, the maximum flow rate, nearby sewage outlets, etc. and input the LSTM prediction model into the current grid pollution situation;

After cleaning and normalizing the marked training set data, put it into the LSTM model for training:

Finally, the embodiment of the present disclosure can obtain the pollution diffusion trend and pollution source information in the current grid.

The Long Short Term Memory (LSTM) model is essentially a specific form of Recurrent Neural Network (RNN). The LSTM model solves the short-term memory problem of RNN by adding gates on the basis of the RNN model, so that the recurrent neural network can really effectively use long-distance timing information. LSTM adds three logical control units, namely Input Gate, Output Gate, and Forget Gate, to the basic structure of RNN, and each of them is connected to a multiplication element. By setting the neural network. The weights at the edges where the memory unit connects to other parts control the input and output of information flow and the state of the cell unit (Memory cell) The key to LSTM is the cell state, which is the horizontal line running from left to right above the LSTM unit in the figure. It is like a conveyor belt, passing information from the previous unit to the next unit, and there are only a few other parts, linear interaction LSTM controls discarding or adding information through “gates”, so as to realize the function of forgetting or remembering. A “gate” is a structure that selectively passes information, consisting of a sigmoid function and a dot product operation. The output value of the sigmoid function is in the [0,1] interval, 0 means completely discarded, and 1 means completely passed. An ISTM unit has three such gates, namely the forget gate, the input gate, and the output gate.

The embodiment of the present disclosure first collects historical data: the pollutant discharge list and the information in the regional grid; then the discharge list corresponds to the grid information, and the historical pollution situation is marked as a deep learning model training set; and then the data set is divided. The test set and verification set are saved for subsequent model accuracy verification; then the marked training set data is cleaned and normalized, and put into the LSTM model for training; the model parameter weight is adjusted according to the gradient and output information; the final verification is the final prediction model.

The reasoning part of the embodiment of the present disclosure involves obtaining the direction of the river in the grid information, whether it is a flood season, the maximum flow rate, nearby sewage outlets, etc. combined with the pollution situation of the current grid, and inputting the LSTM prediction model; and then deducing the current grid. Pollution spread trends and pollution source information.

Compared with related technologies, the embodiments of the present disclosure make full use of the monitoring data of river sections, comprehensively consider big data such as river flow direction, sewage outlets along the river, important pollution source information, hydrological flow rate, etc. and use deep learning algorithms to continuously optimize coefficients. Predict the spread path; and trace the source of pollution through historical data along the line. Compared with the traditional mechanism model, the deep learning model of the embodiment of the present disclosure has a greatly improved operating speed, which is convenient for timely discovery and control of pollution; and the use of the deep learning model greatly improves the accuracy of the system, and has the learning ability. With the continuous supply of historical data, pollution will become more sensitive and accurate.

### R5-19-62—a Hyperspectral Inversion Algorithm for Moisture Content of Vegetation Canopy Fuel.

Vegetation is an important part of the terrestrial ecosystem, and the water content in the vegetation canopy is 40%-80%. Vegetation water content (VWC) is an important indicator of vegetation drought stress. Common vegetation water content indicators include canopy water content (CWC), leaf equivalent water thickness (EWT). Live fuel moisture content (LFMC) and relative water content (RWC). Plant water is the main factor affecting photosynthesis and biomass of green plants, and many key biogeochemical cycle processes, including photosynthesis, evapotranspiration and net primary productivity, are directly and closely related to it. Plant water plays an important role in vegetation function, water exchange and energy transfer between vegetation and the atmosphere, drought and fire risk assessment, and its in-depth research is important for accurate monitoring and diagnosis of vegetation environmental stress, potential occurrence of natural fire, and effective acquisition of soil moisture, have important research significance. Remote sensing technology is an important research method for fast, non-destructive and multi-scale detection of vegetation biophysical and biochemical characteristics. In recent years, compared with the traditional wideband remote sensing, hyperspectral remote sensing technology has greatly improved the spectral resolution, can record the reflectance values of each band in detail, and effectively improved the retrieval accuracy of vegetation water content remote sensing. It is widely used in crop drought, forest and grassland. Fire, land cover change, and crop yield monitoring.

Vegetation water content is an important indicator of vegetation growth status, and is an important parameter in agricultural, ecological and hydrological research. Its diagnosis is of great significance for monitoring the drought status of natural vegetation communities and forecasting forest fires. Many scholars have applied remote sensing technology to monitor vegetation water content, but there is no research on monitoring vegetation canopy based on hyperspectral technology. Moreover, the traditional estimation of the moisture content of combustibles in the region is based on a large amount of artificially measured data. Although this method has high accuracy, it is very inefficient, consumes a lot of manpower and material resources, and causes certain damage to the regional ecology.

Based on the above technical problems, an embodiment of the present disclosure provides an algorithm for retrieving the moisture content of combustibles in a vegetation canopy with hyperspectral data.

An exemplary embodiment of the present disclosure provides a hyperspectral retrieval algorithm for the moisture content of fuels in a vegetation canopy, including the following steps:

Obtain the fresh weight and dry weight of the vegetation, and calculate the moisture content of the vegetation;

Obtain the gray scale data, albedo map data and spectral index of the vegetation; Select the model to invert the water content of the vegetation canopy.

The calculation about the moisture content of the sample vegetation in the embodiment of the present disclosure:

Inversion calculates FMC. It is the leaf water content as a percentage of fresh or dry weight.

$$FMC = \frac{}{} \times 100 \%$$

FMC=(fresh weight-dry weight)/fresh weight (or dry weight)*100% In the embodiments of the present disclosure, about model establishment. The equipment used: Hyperspectral equipment Rainbow-VN, its effective spectral range is 400-1000, to obtain the gray scale data and reflectance map data of vegetation.

Currently commonly used spectral indices include normalized difference moisture index (NDWI), moisture index (WI), normalized infrared index (II), simple ratio index (SR), adjustable moisture index (SWAI), etc.

Calculated as Follows:

$$SR = \frac{{R}_{1600}}{{R}_{820}}$$

$$SW \text{?} I = \frac{{R}_{820} - {R}_{1600}}{{R}_{820} + {R}_{1600} + L} \times ( 1 + L )$$

$$II = \frac{( {R}_{820} - {R}_{1600} )}{( {R}_{820} + {R}_{1600} )}$$

$$W \text{?} = \frac{{R}_{970}}{{R}_{900}}$$

$$NDWI = \frac{( {R}_{860} - {R}_{1240} )}{( {R}_{860} + {R}_{1240} )}$$

$${WI}_{2} = \frac{{R}_{950}}{{R}_{900}}$$

$$\text{?} \text{indicates text missing or illegible when filed}$$

As shown in FIG. 62-1, in practical applications, the final spectral index used can be determined according to the vegetation moisture content measured in the laboratory to invert the vegetation canopy moisture content. The most commonly used index at present is the simple ratio index (SR) In the embodiment of the present disclosure, about water cut inversion. At present, the models used for water cut inversion are mainly concentrated in four categories: linear regression function fitted by least square method, and quadratic regression function. Exponential and logarithmic functions. In the hyperspectral imaging-based inversion algorithm for the moisture content of forest vegetation canopy combustibles communicated in the embodiment of the present disclosure, these four methods can be calculated separately to obtain the correlation coefficient R2, compare the size of R2, and select the most suitable model for inversion.

| [symbol] | [symbol] |
|---|---|
| [symbol] | y = ax + b |
| [symbol] | y = ax² + bx + c |
| [symbol] | y = exp(ax) |
| [symbol] | y = alog(x) + b |

Regression model
linear regression function fitted by least
square method,
least squares method
quadratic regression function
exponential regression function
Logarithmic regression function

The input parameters and output parameters of the algorithm of the embodiment of the present disclosure: input parameters: moisture content of sample vegetation (may only be needed once, or can be provided separately according to different seasons); hyperspectral image data; spectrometer parameters. Output parameters: Inverted vegetation canopy fuel moisture content.

### R5-20-63—a Fire Danger Level Prediction Algorithm.

The occurrence and development of forest fires are inseparable from meteorological conditions. Forest fire risk is an important measure of the possibility of forest fire occurrence and the difficulty of spreading. The zoning of forest fire danger weather grades is an important basis for forest fire prevention management. The forest fire danger level forecasting system is very important to predict and forecast forest fires. The Canadian Forest Fire Danger Rating System (CFFDRS) is a relatively common forest fire danger rating system, and the Canadian Forest Fire Climate Index (FWI) system is an important part of CFFDRS. The Canadian fire climate index system is based on the time-lag-equilibrium moisture content theory, and calculates the change of moisture content of combustibles through changes in weather conditions, and then divides forest potential fire hazard levels according to the moisture content of combustibles at different locations or sizes.

At present, Canada's forest fire risk weather index algorithm is widely used abroad to evaluate fire risk, but the calculation time span of this algorithm is calculated once a day, and the input parameters are simple (only daily precipitation, surface temperature, relative humidity, and wind speed), only considering Due to the influence of weather factors, the applicable site is more inclined to the virgin forest with deep combustible accumulation on the surface.

Based on the above technical problems, an embodiment of the present disclosure provides a fire danger level prediction algorithm.

Exemplarily, as shown in FIGS. 63-1 to 63-2, an embodiment of the present disclosure provides a fire danger level prediction algorithm, including the following steps:

A fire danger level prediction algorithm, comprising the following steps: Acquiring fire risk environment parameters, the fire risk environment parameters include air temperature, relative humidity, wind speed, precipitation;

Calculate the initial spread rate (ISI) and accumulation index (BUI) through the Canadian forest fire danger rating system;

Calculation of forest fire risk climate index.

Obtain meteorological thunderstorm probability, land type attribute and coverage rate, risk and hidden danger location, custom and festival factors, weather description field factors, grid crowd flow influencing factors, international forest fire weather calculation formula, vegetation attribute and coverage rate parameters, and generate corresponding weight ratios;

The Forest Fire Danger Climate Index is multiplied by all weight ratios to generate the predicted fire danger rating.

Wherein, after the step of obtaining the fire risk environment parameters, the fire risk environment parameters include air temperature, relative humidity, wind speed, precipitation, and before the step of calculating the initial spread speed and accumulation index by the Canadian forest fire danger rating system, it also includes:

Generate fine combustible material moisture code (FFMC) according to temperature, relative humidity, wind speed, precipitation, vegetation attributes and coverage parameters; generate humus moisture code (DMC) according to temperature, relative humidity, and precipitation parameters; generate humus moisture code (DMC) according to temperature, precipitation, vegetation attributes and The coverage parameter generates a drought code (DC);

Wherein, the step of calculating the initial spreading speed and accumulation index by the Canadian forest fire danger rating system exemplarily includes:

According to the humidity code and wind speed of fine combustibles, the initial spreading speed is calculated, and the accumulation index is calculated according to the humus humidity code and drought code.

Compared with related technologies, the algorithm of the fire danger rating system in the embodiment of the present disclosure is called CEFDRS (Fire Danger Rating System) for short, which can calculate the fire risk level of each region and predict the possible fire risk situation in the next 240 hours. The embodiments of the present disclosure comprehensively consider natural forest fire factors (geographical factors, meteorological factors, topography, vegetation, land type, fuel load, coarse humus humidity, fine combustible humidity, combustible accumulation index, combustible spread index), man-made forest fire factors (local cultural environment, living habits, customs and cultural traditions), hidden danger data analysis, etc. have greatly improved the scientificity and precision of the forest fire risk level assessment system, which is a good example for Chongli and the Winter Olympics Tailor-made early warning and prediction system for forest fire safety hazards.

Fire danger level entry parameter 1: Meteorological thunderstorm probability.

It can be obtained from the thunderstorm probability hourly forecast table of the weather station. The thunderstorm probability hourly forecast table is trained with the deep neural network model based on the monitoring data of historical weather stations, and the weather station weather and thunderstorm probability in the future can be obtained through prediction.

Data source: monitoring data of historical weather stations.

Fire danger level entry parameter 2: various types of vegetation attributes and coverage.

Each type of vegetation has different burning characteristics and coverage. The classification is as follows:

Flammable: pitch pine.

Combustible, poplar, birch, larch and oak.

Flame retardant: commercial forest shrubs and apricots.

Based on the comprehensive consideration of the combustibility and coverage of the grid vegetation, it is used as an input parameter of the fire danger level.

Fire danger level entry parameter 3, various types of land attributes and coverage.

Each land type has different burning characteristics and coverage. Land types include, arbor forest, sparse forest, special irrigation, pasture land, logging land, village, country road, graded road, institution, cultivated land, auxiliary forest land, barren hill, failed land, wetland, river, difficult land, unforested land, bare land Rock, others, industrial and mining, nursery, photovoltaic, lake, city, green space.

Based on the comprehensive consideration of the combustibility and coverage of the grid land type, it is used as an input parameter of the fire danger level.

Fire hazard level entry 4: Risky and hidden danger locations.

For some special locations, the risk points are relatively high, such as cemeteries, fireworks and firecracker shops, barbecue stalls, etc. so the concept of risk hidden locations is introduced as a parameter of fire danger level. It can be configured by the engineering department according to on-site inspection.

Fire danger level entry 5: Custom festival factors.

The festivals considered mainly include New Year's Day, Spring Festival, Labor Day, Ching Ming Festival, Dragon Boat Festival, National Day, Mid-Autumn Festival, and Hungry Ghost Festival. Data source: Judgment on whether the date is a festival or not.

Fire danger level entry parameter 6: weather description field factor.

Weather data, the weather descriptions used are “clear, cloudy, few clouds, showers, severe showers, thunderstorms, severe thunderstorms, thunderstorms with hail, light rain, moderate rain, heavy rain, extreme rainfall, drizzle, drizzle, heavy rain, heavy rain. Severe rainstorm, freezing rain, light to moderate rain, moderate to heavy rain, heavy to heavy rain, heavy to heavy rain, heavy to heavy rain, rain, light snow, moderate snow, heavy snow, blizzard, sleet, sleet, rain and sleet. Snow showers, light to moderate snow, moderate to heavy snow, heavy to blizzard, snow, mist, fog, haze, blowing sand, floating dust, sandstorm, strong sandstorm, dense fog, strong dense fog, moderate haze, severe haze, severe Haze, heavy fog, extremely dense fog, heat, cold, unknown”. For long-term missing data, the neural network is used to predict intelligent completion.

Fire danger level entry parameter 7: Influencing factors of grid flow of people.

According to the personnel detection function of the bayonet camera, there is a historical data monitoring of the flow of people, so that the neural network can be used to predict the flow of people in the grid in the future.

Data source: monitoring and statistics of traffic flow by bayonet cameras.

Fire danger level entry reference 8: International forest fire weather calculation formula. Calculated from temperature, humidity, wind speed, rainfall.

The input parameters are temperature, humidity, wind speed, and rainfall, and the forest fire risk coefficient benchmark is calculated using the international forest fire weather calculation formula. Entered as a fire hazard rating.

The fire danger index calculated above is converted into a fire danger level through the following table, which is divided into 1-5 levels. As shown in the table below.

| grade | fire danger level | | | | |
|---|---|---|---|---|---|
| digital | Low | middle | high | very high | extreme |
| representation | 1 | 2 | 3 | 4 | 5 |
| DMC | 0-21 | 21-27 | 27-40 | 40-60 | >60 |
| FFMC | 0-63 | 63-84 | 16-88 | 88-91 | >91 |
| DC | 0-80 | 80-190 | 190-300 | 300-425 | >425 |
| ISI | 0-2 | 2-5 | 5-10 | 10-15 | >15 |
| BUI | 0-20 | 20-30 | 30-40 | 40-60 | >60 |
| CEFDRS | 0-5 | 5-10 | 10-20 | 20-30 | >30 |

In this embodiment, in the process of generating the FWI index in the embodiment of the present disclosure, the FFMC value of the previous hour is 85 if missing; the DWC value of the previous hour is missing 6; the DC value of the previous hour is 20 missing.

The fire danger rating system of the embodiment of the present disclosure draws on the strengths of others. The system contains not only the measurement considerations of traditional physical model derivation algorithms (time delay-equilibrium moisture content theory, etc.), but also modern artificial intelligence neural network algorithms (depth neural network expert system, deep neural network prediction system, deep neural network image processing system). The traditional physical model deduction algorithm is responsible for introducing various physical science calculation methods, and the artificial intelligence neural network algorithm is provided for the weather forecast system, thunderstorm probability forecast system, and human flow forecast system.

### R5-21-64—a Smoke Detection Method Based on Deep Learning.

The smoke detection function is mainly used in the monitoring of construction sites, industrial parks, warehouses, and other flammable and explosive scenes. This function is suitable for daytime or night environments with good lighting conditions, but not for scenes with poor lighting conditions and severe occlusion. The purpose of the outdoor smoke and fire automatic retrieval alarm system is to be able to carry out intelligent uninterrupted work, automatically discover abnormal smoke and fire signs in the control area, issue alarms in a rapid manner and cooperate with firefighters to deal with fire dilemmas, and Minimize misreporting and underreporting; in addition, real-time images of the scene can be checked, and the dispatching system can be directed to fight fires immediately based on the visualized pages.

At present, the smoke and fire detection algorithm is mainly divided into two systems: one is to use infrared thermal imager technology or target detection technology based on deep learning for monitoring. The other is to judge the scene information after decoding the video stream transmission of the camera, and finally complete the detection and report. The smoke and fire detection algorithm is based on intelligent video analysis. Through real-time retrieval and judgment of video information, fire and smoke in the monitoring area can be detected in time without manual monitoring, and the sound and light alarm can be linked. At present, it is widely used in scenarios such as smart factories and forest fire prevention. Firework detection in computer vision can locate firework or firework image classification in surveillance video and images, which has unique significance in the field of fire safety.

However, on the one hand, a large amount of operating resources will be occupied during the video streaming process. On the other hand, the infrared camera technology is relatively complicated in the installation process and the cost is high. In the follow-up detection process, it is difficult to distinguish living things or high temperatures in areas affected by weather, which is prone to false alarms. Although deep learning target detection technology is currently widely used, and it has a good detection effect on specific targets (flames) after training, most models consume a lot of computing power. Or the cost is expensive, or the real-time performance cannot be guaranteed. Based on the above technical problems, the embodiments of the present disclosure provide a firework detection method based on deep learning, which saves the resource consumption of video stream encoding and decoding, greatly improves the operation speed of the algorithm, reduces the operating pressure of the deep learning algorithm, and reduces the computing power requirements of the equipment, cost and improve detection accuracy.

Exemplarily, as shown in FIG. 64-1, the embodiment of the present disclosure provides a deep learning-based smoke detection method, which includes the following steps:

A smoke detection method based on deep learning, said method comprising the following steps, get image data;

Determine whether the scene has changed.

If there is a change, day and night are distinguished;

If it is daytime, it will be sent to the deep learning target detection algorithm for detection and classification to determine whether there is a flame, if it is night, the current picture will be rendered and then sent to the deep learning target detection algorithm for detection and classification to determine whether there is a flame.

Wherein, the step of obtaining image data exemplary includes: Get the image data transferred by FTP protocol.

Wherein, the step of judging whether the scene changes exemplarily includes: Use the vibe algorithm to determine whether the scene has changed;

Wherein, after the step of judging whether the scene changes, it also includes.

If there is no change, update the background model and reacquire image data.

Wherein, if it is daytime, it is sent to the deep learning target detection algorithm for detection and classification to determine whether there is a flame; if it is night, the current picture is rendered, and then sent to the deep learning target detection algorithm for detection and classification to determine whether there is a flame Exemplary steps include:

If it is daytime, it will be sent to the deep learning target detection algorithm for detection and classification to determine whether there is a flame, if it is night, the current image will be rendered by the opencv algorithm, and then sent to the deep learning target detection algorithm for detection and classification to determine whether there is a flame.

FIG. 64-2 is a diagram of FTP file transfer. The File Transfer Protocol (File Transfer Protocol, FTP) is a set of standard protocols for file transfer on the network. It works on the seventh layer of the OSI model and the fourth layer of the TCP model. Layer, that is, the application layer, uses TCP transmission instead of UDP. The client must go through a “three-way handshake” process before establishing a connection with the server to ensure that the connection between the client and the server is reliable, and it is connection-oriented, for data transmission. Provide a reliable guarantee. FTP allows users to communicate with another host in the form of file operations (such as file addition, deletion, modification, query, transfer, etc.). However, the user does not actually log in to the computer he wants to access and becomes a full user. The FTP program can be used to access remote resources to realize the user's round-trip file transfer, directory management, and access to e-mail, etc. even though the computers on both sides may have different configurations, operating system and file storage method.

Exemplarily, as shown in FIG. 64-1, in this embodiment, the embodiment of the disclosure transmits the picture to the server through the FTP method, and the algorithm obtains the latest picture by scanning the storage location of the picture on the server, and then uses the vibe algorithm to establish domain pixels. If the scene changes, it is initially judged as a suspected fire. For the current picture to be detected, day and night are distinguished. If it is daytime and the quality of the picture to be tested is high, it will be sent to the deep learning target detection algorithm for secondary detection and classification. If it is dark night and the image quality is slightly poor, use the opencv algorithm to render and enhance the image quality, and then transmit it to the target detection algorithm for classification.

Compared with related technologies, the embodiment of the present disclosure uses ftp technology for image transmission and sharing of multi-channel cameras, saves resource consumption of video stream encoding and decoding, and greatly improves algorithm operation speed; performs preliminary scene change detection through vibe algorithm, reduces depth Learn the operating pressure of the algorithm to reduce equipment computing power requirements and costs; through day and night judgments, render and repair night images to improve detection accuracy.

### R5-22-65—a Fire Spread Algorithm.

Forest fire is one of the most harmful forest disasters. It not only ruthlessly destroys various creatures in the forest and destroys the terrestrial ecosystem, but also produces huge smoke and dust that seriously pollutes the atmosphere and directly threatens the living conditions of human beings. It consumes a lot of manpower, material resources, and financial resources, brings huge losses to the country and people's lives and property, disrupts the economic and social development of the region and the order of people's production and life, and directly affects social stability. Therefore, the early identification of forest fires is very important. In addition, in order to carry out more effective defense and fire-fighting measures, it is also very useful to identify the direction of fire spread, which can save a lot of manpower, material and financial resources for fire-fighting, and has certain guidance sex.

The Wang Zhengfei model and the Rothermel model are the two most commonly used models for forest fire simulation. In order to quantitatively compare the applicability of the two models to forest fire spread, the forest fire spread model was used and factors such as fire site terrain, meteorology and combustible types were considered comprehensively. Based on ArcEngine, the two-dimensional simulation of forest fires under different models is finally realized. The simulation results show that under certain terrain and wind speed conditions, the fitting of Wang Zhengfei's model is closer to the real fire simulation situation. The fitting degree of Wang Zhengfei's model after the model correction can reach 0.94; in addition, after repeated simulations, it is found that under certain terrain conditions, as the initial speed of spreading increases, the spreading area also increases correspondingly; different wind speeds. The area of the formed fire field is different, and as the wind speed increases, the spread area increases accordingly.

The forest fire simulation model in the related art has a lot of parameters to be imported, such as the geocoding level, the slope of the fire point, the uphill direction, etc. which is troublesome. And there are few prediction directions provided, so the related technology needs to be improved and improved.

Based on the above technical problems, embodiments of the present disclosure provide a fire spread algorithm.

As shown in FIG. 65-1 and FIG. 65-2, the embodiment of the present disclosure provides a fire spread algorithm, including the following steps: input parameters;

Calculate the starting point grid of the flame; calculate the fire spread speed according to the current air humidity and slope selection algorithm model;

Calculate the actual value of each output parameter according to the obtained fire spread speed, and calculate according to the time interval of every 5 minutes to obtain the output parameter value; send the obtained output parameter value back to the front end.

Wherein, the step of returning the obtained output parameter value to the front end exemplarily includes: converting the obtained output parameter value into json format and sending it back to the front end.

Wherein, in the step of inputting parameters, the input parameters at least include: longitude and latitude, humidity, wind speed, wind direction, and combustibles coefficient.

Wherein, before the step of calculating the fire spread speed according to the current air humidity and slope selection algorithm model, after the step of calculating the starting point grid of the flame, it includes: calculating wind field data, calculating relative slope, and calculating upslope. Wherein, after the step of calculating the fire spread speed according to the current air humidity and slope selection algorithm model, the actual value of each parameter is calculated according to the obtained fire spread speed, and calculated according to the time interval of every 5 minutes, before the step of obtaining the parameter value, it also includes: when the slope <=15 or humidity <=35%, select the Rothermel algorithm; when the slope is between 15 and 75, select the Wang Zhengfei forest fire spread algorithm.

Embodiments of the present disclosure relate to forest fire spread models:

1. Rothermel model based on the law of conservation of energy.

The Rothermel model studies the spread process of the flame front without considering the continuous burning of the overheated fire site. It is required that the combustibles in the field are relatively uniform, and it is a mixture of various grades with a diameter less than Scm, and it is assumed that the impact of larger types of combustibles on the spread of forest fires can be ignored. The Rothermel model applies the concept of “quasi-steady state”, that is, describes the fire spread from the macro scale, which requires that the fuel bed parameters are continuous in spatial distribution; the spatial distribution of terrain and terrain is continuous; dynamic environmental parameters cannot change too much quick.

The Rothermel model is a physical mechanism model based on the law of conservation of energy. Due to its high degree of abstraction, it has a wide range of application. In reality, it is difficult to achieve uniform combustibles on the microscopic scale, so Rothermel used the weighted average method to obtain the parameters of combustibles, and then Francis estimated the spread of forest fires with heterogeneous combustibles in space. Considering the time-consuming and labor-intensive acquisition of combustibles configuration, the combustibles model is used to describe the parameters for the calculation of forest fire spread. When the water content of combustibles bed exceeds 35%, the Rothermel model becomes invalid. The Rothermel model itself is a semi-empirical model, because some parameters of the model need to be obtained through experiments.

TABLE 1
Input parameters of the Rothermel forest fire spread model

| [symbol] | [symbol] | [symbol] |
|---|---|---|
| Wo | [symbol] | Kg/m² |
| h | [symbol] | Kj/kg |
| Pp | [symbol] | Kg/m³ |
| σ | [symbol] | cm²/cm³ |
| δ | [symbol] | m |
| Mf | [symbol] | [symbol] |
| St | [symbol] | [symbol] |
| Se | [symbol] | [symbol] |
| U | [symbol] | m/min |
| tanΦ | [symbol] | [symbol] |
| Mx | [symbol] | [symbol] |

### 2. Wang Zhengfei's Forest Fire Spread Model

R=R₀Kₛ K_{w} K_{φ.}

The combined model of Wang Zhengfei and Mao Xianmin is based on the characteristics of forest fires, which has fewer parameters and takes into account the combination of terrain and wind direction. This model is only applicable to the situation of upslope and wind along the upslope, so Mao Xianmin et al. considered the combination of wind direction and terrain and derived the equations of upslope, downslope, left flat slope, right flat slope and wind direction, available for practical use.

### 3. The McArthur Model of Australia

R=0.13F.

The McArthur model is the mathematical description of the McArthur Fire Hazard Ruler by Noble I. R et al. It can not only forecast fire weather, but also quantitatively forecast some important forest fire behavior parameters. The regions are mainly countries and regions with a Mediterranean climate.

### 4. Canadian Forest Fire Spread Model.

The Canadian Fire Spread Model is the Canadian Fire Danger Rating System. According to the vegetation status in Canada, combustibles can be divided into 5 categories, namely: coniferous trees, broad-leaved trees, mixed forests, logging bases and open lands, and are subdivided into 16 representative forest types. Through 290 fire observations, most combustibles spread velocity equations were summarized. Different types of combustibles have different spreading speed equations, but all equations take the initial spreading index as an independent variable, which is related to the water content of fine combustibles and wind speed.

The Canadian forest fire spread model is a statistical model, which does not consider the physical nature of forest fire behavior, but establishes models and formulas by collecting, measuring and analyzing data from actual fire sites and simulation experiments Its advantage is that it can conveniently and visually understand each sub-process of fire and the whole fire process, can successfully predict the fire behavior under the similar conditions to the test fire parameters, and can fully reveal the action law of this complex phenomenon of forest fire. Its disadvantage is that this type of model does not consider any heat transfer mechanism. Due to the lack of a physical basis, the accuracy of using statistical models decreases when the actual fire conditions do not match the experimental conditions.

Introduction of related parameters of forest fire spread model.

### 1. Combustible Load.

Combustible load refers to the absolute dry weight of combustibles per unit area, and its unit is (kg/m 2). The amount of combustibles varies greatly, and it is difficult to grasp the law, so it is not easy to measure accurately. It can be understood as the amount of combustibles that can be burned within a certain period of time and within a certain area.

The fuel load depends on the water content of the various constituents in the fuel bed. The fuel load also has a certain relationship with its age. In order to obtain fuel load data, it is necessary to accurately determine the total vegetation amount; at the same time, to obtain effective fuel load, it is necessary to find the distribution of the size of live and dead fuel.

### 2. Surface Area to Volume Ratio σ.

The combustibles in the forest refer to the complex of various combustibles from the peat and humus layer to the top of the vegetation crown. Combustibles include both living and dead combustibles. Combustibles in their natural state are generally inhomogeneous and discontinuous, and are affected by terrain, weather, and other factors. Fuel load and physical and chemical properties are the main parameters for estimating forest fire behavior.

In the forest fire spread model, the size of combustibles is mainly reflected by the parameter σ of surface area to volume ratio. It can be understood that the larger the σ value, the smaller the combustible particles, and the easier it is to ignite and burn. When calculating the surface area to volume ratio σ of combustibles, the usual calculation method is to divide the unit surface area by the volume.

### 3. Moisture Content Mf of Combustibles.

Moisture content of combustibles is closely related to forest fire behavior. It refers to the ratio of the weight of water in fuel to the weight of dry fuel, and is a dimensionless parameter. The moisture content of forest combustibles directly affects the difficulty of igniting combustibles, briefly affects the fire intensity, fire spread speed and effective radiation, and also has a cooling effect, promoting the formation of smoke and reducing beat generation.

There are two parameters related to the water content of combustibles in the model, namely the moisture content Mf and the extinguished moisture content Mx of combustibles. At the same time, the moisture content should consider the moisture content of living organisms and dead organisms respectively. The moisture content of living things is generally obtained through experiments, and it changes with the month.

### 4. Wind Speed and Direction U.

The horizontal movement of air is called wind, which is caused by the uneven distribution of air pressure in the horizontal direction. When two adjacent air pressures are different, it will move from high pressure to low pressure. The wind direction refers to the direction of the wind, expressed in eight or sixteen directions. Wind speed refers to the horizontal distance that the wind moves per unit time, usually in meters per second, and also expressed in “level”.

Wind speed has a great influence on the spreading speed of forest fire. The spreading speed of fire head increases with the increase of wind speed, the spreading speed of fire wing increases slightly with increasing wind speed, and the spreading speed of fire tail decreases with increasing wind speed, even Can make the tail of the fire extinguished.

TABLE 1
Relationship between wind speed and fire speed

| [symbol] | 1 | 2 | 3 | 4 | 5 | 6 |
|---|---|---|---|---|---|---|
| [symbol] m/s | 2 | 3.6 | 5.4 | 7.4 | 9.8 | 12.3 |
| [symbol] M/min | 6.18 | 13.85 | 50.5 | 64.55 | 83.33 | 144.33 |
| [symbol] | 7 | 8 | 9 | 10 | 11 | 12 |
| [symbol] | 14.9 | 17.7 | 20.8 | 24.2 | 27.8 | 29.83 |
| [symbol] M/min | 250 | 353.55 | 500.00 | 559.02 | 625.00 | 833.00 |

### 5. Slope and Aspect.

tanφ.

It can be seen from the experiment that under the same conditions, the speed of fire spread increases with the increase of the slope, the speed of fire spread on the uphill slope is larger and the speed of fire spread on the downhill slope is smaller, and the slope change of the downhill slope has a great influence on the spread of fire. The effect of speed is not as obvious as the uphill fire. The change of the slope causes the relative position between the flame surface and the fuel in the unburned area to change, thereby changing the radiation of the flame facing the fuel in the unburned area, and causing the flame speed to change. The radiant heat flow of the fuel on the uphill fire increases, which shortens the time for the fuel to heat up to ignite and increases the speed of fire spread.

### 6. Combustible Tightness β.

In the combustible bed, the compactness of combustible particles stacked is called compactness. In addition to affecting the air supply to the burning particles, the compactness also affects the heat transfer between the particles at the flame front. In the calculation of the model, the compactness of the combustible bed is quantified by the compression ratio, which is defined as the ratio of the combustible bed density pb to the combustible particle density pp:

$$β = \frac{{P}_{b}}{{P}_{p}}$$

Calculation method of forest fire spread model parameters:

1. Combustible load W_{0.}

In the actual application research, according to the experimental woodland vegetation, select the appropriate fuel load model. This algorithm uses the current situation intersecting fuel investigation method to obtain the data of the fuel load in the experimental forest land. This method calculates the fuel load using specific wood material densities by estimating the fuel volume:

$${W}_{0} = \frac{0.1234 \times ( n \times \text{?} ) \times \text{?} \times \text{?} \times c}{N \times \text{?}}$$

$$c = \sqrt{1 + {( ( \% ) / 100 )}^{2}}$$

$$\text{?} \text{indicates text missing or illegible when filed}$$

### 2. Surface Area to Volume Ratio σ.

Generally speaking, the σ values of combustibles with different sizes and shapes are relatively different, but the time lag has little effect on the surface area to volume ratio. Therefore calculate the herbaceous and woody surface area to volume ratios separately:

Tree Branches:

$$σ = \frac{4}{d}$$

### Broad and Grass Leaves:

$$σ = \frac{2}{\text{?}}$$

$$\text{?} \text{indicates text missing or illegible when filed}$$

### 3. Fuel Bed Depth ô.

Combustible bed depth refers to the average thickness of surface combustibles. The calculation of fire spread model is relatively sensitive to combustible bed depth. The combustible bed depth determined by the plane intercept method is called the average particle depth.

$$δ = \text{?} \frac{\text{?} \times \text{?}}{\text{?}}$$

$$\text{?} \text{indicates text missing or illegible when filed}$$

### 4. Moisture Content Mf.

The moisture content of combustibles is determined by calculation in the laboratory, and the formula is:

$$= \frac{}{} \times 100 \%$$

### 5. Wind Speed U in the Middle of the Flame.

When conducting model research, it is necessary to obtain the wind speed in the middle of the flame, that is, the average wind speed, which refers to the average wind speed from the top of the combustible bed to the top of the flame. The calculation method is:

$$x = \frac{\text{?}}{0.5} \times 1.15$$

$$\text{?} \text{indicates text missing or illegible when filed}$$

6. Fire wire strength.

The fire wire strength is the amount of energy released per unit time and unit fire wire length, which is generally calculated by the American Byram fire wire strength formula, specifically:
I=hW₀R.

### 7. Flame Length.

The flame length refers to the linear distance from the bottom of the fire at the fire line to the highest point of the continuous flame, which is generally the average flame length, and its empirical formula is:
L=0.07761 046.

### 8. Temperature in Live Zone.

The temperature of the live zone refers to the average temperature of the live zone higher than that of the surrounding environment, using Finn Weigel's empirical formula:

$$Δ T = \frac{3.9 \text{?}}{H}$$

$$\text{?} \text{indicates text missing or illegible when filed}$$

### 9. The Perimeter of the Fire Scene.

The initial fire site is the fire site that has not been effectively controlled since the forest fire broke out. The empirical calculation formula for the perimeter length of the initial fire site is:

$$C = 3 R \times Δ t$$

### 10. Fire Area.

The empirical calculation formula for the initial fire area is:

$$S = 0.75 \times {( R \times Δ t )}^{2}$$

In the embodiment of the present disclosure, this embodiment simulates the spread of the forest fire according to the parameters input by the front end, and returns various parameters of the simulated spread of the forest fire at intervals of once every five minutes, including the edge coordinates of the fire scene, in 12 directions (one every 30 degrees) the speed of fire spread, the length of the line of fire, the area of fire, etc. The fire spread algorithm is written in the form of an interface using flask and is directly called, so its input parameters are input by the user, including six parameters latitude and longitude of the initial fire point, air humidity, wind speed, wind direction, vegetation index, and simulation time. The fire spread algorithm finally returns data in json format, which includes the following parameters: length of fire line, fire area, flame spread speed level, spread speed in main directions (one per 30 degrees), spread distance, and latitude and longitude of flame boundary.

Compared with related technologies, the embodiment of the present disclosure utilizes the Wang Zhengfei model and the Rothermel model, and only needs to provide longitude and latitude, and a json file with built-in topographic features, which is easy to operate and can provide predictions in 12 directions.

### R5-23-66—a Fire Behavior Analysis Method.

In forest fires, when the fire intensity reaches a certain level, there are special fire behavior phenomena. The study of special fire behavior in forest burning is one of the difficulties and focuses in this field. The characteristics of special fire behavior are: a sharp increase in fire intensity, a sustainable fire spread quickly, air convection is very easy, long-distance flying fire, fire A whirlwind or swath of horizontal flame with a sudden calm in the wind. Phenomena of special fire behavior include fire whirlwind, convective column, flying fire and bot explosion etc. When the fire exhibits the above-mentioned characteristics and phenomena, its intensity has reached the level that conventional extinguishing methods are seldom effective. In such cases, fire fighting should be carried out on those parts of the fire line that can ensure safe work, and take measures to protect valuable property or resources. Forest fires are sudden, random and arbitrary, and have a process of gradual formation, occurrence and development. When the general forest fire is affected by the special fire environment, it will be very random and irresistible. Forest fire is one of the most difficult natural disasters in the world, and fighting forest fires is extremely dangerous. Forest fires are fickle and rarely are two fires the same. After the fire breaks out, predicting and forecasting the speed of forest fire spread, energy release, fire intensity and fire fighting difficulty are of great significance to forest fire fighting, manpower and material resources. The study of forest fire behavior is helpful to grasp the occurrence and development of forest fire in time, accurately grasp when, where and under what conditions forest fire will occur, which is helpful to make full preparations in advance and make correct decisions, help to put out fire more effectively and safely, and avoid accidents. However, the research and development of fire behavior is relatively slow, because of the complexity of forest fire and the difficulty of conducting forest fire experiments.

The fire behavior analysis function can simulate the spread of fire based on factors such as on-site temperature, humidity, wind direction and speed, and vegetation level, allowing users to make appropriate and effective rescue decisions based on real-time disaster conditions. Related technologies cannot use fire behavior analysis and simulation in 3D maps question.

Based on the above technical problems, an embodiment of the present disclosure provides a fire behavior analysis method.

Exemplarily, as shown in FIGS. 66-1 to 66-3, an embodiment of the present disclosure provides a fire behavior analysis method, which includes the following steps:

A method for analyzing fire behavior, said method comprising the following steps: analyzing fire behavior data through cesium, adding the shape of the fire scene on a three-dimensional map in the form of a polygonal covering; simulating through the CallbackProperty method of cesium. Cesium provides an efficient data visualization platform for 3D GIS. That is: Cesium is a cross-platform, cross-browser JavaScript library for displaying 3D earth and maps. Cesium uses WebGL for hardware-accelerated graphics, and does not require any plug-in support for use. Cesium is used for geographic data visualization. It supports efficient rendering of massive data, 3D visualization of time series dynamic data, dynamic simulation of geographical environment elements such as the sun, atmosphere, clouds and fog, and loading and drawing of terrain and other elements Contains a wealth of available tools. That is, the tools provided by Cesium's basic controls, such as geocoders, layer selectors, etc.

The embodiment of the disclosure analyzes the data given by the algorithm, adds the shape of the fire scene on the three-dimensional map in the form of a polygonal overlay, and displays the simulation process smoothly in real time through the CallbackProperty method of cesium. The application scenarios of the embodiments of the present disclosure are applicable to some mountains, forests and other places with lush vegetation and high fire risk index. The fire behavior analysis is carried out to predict the spread speed and the coverage area of the fire area after the fire, and the place where the prediction result is more dangerous can be advanced Be prepared. As shown in FIG. 66-1, predict the area of fire spread 10 minutes after the start of the fire. Predict the area of fire spread 30 minutes after the start of the fire as shown in FIG. 66-2. As shown in FIG. 66-3, predict the area of fire spread 1 hour after the start of the fire. In the embodiment of the present disclosure, while predicting, the fire intensity, the length of the fire line and the burning area can also be calculated through an algorithm.

Compared with related technologies, the embodiment of the present disclosure realizes three-dimensional fire behavior analysis through the combination of CesiumJS and simulation algorithm.

solves the problem of three-dimensional map fire behavior analysis and simulation, and allows us to input wind speed, rainfall index and vegetation at a designated location Once the area and its surroundings are on fire, the behavior and spread of the fire can be estimated within one hour. For locations where the calculated fire risk index is higher, preparatory measures can be taken in advance.

### R5-24-67—a Human Intrusion Detection Algorithm Based on Deep Learning.

Based on the basis of machine vision, develop personnel intrusion detection algorithm. It can be used for intrusion detection in machine rooms, garages, and railway track areas. To save labor costs, only one monitoring platform is needed to monitor and record entry and exit information and illegal intrusion information, and link the alarm module for reporting and early warning. Currently intrusion detection is done by background subtraction and pixel difference of adjacent frames. Check whether there are moving objects in the monitoring video screen, and then judge and report. In related technologies, a simple background subtraction algorithm is easily affected by various conditions such as illumination, shadows, and floating objects during the intrusion detection process, causing false positives. The alarm is single, and it cannot respond to different intrusion situations. Therefore, related technologies still need to be improved and improved.

Based on the above technical problems, the embodiments of the present disclosure provide a human intrusion detection algorithm based on deep learning.

Exemplarily, as shown in FIGS. 64-2 and 67-1, the embodiment of the present disclosure provides a human intrusion detection algorithm based on deep learning, including the following steps acquiring pictures to be processed; generating a set of pictures to be processed, and establishing a background model; Combined with the background model to judge whether there are abnormal objects in the current scene; if there are abnormal objects, it will be regarded as a mobile object intrusion, which will be passed to the deep learning model for target detection, and it will be judged whether the object is a person/other object; Judgment is made based on the entered staff information, if it is not a staff member, an intrusion alarm will be issued, if it is a staff member, the current work information will be recorded; if it is judged to be an animal, the sound and light alarm will be linked to sound the whistle to drive away and report the information.

Wherein, the step of acquiring the picture to be processed exemplarily includes, acquiring the picture to be processed through the FTP protocol. Wherein, the step of judging whether there is a moving object in the current scene in combination with the background model exemplarily includes, judging whether there is a moving object in the current scene through a vibe algorithm combined with the background model.

The embodiments of the present disclosure are aimed at scenarios such as machine rooms and railway inspections; report by level, set up the staff range, record the staff, and divide the intrusion of non-staff into loitering warning and intrusion alarm linkage.

The embodiment of the present disclosure transmits the picture to the server through the FTP method, and the algorithm scans the storage location of the picture on the server to obtain the latest picture, and then uses the self-built background and random background update logic to find whether there is a moving object in the current scene. The random background update logic can enhance the robustness of the background and reduce false positives caused by environmental factors. FIG. 64-2 is a diagram of FTP file transfer. The File Transfer Protocol (File Transfer Protocol, FTP) is a set of standard protocols for file transfer on the network. It works on the seventh layer of the OSI model and the fourth layer of the TCP model. Layer, that is, the application layer, uses TCP transmission instead of UDP. The client must go through a “three-way handshake” process before establishing a connection with the server to ensure that the connection between the client and the server is reliable, and it is connection-oriented, for data transmission. Provide a reliable guarantee FTP allows users to communicate with another host in the form of file operations (such as file addition, deletion, modification, query, transfer, etc.). However, the user does not actually log in to the computer he wants to access and becomes a full user. The FTP program can be used to access remote resources to realize the user's round-trip file transfer, directory management, and access to e-mail, etc. even though the computers on both sides may have different configurations, operating system and file storage method. In the embodiment of the present disclosure, it is determined that there is information about object movement and stay in the current monitoring area, and the current image is pulled and rendered, and then classified by a deep learning algorithm. If non-personnel break in, report the category and record (alert), if it is judged as a person, perform face recognition, if the judgment result is a normal worker, report and record (info), if it is a non-recording person, perform linkage alarm (warning).

In this embodiment, first, the FTP protocol is used for data collection, and the pictures to be processed are acquired. And build a background model through the image set to be processed. Use the vibe algorithm combined with the background model to judge whether there is a moving object in the current scene. When vibe finds that the background has changed, it is regarded as a moving object intrusion, and it is passed to the deep learning model for target detection, and the object is judged as a person/other object. If it is judged to be a person, perform personnel identification operation, and judge based on the entered staff information; if it is not a staff member, an intrusion alarm will be issued, and if it is a staff member, the current work information will be recorded. If it is judged as an animal, the sound and light alarm will be linked to whistle to drive away and report the information. Among them, FTP file transfer provides input pictures for the VIBE model. The VIBE algorithm separates the foreground and background models to determine whether there are moving objects in the current scene. When there are moving objects, the current picture is transmitted to deep learning for target detection; the deep learning model detects and classifies the pictures with moving objects judged by the VIBE algorithm to determine Specific object categories; the face recognition model judges whether it is a recorded staff member when the detection result is a person, and then determines whether to call the police; the sound and light alarm responds to different detection results (honking, reminding, warning, etc. Condition).

Compared with related technologies, on the one hand, the embodiment of the present disclosure utilizes ftp technology to transmit and share images of multiple cameras, saving resource consumption of video stream encoding and decoding. Improve the algorithm running speed. On the other hand, the vibe algorithm is used to perform preliminary living intrusion detection, and when it is determined that there is a target, it will be classified and detected to save computing power. In addition, the deep learning model is used for secondary judgment, and the classification results are reported according to the detection results, which not only enriches the feedback, but also reduces the probability of false positives and negative negatives.

### R5-25-68—Facial Feature Recognition Algorithm Based on Deep Learning.

Face recognition is a biometric identification technology based on human appearance feature information for identity authentication. Compared with biometric identification technologies such as fingerprint recognition, iris recognition, and DNA comparison, it has the characteristics of non-mandatory and non-contact. There is no need to specially cooperate with face acquisition equipment, and feature analysis can be performed unconsciously only through video images, and feature information comparison and locking can be completed.

At present, the face recognition technology performs streaming decoding on the input image of the camera, and then transmits it to the algorithm module. The algorithm part includes three modules Face Detection, Face Alignmet, and Feature Representation. Face detection first solves the problem of “where” is to determine the position information of the face in a picture; face alignment extracts the corresponding feature point information on the basis of face detection, and adjusts the position of the feature points, to complete face alignment, face alignment can greatly improve the stability of face recognition results; face feature table comparison is to extract feature vectors on the aligned and adjusted pictures, and calculate the distance between feature vectors so that Judge the similarity between faces, and finally lock the face target.

Face recognition technology is currently widely used in access control and face payment scenarios. In the process of detection and recognition in these scenarios, there are common limitations. They are all face target detection for close-range and large targets, while for wide-angle, small. The target face detection effect is not good, and it is prone to missed detection, the encoding and decoding of video streams will take up a lot of operating resources, resulting in slow running speed of the algorithm and low timeliness; Large resources, low timeliness.

Based on the above technical problems, the embodiments of the present disclosure make breakthroughs based on three aspects: data acquisition, face detection, and feature extraction and comparison. While enriching the feature information of face recognition, the operation speed is improved and the false detection rate and false alarm rate are reduced.

Therefore, the embodiment of the present disclosure uses the FTP protocol for image transmission and sharing of multiple cameras, saves the resource consumption of video stream encoding and decoding, greatly improves the algorithm operation speed, and then uses the PyramidBox method for face detection to improve small target face detection. The accuracy is high, the gender and age characteristics of the person are added on the basis of the basic feature extraction, and the comparison range is narrowed according to the relevant information during the face feature comparison process to increase the running speed.

Exemplarily, as shown in FIG. 64-2, FIG. 68-1 to FIG. 68-2, the embodiment of the present disclosure provides a face feature recognition algorithm based on deep learning, and the algorithm includes the following steps.

Obtain the image to be processed according to the FTP protocol;

The picture to be processed is input to the pyramidBox face detection model, and the face position information is judged;

Correcting the face information to determine whether the face is blocked or turned sideways; If the face information is complete, it will be transmitted to the subsequent deep learning model to judge the gender and age information of the face.

Wherein, if the face information is complete, it is transmitted to the subsequent deep learning model. After the judgment of the gender and age information of the face, it also includes: clustering and storing the face information according to different ages and genders. Recognized age and gender information, narrow the search scope, and then search.

Wherein, in the face feature recognition algorithm based on deep learning in the embodiment of the present disclosure, in the process of face search, the conventional search is traversal search.

The embodiments of the present disclosure will be described in detail below in conjunction with FIG. 64-2, FIG. 68-1˜FIG. 68-2:

The embodiment scheme of the present disclosure is based on three aspects of data acquisition, face detection, and feature extraction and comparison to make breakthroughs. While enriching the feature information of face recognition, it improves the operation speed and reduces the false detection rate and false alarm rate.

Exemplarily, first, the FTP protocol is used to collect data, and obtain pictures to be processed. Among them, the method of using the FTP protocol for data collection includes the use of the FTP protocol for image transmission and sharing of multiple cameras. This method can save the resource consumption of video stream encoding and decoding, and greatly improve the operation speed of the algorithm.

Among them, FTP (File Transfer Protocol, file transfer protocol) is one of the protocols in the TCP/IP protocol group. The FTP protocol consists of two components, one is the FTP server and the other is the FTP client. The FTP server is used to store files, and users can use the FTP client to access resources on the FTP server through the FTP protocol.

As shown in FIG. 68-2, the image to be processed is input to the pyramidBox face detection model to judge the face location information. In an embodiment, by inputting the picture to be processed into the face detection model, determining the position information of the face in the figure, and adopting the method of PyramidBox for face detection, the accuracy of small target face detection can be improved, wherein PyramidBox refers to is a face detection algorithm.

Correct the face information to determine whether the face is covered or turned sideways; if the face information is complete, it will be transmitted to the subsequent deep learning model to determine the gender and age information of the face.

Wherein, if the face information is complete, it is transmitted to the subsequent deep learning model. After the judgment of the gender and age information of the face, it also includes: clustering and storing the face information according to different ages and genders. Recognized age and gender information, narrow the search scope, and then search. On the basis of the basic feature extraction, the gender and age features of the person are added, and the comparison range is narrowed according to the relevant information during the face feature comparison process, which can improve the running speed.

Wherein, in the process of face retrieval, conventional retrieval is traversal retrieval, which refers to visiting each node in the tree (or graph) sequentially along a certain search route.

Compared with related technologies, the invention makes breakthroughs in three aspects: data acquisition, face detection, and feature extraction and comparison. While enriching the feature information of face recognition, it improves the operation speed and reduces the false detection rate and false positive rate. Use the FTP protocol to collect data to obtain pictures to be processed, input the pictures to be processed into the pyramidBox face detection model, judge the position information of the face, correct the face information, and judge whether the face is blocked or turned sideways. If the face information is complete, it will be transmitted to the subsequent deep learning model to judge the gender and age information of the face. In the embodiment of the present disclosure, the face information is clustered and stored according to different ages and genders, and when searching, the search range is first narrowed based on the identified age and gender information, and then the search is performed. On the basis of improving small target face detection, it adds unique feature extraction such as age and gender, narrows the scope of face comparison and retrieval, and improves operating efficiency.

### R5-26-69—a Multi-Camera Multi-Target Detection Positioning Tracking Method.

Target detection and tracking technologies are booming and have been widely used in forest firefighting, security monitoring, railway inspections and many other scenarios. It has the characteristics of simple deployment, timely feedback, and reliable detection results. However, most of the existing devices on the market are uploaded, detected and reported in fixed monitoring areas, and do not support multi-view camera linkage to monitor overall activities and behavior changes in the current associated environment.

Based on the above technical problems, the embodiment of the present disclosure can obtain the complete action track of the target through multi-camera multi-view fusion detection.

Compared with the target positioning of traditional base stations and pulse signals, the embodiment of the present disclosure is easy to deploy, and can be deployed and installed on the original surveillance camera, and the positioning is contactless and has no fixed equipment restrictions. Exemplarily, as shown in FIG. 69-1, an embodiment of the present disclosure provides a multi-camera-based multi-target detection point tracking method, which includes the following steps: Obtain the coordinates and height of the current scene through multiple positioning cameras, and construct a space model of the current scene according to the coordinates and height; When a target object is detected by one or more positioning cameras, the current position information of the target object is obtained according to the space model as a reference object; According to the entry and exit trajectories of the first appearance scene of the target object, the first movement trajectory is obtained;

Further, the detection of the target object in the multi-scene graph is fused to find the same object. Further, the steps of finding the same object by fusing the detection of the target object under the multi-scene graph include:

Fuse the positioning data of the target object from multiple positioning cameras and multiple perspectives to achieve more accurate positioning.

Further, after fusing the detection situation of the target object under the multi-scene graph, after finding the same object, it also includes:

Fuse the action trajectory of the same object under multiple perspectives, draw the movement trajectory of the target object, and complete the continuous tracking and positioning across cameras. The embodiment scheme of the present disclosure will be described in detail below in conjunction with FIG. 69-1:

As shown in FIG. 69-1, the solution of the embodiment of the present disclosure is to realize positioning and tracking based on multi-cameras and multi-target points, and perform scene fusion detection through multi-cameras and multi-view angles, so as to obtain the complete trajectory of the target object and realize the positioning of the target object track.

Exemplarily, first, the coordinates and heights of the current scene are acquired through multiple positioning cameras, and a space model of the current scene is constructed according to the coordinates and heights.

In the embodiment, different positioning cameras can obtain the coordinates and heights of different angles of the current scene, and the construction of the space model can be realized through these coordinates and heights of different angles.

When a target object is detected by one or more positioning cameras, the current position information of the target object is obtained according to the space model as a reference object. In an embodiment, when one or more positioning cameras detect a target object, according to the coordinates and height of the space model as a reference, the current position information of the object can be obtained.

According to the entry and exit trajectories of the target object in the first appearance scene, the first movement trajectory is obtained.

In an embodiment, when it is detected that the target object appears in the first scene for the first time, the position information of the first appearance in the first scene is recorded, that is, the target object is in the The position information of the entry track of the first scene, when detecting the last appearance of the target object in the first scene, record the current position information, that is, the exit track information of the target object, according to the entry track information and exit. The trajectory information can obtain the first moving trajectory of the target object.

Further, the detection of the target object in the multi-scene graph is fused to find the same object. In the embodiment, the same object may appear in different scenes, and the same object can be limitedly tracked by fusing the detection status of the target object in multiple scenes. Wherein, the steps of finding the same object by fusing the detection situation of the target object under the multi-scene graph include:

Fuse the positioning data of the target object from multiple positioning cameras and multiple perspectives to achieve more accurate positioning.

In an embodiment, different positioning cameras can provide positioning data of the target object under different viewing angles, and the data can more conveniently determine the exact position of the target object.

Further, after fusing the detection situation of the target object under the multi-scene graph, after finding the same object, it also includes:

Fuse the action trajectory of the same object under multiple perspectives, draw the movement trajectory of the target object, and complete the continuous tracking and positioning across cameras. In the embodiment, by fusing the action trajectories of the same object from multiple angles, and according to the positioning information of the action trajectories, the movement trajectories of the target objects can be drawn, so as to realize continuous tracking and positioning across cameras. Compared with related technologies, the embodiment of the present disclosure adopts multi-camera multi-view fusion detection, which can obtain the complete action trajectory of the target, obtain the coordinates and height of the current scene through multiple positioning cameras, and construct the space of the current scene according to the coordinates and height model; when one or more positioning cameras detect the target object, the current position information of the target object is obtained according to the space model as a reference object: according to the entry and exit trajectory of the first appearance scene of the target object. The first moving trajectory is obtained to realize the tracking and positioning of the target object.

The embodiment of the present disclosure adopts the multi-camera multi-target detection point method for positioning and tracking, realizing positioning visualization and more accurate positioning. Multi-camera and multi-view fusion detection can obtain the complete movement track of the target object Compared with the traditional base station and pulse Target positioning, the technical solution of the embodiment of the present disclosure is easy to deploy, can be deployed and installed on the original surveillance camera, and the positioning is contactless and has no fixed equipment restrictions.

### R5-27-70—Algorithm Cluster Service for Smart City Management.

Urban management has always been an important part of smart cities. Traditional management methods rely on complaints from the masses, letters and visits, and media reports. The urban management department is actually very passive in discovering and solving problems, and there is no early warning for some urban problems. In addition, various departments There may also be some integration and communication issues. For some core problems of urban management, such as road occupation, vehicle occupation, illegal parking of vehicles, garbage piled up on the street, loss of manhole covers, etc. it is difficult for the urban management department to find these problems in a short time, which leads to the messy appearance of the entire city, which is not conducive to Social development.

In view of the above technical problems, the embodiment of the present disclosure provides algorithm cluster services for smart urban management.

The embodiment of the present disclosure introduces a series of AI vision algorithms to assist urban management personnel to quickly find problems. It includes all computer vision algorithms required by urban management, and is used to solve the difficulty of obtaining evidence, many and scattered violations, high cost: low efficiency of manual inspection, difficult traceability: no early warning in ordinary monitoring, difficult decision-making, no analysis of data statistics question.

Exemplarily, the algorithm cluster service of the smart city management provided by the embodiment of the present disclosure, the algorithm cluster service includes: detecting the relevant information of the core problems existing in the city through the AI visual algorithm; uploading the relevant information to the management platform; the The management platform feeds back the related information to the managers.

Further, the AI vision algorithm includes: road occupancy business recognition algorithm, motor vehicle road occupancy recognition/vehicle illegal parking recognition algorithm, street garbage recognition algorithm and manhole cover recognition algorithm.

Furthermore, the core problems include: road occupation, vehicle occupation, illegal parking of vehicles, garbage piled on the street, and loss of manhole covers.

Further, the road-occupied business identification algorithm is based on artificial intelligence visual analysis technology to detect the road-occupied business of small vendors in the designated area, platform.

Further, the motor vehicle occupancy recognition/vehicle illegal parking recognition algorithm can automatically detect the license plate of the illegally parked vehicle when the vehicle enters the illegal parking area or illegally occupies the road, number, and upload the license plate number of the illegally parked vehicle and the picture of the illegally parked vehicle on site to the management platform.

Further, the street garbage recognition algorithm is based on calculation and deep learning of urban street garbage detection, automatically recognizes street garbage piles through cameras, and uploads the placement of street garbage to the management platform.

Further, the manhole cover recognition algorithm is based on artificial intelligence visual analysis technology, which automatically detects manhole covers on urban roads, and if a manhole cover is missing is detected, the information about the manhole cover missing is uploaded to the management platform.

Further, the AI vision algorithm also includes: out-of-store business algorithm, road-occupancy business algorithm, illegal stall setting algorithm, clutter stacking algorithm, illegal umbrella opening algorithm, illegal outdoor advertising algorithm, street hanging algorithm. Exposed garbage algorithm, garbage bin overflow algorithm, non-motor vehicle random parking algorithm, banner slogan detection algorithm, motor vehicle random parking algorithm, manhole cover abnormality detection algorithm, license plate recognition algorithm.

The scheme of the embodiment of the present disclosure is described in detail below: through a series of AI vision algorithms to detect the relevant information of the existing core problems, upload the relevant information to the management platform, and the management platform will feed back the relevant information to the management personnel, so After receiving the relevant information, the management personnel can solve the core problem in the first time.

Wherein, the AI vision algorithm includes: road occupancy business recognition algorithm, motor vehicle road occupancy recognition/vehicle illegal parking recognition algorithm, street garbage recognition algorithm and manhole cover recognition algorithm. The core problems mentioned include: road occupation, vehicle occupation, illegal parking of vehicles, street garbage piles, and loss of manhole covers.

Further, the road-occupied business identification algorithm is based on artificial intelligence visual analysis technology to detect the road-occupied business of small vendors in the designated area, platform, the management platform feeds back the road-occupying operation situation to the urban management personnel, and the road-occupying operation identification algorithm can enable the urban management personnel to know the road-occupying operation situation in a timely manner, and assist the urban management personnel to strengthen the urban management system, management and improve the efficiency of law enforcement.

Further, the motor vehicle occupancy recognition/license plate illegal parking recognition algorithm is aimed at districts, industrial parks, roadside parking, fire exits and other areas. When a vehicle enters an illegal parking area or illegally occupies a road, the motor vehicle occupies Recognition/vehicle illegal parking recognition algorithm can automatically detect the license plate number of the illegally parked vehicle, and upload the license plate number of the illegally parked vehicle and the picture of the vehicle parked illegally to the management platform, and the management platform will feed back the vehicle picture to. The management personnel are convenient for the urban management personnel to deal with illegally parked vehicles or motor vehicle lane-occupied behaviors in a timely manner.

Further, the street garbage recognition algorithm is an urban street garbage detection based on calculation and deep learning, automatically recognizes street garbage piles through cameras, and uploads the placement of street garbage to the management platform, and the management platform will. The situation is fed back to the management personnel, which provides convenience for the urban municipal managers to effectively arrange clean-up personnel.

Further, the manhole cover recognition algorithm is based on artificial intelligence visual analysis technology, which automatically detects manhole covers on urban roads. If a manhole cover is missing, upload the missing information of the manhole cover to the management platform, and the management platform uploads the information Feedback to the management personnel in time, the management personnel can grasp the missing information of the manhole cover at the first time, deal with it in time, and effectively prevent the occurrence of safety accidents.

Among them, the AI vision algorithm also includes: out-of-store business algorithm, road-occupancy business algorithm, illegal stall-setting algorithm, clutter-stacking algorithm, illegal umbrella-holding algorithm, illegal outdoor advertising algorithm, street-hanging algorithm, exposure Garbage algorithm, garbage bin overflow algorithm, non-motor vehicle random parking algorithm, banner slogan detection algorithm, motor vehicle random parking algorithm, manhole cover abnormality detection algorithm, license plate recognition algorithm.

Compared with related technologies, the embodiments of the present disclosure use a series of AI visual algorithms to detect relevant information of core problems, upload the relevant information to the management platform, and the management platform feeds back the relevant information to the management personnel, so after receiving the relevant information, the management personnel can solve the core problem in the first time.

The embodiment of the present disclosure includes all computer vision-oriented algorithms required by urban management, and is used to solve the difficulty of obtaining evidence: many and scattered violations, high cost, low efficiency of manual inspection, difficult traceability: no early warning in ordinary monitoring, difficult decision-making; data statistics No analysis. Give full play to the functions of the algorithm middle platform and algorithm library in the embodiment of the present disclosure. Cover every scene. For example, in different scenarios such as smart parks, streets, and schools, different algorithms are installed to effectively manage urban management.

### R5-28-71—Data Search System Based on ElasticSearch and Faiss.

Nowadays, social network information is developed, and the Internet is used everywhere in life. In back-end business scenarios, you often encounter scenarios that need to be searched. For example, users will search log information, which includes text information and image information. Most other products in related technologies only consider the characteristics of ElasticSearch, and search based on word frequency, but ElasticSearch cannot search according to the meaning of words or the content meaning of pictures.

Based on the above technical problems, the embodiment of the present disclosure combines ElasticSearch and Faiss, adopts multiple acceleration methods, and can retrieve various data on hundreds of millions of data sets within milliseconds Adding Faiss can make the search more accurate. During the search process, not only can obtain word meaning search results instead of simple keyword matching results; but also fall back to the keyword search scheme in the case of no suitable result found in word meaning search.

Exemplarily, as shown in FIG. 71-1 to FIG. 71-4, an embodiment of the present disclosure provides a data retrieval system based on ElasticSearch and Faiss. The data retrieval system includes: acquiring information input by a user; Judging the input type of the information; selecting a query scheme according to the input type; outputting a query result according to the query scheme.

Wherein, the step of selecting a query scheme according to the input type includes: if the input type is text input, then enter the query in combination with ElasticSearch and Faiss; if the input type is image input, then use the VGG network to extract the features of the image and then enter Faiss Inquire.

Wherein, the text input includes word meaning and keywords, if the input type is text input, then the step of entering the query in combination with ElasticSearch and Faiss includes: if no suitable result is found in the word meaning search, then fall back to the keyword word to search.

Wherein, the core principle of Faiss includes inverted index IVF and product quantization PQ; the product quantization PQ includes clustering and quantization.

The scheme of the embodiment of the present disclosure is described in detail below in conjunction with FIGS. 71-1 to 71-4; the scheme of the embodiment of the disclosure is based on ElasticSearch and Faiss for data search, since most products in the related art only consider the characteristics of ElasticSearch, and based on Search by word frequency, ElasticSearch cannot search according to the meaning of words or the content of pictures, so the embodiments of the present disclosure combine ElasticSearch and Faiss to use multiple acceleration methods to search for data.

Exemplarily, firstly, the data input by the user is collected, and the information input by the user is acquired.

The input type of the information is judged according to the information.

A query scheme is selected according to the input type.

Output corresponding query results according to the query scheme.

Wherein, the step of selecting a query scheme according to the input type includes, if the input type is text input, then enter the query in combination with ElasticSearch and Faiss; if the input type is image input, then use the VGG network to extract the features of the image and then enter Faiss Inquire.

In the embodiment, if the user input is text, the system will automatically query and search the text in combination with ElasticSearch and Faiss, if the user input is a picture, the system first extracts the features of the picture through the VGG network and then enters Faiss for query. And output the query results after summarizing.

Among them, as shown in FIG. 71-1. Faiss is a framework that provides efficient similarity search and clustering for dense vectors Its working principle is built around the index type that stores a set of vectors, and provides a function to use L2 and/or dot product vector comparisons to search in them. The core principles of Faiss include inverted index IVF (Inverted File System) and product quantization PQ (Product Quantization), wherein the core idea of product quantization PQ is clustering, including clustering (Cluster) and quantization (Assign) This principle is the main means for Faiss to achieve high speed, less memory and precise retrieval.

As shown in FIG. 71-2, for the principle of inverted index IVF, for example, the row index comes from the need to find records based on the value of the attribute in practical applications. Each item in this index table includes an attribute value and the address of each record having the attribute value, the attribute value is not determined by the record, but the position of the record is determined by the attribute value.

VGG was proposed by the Visual Geometry Group of Oxford. The full name of VGG is Visual Geometry Group. It can increase the depth of the network and affect the final performance of the network to a certain extent. VGG consists of 5 convolutional layers, 3 fully connected layers, and softmax. The output layer is composed of layers separated by max-pooling, and the activation units of all hidden layers use the ReLU function. VGG uses multiple convolution layers with smaller convolution kernels (3×3) instead of one convolution layer with larger convolution kernels. On the one hand, it can reduce parameters, on the other hand, it is equivalent to more nonlinear mapping, which can increase. The fitting/expressive power of the network. VGG achieves the same performance by reducing the size of the convolution kernel (3×3) and increasing the number of convolution sub-layers.

Wherein, the text input includes word meaning and keywords, if the input type is text input, then the step of entering the query in combination with ElasticSearch and Faiss includes: if no suitable result is found in the word meaning search, then fall back to the keyword word to search. In the embodiment, the addition of Faiss can make the search more precise, and various data on trillion-level data sets can be retrieved within milliseconds.

Finally, a data search system based on ElasticSearch and Faiss.

Compared with related technologies, the embodiment of the present disclosure combines ElasticSearch and Faiss, and adopts multiple acceleration methods (CPU, GPU acceleration). Compared with the characteristics of a single ElasticSearch, adding Faiss can make the search more accurate and the search speed faster. Most other products only consider the characteristics of ElasticSearch, search based on word frequency, and cannot search according to the meaning of words or the content of pictures.

The technical solutions of the embodiments of the present disclosure can not only obtain word meaning search results instead of simple keyword matching results; but also fall back to the keyword search solution when no suitable result is found in the word meaning search.

### R5-29-72—Face Search System Based on Milvus.

Nowadays, with the rapid development of science and technology and the development of network information, face search technology is gradually applied in people's lives. For example, missing children can be found all over the Internet through face search technology. However, the related technology is a general-purpose image search technology, and the traditional machine learning method was used to extract the vector, and the operation is complicated.

The embodiment of the present disclosure utilizes Milvus to construct a face search system, and combines Milvus with the scene of face search to retrieve various data on a trillion-level data set within milliseconds, making face search easier.

Exemplarily, as shown in FIG. 72-1, the Milvus-based face search system provided by the embodiment of the present disclosure includes: determining the face image information to be retrieved; face image;

Output the face image similar to the face image to be retrieved to the list of similar faces; wherein, the step of detecting each face image to be queried based on the face image database to be queried comprises: using MTCNN to complete the face detection function, InsightFace completes the function of face feature extraction, and then uses Milvus to complete the similarity retrieval of face feature vectors.

Wherein, the step of using MTCNN to complete the face detection function includes: extracting the face boundary and key points of the face in the face image by cascading three networks of PNet, RNet, and ONet; the key points of the face include: : Eyes, nose, corners of mouth and ears. The scheme of the embodiment of the present disclosure will be described in detail below with reference to FIG. 72-1: the embodiment of the present disclosure uses Milvus to build a face search system, and combines Milvus with the scene of face search to make face search easier Determine the face image information to be retrieved; detect based on each face image to be queried in the face image database to be queried, output the face image similar to the face image to be retrieved to a list of similar faces; wherein, the face Recognition usually includes three links: face detection, face feature extraction, and face feature comparison. Face detection is a link in the complete process of face recognition. The face recognition system first uses a camera to collect images or video streams containing faces, and then uses face detection technology to detect the position of faces, locate key points of facial features, and extract faces, and then perform face image preprocessing and face feature extraction. Facial feature extraction refers to the comparison that mainly relies on facial characteristic values. The so-called characteristic value is the information set composed of facial features. Face comparison is to compare the similarity of the face feature vectors extracted by the deep learning model. The characteristic values extracted from different photos of the same person are very close in the feature space; on the contrary, the characteristic values extracted from different photos of the same person are far away in the feature space. Further, the step of detecting each face image to be queried based on the face image database to be queried comprises:

Use MTCNN to complete the face detection function, InsightFace to complete the function of face feature extraction, and then use Milvus to complete the similarity retrieval of face feature vectors. In the embodiment, MTCNN is used to detect and recognize the human face first, and the recognized face image is extracted using InsightFace to extract the features of the human face, and then Milvus is used to complete the similarity retrieval of the human face feature vector, and finally the similarity conforms to. The requested face images are output to a list of similar faces Among them, MTCNN (Multi-task Cascaded Convolutional Networks) refers to the face detection algorithm, which is written in the TensorFlow framework. The MTCNN model is a multi-task network, which is cascaded through three networks: PNet, RNet, and ONet. InsightFace is an open source face recognition library based on MXNet. Milvus supports the use of various AI models to vectorize unstructured data and provides search and analysis services for vector data. It can handle business including image processing, machine vision, natural language processing, speech recognition, recommendation system and new drug discovery Exemplary, the implementation method is: convert unstructured data into feature vectors through the deep learning model, and import them into the Milvus library, store and index the feature vectors, and return vectors similar to the input vectors after receiving the user's vector search request the result of.

Wherein, the step of using MTCNN to complete the face detection function includes: extracting the face boundary and key points of the face in the face image by cascading three networks of PNet, RNet, and ONet; the key points of the face include: Eyes, nose, corners of mouth and ears. In the embodiment, by detecting the boundary of the human face and the key points of the human face, the image of the human face can be quickly acquired, so as to complete the detection of the human face.

Compared with related technologies, the embodiments of the present disclosure combine Milvus with the scene of face search, and can retrieve various data on trillion-level data sets within milliseconds. In the process of face search in the embodiment of the present disclosure, by using MTCNN to complete the face detection function, InsightFace completes the function of face feature extraction, and then uses Milvus to complete the similarity retrieval of face feature vectors, the effect of fast search can be achieved. Can make face search easier.

### R5-30-73—Intelligent Search Service Based on Knowledge Graph.

Smart cities, forest firefighting, environmental pollution control, etc. based on deep learning cannot intuitively provide some information that users are concerned about in the process of result presentation and result demonstration. If you want to trace the source of the relevant pollution discharge exceeding the standard, you need to lock the relevant pollution-affected areas, then lock the pollution sources, and then screen the main contribution of the pollution sources to the target enterprises, resulting in poor control effects on issues that need attention.

Based on the above existing problems, the intelligent search service based on the knowledge map provided by the embodiments of the present disclosure is based on NLP semantic analysis and the knowledge map, and implements a question-and-answer search method. Establish a semantic relationship network for the search target, not only to retrieve keywords for the problem, but to analyze and understand the semantics, and then normalize the query description, and return the result after matching the knowledge base.

The embodiments of the present disclosure construct time-sensitive result retrieval of the knowledge graph, greatly improve the retrieval rate, and provide other highly relevant search information.

Exemplarily, as shown in FIG. 73-1 to FIG. 73-3, an intelligent search service based on a knowledge map provided by an embodiment of the present disclosure includes, obtaining a query requirement of a user; cutting the query requirement word analysis, and put it into BILSTM to obtain the preliminary score; put the preliminary score into the CRF part for summary, and analyze the customer's appeal; search the knowledge map according to the appeal, and feedback the result. Wherein, the construction step of the knowledge map includes: collecting initial data for constructing the map; integrating the initial data and putting them into natural language processing, performing word segmentation and labeling, and clarifying the meaning of words in each context. Perform knowledge extraction tasks on the word meanings, perform knowledge fusion, store the extracted knowledge and eliminate conflicts; knowledge processing, build ontology targets, model them, establish relationship networks between entities, and form a structured knowledge system; process. The final knowledge network is stored in the Nebula Graph database, and a corresponding relational database is built to provide management.

Among them, the steps of collecting the initial data for constructing the map include: for structured data, directly analyze data integration to obtain extracted knowledge; for semi-structured data and unstructured data, after cleaning and labeling, put into data integration and knowledge extraction. Wherein, the knowledge extraction task performed on the processed word meaning includes: entity recognition, relationship extraction and event extraction.

The solutions of the embodiments of the present disclosure will be described in detail below in conjunction with FIGS. 73-1 to 73-3. Exemplarily, the intelligent search service based on the knowledge map provided by the embodiments of the present disclosure includes: obtaining the user's query requirements. Perform word segmentation analysis on the query requirements, and put them into BilSTM to obtain preliminary scores; put the preliminary scores into the CRF part for summarization, and analyze customer demands; retrieve the knowledge graph according to the demands, and feed back the results.

In an embodiment, the user inputs a query requirement, and by obtaining the query requirement of the user, word segmentation analysis is performed on the query requirement, that is, the sentence in the requirement is segmented in and out, the word is segmented, and the segmented word is put into BILSTM obtains a preliminary score, and all the scores output by the BILSTM layer will be used as the input of the CRF layer. The category with the highest score in the category sequence is the final result of our prediction, and the preliminary score is put into the CRF part for summarization and analysis of customer demands, and finally retrieve the knowledge map according to the request, and feedback the result to the user.

Among them, the full name of BILSTM is Bi-directional Long Short-Term Memory. Due to its design characteristics, LSTM is very suitable for modeling time series data, such as text data. BILSTM is a combination of forward LSTM and backward LSTM. The biLSTM-CRF model is mainly composed of the Embedding layer (mainly word vector, word vector and some additional features), the bidirectional LSTM layer, and the final CRF layer. The experimental results show that BiLSTM-CRF has reached or surpassed the CRF model based on rich features, and has become the most mainstream model in the NER method based on deep learning.

Wherein, the construction step of the knowledge graph includes collecting initial data for constructing the graph, integrating the initial data and putting it into natural language processing (NLP), performing word segmentation and labeling, and clarifying the meaning of words in each context. Perform knowledge extraction tasks on the processed word meanings; perform knowledge fusion, store the extracted knowledge and eliminate conflicts; knowledge processing, build ontology targets, model them, establish relationship networks between entities, and form a structured knowledge system; Store the processed knowledge network in the Nebula Graph database, and build a corresponding relational database to provide management.

Among them. Nebula Graph is an open source, distributed, and easily scalable native graph database that can carry ultra-large-scale datasets with hundreds of billions of points and trillions of edges, and provide millisecond-level queries.

In an embodiment, when constructing the knowledge graph, the initial data required for constructing the graph is first collected, wherein the step of collecting the initial data for constructing the graph includes: for the structured data, directly analyze the data integration to obtain the extracted knowledge; After cleaning and labeling semi-structured and unstructured data, put into data integration and knowledge extraction. After the initial data is integrated, put it into natural language processing (NLP), perform word segmentation and labeling, and clarify the meaning of words in each context.

Among them. Natural Language Processing (Natural Language Processing, referred to as NLP) is to use computers to process, understand and use human languages (such as Chinese, English, etc.), which belongs to a branch of artificial intelligence and is an interdisciplinary subject of computer science and linguistics. Also often referred to as computational linguistics.

An extraction task is performed on the processed word meaning, wherein the content of the knowledge extraction task on the processed word meaning includes: entity recognition, relation extraction and event extraction. Exemplary, the object recognition, exemplary, if Beijing is the capital of China, then “Beijing” is an entity: the relationship extraction, exemplary, if Beijing is the capital of China, then “Beijing” is equivalent to the relationship “Chinese capital”; The event extraction refers to the extraction of events and happenings.

Perform knowledge extraction tasks on the processed word meanings; perform knowledge fusion, store the extracted knowledge and eliminate conflicts; knowledge processing, build ontology targets, model them, establish relationship networks between entities, and form structured knowledge system; store the processed knowledge network in the Nebula Graph database, and build a corresponding relational database to provide management.

In view of the existing problems, the embodiment of the present disclosure first obtains knowledge, prepares the requirements for the establishment of the initial knowledge map, refines and aggregates the data, makes a structured statement, and stores it in the Nebula Graph series relationship to form a map, combined with NLP semantic analysis, understand the user input requirements, and accurately retrieve the map to return the results.

The embodiments of the present disclosure implement result retrieval by constructing a knowledge map, which greatly improves the retrieval rate and can provide other highly relevant search information.

Digital twin middle platform, including technology numbered R6-1.

The digital twin platform provides urban 3D twin services for the artificial intelligence business platform based on the dynamic sensor data of different industries and locations uploaded from multi-mode heterogeneous networks. The CIM, AR, VR, BIM, GIS, etc. required by the artificial intelligence business platform all require the support of the digital twin platform.

At the same time, the data generated by the modification and definition of maps, layers, key points, etc. in the digital twin platform will also be fed back to the data intelligent fusion platform and stored in the corresponding theme/theme library.

The implementation of the digital twin platform of the support layer in the embodiment of the present disclosure will be described in detail below in conjunction with exemplary embodiments.

### R6-1-74—Digital Twin Center.

Data Center is a set of sustainable “enabling enterprise data to be used” mechanism. It is a strategic choice and organizational form. It is based on the company's unique business model and organizational structure, supported by tangible products and implementation methodologies. A set of mechanisms that continuously turns data into assets and serves the business Products in the current related technologies lack the ability to synchronize and map operations between various types of physical devices and twin models; lack a mid-platform architecture that provides general capabilities for digital twins; lack unified management of AR engines, VR engines, and CIM visualization engines. The ability to integrate publishing and provide services.

Based on the above technical problems, embodiments of the present disclosure provide a digital twin platform to provide support for CIM, AR, VR, BIM, GIS, etc. required by an artificial intelligence business platform.

The digital twin platform provided by the embodiments of the present disclosure provides urban three-dimensional twin services for the artificial intelligence business platform based on the dynamic sensor data of different industries and different locations uploaded by multi-mode heterogeneous networks. At the same time, the data generated by the modification and definition of maps, layers, key points, etc. in the digital twin platform will also be fed back to the data intelligent fusion platform and stored in the corresponding theme/theme library.

Exemplarily, the embodiments of the present disclosure provide synchronization and operation mapping capabilities between various types of physical devices and twin models; provide a middle-end architecture and implementation methods for general capabilities of digital twins, provide extension technologies for capability engines and multiple Dimensional performance-balancing technical architecture; provides the capabilities of AR engine, VR engine, and CIM visualization engine for unified management, integrated release and service provision.

Exemplarily, as shown in FIG. 74-1 to FIG. 74-5, the digital twin middle platform provided in an embodiment of the embodiment of the present disclosure is a middle platform that provides unified digital twin services, and provides CIM for business systems Model engine support and interaction layer docking Contains the following parts:

CIM data access, CIM mapping, CIM management platform, capability engine, service interface, interactive interface; the steps are as follows: Step 1: CIM access unit accesses data from the real scene, cleans and stores it and provides it to the CIM management platform Step 2: The CIM management platform establishes a BIM model library according to the data accessed, establishes a model library such as a GIS database, and includes but is not limited to adding, deleting, changing, checking, taking effect, deploying, publishing, and downloading the library files. Rack operations; Step 3: The CIM management platform transmits the model data to the capability engine unit, and the capability engine performs operations such as rendering, layering, and publishing on the model; Step 4: Provides the digital twin display and interaction for the business system through the service interface Interface; step 5: connect the VR device and the AR device through the interactive interface, and perform model and scene display and interactive docking; step 6: CIM mapping classifies, processes, and maps the interactive operations in step 5 to the physical device. Form a closed loop of digital twins.

Wherein, the CIM data access is to access objective data of real scenes, and the objective data includes geographic information, altitude information, sensor information, and the like. The steps include the following: Step 1: Static data access, accessing the static data required by the model, including but not limited to geographic information, altitude information, zoning information, model height, area, material and other static data;

Step 2. Dynamic data access, data dynamic data combined with CIM access from IoT devices, including but not limited to real-time temperature and humidity data, meteorological data, noise data, environmental monitoring data, geographic location data, voice and video data, fire alarm data, intrusion alarm data, etc. Step 3: Perform data cleaning on the accessed static data and dynamic data, and remove abnormal data in the data; Step 4: Classify the accessed data according to type. Grading. Facilitate the processing and transformation of data in the following links. Step 5: Standardize the data in different formats at the same latitude and unified standard format; Step 6: Establish configuration rules for CIM data and take effect of the rules, which can be used for data in different. The dimension triggers the alarm level, and the configuration rules facilitate the next step to convert the data into CIM; Step 7: CIM data conversion converts the data processed by the rules into model parameters, which facilitates the automatic generation of models.

Wherein, the management platform is a platform for unified management of BIM model library files, and its steps are as follows: Step 1 access dynamic data from CIM data and data required for building models; Step 2: GIS data access, marking, storage. Do the processing before building the model; Step 3: Build the model according to the imported GIS data, and build the model according to the imported model file; Step 4. Create the model file, and store, modify, add, delete. Operations such as replacement, model file management; Step 5: According to the needs of the scene, combine and select models to take effect, then push the selected model combination into the capability for processing. Wherein, the capability engine provides the capability of rendering, layering, processing and releasing the model of the CIM management platform.

The steps are as follows: Step 1: Import the model file of the CIM management platform; Step 2: Call the CIM visualization engine to publish the CIM model. The CIM visualization engine includes but is not limited to epidemic performance management, interaction management, layer management, rendering Effect management and other functions; Step 3: For AR data, call the AR engine for services. The AR engine includes but not limited to functions such as recognition performance detection, large-capacity gallery, cloud recognition service, etc.; Step 4: For VR data, call the VR engine. For services, the VR engine includes but is not limited to components such as access engine, file encoding processing, and VR renderer; Step 5. For the above-mentioned three types of engines, CIM visualization engine, AR engine, and VR engine provide external interface services, and can provide. The visual display interface and interactive interface of CIM can provide AR device interface interactive services and VR device interface interactive services.

Wherein, the CIM mapping provides mapping capabilities of interactive pages and interactive devices. The steps are as follows: Step 1: Obtain interactive data including but not limited to VR devices, AR devices, and interactive pages through the model interface; Step 2: Classify model operations, and classify the operations connected to the model; Step 3. Classify Step 2 The completed operation corresponds to the mapping relationship and is mapped to the corresponding entity operation instruction; Step 4. Transfer the instruction of the entity operation through the interface of the IoT device; Step 5: Implement the mapping operation transferred out through the interface on the IoT device. Form a closed loop of mapping operations.

The scheme of the embodiment of the present disclosure is described in detail below in conjunction with FIG. 74-1 to FIG. 74-5: the embodiment of the present disclosure is based on the dynamic sensor data of different industries and different locations uploaded by the multi-mode heterogeneous network, and provides the artificial intelligence service platform with city 3D twin services, CIM, AR, VR, BIM, GIS, etc. required by the artificial intelligence business platform all require the support of the digital twin middle platform. At the same time, the data generated by the modification and definition of maps, layers, key points, etc. in the digital twin platform will also be fed back to the data intelligent fusion platform and stored in the corresponding theme/theme library.

Exemplarily, the digital twin middle platform provided in an embodiment of the present disclosure is a middle platform that provides unified digital twin services, and provides CIM model engine support and interaction layer docking for business systems. Contains the following parts. CIM data access, CIM mapping, CIM management platform, capability engine, service interface, interactive interface;

Its steps are as follows: Step 1: The CIM access unit accesses data from the real scene, cleans and stores it and provides it to the CIM management platform; Step 2: The CIM management platform establishes a BIM model library according to the accessed data, and establishes a GIS Model libraries such as databases, and include but are not limited to adding, deleting, modifying, checking, taking effect, deploying, publishing, and removing operations on library files; step 3: the CIM management platform transmits model data to the capability engine unit. The capability engine performs operations such as rendering, adding layers, and releasing the model; Step 4: Provide the business system with a digital twin display and an interactive interface through the service interface: Step 5: Connect the VR device and the AR device through the interactive interface. Carry out model and scene display and interactive docking: Step 6 CIM mapping classifies, processes, and maps the interactive operations in Step 5 to physical devices to form a closed loop of digital twins. Therefore, the above describes a method for implementing a middle platform architecture that provides unified digital twin capabilities. Embodiments of the present disclosure are applicable to digital twin systems of various scales, and provide unified digital twin modeling, storage, management, publishing and other functions.

Wherein, the CIM data access is to access objective data of real scenes, and the objective data includes geographic information, altitude information, sensor information, and the like. The steps include the following: Step 1: Static data access, accessing the static data required by the model, including but not limited to geographic information, altitude information, zoning information, model height, area, material and other static data:

Step 2: Dynamic data access, data dynamic data combined with CIM access from IoT devices, including but not limited to real-time temperature and humidity data, meteorological data, noise data, environmental monitoring data, geographic location data, voice and video data, fire alarm data, intrusion alarm data, etc.; Step 3: Perform data cleaning on the accessed static data and dynamic data, and remove abnormal data in the data; Step 4: Classify the accessed data according to type. Grading. Facilitate the processing and transformation of data in the following links; Step 5: Standardize the data in different formats at the same latitude and unified standard format; Step 6: Establish configuration rules for CIM data and take effect of the rules, which can be used for data in different. The dimension triggers the alarm level, and the configuration rules facilitate the next step to convert the data into CIM; Step 7: CIM data conversion converts the data processed by the rules into model parameters, which facilitates the automatic generation of models.

It should be noted that the embodiments of the present disclosure are suitable for docking various types of objects including but not limited to temperature and humidity equipment, meteorological equipment, noise equipment, environmental monitoring equipment, geographic location equipment, audio and video equipment, fire alarm equipment, and intrusion alarm equipment. Internet-connected devices, and perform twinning and interaction mapping of IoT devices.

Wherein, the management platform is a platform for unified management of BIM model library files, and its steps are as follows:
Step 1: Access dynamic data from CIM data and data required for building models;
Step 2: GIS data access, labeling, storage, and processing before building a model;
Step 3: Models can be established based on imported GIS data, or based on imported model files.
Step 4: Establish the model file, and perform operations such as storage, modification, addition, deletion, and replacement, and manage the model file;
Step 5: According to the needs of the scene, combine and select models to take effect, then push the selected model combination into the capability for processing.

The embodiment of the present disclosure provides an extension technology of a capability engine and a multi-dimensional performance balancing technology architecture, wherein the capability engine provides the capability of rendering, layering, and post-processing the models of the CIM management platform. The steps are as follows:
Step 1: Import the model file of the CIM management platform;
Step 2: For CIM models, call the CIM visualization engine to publish. The CIM visualization engine includes but not limited to epidemic performance management, interaction management, layer management, rendering effect management and other functions;
Step 3: For AR data, call the AR engine to provide services. The AR engine includes but is not limited to recognition performance detection, large-capacity gallery, cloud recognition service and other functions;
Step 4: For VR data, call the VR engine to provide services. The VR engine includes but not limited to access engine, file encoding processing. VR renderer and other components;
Step 5: For the above-mentioned three types of engines, CIM visualization engine, AR engine, and VR engine provide external interface services, can provide CIM visual display interface, interactive interface, can provide AR device interface interaction service, and can provide VR device interface interaction Serve.

Therefore, the above describes the architecture of the AR engine, VR engine, and CIM visualization engine for unified management, integrated release and service provision capabilities. Embodiments of the present disclosure provide synchronization and operation mapping capabilities between various types of physical devices and twin models, wherein the CIM mapping provides interactive pages and interactive device mapping capabilities. The steps are as follows:
Step 1: Obtain interactive data including but not limited to VR devices, AR devices, and interactive pages through the model interface;
Step 2: Classify model operations, and classify the operations of model access;
Step 3: Classify the operations completed in Step 2, corresponding to the mapping relationship, and map to the corresponding entity operation instructions;
Step 4: Transfer the instruction of the entity operation through the interface of the IoT device;
Step 5: Implement the mapping operation transferred out through the interface on the IoT device to form a closed loop of the mapping operation.

Exemplarily, the embodiments of the present disclosure are applicable to deploying and providing services in various network environments such as private networks, public networks, and intranets; they are also applicable to various industries including but not limited to smart cities, smart emergency, smart environmental protection, smart public security. Information systems for industries such as smart education, smart forests, carbon sinks, smart transportation, city brains, smart parks, and smart municipalities.

Compared with related technologies, the embodiments of the present disclosure provide urban 3D twin services for the artificial intelligence business platform based on the dynamic sensor data of different industries and different locations uploaded by the multi-mode heterogeneous network. The CIM, AR, VR, BIM, GIS, etc. required by the artificial intelligence business platform all require the support of the digital twin platform.

The embodiment of the present disclosure realizes the synchronization and operation mapping capabilities between various types of physical devices and twin models; provides the middle platform architecture and implementation method of digital twin general capabilities; provides the expansion technology of the capability engine and multi-dimensional performance balance.

Technical architecture; and the ability to provide AR engine, VR engine, and CIM visualization engine for unified management, integrated publishing and service provision.

The digital twin middle platform provided by the embodiments of the present disclosure is based on the dynamic sensor data of different industries and different locations uploaded by multi-mode heterogeneous networks, and provides urban three-dimensional twin services for the artificial intelligence business platform. The CIM, AR, VR, BIM, GIS, etc. required by the artificial intelligence business platform all require the support of the digital twin platform. In this embodiment, the data generated by the modification and definition of maps, layers, key points, etc. in the digital twin platform will also be fed back to the intelligent data fusion platform and stored in the corresponding theme/theme library. The digital twin middle platform of the embodiment of the present disclosure provides synchronization and operation mapping capabilities between various types of physical equipment and twin models; provides the middle platform architecture and implementation method of digital twin general capabilities; provides the expansion technology of the capability engine and multiple Dimensional performance-balancing technical architecture; provides the capabilities of AR engine, VR engine, and CIM visualization engine for unified management, integrated release and service provision. Exemplarily, as shown in FIGS. 74-1 to 74-5, the digital twin middle platform provided in an embodiment of the present disclosure is a middle platform that provides unified digital twin services and provides a CIM model engine for business systems Support and interaction layer docking.

The above are only preferred embodiments of the embodiments of the present disclosure, and are not intended to limit the scope of protection of the embodiments of the present disclosure. Any equivalent structure or equivalent process transformation made by using the description of the embodiments of the present disclosure and the contents of the accompanying drawings, or the direct or indirect use of. In other relevant technical fields, they are all equally included in the protection scope of the embodiments of the present disclosure.

Artificial intelligence business platform layer, including technologies numbered R7-1 to R7-8 Display, analyze, predict, forecast, rehearse, etc. the data uploaded by multi-mode heterogeneous networks in different industries and different physical locations, provide artificial intelligence-based unified module component management and smart applications in different industries, and receive data from various supporting platforms. And feed back the operation information of the business end to each support platform. At the same time, some operational data can be dynamically adjusted according to industry requirements or/and physical location, and sent to the terminal through the communication layer to realize linkage.

The implementation manner of the artificial intelligence service platform layer of the support layer of the embodiments of the present disclosure will be described in detail below in conjunction with exemplary embodiments.

### R7-1-75—Artificial Intelligence Unified Module Component Management Platform.

With the continuous change of business requirements, the complexity of system services increases, and the iteration speed gradually slows down. The overall performance of existing products becomes difficult to maintain and improve, resulting in system lag; In the business scenario, there are many tasks that cannot be closed-loop in the same system, the processes among the various systems in existing products are intricate, and in actual business scenarios, there are many tasks that cannot be closed-loop in the same system; the business in existing products There are a large number of common functions among the systems, repeated construction and waste of resources, low reuse rate of delivered projects, lack of solidification and precipitation of business core, and insufficient system flexibility.

In related technologies, account management of each application system is scattered and lacks a unified management mechanism. When users use each system, they need to memorize them according to different naming rules and password policies, and reconfigure them in the system. The operation is cumbersome and easy to cause Potential safety hazards; there is no mapping relationship between the real identity of the user and the application account, the application system authentication is independent, there is no unified authentication strategy, and there is no secure single sign-on mechanism; the existing products lack standardized and unified user authentication and operation logs, and cannot Backtracking, tracking and analyzing user's operation behavior; existing products have system fragmentation, data islands, and end-to-end real-time collaboration. Based on the above technical problems, in the embodiment of the present disclosure, the authentication gateway authorizes the authority of each business platform, and the technical middle platform provides the underlying technical configuration and micro-service technical support for the business system, and then the business middle platform flexibly implements different business scenarios. Extended configuration to achieve flexible and fast delivery.

Exemplarily, as shown in FIG. 75-1-FIG. 75-4, the artificial intelligence module component management platform provided by the embodiment of the present disclosure includes organization management module, user management module, role management module, authority management module, log Management module, thematic project module, and general component library module; the implementation steps include:
Step 1: After creating a user, support the combination of one-to-one, one-to-many, and many-to-many combinations of users and organizational structures;
Step 2: The relationship between the organizational structure and roles is combined in one-to-one, one-to-many, many-to-many and other combinations;
Step 3: If the relationship between the user and the role is many-to-many, assign the authority to the role, there is no need to assign authority to the user separately, and the user points to the corresponding role to have the authority corresponding to the role, simplifying the allocation and authority process;
Step 4: Support granting different permissions to the roles, including page permissions, operation permissions, and data permissions. There is a many-to-many relationship between permissions and the roles;
Step 5: For the data permissions, the resource group control can be realized based on the roles, and the data permissions are further refined based on the resource groups, so as to realize the refined permission management and control of each application.

Wherein, said creating a user includes the following steps:
Step 1: The user enters the registration information through the unified entrance, and registers to the unified registered user system after passing the verification;
Step 2: Create a virtual user terminal by the unified user management system, assign a uniquely identified new user number, and push it to the business system;
Step 3: The business system generates a virtual terminal according to the user number;
Step 4: The business system will create a successful message feedback and unify the user management system through log records.

Wherein, the login steps of the unified user include:
Step 1: The user enters the account password and sends a login request to the unified user management system;
Step 2: After the verification is successful, the unified user management system retums the user's unique number;
Step 3: Authorize the business system through the user's unique number to complete the login operation.

Wherein, the steps of the user inputting the account password and sending the login request to the unified user management system include:
Step 1. The front end sends a request through the unified entrance, and the service gateway filters the verification-free interface, and distributes the request that does not require authentication verification to the corresponding service;
Step 2: If the gateway determines that the request requires authentication verification, the gateway reads data from Redis to verify whether the user is logged in, and returns a 403 error code if the user is not logged in;
Step 3: After the user logs in and authorizes, the gateway requests the user microservice to verify whether the user has the corresponding interface path authority. If there is no authority, return error code 405 and end the request;
Step 4. If the user has the path authority of the corresponding interface, the elbow will asynchronously save the operation log and return the data at the same time;
Step 5: The service returns data and refreshes the token expiration time at the same time.

Wherein, the front end sends a request through a unified entrance, and the steps of filtering the verification-free system by the service gateway include:
Step 1. The user accesses each microservice node through the unified access portal on the web, and then through the gateway;
Step 2: The service gateway includes functions such as routing forwarding, API monitoring, authority control and current limiting;
Step 3. The registration center records the mapping relationship between services and service addresses for users in the micro-service architecture, saves the information of service providers and service consumers, and supports checking the health status of service providers;
Step 4: When the server of the service provider starts, register the service information, such as service address, mailing address, etc. with the registration center in the form of alias;
Step 5. When the service of the service consumer starts, it registers with the registration center and obtains a list of available services. Through the registration center, it obtains the actual service communication address of the designated service provider with the corresponding alias, and invokes the corresponding service.

Wherein, the implementation method also supports function access multiplexing in the form of micro-services, so as to achieve high cohesion and low coupling of the system. The steps include:
Step 1: It is necessary to keep the registration group information of the user service and the business service consistent.
Step 2. Use open feign for inter-service communication, and require business services and microservices to customize service names for convenient use when invoking. Step 3: Deploy user services and business services to the same registration center.

This disclosure supports code-level reuse and customized development to meet business needs in different scenarios. The steps are as follows: Step 1: Create a code branch of your own project through the code management tool. Step 2: Configure the data required by the business system through the page. Step 3: Secondary development can be carried out for the code. Note that backward compatibility must be maintained.

The following is a detailed description of the embodiments of the present disclosure in conjunction with FIG. 75-1 to FIG. 75-4.

The artificial intelligence unified module component management platform provided by an embodiment of the present disclosure can flexibly and quickly configure cross-application, cross-system, and cross-role projects through unified authentication, and establish a unified authentication center and cross-role projects from a business perspective. The authentication gateway, through a decentralized authentication method, solves the bottleneck of multiplexing and unification of permissions in various technical platforms and business platforms.

Exemplarily, the artificial intelligence unified module component management platform provided by the embodiment of the present disclosure includes: an organization management module, a user management module, a role management module, a rights management module, a log management module, a special project module, and a general component library module. Implementation steps include:
Step 1 After creating a user, support the combination of one-to-one, one-to-many, and many-to-many combinations of users and organizational structures;
Step 2. The relationship between the organizational structure and roles is combined in one-to-one, one-to-many, many-to-many and other combinations;
Step 3. If the relationship between the user and the role is many-to-many, assign the authority to the role. There is no need to assign authority to the user separately. The user points to the corresponding role and has the authority corresponding to the role, which simplifies the process of allocation and authority;
Step 4: Support granting different permissions to the roles, including page permissions, operation permissions, and data permissions. There is a many-to-many relationship between permissions and the roles;
Step 5: For the data permissions, the resource group control can be realized based on the roles, and the data permissions are further refined based on the resource groups, so as to realize the refined permission management and control of each application.

Wherein, said creating a user includes the following steps:
Step 1: The user enters the registration information through the unified entrance, and registers to the unified registered user system after passing the verification;
Step 2: Create a virtual user terminal by the unified user management system, assign a uniquely identified new user number, and push it to the business system,
Step 3: The business system generates a virtual terminal according to the user number; Step 4. The business system will create a successful message feedback and unify the user management system through log records.

Wherein, the login steps of the unified user include:
Step 1: The user enters the account password and sends a login request to the unified user management system;
Step 2: After the verification is successful, the unified user management system returns the user's unique number;
Step 3: Authorize the business system through the user's unique number to complete the login operation.

Wherein, the steps of the user inputting the account password and sending the login request to the unified user management system include:
Step 1: The front end sends a request through the unified entrance, and the service gateway filters the verification-free interface, and distributes the request that does not require authentication verification to the corresponding service;
Step 2: If the gateway determines that the request requires authentication verification, the gateway reads data from Redis to verify whether the user is logged in, and returns a 403 error code if the user is not logged in;
Step 3: After the user logs in and authorizes, the gateway requests the user microservice to verify whether the user has the corresponding interface path authority. If there is no authority, return error code 405 and end the request;
Step 4: If the user has the path authority of the corresponding interface, the elbow will asynchronously save the operation log and return the data at the same time,
Step 5: The service returns data and refreshes the token expiration time at the same time.

Wherein, the front end sends a request through a unified entrance, and the steps of filtering the verification-free system by the service gateway include:
Step 1: The user accesses each microservice node through the unified access portal on the web, and then through the gateway;
Step 2: The service gateway includes functions such as routing forwarding. API monitoring, authority control and current limiting,
Step 3: The registration center records the mapping relationship between services and service addresses for users in the micro-service architecture, saves the information of service providers and service consumers, and supports checking the health status of service providers;
Step 4. When the server of the service provider starts, register the service information, such as service address, mailing address, etc. with the registration center in the form of an alias;
Step 5: When the service of the service consumer starts, it registers with the registration center and obtains a list of available services. Through the registration center, it obtains the actual service communication address of the designated service provider with the corresponding alias, and invokes the corresponding service.

The disclosure supports function access multiplexing in the form of microservices, so as to achieve high cohesion and low coupling of the system. The steps include: Step 1: It is necessary to keep the registration group information of the user service and the business service consistent. Step 2: Use openfeign for inter-service communication, and require business services and microservices to customize service names for convenient use when invoking. Step 3: Deploy user services and business services to the same registration center.

This disclosure supports code-level reuse and customized development to meet business needs in different scenarios. The steps are as follows: Step 1: Create a new code branch of your own project through the code management tool. Step 2: Configure the data required by the business system through the page. Step 3: Secondary development can be carried out for the code. Note that backward compatibility must be maintained. The developed code can be deployed and used Among them. Redis is an open-source log type and Key-Value database written in ANSI C language, supporting network, memory-based and persistent, and providing APIs in multiple languages. Token means token (temporary) in computer identity authentication, and the full name of API is Application Program Interface (Interfacd).

The artificial intelligence business platform layer displays, analyzes, predicts, forecasts, and rehearses data uploaded by multi-mode heterogeneous networks in different industries and different physical locations, and provides artificial intelligence-based unified module component management and smart applications in different industries. The data of each supporting platform, and feed back the operation information of the business end to each supporting platform. At the same time, some operational data can be dynamically adjusted according to industry requirements or/and physical location, and sent to the terminal through the communication layer to realize linkage.

The embodiment of the present disclosure starts from a business perspective, establishes a unified authentication center and an authentication gateway, and solves the authority reuse and unification bottlenecks of various technical platforms and business platforms through a decentralized authentication method; for cross-industry applications Common functions, providing thematic components+plug-in components for functional standardization, unification, and reusable presentation, as the underlying modular component management platform, connecting various business middle platforms and technical middle platforms in series, forming a unified background management and operation dimension mode.

According to the business logic, the general functions of the actual business are stripped and abstracted, and each business module is independently decoupled and reconstructed into a standardized public module to achieve unified maintenance and management, reducing the complexity of application development, management and operation and maintenance, using micro-service technology Architecture, effectively splitting business, forming multiple small services with high cohesion and low coupling, and communicating with each other through a lightweight communication mechanism, supporting agile development and deployment, and realizing on-demand configuration and delivery.

The front end adopts a unified component design to reduce code coupling and dependency, and improve code reusability, scalability, and robustness; the platform uses the comprehensive model of role access control as the basis for authentication, and performs access control based on roles. Cross-management of modules such as application roles and resources satisfies multiple mapping relationships such as one-to-many and many-to-many, and improves system performance and scalability to cope with various complex scenarios involving permissions.

Provide plug-in services according to business scenarios, and provide external services through standardized interfaces According to changes in actual business scenarios, plug-ins are added and deleted in the form of patch packages, with strong portability and flexible structural adjustment; the technology center will package and package mature component resources and capabilities, and provide them to the business center in the form of interfaces and micro-services tower.

The business center adopts a decentralized architecture to split each business from the perspectives of basic master data, core business, and process rules to achieve asynchrony and automation. The traffic pressure is evenly shared among the modules, and the load is balanced.

Wherein, the organization management module is used for management and maintenance operations such as addition, modification, and deletion of organization information, and users can control data permissions by binding organization information, and the default data permissions can view all data under the corresponding organization.

The user management module is used for the management and maintenance operations of adding, modifying, and deleting user accounts; each user or user group must be bound to an organization and assigned one or more roles.

The role management module is used for adding, modifying and deleting roles, managing and maintaining operations, supporting process engine configuration, supporting associated resource groups for roles, and performing customized authority control.

The authority management user module controls resources such as menus and data, and supports granting different roles with customized authority at the smallest granularity.

The log management module is used to record and maintain account login and operation logs. The thematic project module includes multiple modules such as command and dispatch, streaming media video wall, algorithm configuration, data governance, data access, equipment operation and maintenance; each business module is decoupled from each other to form a service model with high cohesion and low coupling. It supports the combined configuration of each module, and authorized users can operate and access the specified thematic modules.

The general component library module is a common function of the business system, adopts a unified front-end design, and supports rapid configuration and development.

In a nutshell, the artificial intelligence business platform layer provided by the embodiments of the present disclosure displays, analyzes, predicts, forecasts, rehearses, etc. data uploaded by multi-mode heterogeneous networks in different industries and different physical locations, and provides artificial intelligence-based unified module components Management and smart applications in different industries, receive data from each support platform, and feed back business-side operation information to each support platform. At the same time, some operational data can be dynamically adjusted according to industry requirements or/and physical location, and sent to the terminal through the communication layer to realize linkage. Exemplarily, referring to FIG. 75-1 to FIG. 75-4, the artificial intelligence business platform layer provided by an embodiment of the present disclosure includes: organization management module, user management module, role management module, authority management module, log management module. Thematic project modules and common component library modules. Compared with related technologies, the embodiments of the present disclosure can flexibly and quickly configure cross-application, cross-system, and cross-role projects through unified authentication; through decoupling and stripping business modules, each independent module supports asynchronous development, reducing the occurrence of problems in the development process, improve the development efficiency; through the unified public technology module, the service is separated and formed, and when the service is needed again, it is completed through the interface call, avoiding the extension of the research and development cycle, saving development time and resource sampling business process, and encapsulating it into a public business process Modules can be reused directly when encountering the same business process scenario, reducing trial and error costs; solving the pain points of multiple project development links, different integration, and lack of unified development standards and operation and maintenance mechanisms; realizing the integration of technology, business, and data Applications can reduce R&D costs, achieve rapid business response, data accumulation, and performance improvement.

### R7-2-76—Map Measurement.

Map measurement refers to the study of the principles and methods of measuring and calculating the data of various elements on the ground on the map. The 3D map includes: surface measurement: according to terrain fluctuations, the length and area of the model surface change; space measurement European straight line distance or ellipsoid surface distance, cross-sectional area; space distance: very simple, calculate two points. The straight-line distance is enough; space area: take the middle point, or the center of mass, and form a triangle with each side. Calculate the area of each triangle. In the related art, when the map is measured, the geographical information such as coordinates, elevation, distance, and area cannot be obtained from the three-dimensional map. Based on the above technical problems, the map measurement provided by the embodiments of the present disclosure can determine the geographic coordinates or plane Cartesian coordinates of ground points, the distance and orientation between two points, and the like. Quantitative indicators and morphological concepts of related objects on the ground can be obtained through map measurement.

Exemplarily, as shown in FIG. 76-1 to FIG. 76-4, the map algorithm provided by the embodiments of the present disclosure includes, spatial distance measurement, ground-attached distance measurement, spatial area measurement, coordinate measurement, and triangulation measurement, wherein the The above measurement is realized by CesiumJS combined with elevation data and interpolation algorithm.

The embodiments of the present disclosure will be described in detail below in conjunction with FIGS. 76-1 to 76-4:

The map measurement provided by the embodiments of the present disclosure includes measuring the length, height, slope, angle, area, and volume of an object on a map, determining the geographic coordinates or rectangular coordinates of a ground point, the distance and orientation between two points, and the like. Quantitative indicators and morphological concepts of related objects on the ground can be obtained through map measurement, which is an important content of map use. The map algorithm provided by the embodiment of the present disclosure includes: spatial distance measurement, ground-attached distance measurement, spatial area measurement, coordinate measurement and triangulation measurement, wherein the measurement is realized by combining elevation data and interpolation algorithm with CesiumJS Among them, CesiumJS is an open source JS-based 3D map framework.

Wherein, the space distance measurement refers to measuring the space distance between map points and points, and the ground distance measurement refers to measuring the ground distance between map points and points in combination with terrain factors, and the space area measurement is. It refers to the measurement of the spatial area within a certain range on the map. The coordinate measurement refers to the measurement of the latitude and longitude of any point on the map. The triangulation measurement refers to the measurement of the coordinates, distance and slope between two points on the three-dimensional map.

Considering the height as shown in FIG. 76-1, calculate the spatial distance between two points. As shown in FIG. 76-2, it is equivalent to calculating the distance that a person actually needs to walk from the start point to the end point;

Calculate the area of the surface formed by multiple points in the three-dimensional coordinate system as shown in FIG. 76-3;

As shown in FIG. 76-4, measure the latitude, longitude, altitude and other information corresponding to the specified point.

The map measurement provided by the embodiment of the present disclosure directly calls the api of cesium and combines mathematical operations to obtain the result; the measurement of sticking to the ground needs to use an interpolation algorithm, combined with elevation data for measurement: it solves the problem of obtaining coordinates+HS: H8 from a three-dimensional map. Elevation, distance, area and other geographic information issues, realize the spatial distance, distance to the ground, spatial area, coordinates, height difference.

### R7-3-77—Path Planning.

The path planning based on road network and electronic map GPS navigation can be regarded as the path planning problem based on GIS (Geographical Information System). The solution to these problems is to extract the required road information from the complex data information, take the intersection as the node, and the road information as the path information, construct a complex path information topology network, and locate the starting point and the target point as the two nodes in this topology network, and then use the path search algorithm to optimize the shortest path planning.

Based on the above technical problems, the embodiment of the present disclosure converts the coordinates of the starting point and the end point into coordinates, combines with Gaode map planning, obtains a set of line coordinates, and then converts them into wgs coordinates applicable to cesium, and displays them on the 3D map to realize the path planning of the 3D map Function. Exemplarily, as shown in FIG. 77-1, the path planning provided by the embodiment of the present disclosure includes:

Specify two points as the start and end point;

generating a travel route between the two points;

Calculate the length of the route, and calculate the required time according to the set speed per bour. The embodiment of the present disclosure will be described in detail below in conjunction with FIG. 77-1:

In the embodiment of the disclosure, by converting the wgs coordinates of the starting point and the end point into gej coordinates, combined with the Gaode map planning api, a set of line gej coordinates is obtained, and then converted into wgs coordinates applicable to cesium, and the route planning of the three-dimensional map is realized on the three-dimensional map Function.

The path planning provided by the embodiment of the present disclosure includes: Specify two points as the start and end point;

generating a travel route between the two points:

Calculate the length of the route, and calculate the required time according to the set speed per hour. Route planning is the premise of navigation. According to the destination, departure point and route strategy settings, a travel plan is tailored for users. At the same time, it can be combined with real-time traffic to help users bypass congested roads and provide a more intimate and humanized travel experience. As shown in FIG. 77-1, specify two points as the starting point and the end point, generate a travel route between the two points, calculate the length of the route, and calculate the required time according to the set speed.

Among them. Cesium is an open source product for 3D earth and maps. It provides a development kit based on JavaScript language, which is convenient for users to quickly build a virtual earth web application with zero plug-ins, and has high-quality guarantees in terms of performance, accuracy, rendering quality, multi-platform, and ease of use. Through the JS API provided by Cesium, the following functions can be realized: global-level high-precision terrain and image services, vector and model data, temporal-based data visualization, support for multiple scene modes (3D, 2.5D and 2D scenes), the real 2D and 3D integration.

Compared with related technologies, the embodiment of the present disclosure converts the wgs coordinates of the start point and end point into gcj coordinates through the two-dimensional coordinate set and the three-dimensional coordinate set, and combines the Gaode map planning api to obtain the gej coordinate set of the line, and then converts it into the wgs coordinate applicable to cesium, displayed on the 3D map, which solves the path planning problem in the 3D map.

### R7-4-78—3D Heat Map Generation Method Based on 3D Map.

The heat map displays various data indicators in the corresponding area in a special highlighted form, which is used to display the geographical density distribution of the target elements, such as: population density analysis, population activity analysis, vehicle density analysis, etc. which are data. An important form of visualization Combined with the color distribution of the relevant legends of the heat map, it can very intuitively present some data that is not easy to understand or express, such as density, frequency, temperature, etc. so that the difference in data can be displayed intuitively.

At present, the map-based heat map can only be rendered on a flat map, and the heat map of each indicator cannot be displayed intuitively on a three-dimensional map, resulting in poor display effect of the map heat map.

Based on the above technical problems, an embodiment of the present disclosure provides a method for generating a 3D heat map based on a 3D map, which can display various indicators of a corresponding area on the 3D map in the form of a 3D heat map.

The disclosed embodiment is based on GIS (Geographic Information System, geographic information system) and WebGl (Web Graphics Library, a kind of 3D drawing agreement) technology, adopts CesiumJS+ (Cesium is a JavaScript library, is used to create in the Web browser that does not have plug-in 3D globe and 2D map), ArcGis Server+ (ArcGIS Server is a platform for building centralized management and supporting multi-user enterprise-level GIS applications.

ArcGIS Server provides a wealth of GIS functions, such as maps, locators and used in the central server. The software object in the application), the Kriging algorithm and other algorithms realize the beat map display of each index on the three-dimensional map.

The embodiment of the present disclosure uses a three-dimensional heat map generation method based on a three-dimensional map, which can visually display various indicators of the relevant geographical location, and can be used for visual display of weather, population distribution, housing prices, and areas where forest fires occur, and solves various indicators of the three-dimensional map Show the problem through the heat map, combined with the actual legend, you can intuitively get the required information from the heat map. The heat map generation method can be packaged into common tools and inserted into the toolbar of related software, so that it can be used and adjusted in the project, generated at any time, and easy to use.

Exemplarily, an embodiment of the present disclosure provides a method for generating a three-dimensional heat map based on a three-dimensional map, which can draw heat maps such as temperature, humidity, and rainfall that fit the terrain on the three-dimensional map, which includes the following steps:

Obtain the heat map of the specified map area according to the indicator data and the boundary coordinate set of the specified area;

The three-dimensional map of the designated map area is obtained, and the heat map is added to the corresponding area of the three-dimensional map in the form of an overlay.

Among them, when obtaining the heat map of the specified map area according to the indicator data and the specified area boundary coordinate set, it also includes:

Use CesiumJS+, ArcGis Server+, kriging algorithm, etc. to obtain a canvas (canvas) heat map that is consistent with the shape of the specified map area, and then render the canvas heat map into a three-dimensional beat map.

The embodiment of the present disclosure adopts the Web Worker tool for multi-thread calculation and rendering, and the obtained heat map is a three-dimensional heat map, and various indicators of the corresponding map area are displayed more intuitively through the three-dimensional heat map. Among them, before the step of obtaining the heat map of the specified map area according to the indicator data and the specified area boundary coordinate set, it also includes:

Obtain the corresponding indicator data of the specified map area, such as latitude and longitude data, temperature, humidity, rainfall, wind force, wind speed, etc Get the boundary coordinate set of the specified map area according to the latitude and longitude data.

Optionally, the method of generating the heat map includes;

Create a buffer zone for each discrete point in each heat map layer;

For the buffer of each discrete point, use a gradual gray scale to fill from the inside to the outside, from shallow to deep;

Indexed by the gray value of the fill, maps the corresponding color from the color ramp, and recolors the fill image according to the mapped color.

Exemplarily, the complete gray scale ranges from 0 to 255 gray scales, where 0 represents pure black and 255 represents pure white. The color in the middle gradually changes from black to white, that is, the larger the value, the brighter the color, and the whiter it appears in the gray scale. When coloring an image, it is possible to map colors from a ribbon of 256 colors (e.g. rainbow colors) and recolor the image to render a heatmap. In the embodiment of the present disclosure, the state of point density in the heat map layer is displayed by changing from cool color to warm color. In addition to reflecting the relative density of point elements (such as temperature, humidity, rainfall, wind force, wind speed, etc), the heat map layer can also represent the point density weighted according to attributes, so as to consider the contribution of the weight of the point itself to the density.

In one embodiment, when filling the buffer zone of each discrete point from the inside to the outside, from shallow to deep using a progressive gray scale, it includes:

In the area where the buffers intersect, the gray band is superimposed and filled, so the more the buffers intersect (such as intersect), the greater the gray value, and the “hotter” this area is During implementation, any channel in the ARGB (ARGB is a color mode, that is, an additional transparency channel is added to the RGB color mode) model can be selected as the superimposed gray value, that is, any color channel of red, green, and blue can be used as the superimposed gray value Value, colored by map.

Preferably, before the step of establishing a buffer zone for each discrete point in each heat map layer, it also includes:

Get the 3D map of the specified map area, and open the Alpha channel in the map. The Alpha channel is a transparent channel, which refers to the transparency and translucency of an image. The area with a larger gray value has lower transparency, and the gray value. The lower the area, the higher the transparency.

In the embodiment of the present disclosure, the heat map is a three-dimensional heat map of a dynamic grid. Further, when the three-dimensional map of the specified map area is obtained, the heat map is added to the corresponding area of the three-dimensional map in the form of an overlay. After the steps, also include:

When the map is zoomed, the heatmap scales accordingly. The three-dimensional curved surface heat map generated by the embodiments of the present disclosure is a dynamic grid surface, so that when the map is zoomed in or out, the three-dimensional curved surface is correspondingly enlarged or reduced, so as to be displayed synchronously according to changes in user operations. The embodiment of the present disclosure solves the problem of displaying the heat map of each index in the three-dimensional map Combined with the generated legend, the user can intuitively obtain the desired information from the heat map.

In the related technology, the heat distribution in a designated area is displayed in the form of a two-dimensional heat map, and the temperature, humidity, wind speed, light and other indicators in different areas can be visually judged through the heat layer, but this display method is not intuitive. In the related technology, the distance between the building and the ground is judged by the height thermal distribution, but this display method cannot be displayed according to the shape of the indicated object (such as terrain, the shape of the building, etc.), and this display method is still not intuitive.

The solution of the embodiment of the present disclosure includes: firstly, acquiring the corresponding index data of the specified map area, the index data can be collected by corresponding sensors, or directly call the data provided by relevant departments. If you need to display meteorological data, you can directly use the data published by the meteorological department to obtain the temperature, humidity, rainfall, wind force, and wind speed of the specified map area.

Afterwards, the canvas heat map with the same shape as the specified map area is obtained through the Kriging algorithm, and the Web Worker tool is used for multi-thread calculation and rendering, and the heat map is converted into a 3D heat map generation method based on a 3D map. The method displays the temperature, humidity, rainfall, wind force, and wind speed of the specified map area. Take the display of humidity as an example. The higher the humidity, the brighter warm color (such as red) is displayed on the top of the surface. The lower the humidity, the cooler color (such as blue) is displayed on the bottom or edge of the surface. The middle value can be represented by yellow.

Afterwards, the 3D map of the specified map area is obtained, and the Alpha channel in the map is turned on, so as to facilitate the extraction of the outline of the specified map area, and the corresponding terrain can be displayed in this way.

Then, add a 3D map-based 3D heat map generation method to the corresponding area of the 3D map in the form of an overlay, and finally draw the terrain-fitting temperature, humidity, and rainfall on the 3D map to generate a 3D heat map based on a 3D map method.

The thermal map generation method can be packaged into common tools and inserted into the toolbar of related software, so that it can be used and adjusted in the project. It can be used to display weather-related temperature, humidity, rainfall, wind force, and wind speed. Through various meteorological indicators. It is also used for forest fire prevention. For example, through the display of these indicators, it is possible to directly observe forest areas with low rainfall, high temperature, low humidity, and strong wind, and increase the monitoring frequency of related areas, so that the forest can be observed in time fire house. Not only that, but the embodiments of the present disclosure can also display indicators of various industries such as population density distribution, animal distribution, housing prices in various places, and the like.

Compared with related technologies, the embodiment of the present disclosure solves the problem of displaying the heat map of each index in the three-dimensional map, and adopts the display of the heat map of the three-dimensional curved surface, so that people can intuitively obtain the desired information from the map, and the embodiment of the present disclosure. It can be packaged into a common tool, which can be used and adjusted in projects, and is easy to operate.

### R7-5-79—Grid Refinement Management Method.

Forest fires not only lead to the imbalance of the forest ecosystem, the decline of forest biomass, the weakening of productivity, the reduction of beneficial animals and birds, and even the casualties of humans and animals. Not only the loss of forest fires is huge, but also the annual urban fires have caused casualties and huge property losses. Forests, cities, riversides, etc. have a wide area, and there are many types and levels of insurance, so the monitoring, prevention and management are very complicated and easy to miss.

Based on the above technical problems, the embodiments of the present disclosure provide a fine-grained grid management method, which facilitates daily work of staff through the grid-based management of emergency events.

Grid management is a kind of administrative management reform. Relying on the unified urban management and digital platform, the urban management jurisdiction is divided into unit grids according to certain standards. By strengthening the inspection of the components and events of the unit grids, a kind of. The form of separation of supervision and disposal is conducive to the daily work of the staff.

The grid refinement management method provided by the embodiments of the present disclosure can be used in the management of forests/urban firefighting and other fields, carry out hierarchical management according to danger, and adopt corresponding management measures, so as to manage emergencies and events that need to be focused on in a targeted manner, improve management efficiency.

The disclosed embodiments are based on CesiumJS+ (Cesium is a JavaScript library for creating 3D globes and 2D maps in web browsers without plug-ins), ArcGis Server+ (ArcGIS Server is an enterprise-level server for building centralized management and supporting multiple users) A platform for GIS applications. ArcGIS Server provides a wealth of GIS functions, such as maps, locators, and software objects used in central server applications), etc. and realizes fine-grained management of grids in 3D maps.

Exemplarily, as shown in FIG. 79-1, an embodiment of the present disclosure provides a grid refinement management method, including the following steps:

Obtain positioning data in the web page and display a three-dimensional map;

Obtain the latitude and longitude data of the grid boundary, and divide the 3D map into corresponding grids:

In a three-dimensional map, the grid and grid boundaries are added in the manner of an overlay.

Wherein, before the step of obtaining the latitude and longitude data of the grid boundary and dividing the three-dimensional map into corresponding grids, it also includes:

Obtain the specified map area according to the positioning data.

In the embodiment of the present disclosure, the county/district is used as the boundary, and the map area is divided into multiple grids, and each county/district can contain multiple grids, and each grid is a lower-level management unit of an administrative village. The fire and flood danger levels of each grid are different, so the corresponding fire prevention and flood control measures are also different, so that the danger levels are differentiated. For example, increase the number or frequency of inspection personnel in areas with high danger levels, and reduce inspections in areas with low danger levels, and allocate human and material resources to areas that are more needed. Wherein, in the three-dimensional map, the step of adding the grid and the grid boundary in the manner of adding an overlay includes:

Generate 3D grids and grid boundaries based on 3D maps; Among them, high-level dangerous events are set to be displayed in a highlighted manner, or displayed in a flashing manner, and different types of insurance adopt different display methods;

The 3D grid and the grid boundary are added in the form of an overlay according to the 3D map, and the 3D grid can be displayed on the ground more intuitively.

During implementation, the grid boundaries are disjoint to avoid wasting management resources and crossing jurisdictions.

Wherein, in the three-dimensional map, after the step of adding the grid and the grid boundary in the manner of adding an overlay, it also includes:

When a dangerous situation occurs, the location and type of the dangerous situation will be prompted by flashing, and the root display will be displayed to show the coping strategy. In the following, in combination with FIG. 79-1, taking forest/urban fire protection as an application example, the scheme of the embodiment of the present disclosure will be described in detail:

As shown in FIG. 79-1, the scheme of the embodiment of the present disclosure is based on a three-dimensional map, conducts fine grid management of forest/urban fire protection, conducts inspections, investigations, and dangerous situations according to different levels, realizes management differentiation, and improves management efficiency.

Exemplarily, firstly, on the web page, use the map data service to locate the specified area, and display the three-dimensional map of the specified area.

Afterwards, the backend provides the latitude and longitude data of the grid boundaries, and divides the 3D map into corresponding grids.

Exemplarily, this embodiment of the present disclosure may set a grid boundary according to a county boundary of a three-dimensional map, and obtain grid diagonal coordinates. And divide the areas corresponding to the three-dimensional map into forests, cities, etc. and set the grid fire danger level according to the divided areas.

The division includes, but is not limited to, in the forest area, according to tree species, terrain, land type, temperature and humidity, rainfall, etc. the areas that need to be inspected are divided into areas that need to be inspected, areas that are generally inspected, etc. Urban areas are divided into key inspection areas, general inspection areas, and areas where fire protection equipment needs to be added according to the use of buildings and fire inspection data.

Afterwards, use cesium at the front end to add grids and grid boundaries to the 3D map in the form of overlays, and perform ground-sticking processing, thereby realizing fine grid management in the 3D map.

Cesium is an open source, webgl-based 2D and 3D map engine. As far as its implementation is concerned, it is a relatively complete version of the current open source version. It has complete data source support, supports large scenes, and supports customized style rendering. In addition to cesium, the embodiment of the present disclosure can also use ArcGis Server to add grids and grid boundaries to the 3D map in the manner of adding overlays.

It should be noted that the embodiment of the present disclosure can not only be used for water and flood prevention management of forests or cities through grid refinement management, but also realize management of urban construction and resource allocation, and the embodiments of the present disclosure are not limited to one of them. In addition, the division of regions can also be narrowed down to towns, villages, etc. so as to realize the refined management of their respective work tasks and responsibilities in small regional units.

Compared with the related technologies, the embodiment of the present disclosure realizes fine-grained management of the specified area in the three-dimensional map, and according to the grid data combined with related services, it can be used for urban management such as fire prevention and flood control, as well as rapid monitoring of dangerous situations such as dense fire prevention and flash floods, treatment and prevention.

### R7-6-80—Smart Early Warning Method.

Intelligent operation and maintenance, also known as intelligent operation and maintenance, is based on existing operation and maintenance data (logs, monitoring information, application information, etc.) and uses machine learning to further solve problems that cannot be solved by automated operation and maintenance. The intelligent operation and maintenance platform in related technologies includes: various monitoring tools, custom data labels and data standardization through monitoring tools, and then perform alarm aggregation and automatic deduplication through the data processing engine, and then convey alarm notifications according to the set engine rules, and Summarize problem handling into a knowledge base.

Then the intelligent operation and maintenance platform in related technologies (for example: Ruining cloud intelligent operation and maintenance platform) has the following functional characteristics:

(1) It has a cross-platform alarm aggregation function: it can seamlessly connect various monitoring tools and bid farewell to information islands;

Realized integrated centralized management, the platform integrates more than 100 kinds of monitoring tools, including basic resource monitoring, cloud monitoring, network monitoring, performance monitoring, project management and other tools, which can be integrated and centralized management;

Easy linking to third parties Provide a complete Rest API interface and Email integration methods, quickly realize cross-platform alarm aggregation, and create a more complete collaboration platform around the intelligent alarm platform.

(2) Intelligent deduplication and noise reduction: the platform adopts a more humanized intelligent algorithm to bid farewell to the alarm storm;

A variety of machine learning algorithms; support various noise reduction functions, including alarm suppression, duplicate data, correlation and threshold processing, to achieve an ultra-high noise reduction ratio of not less than 95%;

Alarm notification suppression: No configuration is required, and subsequent notifications of repeated alarms are automatically blocked, greatly reducing the number of spam alarms. It can adapt to a variety of complex operation and maintenance scenarios: including event and alarm classification, clustering, abnormal discovery and other artificial intelligence scenarios, which greatly reduces the interference caused by redundant events and helps the team focus on more important work.

(3) Discovery of novel events. The algorithm supports real-time detection and automatically discovers new events. Novel events Compared with the previous cycle, new events in this period are novel events. Based on the pattern recognition algorithm, it provides periodic novel event mining, automatically discovers events that have never occurred in different time windows, and helps operation and maintenance and business personnel to identify emergencies more quickly and accurately.

(4) Root cause analysis of faults: AI algorithm identifies abnormal events and directly finds the root cause of the problem.

Root cause prediction: According to the scenarios and data in the actual operation process, combined with the experience of operation and maintenance personnel and various scenario algorithms, an alarm model is formed. Based on the corresponding alarm model, users can identify the pattern matching degree and distinguish abnormalities, and predict and discover possible root causes of faults in advance to ensure the stable operation of the business.

(5) On-Call response mechanism: automatic upgrade of alarm overtime processing, fully guaranteeing business continuity.

Direct access to the person in charge of the alarm: Customize the assignment and upgrade strategy based on the alarm content, and cooperate with flexible scheduling management to ensure that business issues can be sent to the correct personnel and teams in real time:

Automatic alarm escalation mechanism: After the first alarm receiver handles it overtime, the platform can automatically trigger the escalation mechanism to directly reach the superior responsible person, reducing the omission of alarms in an all-round way, so as to quickly build a dedicated alarm response mechanism.

(6) Multi-channel notification must reach: IT events are notified in seconds, directly to the person in charge in real time.

Custom notification strategy: support multiple alarm notification methods such as telephone, SMS, WeChat, email, DingTalk, App, etc. multi-channel distribution to achieve alarm must reach, greatly improving the effective arrival rate of alarm notification;

Alarm response anytime and anywhere: It can respond and process alarms on PC and mobile terminals at the same time, meeting the needs of alarm management in different work scenarios, so that every alarm can be easily handled.

(7) Multi-role communication and collaboration: The platform seamlessly connects with corporate communication habits in one stop, aligning goals and fully activating work efficiency; Multi-terminal collaborative processing: nearly 20 kinds of office collaboration platforms are integrated, suitable for a variety of collaboration scenarios, covering from general team collaboration to professional agile practice.

Multi-person collaborative distribution: Collaborative office is carried out in the form of a collaborative group, and a fixed business group or temporary project group can be established Once an alarm occurs, it can be directly sent to the relevant person in charge;

Breaking the boundaries of departments: All response processes are clear and traceable, greatly improving the convenience of operation and maintenance personnel, clearer coordination tasks, more focused communication and discussion, and more efficient response to each business problem.

(8) Knowledge precipitation and reuse: multi-person co-construction allows information to flow freely within the enterprise;

Knowledge production and creation: Through preset, recorded and shared fault repair solutions, a team knowledge base is formed, team wisdom is gathered, knowledge transfer costs are reduced, and overall MTTR (mean recovery time) is improved;

Multi-person collaboration and sharing: All members create and manage knowledge on the same platform, easily gather team wisdom, effectively reduce the cost of knowledge transfer for enterprises, and use more predecessors' experience sharing to help solve fault problems faster.

(9) Multi-dimensional alarm analysis: Real-time data visualization to help more refined operation management.

Multi-dimensional reports through rich ready-to-use multi-dimensional reports, realize the unified analysis of all alarm sources and monitoring tools, and provide business and operation leaders with analysis alarms, member work efficiency, and overview system operations.

Integrated display of cross-platform data: Unified analysis reports cover all alarm sources and tools. Through data review and combined analysis, comprehensive control of the operation situation is realized; professional operation and maintenance insights are provided for the team, and the maturity of process management is comprehensively improved.

Although the intelligent operation and maintenance platform in related technologies has solved the problem of deduplication of alarms to a certain extent, there is still a shortcoming: For the alarm information generated by the abnormal data reported by the smart terminal, the existing intelligent operation and maintenance platform cannot provide suggestions and solutions for the abnormal alarm information, so that the operation and maintenance personnel need to process the alarm information according to their own experience. Fault location and disposal failed to provide effective support. In addition, the intelligent operation and maintenance platform in the related technology does not have a fault prediction function, and cannot handle faults that will occur later, so the maintenance cost is high.

Based on the above technical problems, the embodiments of the present disclosure provide a smart early warning method, which can be applied to multi-mode heterogeneous IoT sensing platform products and unified operation and maintenance management platforms. Based on knowledge graph technology, it provides platform operation and maintenance personnel with intelligent Alarm and disposal plan, and can predict the failure of smart equipment, deal with failure problems in advance, reduce the number of alarms, and reduce maintenance costs.

An embodiment of the present disclosure provides a smart early warning method, including the following steps:

Establish a knowledge base of warnings and handling schemes;

When a fault occurs, the corresponding alarm information is output, and the corresponding disposal plan is displayed at the same time.

The embodiments of the present disclosure provide an intelligent operation and maintenance solution for platform operation and maintenance personnel by establishing a knowledge base in advance and directly searching for a treatment solution corresponding to the alarm information when an alarm is issued.

Further, when outputting the alarm information, the priority of the alarm information is obtained, and the alarm information and corresponding processing solutions are output in a descending order of priority.

Among them, establish a knowledge base of alarms and disposal solutions, including.

Extract knowledge related to alarms and disposal schemes from data sources, information sources, and knowledge sources:

Convert the extracted knowledge related to alarms and disposal schemes into corresponding knowledge factors and store them in the knowledge factor database;

Read the knowledge rule base, use the knowledge factor to fuse the knowledge related to the alarm and the disposal plan through the fusion algorithm, and obtain the fusion result.

Among them, after the fusion result is obtained, it also includes: Feedback evaluation of the knowledge fusion results;

According to the feedback evaluation results, the relevant parameters of the knowledge rule base are corrected, and the correction results are saved in the knowledge rule base.

Furthermore, the intelligent early warning method of the embodiment of the present disclosure further includes: using a prediction algorithm and a deep neural network to predict future fault alarm data and output a predicted alarm.

In this embodiment, the predicted warning includes:

Obtain massive historical alarm data;

According to massive historical alarm data, train deep neural network parameters; Save the neural network model parameters;

Load the neural network model and output predictive alarm data.

The embodiment of the present disclosure is based on the alarm and treatment plan of the knowledge map technology, which can be used for fault alarm and early warning of any intelligent terminal, such as for detecting fault alarms and alarms of various sensors such as water quality, air pollution, soil, meteorology, methane, and flame detection. Early warning can also be used for gate access control, multi-mode heterogeneous grid terminals, multi-mode heterogeneous security remote terminals, various communication terminals, gateways, cameras, spectrometers, mobile terminals, vehicle-mounted terminals, positioning terminals, wearable terminals, various Fault alarms and early warnings for various household electrical appliances. The embodiments of the present disclosure support customization of the alarm rules for abnormal data reported by the smart terminal, and can support combined condition triggering of multiple thresholds.

The embodiment of the present disclosure is based on the management of alarms and treatment plans based on knowledge graph technology: using knowledge acquisition, knowledge representation, knowledge storage, knowledge fusion, knowledge modeling, knowledge calculation and knowledge operation and maintenance technologies to realize the acquisition and integration of alarms and treatment plans. Modeling, calculation, operation and maintenance and storage of the whole process management.

Among them, the acquisition of alarm and disposal plan knowledge can be extracted from the generation of historical alarms and disposal plans, forming structured knowledge and storing it in the knowledge graph, forming understandable knowledge through machine learning, and through expert experience. After summarizing, knowledge is formed, knowledge conversion is completed, and knowledge factors are formed.

The representation of alarm and disposal plan knowledge can be based on the expression of production rules, according to the logic of the causal relationship between the alarm and the disposal plan, to form the knowledge representation form of “IF-THEN” (condition); through the method of knowledge fusion. Knowledge acquisition, matching, integration, and mining are performed on numerous scattered alarm and disposal plan knowledge to obtain implicit or valuable new knowledge, optimize the structure and connotation of knowledge, and provide alarm and disposal plan knowledge services.

The knowledge modeling of alarm and disposal plan adopts the top-down method. Firstly, the data schema is defined, which is manually compiled by domain experts, starting from the top-level concept, and then gradually refined to form a well-structured classification hierarchy. Knowledge calculation, including alarm and disposal plan knowledge calculation, exemplary, including knowledge statistics and graph mining, knowledge reasoning; knowledge map operation and maintenance process After the initial construction of the knowledge map, according to the use feedback, the same type of knowledge and increase. The process of evolution and improvement of the knowledge map of the full amount of alarms and disposal schemes based on new knowledge sources is the process of knowledge fusion.

Please refer to FIG. 80-1. The knowledge fusion method for warnings, warning suggestions, and disposal plans includes the following steps.
1. Knowledge extraction: Obtain knowledge related to alarms and disposal schemes from various data sources, information sources and knowledge sources,
2. Knowledge conversion: According to the ontology database, the extracted knowledge forms related to alarms and disposal schemes are converted into knowledge factors;
3. Fusion algorithm: read the knowledge rule base, and integrate the knowledge related to the alarm and the disposal plan according to the fusion algorithm;
4. Fusion result: Fusion is carried out through the fusion algorithm to obtain the result;
5. Feedback evaluation Feedback evaluation of knowledge fusion results,
6. Parameter correction: According to the feedback evaluation results, the relevant parameters of knowledge rules are corrected.

Through the above six steps, the alarm and disposal plan knowledge base is obtained. When a fault occurs, find the corresponding alarm information and output it, and at the same time find the corresponding disposal plan and display it. At this time, the operation and maintenance personnel can carry out remote or on-site maintenance according to the treatment plan Faulty equipment. Please refer to FIG. 80-2. In the intelligent early warning method provided by the embodiment of the present disclosure, not only a fault alarm processing method can be provided, but also a fault early warning method can be provided to improve the intelligence of the equipment. The fault prediction process includes the following steps:
1. Acquire massive historical alarm data: acquire the generated massive historical alarm data, including data collected by different types of smart terminals and alarm data of different alarm types;
2. Deep neural network training: train deep neural network parameters;
3. Save the model, save the neural network model parameters after training;
4. Load the model, load the neural network model, and predict the future alarm data in combination with the input forecast date;
5. Predict future alarm data: predict the distribution of future alarm data.

The distribution of future alarm data includes, but is not limited to, component aging and expiration predictions, component damage predictions, software upgrade failure predictions, etc. Operation and maintenance personnel can use future alarm data to maintain equipment in advance to avoid. In the future, there will be a fault alarm shutdown to avoid economic losses caused by equipment shutdown.

The intelligent early warning method provided by the embodiments of the present disclosure provides platform operation and maintenance personnel with more intelligent alarm and disposal plan management solutions, and provides disposal suggestions and disposal plans together with abnormal alarms, which reduces the ability requirements of operation and maintenance personnel Maintenance personnel provide effective support for fault location and disposal, realizing more accurate operation and maintenance management of smart devices; moreover, it can predict faults, deal with faults in advance, reduce the number of alarms, ensure the functions of smart devices, and improve the reliability of smart devices, also reduces maintenance costs.

In addition, the embodiment of the present disclosure divides different alarm information into different priorities, and further improves the intelligence of early warning for different alarm handling priorities.

### R7-7-81—Forest Fire Prevention Method Based on Grid Management.

According to statistics, an average of more than 200,000 forest fires occur every year in the world, and the burned forest area accounts for more than 1% of the world's total forest area Forest fires not only lead to the loss of balance of the forest ecosystem, the decline of forest biomass, the weakening of productivity, the reduction of beneficial animals and birds, and even the casualties of humans and animals. Therefore, it is necessary to carry out fire prevention management in forest areas.

At present, most forest fire protection systems use the method of managing the entire forest area as a unified fire prevention area. However, there are different vegetation types, different soil types, and different terrains in the same forest area. It is obviously inappropriate to carry out unified risk analysis and unified management in forest areas.

At present, forest fire prevention usually adopts the method of personnel inspection, so forest patrol is one of the daily tasks of forest rangers, but the single and large-scale forest area has too many dead spots for forest rangers, and sometimes some areas are missed during forest patrol, forest fire hazards.

In addition, in the event of a fire, if there is no more refined management, fire-fighting materials and firefighters will not be able to locate the fire at the first time, and they will not be able to dispatch personnel and materials to carry out the fire-fighting work at the first time.

Based on the above technical problems, the embodiments of the present disclosure provide a forest fire prevention method based on grid management. The grid management through the forest is beneficial to forest fire prevention and emergency management.

The forest fire prevention method based on grid management provided by the embodiments of the present disclosure can be used in forest fire management, and conduct hierarchical management according to danger, and adopt corresponding management measures, so as to manage emergencies and events that need to be focused on in a targeted manner. Improve management efficiency. Exemplarily, as shown in FIG. 81-1, the embodiment of the present disclosure provides a forest fire prevention method based on grid management, including the following steps:

Configure the forest fire prevention grid information database, which includes at least one of grid division, grid risk level, and grid responsibility system;

According to the forest fire prevention grid information database, the forest patrol information is displayed.

Among them, the grid division is based on administrative villages. An administrative village can contain multiple grids, and each grid is the next-level management unit of the administrative village. The embodiment of the present disclosure performs grid division based on the map, and the grid covers the corresponding area of the map, making the map display concrete.

When calculating the grid risk level, different grids can be divided into grids of different levels according to the grid control level, and different resources are allocated according to the grid risk level to determine different control efforts.

In the grid responsibility system, each ranger is assigned to a specific grid to ensure that the responsibility of the grid is assigned to the person, and the embodiment of the present disclosure can perform task assignment, risk warning, etc. based on the grid, and be carried out by the specific person in charge, deal with.

The embodiment of the present disclosure shows more clearly the data of various resources in the forest area, makes the division of responsibilities of the rangers more clear, can guide the entire work arrangement of the rangers, and improves the efficiency of forest fire prevention management. Furthermore, when a fire occurs, the fire-fighting response strategy is displayed according to the forest fire prevention grid information database.

In the embodiment of the present disclosure, the establishment of forest fire prevention gridded information database includes but not limited to grid geographic location information database, grid vegetation information database, grid land information database, grid terrain and terrain information database, grid terrain and terrain information database Information base, grid personnel information base, grid fire resource information base, grid IoT equipment information base, grid fire risk prediction database, realize grid division, grid risk level control, grid responsibility system, and grid refinement management, grid hidden danger information management, grid IoT equipment management, fire risk prediction, etc.

The embodiment of the present disclosure is applicable to any forest fire prevention management system. Through finer grid division, the vegetation resources, land resources, fire-fighting facility resources, personnel resources, and IoT equipment resources of each grid are better optimized. At the same time, in the daily forest patrol, the scope of each person's responsibility is smaller, and the forest area can be covered in a more refined manner. At the same time, in the event of a fire, various resources can be located through the grid and uniformly dispatched.

Among them, when configuring the forest fire prevention grid information database, it includes grid information, adding, editing, deleting and viewing.

During specific implementation, the front-end page of the gridded application can be accessed through the web page to perform related operations, and then the corresponding data in the database can be modified by processing the front-end request through the gridded application service platform.

The configured grid information can provide support for the fire danger prediction of the forest fire prevention system. After calculation by the prediction algorithm, the fire danger level of the corresponding grid will be stored in the grid information database, and the grid application service platform will. The data in the database is handed over to the front end (that is, the web page) for display, providing data support for grid patrolling, etc.

When a fire occurs, optimal allocation is made according to the resources in the grid, so as to better control the fire danger.

In order to better understand the embodiments of the present disclosure, the scheme of the embodiments of the present disclosure will be described in detail below in conjunction with FIG. 81-1, taking forest fire prevention as an application example:

As shown in FIG. 81-1, the forest fire prevention system in the embodiment of the present disclosure includes a web page, an application service platform, a grid database, and a fire risk level algorithm part, wherein the web page is mainly used for display and operation by staff, and the application service platform. It is used to perform corresponding operations according to the instructions received from the web page. The fire danger level algorithm is mainly used for fire danger prediction, and to provide timely fire fighting response strategies in case of fire, so as to perform grid refinement management and improve management efficiency.

Exemplary, first, configure the forest fire prevention gridded information database, which includes but not limited to: grid geographic location information base, grid vegetation information base, grid land information base, grid topography information base, grid terrain information base Geographic information database, grid personnel information database, grid fire resource database, grid IoT equipment information database, grid fire risk prediction database, etc.

When establishing the grid geographic location information database, the administrative village/township is taken as the superior unit to further divide the forest area. The information database needs to record the boundaries of each grid, and there must be no intersection between adjacent grids. When dividing, an administrative village/township can be divided into multiple grids, and the grids fill the entire administrative area as a whole.

When establishing the grid vegetation information base, it is mainly used to establish the information base for the grid vegetation resources, which includes vegetation types, such as trees, shrubs, etc. and specifies the spontaneous combustion probability for each type of vegetation. Each grid in the information base should contain the corresponding vegetation and its proportion. In addition, it is also necessary to collect the overall tree growth of the grid, including average tree height, DBH of vegetation, and average growth years.

When establishing a grid land information database, it is necessary to collect land types in each grid, such as cultivated land, wasteland, forest land, etc. and to collect the proportion of each land type in the grid.

When building the grid terrain information database, it is necessary to collect the information of the special terrain and terrain in the grid Part of the special terrain is easy to cause the spread of fire, which has a certain impact on the fire risk of the grid. For example, gourd valley, canyon, cliff and so on.

When establishing the grid personnel information database, it is necessary to designate a corresponding person in charge (such as a forest ranger) for each grid, and the person in charge is responsible for the daily forest patrol of the grid, the investigation of grid fire hazards, and the occurrence of fire hazards. The person in charge at the first time.

When establishing the grid fire-fighting resource library, the embodiments of the present disclosure reasonably deploy fire-fighting resources such as fire-fighting water tanks, fire hydrants, and fire stations according to the fire danger level and prevention and control level of the grid. At the first time when a fire occurs, the embodiments of the present disclosure can easily locate corresponding firefighting resources through the corresponding grid, and carry out fire rescue at the first time. When establishing the grid IoT device information library, it includes the monitoring and control of sensing devices and gateway devices in the grid. The embodiment of the present disclosure is a grid construction sensing device, which collects parameters such as temperature, humidity, wind speed, wind direction, air pressure, rainfall, and snowfall in the corresponding area of the grid, and transmits the collected parameters according to the specified time interval through the network transmission device. To the well-built data twin warehouse, it provides reliable parameters for the fire risk judgment of the grid.

When establishing the grid fire risk prediction database, the fire risk level corresponding to each grid is calculated according to the forest fire risk level algorithm of the embodiment of the present disclosure, and the fire risk is displayed and forecasted through the application service platform, which is for the person in charge of the grid and the forest ranger Provide guidance on daily forest patrols.

The embodiment of the present disclosure predicts the fire danger level based on grid-based fine management, and uses the grid as the basis to predict the fire danger level at an hourly granularity. Vegetation, topography, terrain, etc.) as part of the input parameters, grid hidden danger point information as part of the input parameters, local customs and solar terms as part of the grid fire warning, and combined with grid IoT devices to provide Comprehensive evaluation of meteorological information, soil condition information and other parameters to predict, the prediction results are accurate, and can provide timely guidance for rangers on daily forest patrols, predict in advance to avoid fires, and can also provide timely information in case of fires firefighting strategy.

After that, according to the forest fire prevention grid information database, the forest patrol information is displayed.

Among them, forest patrol information includes the scope of daily forest patrol areas, patrol responsibilities, and investigation of grid fire hazards. When the predicted fire risk level is high, the controllable sensing devices and gateway devices in the grid are displayed to set the operating frequency of the sensing devices, and the control gateway devices provide more channels for fast transmission of collected data. In the event of a fire, various resources can be located through the grid and dispatched in a unified manner.

It should be noted that the use of grid management in the embodiments of the present disclosure is not limited to forest firefighting. In other industries, grid management can also achieve fine positioning of problems. For example, in the urban management system, the grid with streets as the superior unit divides the streets into finer sections, which is more conducive to the daily work of urban management staff.

The embodiment of the present disclosure conducts fine management based on grid-based forest fire prevention, and realizes configurable grid basic information, configurable grid basic vegetation resources, configurable grid land resources, configurable grid main terrain, and configurable grid. The specific person in charge can be configured, the grid firefighting resources can be configured, and the system hidden danger point information is configured based on the grid, and the system IoT device information is configured based on the grid, which mainly has the following beneficial effects:
1. The embodiment of the present disclosure makes the display of various resource data in the forest area clearer. Compared with the traditional forest area resources divided by administrative divisions, the grid can better finely monitor the materials in the forest area. Assignment deployment and management.
2. Through the grid management, the division of responsibilities of forest rangers is more clear, and the scope of daily forest patrols is also more refined, so that some dead spots for firefighting can be better checked.
3. The embodiment of the present disclosure adopts a fine grid-based fire risk level processing method, which can guide the entire work arrangement of the rangers.
4. In the event of a fire, the grid method can allocate resources in the grid at the first time, so as to better control the fire.

### R7-8-82—Safety Monitoring Method for the Elderly Living Alone.

All countries in the world have experienced the serious problem of population aging. The number of elderly people living alone is increasing. For the elderly living alone in the community, there is currently a lack of monitoring of their emergencies. It is often long after the emergency occurs that the community management personnel. It was found that the loss of the best opportunity and time to intervene in emergencies of the elderly living alone caused the problem to develop from mild to severe, and even lead to loss of life. Moreover, there is no real-time monitoring and help to solve problems in various activities of the elderly living alone.

In the existing smart community system in use, based on the multi-terminal display of the smart community IoT (Internet of Things) platform, PC terminal, mobile APP WeChat platform, etc. it can comprehensively realize safe communities, affordable housing management, and renovation of old communities. Smart property and other scenarios have landed.

The smart community system in related technologies integrates face recognition, silent living body, infrared recognition and other technologies to realize smart access control, smart monitoring, smart attendance, and unified monitoring management, providing efficient, reliable, and intensive smart security access control management solutions.

The smart community system in related technologies can effectively help real estate and property groups realize easy management and control of parking hardware of different brands in the market, convenient financial management, and flexible connection with ERP and financial systems through IoT sensor controllers, mobile payment and other technologies.

The smart community system in the related technology is based on the concept of Internet+, and provides a one-stop comprehensive system and APP development plan for the property, including digital community+government service+convenient life, linking the community service of the property with the life of residents.

In addition, in combination with the actual situation of the community, AI and big data technologies are used to provide customized services for the elderly through the platform carrier of the robot, and better solve the daily entertainment and leisure needs of the elderly in the community.

However, the current smart community system provides some solutions for the property management and outdoor activities of the elderly, and does not monitor and analyze the state of the elderly living alone at home. When the elderly need help, the property management cannot provide services in time.

Based on the above technical problems, the embodiment of the present disclosure provides a safety monitoring method for the elderly living alone, which judges whether the elderly living alone is abnormal through data such as water consumption and electricity consumption, and the property management company can visit the home in time to help the elderly solve the problem according to the data.

The safety monitoring method for the elderly living alone provided by the embodiments of the present disclosure judges whether the elderly living alone needs help based on whether the electricity and water consumption data are lower than the set lower limit value, and can detect serious illness, fainting, death and other serious situations at home for the elderly living alone, and be processed in a timely manner.

The embodiment of the present disclosure is based on the integrated monitoring and alarm technology of household water consumption and electricity consumption: set the minimum threshold value of household daily water consumption and household daily electricity consumption threshold, and monitor the daily water consumption and daily consumption of each household in the community in real time Electricity, to identify the households whose accumulated water consumption is less than the minimum value threshold and the cumulative electricity consumption of the day (12 hours) is less than the minimum threshold value of electricity consumption, generate a household abnormal alarm, and send text messages, phone calls. Notify the property by mail or other means, and generate a work order, which will be dispatched to the relevant property personnel to visit the family on site. If an emergency occurs to the elderly living alone, emergency treatment can be carried out in time, and the treatment process will be recorded, and the work order will be finally closed.

Exemplarily, an embodiment of the invention provides a safety monitoring method for the elderly living alone, including the following steps:

Obtain daily water consumption data and/or daily electricity consumption data, and determine whether the water consumption and/or electricity consumption is less than the set threshold; When the water consumption and/or electricity consumption is less than the set threshold, a work order is generated and a household abnormal alarm is output to the bound terminal.

Among them, the bound terminal can be the mobile phone of the property staff, the mobile phone of the family members, etc. and the family abnormality alarm will be sent by SMS, phone call, e-mail, etc.

Furthermore, after the property personnel come to the door for emergency inspection, they fill in the disposal information through the binding terminal.

Further, the step of acquiring daily water consumption data and/or daily electricity consumption data and judging whether the water consumption and/or electricity consumption is less than a set threshold value also includes:

Obtain daily gas data and judge whether the gas consumption is less than the set threshold;

When the gas consumption is lower than the set threshold value, a work order is generated and an abnormal household alarm is output to the bound terminal.

Further, when the water consumption and/or electricity consumption is greater than the set upper limit, a work order is generated and a household abnormal alarm is output to the bound terminal. Further, when the gas consumption is greater than the set upper limit, a work order is generated and a home abnormal alarm is output to the bound terminal.

The embodiment of the present disclosure is based on the real-time monitoring and alarm technology of domestic water consumption: set the minimum threshold value of daily household water consumption, monitor the daily water consumption of each family in the community in real time, and monitor the households whose cumulative water consumption is less than the minimum threshold value on that day (12 hours). Identify and generate alarms, and support checking the water consumption of households with daily water consumption alarms at peak household water consumption on that day.

The embodiment of the present disclosure is also based on the real-time monitoring and alarm technology of household power consumption: set the minimum threshold value of household daily power consumption, and monitor the daily power consumption of each family in the community in real time. Households with the minimum electricity consumption threshold are identified and alarms are generated, and it is supported to view the power consumption of households with daily power consumption warnings during peak household power consumption on that day.

The embodiment of the present disclosure is also based on the real-time monitoring and alarm technology of household electricity consumption: set the minimum threshold value of household daily gas consumption, and monitor the daily gas consumption of each household in the community in real time. For the cumulative gas consumption of the day (12 hours) less than the gas consumption Households with the minimum threshold are identified and an alarm is generated, which supports viewing the gas consumption of households with daily gas consumption alarms at peak household gas consumption on that day.

In order to better understand the embodiments of the present disclosure, the solutions of the embodiments of the present disclosure will be described in detail below in conjunction with FIG. 82-1, taking household electricity and electricity and water monitoring as application examples. The safety monitoring method for the elderly living alone provided by the embodiments of the present disclosure is based on the integrated monitoring of household water consumption and electricity consumption, and alarms. Examples include:

Sending water consumption data: smart water meters collect and send water consumption data of household smart water meters in real time to the tap water management system of the water supply group;

Receiving water consumption data: the tap water management system of the water supply group receives the water consumption data sent by the household smart water meter;

Obtain water consumption data: the property management system of the community obtains the water consumption data of the household smart water meters in the community from the tap water management system of the water supply group;

Send electricity consumption data: the smart meter collects and sends the electricity consumption data of the household smart meter in real time to the power consumption management system of the power supply group.

Receiving electricity consumption data: the power consumption management system of the power supply group receives the electricity consumption data sent by the household smart meter. Acquisition of electricity consumption data: the property management system of the community obtains the electricity consumption data of the household smart meters in the community from the power consumption management system of the power supply group;

Judgment of water consumption threshold: For each family in the community, it is judged whether the cumulative electricity consumption of the day (12 hours) is less than the minimum threshold of electricity consumption;

Judgment of power consumption threshold. For each family in the community on the same day (12 hours), it is judged whether the cumulative power consumption is less than the minimum threshold of power consumption;

Generate a work order: If it is judged whether the cumulative electricity consumption of the household on the day (12 hours) is less than the minimum threshold of electricity consumption and whether the cumulative electricity consumption of the household on the day (12 hours) is judged to be less than the minimum threshold of electricity consumption, a work order is generated. Notify the property management personnel by SMS, telephone, email, etc. and require the property management personnel to come to check whether there is any abnormal situation:

Door-to-door inspection: After receiving the work order, the property management will go to the residents of the community to check the situation. If there is any abnormality in the elderly living alone, emergency treatment will be carried out;

Fill in the disposal information. After the property management personnel come to check, fill in the disposal information;

End work order: The manager closes the work order after viewing the work order disposition information.

In order to improve the monitoring accuracy, when there is an abnormality in the electricity consumption and electricity consumption data, an alarm message will be output. At this time, the property personnel can call the resident to verify.

Furthermore, the embodiment of the present disclosure also detects the upper limit of water consumption and electricity consumption. When the water consumption exceeds the daily upper limit, the user will visit the home in time to check whether the user has forgotten to turn off the tap or burst the water pipe. When the electricity consumption exceeds the daily upper limit, it is timely to check whether the user's family has forgotten to turn off the electrical equipment, so as to avoid the waste of electric energy.

In addition, the embodiment of the present disclosure can also detect the daily gas consumption. When the gas consumption is lower than the set threshold value, an alarm message will be output. At this time, the property staff can call the resident to check whether the appearance or sickness did not cook. And when the gas consumption is greater than the set upper limit, a work order is generated and a household abnormality alarm is output to the bound terminal, and the property personnel will come to check to prevent users from gas poisoning.

It should be noted that the embodiment of the present disclosure can also monitor the usage of other commonly used devices of the user, such as data such as broadband traffic usage, as long as the usage of the user can be monitored and the user may be in a state according to the usage. And the embodiment of the present disclosure is not limited to the monitoring of the elderly living alone, but can monitor the consumption of all residents in the community, providing protection for the personal safety of the community users.

The safety monitoring method for the elderly living alone provided by the embodiment of the present disclosure can detect serious illness, fainting, death and other serious situations of the elderly living alone at home as early as possible, and can deal with them in a timely manner; as a service provided by the property management company, it will bring value-added services to the property management company and improve services quality. The embodiment of the present disclosure monitors whether the user may be in a dangerous state by using data such as electricity, water, and gas, and provides timely help while ensuring user privacy.

In addition, the embodiment of the present disclosure does not need to install a camera or wirelessly wear a monitoring terminal, does not affect the daily life of the elderly at home, and does not require too much attention from personnel, and realizes unfettered all-weather intelligent care for the elderly at home.

City operation comprehensive IOC layer, including technologies numbered R8-1 to R8-2. Integrate data from various industries to achieve an overview of the city's overall situation, monitoring and early warning, command and dispatch, event handling, and operational decision-making. The bridge/support of various aggregation and downlink data of the city operation comprehensive IOC layer relies on the multi-mode heterogeneous network established by dynamically adjusting any communication parameters according to industry requirements or/and physical location.

The implementation of the city operation comprehensive IOC layer of the support layer of the embodiment of the present disclosure will be described in detail below in conjunction with exemplary embodiments.

### R8-1-83—Urban Comprehensive Operation IOC

Urban operation refers to various matters related to maintaining the normal operation of the city, mainly including the management of urban public facilities and the services they carry. Urban planning and construction are ultimately to serve the operation of the city and serve the citizens. Urban facilities can only function and provide services after the planning, construction and operation are completed, so as to truly create a good living environment for citizens and ensure the normal life of citizens.

The urban comprehensive operation system products in the related technology include many subsystems such as municipal infrastructure, public utilities, traffic management, waste management, city appearance and landscape management, and ecological environment management.

The deficiencies in the existing comprehensive urban operation are as follows:

1) The city integrated operation system products in related technologies have barriers of data islands, which cannot integrate the information system data of various industries in smart cities, unify data standards, unified data cleaning and unified data exchange; 2) cities in related technologies. The comprehensive operation system cannot open up the incident handling process between various departments, 3) The products in the related technology lack a complete closed loop of urban comprehensive operation.

Based on the above technical problems, the present disclosure provides an IOC platform for comprehensive urban operation and a method for comprehensive urban operation.

By adopting the technical solution of the present disclosure, the information system data of various industries can be fused, unified data standards, unified data cleaning and unified data exchange, and the event handling process between various departments can be opened up, so as to realize the complete urban comprehensive operation closed loop.

In an optional embodiment, the city comprehensive operation IOC platform of the present disclosure can be divided into five components according to functions, as shown in FIG. 83-1, which are dynamic monitoring and early warning, pre-plan management, cross-departmental event handling. Operational decision analysis, leadership cockpit.

The components include, dynamic monitoring and early warning, contingency plan management, cross-departmental event handling, operational decision analysis, and leadership cockpit. The role of each component is as follows:
1) Dynamic monitoring and early warning is a unit for unified access, unified cleaning, and unified exchange of information system monitoring data, business data, and execution result data in various industries.
2) Pre-plan management, providing pre-plan storage and automatic pre-plan association functions for various event processing;
3) Cross-departmental incident handling is a unit that connects the processes of various committees and departments in various industries, and conducts cross-departmental handling and circulation of various events that are dynamically monitored and warned;
4) Operational decision-making analysis is a unit that conducts statistics on time and space dimensions of events, conducts intelligent analysis, and forms an analysis report to display the operating situation;
5) The leader's cockpit is a unit that displays dynamic monitoring and early warning data, contingency management plans, event handling process monitoring, and operational decision-making analysis, and provides leadership decisions that are distributed through the integrated communication platform and executed through cross-departmental event handling. And stored in the closed-loop function of the plan management.

In yet another optional embodiment, referring to FIG. 83-2 to FIG. 83-6, the comprehensive urban operation method (applicable to the above-mentioned system) of the present disclosure includes the following steps:

Step S1: Dynamic monitoring and early warning monitoring of data from different sources in various industries and the alarm events generated. The various industries here are not necessarily complete industries. They can be set as part or all of the entire industry according to the needs of process nodes, and The industries set for any two nodes may not be exactly the same;

Step S2: Contingency plan management classifies and analyzes the alarms generated by dynamic monitoring and early warning, and selects the corresponding contingency plan for matching and pushing;

Step S3. According to the plan and the time-based disposal process, the cross-departmental event disposal will get through the relevant departments of each disposal, and carry out the flow of the process:

Step S4. Run the decision-making analysis to obtain the progress of time disposal and the analysis of each dimension of time, and display it in a visual way such as a graph;

Step S5. Visually display the data of the first four steps in the leader's cockpit, so that the leader can see the current situation of the city's comprehensive operation at a glance.

The above step S1 includes dynamic monitoring and early warning, and unified access, unified cleaning, and unified exchange of data from various industries in the following manner: Step S11: The data intelligent fusion platform fuses the data of n industries; among them, the n industries are:
1) Industry 1 is the smart forestry and grass industry, which includes information systems such as a smart forestry system management platform, a biodiversity protection platform, a grid-based intelligent forest fire early warning platform, a group prevention and management management platform, and a big data platform for pest control wait;
2) Industry 2 is a carbon-neutral industry, which includes information systems such as a carbon-neutral transaction management platform, a carbon-neutral carbon sink management platform, and a carbon-neutral carbon source management platform,
3) Industry 3 is the eco-environment industry, which includes information systems such as atmospheric environment monitoring and early warning platform, hazardous solid waste dynamic management platform, water environment monitoring and early warning platform, etc.;
4) Industry 4 is the public security industry, which includes information systems such as cultural relics protection information platform, epidemic prevention and control information platform, public security and police situation big data intelligent research and judgment platform, security community management and control platform, etc.;
5) Industry 5 is the water conservancy and water affairs industry, which includes information systems such as smart water conservancy comprehensive management platform, sponge city smart platform, etc.
6) Industry 6 is the urban management industry, which includes information systems such as city gas safety early warning platform, smart sanitation management platform, smart garden management platform, digital city management platform, etc.;
7) Industry 7 is construction site construction industry, which includes information systems such as smart construction site comprehensive management platform, etc.;
8) Industry 8 is the emergency management industry, which includes information systems such as intelligent emergency comprehensive early warning research and judgment system, etc.;
9) Industry 9 is the campus management industry, and the information system included includes a smart campus comprehensive management platform.

In addition to the above 9 industries (as shown in FIG. 83-2), the technical solution of the present disclosure supports expansion access to information systems of other industries.

For data, the message format can be pre-defined, including industry code, data type, specific data, etc. For example, the industry code of the smart forest and grass industry is 1, the industry code of the carbon neutral industry is 2, and so on. For alarm events, the message format can also be pre-defined in a similar manner.

Step S12 Configure the alarms for the data of the n industries that are connected according to the self-defined rules. When the data meets the alarm rules, the alarms of the corresponding rules will be triggered and alarm events will be formed. For example: the water level of the underground drainage system exceeds Corresponding alarm events are generated when the manhole cover is lost or the roadside sightseeing tree is blown off, etc.;

Step S13. Carry out dynamic analysis of the time and space dimensions of the alarm events in the previous step, and save the analysis results, such as counting various alarm events according to the time dimension, so as to know the frequency of various alarm events in each time period. It can also perform dynamic analysis according to the spatial dimension, analyze the frequency of alarms in each area, and analyze the correlation between alarms in the same area;

Step S14 Carry out real-time early warning triggering and notification for the alarm event, notify the relevant personnel of the relevant department and associate the event with the plan, for example: if the rain warning and the electric leakage warning of a certain place are received, the rain warning and electric leakage warning will be respectively. The warning is sent to the local meteorological department and power department.

The plan management in step S2 is shown in FIG. 83-3, including:

Step S21: Access and classify alarm events and early warning events generated by dynamic monitoring and early warning.

Step S22: The early warning events are classified into event 1 to event n;

Step S23. According to the types of events, corresponding plans are gathered, and the plans are unified to provide cross-departmental event handling.

Following the above example, after sending the rain warning and electric leakage early warning to the local meteorological department and the electric power department respectively, an associated alarm is generated to the communication operator after analysis, so as to send an alarm to mobile phones around the leakage area (the content of the alarm includes, avoid the area, how to rescue an electrocuted person, etc.).

The cross-department incident handling in step S3 is shown in FIG. 83-4, including.

Step S31: Access events generated by dynamic monitoring and early warning and contingency plans generated by contingency plan management, and automatically/manually distribute the events to the responsible department 1;

Step S32. The responsible department 1 assigns the incident to the responsible person 1 to handle the incident. After the responsible person 1 completes the handling, if the incident needs to be handled across departments, the event handling process is transferred to the entrusting department 2;

Step S33: The commissioning department 2 assigns the incident to the commissioning personnel 2 to handle the incident After the commissioning personnel 2 completes the disposal, if the incident needs to be handled across departments, the event handling process is transferred to the next commissioning department, and so on, until all the disposal processes are completed and the event is disposed of;

Step S34. Push the treatment process and treatment results to the operation decision analysis. For example, if it is detected that the road manhole cover is missing, an alarm will be sent to the relevant administrative department, signal, gas, natural gas and other pipelines are specifically responsible for the respective departments), and then send the alarm to the specific department for processing, find the missing manhole cover or cover it with a new manhole cover.

The operation decision analysis of step S4 includes:

Step S41: Access the progress and results of event flow, and classify them;

Step S42: On the basis of event classification, perform data statistics in various dimensions, such as time dimension statistics, location dimension statistics, and result dimension statistics; Step S43: Perform statistics on completed events in various dimensions, and then conduct intelligent analysis on events, such as analysis of high-frequency occurrence time, high-frequency location analysis, and high-frequency event analysis;

Step S44: display the statistical results of the event and the results of the intelligent analysis in a graph, so that the results of the operation decision analysis can be seen at a glance; Step S45. Push the result of the operation decision analysis to the leadership cockpit. The visual presentation of the leadership cockpit in step S5, as shown in FIG. 83-5, includes: Step S51. Connect the data of dynamic monitoring and early warning, the plan of contingency management, the progress of inter-departmental handling of events, and the results of operation decision analysis to the leader's cockpit. The data interface can be provided in the leader's cockpit, and other parts can follow the data interface. The data format requires access to the data; Step S52: The leader visually displays and prompts the accessed data;

Step S53. The leader can make decisions according to the status of the access data and the decision-making suggestions given by the auxiliary decision-making unit;

Step S54. The leader's decision-making can conduct real-time command and dispatch, push the disposal decision to the contingency plan management and event disposal circulation process, and form a closed-loop urban comprehensive operation IOC.

This disclosure is applicable to comprehensive urban operation scenarios at various levels such as district and county levels, prefecture-level cities, provincial departments, and ministries and commissions, and is applicable to hierarchical deployment of departments at all levels, forming cascaded urban big data dynamic monitoring and early warning, and urban emergency plan management. Hierarchical event handling, big data operation decision analysis and leadership hierarchical management decisions.

This disclosure is applicable to the access and aggregation of data and processes of various government commissioned units, enterprises and institutions, and unified data cleaning, data standardization, early warning rule definition and monitoring and early warning.

The present disclosure is applicable to various secure network environments, and provides secure data access management and city comprehensive operation functions.

This disclosure is applicable to departments and personnel of government commissioned units at all levels, enterprises and institutions.

The present disclosure is applicable to environments of centralized deployment and distributed deployment, and is applicable to user groups of different sizes and various complicated circulation processes.

Adopting the technical solution of the present disclosure has the following technical effects. 1) The present disclosure solves the barrier problem of data islands in the urban comprehensive operation system products in the related art, integrates the information system data of various industries in the smart city, and unifies the data standards. Unified data cleaning and unified data exchange; 2) This disclosure solves the problem that the urban comprehensive operation system cannot open up the event handling process between various departments; 3) This disclosure establishes a closed loop of urban comprehensive operation functions, making urban comprehensive operation more efficient R8-2-84-A Design Method for Industry Intelligent Platform Based on Multimedia, VR and AR At present, the human-computer interaction of the industry intelligent platform still adopts the relatively traditional mouse and keyboard methods; the new human-computer interaction method has not been introduced into the human-computer interaction, and the user's sense of immersion is not strong; in addition, the industry intelligent platform supports streaming media not effectively. In the application of VR/AR/MR platform in the design of complex product virtual prototypes, in the process of new product design, designers can directly import the original 3D data into the TMAX3D-VR visualization platform, endowing real material texture and lighting information, through VR display equipment Or directly watch the real real-time 3D effect on the computer screen, which facilitates the comparison and review of design schemes, reduces the dependence on physical prototypes, effectively reduces the R&D cost of new products, and shortens the new product design cycle. The VR/AR/MR platform supports network-based multi-department collaborative work in different places, and can conduct real-time review and discussion on the same set of 3D VR content at the same time. The AR/MR features and advantages that the platform should have are: support for large data volumes and ultra-real real-time AR rendering effects, easy-to-operate fully graphical AR and MR development tools to facilitate the realization of various AR and MR, interactive settings.

In the application of VR/AR/MR platform in complex product exhibitions, the characteristics and key points of VR/AR/MR platform: multi-format. Passes layered output; support various multi-channel display output; support international mainstream high-end head-mounted VR Display device; supports a variety of international top industrial level interactive tracking peripherals. VR/AR/MR platform in the application of complex product testing and support: VR technology can be applied in aerospace, automobile manufacturing, industrial products, and AR/MR virtual maintenance and assembly. The VR/AR/MR platform is equipped with a top industrial tracking system (A.R.T.) and an ergonomic force feedback system (Haption). The top industrial tracking system A.R.T, supports industrial measurement and ergonomic motion capture, supports high-precision object position and orientation measurement, can independently track more than 20 targets in 6 degrees of freedom, supports real-time high-precision full-body tracking, finger tracking, and tracking accuracy Up to 0 1 mm. Ergonomic force feedback system Haption. Realize operation simulation close to real physical collision force sensing, support 3-DOF and 6-DOF force feedback simulation, support virtual object gravity simulation, and realize virtual maintenance, process planning, and assembly of product digital models Process verification, robot control, accessibility verification, assembly training and other functions.

In the above-mentioned virtual maintenance and assembly, the platform adopts a physics engine, which supports real-time dynamic collision interference inspection, simulates free fall and other object characteristics, supports collision interference highlighting, prevents penetration and other feedback forms; supports component grouping and real-time picking Functions such as, budget, and verification of assembly paths in a reasonable space; it is used for feasibility analysis of assembly and disassembly, assembly path inspection, assembly space display, high-quality real-time assembly path definition, etc.

From the above content, it can be known that the disadvantages of related technologies include: 1) The current human-computer interaction of the industrial intelligent platform still adopts the relatively traditional mouse and keyboard human-computer interaction method. The latest human-computer interaction methods of VR, AR and STT have not yet been introduced into human-computer interaction methods, and the user's sense of immersion is not strong; 2) The rendering engine capability in related technologies is limited, and the visual rendering of overly large and complex digital models cannot get friendly satisfaction; 3) The industry intelligent platform is not effective in supporting streaming media.

Based on the above technical problems, the present disclosure provides a design method for an industry intelligent platform based on multimedia, VR, and AR.

The disclosed technical solution mainly includes the following parts:
1) TTS-based voice broadcast method: In the industry intelligent platform, TTS-based voice broadcast technology is adopted, user selection menu adopts TTS voice broadcast, system pop-up window information adopts TTS voice broadcast, equipment reports real-time information using TTS voice broadcast, equipment alarm. The information is broadcast by TTS voice;
2) Multimedia input method based on STT. In the industry intelligence platform, based on STT (speech-to-text) technology, users interact with the industry intelligence platform through voice, including selecting menus through voice, and inputting relevant information through voice;
3) Pre-plan demonstration and simulation based on AR and VR technology. Through AR and VR technology, users can immerse themselves in the virtual pre-plan demonstration and simulation scene generated by AR or VR to interact, and roam in the scene in a panoramic manner. View all kinds of data or charts of the system in an intuitive way: the display of equipment and equipment data based on the electronic map adopts AR and VR technology, and users can directly interact with the data in an intuitive way;
4) Streaming media technology: including streaming media processing, storage and publishing technology, IM technology based on streaming media, video conferencing and command and dispatch technology.

As an optional implementation, the technical solution of the present disclosure is described in detail below in conjunction with exemplary embodiments:

The technical process of TTS voice broadcasting is shown in FIG. 84-1. The technical flow chart of TTS voice broadcasting includes the following components:

Step S1, information acquisition acquire information that requires TTS voice broadcast, support TT'S voice broadcast information, including user selection menus, display information in system pop-up windows, real-time information reported by equipment, equipment alarm information, and convert the acquired information into text information.

For example, if the sensors distributed in the urban area detect rain and electricity leakage in a certain place, a rain warning and electricity leakage warning will be generated at this time, and the rain warning and electricity leakage warning will be sent to the local meteorological department and electric power in an agreed way. At the same time, the department's intelligent platform generates an associated alarm after analysis (the associated alarm is used to send an alarm to mobile phones around the leakage area), and sends it to the communication operator's intelligent platform in an agreed manner, meteorological department, electric power department After receiving the alarm message, the intelligent platform of the communication operator decrypts and decodes it according to the agreed method to obtain the alarm information.

Step S2, text-to-speech synthesis: synthesize the text information obtained from the information into speech; text to speech (text to speech), referred to as TTS. A technology that converts text into speech, similar to the human mouth, speaks what you want to express through different timbres. In speech synthesis, it is mainly divided into a language analysis part and an acoustic system part, also known as the front-end part and the back-end part. The language analysis part mainly analyzes the input text information, such as judging the text structure and language: when it is necessary to synthesize After inputting the text, it is first necessary to determine what language it is, such as Chinese, English, Tibetan, Uighur, etc. and then divide the entire text into individual sentences according to the grammar rules of the corresponding language, and divide the segmented sentences. It is passed to the subsequent processing module to generate the corresponding linguistic specification, which is equivalent to thinking about how to read in advance, that is, in order to imitate the real human voice, it is necessary to predict the rhythm of the text, where to pause, how long to pause, which word Or the word needs to be re-read, which word needs to be read lightly, etc. to realize the high and low tortuous and cadence of the voice.

The acoustic system part is mainly based on the phonetics specifications provided by the speech analysis part to generate corresponding audio to realize the function of sounding. Exemplary, waveform splicing, parametric synthesis and end-to-end speech synthesis technologies can be used. Taking waveform splicing speech synthesis as an example, a large amount of audio can be recorded in the early stage to cover all syllables and phonemes as fully as possible, and a large corpus based on statistical rules. The corresponding text audio is spliced, so the waveform splicing technology splices the syllables in the existing library to realize the function of speech synthesis. Step S3, voice broadcast: perform voice broadcast on the synthesized voice.

The STT-based multimedia input method flow chart is shown in FIG. 84-2. The STT-based multimedia input method flow chart includes the following components Step S1, user voice input: the user voice input command or input content, the command includes menu selection or related Button selection, such as the user says “select the button to view the current alarm from the menu”;

Step S2, voice recognition: recognize the instruction or content input by the user's voice, such as recognizing that the user instruction is to select “view the current alarm” from the menu button; step.

S3, voice-to-text: recognize the user's voice and convert it into text, and the process of STT is similar to the reverse process of TTS, from voice to text; step S4, semantic analysis: perform semantic analysis on the converted text; step S5. Execute corresponding operations Execute corresponding operations according to actual application scenarios, including, execute menu operations, execute buttons, or input operations, such as displaying the display interface of “current alarm”.

Refer to FIG. 84-3 for the VR technology-based contingency plan demonstration and simulation technology flow chart. The VR technology-based contingency plan demonstration and simulation technology flow chart includes the following components: Step S1, motion information collection module, collect motion information of VR users in real time, and real-time Send it to the VR interaction module, for example, you can use VR to collect the video screen of the staff on the job site; step S2, the pre-plan information module: input the relevant information of the pre-plan into the virtual scene generation module, after the expert sees the video screen of the remote on-site staff, you can Remotely guide the on-site staff, which can be realized by inputting the relevant information of the plan; step S3, external equipment: input the position information and control information of the external equipment for VR interaction to the VR interactive module, in order to reproduce it on the VR user's equipment. The same virtual scene as the scene can input the location information and control information of the external equipment; step S4, the virtual scene generation module, can generate the virtual scene in real time, and can integrate the plan information provided by the plan information module;

Step S5, VR interaction module: interact external device control information, motion information, and plan information in the virtual scene, reproduce the same virtual scene as the scene on the VR user's device, and display the guidance plan of the remote expert.

Refer to FIG. 39-1 for the overall architecture of IM services based on streaming media instant messaging. The overall architecture diagram of IM services based on streaming media instant messaging includes the following components: 1 Each regional communication module, responsible for local domain communication; 2. FreeSwitch and ESL: FreeSWITCH is. An open source telephone softswitch platform, supports communication protocols such as SIP. Skype, H323, IAX and Google Talk, supports voice codecs of various bandwidths, supports 8K, 16K, 32K and 48 KHz high-definition calls; ESL can be batched to customers Outbound calls are transferred to idle agents after the customer is connected; Esl service can maintain the current state of the conference through some conference events; 3. Load balancing service: obtain the nearest access to the access layer address through the load balancing service, for example. For urgent tasks, more resources can be allocated to ensure better call quality, 4 Business services provide multimedia message services: 5. Registration center: responsible for exchanging information.

Refer to FIG. 39-3 for the system message flow architecture diagram. The flow chart of sending events from the server to the user includes the following components: 1 FreeSwitch: FreeSWITCH is an open source telephone softswitch platform that supports SIP. Skype, H323. IAX and Google Talk and other communication protocols, support voice codecs of various bandwidths, support 8K, 16K, 32K and 48 KHz high-definition calls;

2. ESL. FreeSWITCH is an open source telephone softswitch platform that supports communication protocols such as SIP. Skype, H323, IAX and Google Talk, supports voice codecs of various bandwidths, and supports high-definition calls of 8K, 16K, 32K and 48 KHz; ESL can make outbound calls to customers in batches, and transfer them to idle seats after the customers are connected; ESL service can maintain the current status of the meeting through some conference events; 3. Routing service provide message routing service; 4. Access layer service: Provide services related to multimedia message access; 5. Downstream applications: server applications that send messages: 6. Business services: provide multimedia message services.

Refer to FIG. 39-4 for the flow of user-to-user message flow. The flow chart of user-to-user message flow includes the following components. 1. Access layer service provide services related to multimedia message access: 2. Load balancing service: obtain through the load balancing service Nearby access to the address of the access layer; 3. Business service provide multimedia message service.

Refer to FIG. 39-5 for the message storage process. The message storage flow chart includes the following components: 1. Access layer service: provide services related to multimedia message access; 2. Routing service: provide message routing service; 3. Message service: provide message Storage-related services; 4. Kafka: Provide message queue-related services; 5. Redis: Provide memory cache services; 6. ElasticSearch: Provide search services.

In the technical solution of the present disclosure, an appropriate interaction method can be selected according to business emergencies, business types, network conditions, etc. For example, for on-site operations and the need to understand the on-site operations, VR can be used. Those with high requirements can use instant messaging IM service.

Adopting the technical solution of the present disclosure, the IT resource service provides unified monitoring including computing resources, storage resources and network resources for the support layer, the artificial intelligence business platform layer, and the city operation comprehensive IOC layer according to different needs such as business volume and time, and dynamic allocation services. The help of this technical solution to the product is as follows: 1) TTS-based voice broadcast mode and STT-based multimedia input mode can make human-computer interaction more convenient and diversified; 2) Pre-plan demonstration and simulation based on AR and VR technology are more substantial Improve the intuition and immersion of human-computer interaction, making the human-computer interaction more intuitive and convenient; 3) Streaming media technology makes the types of interactive media more diverse and provides different media interaction methods.

Cloud management platform, including technology numbered B1-1 IT resource service provides unified monitoring and dynamic allocation services including computing resources, storage resources and network resources for the support layer, artificial intelligence business platform layer and urban operation comprehensive IOC layer according to different needs such as business volume and time.

The implementation manner of the IT resource service platform in the embodiments of the present disclosure will be described in detail below in conjunction with exemplary embodiments.

### B1-1-85—Cloud Management Platform.

At present, the cloud management platform has been widely used in various industries relying on powerful cloud computing capabilities, but the cloud management platform in related technologies is not yet mature enough. Related products based on the cloud management platform lack comprehensive monitoring of the cloud physical environment.

The cloud management platform in related technologies has the following problems: lack of multi-path and multi-method technology to obtain cloud physical environment parameters; cannot be flexibly applied to any type of cloud physical equipment; cannot perform customized service configuration and maintenance according to different application scenarios. It is not possible to physically power off, restart and maintain cloud physical equipment remotely, it can abstract cloud physical equipment into a 3D virtual model, but it cannot map the operation of the 3D model to the actual cloud physical equipment and cloud physical environment monitoring equipment. Cloud physical environment monitoring equipment cannot transmit monitoring data through active+passive multi-mode methods; it cannot perform service installation and management configuration on bare metal cloud physical machines.

Based on the above technical problems, the embodiments of the present disclosure provide a cloud management platform, which can be applied in the multi-mode heterogeneous system as shown in FIG. 1, and is compatible with the terminal layer (including various sensors, etc.) of the multi-mode heterogeneous system in this embodiment.), the communication layer (including base stations, gateways, etc.), and the support layer (including data centers, core networks, etc) interact to perform dynamic and linkage control on the entire multi-mode heterogeneous system. The cloud management platform in this embodiment provides IT resource operation and maintenance services externally. The IT resource operation and maintenance service can uniformly manage and virtualize the IT resources in the computer room and provide resources to other system interfaces to call the operation and maintenance of IT resources. Other aspects of this embodiment. The system can be but not limited to: business system, business support system, basic data acquisition system, communication system, business application system, etc.

An embodiment of the present disclosure provides a cloud management platform, the platform includes, a unified management system, a unified monitoring system, a unified operation and maintenance system, a unified secure system, a 3D twin system, and a user management system, wherein.

The unified management system is used for unified management of cloud physical equipment and cloud physical environment;

The unified monitoring system is used to dynamically monitor the cloud physical environment, cloud physical equipment, and state parameters of network equipment;

The unified operation and maintenance system is used to perform unified operation and maintenance management on the physical equipment and physical environment of all cloud computer rooms;

The unified secure system is used to protect the operation security and network security of the cloud management platform;

The three-dimensional twin system is used to establish and display the three-dimensional twin model of the cloud computer room;

The user management system is used for editing user accounts of the cloud management platform, managing role permissions of the user accounts, and managing operation logs.

Wherein, the unified management system is also used for: managing cloud computer room resources.

Wherein, the unified management system is also used to: monitor at least one of the following information of the cloud physical environment through a passive radio frequency tag reading and writing device: temperature, humidity, moisture content, pressure, voltage, current, power, gas content. Airflow speed, airflow direction.

Wherein, the unified management system is also used to: monitor at least one of the following information of the cloud physical environment through an active wireless monitoring device:

temperature, humidity, moisture content, pressure, voltage, current, power, gas content, airflow velocity. Airflow direction.

Wherein, the unified management system is also used to monitor at least one of the following information of the cloud physical environment through a dual-mode device including active wireless monitoring and passive radio frequency: temperature, humidity, moisture content, pressure, voltage, current, power, gas content, airflow velocity, airflow direction.

Wherein, the unified management system is further configured to: dynamically expand and connect computing resources of multiple types of physical devices through interfaces, and manage the computing resources through corresponding interfaces.

Wherein, the unified management system is further used for: virtualizing computing resources of physical devices into computing resources; or indirectly managing and connecting computing resources of physical devices through a virtualization platform.

Wherein, the unified management system is further configured to, dynamically expand and connect multiple types of storage resources through interfaces, and manage the storage resources through corresponding interfaces.

Wherein, the unified management system is also used for: docking network devices with multiple physical interfaces, wherein the multiple physical interfaces include at least one of the following: 10M network interface, 100M network interface, 1000M network interface. Mega network interface, custom circuit.

Wherein, the unified management system is also used for: dynamically expanding and connecting network protocols of multiple interface network devices.

Wherein, the unified management system is also used for: dynamically expanding and docking multiple interface level protection security equipment, wherein the level protection security equipment includes at least one of the following: port firewall, anti-DDOS traffic cleaning, vulnerability scanning, SSL VPN, WEB firewall, WEB anti-tampering system, intrusion prevention system, intrusion detection system, network behavior audit system, database design system, operation and maintenance audit system, anti-virus management system, intranet security management system, application monitoring system.

Wherein, the unified management system is also used for: dynamically expanding and docking cryptographic devices with multiple interfaces, wherein the cryptographic devices include at least one of the following server cipher machine, collaborative signature system, key management system, security Authentication gateway, signature verification server, IPSec VPN security gateway, SSL VPN security gateway, digital certificate authentication system, time stamp server, security access control system, dynamic token, electronic seal system, cloud server cipher machine, digital watermark system, database encryption system.

Wherein, the unified management system is also used to dynamically expand and access monitoring-aware resources of multiple interfaces, wherein the monitoring-aware resources include at least one of the following: video monitoring resources, access control identity authentication equipment, temperature. Humidity, moisture content, pressure, voltage, current, power, gas content, airflow velocity, airflow direction.

Wherein, the state parameters include at least one of the following: operating parameters, used resources, remaining resources, physical entity parameters, virtual platform parameters, and container platform parameters.

Wherein, the unified monitoring system is also used to: perform dynamic real-time monitoring on the equipment in the cloud computer room; determine whether the monitoring data exceeds the set threshold; if the monitoring data exceeds the set threshold, generate an alarm of the corresponding level according to the preset alarm rules information, wherein the alarm rules include multi-level alarm levels configured according to scenario requirements and management requirements Wherein, the unified monitoring system is further configured to: obtain monitoring data of the cloud physical environment from the cloud environment sensing integration device through dynamic expansion.

Wherein, the unified monitoring system is further used for, indirectly obtaining the monitoring data of the cloud physical environment through the physical environment monitoring platform in a dynamic expansion manner.

Wherein, the unified monitoring system is also used to: directly access multiple types of cloud physical devices through dynamic expansion, and monitor at least one of the following status information of the cloud physical devices: computing resources, computing performance, storage resources. Storage performance.

Wherein, the unified monitoring system is further configured to: indirectly access multiple types of cloud physical devices through a resource virtualization platform through dynamic expansion, and monitor computing resources and storage resources of the cloud physical devices.

Wherein, the unified monitoring system is also used to: indirectly access multiple types of cloud physical devices through a virtualization platform through dynamic expansion, and monitor the computing performance and storage performance of the cloud physical devices;

Wherein, the unified monitoring system is further used for, accessing network devices of multiple types and protocol interfaces through dynamic expansion, and acquiring dynamic network parameters of the network devices.

Wherein, the unified monitoring system is further used for accessing the hierarchical protection safety equipment through dynamic expansion, and acquiring the monitoring data of the hierarchical protection safety equipment.

Wherein, the unified monitoring system is also used for: accessing the monitoring equipment of the cloud physical environment through dynamic expansion, and obtaining the monitoring data of the monitoring equipment, wherein the monitoring data includes at least one of the following: temperature, humidity, moisture content, pressure, voltage, current, power, gas content, airflow velocity, and airflow direction.

Wherein, the unified monitoring system is also used for: classification management and statistical alarm level notification.

Wherein, the unified monitoring system is also used for: pushing the monitored monitoring data and alarm information to the mobile terminal.

Wherein, the unified monitoring system is also used for: managing bare metal servers and monitoring data access.

Wherein, the unified monitoring system is also used to: monitor at least one of the following state parameters of the cloud physical device connected to the cloud management platform: memory state, total memory size, number of memory sticks, memory location, single memory capacity, memory production Manufacturer, memory serial number, memory factory date, status of each memory, number of CPUs, total number of CPU cores, CPU model, number of cores per CPU, number of threads per CPU, location of each CPU, manufacturer of each CPU, and number of threads per CPU CPU status, obtain server SN code, number of power supplies, status of each power supply, serial number of each power supply, wattage of each power supply, number of fans, status of each fan, obtain Raid card model, number of hard disks, hard disk size, hard disk type. Hard disk manufacturer, hard disk location, hard disk speed, hard disk serial number, hard disk status, hard disk interface type.

Wherein, the unified monitoring system is further used for, analyzing the access monitoring data in time and space dimensions, and generating a visual chart.

Wherein, the unified monitoring system is also used for: performing big data situation algorithm calculation on the connected monitoring data, obtaining current situation information of the monitoring cloud management platform in various dimensions, and converting the posture information into visual information.

Wherein, the unified operation and maintenance system is also used for: judging whether the monitored dynamic data is greater than the preset alarm threshold; if the dynamic data is greater than the preset alarm threshold, triggering alarm information, wherein the alarm threshold is related to the Correspondence to demand.

Wherein, the unified operation and maintenance system is further used for: classifying the monitoring data according to the degree of importance, and grading the alarm information triggered by the monitoring data according to the category of the monitoring data.

Wherein, the unified operation and maintenance system is further used for: searching for the linkage personnel matching the alarm personnel, and notifying the linkage personnel of the alarm information in various notification ways.

Wherein, the unified operation and maintenance system is further configured to: search for a control device that matches the alarm name, and when an alarm with the alarm name occurs, link the control device to perform corresponding operations.

Wherein, the unified operation and maintenance system is also used for: performing on-site or remote operation and maintenance management operations on the cloud physical environment, wherein the operation and maintenance management operations include at least one of the following opening, closing, scaling up, scaling down. Adjust higher, lower, faster, slower, adjust position, adjust time, adjust sensitivity, adjust threshold, adjust brightness and darkness. Wherein, the unified operation and maintenance system is also used for: performing on-site or remote operation and maintenance management operations on the cloud physical equipment, wherein the operation and maintenance management operation is at least one of the following: powering on and powering off the cloud physical equipment. Virtualize cloud physical device resources, view, allocate, change, add, delete, enable, deactivate, open, close operations on virtualized resources, view, allocate, change, network environment and network devices. Add, delete, enable, disable, open, close operations.

Wherein, the unified operation and maintenance system is also used to: record the operation and maintenance problems and solutions that occurred in the historical time; associate and archive the operation and maintenance problems and corresponding solutions; if the same type of operation and maintenance problems are detected in real time. Find the corresponding solution from the archived information.

Wherein, the unified secure system is also used for unified management, monitoring and operation of the following security systems of the cloud management platform: firewall, anti-DDOS traffic cleaning, vulnerability scanning, SSL VPN, WEB firewall, WEB anti-tampering system, intrusion Protection system, intrusion detection system, network behavior audit system, database audit system, operation and maintenance audit system, anti-virus management system, intranet security management system.

Wherein, the unified secure system is also used for: statistics, analysis, and display of DDOS attacks received by the current cloud management platform, and supports configurable policies to clean network traffic received by the cloud management platform.

Wherein, the unified secure system is also used for: performing vulnerability scanning and building repair on the cloud management platform.

Wherein, the unified secure system is also used for: adopting SSL VPN to perform identity authentication, encryption and tamper-proof operations for application access connections Wherein, the unified secure system is also used for detecting and defending against network attacks from the WEB side at the seventh layer of the Internet network through the WEB firewall. Wherein, the unified secure system is also used for: using intrusion monitoring technology and intrusion prevention technology, performing sand table drill and exception identification on dynamic code, executing and stopping transmission of dynamic code.

Wherein, the unified secure system is also used to audit logs or alarm summaries and traffic records in the form of traffic audit or behavior audit through host audit, network sniffer audit, bastion machine audit, and transparent bridge deployment.

Wherein, the unified secure system is also used to analyze, analyze, record, and report database access behaviors through database auditing, so as to realize pre-planning and prevention, real-time monitoring during events, response to violations, post-event compliance reporting, accident Track and trace.

Wherein, the unified secure system further includes an operation and maintenance audit component, and the operation and maintenance audit component includes functions of single sign-on, account management, identity authentication, resource authorization, access control and operation audit. Wherein, the unified secure system is also used for: using a gene recognition engine to scan viruses and accurately identify known network viruses and unknown network viruses.

Wherein, the unified secure system also includes: an intranet security management component, and the intranet security management component is used to perform the following security operations: security monitoring, security warning, security notification, security protection, emergency response, decision analysis, asset management, policy configuration, list management, security management notification, operation and maintenance monitoring, intelligent update.

Wherein, the 3D twin system is also used for.

Through the three-dimensional visualization technology, a three-dimensional twin model of the cloud computer room is established, and the three-dimensional twin model is used to display the equipment model uniformly managed by the unified management system, the status data uniformly monitored by the unified monitoring system, and the unified operation and maintenance. The unified operation and maintenance interface of the system shows the unified computing situation of the unified secure system.

Wherein, the 3D twin system is also used for′.

Generate a three-dimensional model of the computer room environment according to the size of the input computer room.

Wherein, the 3D twin system is also used for.

Add the sensing monitoring equipment model of the cloud physical environment to the cloud computer room to form a subordinate model of the 3D twin model, the sensing monitoring equipment model is connected with the entity sensing monitoring equipment, and transmit the data sensed by the entity sensing monitoring equipment to the 3D twin model exhibit.

Wherein, the 3D twin system is also used for:

Map the operation of the sensing monitoring device model to the entity's sensing monitoring device, and perform the same operation on the entity's sensing monitoring device, wherein the mapped operation includes at least one of the following: open, close, increase, decrease, increase, adjust down, adjust up, adjust down, adjust position, adjust time, adjust sensitivity, adjust threshold, adjust brightness and darkness.

Wherein, the 3D twin system is also used for.

According to the quantity, model, and arrangement of the input physical cabinets, a three-dimensional model of the cabinets is generated, wherein the three-dimensional model of the cabinets is used to display basic attribute information and dynamic information of the cabinets. Wherein, the 3D twin system is also used for:

Operate the 3D model of the cabinet and map the corresponding operation to the physical cabinet. Wherein, the 3D twinning system is further configured to: add the 3D model of the cloud physical equipment to the space in each cabinet of the 3D model of the cabinet to form a subordinate model of the 3D model of the cabinet in the space, wherein the 3D model of the device of the cloud physics is used to display the monitoring parameters of the cloud physical device.

Wherein, the 3D twin system is also used for.

Operate the cloud physical device model added to the multi-mode heterogeneous system, and map the operation to the cloud physical device of the entity.

Wherein, the 3D twin system is also used for.

The network environment information of the cloud computer room is displayed, wherein the network environment information includes network connection link status, network usage and remaining bandwidth status, network interface usage and remaining status.

Wherein, the 3D twin system is also used for.

Operate the network environment device model and map the operation to the entity's network environment device.

Wherein, the 3D twin system is also used for: operating the safety device model, and mapping the operation to the physical safety device.

Wherein, the user management system is also used for:

Add, delete, modify, and query users by category based on user accounts, or add, delete, modify, and query users by roles based on user accounts.

Wherein, the user management system is combined with the identity authentication secure device to construct a fusion system of secure user addition, authentication, and access rights management, wherein the fusion system adds users by the user management system, and then assigns a unique identity ID by the identity authentication device and a corresponding security key, the unique ID and security key are used for the identity secure device to authenticate the user when the user logs in, and the carrier of the unique ID and security key corresponds to the user login carrier. Wherein, the user management system is also used for′.

Assign and manage the permissions of roles for user accounts. When a user creates a user account, at least one role is bound, and the role is used to determine the scope of permissions of the corresponding user account.

Wherein, the user management system is also used for.

Divide the authority scope of user accounts based on the operation authority of page buttons; divide the authority scope of user accounts by page display authority; divide the authority scope of user accounts by browsing, operating, modifying, and using data; divide by calling and disabling interfaces. The permission scope of the user account.

Wherein, the user management system is also used for collecting, storing, indexing, and displaying the operation log of the user account, wherein the operation log refers to the operation log of the cloud management platform, and the operation log is collected according to different collection paths Classification and hierarchical storage, the operation log is indexed according to the browsing authority of the data, and the operation log uses a visual chart to classify and analyze the situation of the log record and then display it.

The following describes the embodiment scheme of the present disclosure in detail in conjunction with FIG. 85-1:

As shown in FIG. 85-1, this embodiment is applicable to the installation and deployment of information systems in any industry and the management of computer room equipment, and is applicable to the management of data center computer rooms and equipment in any scale, and is suitable for self-built cloud computer rooms and public Management of cloud computer room and computer room equipment. It is suitable for the management of the integrated intelligent cabinet. It is suitable for on-site and remote cloud platform computer room management.

The following describes the cloud management platform of this embodiment with reference to FIG. 85-1. The operation process of the cloud management platform includes:

Step 1. Unify the management system, connect the cloud physical device interface, the cloud physical environment device interface, the network environment device interface, and the secure device interface through the cloud physical device protocol, cloud physical environment device protocol, network environment device protocol, and secure device protocol. Add, modify, and connect related devices.

After step 2 and step 1 are completed, the monitoring data of cloud physical equipment, cloud physical environment equipment, network environment equipment, and security equipment can be aggregated to the cloud management platform, data analysis is performed on the aggregated data, alarm events and monitoring situations are analyzed, and then. The results of the analysis are presented.

After step 3 and step 2 are completed, according to the analyzed monitoring situation and alarm information, the analysis results will be pushed to the linkage personnel configured on the cloud management platform, and then the system will intelligently provide solutions based on historical operation and maintenance management records. The solutions are divided into There are two schemes, automatic operation and maintenance and manual operation and maintenance, and then carry out precise operation and maintenance operations according to different types of equipment. After steps 4 and 3 are completed, unified operation and maintenance management forms a closed loop.

Step 5. Unify the security system, which is a closed-loop system, and the interface of the docking secure device analyzes the security situation data of the security boundary and detects the situation.

After sensing an alarm event, analyze and make a decision on the security event, and then configure the secure device and replace the policy through the secure device interface. Form a record and knowledge base of security decisions after security incidents are resolved. This knowledge base and records provide the basis for security decisions.

Step 6. The 3D twin system establishes a 3D model according to the parameters of cloud physical equipment, cloud physical environment equipment, network environment equipment, and security equipment, and the interface of the docking equipment forms a mapping relationship between the model and the physical equipment. The 3D model can then be interacted with and the interactions mapped to the physical device. And the data generated by the physical equipment can be displayed in the 3D model, and the data of the cabinet and the computer room can also be displayed in the 3D model.

Step 7. The overall cloud management platform provides external IT resource operation and maintenance services. The IT resource operation and maintenance service can uniformly manage and virtualize the IT resources in the computer room, and provide resources to other system interfaces to call the operation and maintenance of IT resources.

As shown in FIG. 85-1, the components of the cloud management platform include: unified management system, unified monitoring system, unified operation and maintenance system, unified secure system, 3D twin system, and user management system. The various systems of the cloud management platform are explained and illustrated in detail below in conjunction with exemplary implementation methods.

In one implementation of this embodiment, as shown in FIG. 85-2, the unified management system is a system for unified management of the physical equipment and physical environment of the cloud management platform, including computing resources, storage resources, and network resources of the cloud computer room, resources, security resources, and monitoring and sensing resources for unified resource management. Including: secure device management, network environment device management, cloud physical device management, cloud physical environment device management, connecting with associated hardware through corresponding protocols and interfaces. The unified management system can realize the following functions:

The unified management system can comprehensively manage the resources of the cloud computer room;

The unified management system can monitor the cloud physical environment including temperature, humidity, moisture content, pressure, voltage, current, power, gas content, airflow speed, airflow direction, etc through passive radio frequency tag reading and writing equipment;

The unified management system can monitor the cloud physical environment including temperature, humidity, moisture content, pressure, voltage, current, power, gas content, airflow velocity, airflow direction, etc. through active wireless monitoring equipment; The unified management system can monitor the cloud physical environment including temperature, humidity, moisture content, pressure, voltage, current, power, gas content, airflow velocity, airflow direction, etc by including active wireless monitoring and passive radio frequency dual-mode equipment;

The unified management system can dynamically expand and connect to and manage the computing resources of any interface. It can directly connect to the computing resources of physical devices and virtualize them as computing resources, or connect to the virtualization platform to indirectly manage and connect to the computing resources of physical devices;

The unified management system can dynamically expand and connect and manage storage resources of any interface.

The unified management system can be connected to network devices with any physical interface, including 10M network interface, 100M network interface. Gigabit network interface, 10G network interface, custom circuit, etc.;

The unified management system can dynamically expand and connect to the docking protocol of any interface network device:

The unified management system can dynamically expand and connect to any interface level protection secure device, including port firewall, anti-DDOS traffic cleaning, vulnerability scanning, SSL VPN, WEB firewall, WEB anti-tampering system, intrusion prevention system, intrusion detection system, network behavior audit system, database design system, operation and maintenance audit system, anti-virus management system, intranet security management system, application monitoring system, etc.

The unified management system can dynamically expand and connect to any interface cryptographic devices, including server cipher machines, collaborative signature systems, key management systems, security authentication gateways, signature verification servers, IPSec VPN security gateways, SSL VPN security gateways, and digital certificate authentication System, time stamp server, security access control system, dynamic token, electronic seal system, cloud server cipher machine, digital watermark system, database encryption system, etc.;

The unified management system can dynamically expand and access monitoring-aware resources of any interface, including video monitoring resources, access control authentication equipment, temperature, humidity, moisture content, pressure, voltage, current, power, gas content, airflow velocity, and airflow direction sensory equipment, etc.

In an implementation of this embodiment, as shown in FIG. 85-3, it shows the structure and operation logic of the unified monitoring system, which is used to dynamically monitor the cloud physical environment, cloud physical equipment, network equipment operating parameters, and resource usage, remaining resources, physical entity parameters, virtual platform parameters, container platform parameters and other cloud operation management systems that can monitor data. Use secure device interfaces to monitor security resources and security monitoring data, use network environment device interfaces to monitor network resources and network device operating parameters, use cloud physical device interfaces to monitor remaining resources, used resources, operating parameters, and container resources, and use cloud physical environment device interfaces Monitor real-time monitoring parameters, then aggregate the above monitoring data, analyze the aggregated monitoring data, and finally display the monitoring posture, or generate monitoring data alarms and then display the monitoring posture. The unified monitoring system can realize the following functions:

The unified monitoring system can monitor all the equipment in the cloud computer room dynamically and in real time, and can configure alarm rules. When the data exceeds the set threshold, the alarm rules will be triggered to give different levels of alarms. The alarm levels can be freely configured in multiple levels according to scenario requirements and management requirements.

The unified monitoring system can directly connect to cloud environment sensing integrated equipment to obtain cloud physical environment monitoring data through dynamic expansion; The unified monitoring system can obtain cloud physical environment monitoring data indirectly through the physical environment monitoring platform through dynamic expansion; The unified monitoring system can directly connect to any type of cloud physical equipment through dynamic expansion, and monitor computing resources, computing performance, storage resources, and storage performance;

The unified monitoring system can indirectly access any type of cloud physical equipment through the computing and storage resource virtualization platform through dynamic expansion, and monitor computing resources and storage resources;

The unified monitoring system can indirectly access any type of cloud physical equipment through the computing and storage performance virtualization platform through dynamic expansion, and monitor computing performance and storage performance;

The unified monitoring system can access network devices of any type and protocol interface through dynamic expansion, and obtain dynamic network parameters.

The unified monitoring system can access level-protected safety equipment through dynamic expansion, and obtain the monitoring data of level-protected safety equipment.

The unified monitoring system can be dynamically expanded to access the monitoring equipment of the cloud physical environment, and obtain monitoring data including temperature, humidity, moisture content, pressure, voltage, current, power, gas content, airflow velocity, and airflow direction.

The unified monitoring system can perform classification management and statistics according to the alarm level notification.

The monitoring data and alarm information involved in unified monitoring can be pushed to mobile end users for viewing and processing.

The unified monitoring system can manage bare metal servers and access monitoring data. The unified monitoring system can monitor the memory status, total memory size, number of memory sticks, memory location, single memory capacity, memory manufacturer, memory serial number, memory factory time, each memory state, number of CPUs, total CPU Number of cores, CPU model, number of cores per CPU, number of threads per CPU, location of each CPU, manufacturer of each CPU, status of each CPU, server SN code, quantity of power supplies, status of each power supply, and power supply of each CPU Serial number, wattage of each power supply, number of fans, status of each fan, access to Raid card model, number of hard disks, hard disk size, hard disk type, hard disk manufacturer, hard disk location, hard disk speed, hard disk serial number, hard disk status, hard disk interface type and other parameters.

The unified monitoring system can analyze the connected monitoring data in time and space dimensions, and form an analysis chart, which is convenient for operation and maintenance personnel to analyze and view.

The unified monitoring system can calculate the situation algorithm of big data according to the access data, evaluate the situation of each dimension of the current monitoring cloud management platform, and display it visually.

In an implementation of this embodiment, as shown in FIG. 85-4, it illustrates the structure and operation logic of the unified operation and maintenance system, which can manage the unified operation and maintenance of the physical equipment and environment of all cloud computer rooms. Monitor data alarms, push alarms to operation and maintenance personnel, intelligently issue alarm solutions, and then adopt automatic or manual operation and maintenance operations, including: operating security equipment, operating network environment equipment, operating cloud physical environment equipment, so as to realize dynamic linkage control, the unified operation and maintenance system can realize the following functions:

The unified operation and maintenance system monitors the dynamic data accessed in a unified manner, sets the alarm threshold according to business needs, and triggers an alarm message when the data exceeds the threshold.

The unified operation and maintenance system can classify the importance of monitoring data, thereby grading the level of alarms, and can classify multi-level alarms. For example, if an alarm occurs on important parameter data, it is regarded as a high-level alarm.

The unified operation and maintenance system can automatically configure the linkage between alarm names and personnel, and assign specific types of alarms to specific personnel. When an alarm occurs, it can be automatically linked to notify relevant personnel in any notification method. The unified operation and maintenance system can configure the linkage between the alarm name and the control equipment. When an alarm occurs, it can automatically link the control equipment to perform corresponding operations.

The unified operation and maintenance system can perform on-site or remote operation and maintenance management operations on the cloud physical environment. The operation and maintenance management operations include opening, closing, increasing, reducing, increasing, decreasing, adjusting fast, adjusting Time, adjust sensitivity, adjust threshold, adjust light and dark, etc. All operations related to cloud computer room operation and maintenance.

The unified operation and maintenance system can perform on-site or remote operation and maintenance management operations on cloud physical devices. Operation and maintenance management operations include power-on and power-off processing of cloud physical devices. Operation and maintenance management operations include virtualizing cloud physical device resources, viewing, allocating, changing, adding, deleting, enabling, deactivating, opening, and closing virtualized resources. Operation and maintenance management operations include viewing, assigning, changing, adding, deleting, enabling, deactivating, opening, and closing operations on the network environment and network devices.

The unified operation and maintenance system can record, regularize and archive the operation and maintenance problems and solutions that occurred in the past. When similar operation and maintenance problems occur, the intelligent index analyzes the archives and gives corresponding solutions.

In an implementation of this embodiment, as shown in FIG. 85-5, it illustrates the structure and operation logic of the unified secure system. The unified secure system is a system used to protect the operation security and network security of the cloud management platform Access to various security software and hardware through the secure device interface, cloud environment security awareness, trigger secure device alarms, execute security decisions, and then perform secure device operations, execute security practice records and archives, and guide security if similar secure device alarms occur in the future decision making. The unified secure system can realize the following functions:

The unified secure system can manage cloud management based on the platform's port firewall, anti-DDOS traffic cleaning, vulnerability scanning, SSL VPN, WEB firewall, WEB anti-tampering system, intrusion prevention system, intrusion detection system, network behavior audit system, database audit system, operation Unified management, monitoring and operation of the maintenance audit system, anti-virus management system, and intranet security management system.

The unified secure system can count, analyze, and display the DDOS attacks received by the current cloud management platform, and supports configurable policies to clean the traffic.

The unified secure system can perform vulnerability scanning and automatic repair functions on the cloud management platform.

The unified secure system includes SSL VPN technology, which provides authentication, encryption and tamper-proof functions for application access connections.

The unified secure system includes WEB firewall technology, which can detect and defend against WEB-side attacks at the seventh layer of the Internet network.

The unified secure system includes intrusion monitoring technology and intrusion prevention technology, which can conduct sand table drills on dynamic codes and identify abnormalities, execute them and stop transmission operations.

The unified secure system includes network behavior auditing technology, which can audit logs/alarm summaries and traffic records in two forms; traditional auditing and behavioral auditing, through host auditing, network sniffer auditing, bastion machine auditing, and transparent bridge deployment.

The unified secure system includes database auditing technology, which can analyze, analyze, record, and report through various database access behaviors to help plan prevention in advance, real-time monitoring during the event, response to violations, compliance reporting after the event, and accident tracking.

The unified secure system includes operation and maintenance audit technology, including functions of single sign-on, account management, identity authentication, resource authorization, access control and operation audit.

The unified secure system includes anti-virus management technology, which can be connected to the gene recognition engine to scan for viruses and accurately identify known and unknown threats. The unified secure system includes intranet security management technology, which can perform security monitoring, security warning, security notification, security protection, emergency response, decision analysis, asset management, policy configuration, list management, security management notification, operation and maintenance monitoring, and intelligent update, safe operation.

In one implementation of this embodiment, as shown in FIG. 85-6, the structure and operation logic of the 3D twinning system are illustrated. The 3D twinning system uses 3D visualization technology to establish a twinning model of the computer room and display a unified management equipment model. Display the status data of unified monitoring, display the interface for docking with unified operation and maintenance, and display the situation of unified security. Including data display, 3D computer room display, 3D cabinet display, 3D model of equipment and 3D model of security equipment, 3D model of network environment equipment, 3D model of cloud physical environment equipment for interaction, 3D model of security equipment, 3D model of network environment equipment, cloud physical environment. The 3D model of the equipment is associated with the corresponding physical equipment through the interface. The 3D twin system can realize the following functions:

The 3D twin system can automatically generate a 3D model of the computer room environment according to the size of the input computer room.

The 3D twin system can add the sensing and monitoring equipment model of the cloud physical environment to the computer room to form a subordinate relationship. And it can be connected with physical sensing and monitoring equipment, and the data can be displayed on the 3D model. The 3D twin system can map the operation of the model of the sensory monitoring device to the sensory monitoring device of the entity, and perform the same operation on the sensory monitoring device of the entity. The operations that can be mapped include open, close, increase, decrease, increase, decrease, speed up, slow down, position adjustment, time adjustment, sensitivity adjustment, threshold adjustment, brightness adjustment, etc.

The 3D twin system can automatically generate a 3D model of the cabinet according to the quantity, model, and arrangement of the input cabinets, and can display the basic information and dynamic information of the cabinet.

The 3D twin system can operate on the model of the cabinet and map the operation to the solid cabinet.

The 3D twin system can add a 3D model of cloud physical equipment to the space in each cabinet to form a spatial affiliation. And it can display the monitoring parameters of cloud physical devices. The 3D twin system can operate on each added cloud physical device model, and map the operation to the physical cloud physical device.

The 3D twin system can display the network environment of the computer room, including network connection link status, network usage and remaining bandwidth monitoring, network interface usage and remaining status, etc.

The 3D twin system can operate on each network environment equipment model, and map the operation to the entity network environment equipment.

The 3D twin system can operate on each safety device model and map the operation to the physical safety device.

In an implementation of this embodiment, the cloud management platform further includes a user management system, which is a system for adding, deleting, modifying, and querying users of the cloud management platform, role authority management, and operation log records. The user management system can realize the following functions:

The user management system can classify users, add, delete, modify, and query by role. The user management system can be combined with hardware identity authentication secure devices to establish a system for secure user addition, authentication, and access rights management. The user is added by the user management system, and the unique identity ID and corresponding security key are assigned by the identity authentication device. When a user logs in, the identity secure device authenticates the user through a unique ID and a security key, ensuring the security of the user's login. The carrier of the unique identity ID and the security key can take any form according to the difference of the user's login carrier.

The user management system can assign and manage the rights of roles. When a user is created, the scope of the user's rights is determined by binding with the role.

There are many ways to divide the permissions of the user management system. It can be divided by the operation authority of the page button; it can be divided by the display authority of the page; it can be divided by the browsing, operation, modification and use authority of the data; it can be divided by calling and disabling the interface.

The user management system can collect, store, index, and display user operation logs. The collection of operation logs includes not only the operation logs of the system, but also the operation logs of the corresponding unified management cloud management equipment, including the operation logs of the corresponding cloud management environment, including the operation logs of the unified secure system, including the unified operation and maintenance equipment. Operation logs of the virtual system. Operation log storage is classified and stored hierarchically according to different collection paths. The operation log index is indexed and displayed according to the browsing authority of the data. The operation log display is to classify and analyze the status of log records by using visual charts and then display them.

The cloud management platform (also referred to as IT resource service) provided by the embodiments of the present disclosure can perform unified resource management on cloud resources such as memory, hard disk, input/output interface, CPU and/or GPU. It can also dynamically expand and manage the computing resources connected to any interface: it can directly connect to the computing resources of physical devices and virtualize them as computing resources, or it can connect to the virtualization platform to indirectly manage and connect the computing resources of physical devices. As an example, what the cloud management platform implements is the allocation and use of computing resources on the platform side. The “edge computing platform” in the multi-mode heterogeneous IoT sensing platform and the artificial intelligence industry algorithm middle platform are used to allocate computing tasks among platforms, gateways/base stations and terminals.

By adopting the cloud management platform of this embodiment, combined with multi-mode heterogeneous application scenarios, the following technical effect can be achieved: the cloud physical environment can be monitored comprehensively. Multi-path, multi-method technology to obtain cloud physical environment parameters. Flexible for any type of cloud physical device. Customized service configuration and keep alive according to different application scenarios. Remotely perform physical power-off restart and maintenance on cloud physical devices. The cloud physical equipment is abstracted into a 3D virtual model, and the 3D model operation is mapped to the actual cloud physical equipment and cloud physical environment monitoring equipment. Transmission of monitoring data through active+passive multi-mode Perform service installation and management configuration on bare metal cloud physical machines. IT resources are managed in a unified manner, and unified IT resource operation and maintenance services are provided externally to improve the efficiency of operation, maintenance and management.

Vertical three-tier association, among which the blockchain security management platform includes technologies from S1-1 to S1-4.

The three vertical verticals are security, operation and maintenance, and IT resource services, in which security and operation and maintenance vertically run through all horizontal levels, providing full-chain, end-to-end unified security and unified operation and maintenance services. The security management platform starts with multi-mode heterogeneous network security, and dynamically controls security from the root, instead of only ensuring security at the platform layer. The implementation of the security management platform in the embodiments of the present disclosure will be described in detail below in conjunction with exemplary embodiments.

S1-1-86—Blockchain security management platform.

At present, there is a large amount of data interaction in business systems, and how to ensure data security is a technical problem that needs to be solved urgently.

The defects or problems in the products or technologies in the related technologies are as follows, the data storage security generated by the business system is untrustworthy; the data transmission link generated by the IoT sensing device has security problems, the IoT sensing device generates. The security problem of insufficient data transmission network authentication; the data generated by the IoT sensing device is transmitted in plain text, and once hijacked, the data information leaks; the IoT sensing device is easily hijacked and becomes a zombie device, the IoT sensing device. The one-size-fits-all adoption of a complex PKI system for security certification will greatly reduce the data transmission efficiency of IoT sensing devices; for business systems, a unified security management system and security services are conducive to the overall security and credibility of the system, and inconsistent security management systems will lead to There are problems with end-to-end mutual authentication, and inconsistent security services will lead to inconsistent system security and inconsistent security performance standards.

Based on the above technical problems, the embodiments of the present disclosure provide a blockchain security management platform, which can be applied in the multi-mode heterogeneous system as shown in FIG. 1, and is compatible with the terminal layer of the multi-mode heterogeneous system in this embodiment (including various sensors, etc.), the communication layer (including base stations, gateways, etc.), and the support layer (including data center, core network, etc.).

An embodiment of the present disclosure provides a blockchain security management platform, the platform includes:

Security resource components, security service components, and security management components, among which,

The security resource component includes a password resource pool, a key management system, and a signature verification system.

The security service component includes a lightweight authentication service interface, a security authentication service interface, and a blockchain service interface;

The security management component includes a communication security system, a network security system, a data security system, a situational awareness system, an emergency response system, a knowledge graph system, and a user management system.

Wherein, the password resource pool includes resources of key management capability and encryption and decryption capability in the password security product of the server. Wherein, the key management system includes symmetric keys, which are used to manage the generation, distribution, revocation, modification, and interface calling of symmetric key pairs, and are used to manage national secret algorithm keys and international algorithm keys.

Wherein, the signature verification system is used for performing digital signature services based on digital certificates for various types of electronic data, and verifying the authenticity and validity of signatures to the signature data.

Wherein, the signature verification system is also used to, use the private key in the asymmetric key pair to encrypt data during the signature process, and use the public key in the asymmetric key pair to encrypt the Ciphertext data during the signature verification process decrypting, wherein the asymmetric key pair includes the private key and the public key.

Wherein, the communication security system, is used to ensure hardware security, identity security, and data link security of IoT devices.

Wherein, the network security system: used to ensure the security of databases and application platforms.

Wherein, the network security system is used for performing identity authentication and data transmission protection on access data of network users by using a security area boundary and a security interface, wherein the security area boundary includes a gatekeeper or a firewall. Wherein, the data security system: used to ensure the anti-tampering and anti-leakage of data in the blockchain security management platform, and the environmental security of the database.

Wherein, the situational awareness system: is used to perform situational awareness according to the logs of the security management component, host log threat sensing data, and network backbone node data, and build an analysis model that conforms to the network and business, and the analysis model is used for The security situation is assessed, predicted and displayed.

Wherein, the emergency response system: is used for grading or classifying the alarms generated by the emergency response system, and automatically triggering an alarm handling process. Wherein, the knowledge map: classify and store the events of security alarm processing in a hierarchical manner, perform re-analysis and classification series of events conforming to the preset security level, and generate security decision-making data.

Wherein, the user management system: used for editing user accounts of the blockchain security management platform, role authority management, and operation log records.

Wherein, the lightweight authentication service interface is used for identity authentication and encrypted data transmission of the IoT device.

Wherein, the security authentication service interface is used for performing identity authentication and data encryption and decryption transmission for devices with a processing capability higher than a preset capability level.

Wherein, the blockchain service interface is used to ensure the security of data generated by IoT devices and users, which cannot be tampered with, and includes smart contracts and consensus mechanisms.

The blockchain security management platform of this embodiment can be applied in a security management system for end-to-end (Internet of Things devices to blockchain security platform) secure access and secure transmission.

The blockchain security management platform in this embodiment provides two lightweight authentication service processes and security authentication service processes that are suitable for secure access of various types of IoT devices to the cloud, so as to realize the communication between business systems and IoT devices. Secure data transmission.

The blockchain security management platform of this embodiment implements a method in which IoT device data is connected to the cloud through secure identity authentication, and the data can be uploaded to the blockchain, and ensures data non-tamper ability and traceability.

The blockchain security management platform of this embodiment is suitable for any scene where IoT devices are safely connected to the cloud; it is suitable for safely connecting any type of third-party platform data, providing a safe channel and data tamper-proof; it is suitable for and Combination of multiple communication types, such as LoRa, NB-IoT, LTE. Bluetooth, Zigbee.

Sub 1G, WLAN, 4G, 5G, etc.; suitable for IoT device data, user-generated data, and third-party access data Scenarios for secure access and uploading data to the blockchain for protection. The blockchain security management platform of this embodiment can provide an alternative new security certification method for the security certification of the traditional certificate system, thereby improving the security of the certification process.

The following is a detailed description of the embodiments of the present disclosure in conjunction with FIGS. 86-1 to 86-5:

As shown in FIG. 86-1, the blockchain security management platform of this embodiment is divided into three components, namely security resources, security services, and security management.

Among them, the security resource component includes a password resource pool, a key management system, a signature verification system, and a data encryption and decryption system. The password resource pool is pre-configured, and then based on the password resources and encryption and decryption algorithm resources in the password resource pool, a key management system, a signature verification system, and a data encryption and decryption system are established.

Security management components include communication security, network security, data security, situational awareness, emergency response, knowledge graph, user management and other systems. Among them, communication security, network security, and data security provide security situation awareness data for situational awareness; situational awareness analyzes the security situation; situational awareness provides the results to emergency response, and emergency response notifies relevant security personnel; then the entire security event Stored in the knowledge map for storage and recording; the knowledge map provides basis support for the configuration of communication security, network security, and data security, forming a closed loop Security service components include lightweight authentication services, security authentication services, and blockchain services. The security service component is based on the security resource component and under the call management of the security management component, it provides security services to the business system and the IoT terminal.

In an implementation of this embodiment, as shown in FIG. 86-2, an authentication service process of a security service component is shown, which is a lightweight authentication service process 1, which is an Internet of Things device access service platform, and through this embodiment. The process of secure access and data transmission on the blockchain security management platform. Lightweight authentication service process 1 is an authentication process with a symmetric algorithm as the core algorithm, and is applicable to national secret algorithms and international algorithms. The lightweight authentication service process 1 is divided into two stages, the key writing stage and the identity authentication stage. There are 3 roles involved: IoT devices, business platforms, and blockchain security management platforms. The key writing stage includes steps 1 to step 4, the identity authentication stage includes steps 5 to 19, and the overall steps include the following steps: Step 1: add IoT devices to the business platform, and initiate an application for key filling of IoT devices: The IoT device generates a list of unique identifiers of the TIT device, and sends the list to the blockchain security management platform. Step 3: The blockchain security management platform is generated by the key management component according to the type of the identifier of the IoT device. The symmetric key D corresponding to the IoT device; Step 4: Give the key of the IoT device to the business platform in the form of an image file or a Ciphertext security message. The business platform writes the symmetries key D of the IoT device into the IoT device through a secure interface. Step 5: Power on the IoT device, start the identity authentication process, and request the platform for identity authentication; Step 6: Embed the IoT device. For secure password products, send the device ID to the business platform; Step 7. The business platform performs whitelist verification on the lot device ID, and if the verification passes, it calls the security access service or/and lightweight authentication service of the blockchain security management platform, authenticating. If the verification fails, the service platform rejects the identity authentication request of the IoT device; Step 8. The blockchain security management platform generates a true random number R, and the key management system calculates the corresponding IoT device's password based on the IoT device ID. Key D, use the IoT device key D to encrypt the true random number R to generate DR, and perform hash calculation on DR to generate MACi. Then send the true random number R to the business platform; Step 9: The business platform forwards the true random number R to the IoT device, and requests the IoT device to authenticate the platform; Step 10: The IoT device uses its own secret key D to authenticate the platform Encrypt the true random number R. of the blockchain security management platform, and use the same hash algorithm to calculate and generate MAC1′; Step 11: The IoT device generates a true random number R2, and uses its own secret key D to compare the true random number R2 Encrypt and generate DR2. Then use the hash algorithm on DR2 to generate MAC2. Then send the MAC1′ generated in step 10 and the true random number R2 generated in step 11 to the business platform; step 12; the business platform forwards MAC1′ and R2, and requests the blockchain security management platform for authentication; step 13: blockchain security. The management platform obtains MAC1′ and compares it with the MAC1 calculated in step 8. If they are not equal, the identity verification of the device fails; if they are equal, proceed to step 14; step 14: use the IoT device secret key D to encrypt the true random number R2 of the IoT device. Generate DR2, use the bash algorithm to encrypt DR2 to generate MAC2′; Step 15: The blockchain security management platform encrypts R+R2 with the IoT device key D to generate the session key Km; Step 16: The blockchain security management platform converts MAC2′and the authentication result of the IoT device is forwarded to the business platform; step 17, the business platform forwards MAC2 to the IoT device, and the authentication result of the IoT device is retained; step 18, the IoT device receives the block chain forwarded by the business platform. The MAC2’ of the security management platform compares the MAC2′ with the local MAC2. If they are different, the authentication of the platform fails, and the intermediate process may be eavesdropped or attacked, and the two-way authentication process fails and ends. If they are the same, the authentication of the platform is successful, and the IoT device uses its own root key D to encrypt the true random number R+R2 to generate the session key Km; Step 19. The session between the IoT device and the blockchain security management platform is started. The secret key Km performs Ciphertext transmission of data.

In one implementation of this embodiment, as shown in FIG. 86-3, another authentication service process of the security service component is shown, which is the lightweight authentication service process 2, which is implemented based on symmetric and asymmetric algorithms for IoT devices and End-to-end two-way identity authentication between blockchain security management platforms. Applicable to national secret and international algorithms. The lightweight authentication service process 2 is divided into two major stages, the key writing stage and the identity authentication stage. There are three roles involved IoT devices, business platforms, and blockchain security management platforms. The key writing phase includes steps 1 to 4, and the identity authentication phase includes steps 5 to 13. The overall process includes the following steps:
Step 1. The service platform adds new equipment, and the key of the equipment needs to be filled;
Step 2: Generate a list based on the unique identifier of the device, and apply to the blockchain security management platform for the root key of the IoT device;
Step 3. The blockchain security management platform generates the private key S and symmetric key D of the IoT device according to the identification of the IoT device, and gives S, D and the public key K of the platform to the business platform;
Step 4: The business platform writes the private key S, symmetric root key D, and platform public key K of the IoT device in a safe way such as image files or ciphertexts;
Step 5. After the IoT device obtains the private key S of the IoT device, the symmetric root key D and the platform public key K, power on and start the identity authentication process;
Step 6: The IoT device generates a true random number R, encrypts R with a symmetric root key D to generate DR, and signs DR with a private key to generate SR. And send the device ID, time stamp, application algorithm, etc. of R, SR and IoT devices to the business platform;
Step 7. The business platform verifies whether the device ID of the IoT device is in the white list. If it is in the white list, it calls the lightweight identity verification service interface of the blockchain security management platform, and sends SR, R, and device ID to the block Chain security management platform;
Step 8. The blockchain security management platform calls the public key of the IoT device according to the device ID of the IoT device to decrypt the SR to obtain DR′, and obtains the root key of the IoT device according to the device ID of the IoT device. The device root key decrypts DR′ to obtain R′;
Step 9: Verify whether R′ is equal to R, if not, end the identity authentication process; if R′ is equal to R, proceed to Step 10. The blockchain security management platform considers the IoT device as a legitimate device, and then generates a true random number R2; and use the root key D of the IoT device to encrypt R′+R2 to generate DR2, and the blockchain security management platform uses the private key Y to encrypt DR2 to generate YR2; then send YR2 and the authentication result of the IoT device to business platform;
Step 11. The business platform records the authentication result of the IoT device by the blockchain security management platform. Forward YR2 to the IoT device, and request the IoT device to authenticate the blockchain security management platform;
Step 12: The IoT device obtains YR2 of the blockchain security management platform, decrypts YR2 with the platform's public key to obtain DR2′, decrypts DR2′ with the root key D of the IoT device to obtain R′+R2, and determines whether R is equal to R′, if R=R′, the Internet of Things device authenticates the blockchain security management platform successfully, and enters step 13; if R/R′, the IoT device authenticates the blockchain security management platform fails;
Step 13: The IoT device and blockchain security management platform store R+R2 as a session key and use it as an encryption key for subsequent Ciphertext transmission.

In one implementation of this embodiment, as shown in FIG. 86-4, it illustrates the secure access & data uplink of IoT devices, and the sensor data of IoT devices enters the blockchain security management platform through identity authentication and a secure transmission channel, and finally realize the process of uploading the data generated by IoT devices to the blockchain, which generally includes the following steps:
Step 1. The IoT device is embedded in a key security storage medium such as a secure password product, which is used to manage the root key, certificate, private key and other keys of the device;
Step 2: The IoT device performs identity authentication and secure access through the secure access gateway through the lightweight identity authentication process or other identity authentication processes;
Step 3. The secure access gateway is also connected to the blockchain security management platform through security authentication service or lightweight identity authentication service;
Step 4. The IoT device accesses the blockchain security management platform through the secure access gateway, and realizes the transmission of data Ciphertext to the blockchain security management platform;
Step 5· The Ciphertext data is parsed into plaintext or uploaded in Ciphertext on the blockchain security management platform. The blockchain security management platform can be used as an organization/unit to process data through smart contracts to realize data uploading. And reach a consensus with other organizations/units to realize data on-chain and have tamper-proof features. In an implementation of this embodiment, as shown in FIG. 86-5, it illustrates the structure and functional logic of the security management component, which is used for security management of terminal equipment, base station/gateway, database, and application platform data, including the following system.

Communication security: used to ensure hardware security, identity security, and data link security of IoT devices and base stations/gateways;

Network security: used to ensure the security of databases and application platforms. Use gatekeepers, firewalls, and other security area boundaries and security interfaces to conduct identity authentication and data transmission protection for network users' access data; Data security: used to ensure the anti-tampering and anti-leakage of the blockchain security management platform data, and the environmental security of the database;

Situation awareness: conduct situation awareness for the above-mentioned communication security, network security, and data security protection system logs, host log threat awareness data, and network backbone node data, establish an analysis model in line with the network and business, and evaluate, predict, and display the security situation;

Emergency response, classify and classify the alarms generated according to the situation. Automatically trigger the automatic disposal process and personnel disposal linkage to achieve rapid response and decision-making, forming a closed loop of security incidents; Knowledge map: Classify and store security alarm events in different levels, conduct in-depth re-analysis and classification series of security milestone events, and form the basis for security decision-making.

In an implementation of this embodiment, the components of the blockchain security management platform include, security resources, security services, and security management. The role and function of each component are described below:

The security resource component includes a password resource pool, a key management system, and a signature verification system.

The password resource pool is a collection of the key management capabilities and encryption and decryption capabilities of the server's password security products;

The key management system includes functions such as generation, distribution, revocation, modification, and interface calling of symmetric keys and symmetric key pairs, and can manage national secret algorithm keys and international algorithm keys.

The signature verification system provides digital signature services based on digital certificates for various types of electronic data, and verifies the authenticity and validity of the signature to the signed data. The signature process uses the private key in the asymmetric key pair to encrypt the data, and the signature verification process uses the public key in the asymmetric key pair to decrypt the Ciphertext data.

Security management components include communication security, network security, data security, situational awareness, emergency response, knowledge graph, user management and other systems. Communication security: used to ensure hardware security, identity security, and data link security of IoT devices;

Network security: used to ensure the security of databases and application platforms. Use gatekeepers, firewalls, and other security area boundaries and security interfaces to conduct identity authentication and data transmission protection for network users' access data;

Data security: designed to ensure the tamper-proof and leak-proof data of the blockchain security management platform, and the environmental security of the database;

Situational awareness. It is to carry out situational awareness for the logs of the previous communication security, network security, and data security protection systems, host log threat sensing data, and network backbone node data, establish an analysis model that conforms to the network and business, and evaluate, predict, and analyze the security situation, exhibit: Emergency response classify and classify the alarms generated according to the situation. Automatically trigger the automatic disposal process and personnel disposal linkage to achieve rapid response and decision-making, forming a closed loop of security incidents; Knowledge map: Classify and store the events of security alarm processing in a hierarchical manner, conduct in-depth re-analysis and classification series of security milestone events, and form the basis for security decision-making.

User management: The user management system is a system for adding, deleting, modifying and checking users of the blockchain security management platform, role authority management, and operation log records.

The security service component includes a lightweight authentication service interface, a security authentication service interface, and a blockchain service interface.

Lightweight authentication service interface, fast identity authentication and data encryption transmission for IoT devices;

Security authentication service interface, for identity authentication and data encryption and decryption transmission for devices with certain processing capabilities.

The blockchain service interface is used to ensure the security of the data generated by IoT devices and users. The blockchain security system established without tampering can be customized for smart contracts and consensus mechanisms.

Using the blockchain security management platform of this embodiment, combined with multi-mode heterogeneous application scenarios, the following technical effects can be achieved: The data encryption and decryption system solves the problem of untrustworthy data storage security generated by the business system.

Through the security management of communication security and password resource pool, the security resources of key management system and the security service of lightweight identity authentication service, the security problem of the sensing data transmission link generated by lol devices is solved.

Through the security management of communication security and the password resource pool, the security resources of the key management system and the security service of lightweight identity authentication service, the security algorithm with a higher security level is used to solve the data transmission network authentication method generated by the IoT sensing device Inadequate security concerns.

Through the security management of the Internet of Things communication security and the password resource pool, the security resources of the key management system, and the security service sense of the lightweight identity authentication service, the problems of data hijacking and data information leakage are solved.

The two-way lightweight identity authentication process solves the problem that IoT-aware devices are easily hijacked and become zombie devices.

The lightweight identity authentication service solves the problem that the one-size-fits-all adoption of a complex PKI system for the security authentication of IoT-aware devices will greatly reduce the data transmission efficiency of IoT-aware devices.

The blockchain security system can perform unified security management on communications, networks, and data, forming a high degree of security and traceability.

### S1-2-87—Application of Blockchain Technology in the Internet of Things.

In the current Internet of Things system, for the original real-time data collected by the sensor, there will be a risk of the original data being tampered with in any link of data processing. If the original data is tampered with, the credibility of the data will be reduced. The accuracy of the results obtained by processing is also correspondingly reduced. However, if the tampered or leaked data is personal privacy, the centralized management structure cannot prove its innocence, and the relevant time when personal privacy data is leaked occurs from time to time. Therefore, the tampering or leakage of personal privacy will cause Users are relatively troubled.

In this regard, related technologies adopt the following technical solutions
1) Storage and traceability of sensor data. Exemplary, the current supply chain transportation needs to go through multiple entities, such as consignors, carriers, freight forwarders, shipping agents, storage yards, shipping companies, land transportation (collection truck) companies, and banks that do manifest mortgage financing. Role Many information systems among these subjects are independent of each other and do not communicate with each other. Because of this, there will be the following two problems, on the one hand, there is the problem of falsification of data; on the other hand, because of the incompatibility of data. When a situation arises, the emergency response cannot be responded in time. In this application scenario, each entity in the supply chain deploys blockchain nodes, and writes the data collected by sensors into the blockchain in real-time (such as when a ship is docked) and offline (such as when a ship is running in the open sea), become electronic evidence that cannot be tampered with, which can increase the cost of counterfeiting and denial by all parties; further clarify the responsibility boundaries of all parties, and at the same time, through the chain structure of the blockchain, trace the source and keep abreast of the latest developments in logistics. That is to say, it is possible to take necessary response measures based on the data collected in real time (for example, during cold chain transportation, cargo compartments exceeding 0° C. will be checked immediately for the source of the failure), enhancing the possibility of multi-party collaboration.
2) Sharing economy. The sharing economy can be regarded as a derivative of the platform economy. On the one hand, it is because the platform is dependent and interest-oriented. For example, there are brands for bicycle sharing, but there are no brands for motorcycle sharing. On the other hand, the platform will also charge corresponding service fees. For example, the taxi-hailing platform will charge 20% of the taxi driver's taxi fare as a platform commission. At present, there are also other companies building a universal sharing platform, relying on the blockchain technology of disintermediation, allowing the supply and demand parties to conduct point-to-point transactions, speeding up the direct sharing of various idle commodities, and saving third-party platform fees. The block chain gateway builds the entire block chain network, and then the asset owner completes the binding of various locks and assets by setting rent, deposit and related rules based on the smart contract Finally, the user pays the corresponding rent and deposit to the asset owner through the APP, obtains the control authority (key) to open the lock, and then obtains the right to use the asset After use, return the item and get your deposit back. The above only takes unlocking as an example, and it is also applicable to the rental scenarios of other items or services such as item rental or parking space rental. The advantage of this method is accurate billing, that is, real-time and accurate payment can be made according to the billing standard on the smart contract, instead of the rough charging (charged by half an hour or one hour) like the current shared bicycles. However, although this method saves the platform fee (20%), it also has defects, such as how to solve the problem if there is an accident because the vehicle is not insured. As another example, if a customer rents a car and drives 200 Kilometers, then directly lock the car, check out and leave, who will drive the car back and wait. In practical applications, many problems should be encountered. 3) Instant charging of electric vehicles Install the APP on the smartphone, register the user's electric vehicle on the APP, and recharge the registered user's digital wallet. When charging is needed, you can find nearby available charging stations from the APP, pay the charging station payer according to the price in the smart contract, and then the APP will communicate with the interface in the charging station, which will execute the instruction for charging the electric vehicle. Although it is possible to search for charging stations through the APP, there are still problems such as complex payment agreements of many charging companies, inconsistent payment methods, relatively scarce charging piles, and inaccurate charging cost measurement Based on these problems, a blockchain-based point-to-point charging project for electric vehicles is currently launched. By installing a simple Linux system device such as a Raspberry Pi in each charging pile, the companies that belong to multiple charging piles and the individuals who own the charging piles are connected in series based on the blockchain, and the Smart Plug that adapts to each interface is used to connect electric vehicles, to charge. Taking Innogy's software as an example, the usage process is as follows: first install the APP on the smartphone, then register the user's electric vehicle on the APP, and recharge the registered user's digital wallet. When charging is needed, you can find nearby available charging stations from the APP, and you only need to pay the charging station payee according to the price in the smart contract to complete the charging. The APP will communicate with the blockchain node in the charging pile, which executes the instructions for charging the electric vehicle.

There are following disadvantages in the related technology at present:
1. In terms of resource consumption, IoT devices generally have problems such as low computing power, weak networking capabilities, and short battery life. However, Bitcoin's Proof of Work (PoW) mechanism consumes too much resources. Obviously, it is not suitable for deployment in IoT nodes, and can only be deployed in servers such as IoT gateways. Secondly, blockchain 2.0 technologies such as Ethereum are also PoW+PoS, and are gradually switching to the Proof of Stake (POS) mechanism. The distributed architecture requires a consensus mechanism to ensure the final consistency of the data. However, compared with the centralized architecture, the consumption of resources cannot be ignored.
2. In terms of data expansion, since the blockchain is a data storage technology that can only be appended and cannot be deleted, with the continuous growth of the blockchain, it needs more and more storage space, so it needs enough storage space to carry out storage.
3. In terms of performance bottlenecks, feedback delays and alarm delays caused by blockchain delays are not feasible on the delay-sensitive Internet of Things or Industrial Internet. Based on the above technical problems, embodiments of the present disclosure provide a method for applying blockchain to the Internet of Things. Embodiments of the present disclosure will be described in detail below from the following aspects.

The embodiment of the present disclosure provides a block chain system architecture of the Internet of Things, which is a centerless resilient and reliable architecture with strong robustness. In terms of credibility, the consensus algorithm can be used to effectively eliminate malicious nodes in a trusted environment and effectively resist destruction and interference. In terms of dynamics, based on the unified mechanism of the consensus algorithm, it realizes invulnerable reorganization and dynamic grouping. In terms of security, measures such as hash compression, digital signature, and asymmetry are comprehensively adopted. In terms of adaptability, based on the P2P elastic mechanism, real-time adaptable and fast communication can be realized. In terms of autonomy, autonomous performance based on smart contracts. In terms of constraints, artificial intelligence behaviors are incorporated into the blockchain framework for unified management and control to realize explainable artificial intelligence (eXplainable Artificial Intelligence, XAI). P2P network communication technology. Based on P2P network communication technology, the blockchain node identification is realized, that is, a blockchain node can be uniquely identified through the blockchain node identification, and the blockchain node can be identified on the blockchain network through the blockchain node identification. Nodes are addressed. Based on P2P network communication technology to manage network connections, it can maintain TCP long connections between blockchain nodes on the blockchain network, automatically disconnect abnormal connections, and automatically initiate reconnections. Based on the P2P network communication technology to realize message sending and receiving, that is, the unicast, multicast or broadcast of messages can be performed between the blockchain nodes of the blockchain network State synchronization is realized based on P2P network communication technology, that is, the state can be synchronized between blockchain nodes.

Transaction consensus technology: Transaction consensus technology is used to ensure the consistency of the entire system. The basic process is: each node executes the same block independently, and then exchanges the execution results between nodes. If it exceeds a certain ratio (for example, 2/3) All the nodes have obtained the same execution result, which means that the block has been consistent on most nodes, and the node will start to produce blocks. The transaction consensus includes Sealer thread and Engine thread, which are respectively responsible for packaging transactions and executing the consensus process. The Scaler thread takes transactions from the transaction pool (TxPool) and packs them into new blocks; the Engine thread executes the consensus process, and the consensus process will execute the block. After the consensus is successful, the block and block execution results are submitted to the blockchain (BlockChain), the block chain uniformly writes these information into the underlying storage, and triggers the transaction pool to delete all transactions contained in the block on the chain, and notifies the client of the transaction execution result in the form of a callback, and supports the Practical Byzantine Fault Tolerant Algorithm ((Practical Byzantine Fault Tolerance, PBFT) and Raft consensus algorithm. PBFT consensus algorithm: BFT algorithm, which can tolerate no more than one-third of fault nodes and malicious nodes, and can achieve final consistency. Raft consensus algorithm: non-Byzantine fault tolerance (Crash Fault Tolerance, CFT) algorithm can tolerate half of the faulty nodes, cannot prevent nodes from doing evil, and can achieve consistency.

Block synchronization mechanism, responsible for broadcasting transactions and obtaining the latest blocks Considering that during the consensus process, the leader is responsible for packaging blocks, and the leader may switch at any time, so it is necessary to ensure that the client's transactions are sent to each blockchain node as much as possible. After the node receives the new transaction, the synchronization module broadcasts the new transaction to all other blockchain nodes. Considering the inconsistency of machine performance or the addition of new nodes in the blockchain network will cause the block height of some nodes to lag behind other nodes, the synchronization module provides a block synchronization function, which sends the latest block height of its own node to other blockchain nodes, when other nodes find that the block height is behind other nodes, they will actively download the latest block.

Block transaction execution engine technology. After the node receives the block, it will call the block validator to take the transactions out of the block and execute them one by one. If it is a pre-compiled contract code, the execution engine in the validator will directly call the corresponding function, otherwise the execution engine will hand over the transaction to the EVM (Ethereum Virtual Machine) for execution.

Ledger management technology: mainly includes synchronization, consensus, transaction pool, blockchain and block executor.

The present disclosure is explained below in combination with exemplary embodiments. First, the Internet of Things blockchain architecture provided by the embodiments of the present disclosure is shown in FIG. 87-1. The IoT blockchain support capability in the IoT blockchain system includes the following components:

1. Access control: Provide user and device access control to resources;

In the embodiments of the present disclosure, access control can be classified into two types: discretionary access control and mandatory access control Among them, autonomous access control means that the user has the right (the user has a relatively high authority level) to access the access objects (files, data tables, etc.) created by himself, and can grant access to these objects to other users and revoke access from users who granted it. In addition, mandatory access control means that the system (through a specially set system security officer) performs unified mandatory control on objects created by users (the user has a relatively high level of authority), and decides which users can access which objects according to the specified rules. What operating system type of access does the object have? Even the creator user may not have the right to access the object after it is created.

2. Consensus Consensus algorithm realizes dynamic network access authentication, malicious node elimination and heterogeneous information fusion functions;

The consensus algorithm in the embodiment of the present disclosure may be the PBFT consensus algorithm and the Raft consensus algorithm. PBFT consensus algorithm: It can further be a BFT algorithm, which can tolerate no more than one-third of faulty nodes and malicious nodes, and can achieve final consistency. Raft consensus algorithm. CFT algorithm, which can tolerate half of the faulty nodes, cannot prevent nodes from doing evil, and can achieve consistency.

3. Encryption: use hash calculation, digital signature and asymmetric encryption technology, and integrate special encryption methods to solve the problem of cross-domain identity authentication; Since the Hash algorithm is characterized by one-way irreversibility, the user can generate a unique bash value of a specific length for the target information through the hash algorithm, but cannot regain the target information through this hash value. Therefore, the Hash algorithm is commonly used in irreversible password storage, information integrity verification, etc. As long as the source data is different, the summaries obtained by the algorithm must be different. The hash algorithm in the embodiment of the present disclosure may be: MD5, RIPEMD, SHA, MAC and SM3 of national secret.

Digital signatures are the inverse application of public-key cryptography: a message is encrypted with the private key and decrypted with the public key. A message encrypted with a private key is called a signature, and only the user who has the private key can generate the signature. The step of decrypting the signature with the public key is called verifying the signature. All users can verify the signature (because the public key is public). Once the signature verification is successful, according to the mathematical correspondence between the public and private keys, you can know that the message is the only one with the private key, sent by users, not just any user. Since the private key is unique, the digital signature can ensure that the sender cannot deny the signature of the message afterwards. Thus, the receiver of the message can use the digital signature to convince the third party of the identity of the signer and the fact that the message was sent. When there is a dispute between two parties about whether the message was sent or not and its content, the digital signature can become a strong evidence.

An asymmetric algorithm is an algorithm that uses public and private keys to encrypt and decrypt. For example, things encrypted by A's public key can only be decrypted by A's private key; similarly, things encrypted by A's private key can only be decrypted by A's public key. As the name implies, the public key is public and can be obtained by others; the private key is private and can only be owned by oneself.

The various encryption methods mentioned above are used comprehensively to solve the problem of cross-domain identity authentication in different application scenarios.

4. Contract: smart contract realizes contract process, contract service and transaction;

The smart contract can be drawn up by the service provider, or jointly by the service provider and the served party. Specific application scenarios may include: unlocking, renting a house, renting a car, hailing a taxi, etc. The contract process is to complete the corresponding agreement based on the smart contract. Taking car rental as an example, the car renter can search for car rental information through the APP, and after finding a suitable vehicle, he can pay the provider who provided the vehicle, and the provider completes the contract service based on the smart contract. Lease to the renter, return the vehicle after the renter no longer uses it, and complete the transaction.

5. P2P. Each user is not only a node, but also has the function of a server. They are equal, and all nodes in the network can transmit to each other. There is no center in the entire network, and any two points in the network can communicate data transmission;

6. Storage and computing: Provide data computing and data storage capabilities.

Since the blockchain is a data storage technology that can only be appended and cannot be deleted, as the blockchain continues to grow, it requires more and more storage space. Therefore, in the embodiments of the present disclosure, sufficient storage space is required for storage By applying the block chain technology to the Internet of Things system or the industrial Internet system through the embodiments of the present disclosure, the original real-time data collected by the sensor can be solved. Immutable, unforgeable and traceable issues. Furthermore, if the blockchain technology is applied to the multi-mode heterogeneous Internet of Things platform, it can effectively provide support for the multi-mode heterogeneous Internet of Things platform, that is, in combination with the above-mentioned access control part, contract part, encryption part. The consensus part and the P2P part can provide unified resource services, unified security services, and unified operation and maintenance services for multi-mode heterogeneous IoT platforms.

### S1-3-88—IoT Security System Based on Keyless Signature Technology.

The current Internet of Things gateway data transmission security verification depends on the management of the key system, and the difficulty of the key management system is the safe distribution and storage of the key. Once the key distribution process is leaked and the storage medium has security holes, then There will be huge hidden dangers in the correctness of IoT data. In addition, the current digital certificate security system based on asymmetric algorithms needs to establish a certificate management system, CA core, etc. and needs to continuously maintain its safe and stable operation. For small-scale construction projects, there is a problem of insufficient construction funds. In addition, the original product data signature verification and certification system has a long certification cycle and cannot be fully applied in the Internet of Things environment.

Based on the above technical problems, embodiments of the present disclosure provide a security method for the Internet of Things based on keyless signature technology. It should be noted that the security method for the Internet of Things based on the keyless signature technology in the embodiment of the present disclosure is applicable to any type of Internet of Things device and the Internet of Things security method for any level of intermediate convergence unit.

Embodiments of the present disclosure are also applicable to any kind of Internet of Things equipment, including but not limited to temperature and humidity monitoring equipment, weather monitoring equipment, water quality monitoring equipment, flame monitoring equipment, emergency monitoring equipment, public safety equipment, audio and video equipment, control equipment. Municipal equipment, handheld devices, etc.

In addition, the embodiments of the present disclosure are also applicable to any network environment for system construction, including but not limited to private network, public network, and public-private converged network environment. Embodiments of the present disclosure are also applicable to any network transmission link, including but not limited to 5G, 4G, LTE, LoRa, NB-IoT. Bluetooth, Sub-1G, etc. And, the embodiments of the present disclosure are applicable to information system applications in any industry.

The embodiments of the present disclosure will be explained below in conjunction with FIG. 88-1 to FIG. 88-3. Exemplarily, it includes the following steps or components:

As shown in FIG. 88-1, the parts involved in the security method applied in the Internet of Things based on keyless signature technology in the embodiments of the present disclosure include: keyless signature nodes, keyless signature gateways, and keyless signature service clusters. Its implementation steps are as follows:

Step 1: The source data and timestamps generated by any number of IoT devices can be signed, and the data can be transmitted to the keyless signature gateway through a dedicated network or public network;

In a specific application scenario, it can be to transmit the temperature and humidity data generated by the temperature and humidity monitoring equipment in the industrial plant and its corresponding timestamp signature data to the keyless signature gateway, and the data generated by the weather monitoring equipment in a certain area Meteorological data and its corresponding time stamp signature data are transmitted to the keyless signature gateway, as well as water quality detection data and its corresponding time stamp signature data generated by water quality monitoring equipment in a certain water area, and forests in a certain area. The data about the flame detection generated by the flame monitoring equipment in it corresponds to the time stamp signature data. It can be seen that the IoT devices corresponding to the data sent to the keyless signature gateway can be IoT devices involved in various industries and fields, and there is no limit to the number of IoT devices reporting data, which can be determined according to actual needs, corresponding settings.

Step 2. The IoT gateway groups and concatenates the aggregated data, and then performs bash calculation and timestamp recording;

After collecting the data sent by different numbers of IoT devices in various fields and industries, the received data can be grouped and concatenated. It can be grouped and concatenated from the dimension of field or industry, or from the dimension of time. Group concatenation can also be performed from the dimension of data volume, or a combination of the above-mentioned dimensions.

Step 3; IoT gateways at all levels uniformly transmit the HASH value and timestamp of the device source data hash calculation to the keyless signature service cluster;

The hash algorithm adopted in the embodiment of the present disclosure may be MD5, RIPEMD, SHA, MAC and SM3 of national secret. Of course, the above is only an example, and other hash algorithms are also within the protection scope of the embodiments of the present disclosure. Step 4· The keyless signature service cluster generates the corresponding hash value at each moment according to the timestamp, and finally forms a hash aggregation calendar. A hash-aggregated calendar provides a root of trust for keyless-signed functions;

Step 5: The keyless signature service cluster provides signature authentication services to verify the authenticity of data.

It should be noted that keyless signatures use pure mathematical algorithms to verify and prove the signature time, origin and data integrity of electronic data, and to prove the reliability and non-repudiation of data. An electronic tag (signature) for keyless signature electronic data After any electronic data is extracted from the electronic fingerprint through local calculation, the keyless signature is obtained through the distributed network infrastructure calculation with the electronic fingerprint.

Through the above steps 1 to 5, the keyless signature system provided by the embodiment of the present disclosure can provide users with a fair, transparent and ability to get rid of internal or third-party trust, and no one can cheat in this system, ensuring data accuracy.

As shown in FIG. 88-2, it illustrates the process of generating a cloud-based trusted root calendar from data and generating a keyless signature from the root calendar. The steps of this process include:

Step 1: The source data is generated from the IoT device, and sorted in time order according to the timestamp generated by the data;

Since the Internet of Things devices of the above data can be Internet of Things devices in various industries and fields without limiting the amount of data, the data can be sorted based on the timestamps generated by the data, so as to perform unified management of the data.

Step 2: The source data is aggregated to the first-level aggregation unit, and the first concatenation and hash value calculation are performed to generate the Hn bash sequence;

Step 3: The first-level hash sequence is transmitted to the second-level aggregation unit for aggregation, and so on, from the source data to the cloud keyless signature service cluster can be aggregated and hashed by n-level aggregation units;

The value of n in the embodiment of the present disclosure can be set correspondingly according to actual needs, for example, 3, 8, 20 and so on. In addition, the hash calculation result of level N-1 is used as the basis for hash calculation of level N.

Step 4. The keyless signature service cluster gathers data aggregation and bash calculation from the whole system according to the time axis to form a hash aggregation calendar of keyless signature; Step 5: A keyless signature is formed from the current moment bash of the aggregated calendar and the n-level hash chain.

It can be seen that, through the above steps 1 to 5, the embodiment of the present disclosure does not need to build a key management system, omits the construction of functions such as the CA core, and can build and establish a secure data verification service for the Internet of Things at a low cost.

As shown in FIG. 88-3, the data transmission signature verification process is a process for verifying the content of data transmission, and its steps include:

Step 1: the IoT device 1 collects data;

In specific application scenarios, the IoT device 1 can be temperature and humidity monitoring equipment, meteorological monitoring equipment, water quality monitoring equipment, flame monitoring equipment, emergency monitoring equipment, public safety equipment, audio and video equipment, control equipment, municipal equipment, handheld devices, etc.

Step 2. The IoT gateway aggregates data from IoT device 1 and performs bash calculation, and then signs & verifies the service cluster to apply for keyless signature.

For example, the IoT device 1 is a flame monitoring device, the flame monitoring device can report the flame detection data to the IoT gateway, and then the IoT gateway performs hash calculation on the data, and applies for keyless signature based on the calculation result.

Step 3. The signature & verification service cluster responds to the signature application of the IoT gateway, and accesses the aggregated data and hash value to the hash aggregation calendar;

Step 4. The signature & verification service cluster generates and stores keyless signatures, and then provides signature verification services;

Step 5: The IoT gateway sends the data to the receiver IoT device 2;

Step 6: After receiving the data, IoT device 2 calculates the hash of the data, and applies to the signature & verification service cluster to verify the signature, and the verification service returns the authentication result of the keyless signature. The IoT device 2 judges whether the data is true and valid according to the result of the verification service.

It can be seen that the embodiment of the present disclosure provides a data signature verification service system with high security and high reliability for products; in addition, the embodiment of the present disclosure may not build a key management system, save the construction of CA core and other functions. It is possible to build a secure data verification service for the Internet of Things at a low cost. Further, the embodiments of the present disclosure can help products realize fast data signature verification and authentication, theoretically can realize 2^{\hat{ }64} calculation service times per second, and solve the problem that the Internet of Things environment cannot be fully applied. The keyless signature system provided by the embodiments of the present disclosure provides users with a fair, transparent and ability to get rid of internal or third-party trust, and no one can cheat in this system; finally, the keyless signature system provided by the embodiments of the present disclosure Security algorithms are immune to quantum computing.

In addition, applying the keyless signature-based Internet of Things security method in the embodiment of the present disclosure to a multi-mode heterogeneous Internet of Things sensing platform can also provide the Internet of Things platform with a large amount of verification data. More secure data verification service.

### S1-4-89—Communication Transmission Encryption Method Based on Blockchain Technology.

At present, data encryption technology is the most commonly used means of security and confidentiality. Using this technology, important data can be encrypted and transmitted, and then decrypted in a certain way after reaching the destination to achieve the effect of ensuring data security.

However, the current data encryption methods are usually encrypted by the server side, and cannot be encrypted at the sensory data source (such as temperature sensing equipment, monitoring equipment, etc.), so that the source data needs to be encrypted without encryption. Encryption can only be performed after transmission to the server, resulting in low data security. Moreover, because key distribution and storage both need to waste resources, when the device nodes are in an environment with poor network status, the distribution and storage of keys cannot be guaranteed, so the data security of these nodes cannot be guaranteed.

Based on the above technical problems, the embodiments of the present disclosure provide a communication transmission encryption method based on blockchain technology.

The embodiments of the present disclosure use the information of each node in the transmission process to encrypt the data to be transmitted. In this way, the data can be encrypted from the node at the source end of the data, and the data security can be guaranteed from the source end. Moreover, it will not rely too much on the network Resources are used for key distribution and storage, which solves the security problem of nodes in an environment with poor network status.

Exemplarily, the embodiment of the present disclosure considers that the information of each node during transmission is used for encryption. In order to ensure data integrity and authenticity, it is necessary to perform a superposition digest algorithm on the data to be transmitted at each node of transmission, after receiving the data packet, the server calculates the summary value one by one for the received data according to the information of the sending node and the intermediate node. In addition, the embodiments of the present disclosure consider that information deviations exist in position information, clock information, and communication serial numbers among nodes, and a granularity enlargement algorithm may be used to compensate Exemplarily, the compensation for location information deviation is mainly for nodes with positioning function, since these nodes may move within a small range or have a location offset, coarse-precision locations can be used. The coarse-precision position here refers to the ability to receive data in the same position area when changing within the allowable deviation range to ensure the positioning accuracy of the node. For the compensation of clock information deviation, under normal circumstances, the data sending node and the data receiving node maintain a synchronous real-time clock, but due to objective factors such as synchronization deviation and transmission delay jitter, both the data sending node and the data receiving node use coarse-grained time to ensure mutual synchronization. For the compensation of communication sequence number deviation, both the data sending node and the data receiving node maintain a communication sequence number, and the communication sequence number has been increasing without repetition. The communication sequence number may not be completely synchronized due to packet loss and other reasons. The data receiving node received the successful communication in the last time. Try within a certain range of serial numbers until you find the correct serial number.

Exemplarily, as shown in FIG. 89-1 and FIG. 89-2, an embodiment of the present disclosure provides a communication transmission encryption method based on blockchain technology, the method includes the following steps:

The data sending node encrypts the data to be sent by using its own communication data to obtain the first encrypted data, and sends the first encrypted data to the intermediate node;

The intermediate node encrypts the first encrypted data with its own communication data to obtain second encrypted data, and sends the second encrypted data to the data receiving node; The data receiving node decrypts the second encrypted data by using the communication data of the data sending node and the communication data of the intermediate node to obtain the data to be sent.

Wherein, the communication data includes, but is not limited to: node identification, location information, clock information, communication serial number, and the like.

Using the above encryption method, each node can use its own location information, real-time time, and communication serial number to obtain a key through a granularity expansion algorithm. The key is not only used to calculate the digest value, but also used to encrypt data, the server can use the same method to obtain key, and used for data verification and decryption.

On the basis of location information, real-time time, and communication serial number, each node can combine encryption algorithms in related technologies such as Data Encryption Standard (Data Encryption Standard, DES for short). Secure Hash Algorithm (Secure Hash Algorithm, SHA for short)). Advanced Encryption Standard (Advanced Encryption Standard, referred to as AES), ECC. Tiny Encryption Algorithm (Tiny Encryption Algorithm, referred to as TEA) and SM2 (an algorithm of national secrets) etc. to realize encryption and decoding, the embodiment of the present disclosure Not specifically limited.

As another implementation, the method also includes the following steps:

The data sending node encrypts the data to be sent by using its own communication data, its own private key and the public key of the data receiving node to obtain first encrypted data, and sends the first encrypted data to the intermediate node.

The intermediate node encrypts the first encrypted data with its own communication data to obtain second encrypted data, and sends the second encrypted data to the data receiving node; The data receiving node uses the communication data of the data sending node and the communication data of the intermediate node to verify the second encrypted data, and uses its own private key to decrypt the second encrypted data after the verification is successful, to obtain the Describe the data to be sent.

Wherein, the communication data includes, but is not limited to: node identification, location information, clock information, communication serial number, and the like.

Wherein, the data sending node and the intermediate node pre-store their respective public-private key pairs {NPkeyi, NSkeyi}, and the data receiving node pre-stores the node identification ID, message authentication code HMAC, private key NSkey and The server's own private key CSkey. The following describes the embodiment scheme of the present disclosure in detail in conjunction with FIG. 89-1 and FIG. 89-2:

The solution of the embodiment of the present disclosure can be applied to the architecture shown in FIG. 1, which includes multiple nodes and servers, and the nodes can be devices participating in communication such as terminals, gateways, base stations, and communication relays; wherein, the terminal (It can also be called sensing terminal Y1-1, linkage terminal Y1-2, mobile terminal Y1-3, video terminal Y1-4, industry terminal Y1-5, etc.) can be used as a data sending node; gateway Y2-2, base station Y2-1, communication relay, etc can be used as intermediate nodes; server R1 can be used as a data receiving node.

Any node i has a unique device ID IDi, a message authentication code HMACi key and its own public-private key pair {NPkeyi, NSkeyi}; the server has its own public-private key pair {CPkey, CSkey}. Any node i can store IDi, HMACi, NSkeyi, and CPkey; the server can store ID, HMAC, NPkey, and CSkey of all nodes. Any node i has clock information (also called real-time clock) and location information (also called longitude and latitude location data), wherein the clock information deviation between any node and other nodes is within the first preset time range, such as positive and negative TD within seconds. The position information deviation between any node and other nodes is within a first preset distance range, such as within plus or minus LD meters. When any node sends data to the next intermediate node or the server takes less than the second preset time, such as TT-TD (TT is greater than TD), the sending process must pass through at least one intermediate node.

The following explains the process of data encryption and data decryption. For example, see FIG. 89-2. Assume that the time information of node i at time ti is represented by Nrtci, and the location information at point li is represented by NLcti. The data to be sent Denoted by Datai, the encryption process of node i includes the following steps:

Step 1. Node i uses the server public key CPkey to encrypt Nrtci and Datai to obtain ciphertext Ei (ciphertext Ei can be represented by SUdatai);

Step 2. Node i uses its own private key NSkeyi to digitally sign its own node IDs IDi and Ei to obtain signature Si;

Step 3. Node i uses message authentication code HMAC1 to perform hash operation on Ei and Si to obtain hash value Hi (hash value Hi can be identified by Hdatai);

Step 4: Node i sends data IDi, Ei, Si and Hi to the next nodej(that is, an intermediate node, such as a gateway, etc.).

Assuming that the time information of node j at time tj is represented by Nrtej, and the location information at location lj is represented by NLctj, the encryption process of node j includes the following steps.

Step 5: Node j obtains real time tj and location lj. Calculation time granularity value tej-tj-TD-(tj-TD % TT), where % means taking the remainder;

Step 6. Node j uses message authentication codes HMACj and tgj to perform hash operation on Hi to obtain hash value Hj (hash value Hj can be identified by Hdataj);

Step 7. Node j sends data IDj, IDi, Ei, Si and Hj to the next nodek(that is, another intermediate node, such as a gateway).

Assuming that the time information of node k at time tk is represented by Nrtck, and the position information at location Ik is represented by NLctk, the encryption process of node k includes the following steps.

Step 8: After node k receives the sent data IDj. IDi, Ei, Si and Hj from node j, it performs the same operation as node j, sends data IDk. IDj, IDi, Ei, Si and Hk, and so on until After the operation of the last intermediate node node n, node n sends the data IDn. . . . IDj, IDi, Ei, Si and Hn to the server After receiving the data IDn. . . . IDj, IDi, Ei, Si and Hn, the server can do the following operations: Step 9, the server judges whether the received IDi exists, if not, then directly discards the data packet; otherwise, proceeds to the next step;

Step 10. The server obtains the key Khmac2 through the granularity expansion algorithm PE of the node i's location information NLeti, communication serial number Nsni, and server time information Crte;

Step 11 The server calculates and obtains the first round of summary value Hdatai2 through Khmac2, IDi, and Ei;

Step 12, the server calculates and obtains the second round of summary value Hdataj2 through the relevant information of nodej(such as the location information NLetj of node j, communication serial number Nsnj, IDj, etc.) and Hi.

Step 13, if Hdatai2 and Hdataj2 are different, then discard the packet; otherwise, proceed to the next step.

Step 14: Use the server key Cskey to decrypt the data packet Ei to obtain the original data Datai. In the above step 1 to step 14, the server knows the ID of the intermediate node through which the node communicates, and the data packet may not carry the intermediate node information, which is automatically obtained from the server during calculation.

The embodiments of the present disclosure use the information of each node in the transmission process (such as node location information, communication system type, time point of sending data, communication sequence number, communication path, etc.) to encrypt the data to be transmitted, so that the The node at the end encrypts the data, and encrypts the data from the source. Moreover, it does not need to rely on network resources for key distribution and storage, which solves the encryption problem of nodes in an environment with poor network status That is to say, the encryption method in the embodiment of the present disclosure mainly has the following functions: to expand the communication security dependence from node to node to the communication chain, and increase the security level. The trouble of key distribution and storage is removed, and resources are saved. The encryption method provided by the embodiments of the present disclosure ensures the confidentiality, integrity and availability of data, and can resist common communication attack methods. For example: the saboteur obtains the data packet by monitoring the communication method. Since the data is encrypted at the source of the sensing terminal, the saboteur cannot easily obtain the original data, so the content of the data cannot be known to ensure the confidentiality of the data; When the packet passes through each node, the integrity check value will be recalculated, and the receiving end will recalculate the integrity check value in the same way. Only when the data sender and all intermediate nodes are correct can it pass. This operation not only ensures data integrity. The property also ensures the non-repudiation of the communication node; the destroyer intercepts the data packet and resends the same data packet to the intermediate node (that is, the replay attack) Since the data uses the timestamp and the serial number as the key fragment, the receiving end Integrity verification and decryption will fail and the data packet will be discarded; if the saboteur uses a man-in-the-middle attack to simulate himself as an intermediate node, since superimposed encryption and verification cannot be performed, any changes to the data cannot pass through the receiving end, verify.

Unified operation and maintenance management platform, including technology numbered M1-1. Dynamically control the status of all devices based on the dynamically adjusted multi-mode heterogeneous network. At the same time, it can also be sent to each terminal according to the demand through the dynamic multi-mode heterogeneous network to realize functions such as alarm, work order, and inspection.

The implementation of the unified operation and maintenance management platform of the embodiment of the present disclosure will be described in detail below in combination with exemplary embodiments.

### M1-1-90—Unified Operation and Maintenance Management Platform.

At present, the realization of digital transformation of industrial enterprises needs to be carried out step by step for production equipment according to the core needs of the enterprises themselves. From the lowest-level equipment data connection, equipment data visualization, equipment data analysis, equipment failure prediction, equipment self-adaptation to the introduction of AI artificial intelligence distribution. To achieve digital transformation, industrial enterprises need to start from the following points equipment can be found, it mainly involves the whole life cycle data of equipment, basic parameter data of equipment ledger, document data of equipment structure data, special tool data of equipment spare parts, equipment failure data. Management and analysis of equipment operation and maintenance data and equipment asset data; equipment visibility: mainly involves the management and analysis of equipment online status, equipment start-stop status, and equipment operating parameters; equipment status controllable: mainly involves equipment health status. Management and analysis of equipment health level, equipment failure location, equipment failure type, equipment failure severity, equipment residual life and equipment operation and maintenance measures; equipment benefit improvement: mainly involves optimizing equipment operation and maintenance strategies, optimizing spare parts preparation strategies, and optimizing equipment maintenance Strategies, optimization of process parameters and optimization of equipment selection.

It can be seen that to realize a smart city, an operation and maintenance management platform is also required to conduct overall operation and maintenance of equipment based on equipment data and optimization strategies. At present, the operation and maintenance management platform in related technologies is mainly aimed at the operation and maintenance management of equipment and equipment data of a single system in a smart city project, and lacks a unified operation and maintenance platform for equipment and equipment data of all smart city projects at the city level. Therefore, it cannot be realized There are certain difficulties in the operation and maintenance of equipment and equipment data in the whole city.

Based on the above technical problems, embodiments of the present disclosure provide a unified operation and maintenance management platform, which dynamically controls the status of all devices based on a dynamically adjusted multi-mode heterogeneous network. At the same time, it can also be sent to each terminal according to the demand through the dynamic multi-mode heterogeneous network to realize functions such as alarm, work order, and inspection.

The embodiment of the present disclosure adopts the unified operation and maintenance technology and the work order processing technology, and performs unified operation and maintenance on the data reported by the equipment and the offline data of the equipment related to the smart city through the multi-mode heterogeneous IoT sensing platform, and automatically generates and reports according to the status of the equipment. Allocate work orders, and process and statistically analyze the work orders, so as to realize the operation and maintenance of equipment and equipment data in the whole city.

Exemplarily, as shown in FIG. 90-1, the embodiment of the present disclosure provides a unified operation and maintenance management platform, and the unified operation and maintenance management platform may include: a data access module, used to access smart city-related projects from other modules. The data information of the equipment, and convert the data information into the real-time data of the equipment and the offline data of the equipment that meet the operation and maintenance requirements; the data alarm analysis module is used to analyze the real-time data of the equipment and the offline data of the equipment according to the preset alarm rules Perform analysis to generate equipment data alarm information and equipment offline alarm information; an operation and maintenance module is used to maintain equipment data according to the equipment data alarm information, and maintain equipment according to the equipment offline alarm information.

Wherein, the data access module includes: a data access service sub-module, which is used to access data information of equipment related to smart city projects from other modules, and convert the data information into real-time data and information of equipment meeting the requirements of operation and maintenance. Device offline data;

The message service system sub-module is used to forward the real-time data of the device and the offline data of the device to the data alarm analysis module, and the message service system sub-module may be Kafka.

Wherein, the data alarm analysis module includes, a data alarm service submodule, used to generate equipment data alarm information and work order data according to preset alarm rules and the real-time data of the equipment. Alarm rules and offline data of the equipment are preset, and equipment offline alarm information and work order data are generated.

Wherein, the operation and maintenance module includes an operation and maintenance system APP sub-module, which is used to provide APP functions, support operation and maintenance personnel to process work orders through APP, and support operation and maintenance management personnel to view and manage work order data through APP:

The WEB application micro-service sub-module of the operation and maintenance system is used to provide WEB application micro-service functions, support operation and maintenance personnel to process work orders through WEB applications, and support operation and maintenance managers to view and manage work order data through WEB applications.

Wherein, the unified operation and maintenance management platform further includes: a business database for storing the device data alarm information, the device offline alarm information, business data and preset alarm rules;

The device authentication library is used to generate device authentication data and alarm rule data according to the device information and the alarm rules.

Wherein, the unified operation and maintenance management platform further includes: a device information synchronization service module, configured to synchronously send the alarm rules in the business database to the device authentication database; an alarm rule synchronization service module, configured to. The scheduling information in the scheduling system and the equipment data in the service database are synchronously sent to the equipment authentication database. The scheme of the embodiment of the present disclosure will be described in detail below with reference to FIG. 90-1: As shown in FIG. 90-1, the unified operation and maintenance management platform of the embodiment of the present disclosure adopts unified operation and maintenance technology and work order processing technology, through multi-mode heterogeneous. The connected sensing platform conducts unified operation and maintenance of the equipment reporting data and equipment offline data related to smart city projects, and automatically generates and distributes work orders according to the status of the equipment, and processes and statistically analyzes the work orders, so as to realize the monitoring of equipment in the whole city. Operation and maintenance and equipment data operation and maintenance.

The unified operation and maintenance management platform can be applied to the unified operation and maintenance management platform (R9) shown in FIG.), multi-mode heterogeneous IoT sensing platform (R1), algorithm middle platform and multimedia command system (R4, R5, R6, R7), etc. provide unified operation and maintenance services. It should be emphasized that the unified operation and maintenance management platform can dynamically control the status of all devices based on the dynamically adjusted multi-mode heterogeneous network, and can also issue instructions to each terminal according to the demand through the dynamic multi-mode heterogeneous network. In order to realize the functions of alarm, dispatching work order, patrol inspection and so on.

Exemplarily, the data information accessed by the data access module in the unified operation and maintenance management platform includes but is not limited to: from the intelligent data fusion platform (R2) shown in FIG. 1, the multi-mode heterogeneous IoT sensing platform (R1) and the algorithm platform (R4) and other platforms access the device upload data, device online status data and camera image alarm data.

The operation and maintenance system WEB application micro-service sub-module is used to realize the basic business logic of the operation and maintenance unified platform, including but not limited to: basic management micro-service, system management micro-service, resource management micro-service, alarm management micro-service and operation and maintenance management micro-service service etc. It can obtain equipment data from the data intelligent fusion platform (R2) shown in FIG. 1, obtain application-available data from the artificial intelligence business platform (R10), and obtain workflow data from the workflow engine, so as to integrate with the operation. The APP subsystem of the maintenance system realizes the operation and maintenance management together. The workflow engine here is used to provide basic workflow flow services for the unified operation and maintenance management platform. The unified operation and maintenance management platform of the embodiment of the present disclosure has the following advantages: it provides unified operation and maintenance of smart city-related projects, and breaks the limitation of chimney construction of different systems of smart city operation and maintenance. The unified operation and maintenance management platform supports independent operation and maintenance of different projects. Supports the control of system access according to user rights. Data from various industries can be integrated to achieve an overview of the city's overall situation, monitoring and early warning, command and dispatch, event handling, and operational decision-making.

In addition, an embodiment of the present disclosure provides a terminal, and the terminal may include, at least one processor, a memory, at least one network interface, and other user interfaces. The individual components in the terminal are coupled together via a bus system. Exemplarily, a bus system is used to realize connection communication between these components. In addition to the data bus, the bus system also includes a power bus, a control bus and a status signal bus. Wherein, the user interface may include a display, a keyboard, or a pointing device, such as a mouse, a trackball (trackball), a touch panel, or a touch screen.

Exemplarily, the memory in the embodiments of the present disclosure may be a volatile memory or a nonvolatile memory, or may include both volatile and nonvolatile memory. Among them, the non-volatile memory can be read-only memory (Read-Only Memory, ROM), programmable read-only memory (Programmable ROM, PROM), erasable programmable read-only memory (Erasable PROM, EPROM), electronically programmable Erase Programmable Read-Only Memory (Electrically EPROM, EEPROM) or Flash. The volatile memory can be Random Access Memory (RAM), which acts as external cache memory. By way of illustration and not limitation, many forms of RAM are available, such as Static Random Access Memory (Static RAM, SRAM), Dynamic Random Access Memory (Dynamic RAM, DRAM). Synchronous Dynamic Random Access Memory (Synchronous DRAM, SDRAM), double data rate synchronous dynamic random access memory (Double Data Rate SDRAM, DDRSDRAM), enhanced synchronous dynamic random access memory (Enhanced SDRAM, ESDRAM), synchronous connection dynamic random access memory (Synchlink DRAM, SLDRAM) And Direct Memory Bus Random Access Memory (Direct Rambus RAM, DRRAM). The memory of the systems and methods described in various embodiments of the present disclosure is intended to include, but is not limited to, these and any other suitable types of memory.

In some embodiments, the memory stores elements, executable modules or data structures, or subsets thereof, or extensions thereof, such as operating systems and application programs. Among them, the operating system includes various system programs, such as framework layer, core library layer, driver layer, etc. which are used to implement various basic services and process hardware-based tasks. Application programs include various application programs, such as media players (Media Player), browsers (Browser), etc. and are used to implement various application services. Programs for realizing the methods of the embodiments of the present disclosure may be contained in application programs.

In the embodiments of the present disclosure, the processor is configured to execute the methods disclosed in the foregoing embodiments of the present disclosure by invoking the computer programs or instructions stored in the memory, specifically, the computer programs or instructions stored in the application program.

The methods disclosed in the foregoing embodiments of the present disclosure may be applied to or implemented by a processor. A processor may be an integrated circuit chip with signal processing capabilities. In the implementation process, each step of the above method can be completed by an integrated logic circuit of hardware in a processor or an instruction in the form of software. The above-mentioned processor can be a general-purpose processor, a digital signal processor (Digital Signal Processor, DSP), an application-specific integrated circuit (Application Specific Integrated Circuit, ASIC), an off-the-shelf programmable gate array (Field Programmable Gate Array, FPGA) or other available Program logic devices, discrete gate or transistor logic devices, discrete hardware components. Various methods, steps and logic block diagrams disclosed in the embodiments of the present disclosure may be implemented or executed. A general-purpose processor may be a microprocessor, or the processor may be any conventional processor, or the like. The steps of the methods disclosed in the embodiments of the present disclosure may be directly implemented by a hardware decoding processor, or implemented by a combination of hardware and software modules in the decoding processor. The software module may be located in storage media in the field such as random access memory, flash memory, read-only memory, programmable read-only memory or electrically erasable programmable memory, registers, and the like. The storage medium is located in the memory, and the processor reads the information in the memory, and completes the steps of the above method in combination with its hardware.

Another embodiment of the present disclosure provides a terminal, and the terminal may be a mobile phone, a tablet computer, a personal digital assistant (Personal Digital Assistant, PDA), or an electronic reader, a handheld game console, or a sales terminal (Point of Sales, POS). Vehicle electronic equipment (vehicle computer), etc. The terminal includes a radio frequency (Radio Frequency, RF) circuit, a memory, an input unit, a display unit, a processor, an audio circuit, a WiFi (Wireless Fidelity) module and a power supply.

Wherein, the input unit can be used to receive digital or character information input by the user, and generate signal input related to user setting and function control of the terminal. Exemplarily, in the embodiment of the present disclosure, the input unit may include a touch panel. The touch panel, also known as the touch screen, can collect the user's touch operation on or near it (such as the user's operation on the touch panel using any suitable object or accessory such as a finger and a stylus), and The program drives the corresponding connected device. Optionally, the touch panel may include two parts: a touch sensor device and a touch controller. Among them, the touch sensor device detects the user's touch orientation, and detects the signal brought by the touch operation, and transmits the signal to the touch controller; the touch controller receives the touch information from the touch sensor device, converts it into contact coordinates, and sends it to the to the processor, and can receive and execute the commands sent by the processor. In addition, various types of touch panels, such as resistive, capacitive, infrared, and surface acoustic wave, can be used to realize the touch panel. In addition to the touch panel, the input unit can also include other input devices, which can be used to receive input digital or character information, and generate key signal input related to user settings and function control of the terminal. Exemplary, other input devices may include, but are not limited to, physical keyboards, function keys (such as volume control buttons, switch buttons, etc.), trackballs, mice, joysticks, optical mice (optical mice are touch-sensitive surface, or an extension of a touch-sensitive surface formed by a touch screen), etc Wherein, the display unit can be used to display information input by the user or information provided to the user and various menu interfaces of the terminal. The display unit may include a display panel. The display panel may be configured in the form of a liquid crystal display (Liquid Crystal Display, LCD), an organic light-emitting diode (Organic Light-Emitting Diode, OLED), or the like.

It should be noted that the touch panel can cover the display panel to form a touch display screen. When the touch display screen detects a touch operation on or near it, it is sent to the processor to determine the type of the touch event. The type provides corresponding visual output on the touch display.

The touch display screen includes an application program interface display area and a common control display area. The arrangement of the display area of the application program interface and the display area of the commonly used controls is not limited, and may be an arrangement in which the two display areas can be distinguished, such as vertical arrangement, left-right arrangement, and the like. The application program interface display area can be used to display the interface of the application program. Each interface may include at least one interface element such as an icon of an application program and/or a widget desktop control. The application program interface display area can also be an empty interface without any content. The commonly used control display area is used to display controls with a high usage rate, for example, application icons such as setting buttons, interface numbers, scroll bars, and phonebook icons.

The RF circuit can be used for sending and receiving information or receiving and sending signals during a call. In particular, after receiving the downlink information on the network side, it is processed by the processor; in addition, the designed uplink data is sent to the network side Generally, an RF circuit includes but is not limited to an antenna, at least one amplifier, a transceiver, a coupler, a low noise amplifier (Low Noise Amplifier, LNA), a duplexer, and the like. In addition, RF circuits can also communicate with networks and other devices through wireless communication. The wireless communication can use any communication standard or protocol, including but not limited to Global System of Mobile communication (Global System of Mobile communication, GSM). General Packet Radio Service (General Packet Radio Service, GPRS). Code Division Multiple Access (Code Division Multiple Access, CDMA). Wideband Code Division Multiple Access (WCDMA), Long Term Evolution (LTE), email. Short Messaging Service (SMS), etc.

The memory is used to store software programs and modules, and the processor executes various functional applications and data processing of the terminal by running the software programs and modules stored in the memory. The memory can mainly include a program storage area and a data storage area, wherein the program storage area can store an operating system, at least one application program required by a function (such as a sound playback function, an image playback function, etc.); The data created by the use (such as audio data, phone book, etc.) and so on. In addition, the memory may include high-speed random access memory, and may also include non-volatile memory, such as at least one magnetic disk storage device, flash memory device, or other volatile solid-state storage devices.

The processor is the control center of the terminal, which uses various interfaces and lines to connect various parts of the entire terminal, by running or executing software programs and/or modules stored in the first memory, and calling data stored in the second memory, perform various functions of the terminal and process data. Optionally, the processor may include one or more processing units.

In the embodiments of the present disclosure, the processor is configured to execute the method provided by the embodiments of the present disclosure by calling the software program and/or module stored in the first memory and/or the data in the second memory.

The foregoing mainly introduces the solutions provided by the embodiments of the present disclosure from the perspective of electronic devices. Exemplarily, in order to realize the above-mentioned functions, the electronic device provided by the embodiments of the present disclosure includes corresponding hardware structures and/or software modules for performing various functions. Those skilled in the art should easily realize that the present disclosure can be implemented in the form of hardware or a combination of hardware and computer software with reference to the units and algorithm steps of each example described in the embodiments disclosed in the present disclosure.

Whether a certain function is executed by hardware or computer software drives hardware depends on the specific application and design constraints of the technical solution. Skilled artisans may implement the described functionality using different methods for each particular application, but such implementation should not be considered beyond the scope of the present disclosure. The embodiments of the present disclosure may divide the electronic equipment into functional modules according to the above method examples. For example, each functional module may be divided corresponding to each function, or two or more functions may be integrated into one processing module. The above-mentioned integrated modules can be implemented in the form of hardware or in the form of software function modules.

It should be noted that the division of modules in the embodiments of the present disclosure is schematic, and is only a logical function division, and there may be another division manner in actual implementation.

Those skilled in the art can clearly understand that for the convenience and brevity of description, only the division of the above-mentioned functional modules is used as an example for illustration. In practical applications, the above-mentioned function allocation can be completed by different functional modules according to needs. The internal structure of the device is divided into different functional modules to complete all or part of the functions described above. For the specific working process of the above-described system, device, and unit, reference may be made to the corresponding process in the foregoing method embodiments, and details are not repeated here. In the several embodiments provided in the present disclosure, it should be understood that the disclosed devices and methods may be implemented in other ways. For example, the device embodiments described above are only illustrative. For example, the division of the modules or units is only a logical function division. In actual implementation, there may be other division methods. For example, multiple units or components can be Incorporation may either be integrated into another system, or some features may be omitted, or not implemented. In another point, the mutual coupling or direct coupling or communication connection shown or discussed may be indirect coupling or communication connection through some interfaces, devices or units.

The units described as separate components may or may not be physically separated, and the components shown as units may or may not be physical units, that is, they may be located in one place, or may be distributed to multiple network units. Part or all of the units can be selected according to actual needs to achieve the purpose of the solution of this embodiment. In addition, each functional unit in each embodiment of the present disclosure may be integrated into one processing unit, each unit may exist separately physically, or two or more units may be integrated into one unit. The above integrated units can be implemented in the form of software functional units.

If the integrated unit is realized in the form of a software function unit and sold or used as an independent product, it can be stored in a computer-readable storage medium. Based on such an understanding, all or part of the technical solution can be embodied in the form of software products, which are stored in a storage medium and include several instructions to make a computer device (which can be a personal computer, server, or a network device, etc.) or a processor to execute all or part of the steps of the methods described in the various embodiments of the present disclosure. The computer storage medium is a non-transitory (English: nontransitory) medium, including various mediums capable of storing program codes such as flash memory, mobile hard disk, read-only memory, random access memory, magnetic disk or optical disk.

On the other hand, the embodiments of the present disclosure also provide a non-transitory computer-readable storage medium, on which a computer program is stored. When the computer program is executed by a processor, the methods provided by the above-mentioned embodiments can be realized and the same technology can be achieved effects, which will not be repeated here. It should be noted that the above embodiments are only used to illustrate the technical solutions of the present disclosure, not to limit them; although the present disclosure has been described in detail with reference to the foregoing embodiments, those of ordinary skill in the art should understand that: it can still. The technical solutions described in the foregoing embodiments are modified, or some of the technical features are equivalently replaced, and these modifications or replacements do not make the essence of the corresponding technical solutions depart from the scope of the technical solutions of the embodiments of the present disclosure.

1-34. (canceled)

35. A wireless device for communicating information via a base station comprising:
memory, firmware, computing module, and a wireless communication interface for communicating with a mesh network to achieve an uplink communication with the base station;
wherein the wireless device is configured to receive data from a sensor and transmit sensor data via the base station;
wherein a communication path for transmission of the sensor data is determined with one or more of the following associated with the transmission of the sensor data: modulation mode, transmission rate, power, distance, spectrum occupation, and/or bandwidth.

36. The wireless device of claim 35, wherein the sensor data is encrypted with network communication path information associated with the sensor data.

37. The wireless device of claim 35, wherein the sensor data is encrypted with one or more of: geographic location information of the gateway through which the sensor data passes; location of route point; intermediate node information; and/or latitude and longitude of coordinate data.

38. The wireless device of claim 34, wherein the sensor data is encrypted with time information associated with transmission of the sensor data; and wherein the sensor data is transmitted from an IoT node.

39. The wireless device of claim 34, wherein the sensor data is encrypted with one of more of the following information: communication path, frequency, bandwidth, transmission speed, and/or communication protocol information associated with transmission of the sensor data; and wherein the sensor data is transmitted from an IoT node.

40. The wireless device of claim 34, wherein the communication path for transmission of the sensor data is associated with at least two of the following:
communication interval, transmit power, data rate, channel delay, spectrum occupancy, source coding, receiving sensitivity, channel coding, signal-to-noise ratio, packet loss rate, channel occupancy rate, reception frequencies, frequency band, size of data package, transmission frequencies, data package structure, modulation scheme, information coding scheme, antenna configuration; and
wherein the determination of the communication path is made to optimize spectral efficiency, network resource utilization rate, and/or to meet the requirement associated with transmission of the sensor data; and
wherein sampling interval, sampling accuracy, and/or transmission rate for the sensor data are adjusted based on change of the sensor data and/or relationship among sensor data.

41. The wireless device of claim 34, wherein sampling interval, sampling accuracy, and/or transmission rate associated with the sensor data are adjusted based on change of the sensor data and/or relationship among multiple sensor data.

42. The wireless device of claim 34, wherein the sensor data is split into distinct data streams for transmission along different communication paths.

43. The wireless device of claim 34, wherein the wireless device is configured to change encoding of the sensor data and transmit the sensor data in a newly encoded format.

44. The wireless device of claim 34, wherein the wireless device is configured to prioritize transmission of the sensor data.

45. A method for communicating information via a base station comprising:
receiving data from a sensor;
communicating with a mesh network to achieve an uplink communication with the base station;
and transmitting the sensor data via the base station;
wherein communication path for transmission of the sensor data is determined with one or more of following associated with the transmission of the sensor data: modulation mode, transmission rate, power, distance, spectrum occupation, bandwidth.

46. The method of claim 45, wherein the sensor data is encrypted with network communication path information associated with the sensor data.

47. The method of claim 46, wherein the sensor data is encrypted with one or more of: geographic location information of the gateway through which the sensor data passes; location of route point; intermediate node information; and/or latitude and longitude of coordinate data.

48. The method of claim 45, wherein the sensor data is encrypted with time information associated with transmission of the sensor data.

49. The method of claim 45, wherein the sensor data is encrypted with one of more of the following information: communication serial number, communication path, frequency, bandwidth, transmission speed, and/or communication protocol information associated with transmission of the sensor data.

50. The method of claim 45, wherein decryption key for the sensor data is associated with network transmission path; wherein the wireless device is an IoT node, and the sensor data is received by another IoT node; wherein the receiving IoT node uses location information of the previous IoT node for decryption of the received sensor data in sequence, thereby implementing layer by layer encryption and layer by layer decryption.

51. The method of claim 45, wherein the sensor data sampling and/or the sensor data transmission linkage is optimized based on network condition for transmission of the sensor data.

52. The method of claim 45, wherein a stream of the sensor data is split into distinct streams for transmission along different communication paths.

53. The method of claim 45, wherein the sensor data is encoded into a new format for transmission.

54. The method of claim 45, wherein the sensor data is sent from an IoT node; and
wherein communication path for transmission of the sensor data is determined with at least two of the following:
communication interval, transmit power, data rate, channel delay, spectrum occupancy, source coding, receiving sensitivity, channel coding, signal-to-noise ratio, packet loss rate, channel occupancy rate, reception frequencies, frequency band, size of data package, transmission frequencies, data package structure, modulation scheme, information coding scheme, antenna configuration;
wherein the determination of the network settings is made to optimize spectral efficiency, network resource utilization rate, and/or to meet the requirement associated with transmission of the sensor data; and
wherein sampling interval, sampling accuracy, and/or transmission rate for the sensor data are adjusted based on change of the sensor data and/or relationship among sensor data.
